(19) United States
(12) Patent Application Publication
(10) Pub. No.: US 2025/0377778 A1
(43) Pub. Date: Dec. 11, 2025

(54) DEVICES, METHODS, AND GRAPHICAL USER INTERFACES FOR ATTENTION BASED SCROLLING AND OBJECT INTERACTIONS

(71) Applicant: Apple Inc., Cupertino, CA (US)

(72) Inventors: Nathan GITTER, Cupertino, CA (US); Cedric BRAY, Sunnyvale, CA (US); Wai Ching LAM, Playa Vista, CA (US); Stephen O. LEMAY, Palo Alto, CA (US); Evgenii KRIVORUCHKO, San Francisco, CA (US)

(21) Appl. No.: 19/231,442

(22) Filed: Jun. 7, 2025

Related U.S. Application Data
(60) Provisional application No. 63/657,968, filed on Jun. 9, 2024.
(60) Provisional application No. 63/805,144, filed on May 13, 2025.
(60) Provisional application No. 63/818,951, filed on Jun. 6, 2025.

(51) Int. Cl. G06F 3/0485; G06F 3/01; G06F 3/0481; G06F 3/04845

(52) U.S. Cl. CPC G06F 3/0485; G06F 3/013; G06F 3/0481; G06F 3/04845

(57) ABSTRACT

Some examples are directed to systems and methods for scrolling scrollable content in response to gaze-based inputs. Some examples are directed to systems and methods for scrolling scrollable content in response to gaze-based inputs and/or input provided by a respective input element. Some examples are directed to systems and methods for displaying virtual objects with an appearance that is based upon a duration of attention directed to the virtual objects. Some examples are directed to systems and methods for displaying animations of virtual objects. Some examples are directed to changing values of audio parameters based on attention of a user. Some examples are directed to changing gaze scrolling regions of content based on characteristics of the content.

### CROSS REFERENCE TO RELATED APPLICATIONS

This application claims the benefit of U.S. Provisional Application No. 63/818,951, filed Jun. 6, 2025, U.S. Provisional Application No. 63/805,144, filed May 13, 2025, and U.S. Provisional Application No. 63/657,968, filed Jun. 9, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays scrollable content. In some embodiments, the computer system detects a gaze of a user of the computer system directed to the scrollable content. In some embodiments, in accordance with a determination that the gaze is directed to a first type of content of the scrollable content, the computer system scrolls the scrollable content at a first speed. In some embodiments, in accordance with a determination that the gaze is directed to a second type of content of the scrollable content, the computer system scrolls the scrollable content at a second speed, different from the first speed.

In some embodiments, a computer system displays scrollable content. In some embodiments, the computer system detects a gaze of a user of the computer system directed to the scrollable content. In some embodiments, in accordance with a determination that a respective input element is not providing an input to scroll the scrollable content, the computer system scrolls the scrollable content. In some embodiments, in accordance with a determination that a respective input element is providing an input to scroll the scrollable content, the computer system forgoes scrolling the scrollable content.

In some embodiments, a computer system displays virtual objects. In some embodiments, the computer system detects attention (e.g., gaze) of the user of the computer directed to the virtual objects. In some embodiments, in accordance with a determination that the duration for which the attention of the user has been directed to the first virtual object exceeds a time threshold, change a visual appearance of the virtual objects. In some embodiments, in accordance with a determination that the duration for which the gaze of the user has been directed to the first virtual object exceeds a second threshold, change a visual appearance of the virtual objects including displaying visual content.

In some embodiments, a computer system displays an animation of a virtual object. In some embodiments, an animation is based on an animation curve. In some embodiments, the animation is based on interpolation between two or more appearance states. In some embodiments, the animation is displayed in response to detecting attention directed to the virtual object. In some embodiments, the animation curves for different virtual objects are the same animation curve. In some embodiments, the animation curve includes a plurality of portions. In some embodiments, the rate of the animation curve changes over time. In some embodiments, the animation curve is at least partially non-linear.

In some embodiments, a computer system transitions between video content items that are displayed in a three-dimensional environment. In some embodiments, while playing the first video content item, the computer system detects a gaze of the user of the computer system move to a second video content item and in response initiates a process to transition from playing the first video content item, to playing the second video content item.

In some embodiments, a computer system changes one or more properties of gaze scrolling regions associated with scrollable content based on characteristics of content including the scrollable content (e.g., based on characteristics of non-scrolling content). In some embodiments, the computer system modifies (e.g., expands or contracts) the gaze scrolling regions, and in some embodiments, the computer system eliminates the gaze scrolling regions.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7BB illustrate exemplary ways in which a computer system scrolls scrollable content in response to gaze-based inputs in accordance with some embodiments of the disclosure.

FIG. 8 illustrates a flow diagram illustrating a method in which a computer system scrolls scrollable content in response to gaze-based inputs in accordance with some embodiments of the disclosure.

FIGS. 9A-9KK illustrate exemplary ways in which a computer system scrolls scrollable content in response to gaze-based inputs and/or input provided by a respective input element in accordance with some embodiments of the disclosure.

FIG. 10 illustrates a flow diagram illustrating a method in which a computer system scrolls scrollable content in response to gaze-based inputs and/or input provided by a respective input element in accordance with some embodiments of the disclosure.

FIGS. 11A-11V illustrate exemplary ways in which a computer system displays a virtual object with an appearance based upon a duration of attention directed to the virtual object in accordance with some embodiments of the disclosure.

FIG. 12 illustrates a flow diagram illustrating a method in which a computer system displays a virtual object with an appearance based upon a duration of attention directed to the virtual object in accordance with some embodiments of the disclosure.

FIGS. 13A-13HH illustrate exemplary ways in which a computer system animates virtual objects based on animation curves in accordance with some embodiments of the disclosure.

FIG. 14 illustrates a flow diagram illustrating a method in which a computer system animates virtual objects based on animation curves in accordance with some embodiments of the disclosure.

FIGS. 15A-15U illustrate exemplary ways in which an electronic device transitions between playing content items based on a detected attention of the user in accordance with some embodiments of the disclosure.

FIG. 16 illustrates a flow diagram illustrating a method in which an electronic device transitions between playing content items based on a detected attention of the user in accordance with some embodiments of the disclosure.

FIGS. 17A-17F illustrate exemplary ways in which a computer system modifies gaze scrolling regions in accordance with some embodiments of the disclosure.

FIG. 18 illustrates a flow diagram illustrating a method in which a computer system modifies gaze scrolling regions in accordance with some embodiments of the disclosure.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays scrollable content. In some embodiments, the computer system detects a gaze of a user of the computer system directed to the scrollable content. In some embodiments, in accordance with a determination that the gaze is directed to a first type of content of the scrollable content, the computer system scrolls the scrollable content at a first speed. In some embodiments, in accordance with a determination that the gaze is directed to a second type of content of the scrollable content, the computer system scrolls the scrollable content at a second speed, different from the first speed.

In some embodiments, a computer system displays scrollable content. In some embodiments, the computer system detects a gaze of a user of the computer system directed to the scrollable content. In some embodiments, in accordance with a determination that a respective input element is not providing an input to scroll the scrollable content, the computer system scrolls the scrollable content. In some embodiments, in accordance with a determination that a respective input element is providing an input to scroll the scrollable content, the computer system forgoes scrolling the scrollable content.

In some embodiments, a computer system displays virtual objects. In some embodiments, the computer system detects attention (e.g., gaze) of the user of the computer directed to the virtual objects. In some embodiments, in accordance with a determination that the duration for which the attention of the user has been directed to the first virtual object exceeds a time threshold, change a visual appearance of the virtual objects. In some embodiments, in accordance with a determination that the duration for which the gaze of the user has been directed to the first virtual object exceeds a second threshold, change a visual appearance of the virtual objects including displaying visual content.

In some embodiments, a computer system displays an animation of a virtual object. In some embodiments, an animation is based on an animation curve. In some embodiments, the animation is based on interpolation between two or more appearance states. In some embodiments, the animation is displayed in response to detecting attention directed to the virtual object. In some embodiments, the animation curves for different virtual objects are the same animation curve. In some embodiments, the animation curve includes a plurality of portions. In some embodiments, the rate of the animation curve changes over time. In some embodiments, the animation curve is at least partially non-linear.

In some embodiments, a computer system transitions from playing a first video content item to playing a second video content item in response to detecting the attention of the user (e.g., based on gaze) being directed to the second video content item. In some embodiments, the transition process includes playing the second video content item concurrently with the first video content item, and gradually increasing the audio associated with the second video content item while gradually decreasing the audio associated with the first video content item. In some embodiments, the transition process terminates with stopping play of the first video content item (including the audio associated with the first video content item) while the second video content item is being played (including the audio associated with the second video content item).

In some embodiments, a computer system changes one or more properties of gaze scrolling regions associated with scrollable content based on characteristics of content including the scrollable content (e.g., based on characteristics of non-scrolling content). In some embodiments, the computer system modifies (e.g., expands or contracts) the gaze scrolling regions, and in some embodiments, the computer system eliminates the gaze scrolling regions.

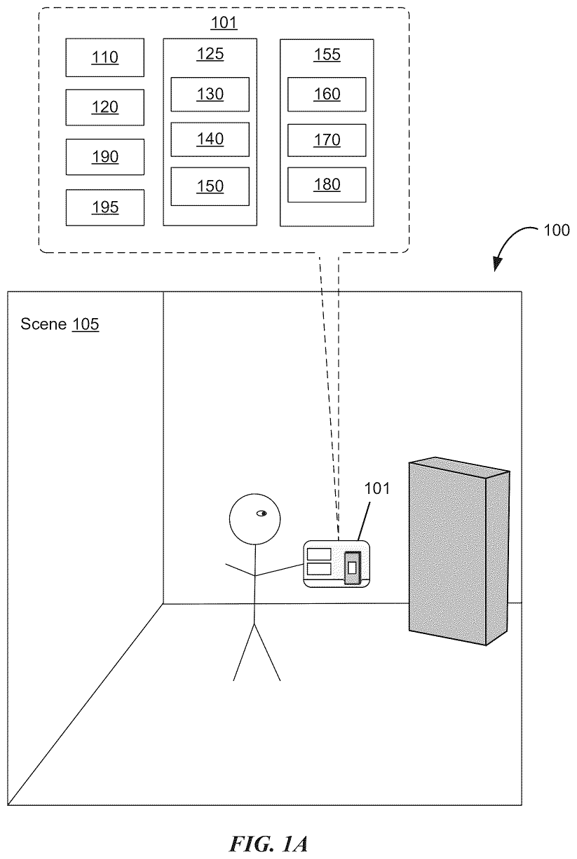

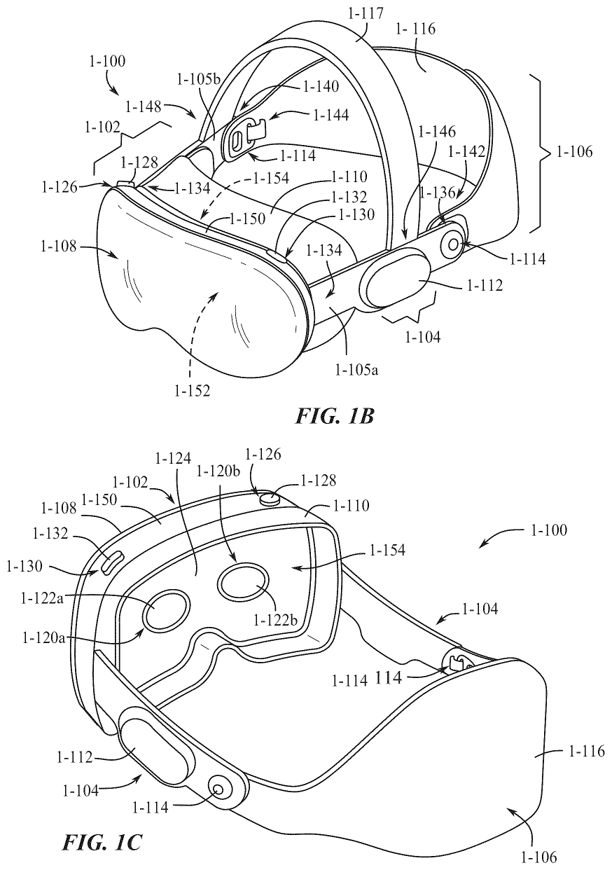

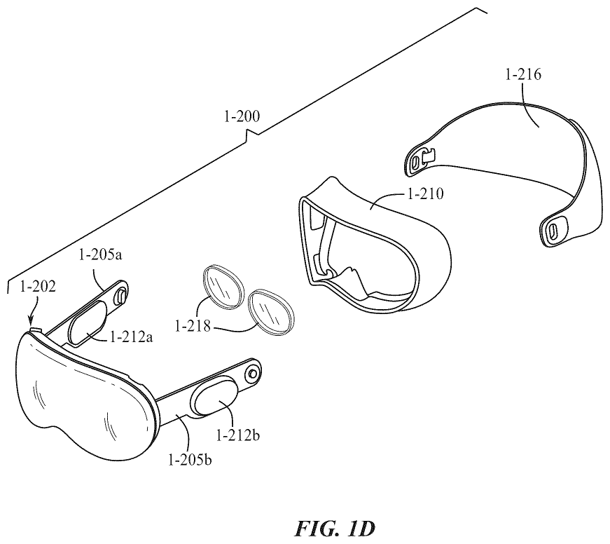

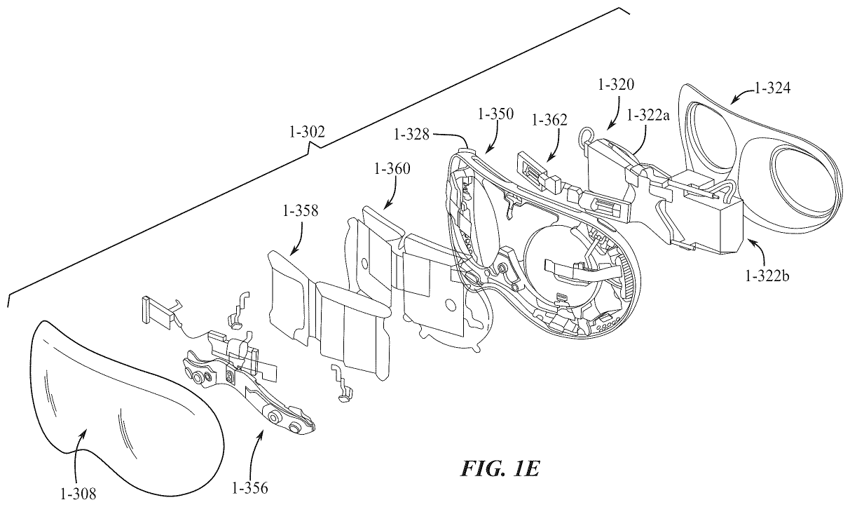

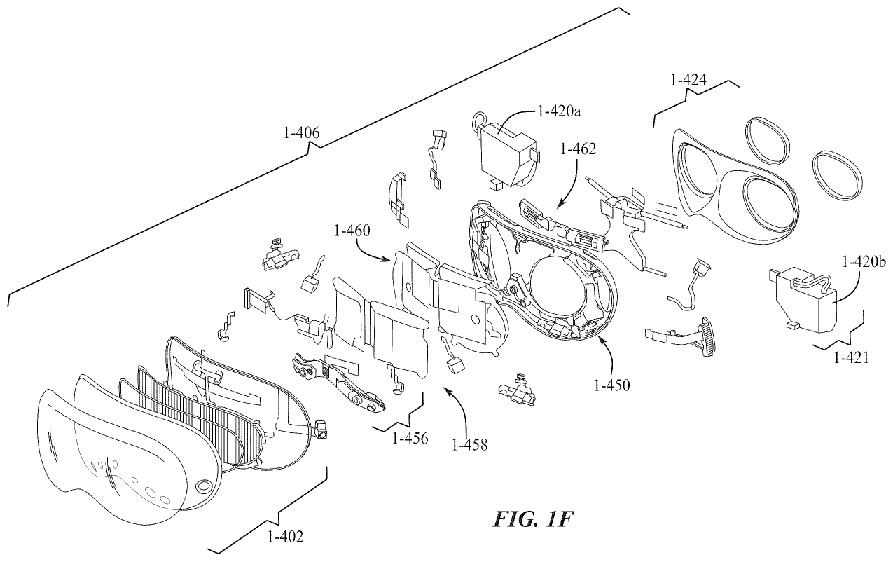

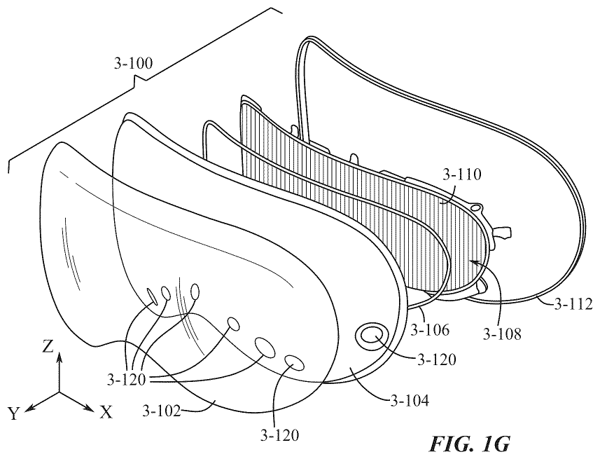

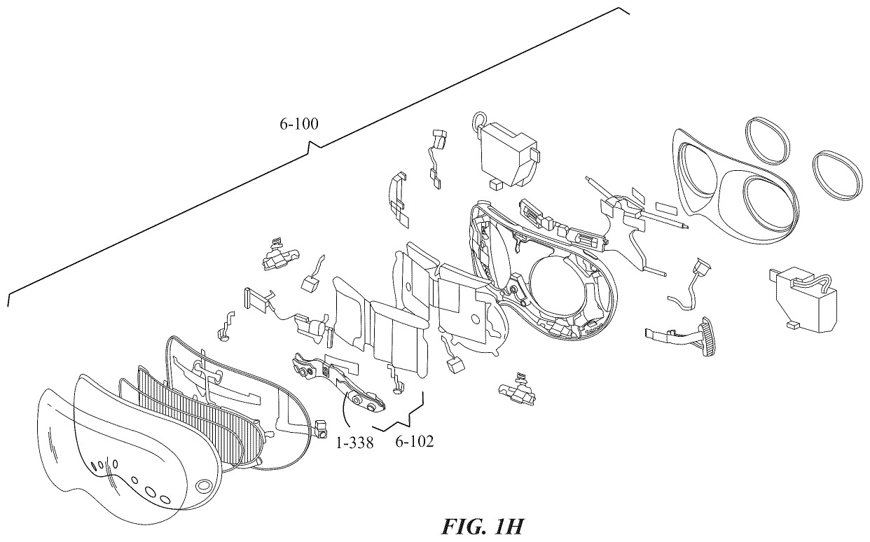

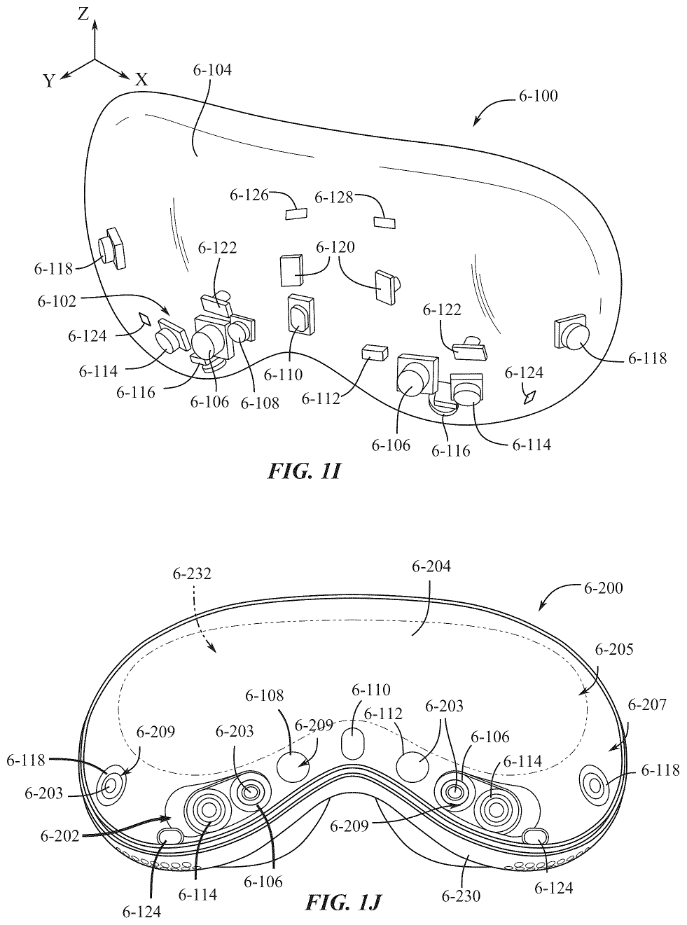

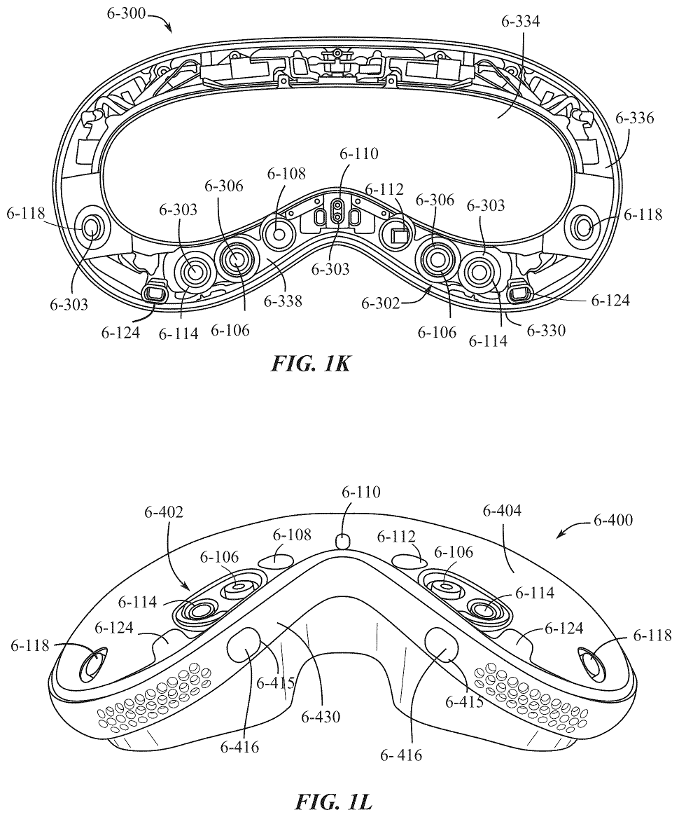

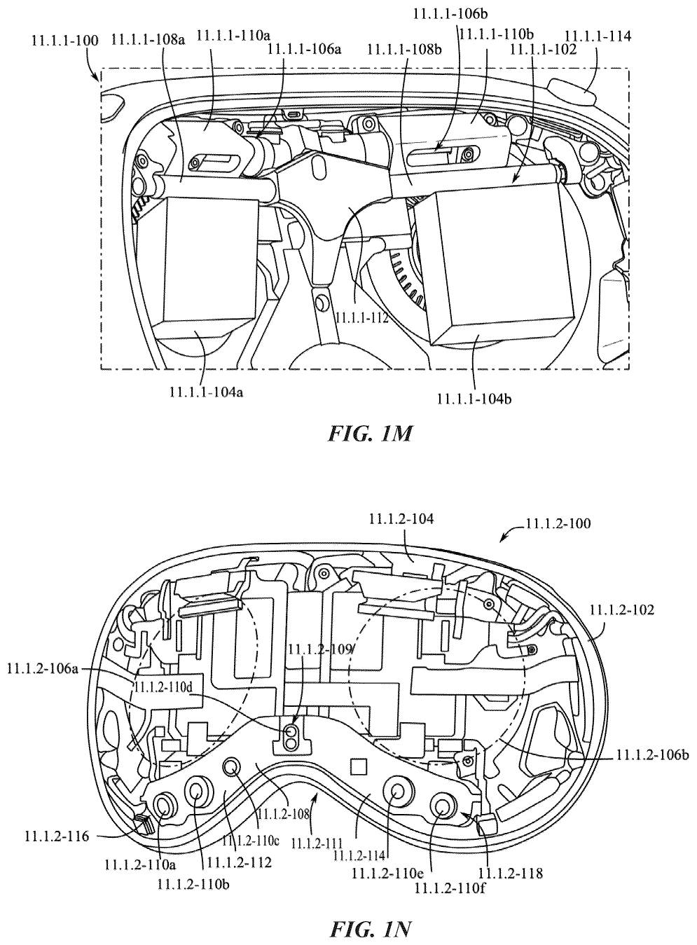

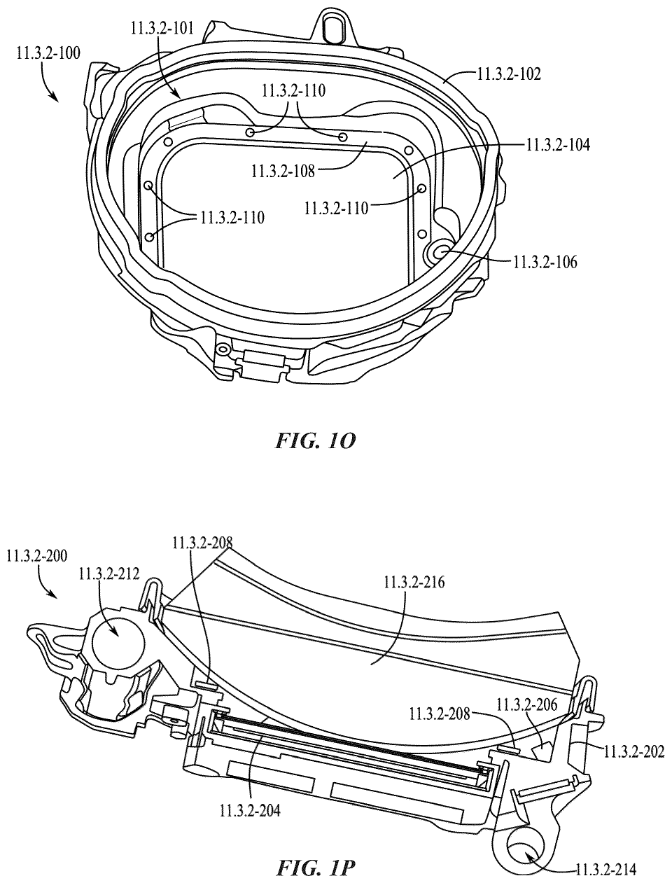

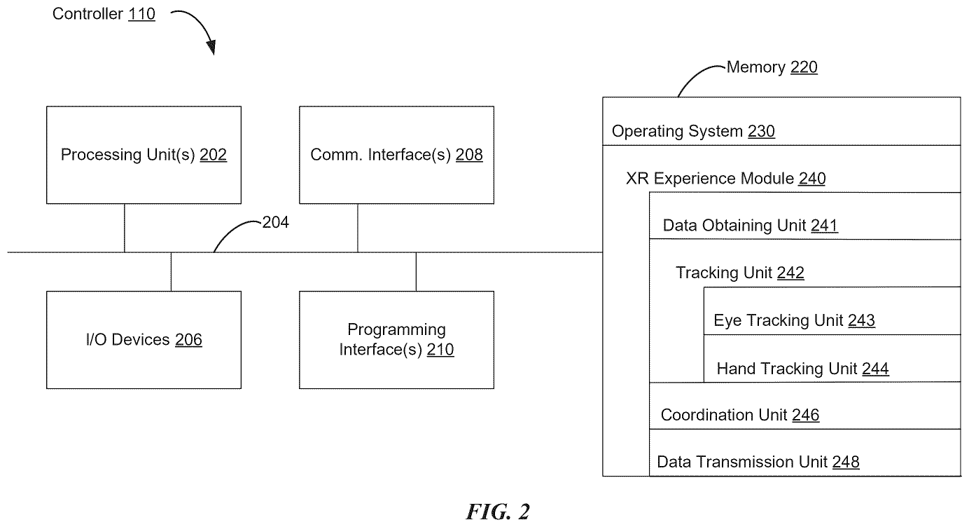

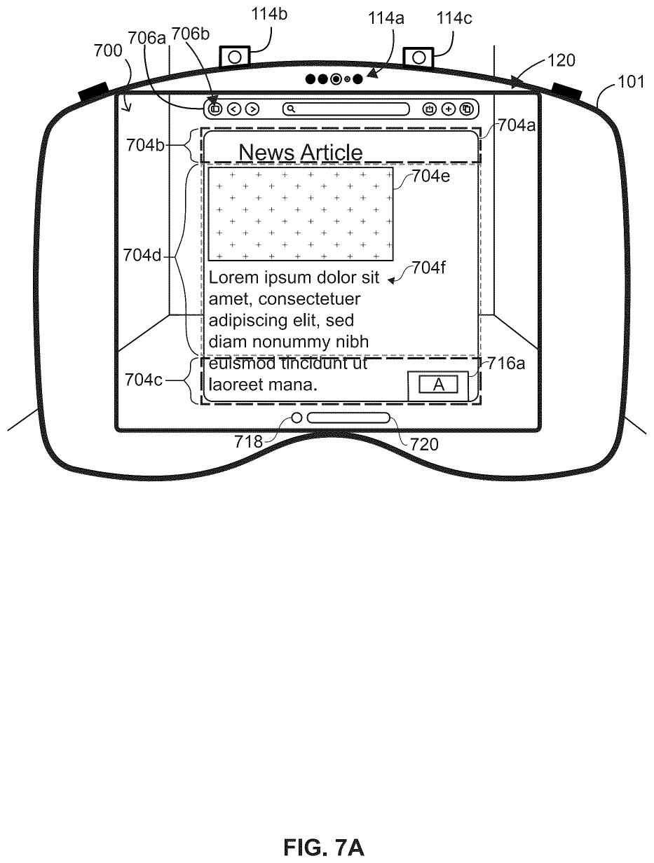

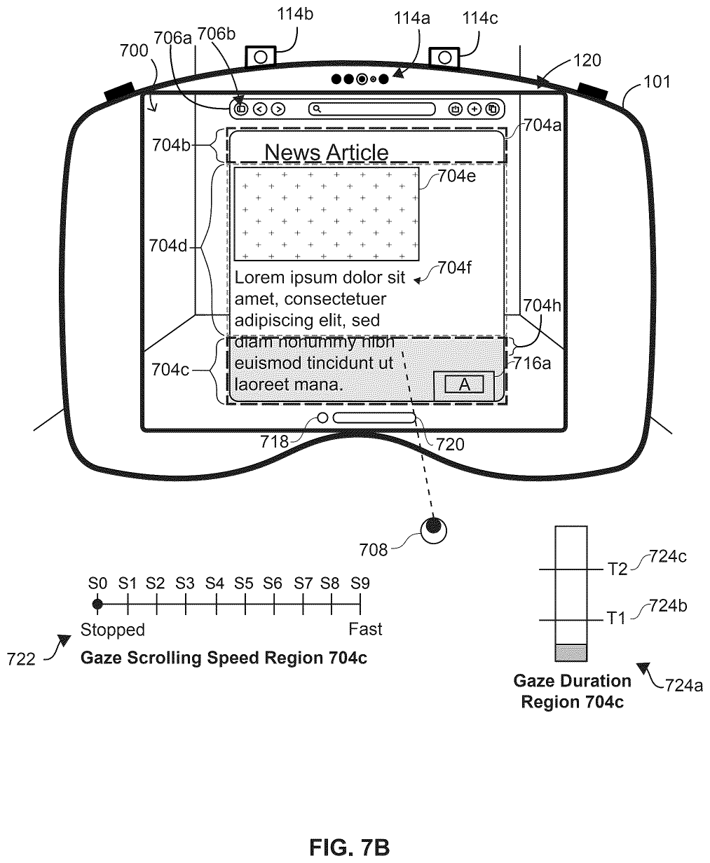

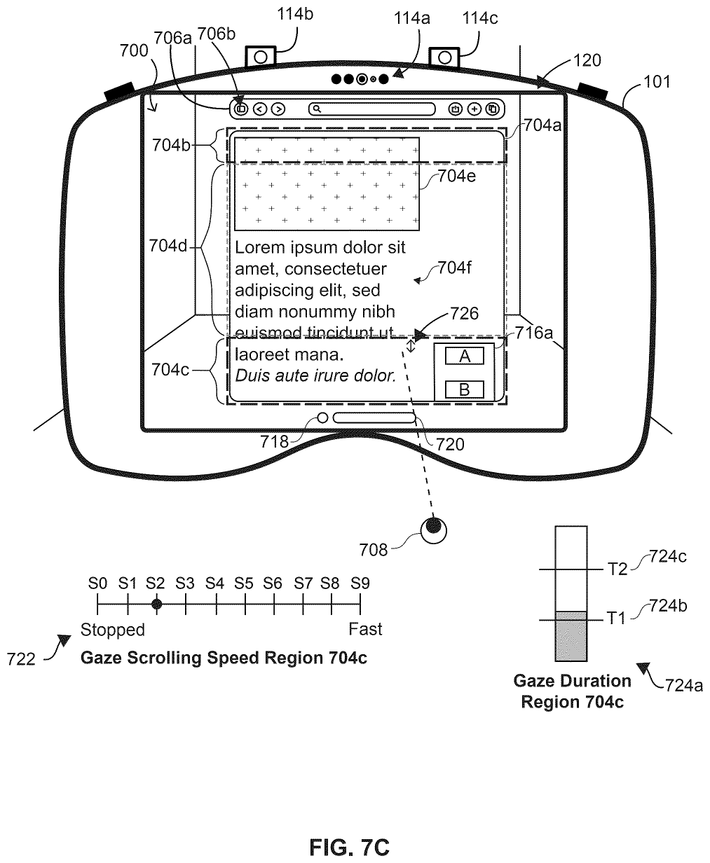

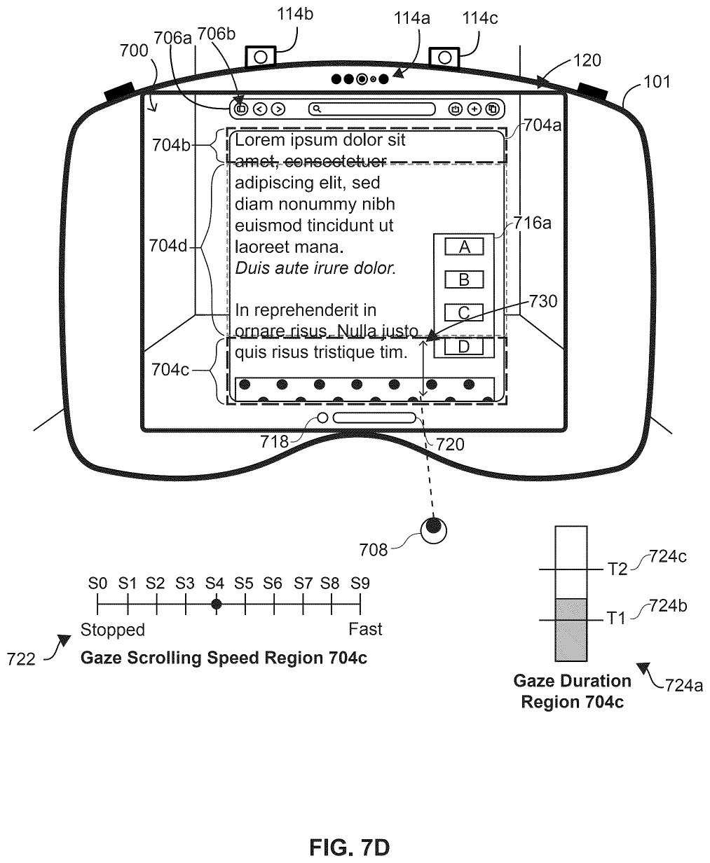

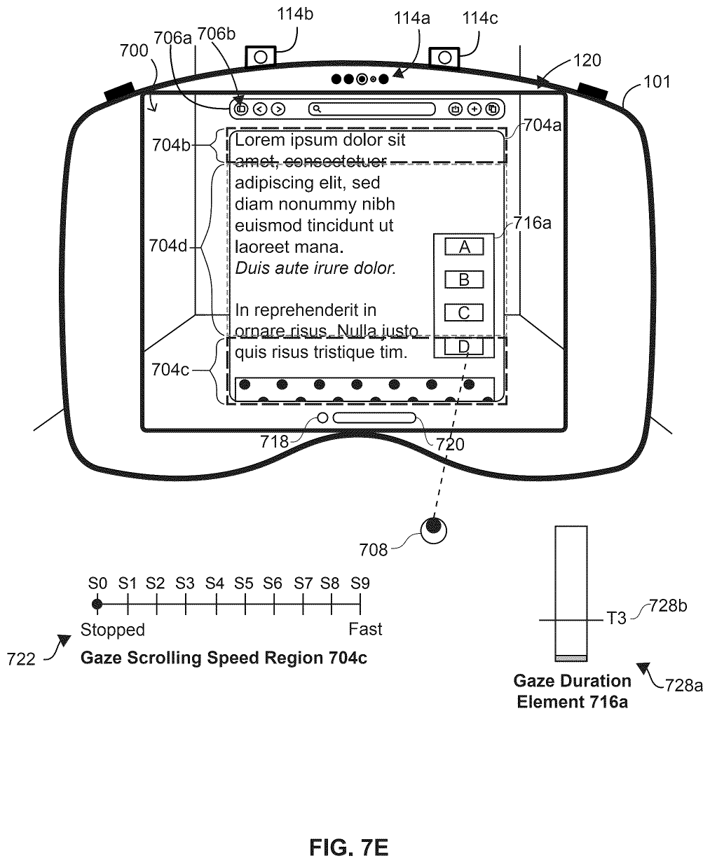

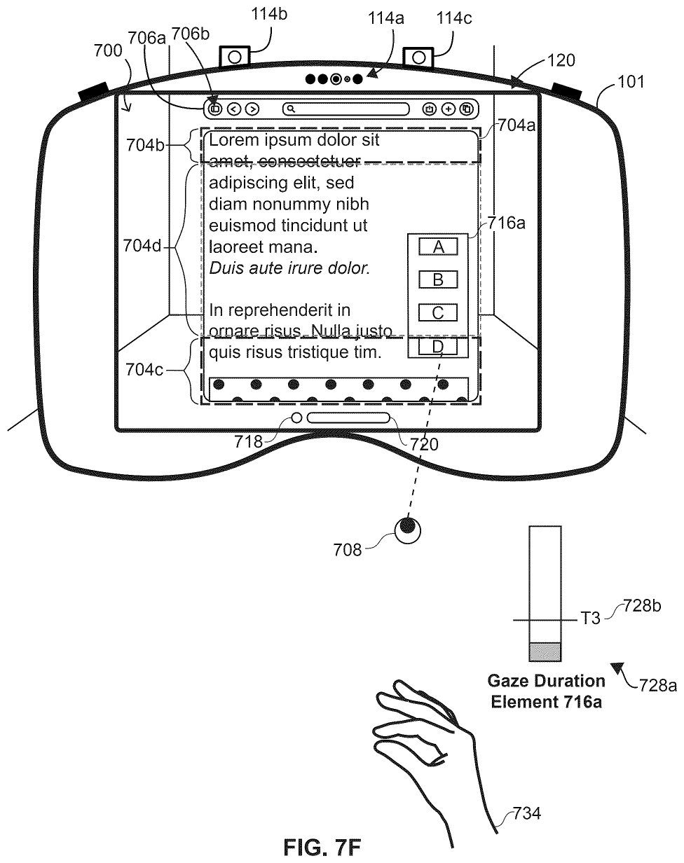

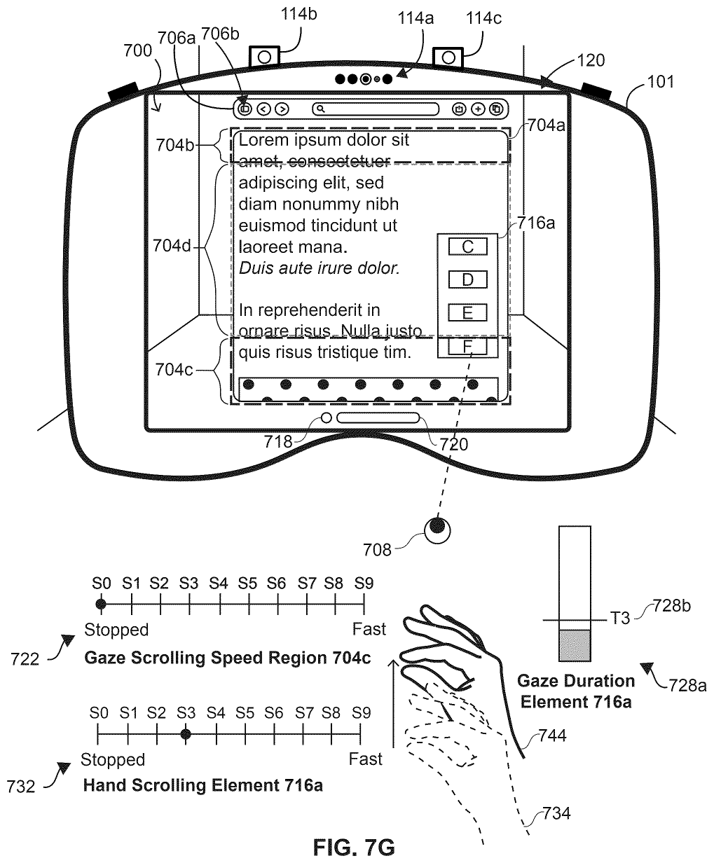

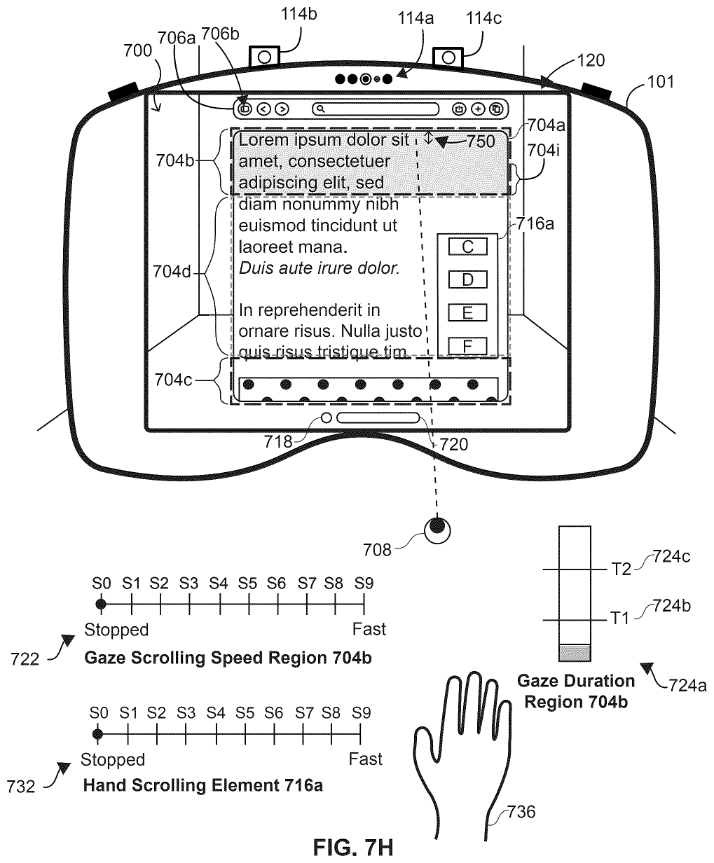

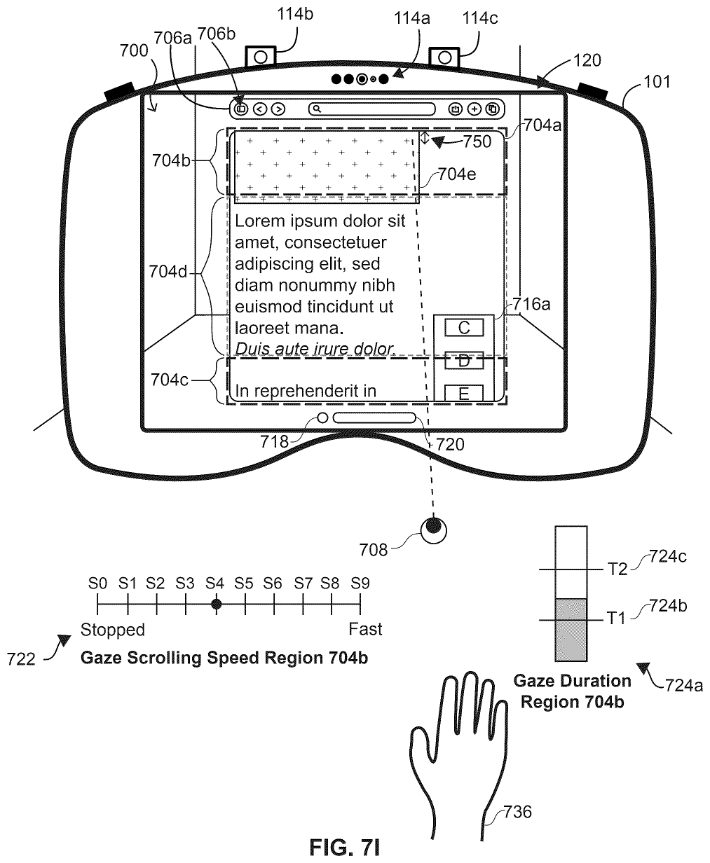

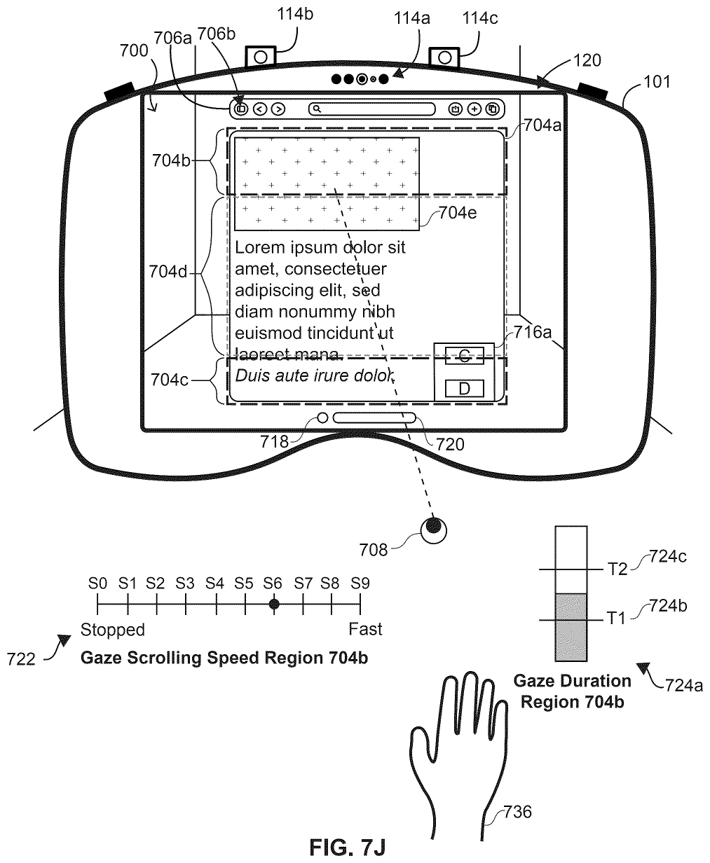

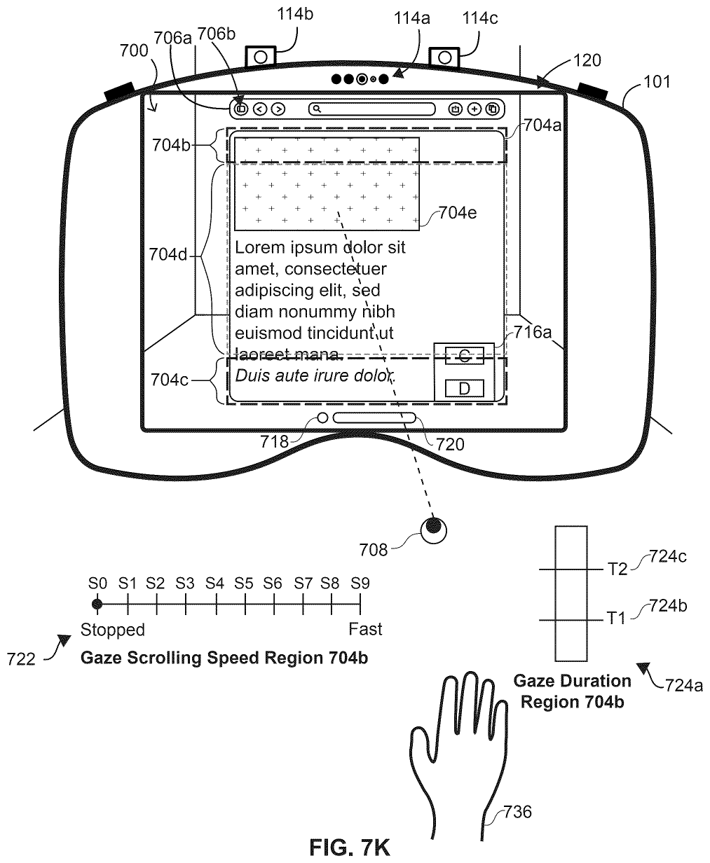

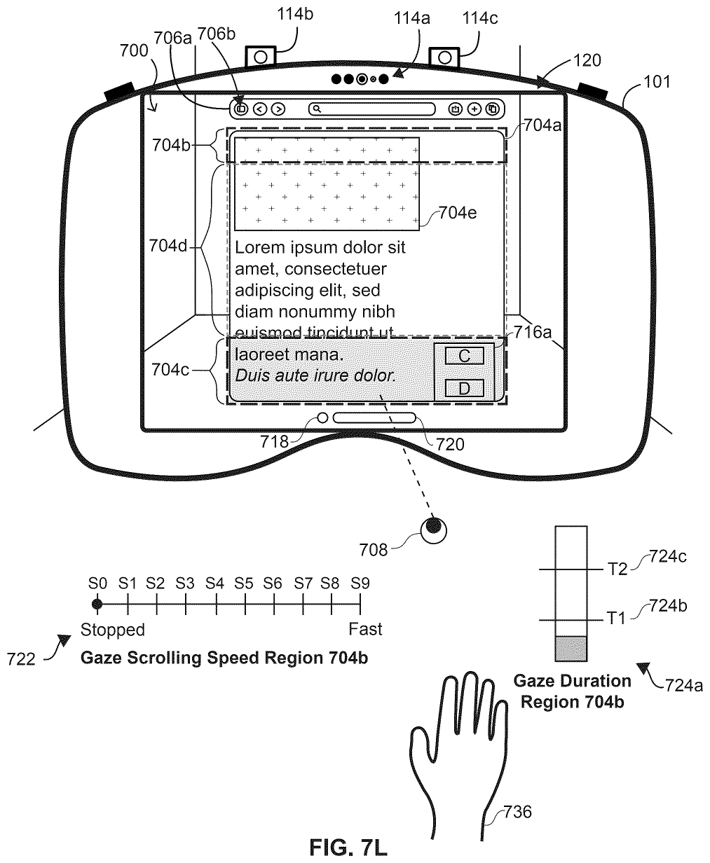

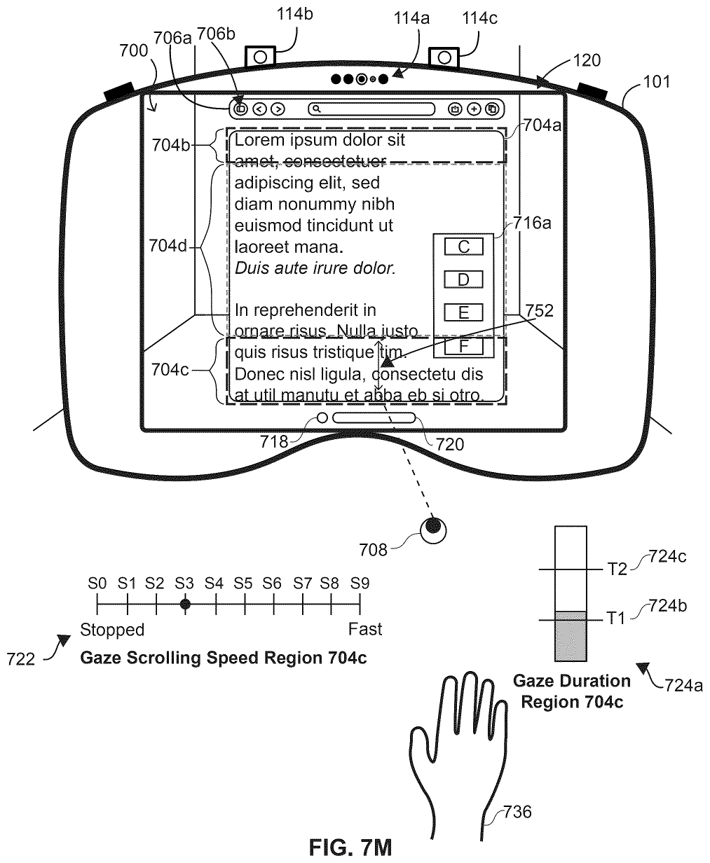

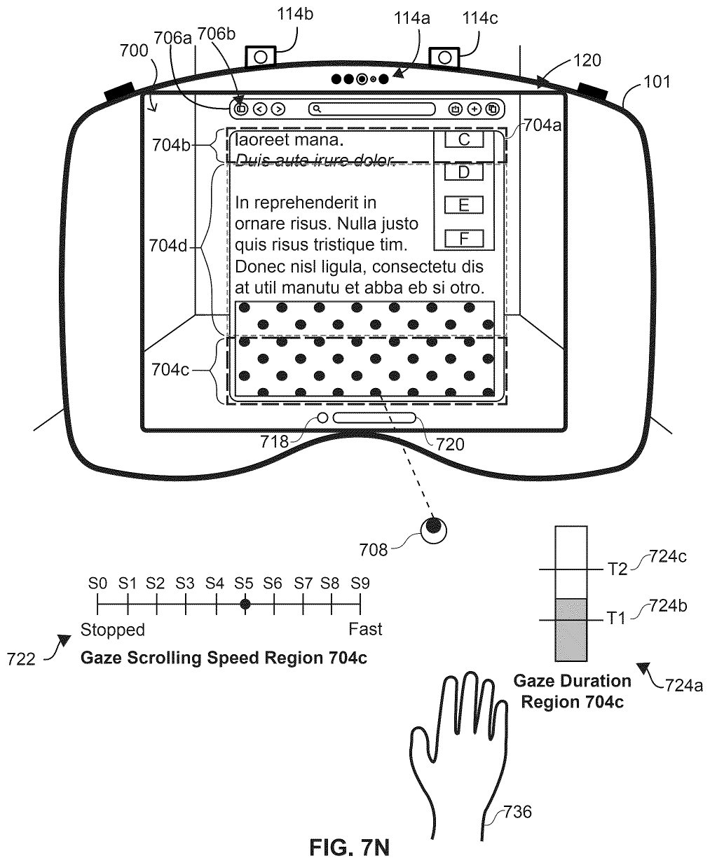

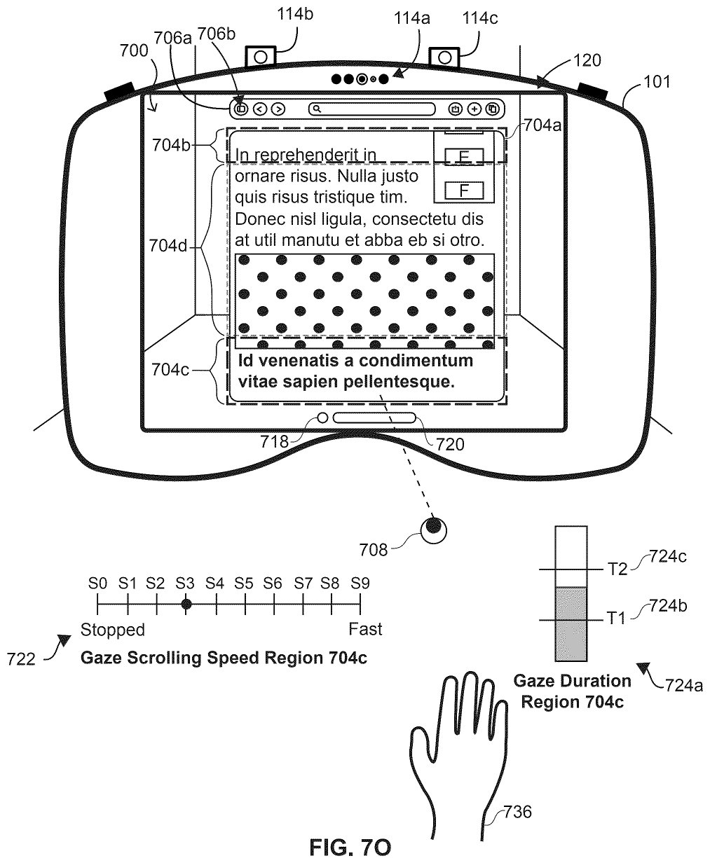

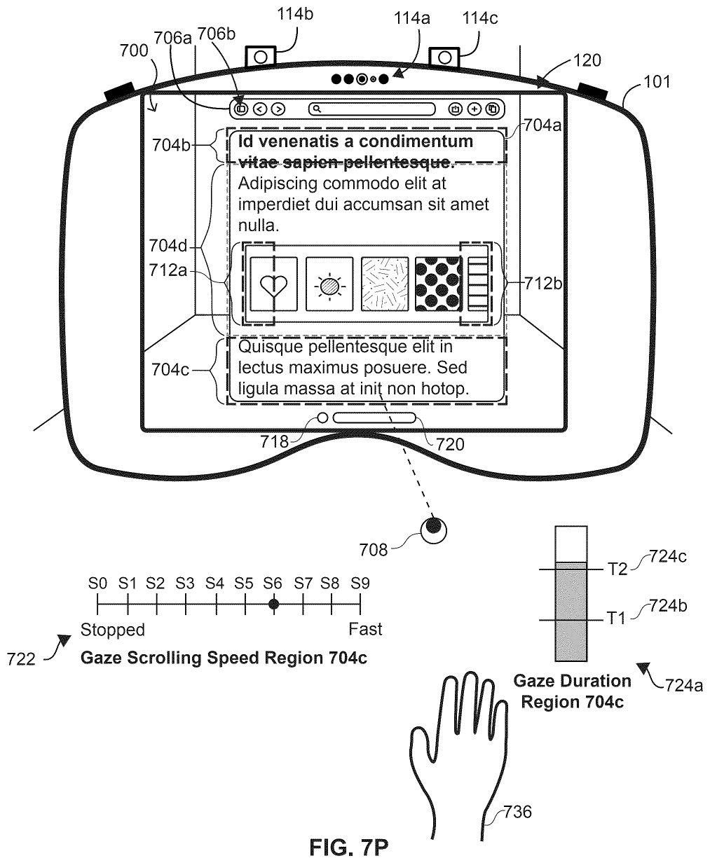

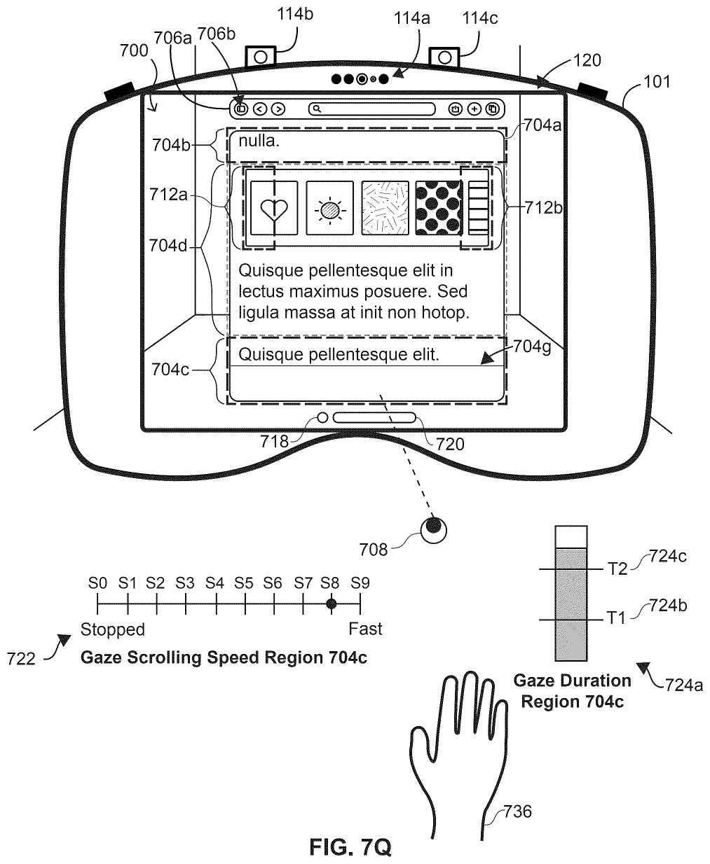

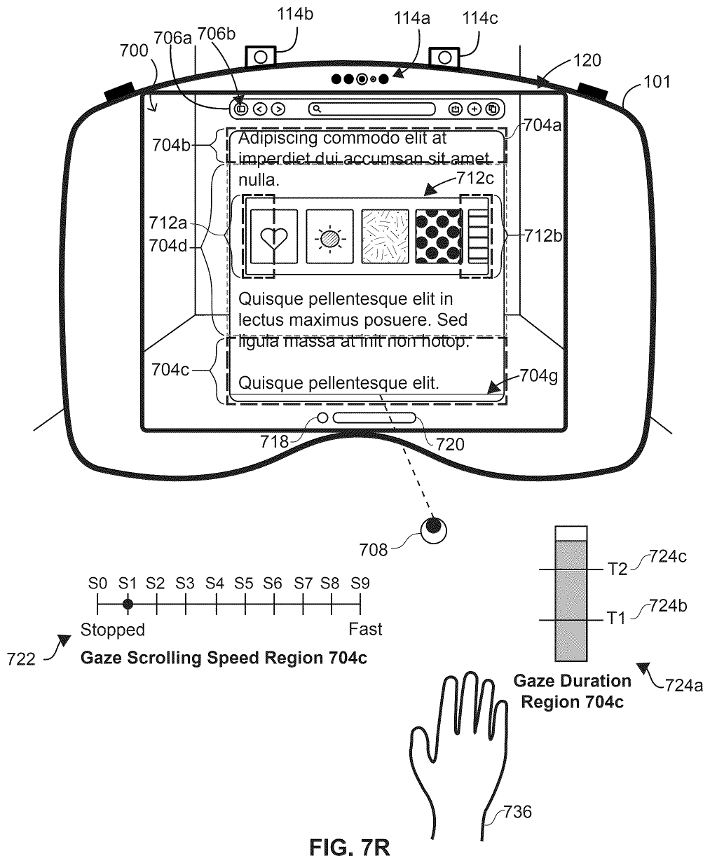

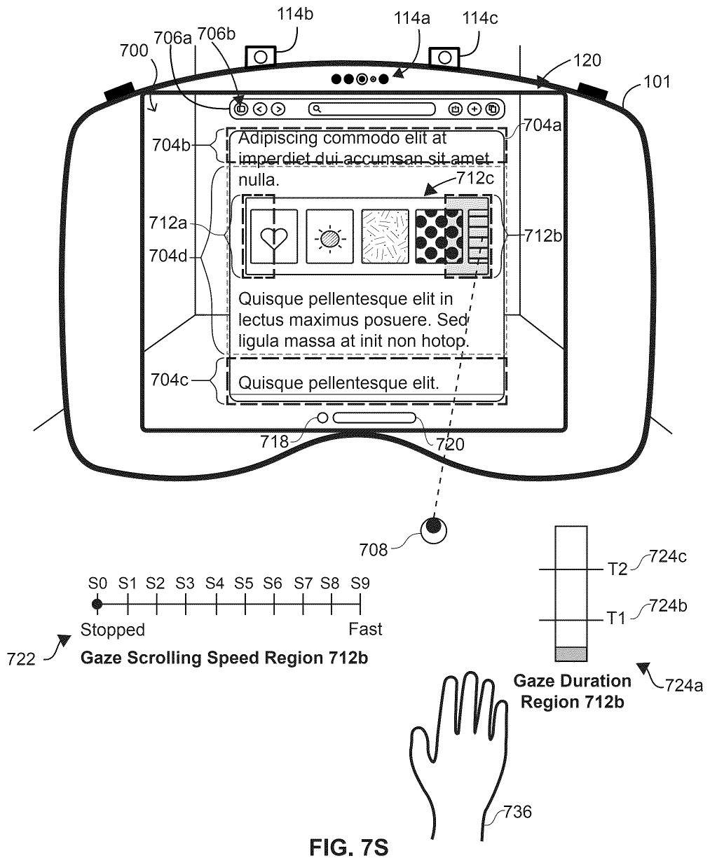

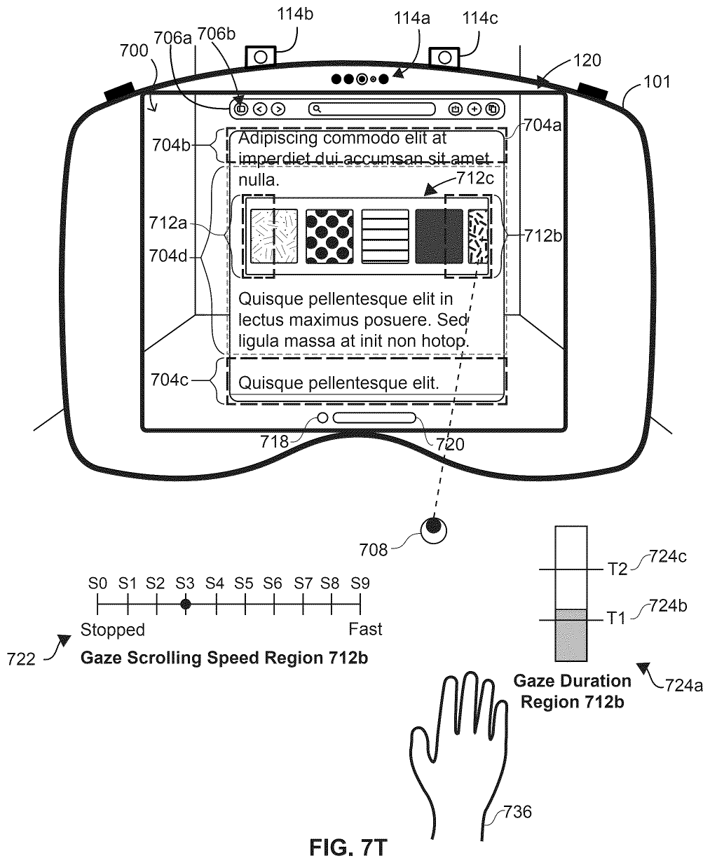

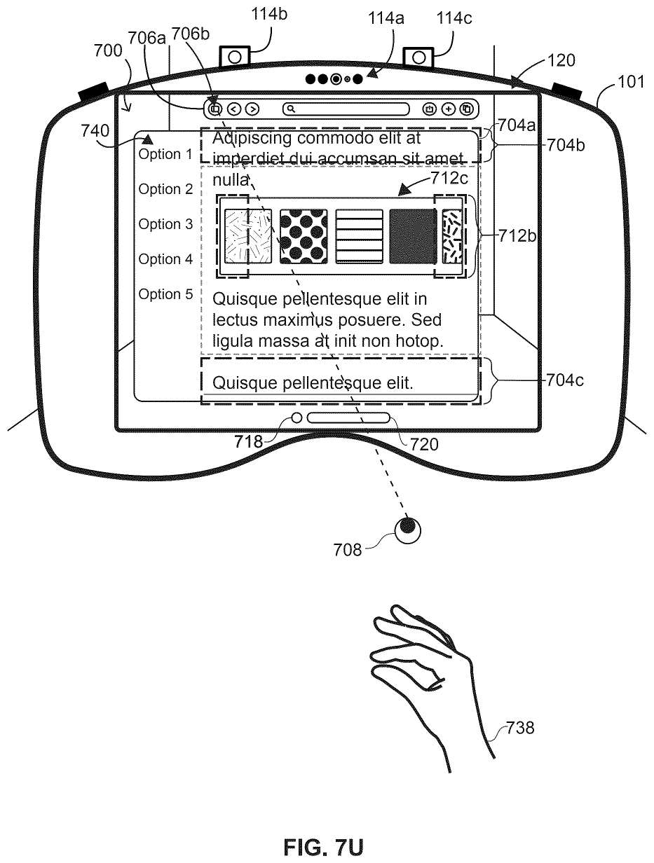

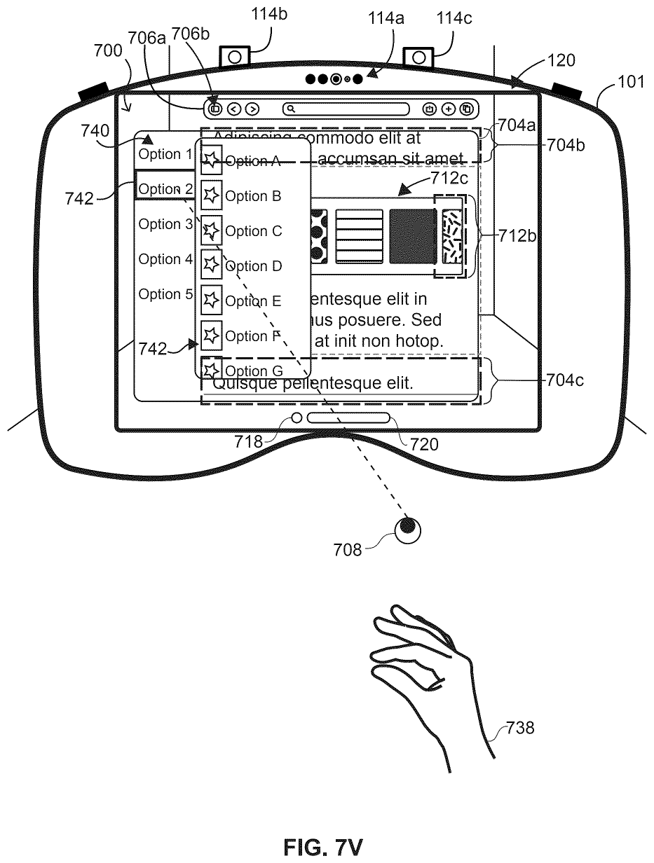

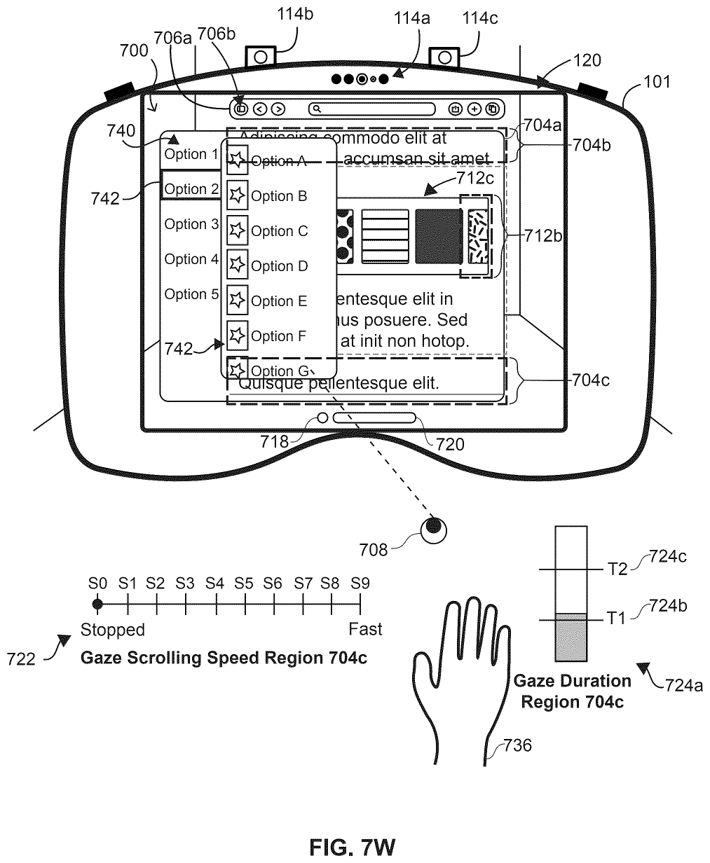

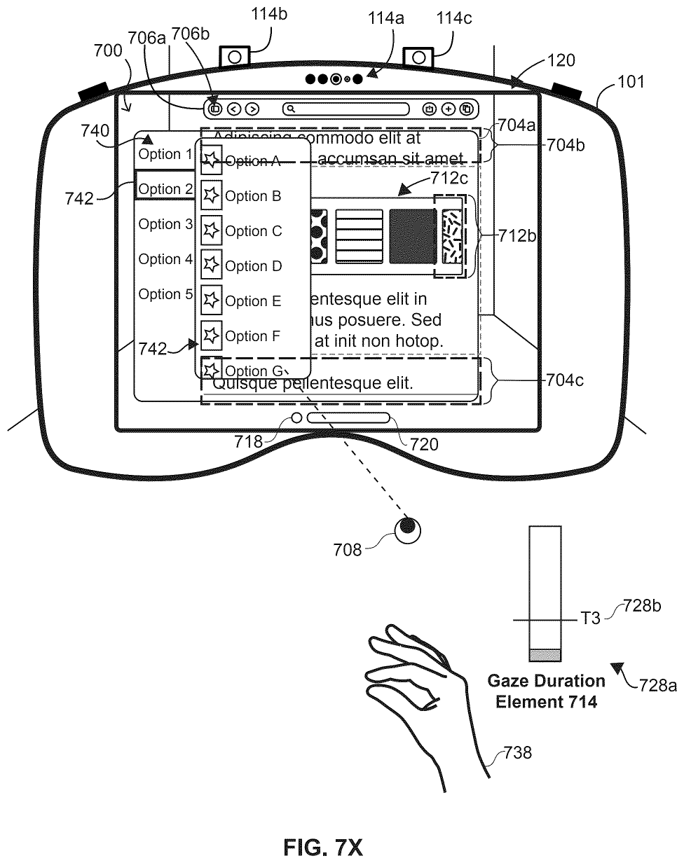

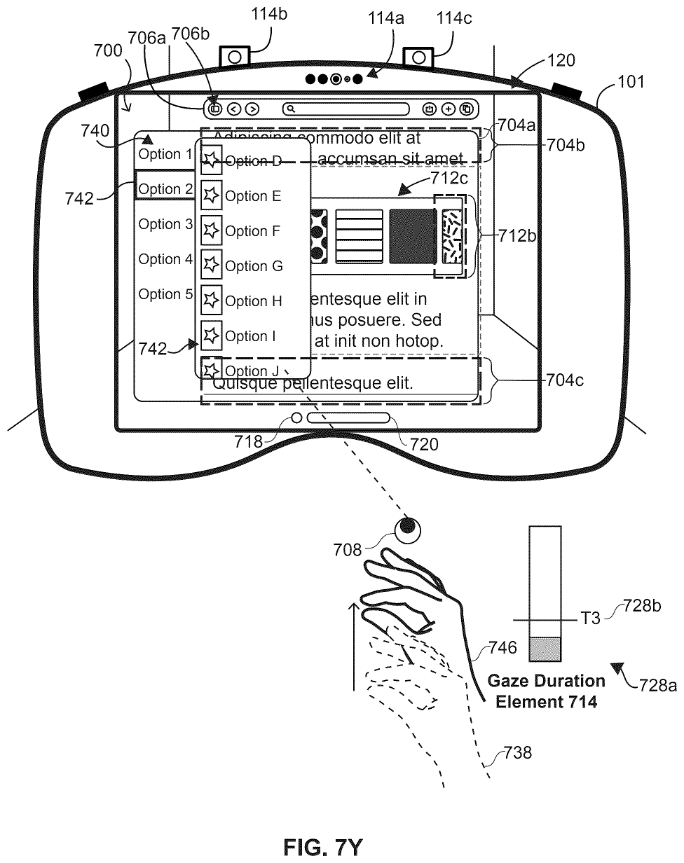

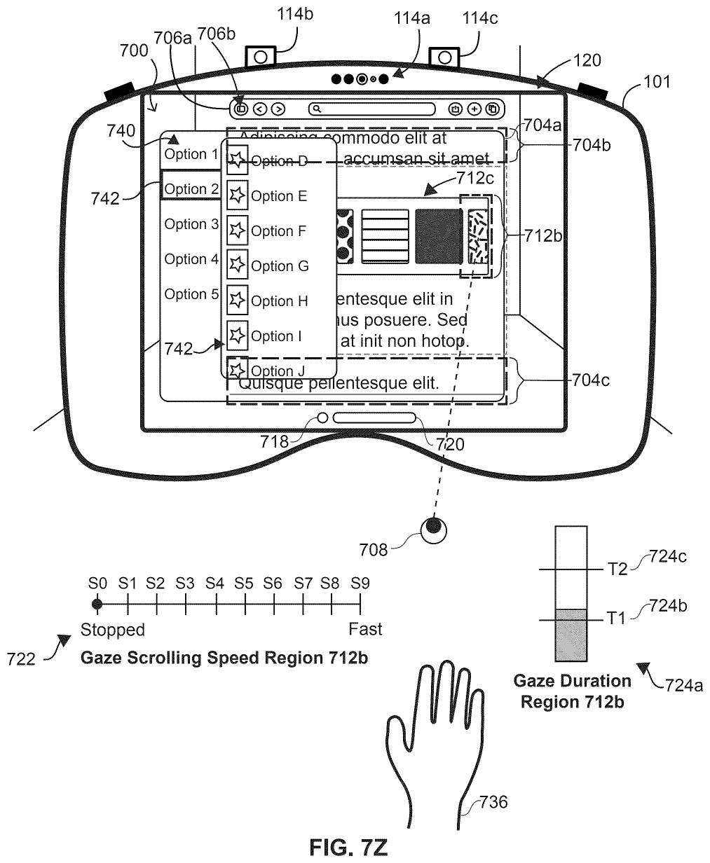

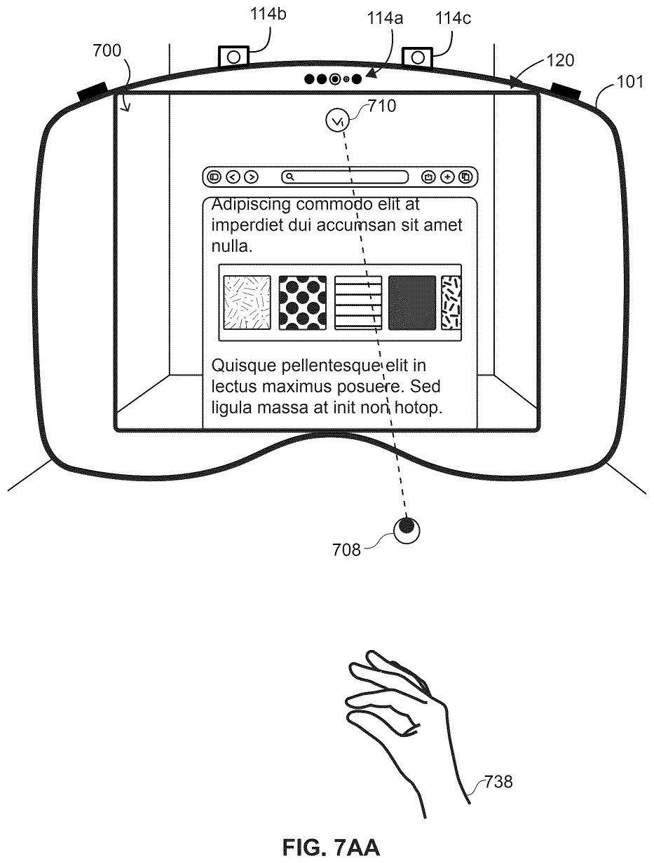

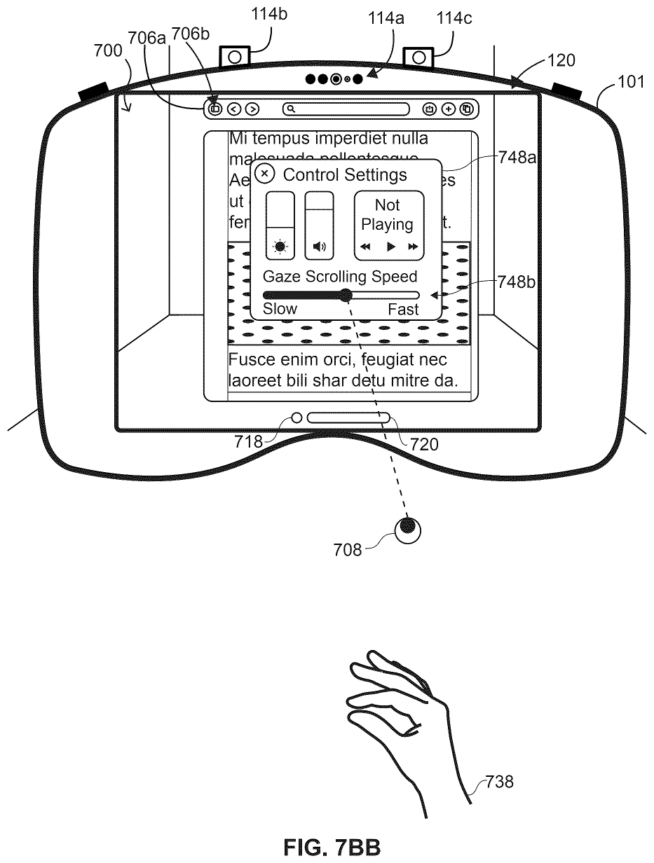

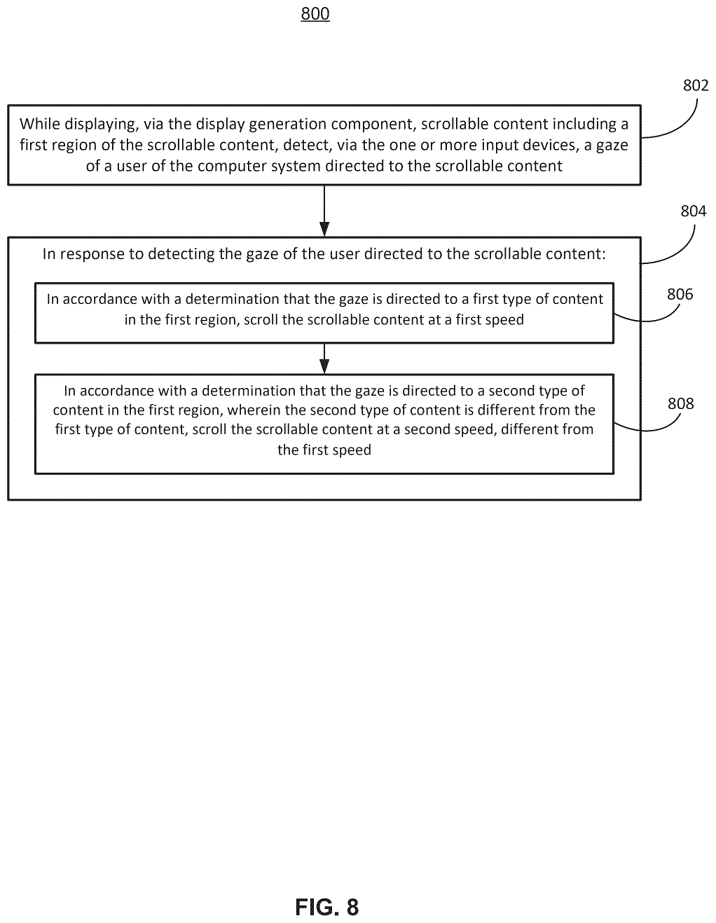

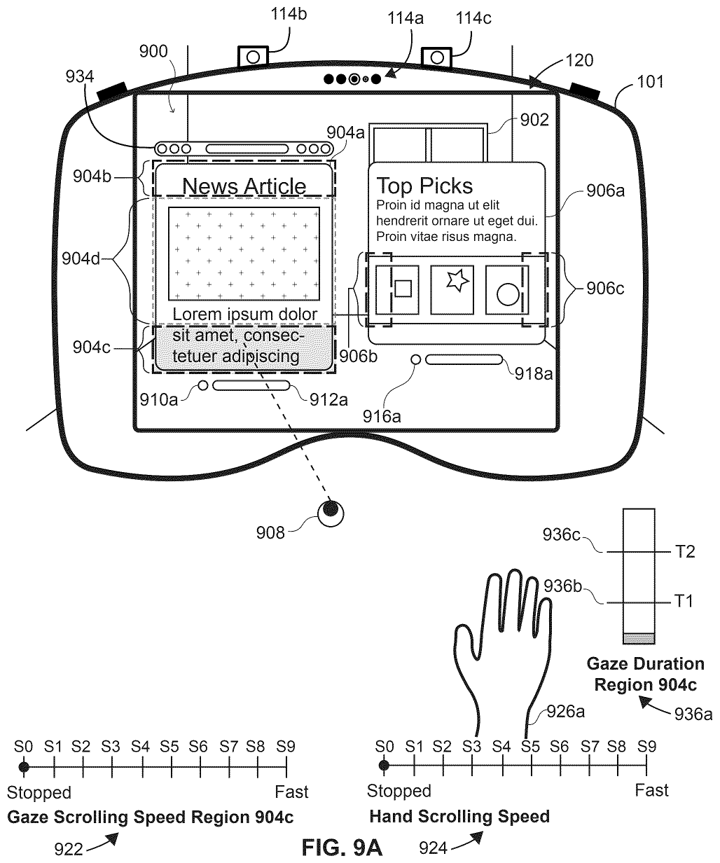

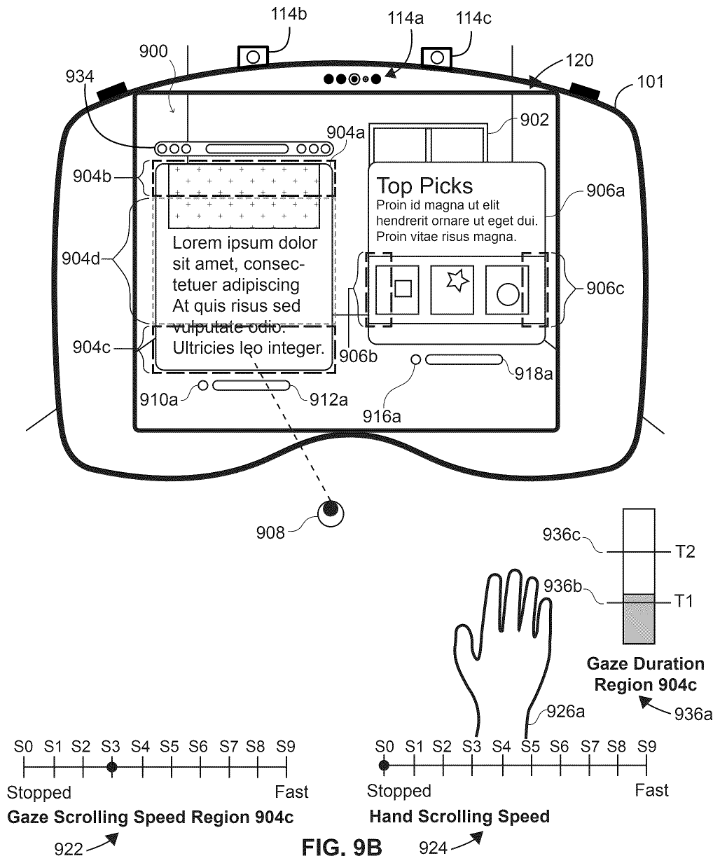

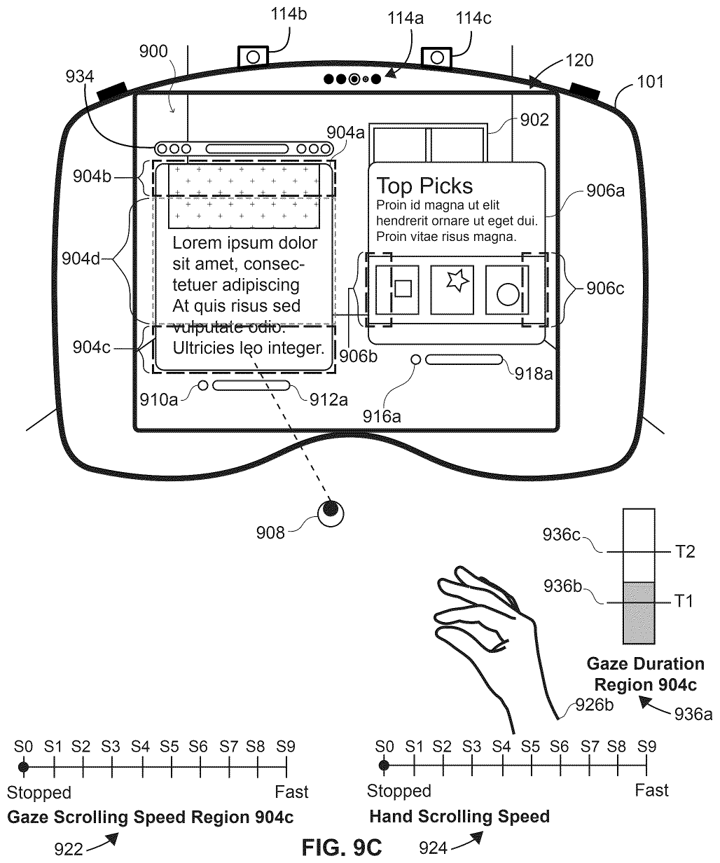

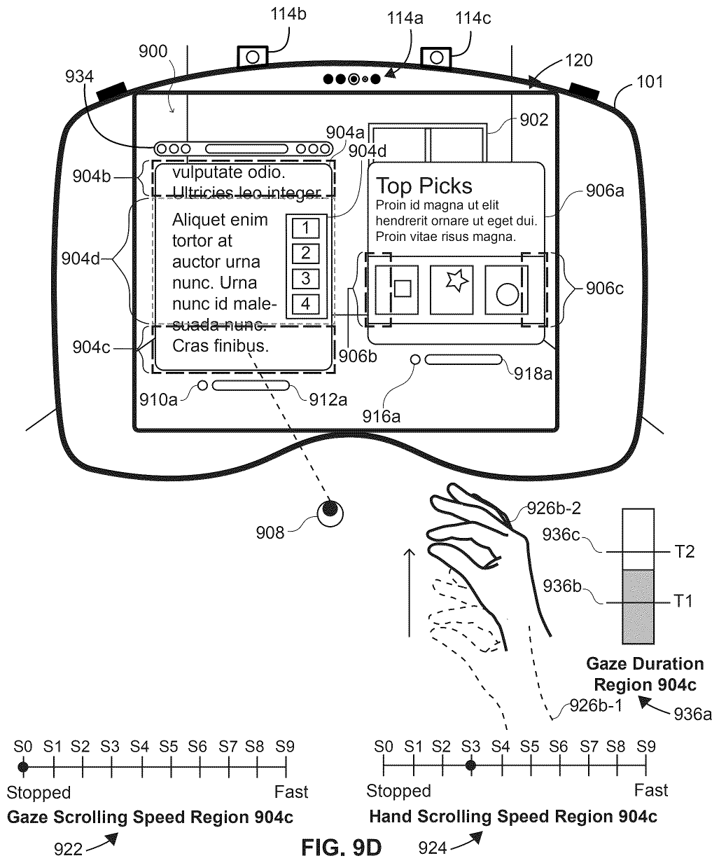

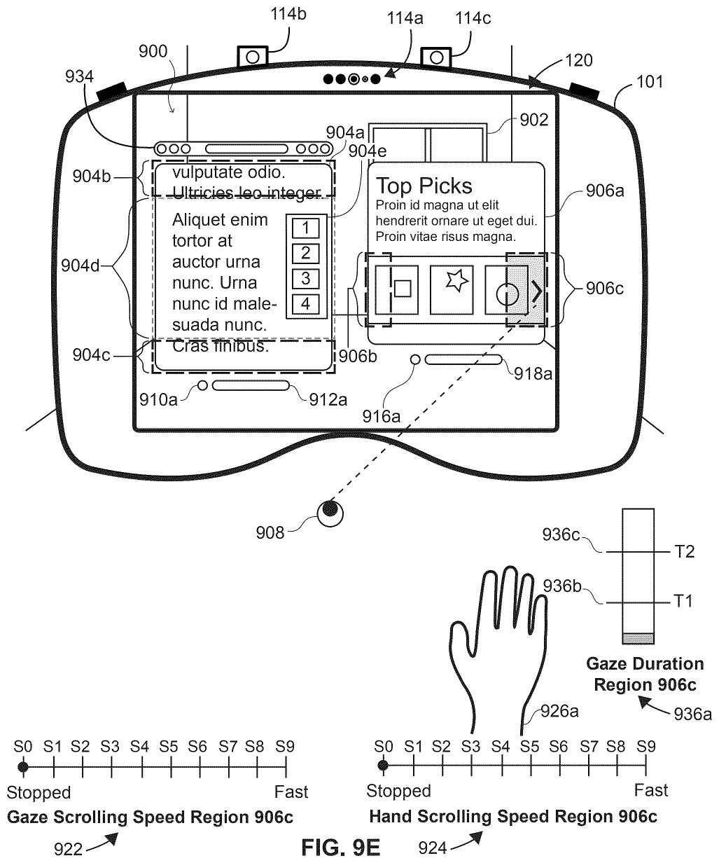

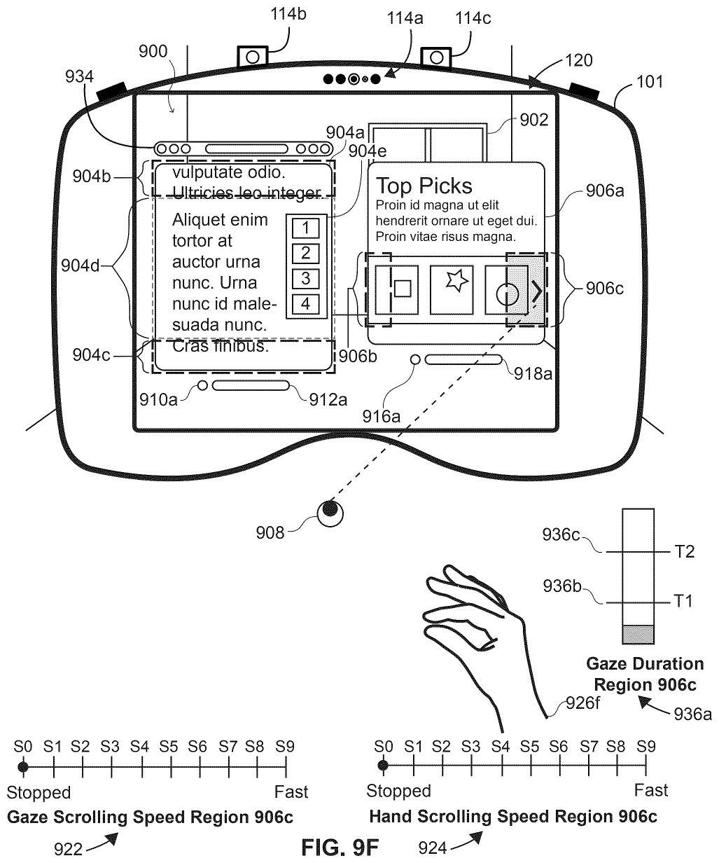

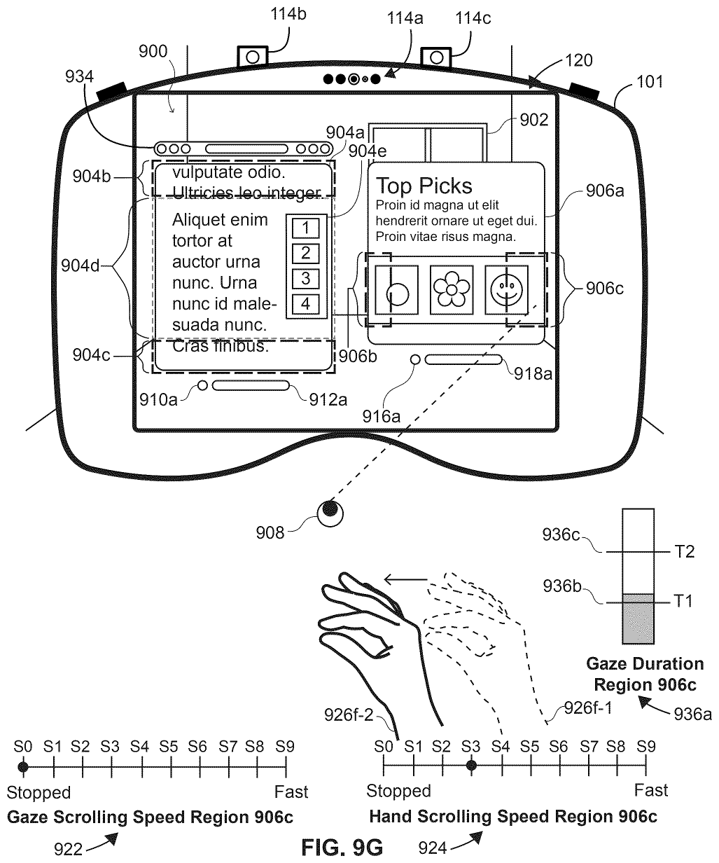

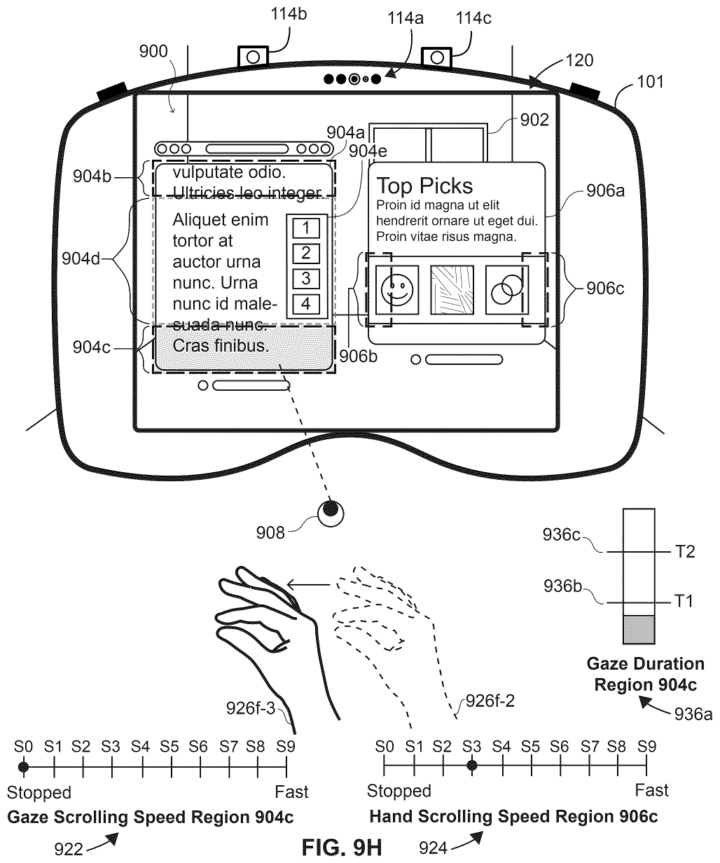

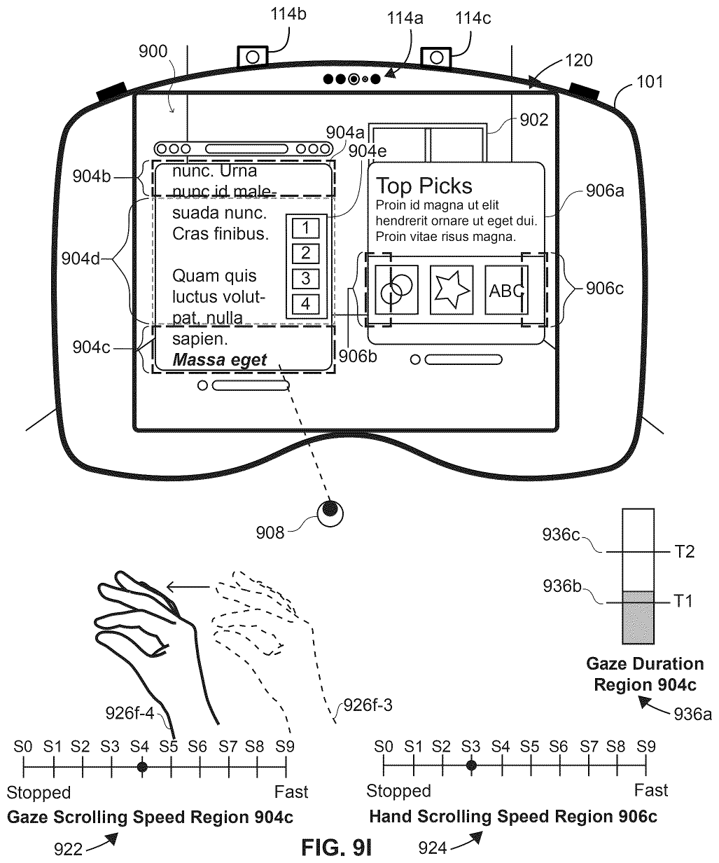

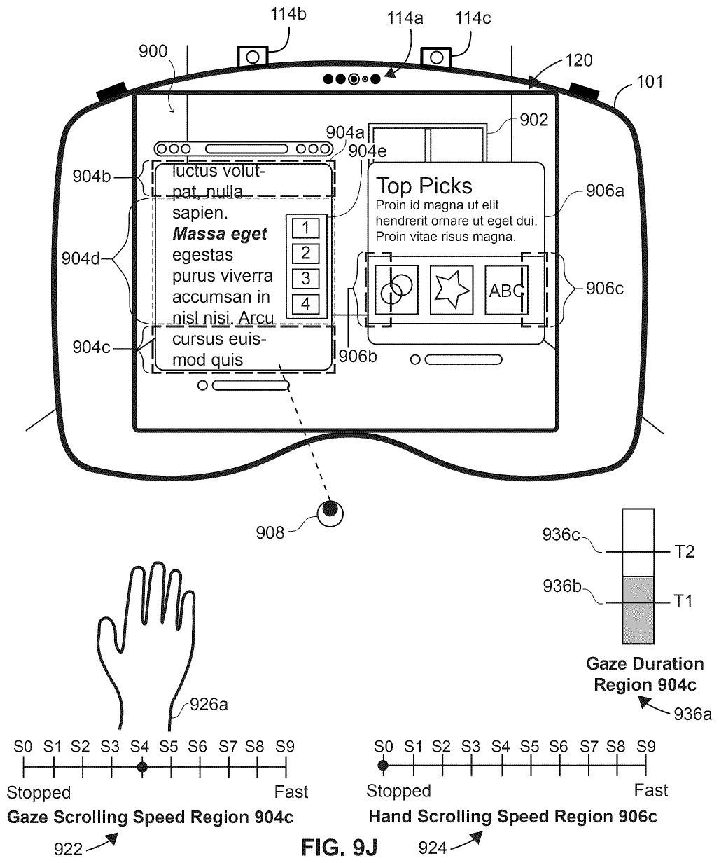

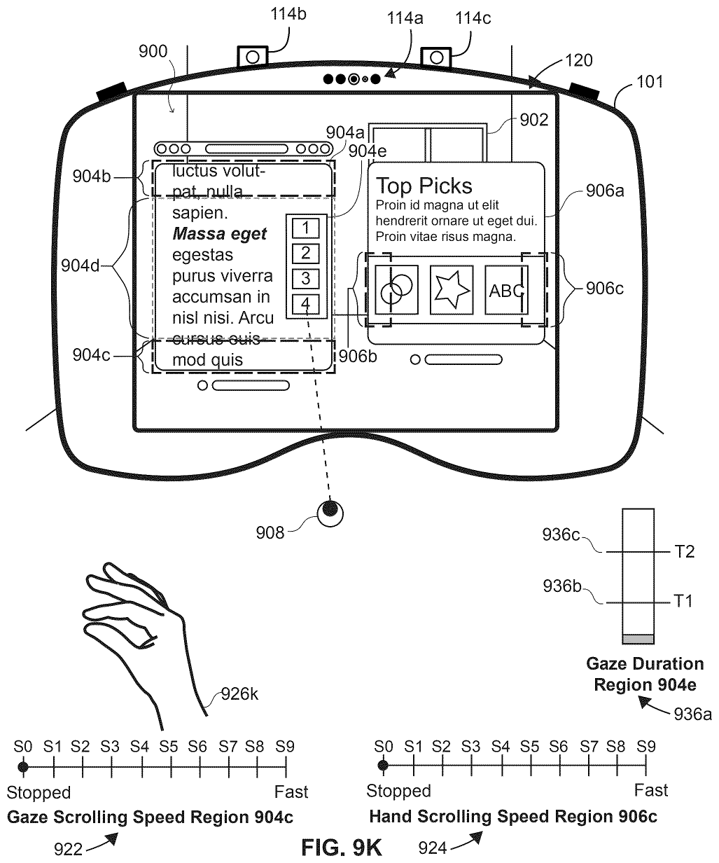

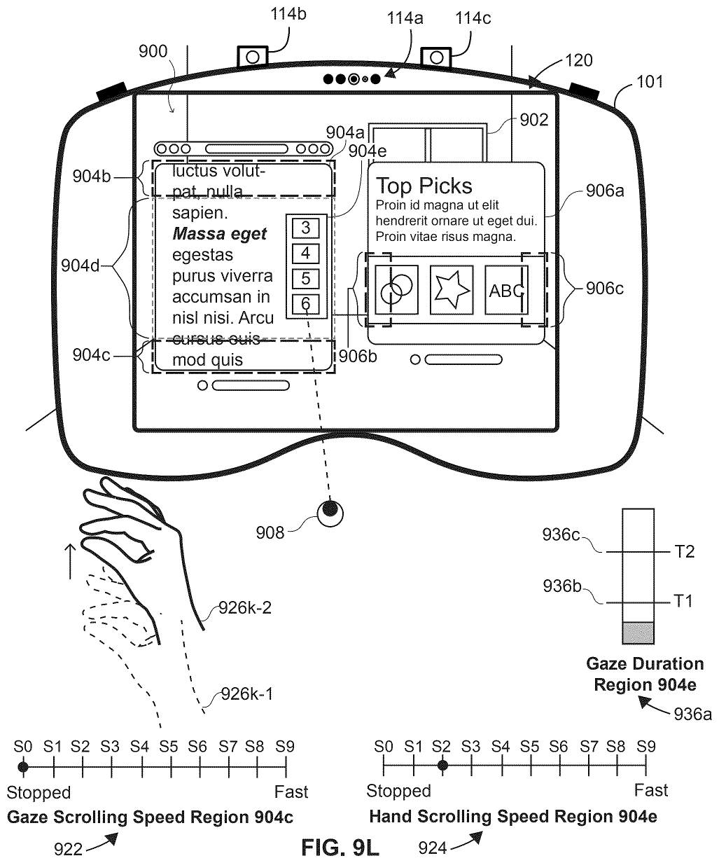

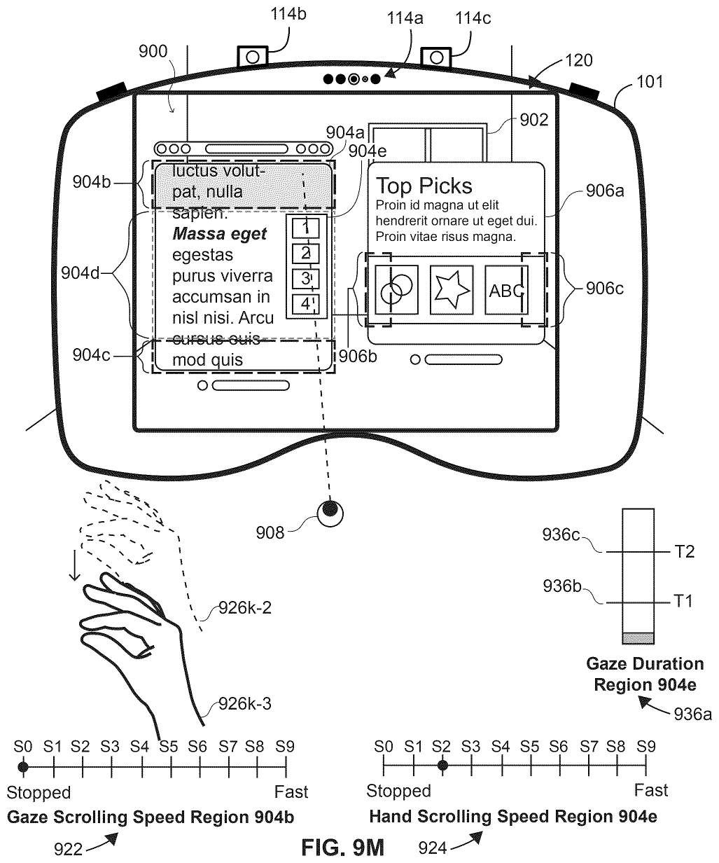

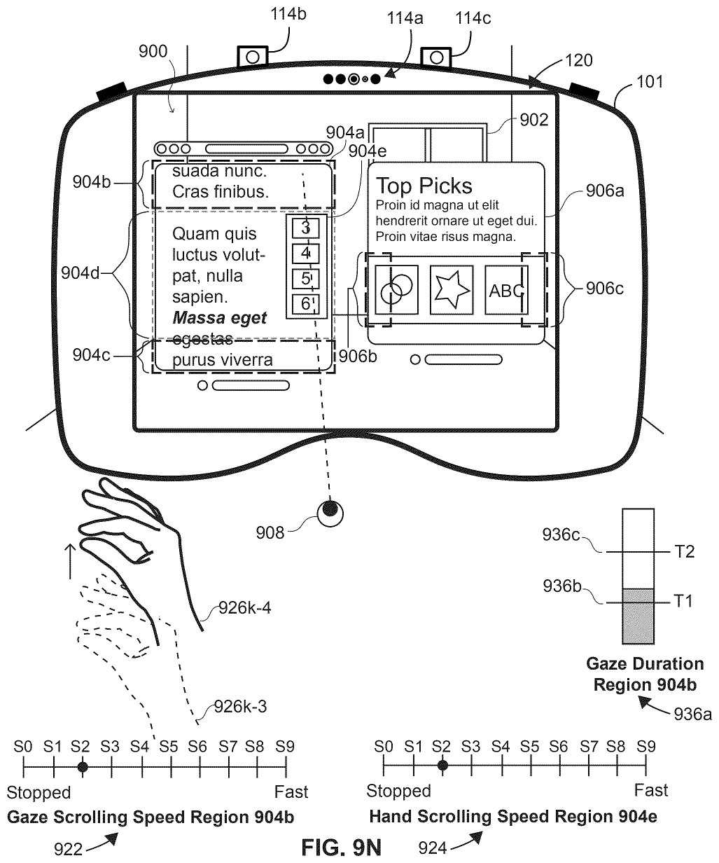

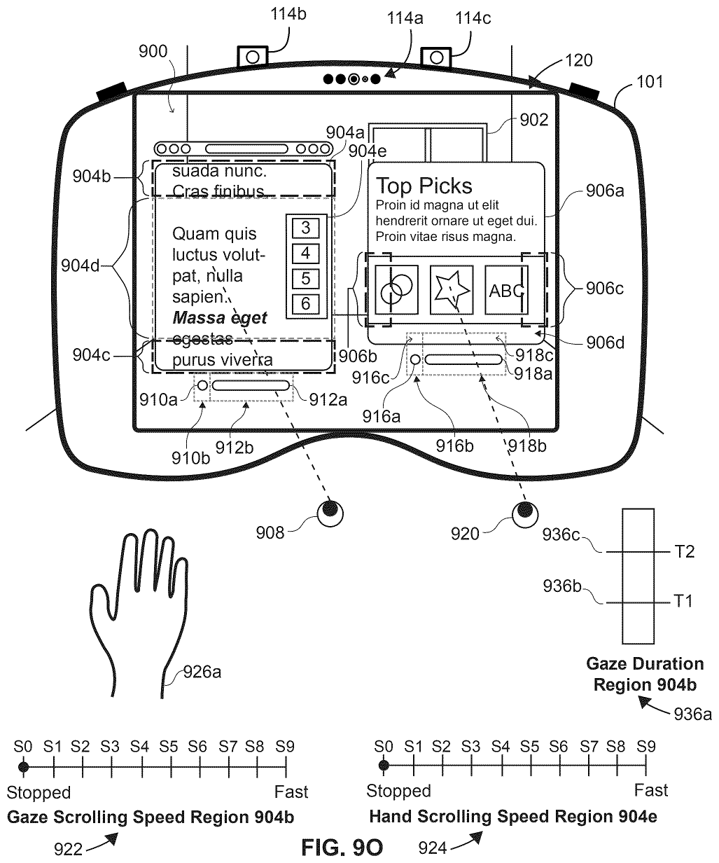

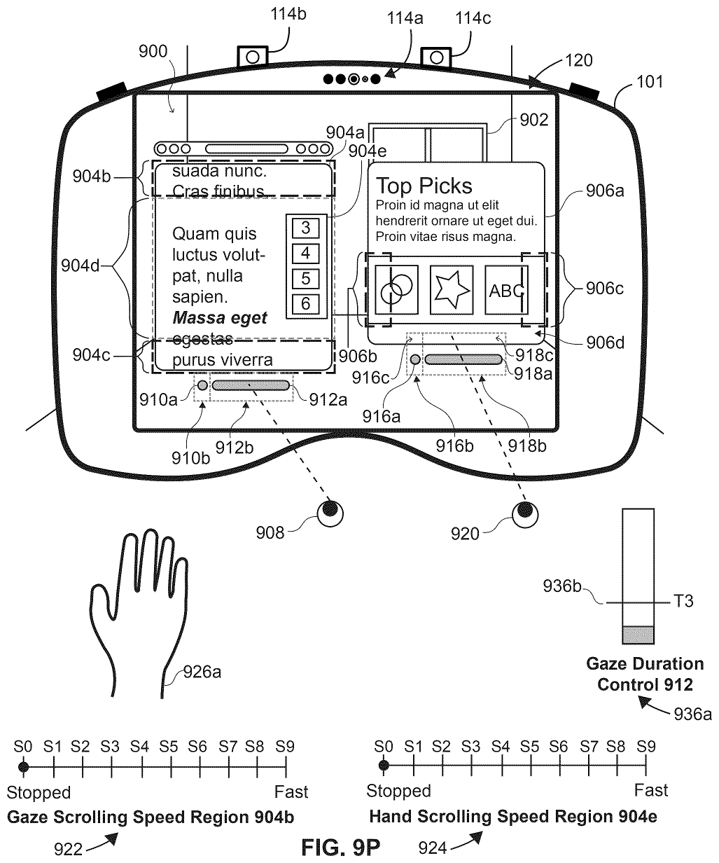

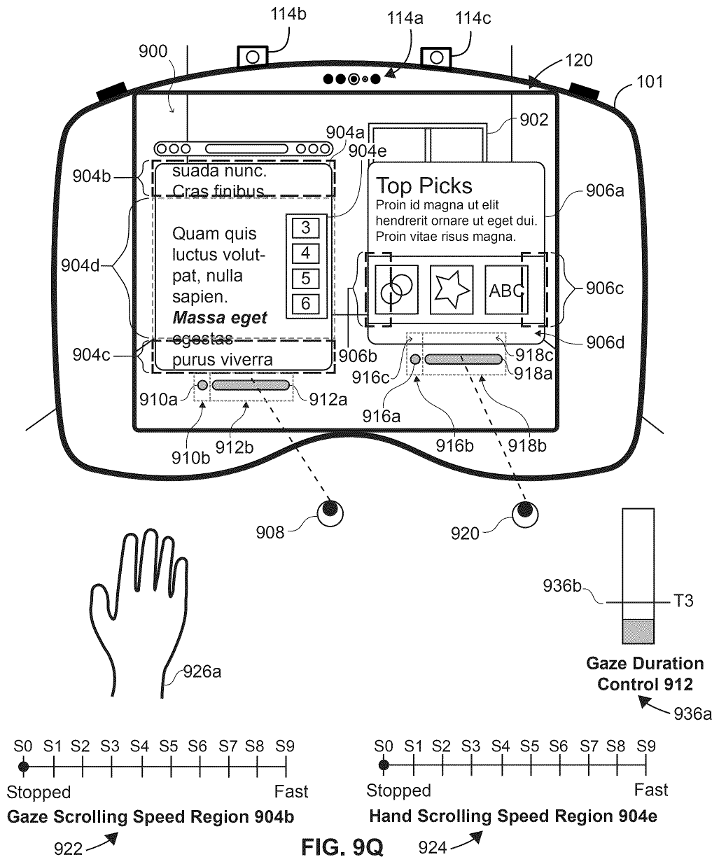

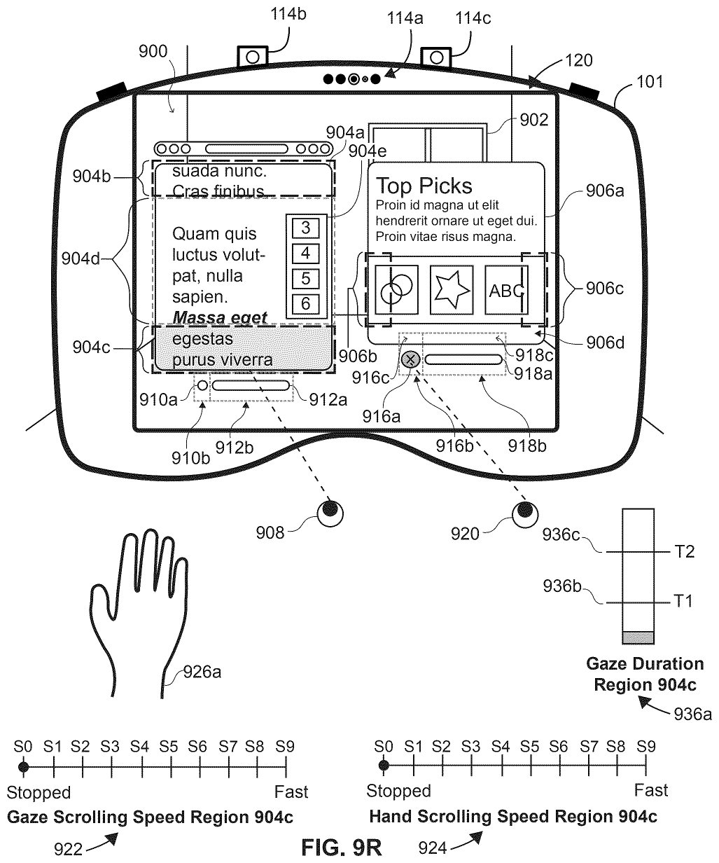

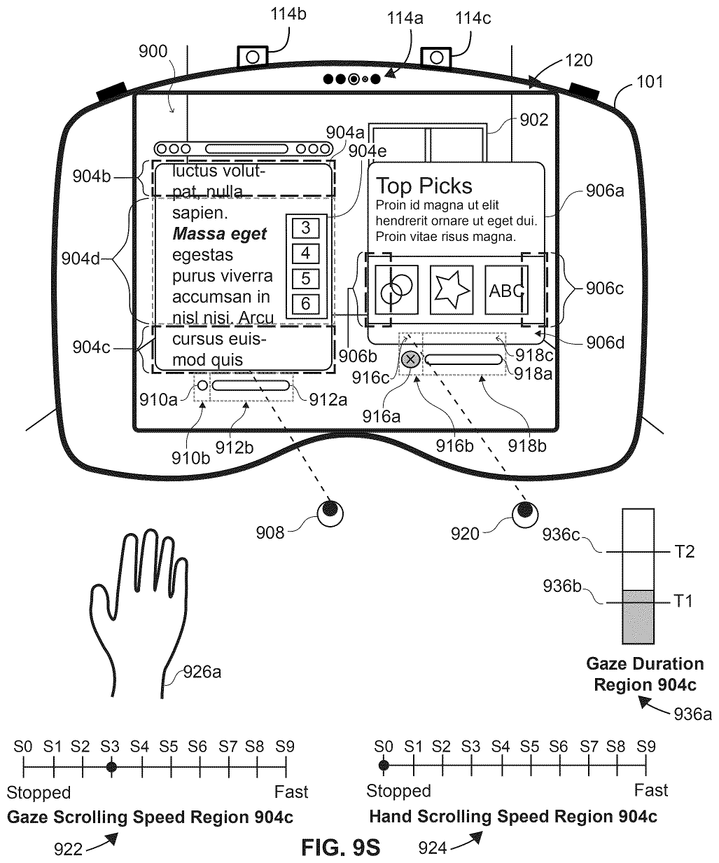

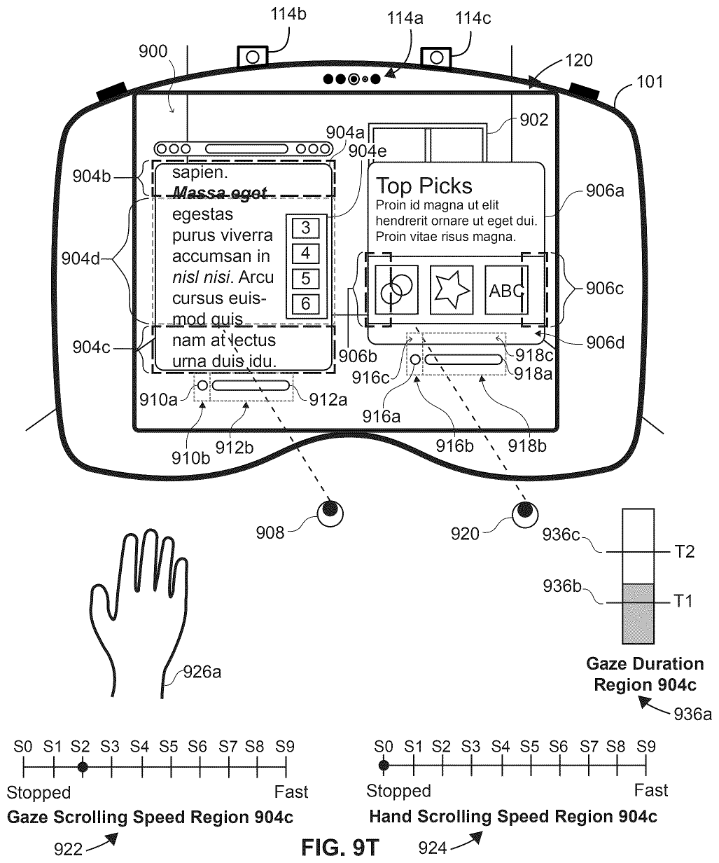

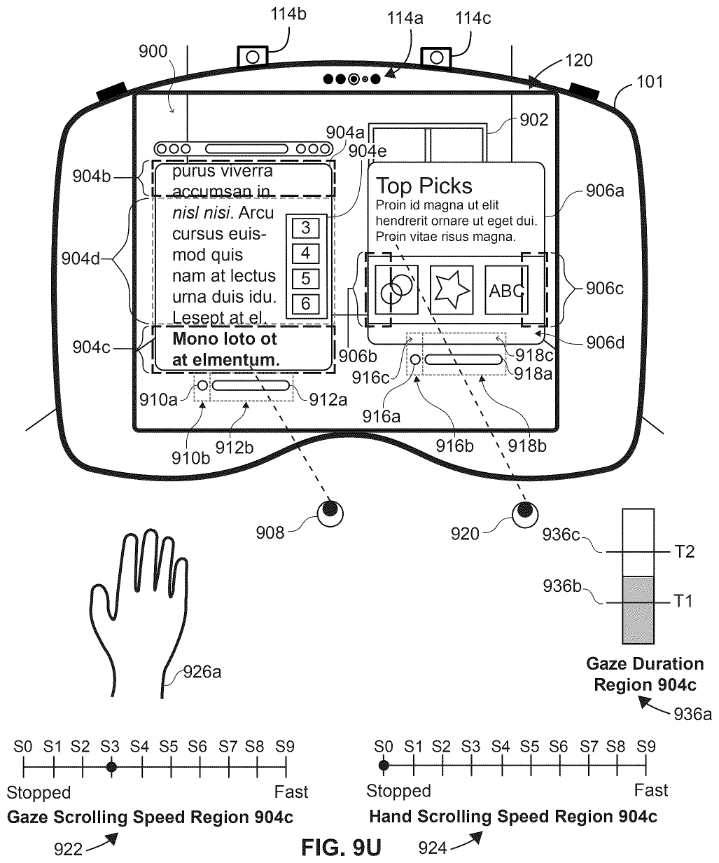

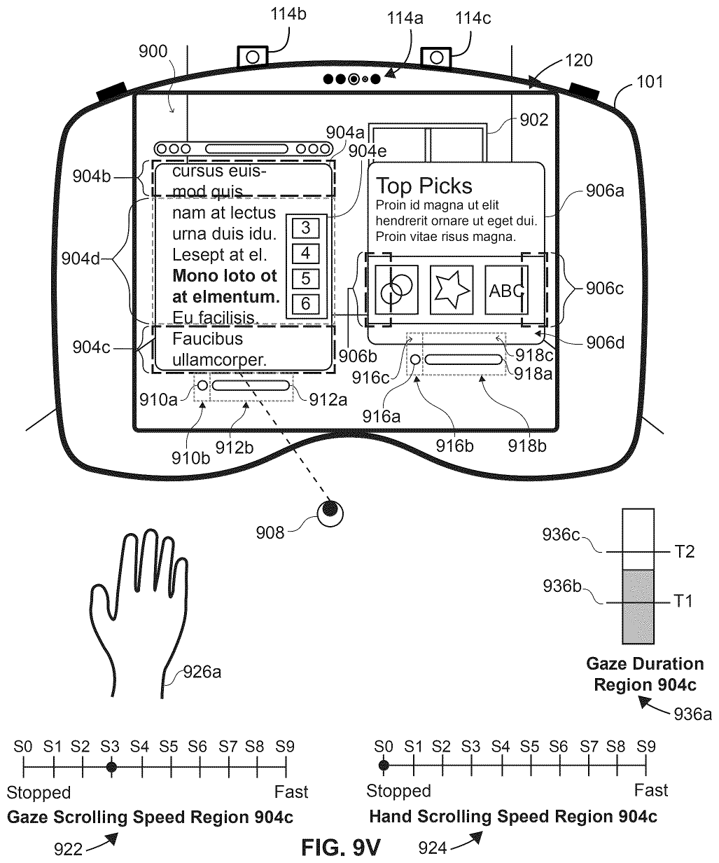

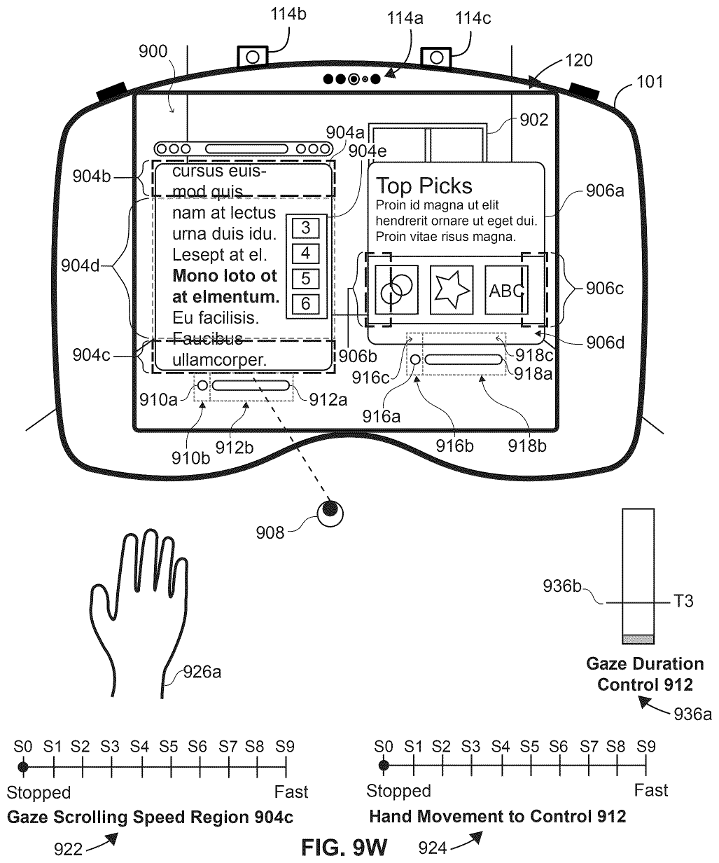

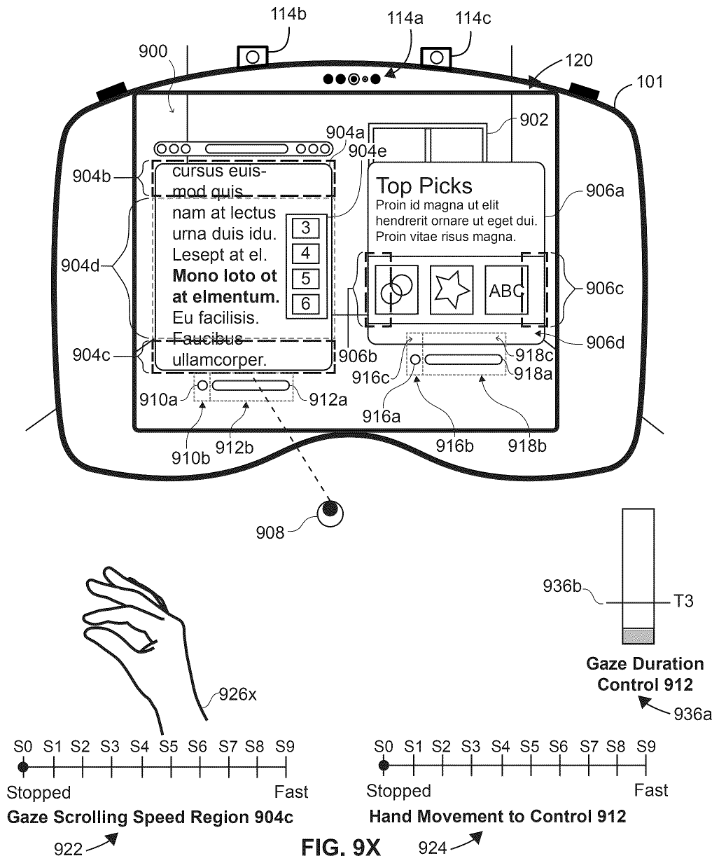

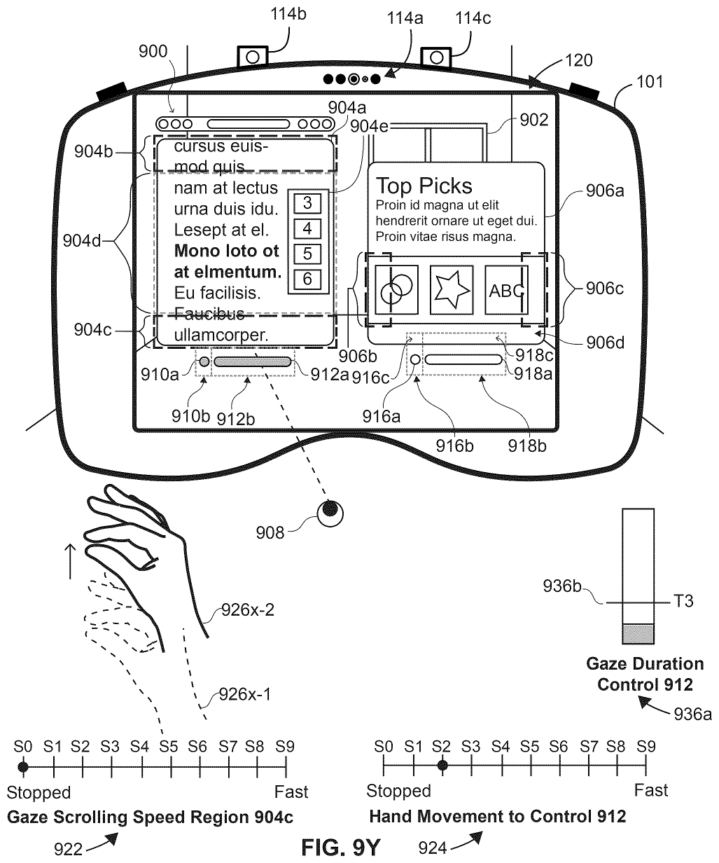

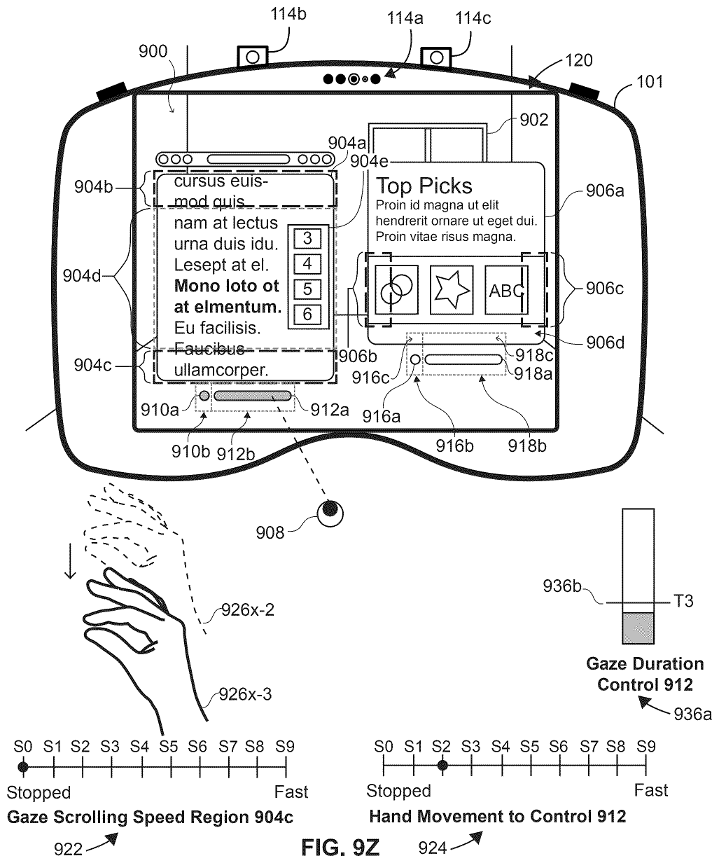

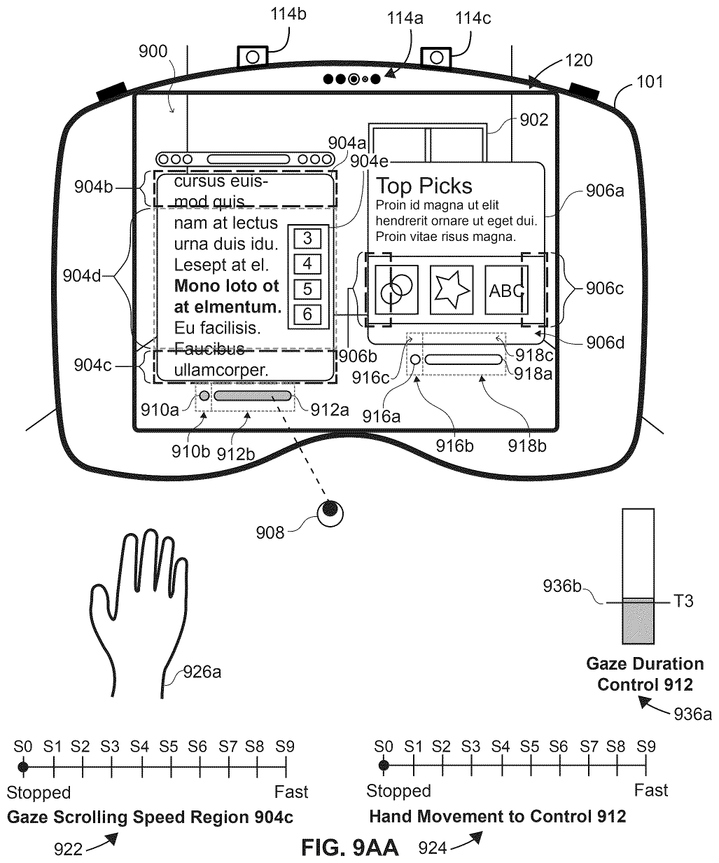

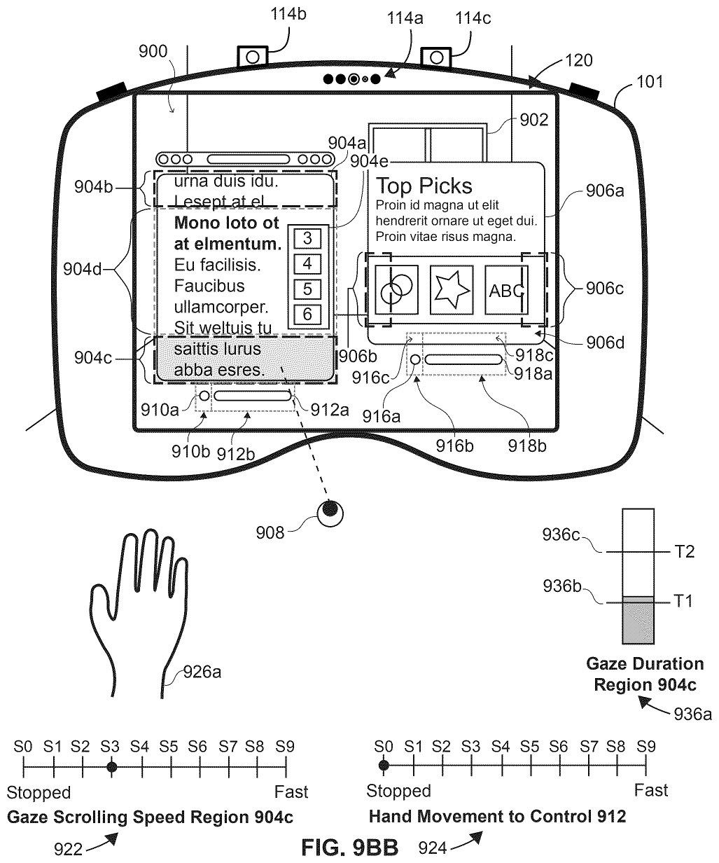

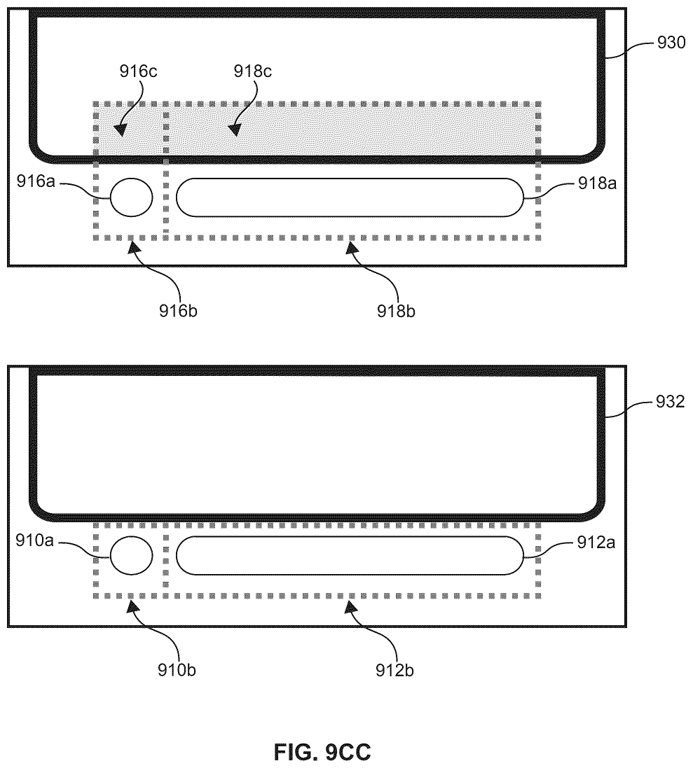

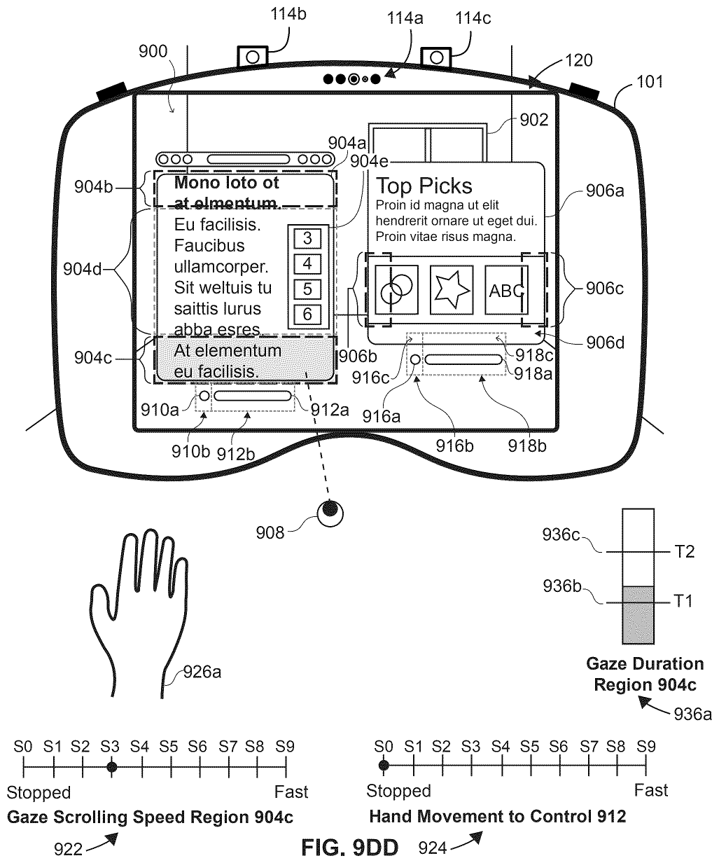

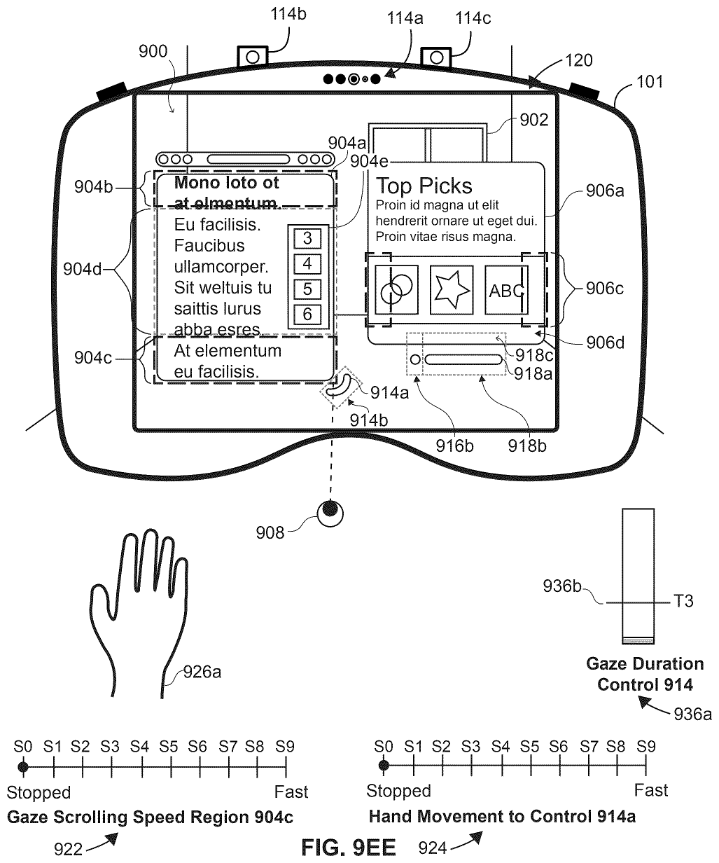

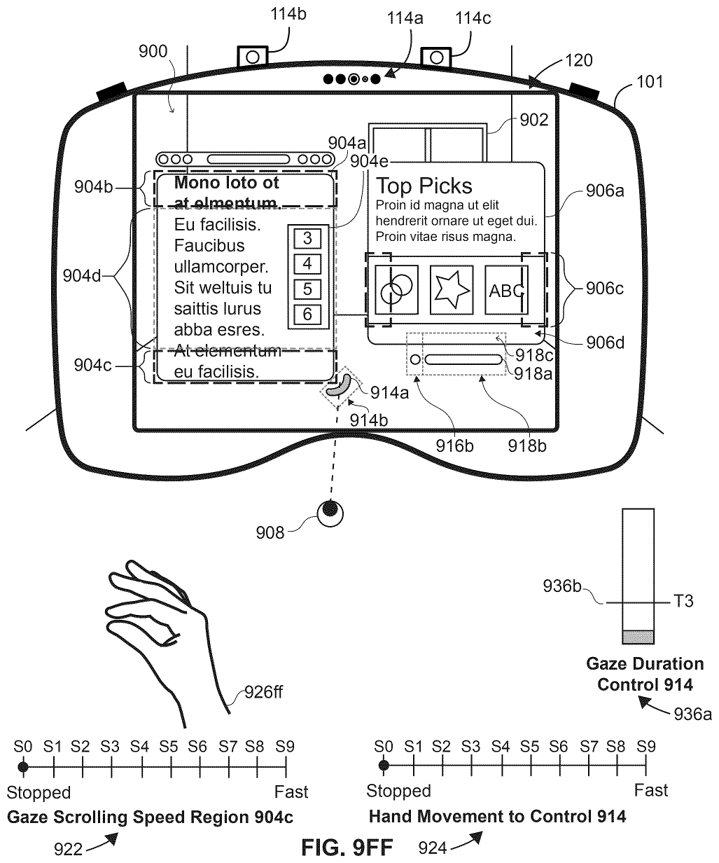

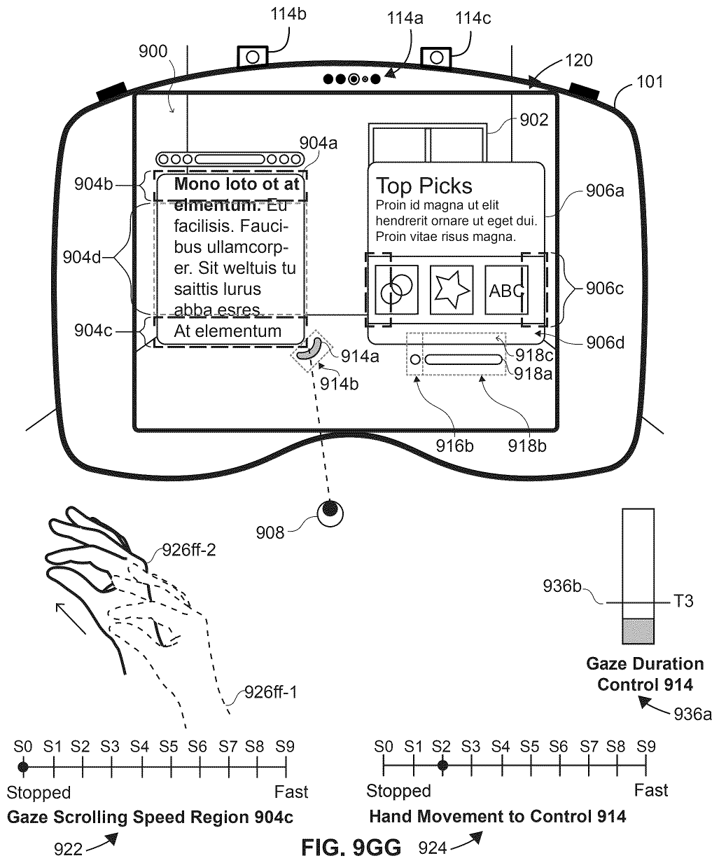

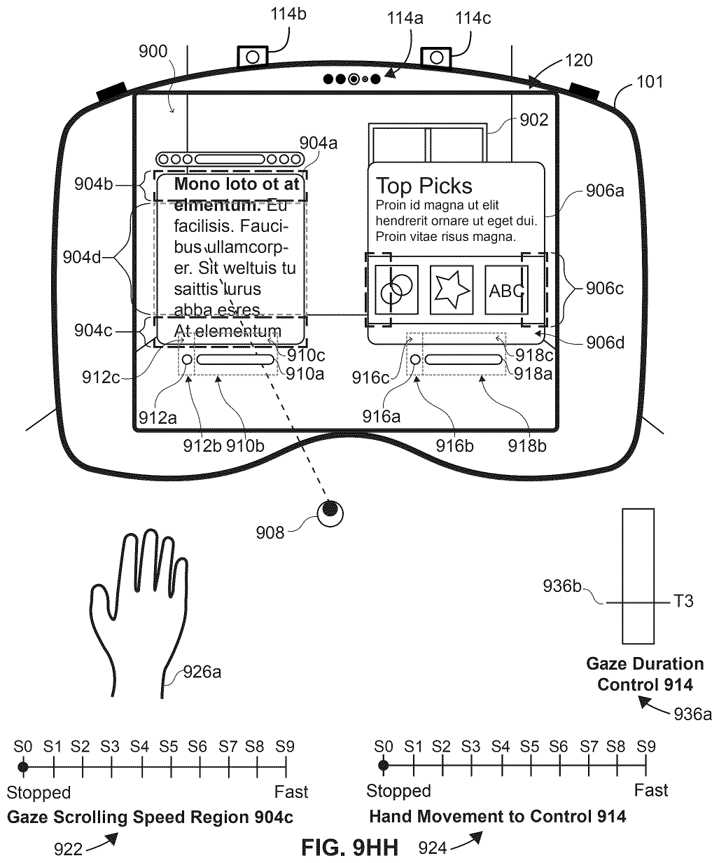

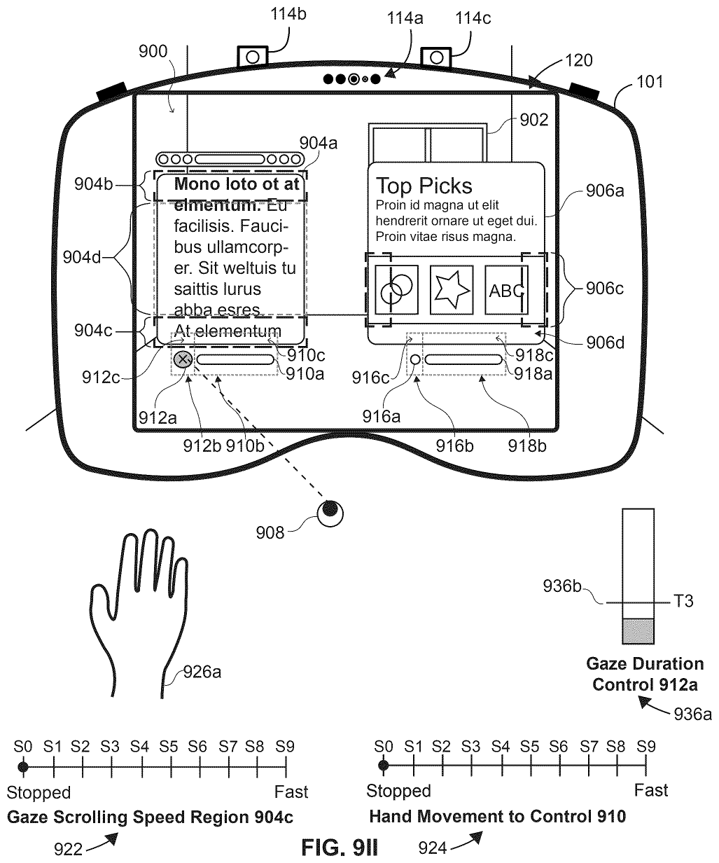

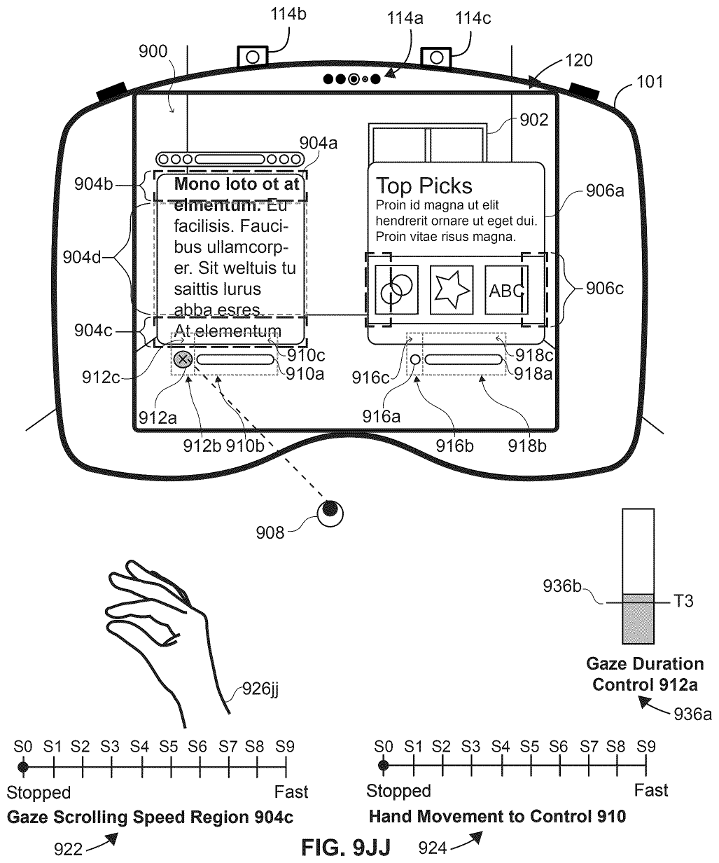

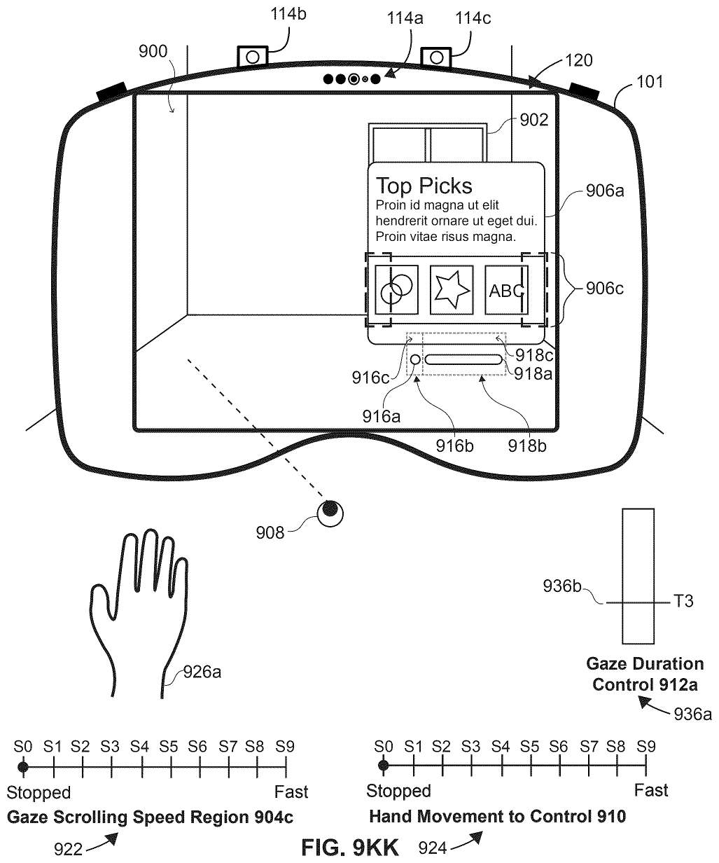

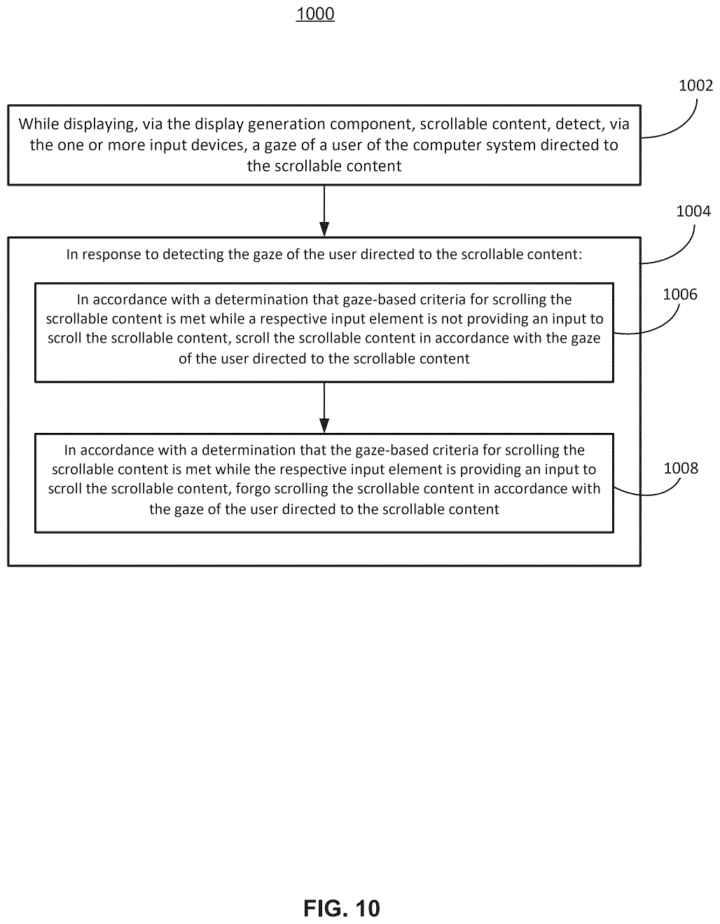

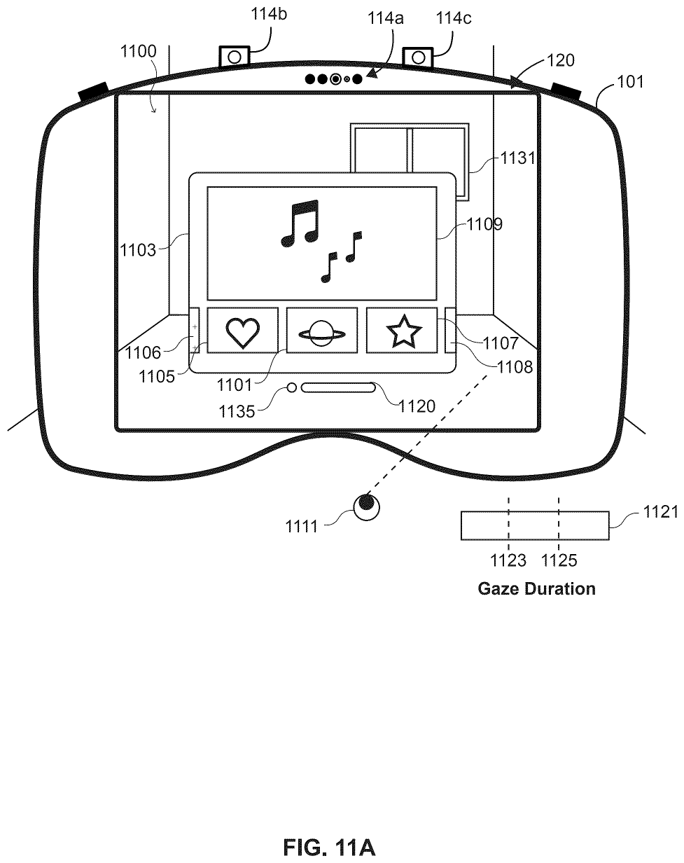

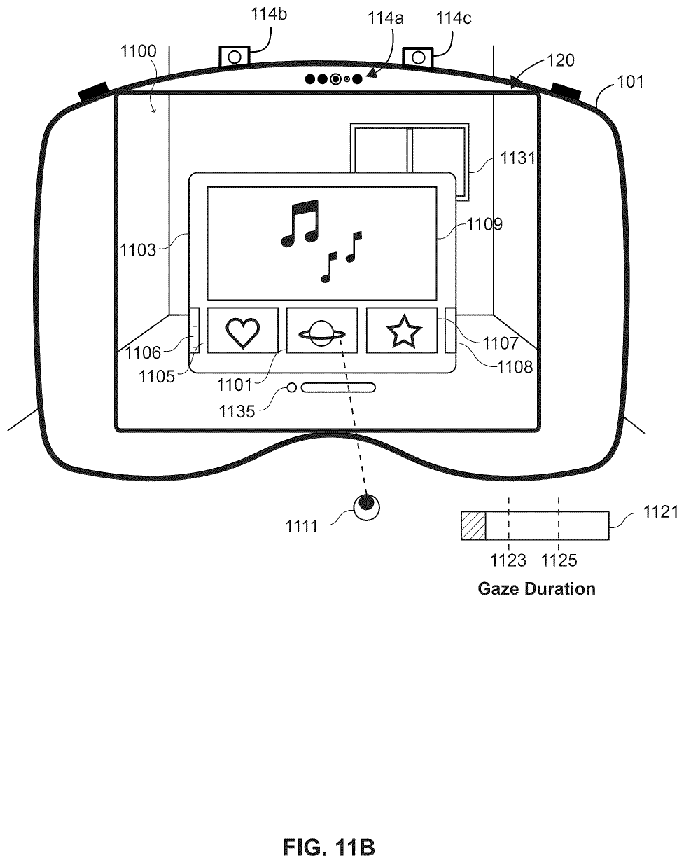

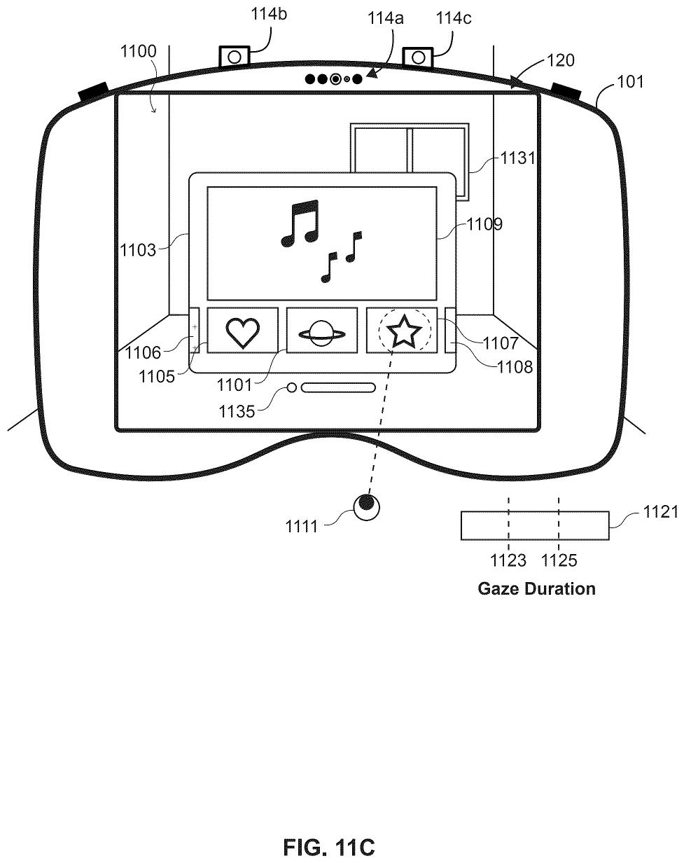

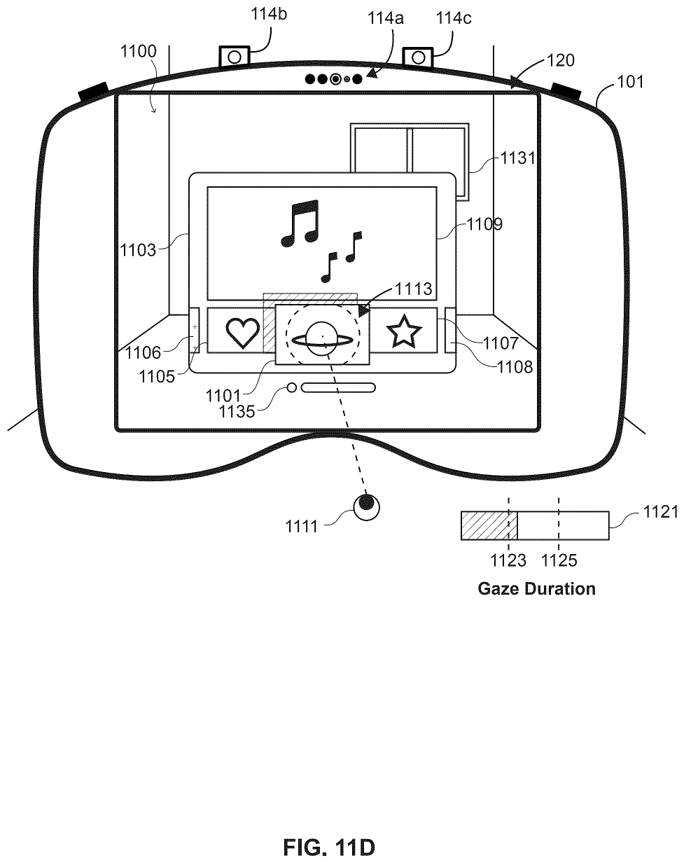

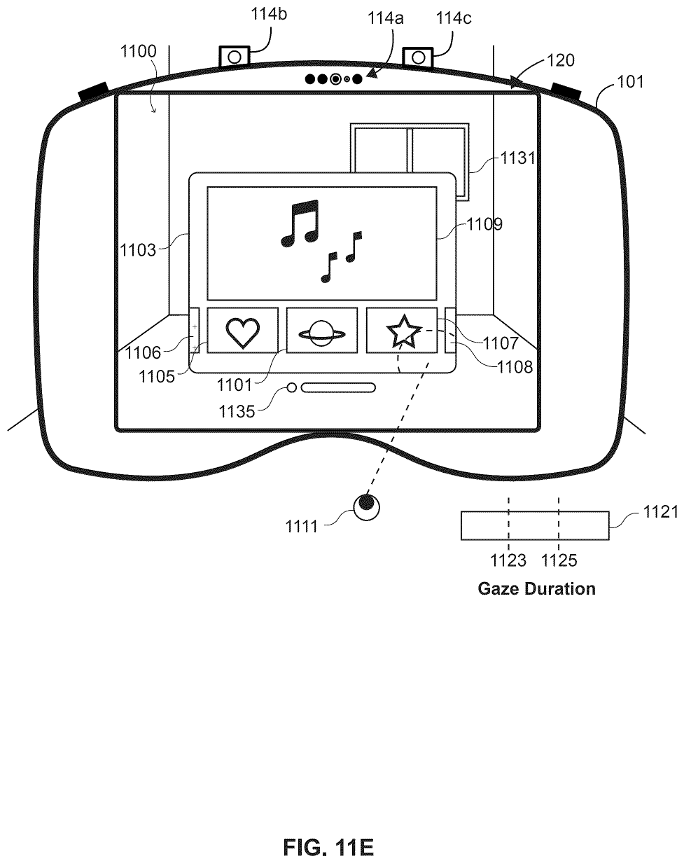

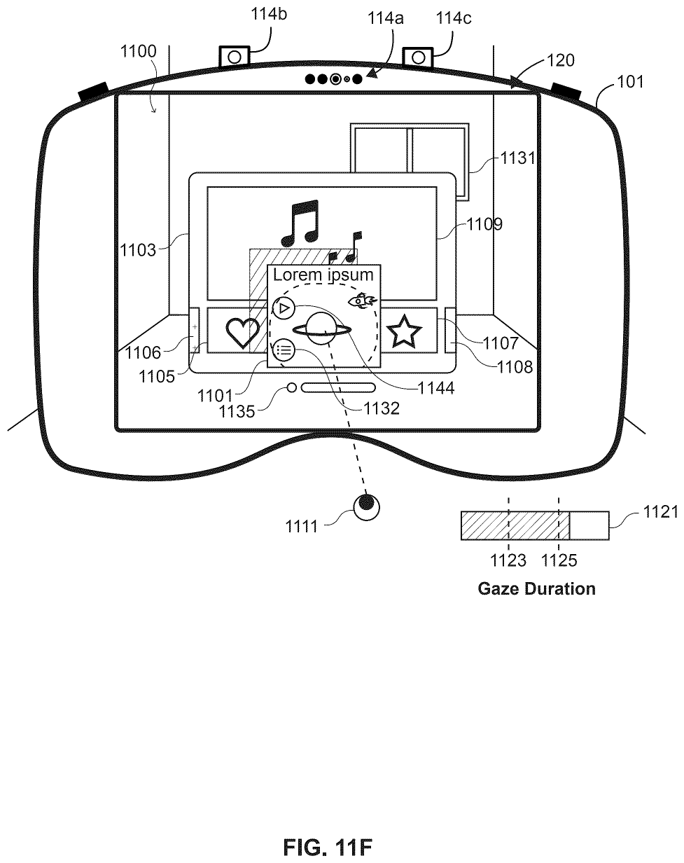

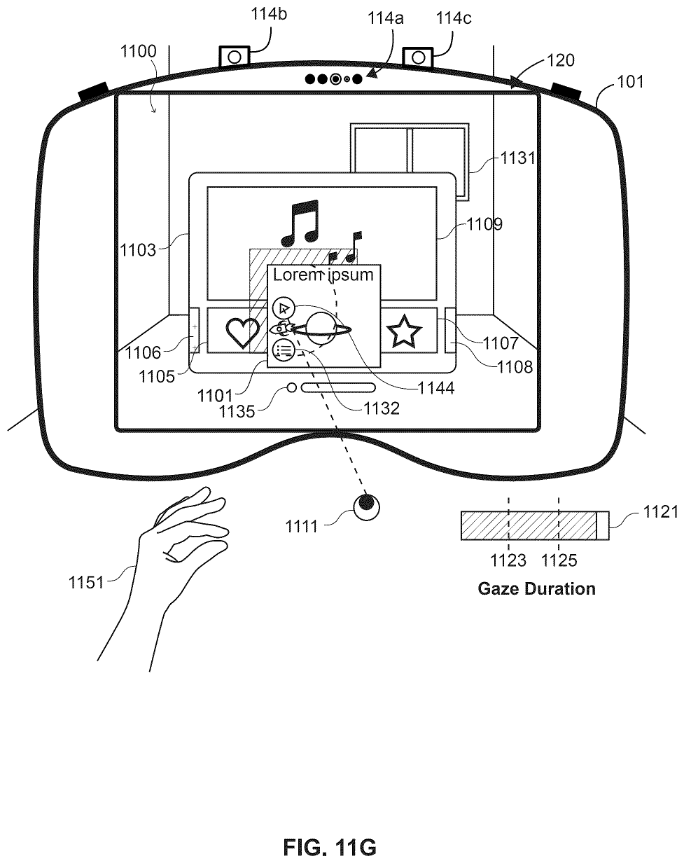

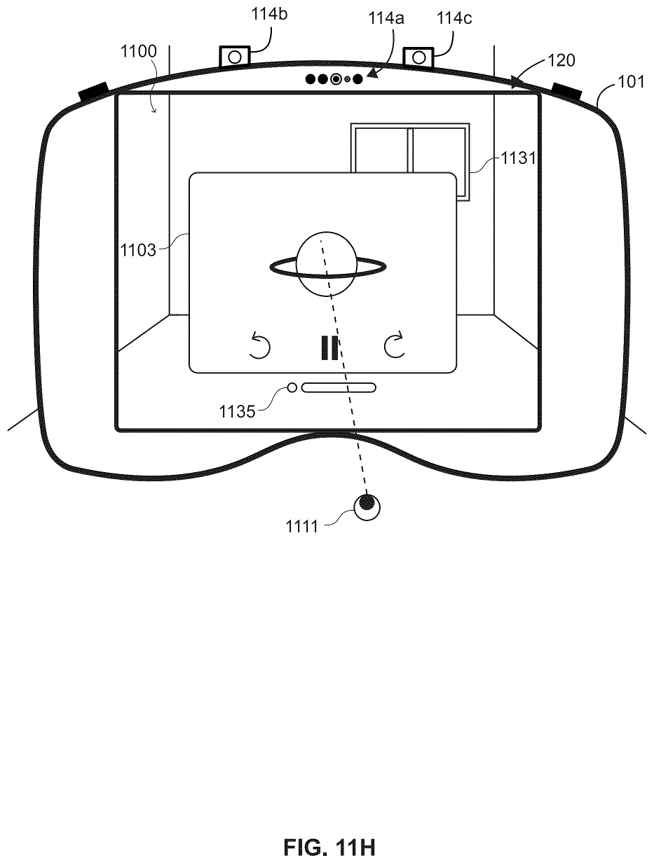

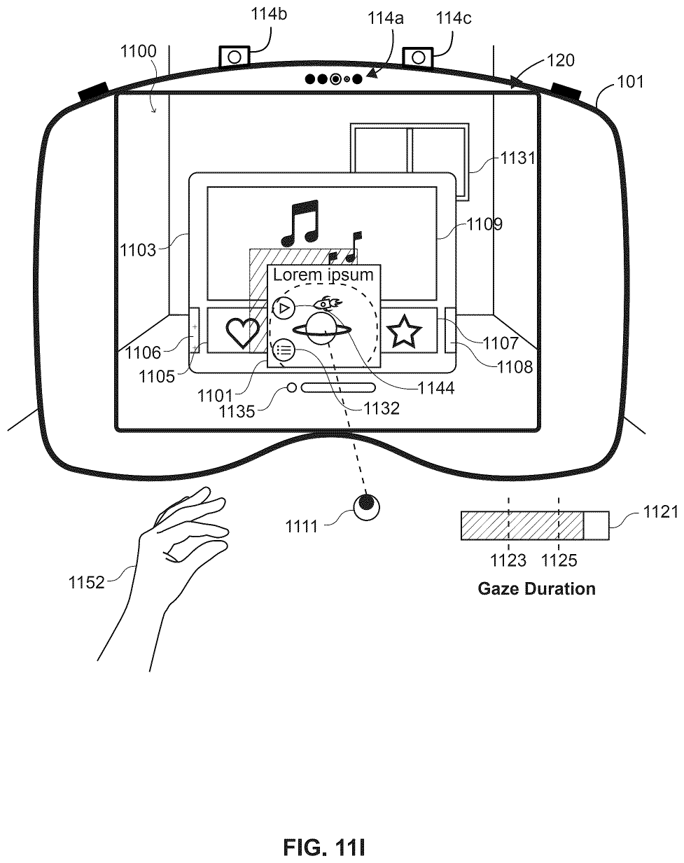

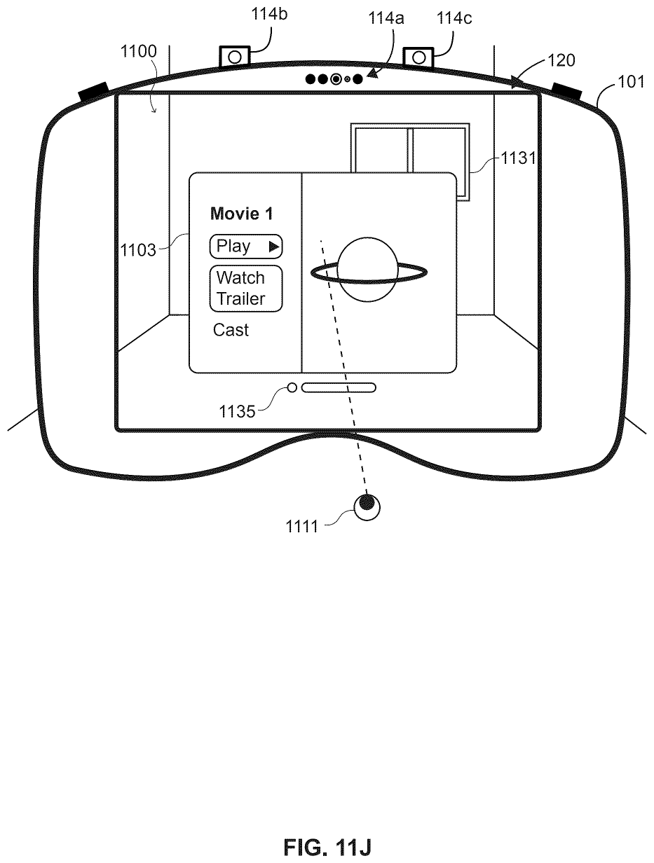

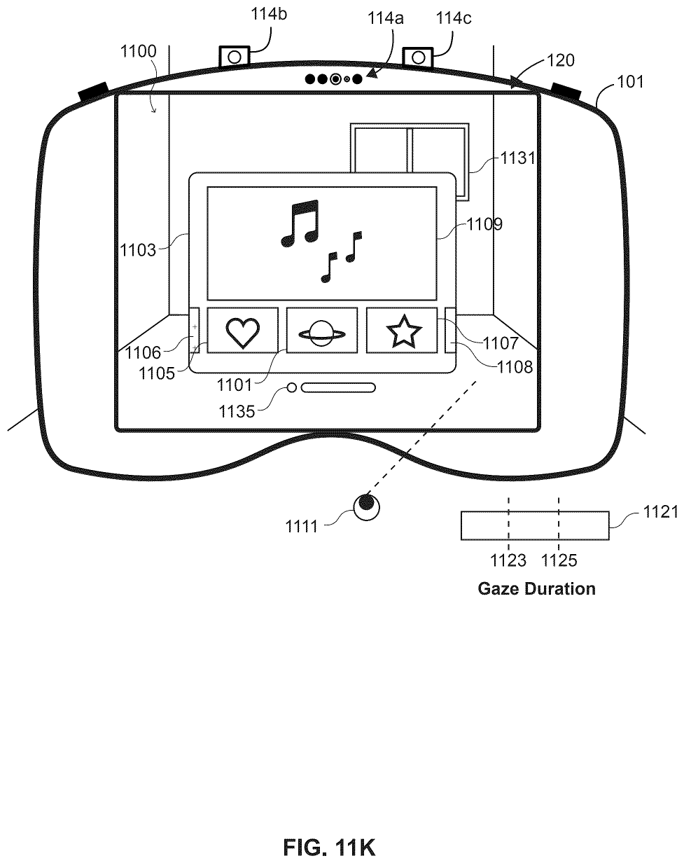

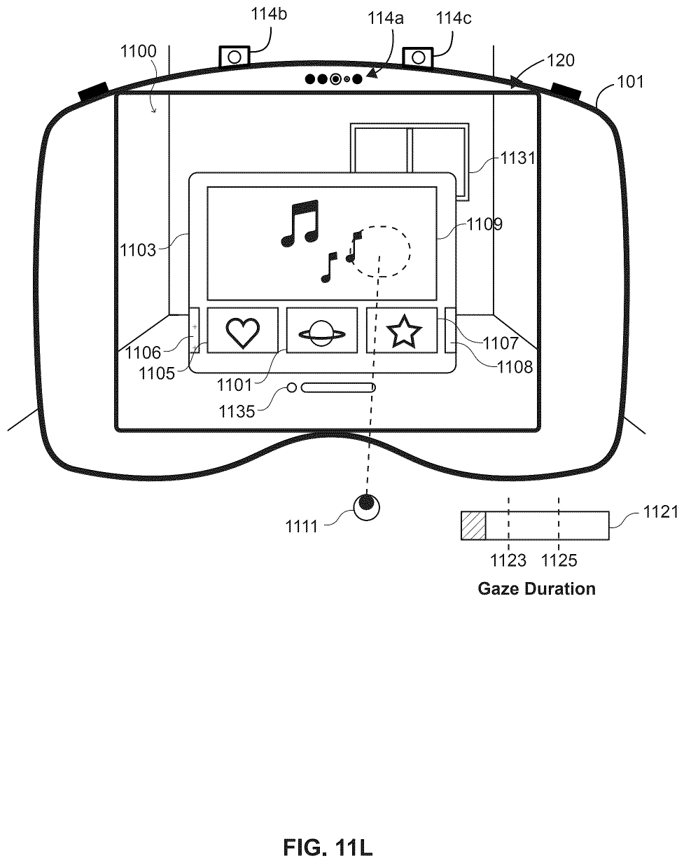

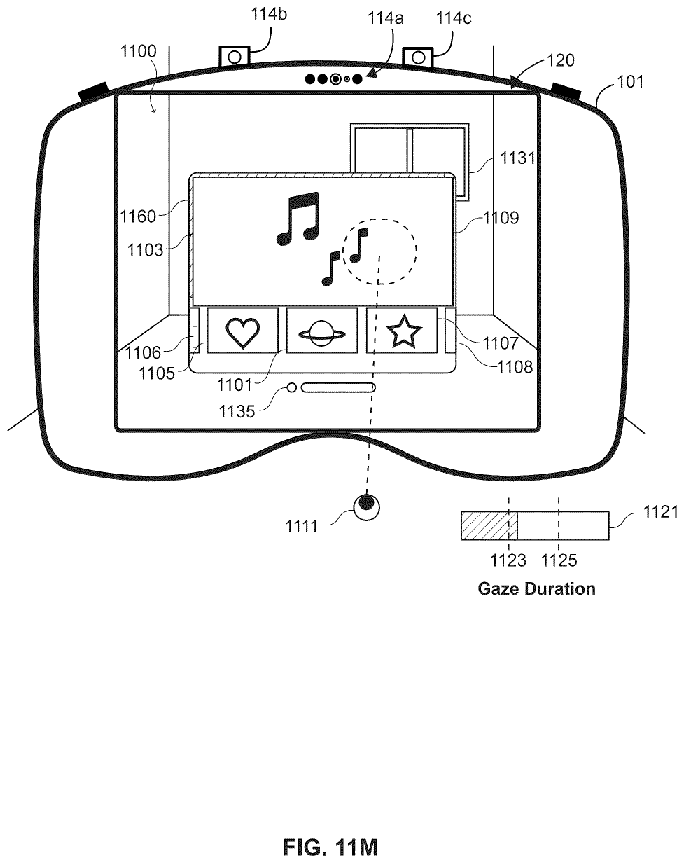

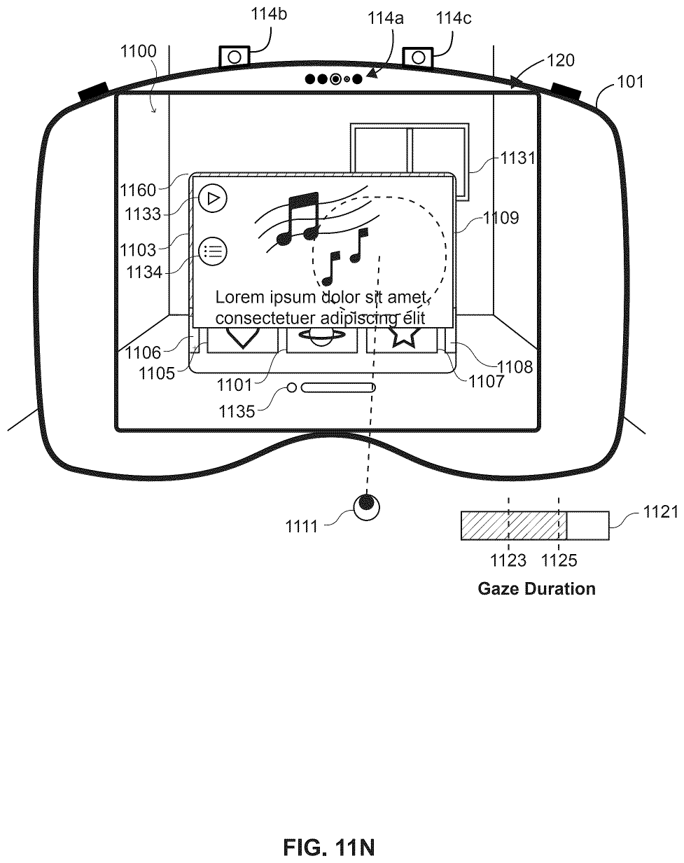

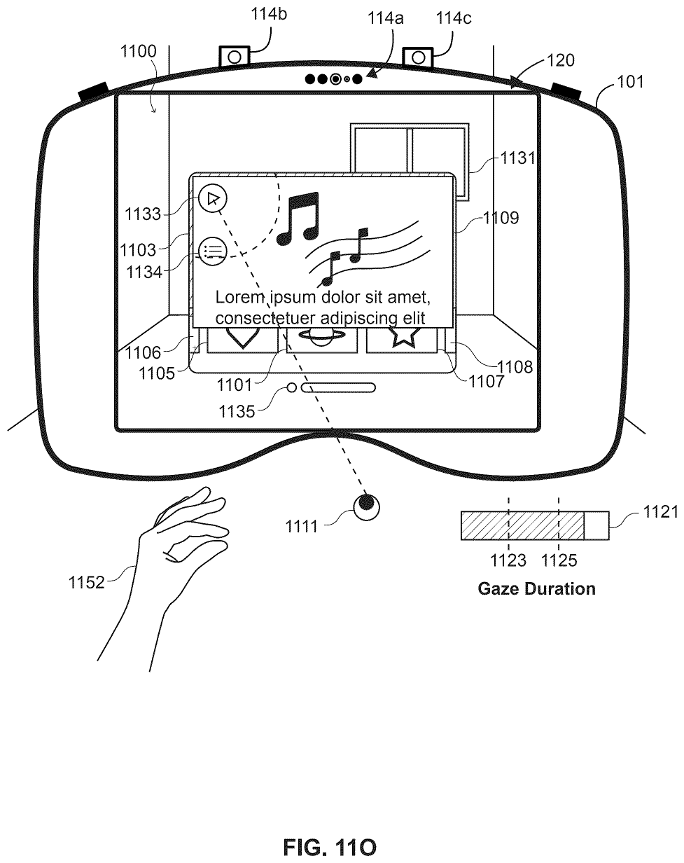

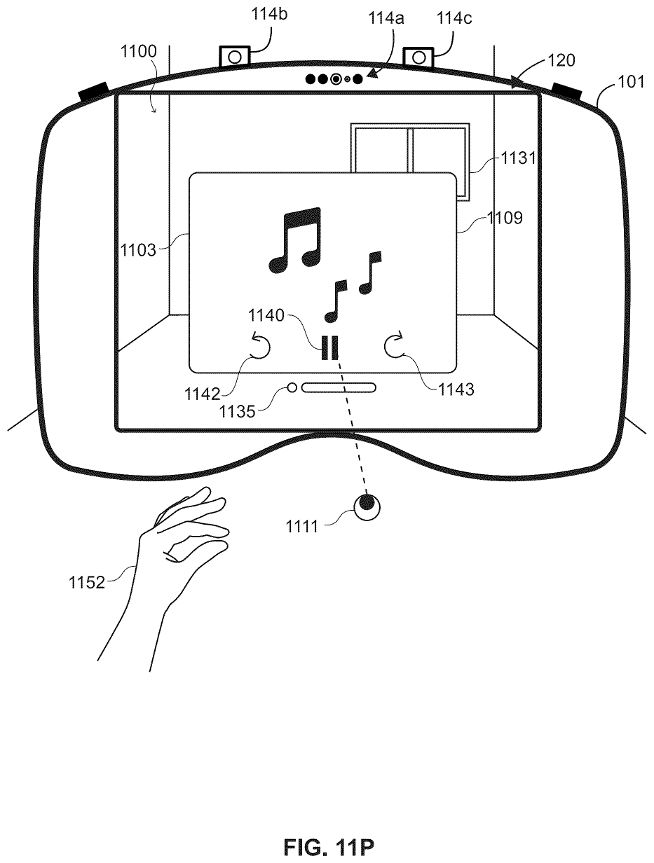

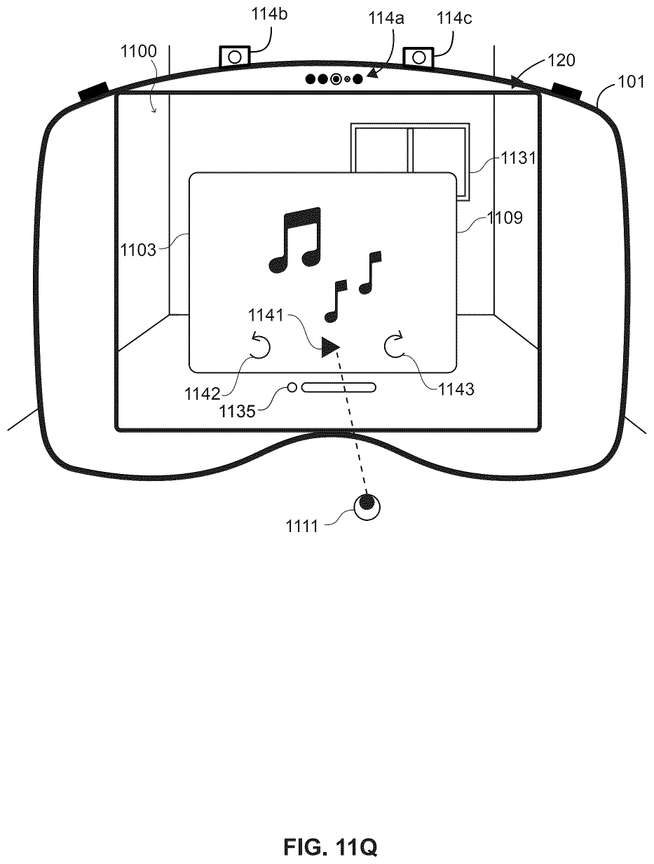

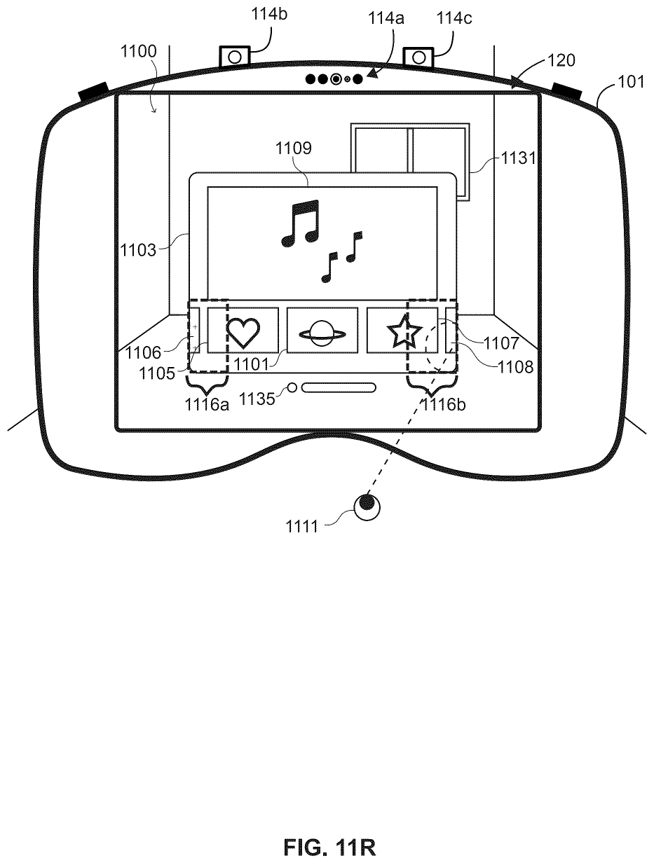

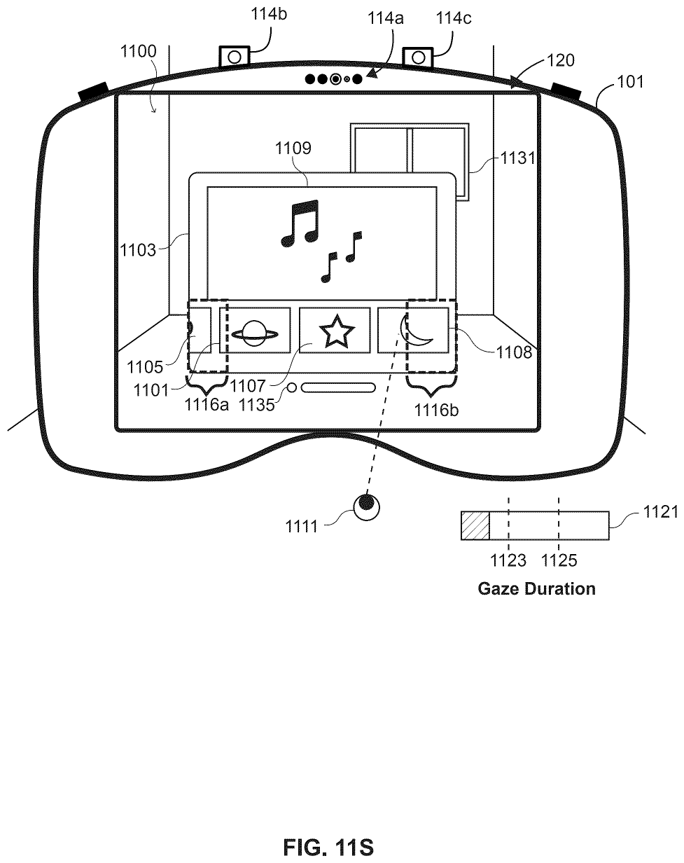

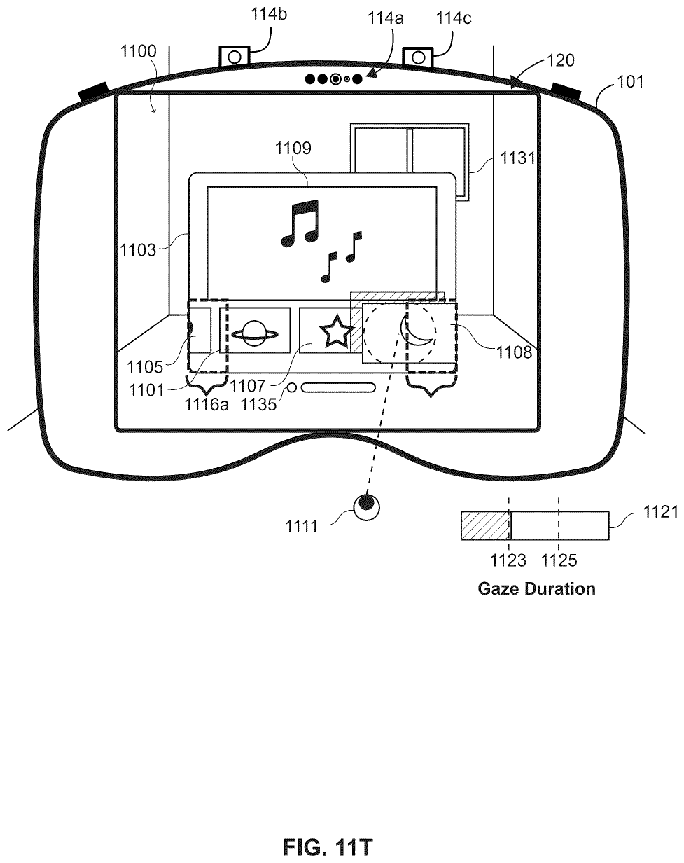

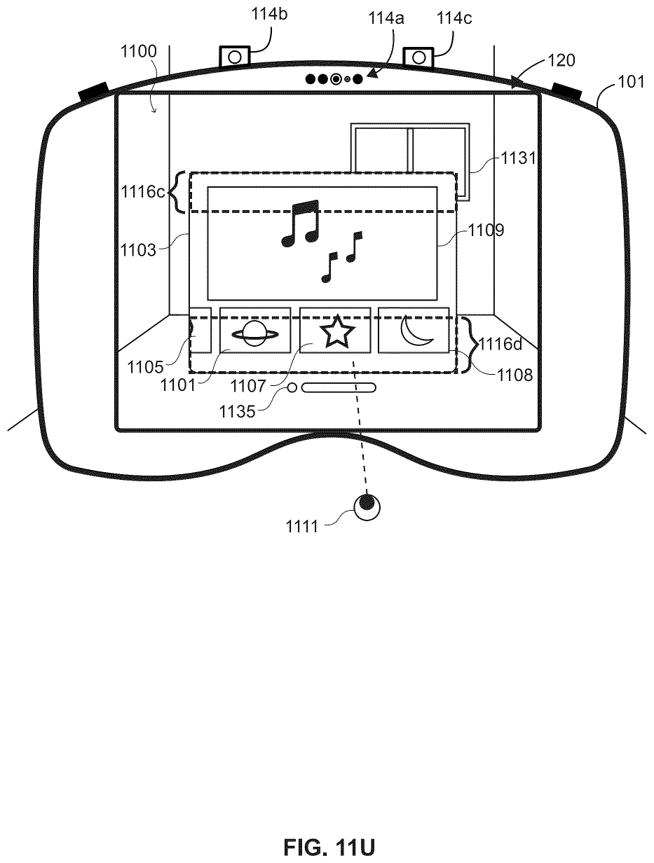

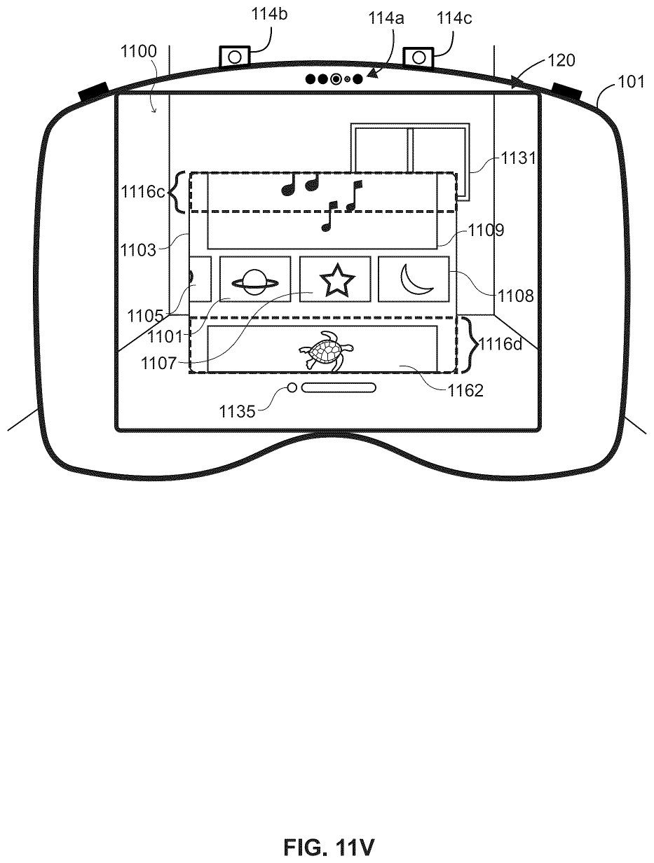

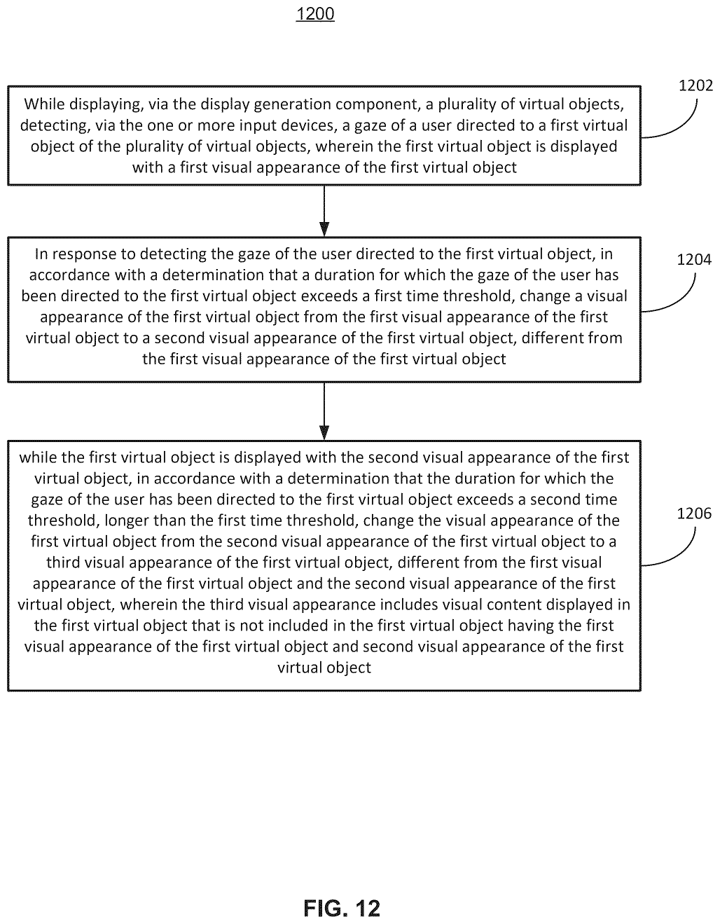

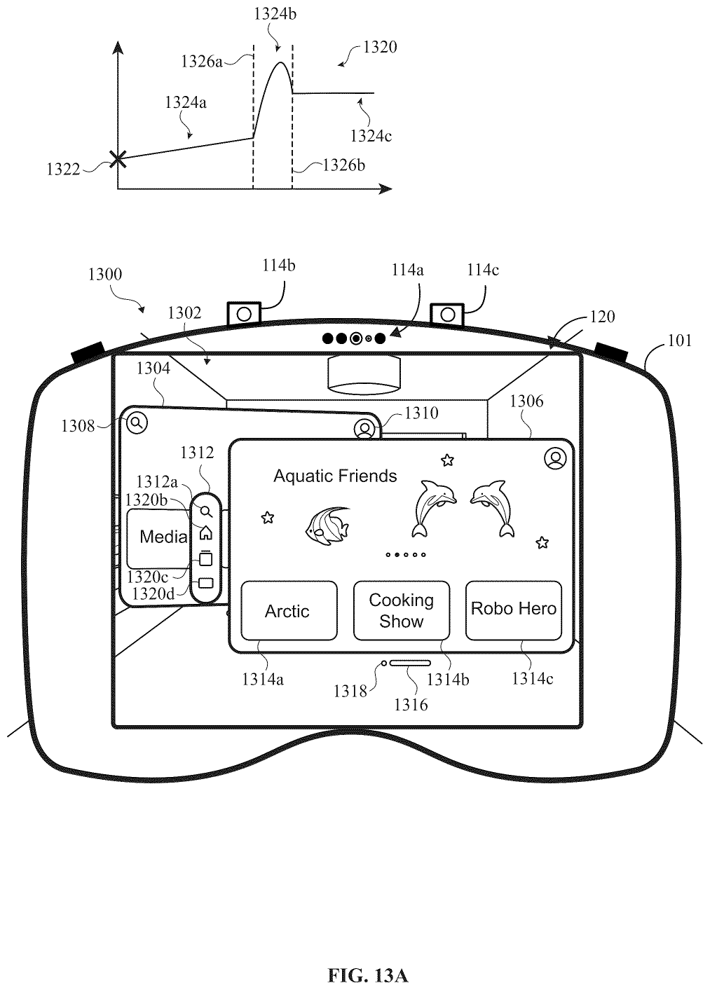

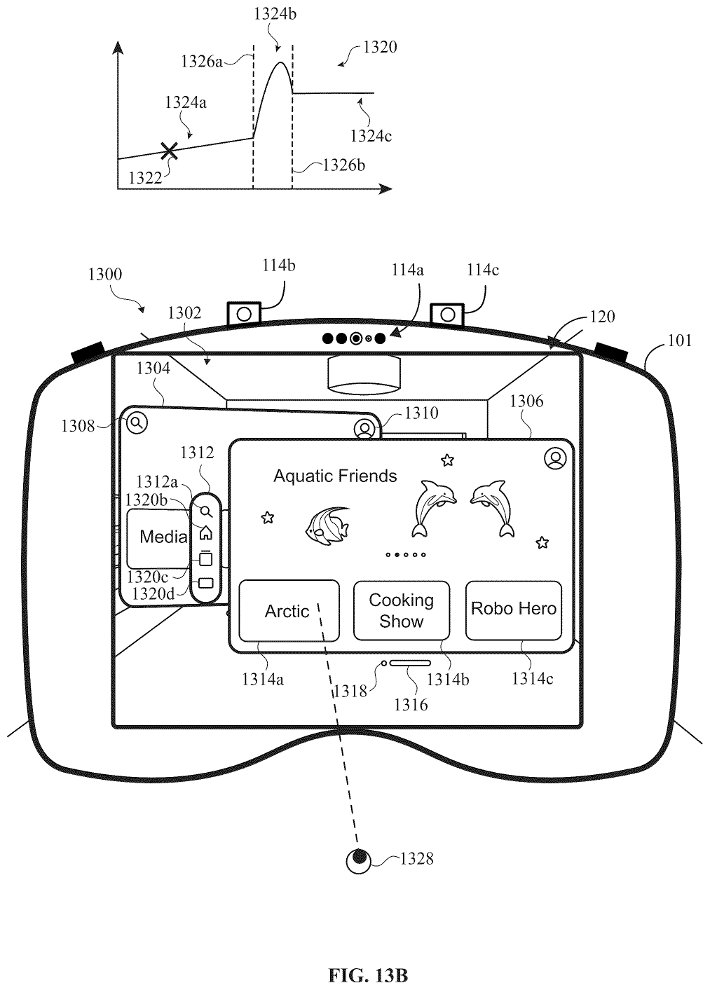

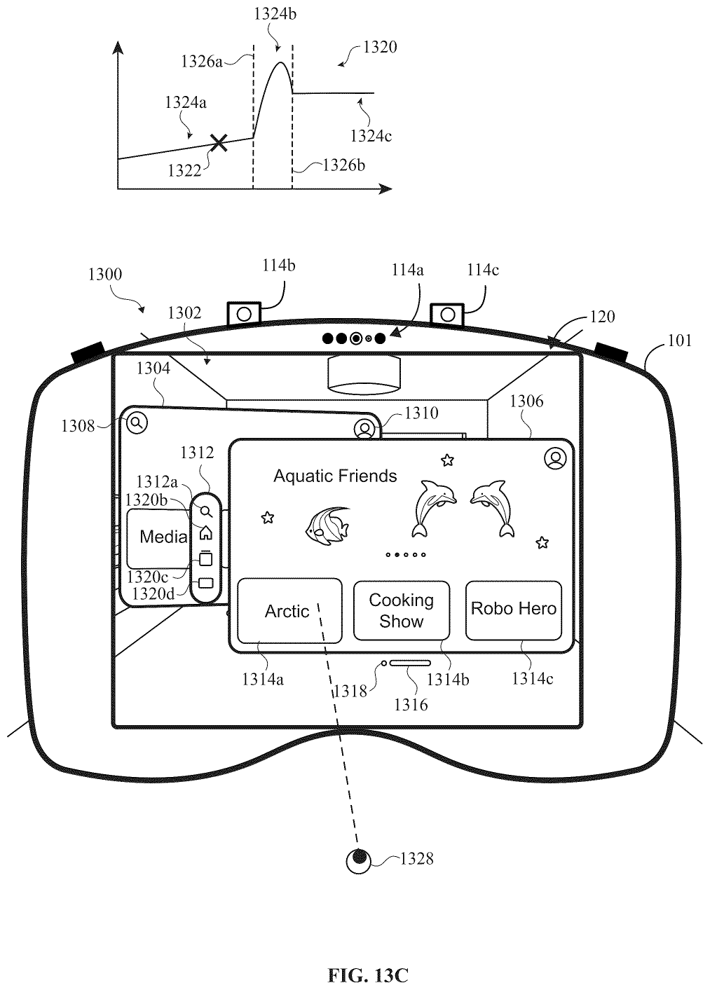

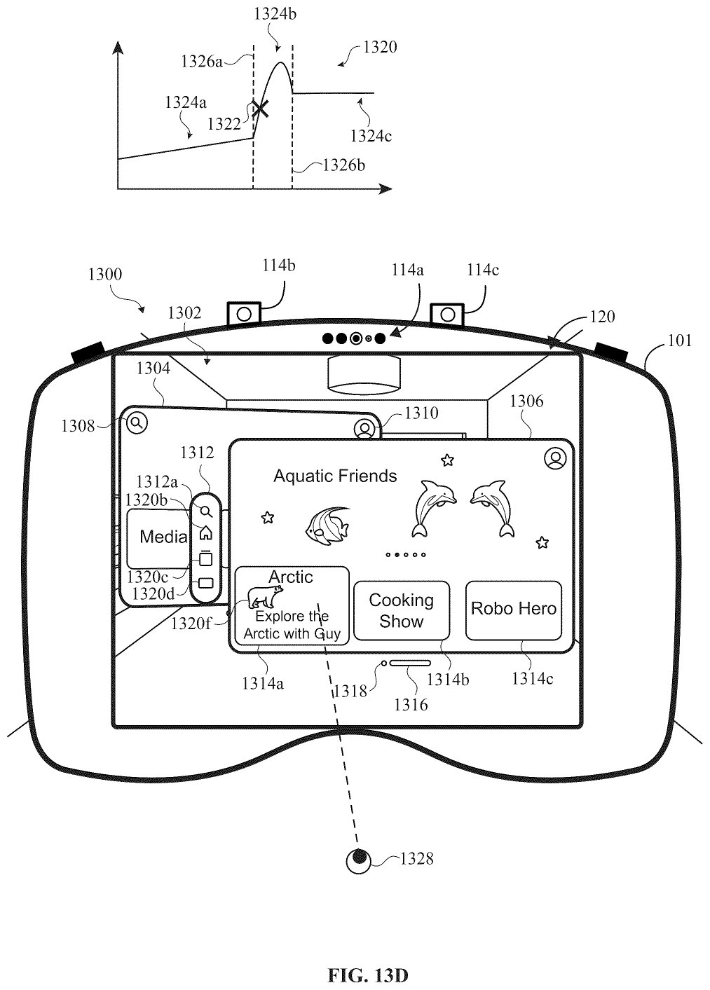

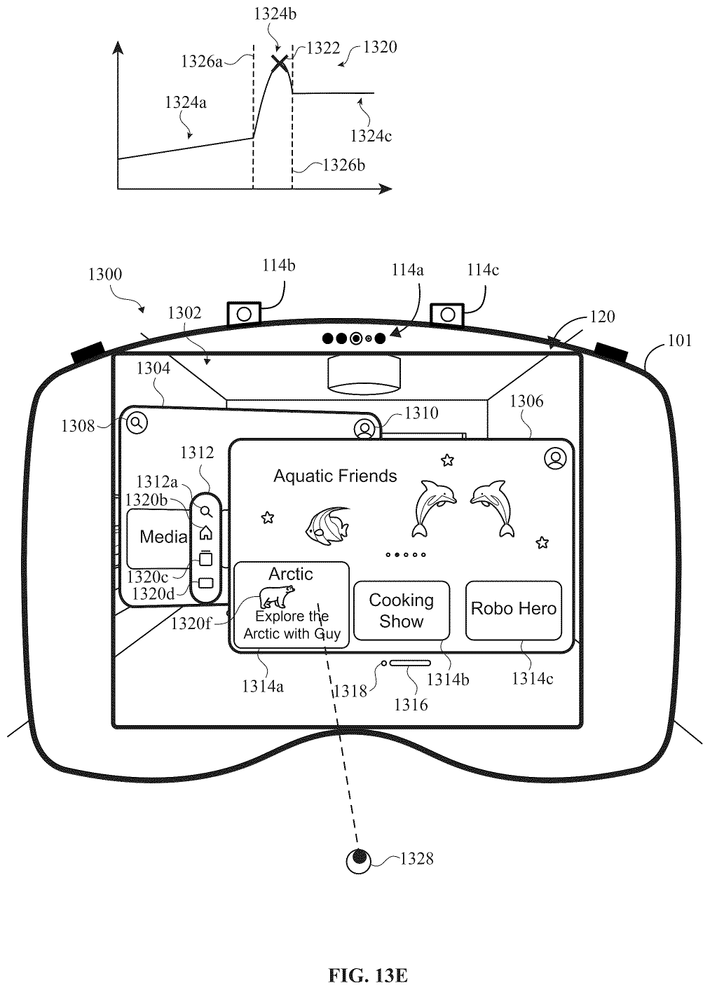

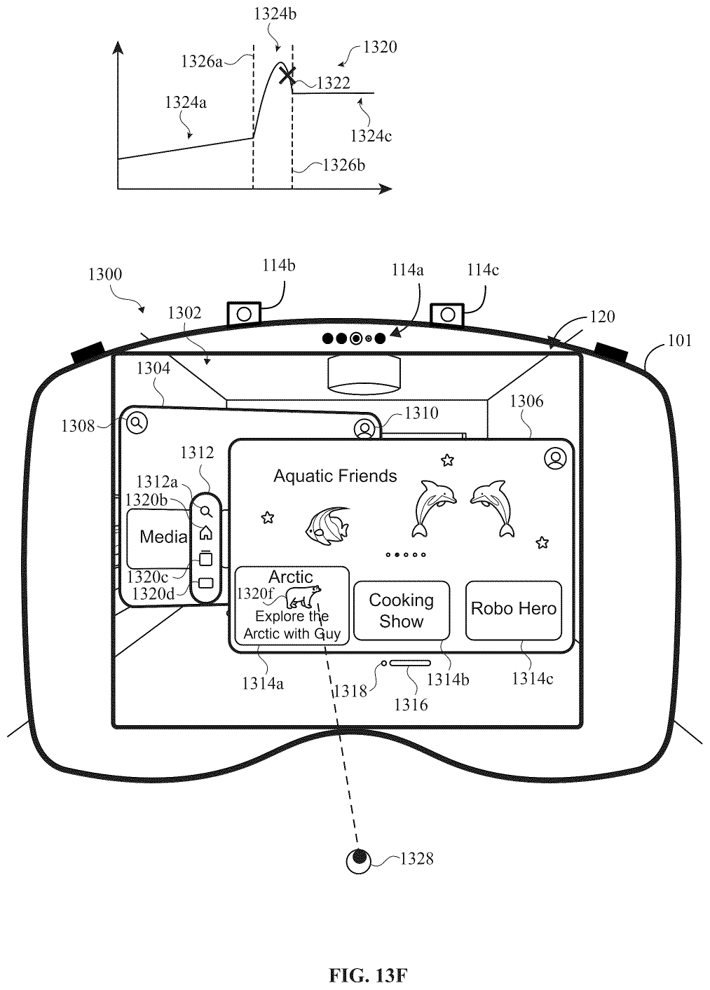

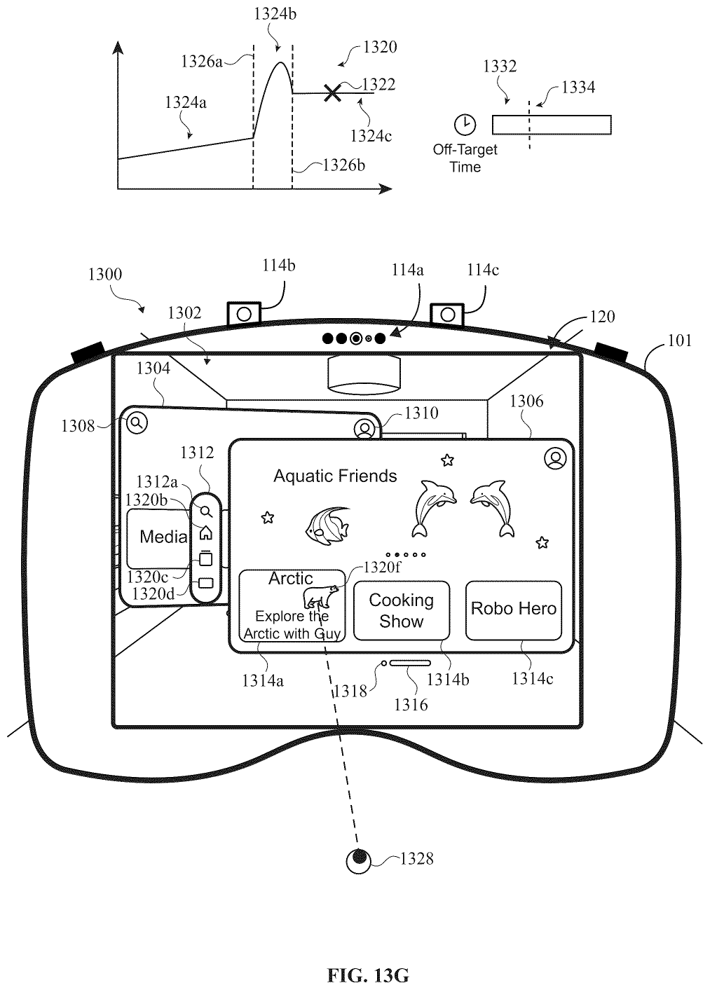

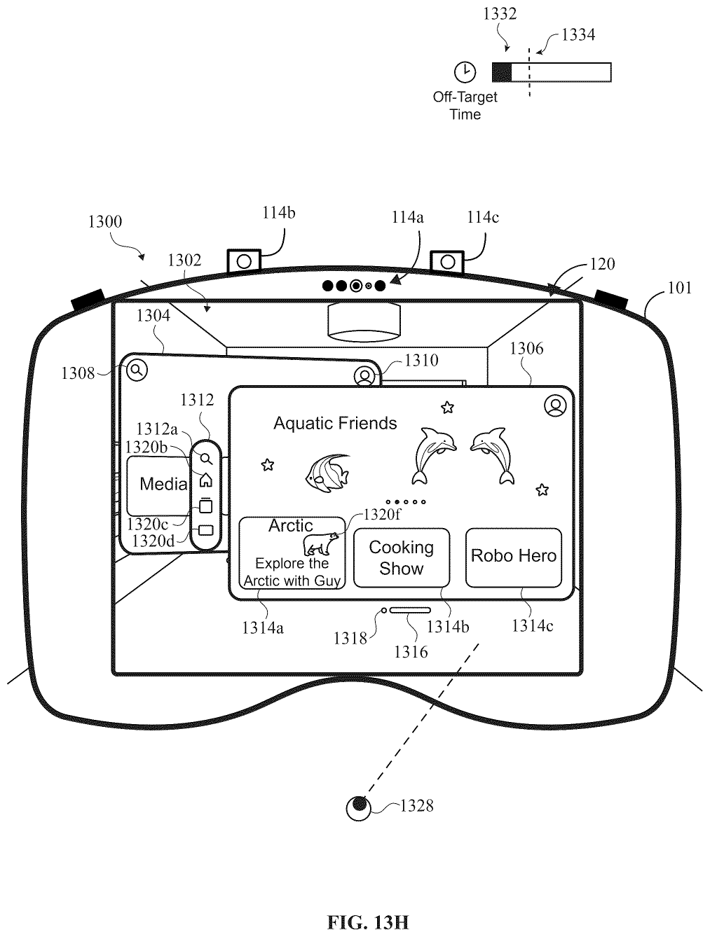

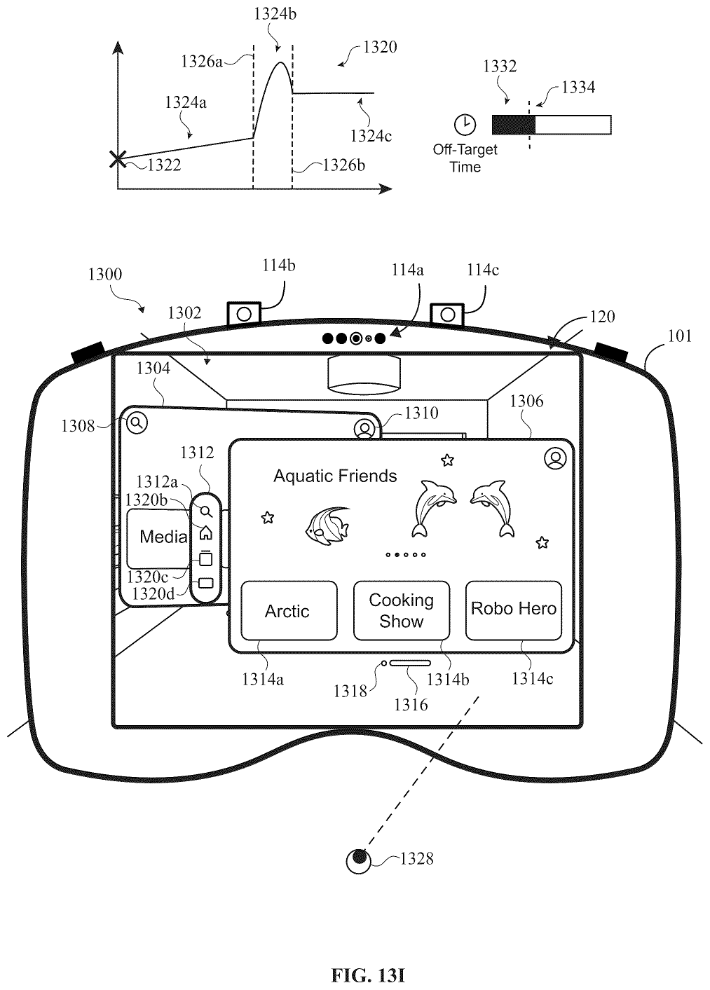

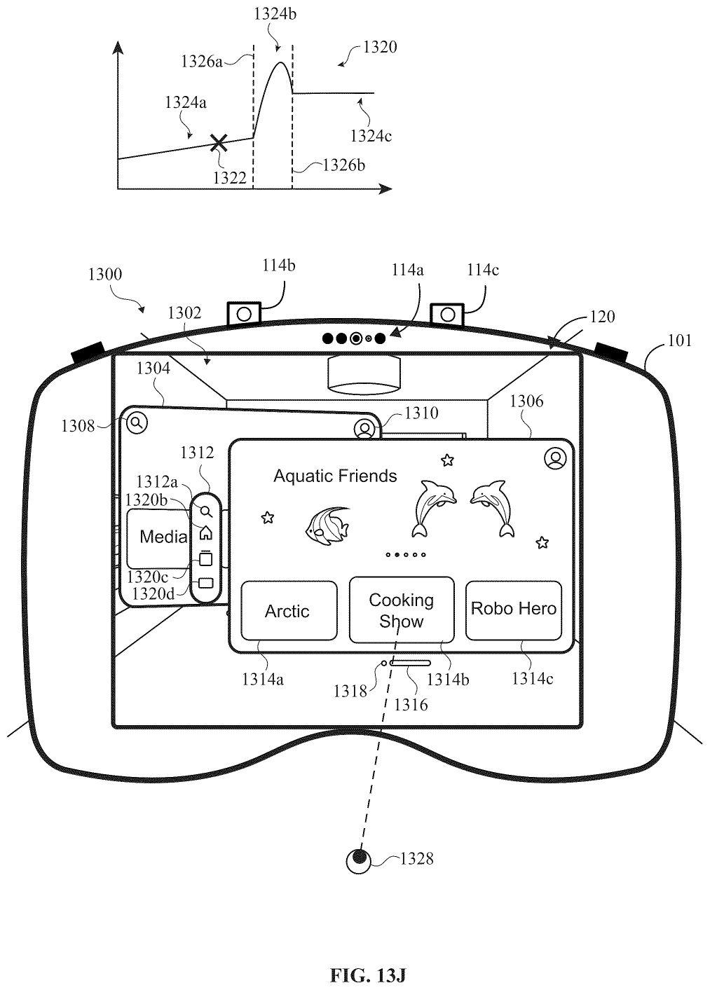

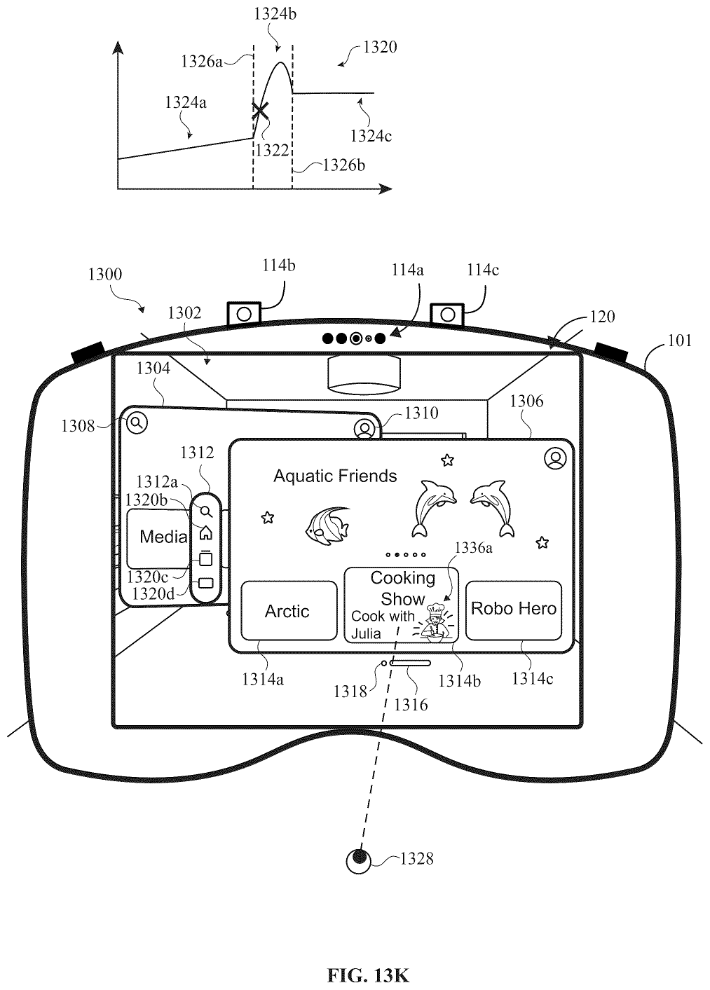

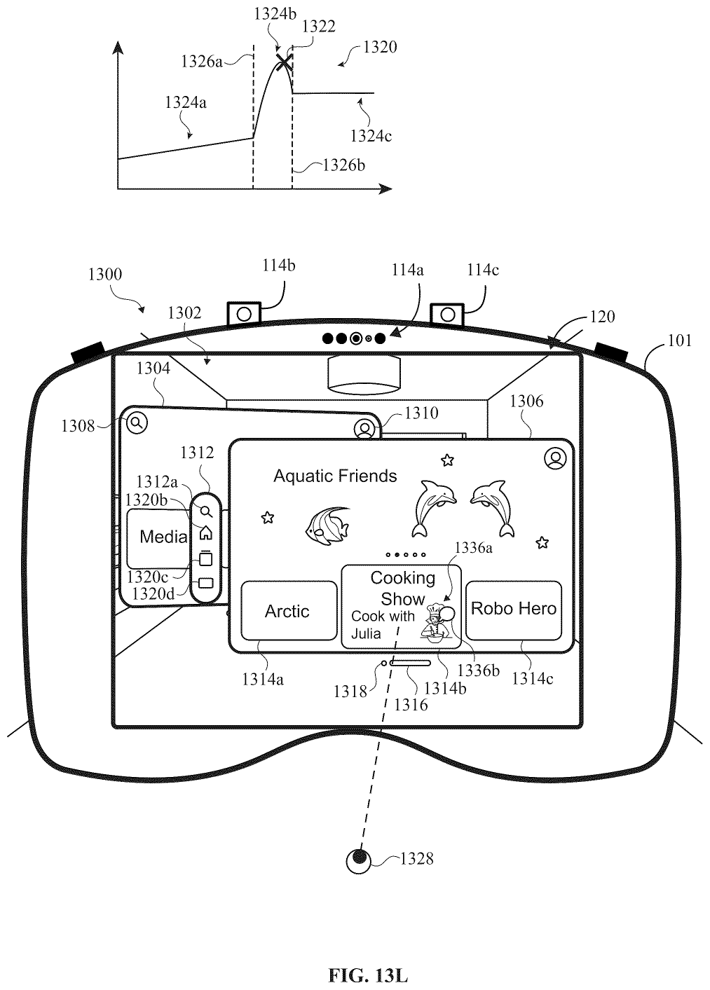

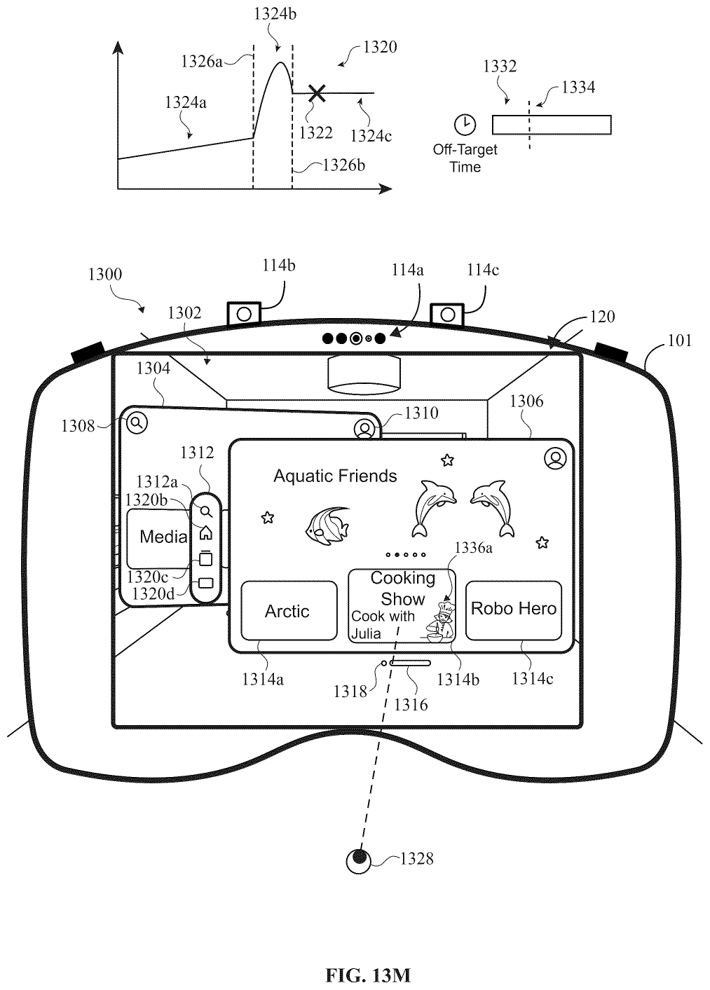

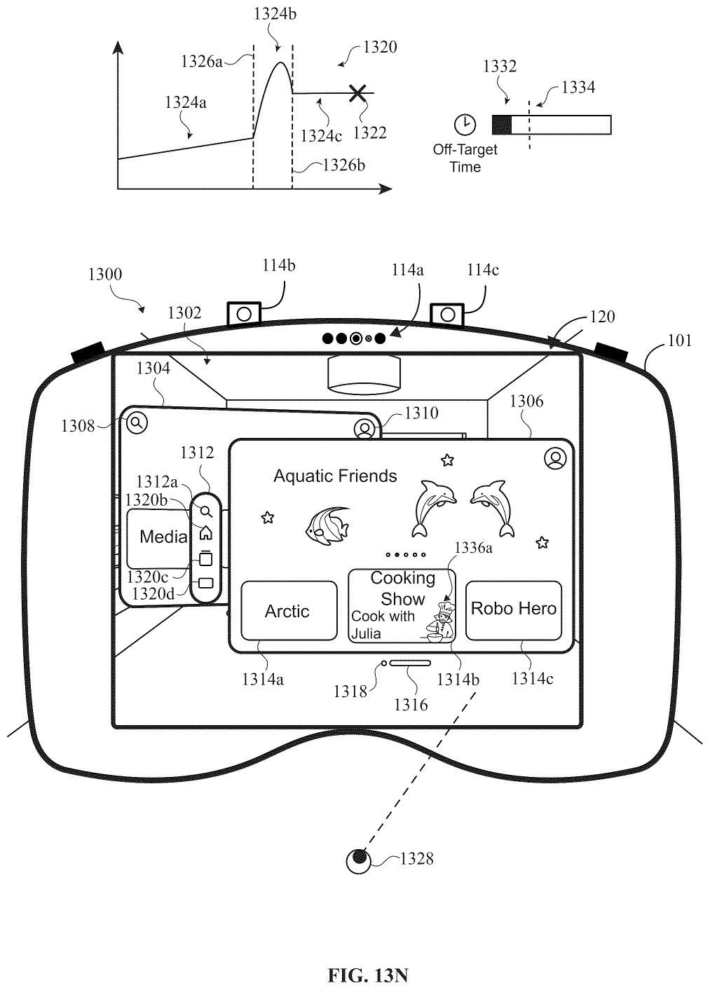

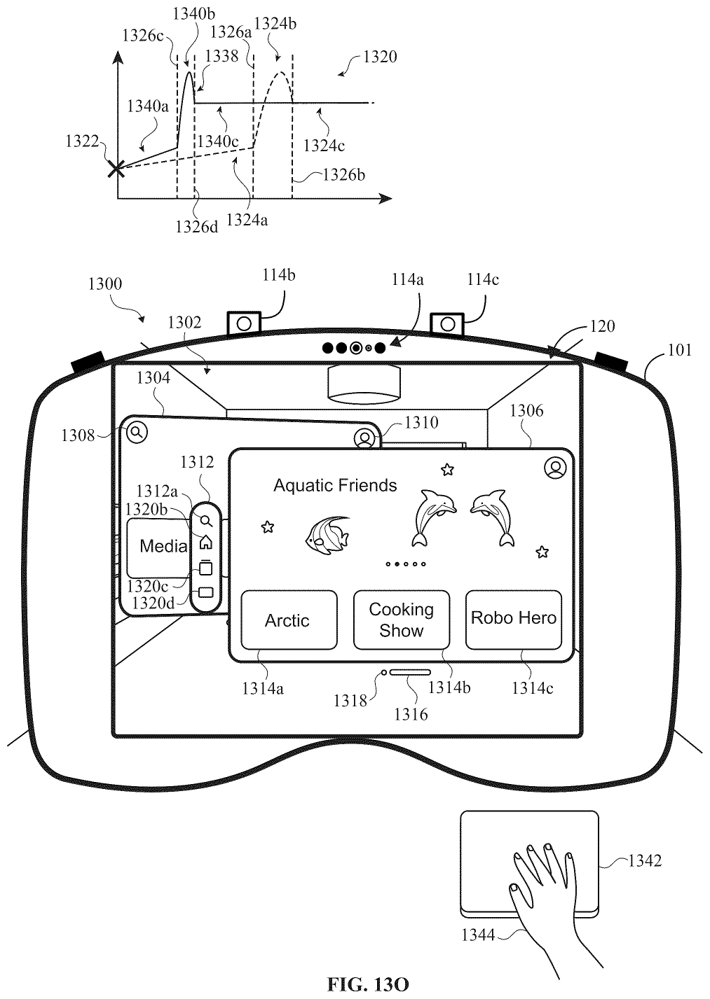

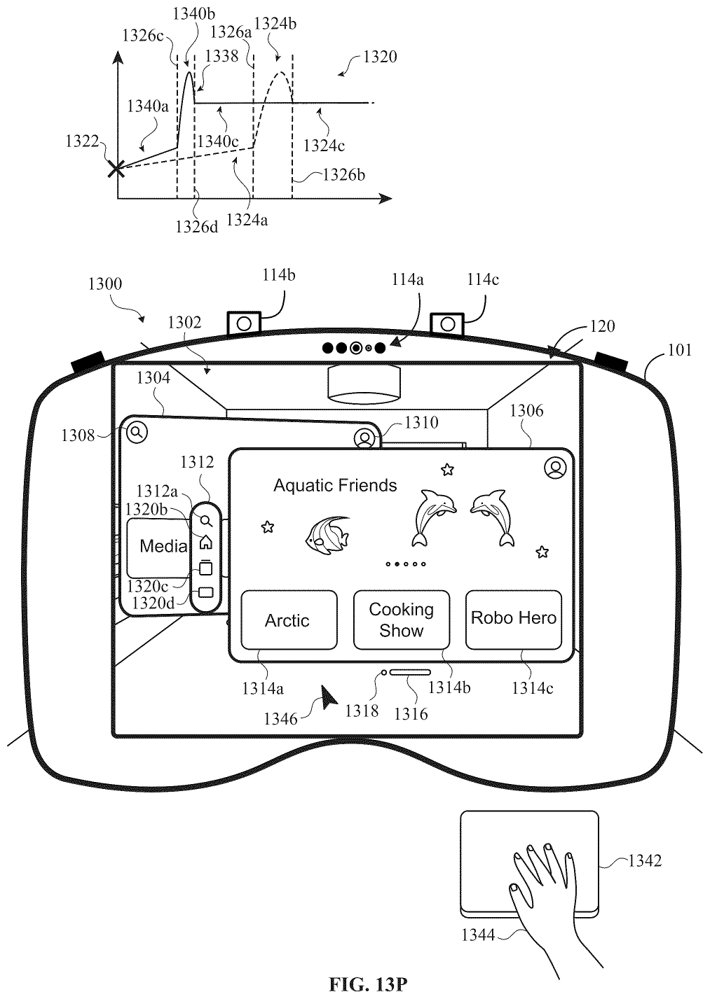

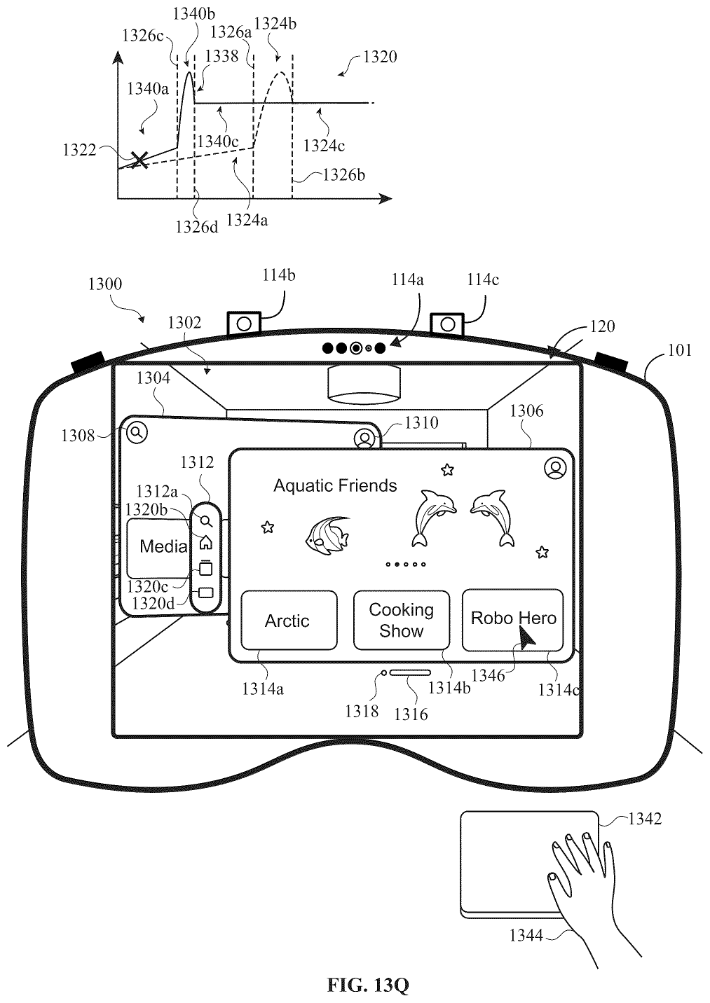

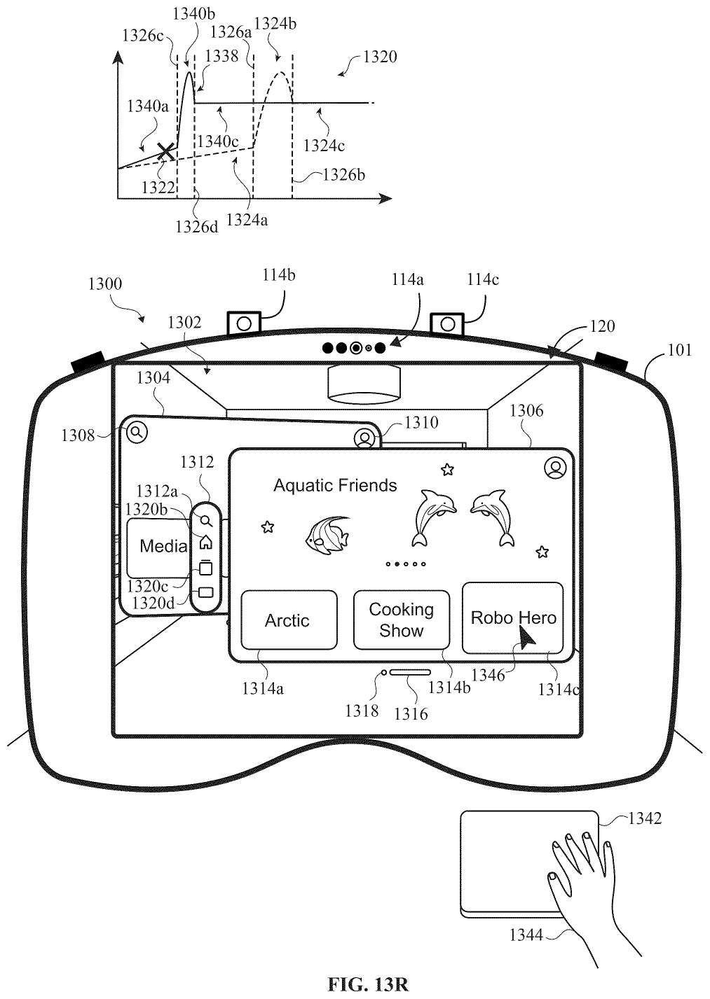

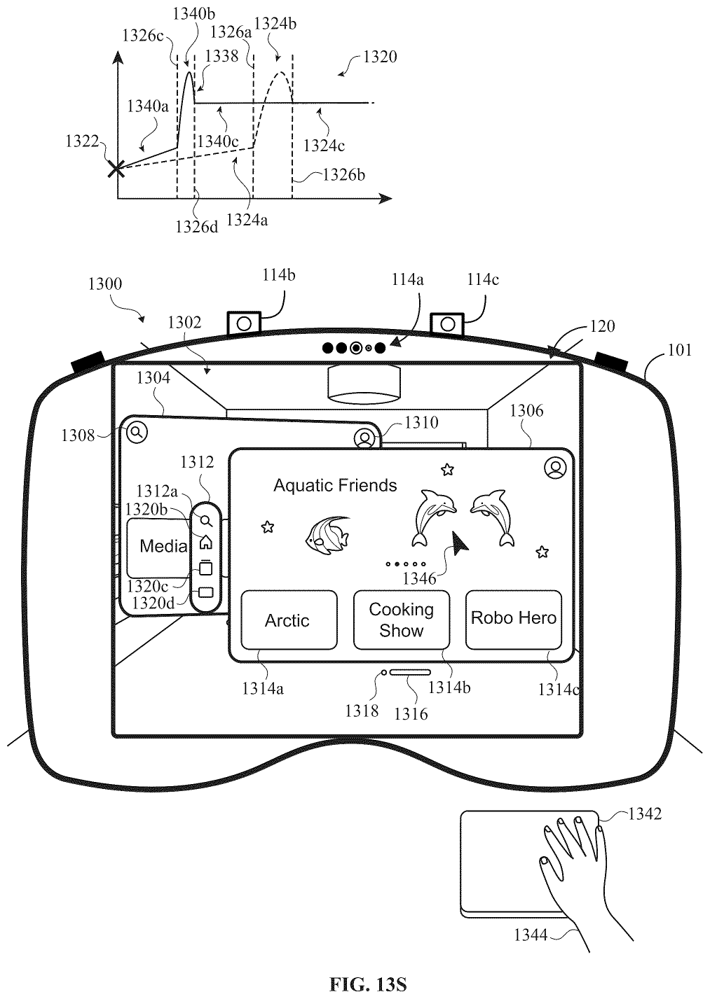

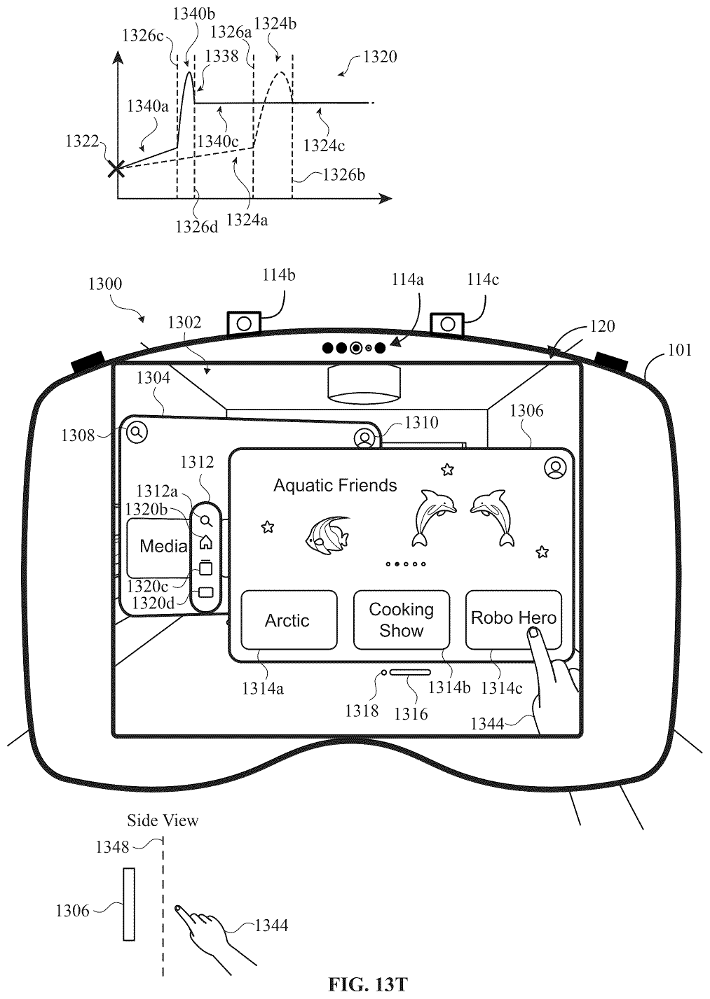

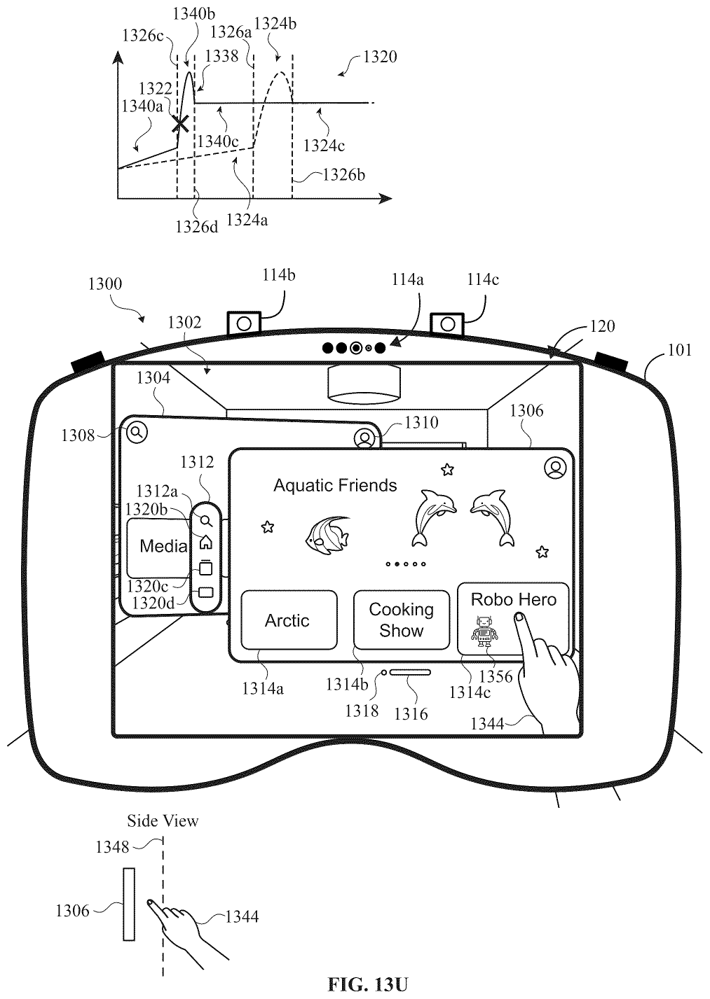

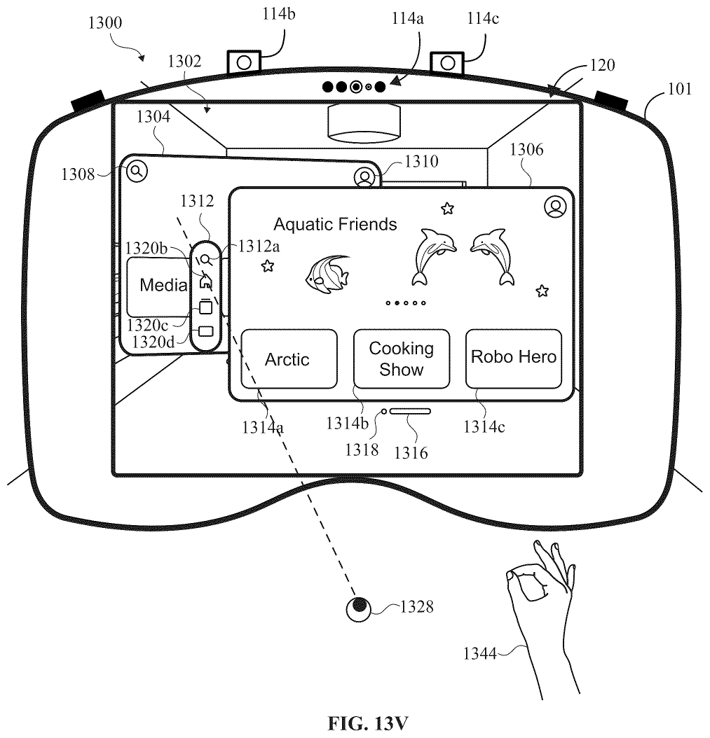

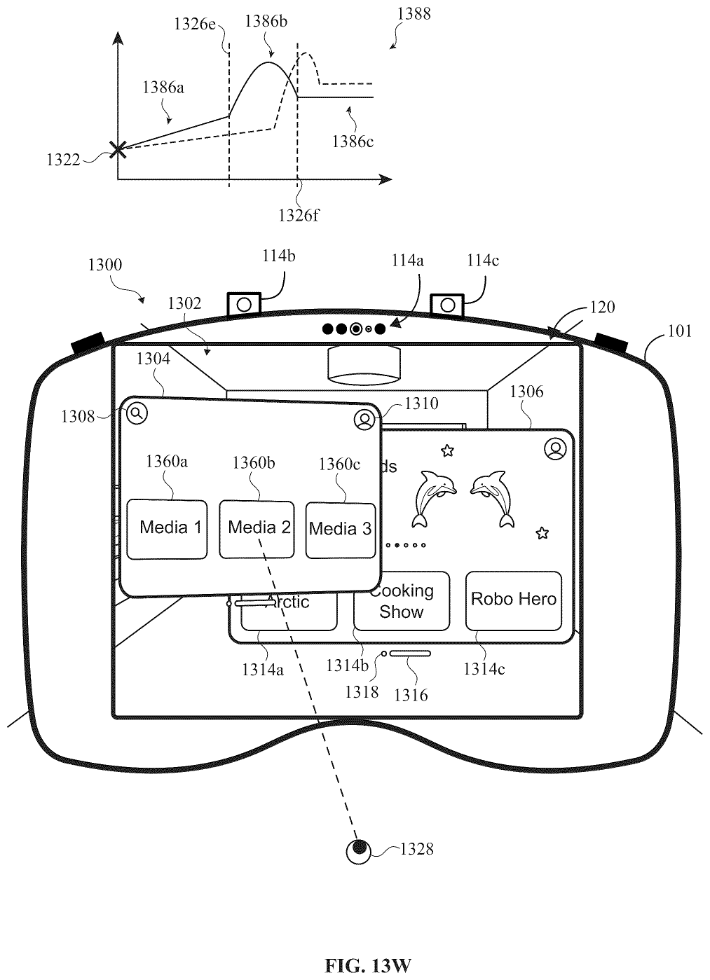

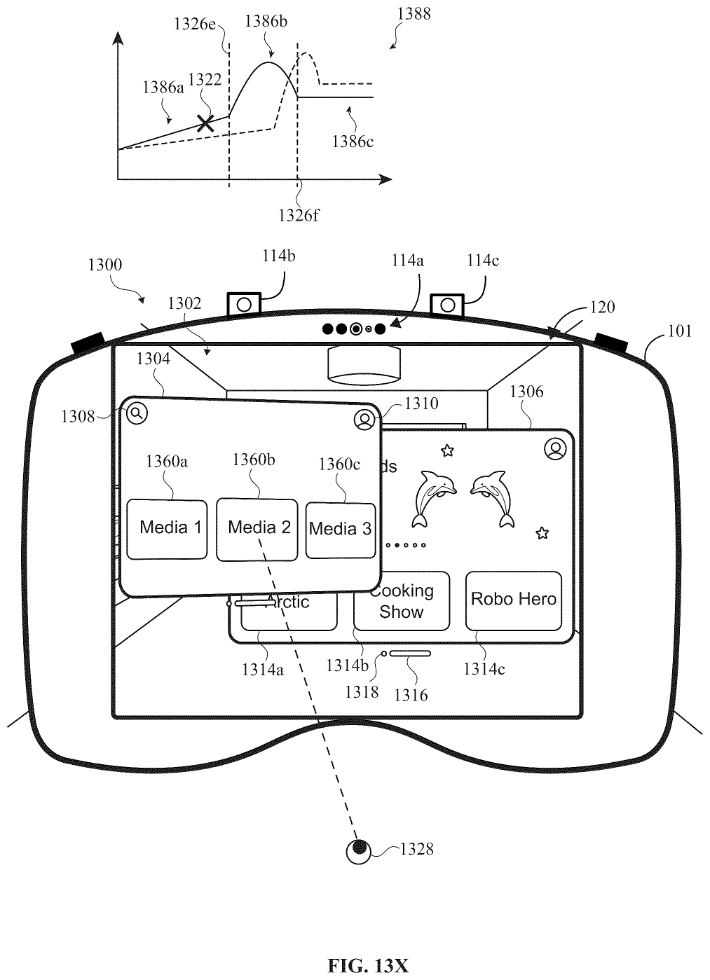

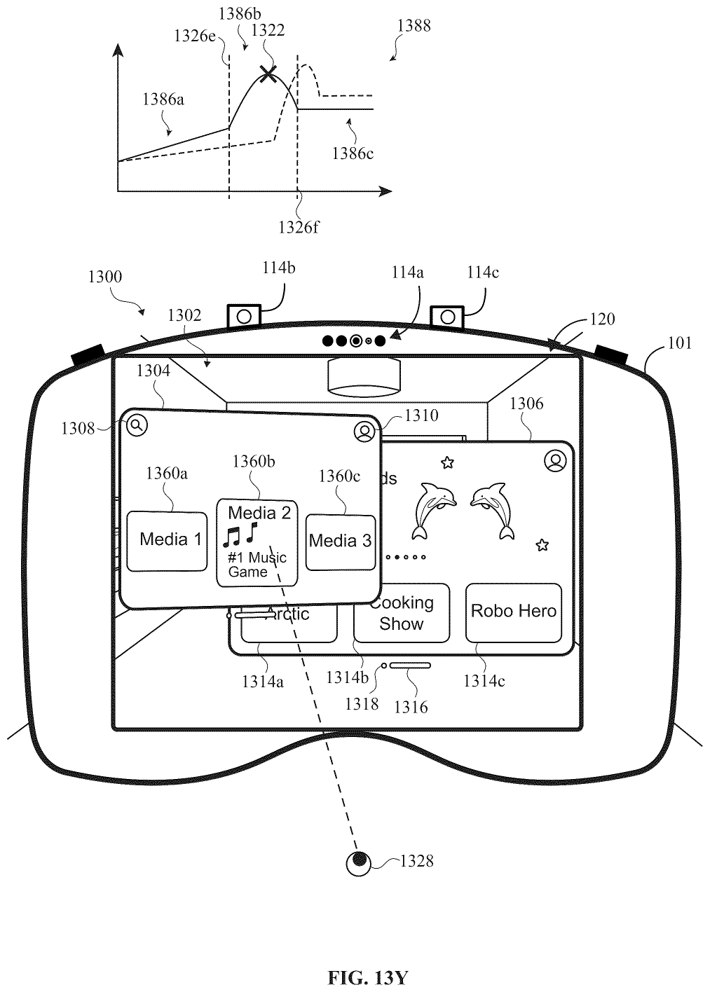

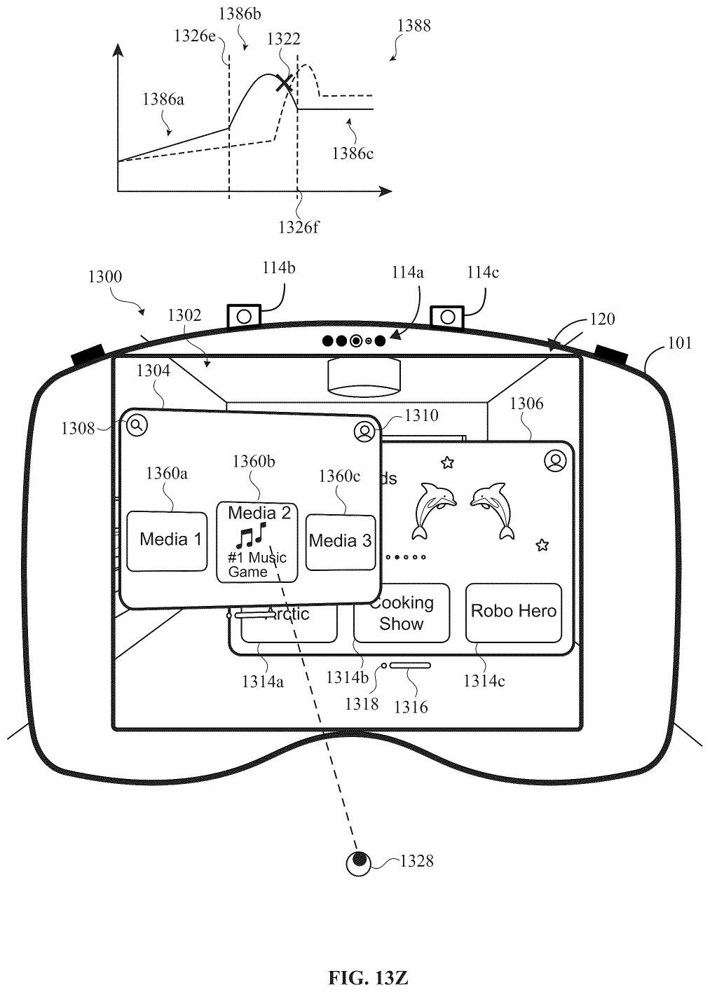

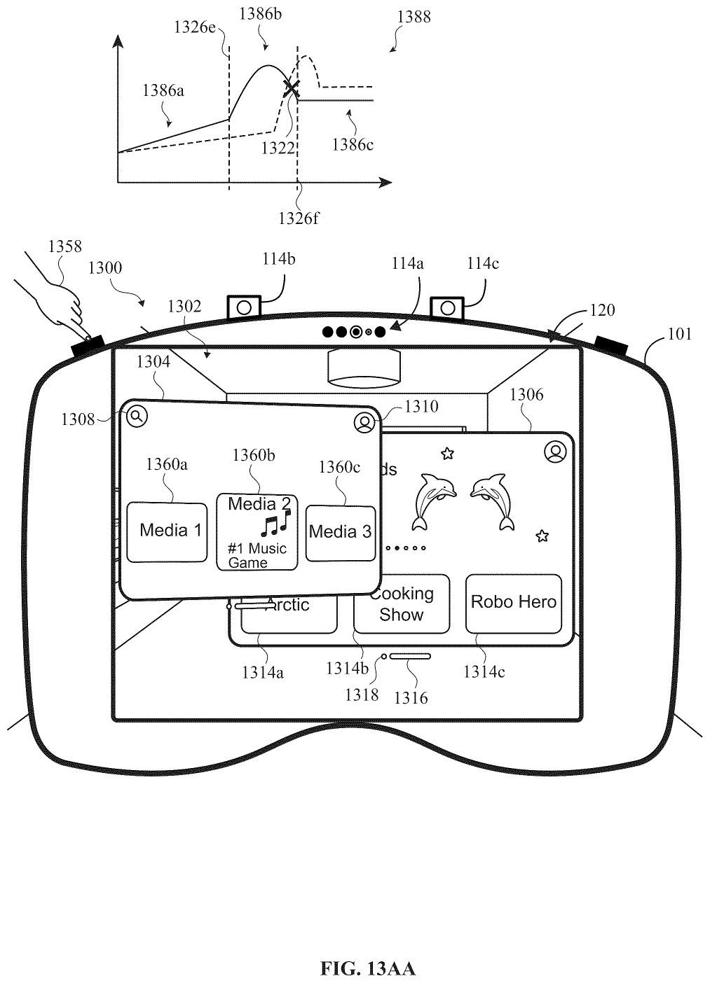

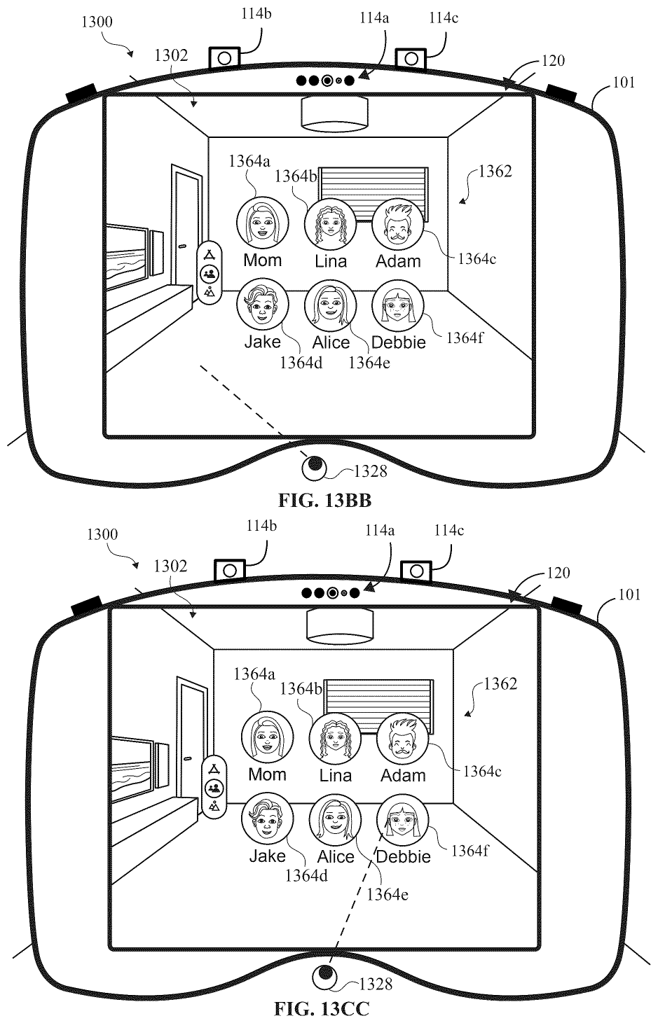

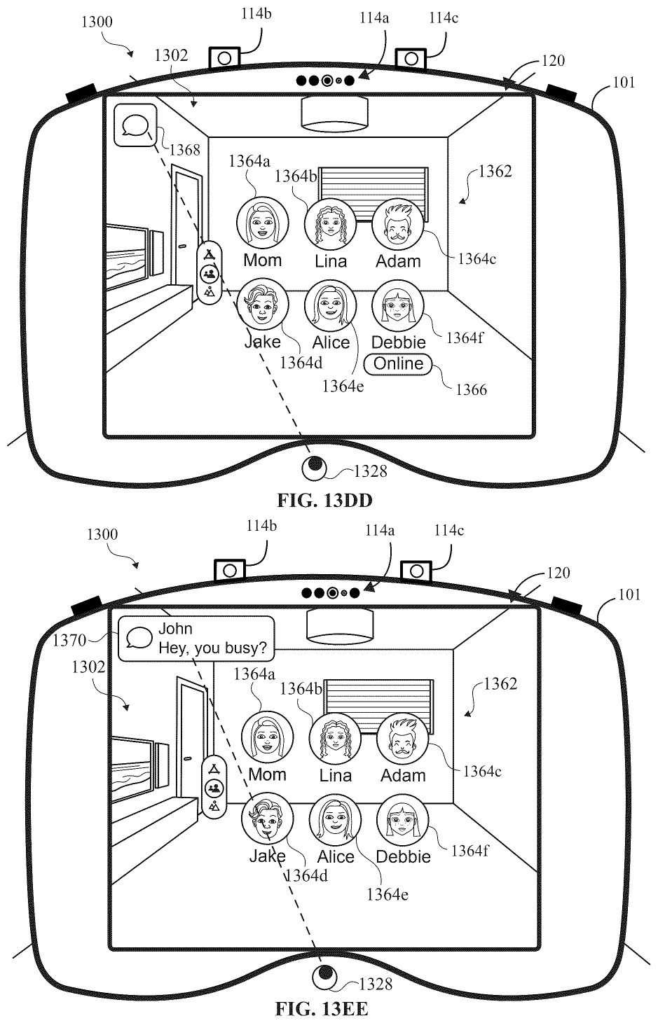

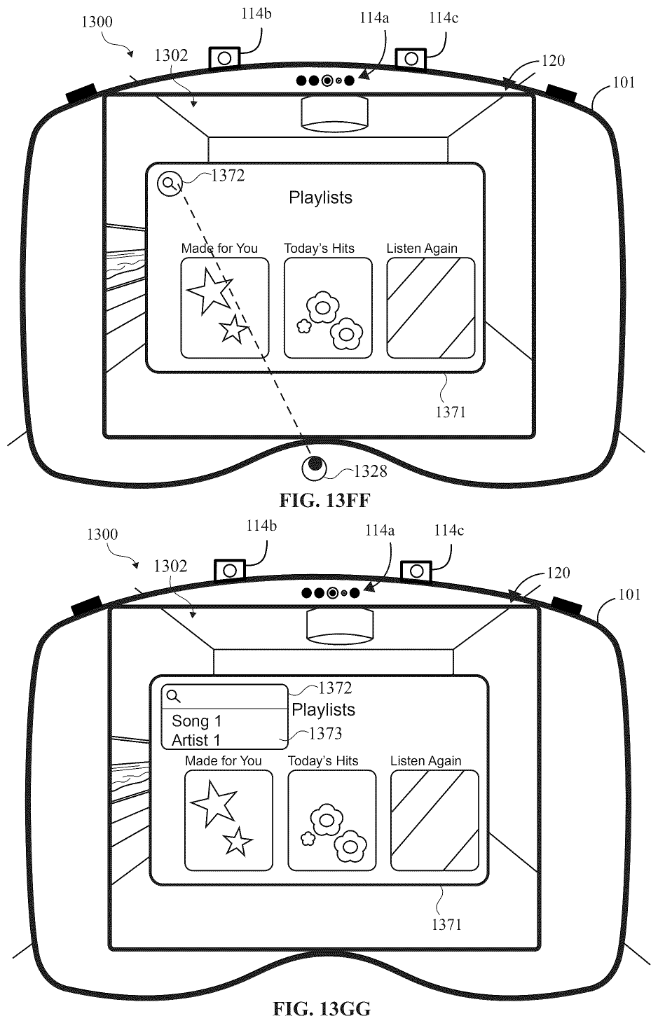

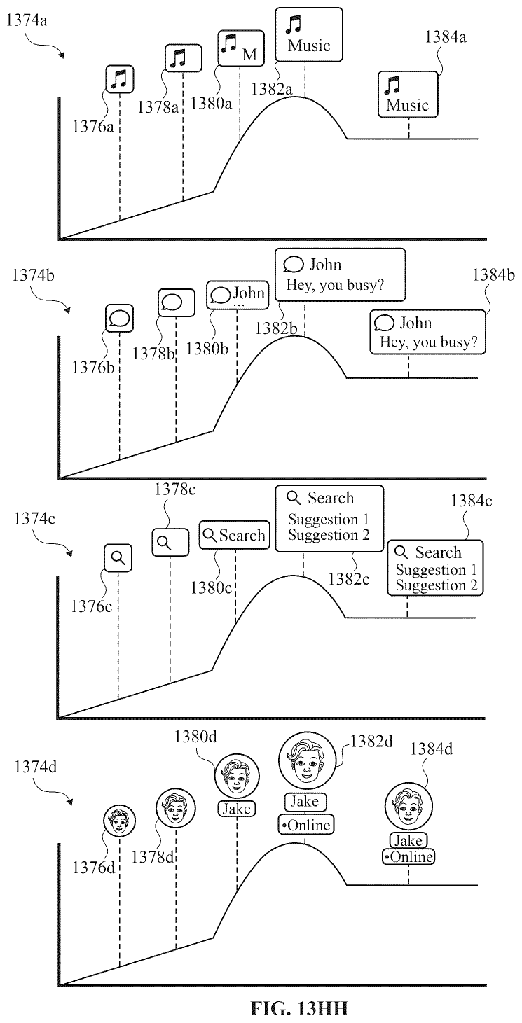

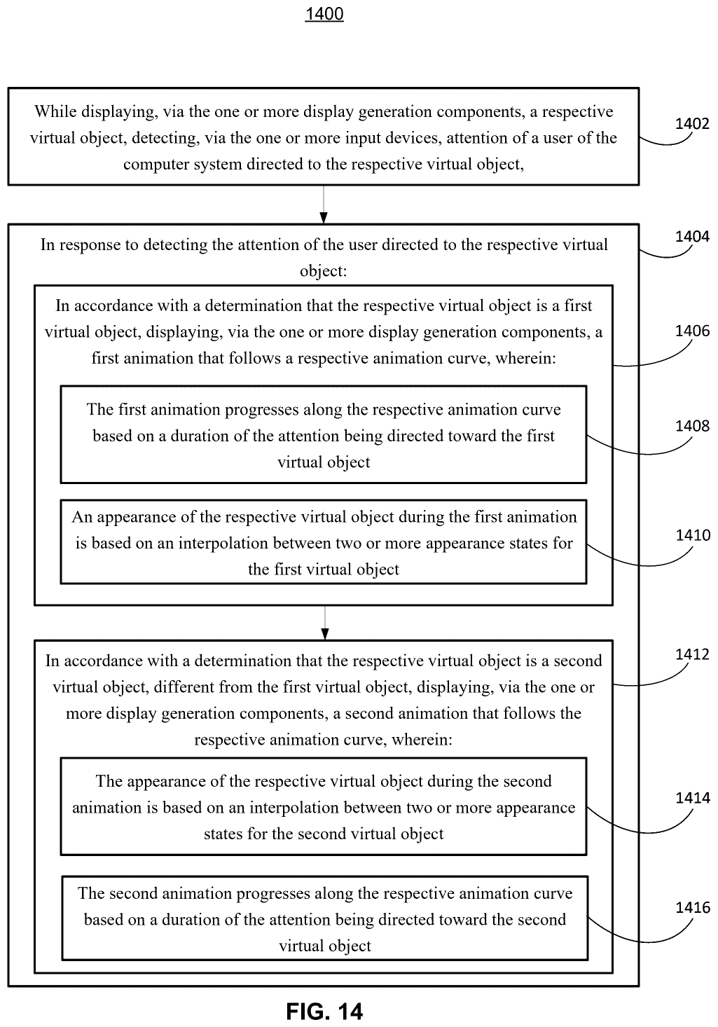

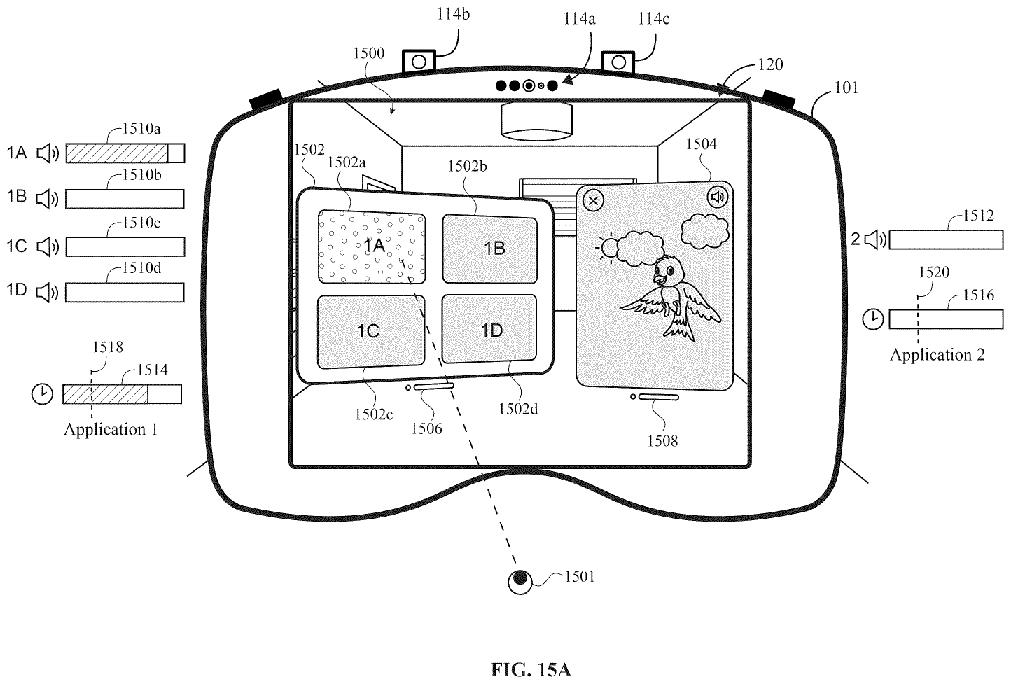

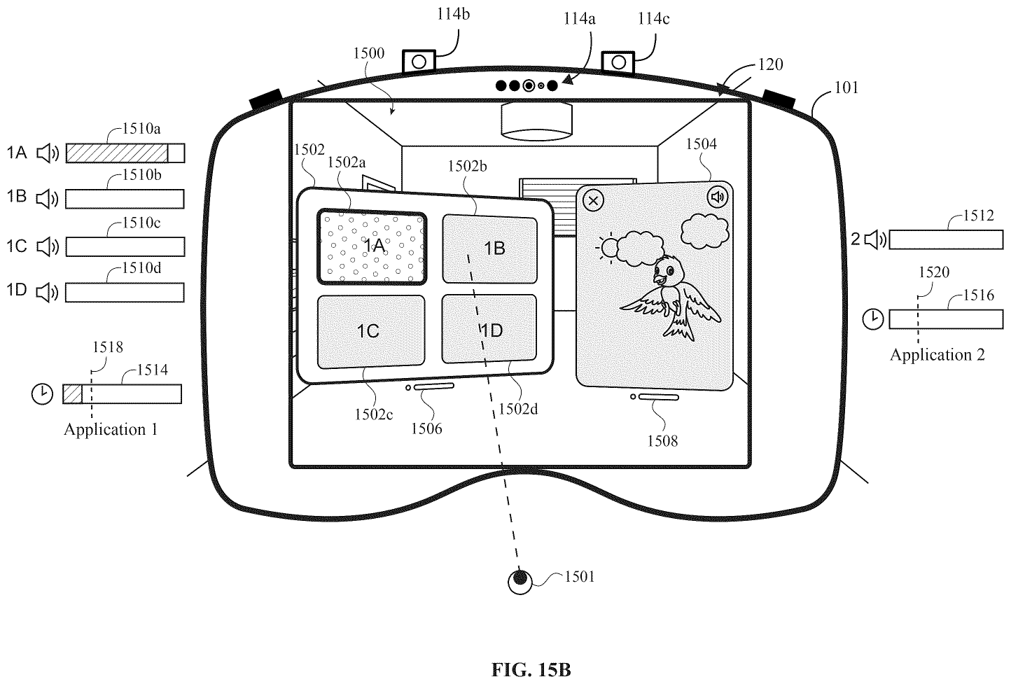

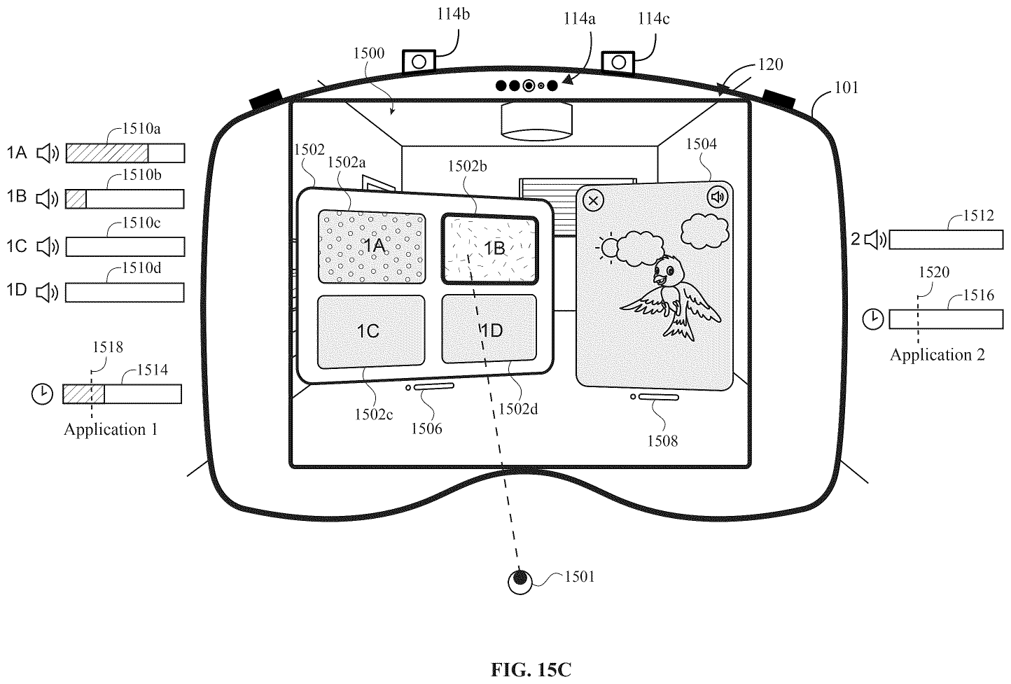

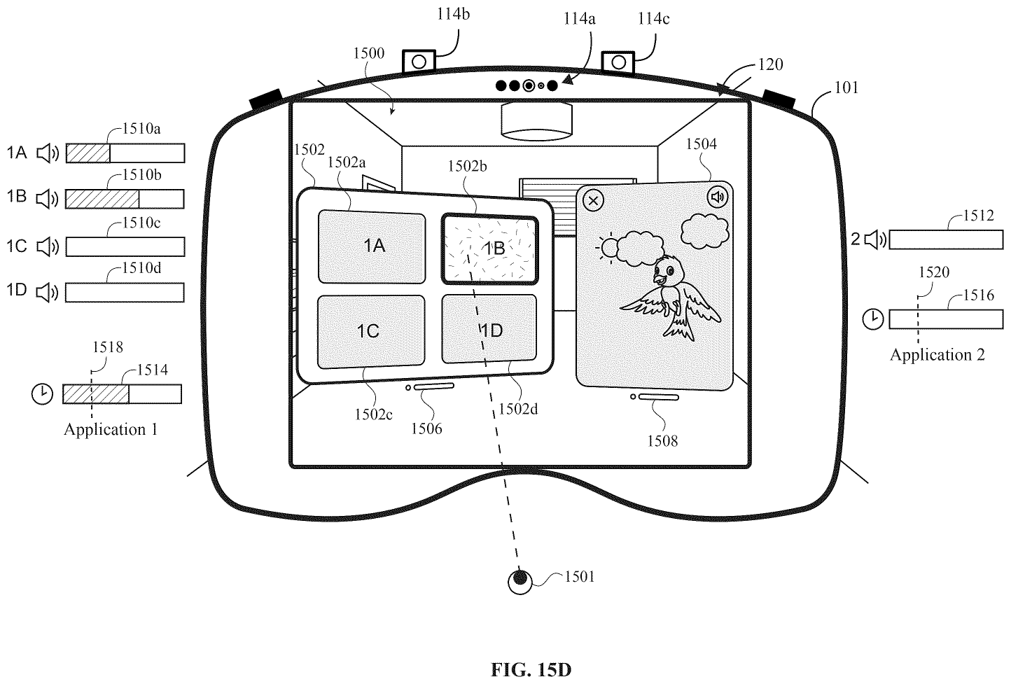

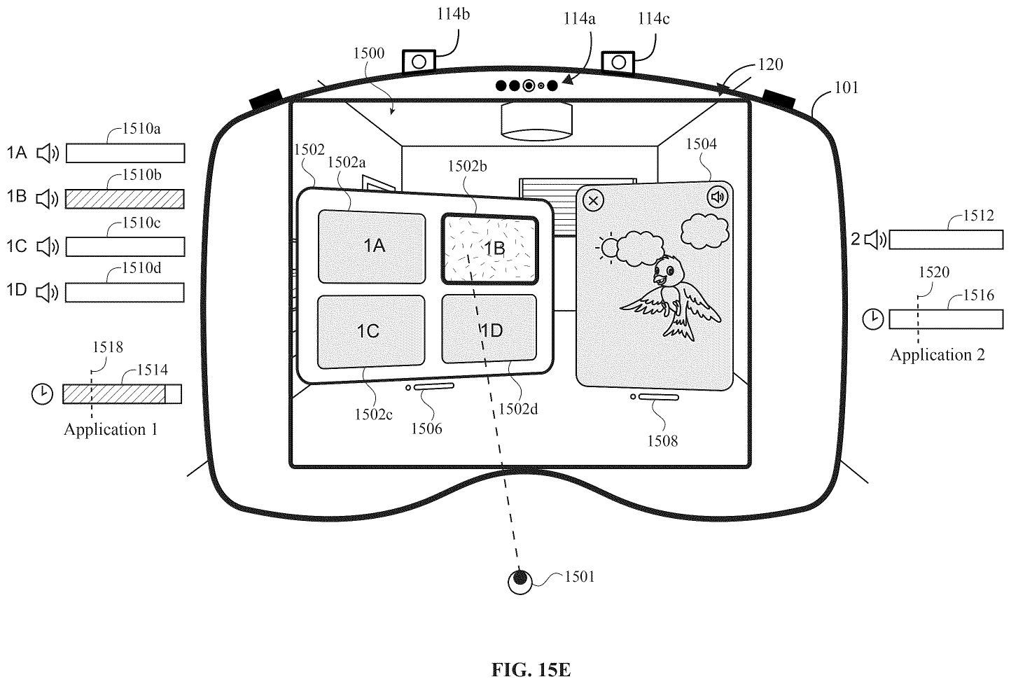

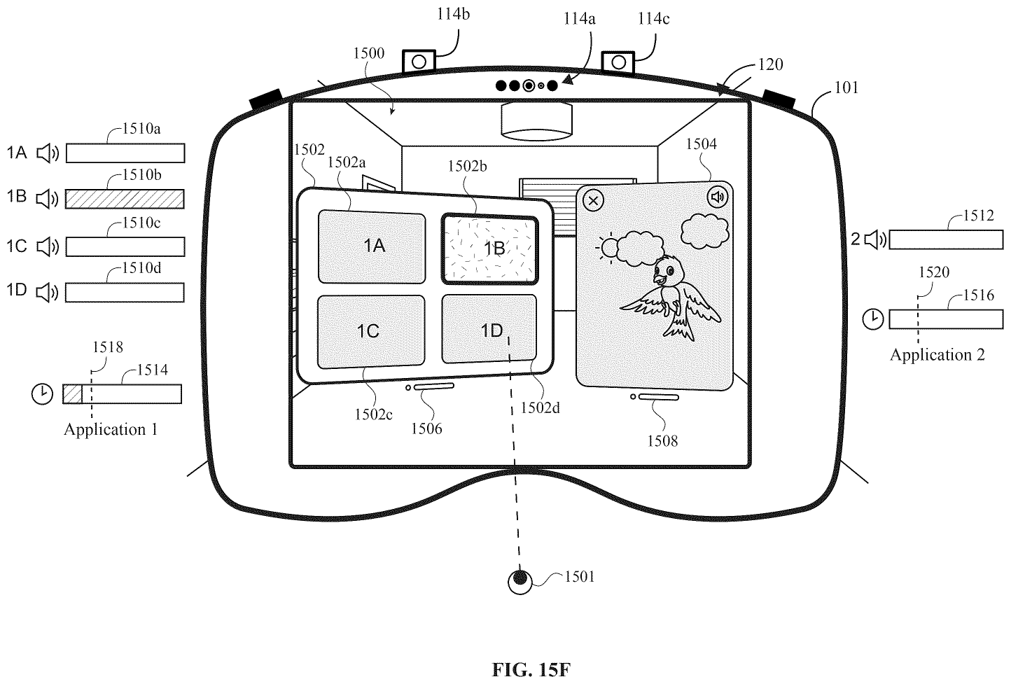

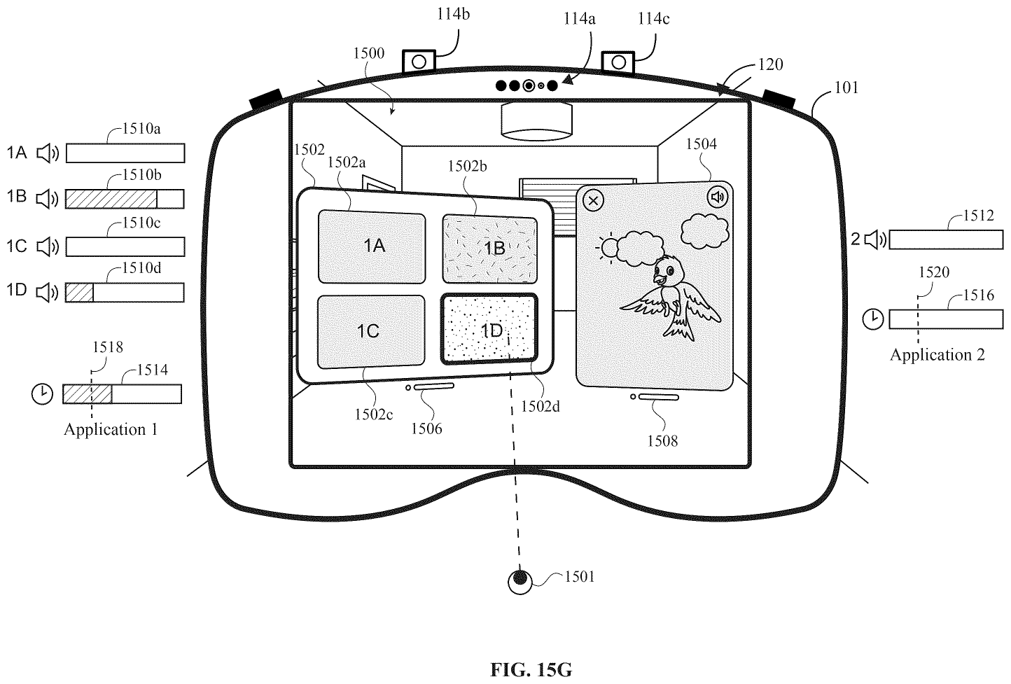

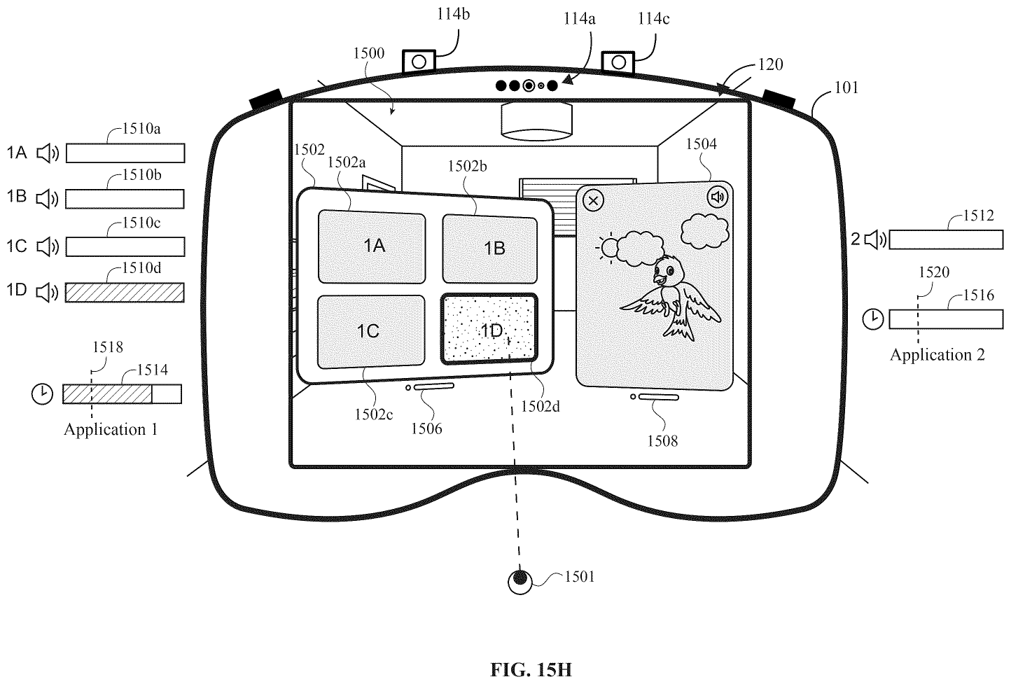

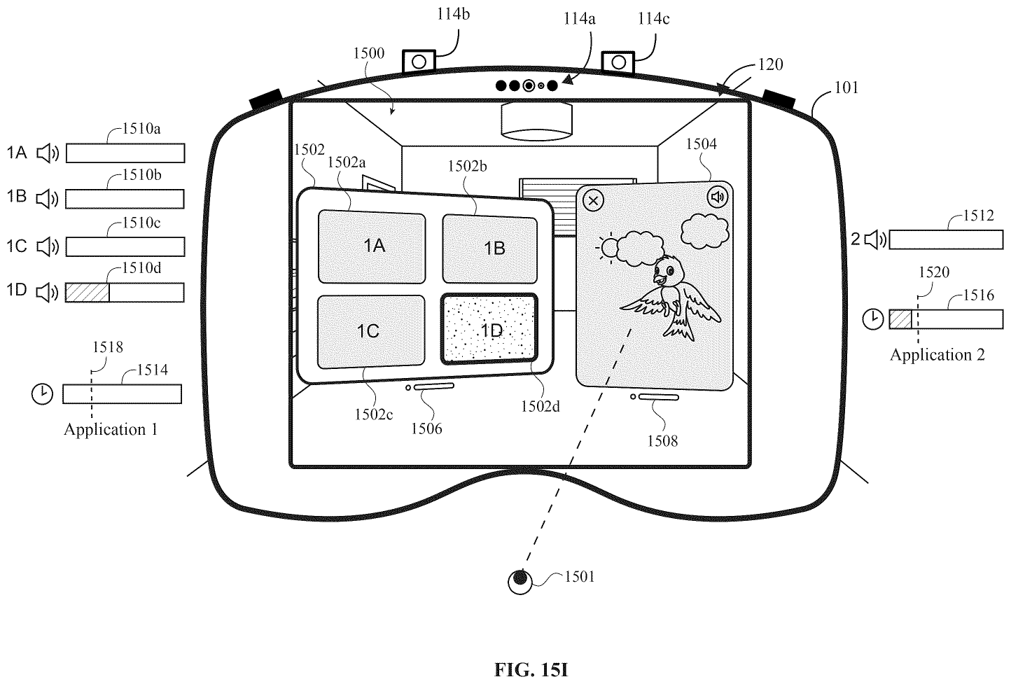

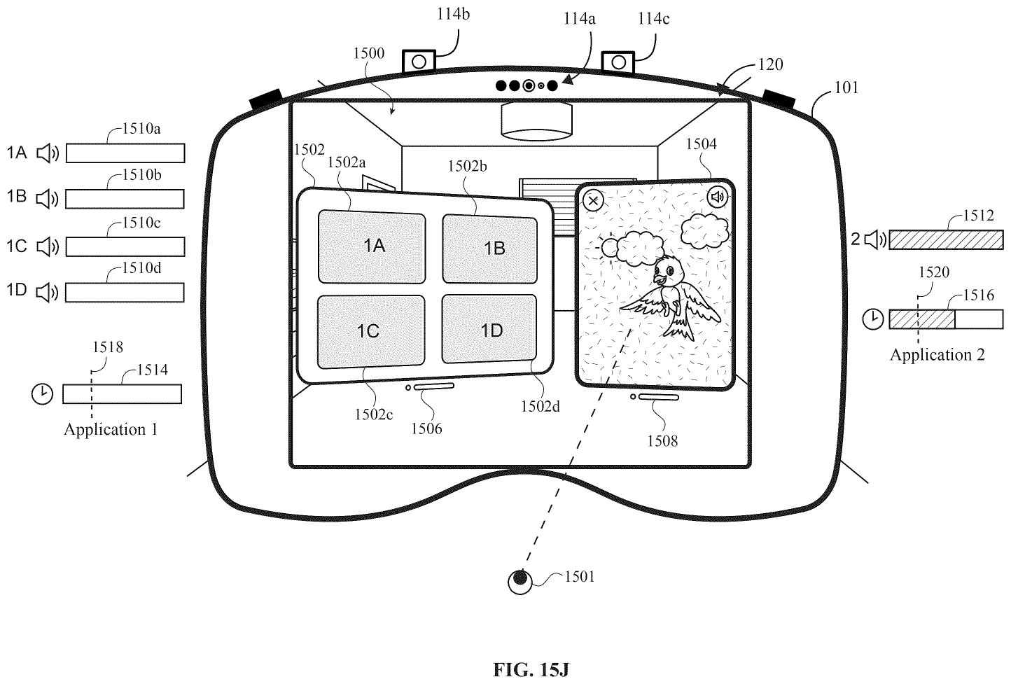

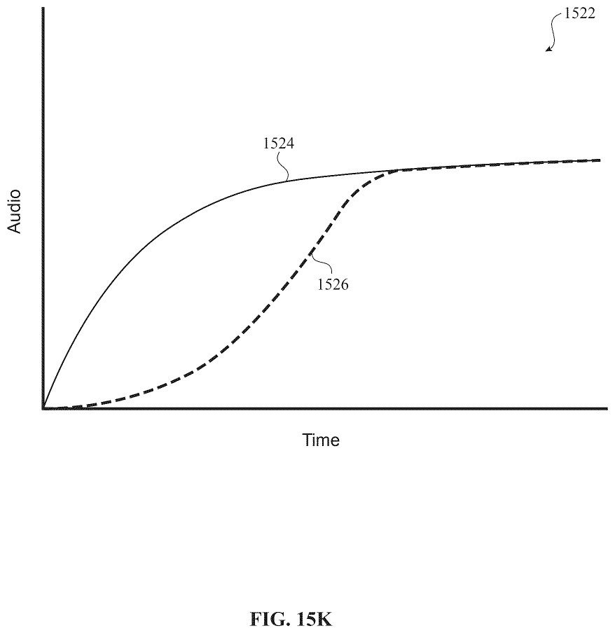

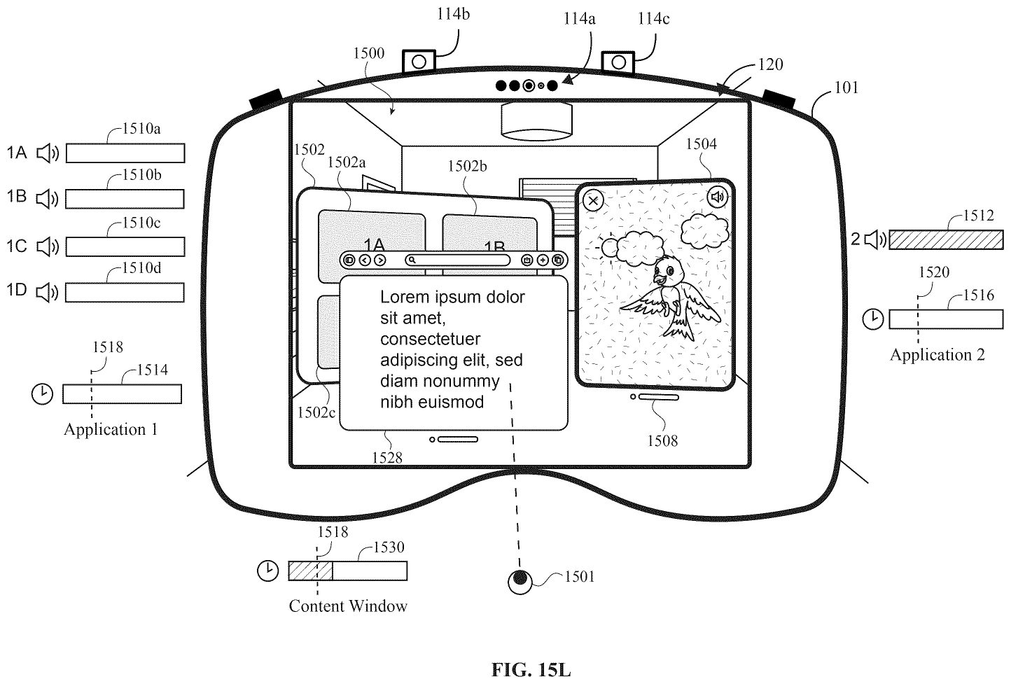

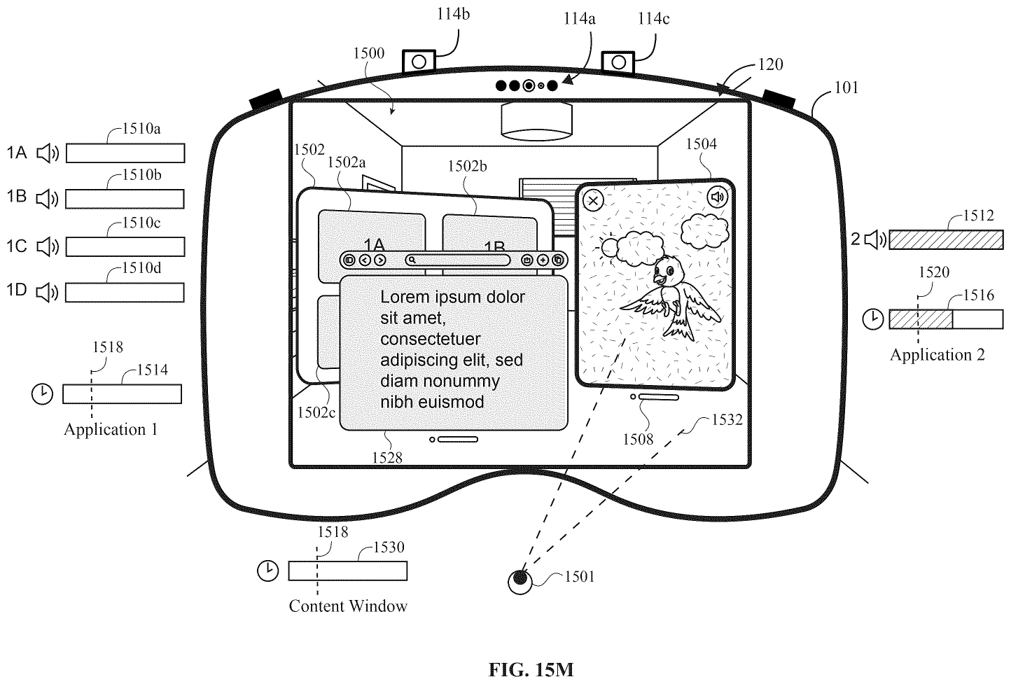

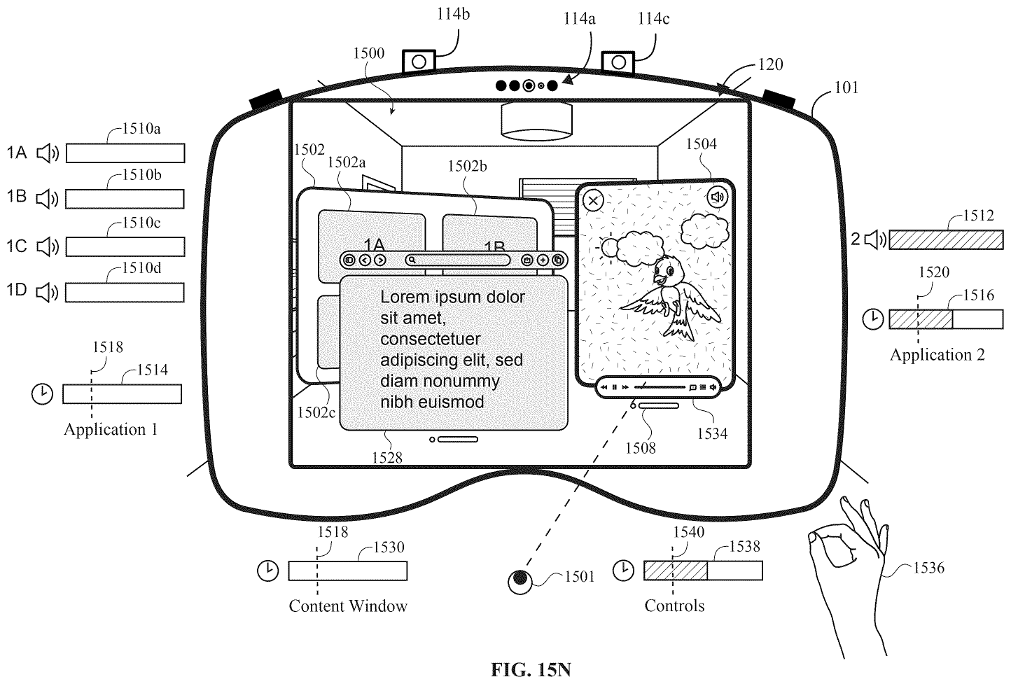

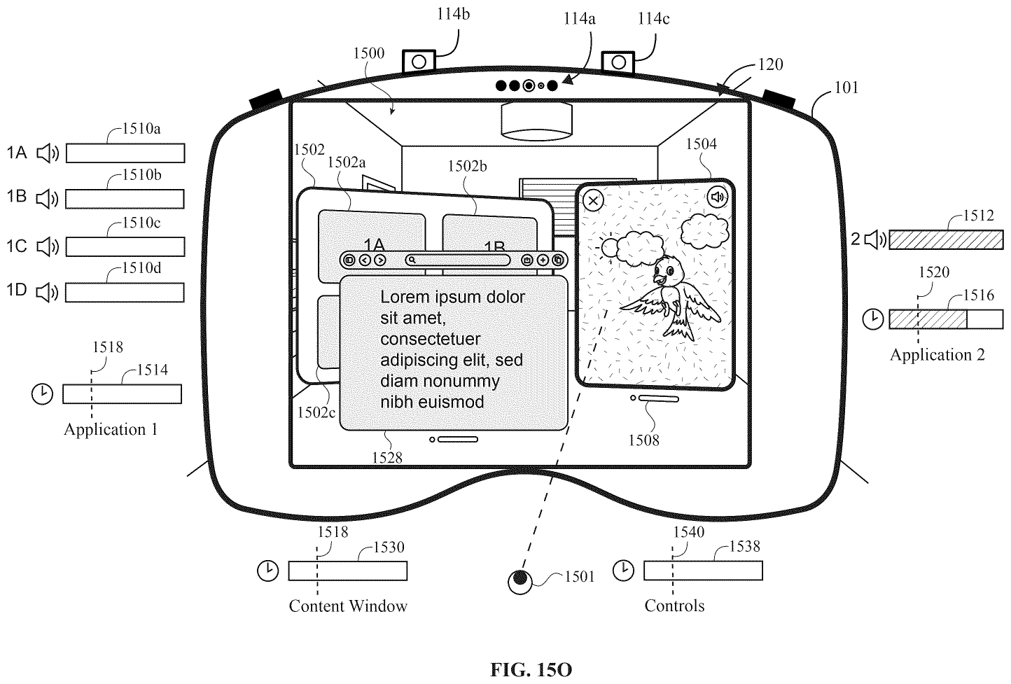

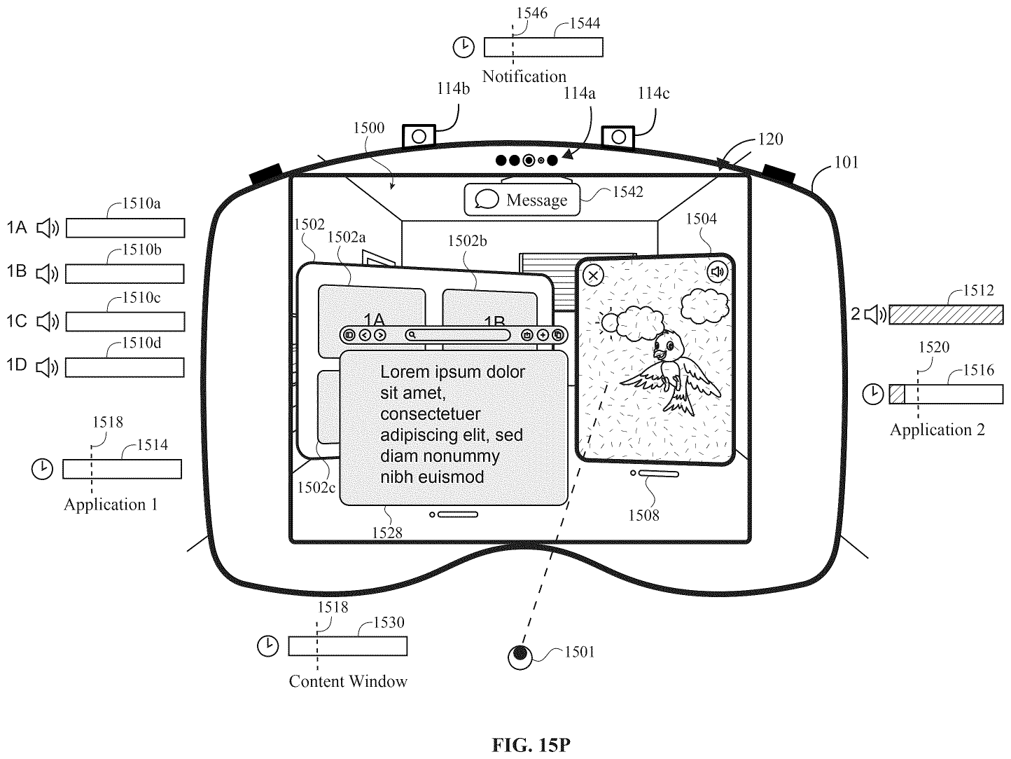

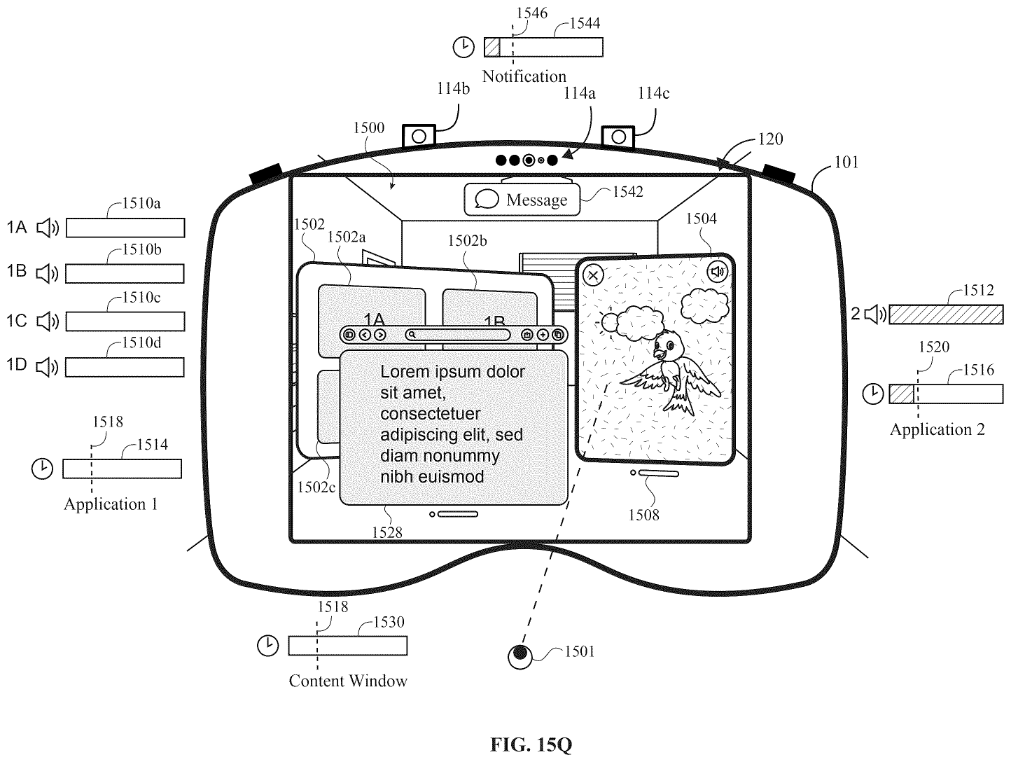

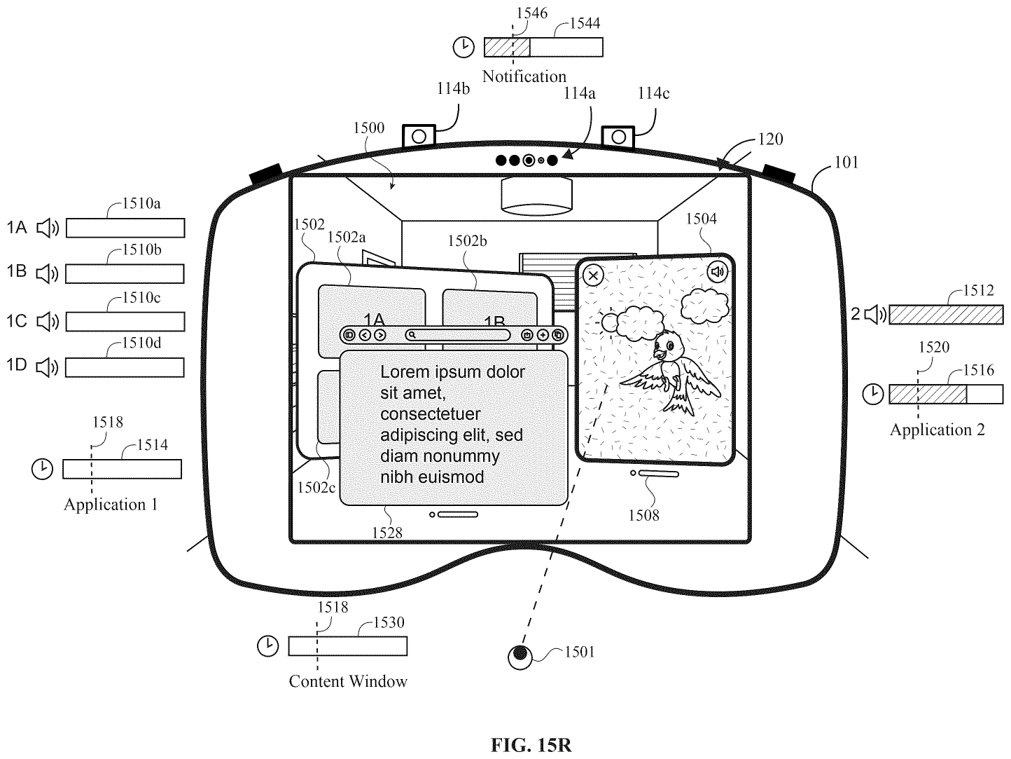

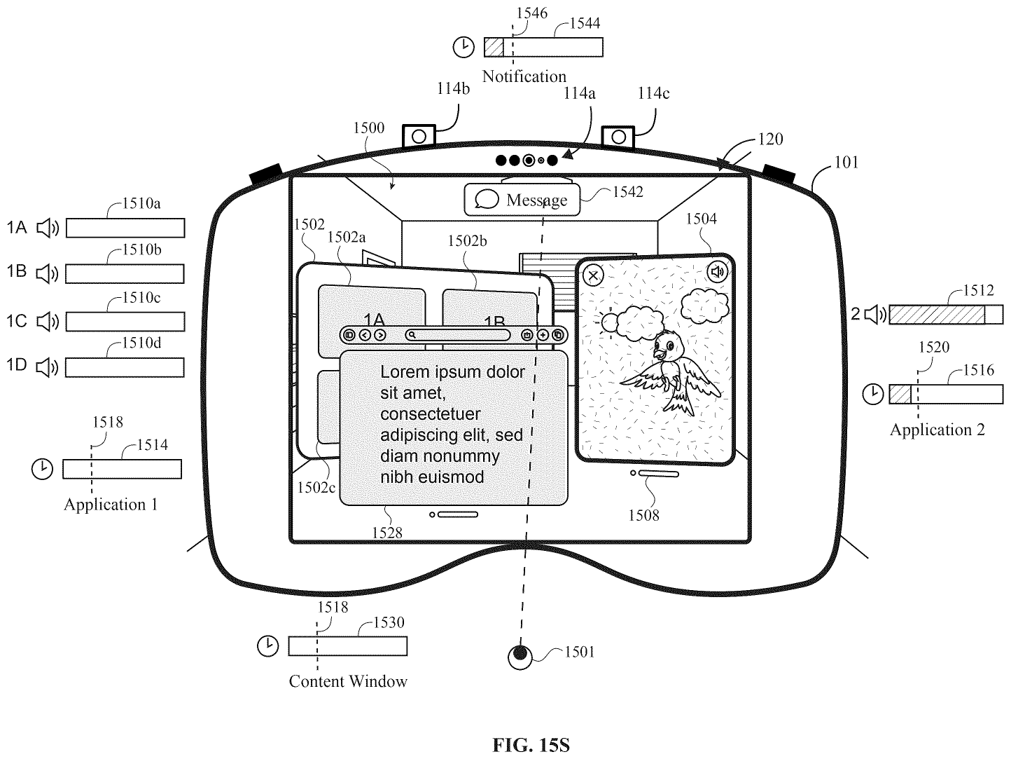

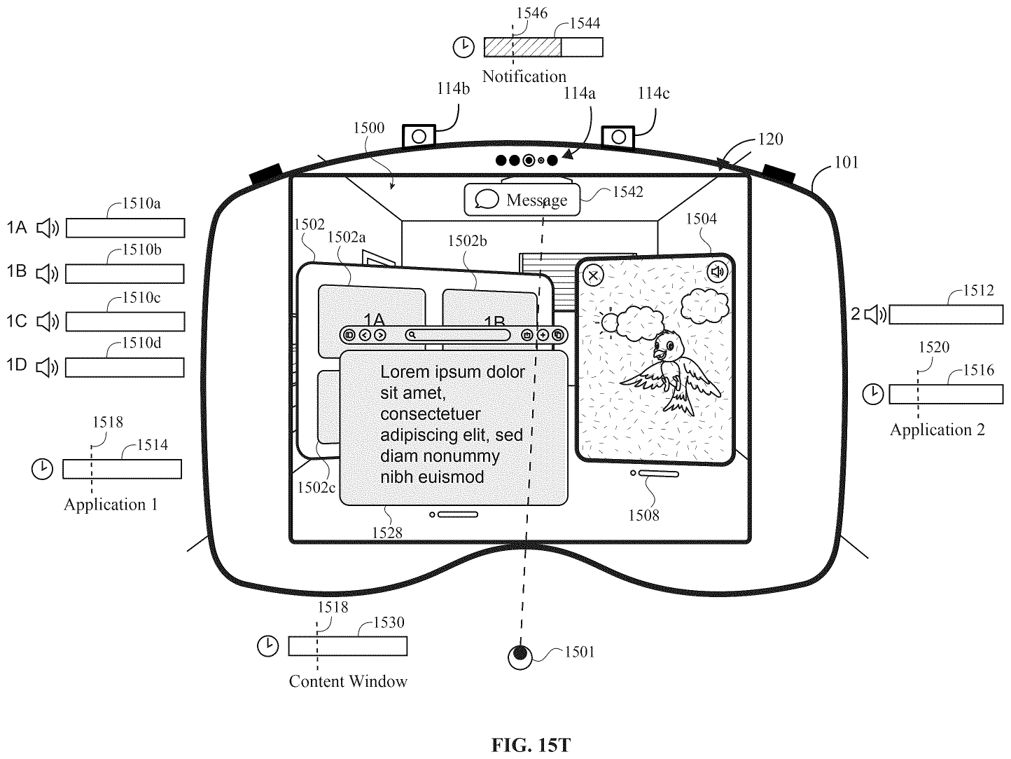

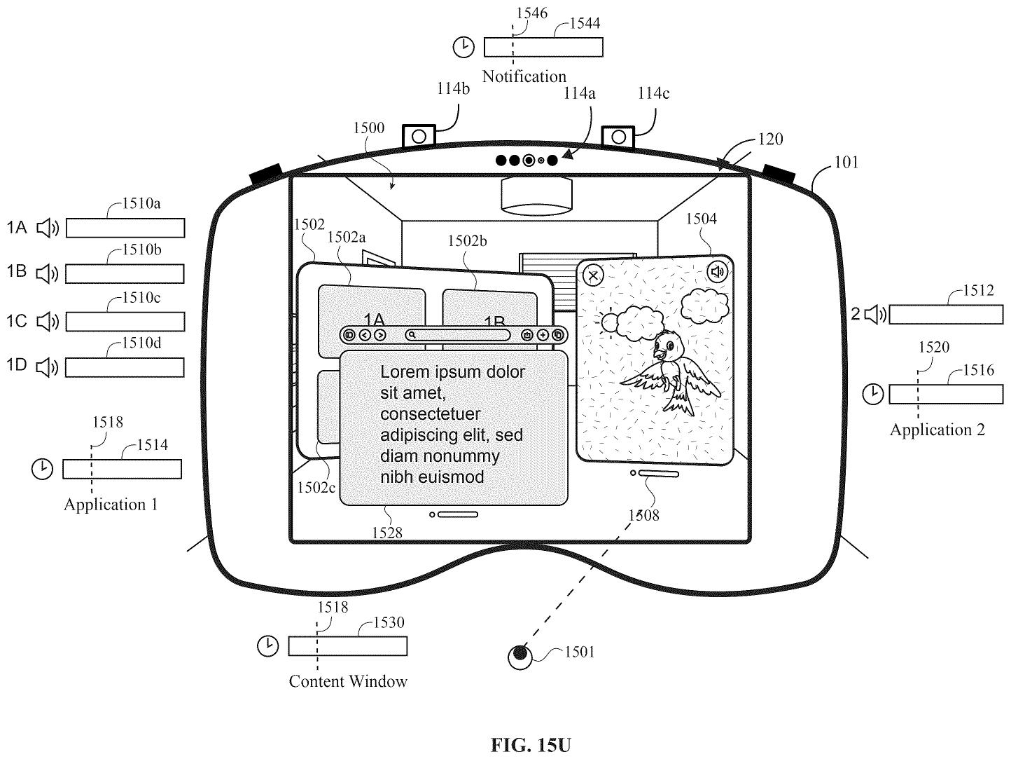

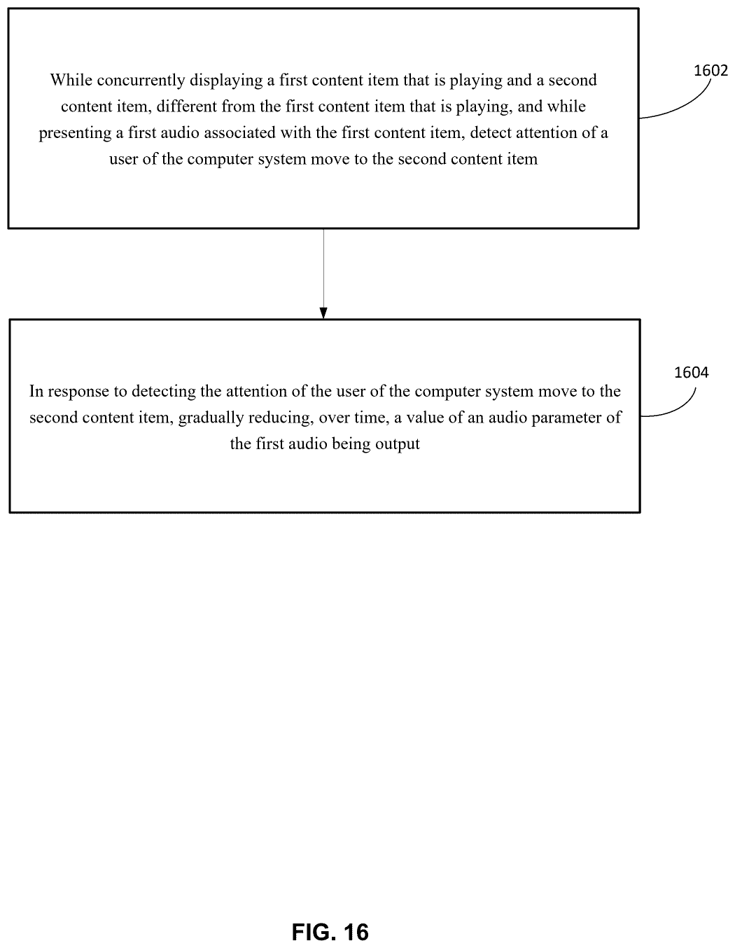

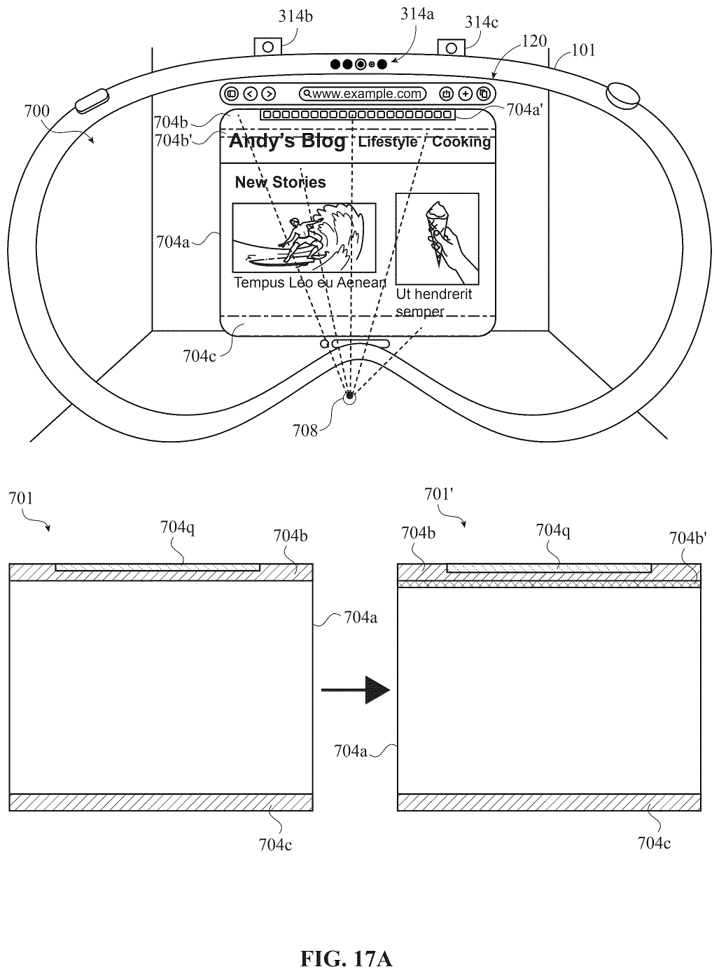

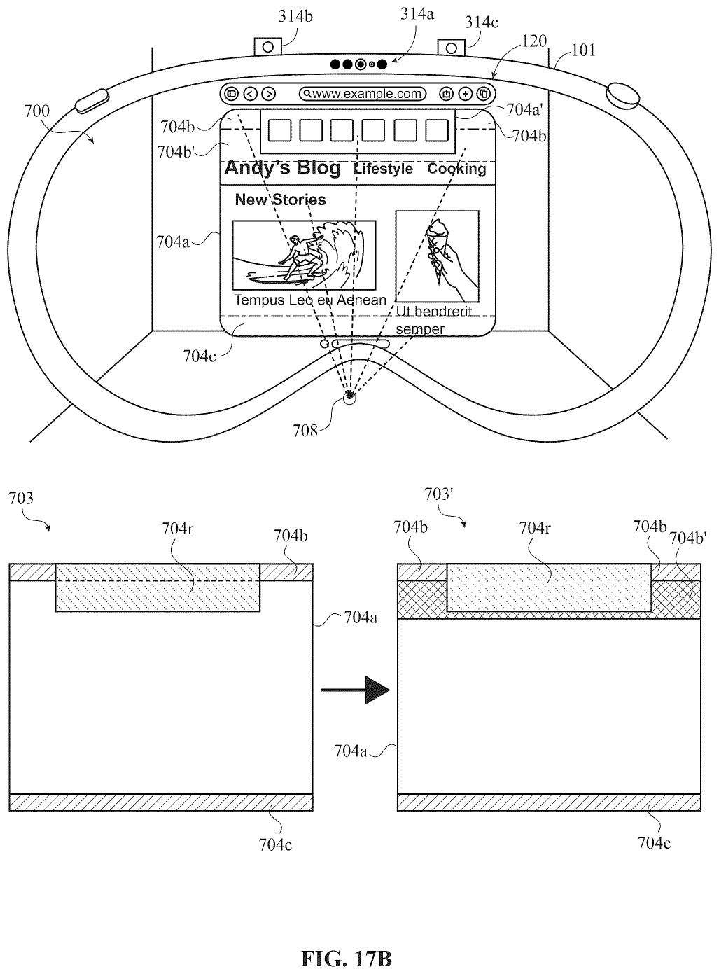

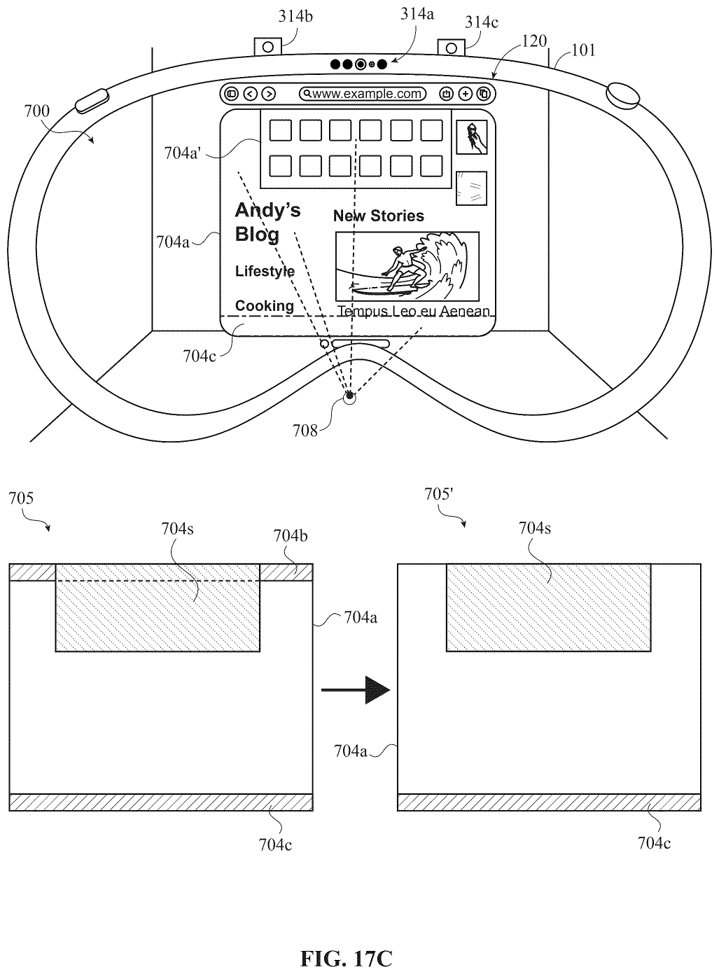

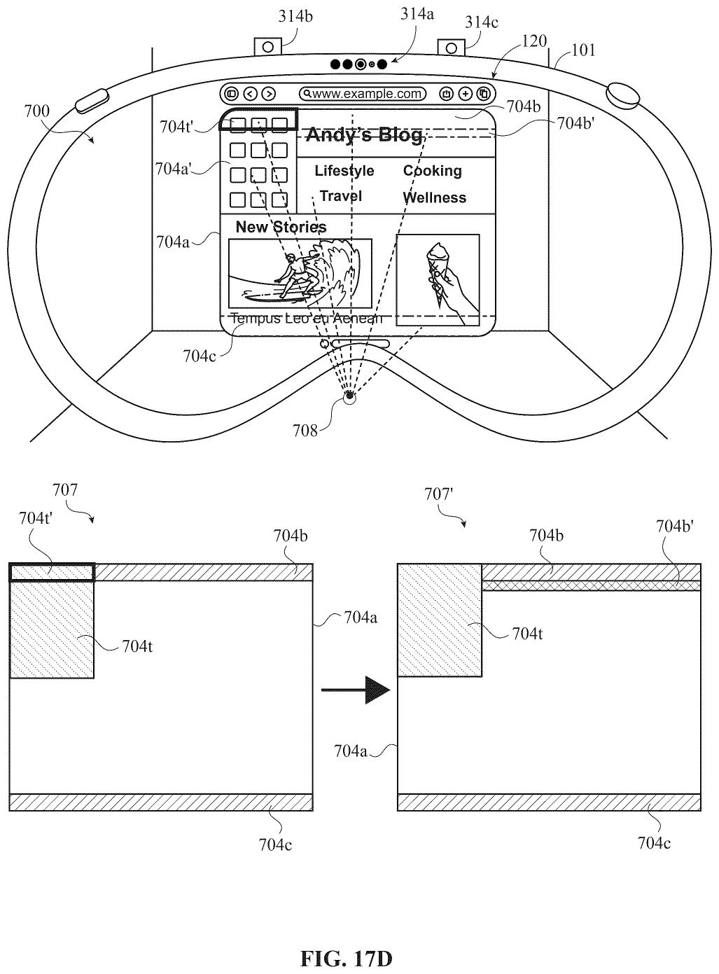

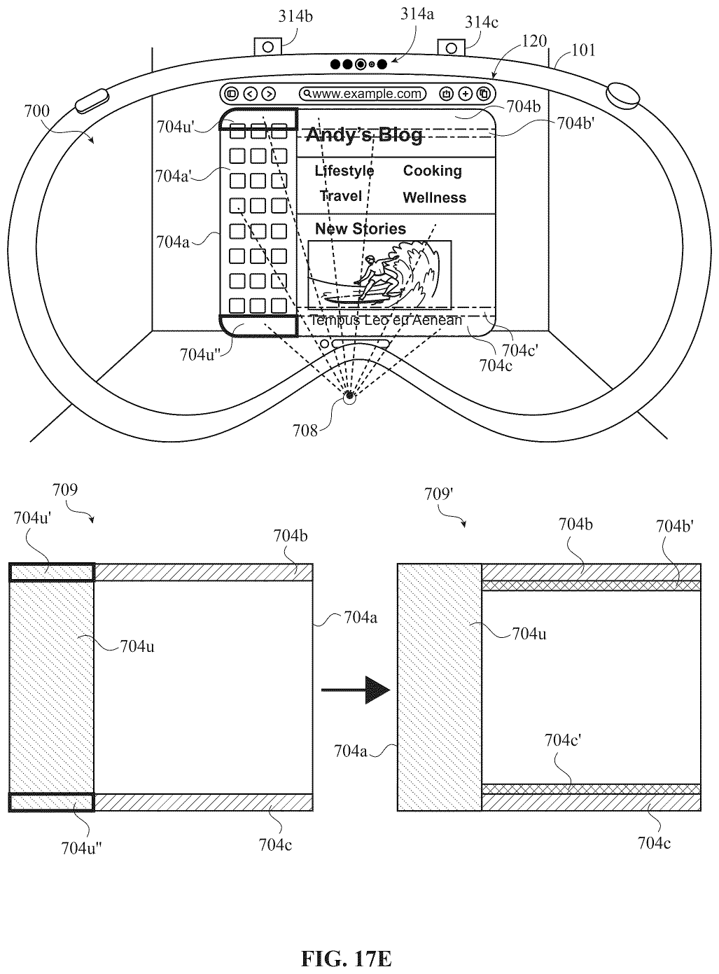

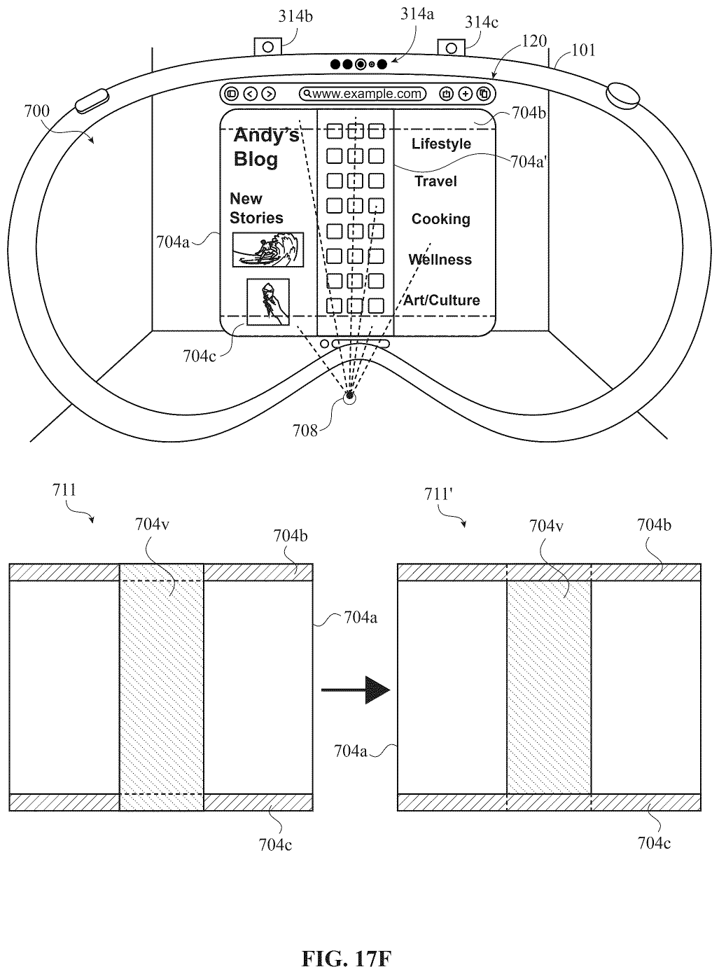

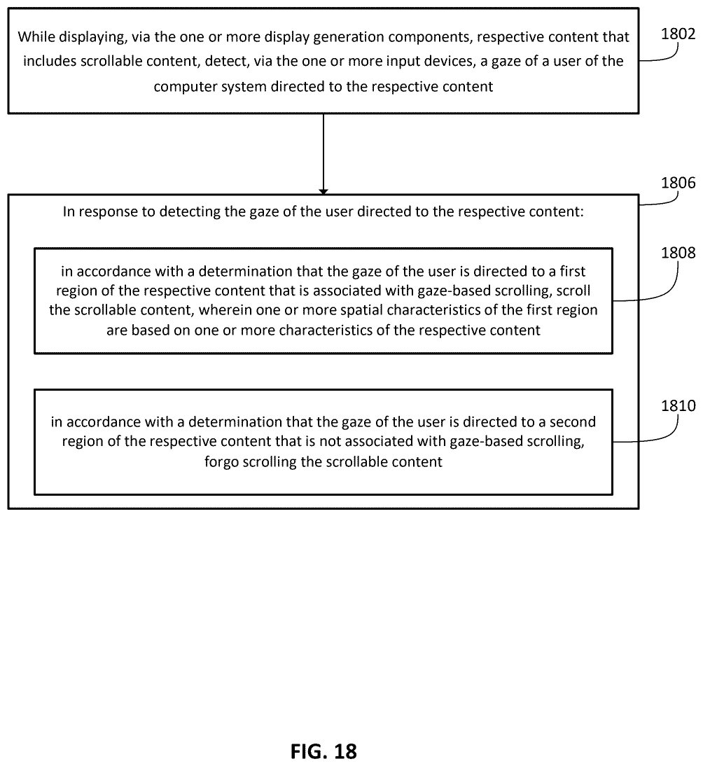

FIGS. 1A-6 provide a description of example computer systems for providing XR experiences to users (such as described below with respect to methods 800, 1000, 1200, 1400, and/or 1600). FIGS. 7A-7BB illustrate example techniques in which a computer system scrolls scrollable content in response to gaze-based inputs, in accordance with some embodiments. FIG. 8 illustrates a flow diagram of methods in which a computer system scrolls scrollable content in response to gaze-based inputs, in accordance with some embodiments. The user interfaces in FIGS. 7A-7BB are used to illustrate the processes in FIG. 8. FIGS. 9A-9KK illustrate example techniques in which a computer system scrolls scrollable content in response to gaze-based inputs and/or input provided by a respective input element, in accordance with some embodiments. FIG. 10 illustrates a flow diagram of methods in which a computer system scrolls scrollable content in response to gaze-based inputs and/or input provided by a respective input element, in accordance with some embodiments. The user interfaces in FIGS. 9A-9KK are used to illustrate the processes in FIG. 10. FIGS. 11A-11V illustrate example techniques for displaying a virtual object with an appearance based upon a duration of attention directed to the virtual object, in accordance with some embodiments. FIG. 12 illustrates a flow diagram of methods displaying a virtual object with an appearance based upon a duration of attention directed to the virtual object, in accordance with some embodiments. The user interfaces in FIGS. 11A-11V are used to illustrate the processes in FIG. 12. FIGS. 13A-13HH illustrate ways in which a computer system animates virtual objects based on animation curves in accordance with some embodiments. FIG. 14 illustrates a flow diagram of methods of animating virtual objects based on animation curves, in accordance with some embodiments. The user interfaces in FIGS. 13A-13HH are used to illustrate the processes in FIG. 14. FIGS. 15A-15U illustrate example techniques for transitioning playing of video content based on the detected attention of the user, in accordance with some embodiments. FIG. 16 illustrates a flow diagram of methods for transitioning playing of video content based on the detected attention of the user, in accordance with some embodiments. The user interfaces in FIGS. 15A-15U are used to illustrate the processes in FIG. 16. FIGS. 17A-17F illustrate example techniques for modifying gaze scrolling regions based on characteristics of content. FIG. 18 illustrates a flow diagram of methods for modifying gaze scrolling regions based on characteristics of content, in accordance with some embodiments. The user interfaces in FIGS. 17A-17F are used to illustrate the processes in FIG. 18.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

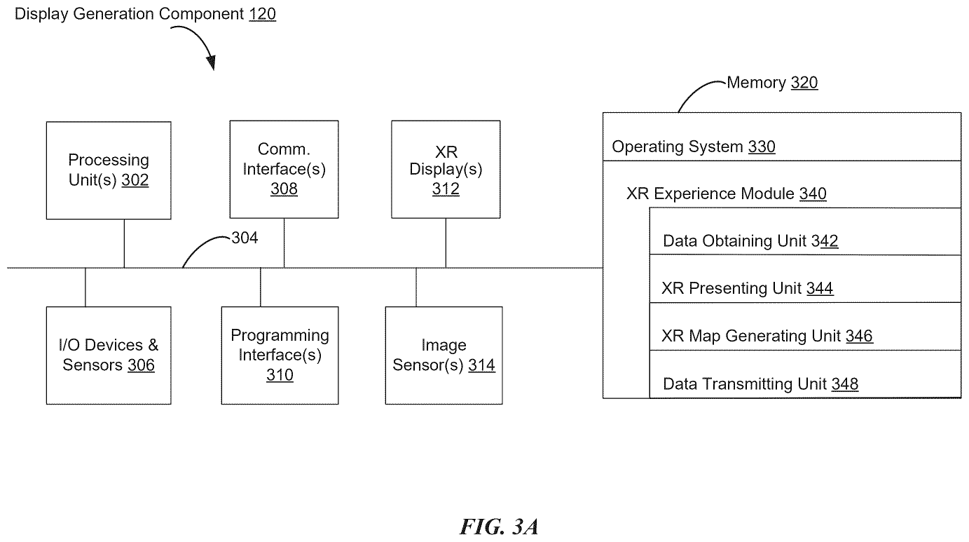

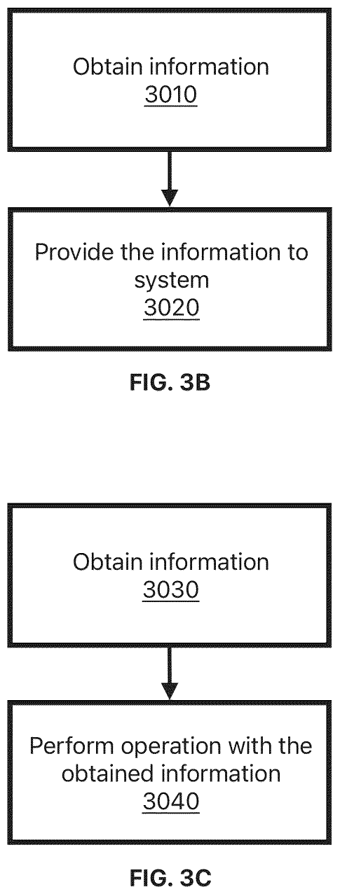

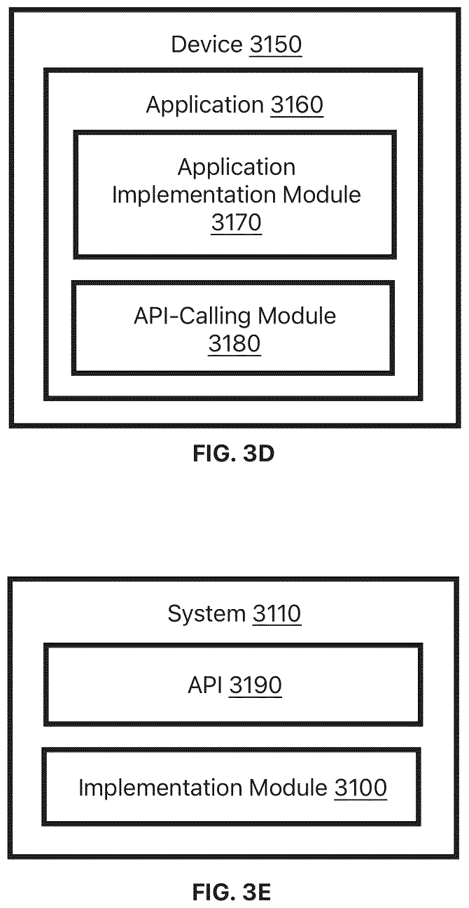

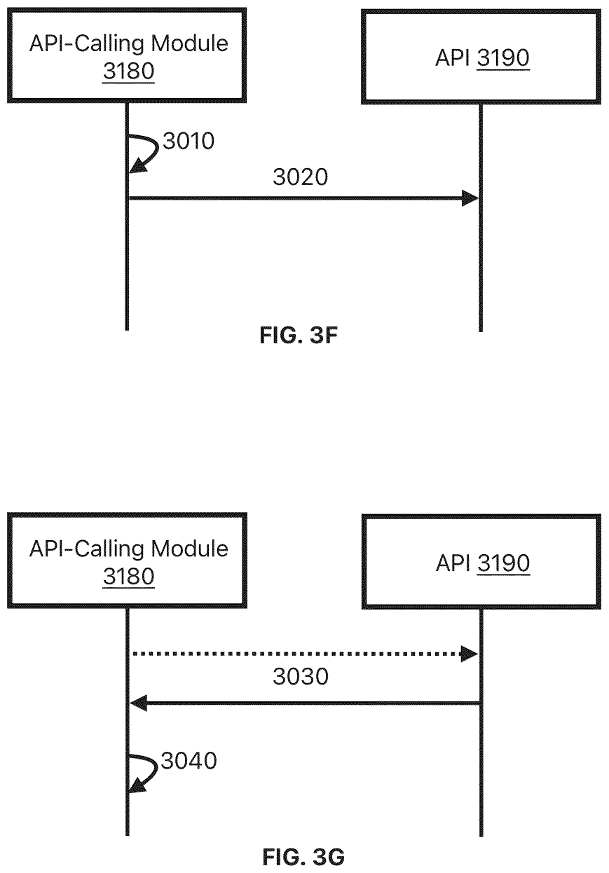

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-IF and described herein. Likewise, any of the features, components, and/or parts, including the arrangements and configurations thereof shown and described with reference to FIGS. 1B, 1C, and 1E-IF can be included, cither alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, cither alone or in any combination, in any of the other examples of devices, features, components, and parts shown in FIGS. 1B-1D and IF and described herein. Likewise, any of the features, components, and/or parts, including the arrangements and configurations thereof shown and described with reference to FIGS. 1B-1D and IF can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, cither alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, cither alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

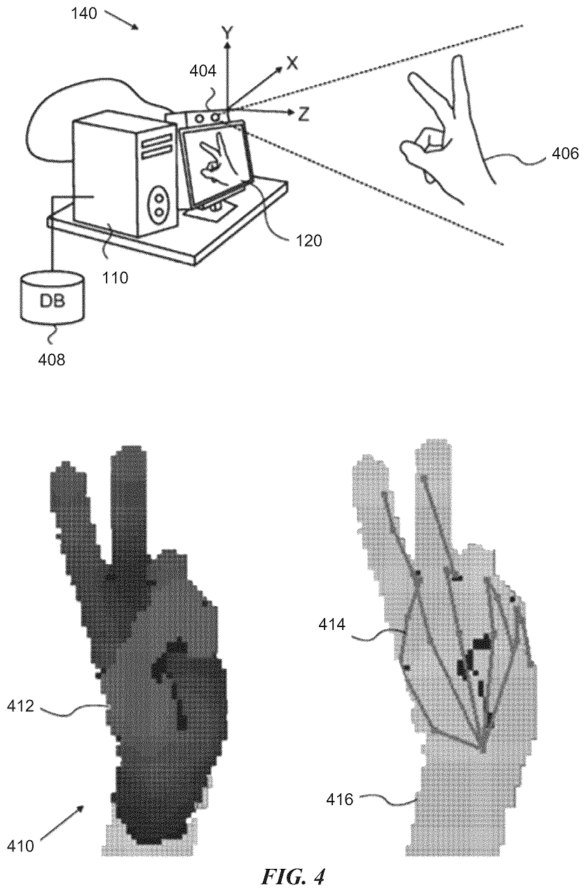

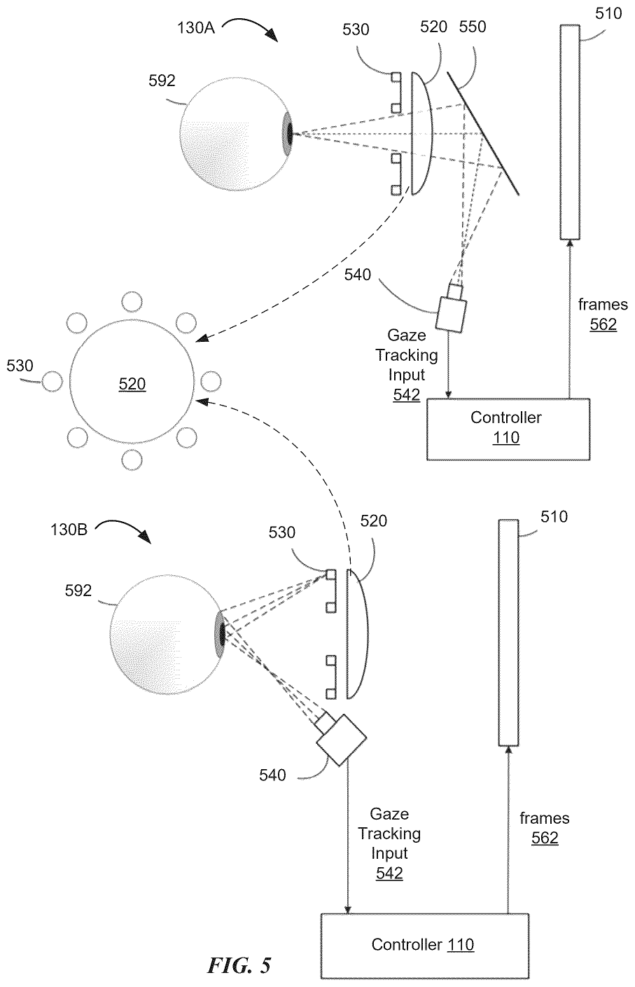

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior—and/or exterior—facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8), method 1000 (FIG. 10), method 1200 (FIG. 12), method 1400 (FIG. 14), method 1600 (FIG. 16), and/or method 1800 (FIG. 18) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

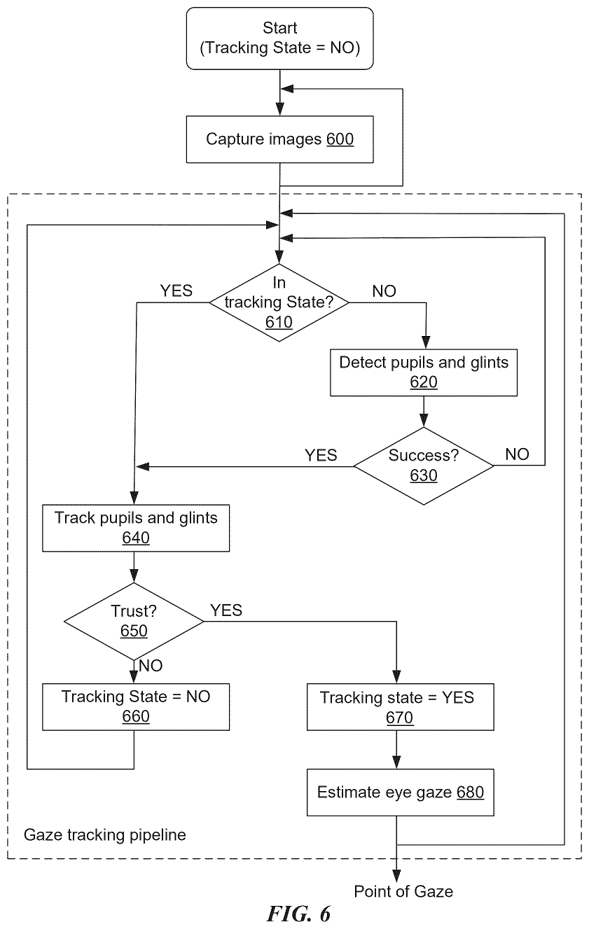

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7BB illustrate methods of and systems for scrolling scrollable content in response to gaze-based inputs in accordance with some embodiments of the disclosure. FIGS. 7A-7BB illustrate exemplary ways in which a computer system scrolls scrollable content in response to gaze-based inputs in accordance with some embodiments of the disclosure. The user interfaces in FIGS. 7A-7BB are used to illustrate the processes described below, including the processes in FIG. 8.

FIG. 7A illustrates a computer system 101 (e.g., an electronic device) displaying, via a display generation component 120 (e.g., display generation components 1-122a and 1-122b of FIG. 1), a three-dimensional environment 700 from a viewpoint of a user of the computer system 101. In FIG. 7A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 700. For example, three-dimensional environment 700 includes representations of the rear and side walls of the room in which the computer system 101 is located.

As discussed in more detail below, in FIG. 7A, display generation component 120 is illustrated as displaying one or more virtual objects in the three-dimensional environment 700. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 7A-7BB. Display generation component 120 has a field of view (e.g., a field of view captured by external image sensors 114b and 114c and/or visible to the user via display generation component 120) that corresponds to the virtual objects shown in FIG. 7A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

In FIG. 7A, three-dimensional environment 700 includes a plurality of virtual objects, such as user interfaces and/or user interface elements 704a, 706a, 718, and 720. In some embodiments, the virtual objects are optionally components of a user interface or window of an application containing scrollable content, such as a reading application, a media content application, a platform control application, or other application described with reference to method(s) 800, 1000, and/or 1200. In some embodiments, the term “scrollable content” refers to the user interface or window of the application. In some embodiments, the term “scrollable content” refers to content bounded to the user interface or window of the application. For example, in FIG. 7A, the computer system 101 displays internet browsing user interface element 704a (e.g., also referred to herein as a window or volume) of a web browser application containing website content, such as text, images, video, hyperlinks, and/or audio content, from the website. In FIG. 7A, internet browsing user interface element 704a includes a navigation user interface element 706a, control element 718, and control element 720. In some embodiments, the navigation user interface element 706a includes a side bar user interface button 706b that, when selected, causes the computer system 101 to expand internet browsing user interface element 704a to include additional content as will be described below. In some embodiments, navigation user interface element 706a includes an address bar and/or a plurality of user interface elements or buttons associated with the internet browsing user interface element 704a. As will be described in more detail with reference to FIGS. 9A-9KK and/or method 1000, control elements 718 and 720 are selectable to cause the computer system 101 to perform respective operations associated with the internet browsing user interface element 704a, such as closing (e.g., cease to display) internet browsing user interface element 704a or moving (and/or resize) the internet browsing user interface element 704a.

In FIG. 7A, internet browsing user interface element 704a includes scrollable content, such as an article that includes text-based content 704f, image-based content 704c, and additional content 716a. The internet browsing user interface element 704a includes a first scrolling region 704b and a second scrolling region 704c. As will be described in more detail below, in response to detecting the gaze of the user directed to the first scrolling region 704b or the second scrolling region 704c (e.g., without requiring additional user input as described below), the computer system 101 scrolls the scrollable content including the text-based content 704f and image-based content 704e respectively. In the example of FIG. 7A, the internet browsing user interface element 704a includes a third region 704d and in response to detecting the gaze of the user directed to the third region 704d, the computer system 101 does not scroll the scrollable content. In some embodiments, the third region 704d is not responsive to a gaze-only input (e.g., not including input from one or more portions of the user (e.g., hand, arm, and/or finger) of the computer system 101 other than those portions (e.g., eyes) providing the gaze input) as described with reference to method(s) 800 and/or 1000. In some embodiments, while the gaze of the user directed to the third region 704d, the computer system 101 detects that a respective input element (e.g., as described in method 1000) is providing an input to scroll the scrollable content, and in response, the computer system 101 scrolls the scrollable content in accordance with the respective input element as described in method 1000. For illustrative purposes, as shown in FIG. 7A and the figures that follow, the first scrolling region 704b, the second region 704c, and the third region 704d are bounded by dashed lines, and it should be understood that the dashed lines of the respective regions are optionally not displayed via the display generation component 120.

In some embodiments, when the computer system 101 scrolls the scrollable content vertically, the first scrolling region 704b is at the top of the internet browsing user interface element 704a and the second scrolling region 704c is at the bottom of internet browsing user interface element 704a. As shown in FIG. 7A, the second scrolling region 704c is larger than the first scrolling region 704b. In some embodiments, when the scrollable content is scrolled horizontally, the internet browsing user interface element 704a includes a left scrolling region and a right scrolling region that are disposed on the right and left sides of internet browsing user interface element 704a.

As mentioned above, the scrollable content includes additional content 716a as shown in FIG. 7A. In some embodiments, the additional content 716a includes embedded content, and/or selectable links to other content. For example, and as will be described in more detail below, additional content 716a includes a list of representations (e.g., icons, images, text, and/or other graphics) of other articles related to the article displayed in internet browsing user interface element 704a. In some embodiments, a representation of an article is selectable to display the article as will be described in more detail below.

In some embodiments, in response to detecting that the gaze of the user is directed to the first scrolling region 704b or the second scrolling region 704c, the computer system 101 displays a visual indication that a respective scrolling region is gaze scrolling enabled (e.g., responsive to gaze-based inputs) as will be described in more detail below and with reference to method(s) 800 and/or 1000. For example, in FIG. 7A, the second scrolling region 704c did not include a visual appearance (e.g., color, pattern, shading, brightness, and/or visual effect) before the computer system 101 detected gaze directed to the second scrolling region 704c. In FIG. 7B, in response to detecting gaze 708 directed to the second scrolling region 704c, the computer system 101 displays the second scrolling region 704c with a color or other visual appearance to emphasize the second scrolling region 704c relative to other regions (e.g., the first scrolling region 704b and the third region 704d) of the scrollable content (and/or the internet browsing user interface element 704a that includes the scrollable content). In some embodiments, the computer system 101 displays the second scrolling region 704c with the visual appearance for a predetermined amount of time (e.g., 1, 5, 10, 15, 30, 40, 50, or 60 seconds). In some embodiments, after the predetermined amount of time has elapsed, the computer system 101 does not display the second scrolling region 704c with the visual appearance as shown in FIG. 7C. In some embodiments, the computer system 101 displays the second scrolling region 704c with the visual appearance as long as gaze 708 is directed to the second scrolling region 704c. In some embodiments, and as will be described below, if the gaze 708 had been directed to the first scrolling region 704b, the computer system 101 would display the first scrolling region 704b with the visual appearance optionally analogous to and/or having one or more of the characteristics of displaying the second scrolling region 704c with the visual appearance as shown in FIG. 7B. In some embodiments, when the computer system 101 detects that gaze 708 is directed to the third region 704d, the computer system 101 does not display the third region 704d with the visual appearance because the third region 704d is not gaze scrolling enabled region as described in more detail with reference to method(s) 800 and/or 1000.

In some embodiments, in response to detecting that the gaze of the user is directed to the first scrolling region 704b or the second scrolling region 704c, the computer system 101 expands the respective region to which the gaze 708 is directed to as described in more detail with reference to method 800. For example, in FIG. 7A, the computer system 101 designates the second scrolling region 704c as responsive to gaze-only scrolling inputs. In FIG. 7B, in response to detecting gaze 708 directed to the second scrolling region 704c, the computer system 101 designates a fourth region 704h, different from and adjacent to the second scrolling region 704c, as responsive to gaze-only scrolling inputs. Thus, in some embodiments, and as shown in FIG. 7B, the computer system expands a size of a respective scrolling region responsive to gaze-only inputs to include the second scrolling region 704c and the fourth region 704h. In some embodiments, the computer system 101 expands the respective scrolling region in response to detecting the gaze 708 directed to second scrolling region 704c as described in more detail in method 800. In some embodiments, the computer system 101 expands the respective scrolling region in response to and/or while scrolling the scrollable content in accordance with the gaze directed to the second scrolling region 704c as described below and in more detail with reference to method 800.

In some embodiments, the computer system 101 implements the fourth region 704h as responsive to gaze-only scrolling inputs as long as gaze 708 is directed to the second scrolling region 704c or the fourth region 704h. In some embodiments, when the computer system 101 no longer detects that gaze 708 is directed to the second scrolling region 704c or the fourth region 704h (e.g., the gaze 708 is directed to the third region 704d, different from the second scrolling region 704c and the fourth region 704h), the computer contracts the respective scrolling region (e.g., the computer system does not designate the fourth region 704h responsive to gaze-only scrolling inputs as shown in FIG. 7A. In some embodiments, and as will be described below, if the gaze 708 had been directed to the first scrolling region 704b, the computer system 101 expands the first scrolling region 704b to include a region different from and adjacent to the first scrolling region as responsive to gaze-only scrolling inputs.

In FIG. 7B, timer 724a indicates the amount of time gaze 708 has been directed to the second scrolling region 704c. For example, the computer system 101 determines that the duration of the gaze 708 directed to the second scrolling region 704c is less than a first time threshold 724b and in response, the computer system 101 does not scroll the scrollable content. FIG. 7B also includes speed indicator 722 indicative of the speed at which the computer system 101 scrolls the scrollable content. In FIG. 7B, speed indicator 722 has a zero value (e.g., “S0”) which indicates that the scrollable content is not yet being scrolled in response to the gaze 708 of the user.

FIG. 7C illustrates the computer system 101 scrolling the scrollable content in response to determining that the duration of the gaze 708 directed to the second scrolling region 704c exceeds the first time threshold 724b. As shown in FIG. 7C, in response to detecting the gaze 708 of the user directed to the second scrolling region 704c (e.g., the bottom region), the computer system 101 scrolls the scrollable content up to reveal additional scrollable content at the bottom of the internet browsing user interface element 704a. In some embodiments, and as will be described below, if the gaze 708 had been directed to the first scrolling region 704b (e.g., the top region), the computer system 101 would scroll the scrollable content 702 down to reveal additional scrollable content at the top of the internet browsing user interface element 704a. In some embodiments, the speed at which the computer system 101 scrolls the scrollable content is based on a location of the gaze 708 from an edge of the second scrolling region 704c. As shown in FIG. 7C, in response to detecting that a location of the gaze 708 is a first distance 726 from the top edge of the second scrolling region 704c, the computer system 101 scrolls the scrollable content at a first speed (e.g., “S2”) as indicated by speed indicator 722.

In some embodiments, the computer system 101 changes the speed at the which the scrollable content is scrolled based on a distance between the location of the gaze from a respective edge of a respective scrolling region. In FIG. 7D, the computer system detects the location of the gaze 708 is a second distance 730, greater than the first distance 726, from the top edge of the second scrolling region 704. In some embodiments, in response to detecting the location of the gaze 708 is the second distance 730 from the edge of the second scrolling region 704, the computer system 101 scrolls the scrollable content at a second speed (e.g., “S4”) as indicated by speed indicator 722. The second speed in FIG. 7D is greater than the first speed in FIG. 7C. In some embodiments, if the gaze 708 had been directed to the first scrolling region 704b, the computer system 101 would determine the location of the gaze 708 relative to the top region of the first scrolling region 704b. For example, when the computer system 101 detects the location of the gaze 708 closer to the top edge of the first scrolling region 704b (e.g., a first distance from the top edge of the first scrolling region 704b), the computer system 101 scrolls the scrollable content at a speed greater than a respective speed when the computer system 101 detects the location of the gaze 708 farther from the top region of the first scrolling region 704b (e.g., a second distance, greater than the first distance, from the top of the first scrolling region 704b).

In some embodiments, and as previously described, the scrollable content (and/or the internet browsing user interface element 704a that includes the scrollable content) includes additional content 716a as shown in FIG. 7E. The additional content 716a optionally includes embedded content, and/or selectable links to other content as described above. In some embodiments, the computer system 101 scrolls the additional content in a same manner (e.g., speed and/or direction) as the scrollable content. For example, in response to detecting the gaze 708 of the user directed to the second scrolling region 704c (e.g., the bottom region) in FIG. 7C, the computer system 101 scrolls the additional content 716a up to reveal additional representations of links to other content (e.g., articles) at the bottom of the internet browsing user interface element 704a. In some embodiments, while the computer system 101 scrolls the scrollable content in response to gaze 708 directed to a respective scrolling region (e.g., the first scrolling region 704b or the second scrolling region 704c), the computer system 101 moves the additional content 716a in accordance with scrolling the scrollable content (e.g., same speed and/or direction) as shown in FIGS. 7B-7D. In some embodiments, while the computer system scrolls the additional content 716a in accordance with scrolling the scrollable content, the additional content 716a itself is separately scrollable as described below with respect to scrolling the additional content 716a in accordance with movement of a respective input element.

In some embodiments, while the computer system 101 scrolls the scrollable content in response to gaze 708 directed to the second scrolling region 704c as described above, the computer system 101 detects the gaze 708 moving from being directed to the second scrolling region 704c in FIG. 7D to being directed to a bottom region of additional content 716a, such as shown in FIG. 7E. In response, the computer system 101 stops scrolling the scrollable content (e.g., the scrolling speed is zero, “S0” as shown by indicator 722). In some embodiments, the additional content 716a is not responsive to gaze-only scrolling inputs similarly to the third region 704d as described above.

FIG. 7F illustrates that while the gaze 708 is directed to the bottom region of additional content 716a, the computer system 101 detects that a respective input element (e.g., described in more detail with reference to method 1000) is providing an input to scroll the additional content 716a, and in response, the computer system 101 scrolls the additional content 716a in accordance with movement of a respective input element (e.g., the hand 734 of the user of computer system 101) as shown in FIG. 7G. In some embodiments, the computer system 101 optionally scrolls the additional content 716a with a magnitude and/or direction corresponding to the movement of the hand 734 of the user (e.g., scrolls the scrollable content upward if a hand moves upward, and scrolls the scrollable content downward if the hand moves downward). For example, in FIG. 7G, the computer system 101 detects a gesture that includes hand 734 performing a pinch gesture (e.g., as described in more detail with reference to method(s) 800 and/or 1000) and movement of the hand 734 upwards while engaged in the pinch gesture (e.g., from a first location to a second location of the hand 744) while the gaze 708 of the user is directed to the bottom region of additional content 716a and, in response, the computer system 101 scrolls the additional content 716a up to reveal additional content at the bottom of the additional content 716a. FIG. 7G illustrates a speed (e.g., “S3”) corresponding to the movement of hand 734 as indicated by speed indicator 732. In some embodiments, although FIG. 7G illustrates that a duration of the gaze 708 is directed to the bottom region of the additional content 716a for less than time threshold 728b as shown by time 728a, the computer system 101 scrolls the additional content 716a in accordance with the movement of hand 734. In some embodiments, although FIG. 7G illustrates the location of gaze 708 directed to a respective location that is within the second scrolling region 704c that is responsive to gaze-only scrolling inputs as described above, in some embodiments, the computer system 101 scrolls the additional content 716a in response to an input including the movement of hand 734 and the gaze 708 of the user directed to the bottom region of the additional content 716a. In some embodiments, if the computer system detected movement of the hand 734 downwards while the gaze is directed to the additional content 716a, the computer system 101 would scroll the scrollable content 702 up to reveal content at the top of the additional content 716a. It is understood that when the hand of the user is described as performing a gesture, the hand of the user is optionally performing an air gesture.

In some embodiments, the computer system 101 ceases scrolling the additional content 716a in response to detecting the gaze 708 of the user moving from being directed to the additional content 716a to being directed to the first scrolling region 704b or in response to detecting the respective input element (e.g., hand of the user) is no longer engaged (e.g., not providing an input to scroll the additional content 716a). For example, as illustrated in FIG. 7H, the computer system 101 stops scrolling the additional content 716a as indicated by speed indicator 732 with a zero value (e.g., “S0”) in response to the computer system 101 detecting an un-pinch hand 736.

In FIG. 7H, in response to detecting that the gaze 708 of the user is directed to the first scrolling region 704b, the computer system 101 designates a fifth region 704i responsive to gaze-only scrolling inputs in a manner similar to the manner described above with reference to the first scrolling region 704b. FIG. 7H also illustrates the timer 724a indicative of the amount of time gaze 708 has been directed to the first scrolling region 704b. For example, the computer system 101 determines that the duration of the gaze 708 directed to the first scrolling region 704b is less than the first time threshold 724b and in response, the computer system 101 does not scroll the scrollable content. FIG. 7H also includes speed indicator 722 indicative of the speed at which the computer system 101 scrolls the scrollable content. In FIG. 7H, speed indicator 722 has a zero value (e.g., “S0”).

FIG. 7I illustrates the computer system 101 scrolling the scrollable content in response to determining that the duration of the gaze 708 directed to the first scrolling region 704b exceeds the first time threshold 724b. As shown in FIG. 7I, in response to detecting the gaze 708 of the user directed to the first scrolling region 704b (e.g., the top region), the computer system 101 scrolls the scrollable content down to reveal additional scrollable content at the top of the internet browsing user interface element 704a. In some embodiments, the computer system 101 detects the location of the gaze 708 is a distance 750 from the top edge of the first scrolling region 704b. In some embodiments, in response to detecting the location of the gaze 708 is the distance 750 from the top edge of the first scrolling region 704b, the computer system 101 scrolls the scrollable content in a manner similar to scrolling the scrollable content in response to the location of the gaze 708 within the second scrolling region 704c described in FIG. 7D. For example, as illustrated in FIG. 7I, the computer system 101 scrolls the scrollable content at a speed (e.g., “S4”) as indicated by speed indicator 722.

In some embodiments, the computer system 101 increases the speed at which the computer system 101 scrolls the scrollable content in response to a determination that the gaze is directed to content of a particular type (e.g., text-based content or image-based content) described below and in more detail with reference to method 800. For example, while the computer system 101 scrolls the scrollable content in response to gaze 708 directed to the first scrolling region 704b at a first speed (e.g., “S4”) as indicated by speed indicator 722 in FIG. 7I and as described above, the computer system 101 detects the gaze 708 moving from being directed to a first location within the first scrolling region 704b as shown in FIG. 7I to being directed to a second location within the first scrolling region 704b as shown in FIG. 7J. In some embodiments, the second location within the first scrolling region 704b to which the gaze 708 is directed includes image-based content 704c. In some embodiments, when the computer system 101 determines that the gaze 708 is directed to image-based content 704e in the first scrolling region 704b, the computer system 101 scrolls the scrollable content at a second speed (e.g., “S6”) as indicated by speed indicator 722. In some embodiments, the second speed is greater than the first speed in FIG. 7I.

In some embodiments, while the computer system 101 scrolls the scrollable content in response to gaze 708 directed to image-based content 704e in the first scrolling region 704b as described above, the computer system 101 detects the gaze 708 moving from being directed to the first scrolling region 704b in FIG. 7J to being directed to the third region 704d, such as shown in FIG. 7K. In response, the computer system 101 stops scrolling the scrollable content (e.g., the scrolling speed is zero, “S0” as shown by indicator 722) and resets the gaze duration of gaze directed to the first scrolling region 704b to zero in FIG. 7K. In some embodiments, the third region is not responsive to gaze-only scrolling inputs as described above and in more detail with reference to method 800.

As described above, the computer system 101 changes the speed at which the computer system 101 scrolls the scrollable content in response to a determination that the gaze is directed to content of a particular type (e.g., text-based content or image-based content). For example, a determination that gaze is directed to image-based content is optionally based on detection of movement of the gaze from a first location corresponding to text-based content to a second location corresponding to image-based content. For example, determination that gaze is directed to text-based content is optionally based on detection of movement of the gaze from a first location corresponding to image-based content to a second location corresponding to text-based content. In another example, a determination that gaze is directed to image-based content is optionally caused by scrolling, in that scrolling optionally changes the type of content displayed at a location corresponding to the respective location of the gaze (e.g., changing and/or revealing image-based content different from the previously displayed text-based content) where the computer system detects that the content at the gaze location is image-based content after the scrolling occurs. In another example, a determination that gaze is directed to text-based content is optionally caused by scrolling, in that scrolling optionally changes the type of content displayed at a location corresponding to the respective location of the gaze (e.g., changing and/or revealing text-based content different from the previously displayed image-based content) where the computer system detects that the content at the gaze location is text-based content after the scrolling occurs.

For example, as illustrated in FIG. 7L, in response to detecting that the gaze 708 of the user is directed to the second scrolling region 704c, the computer system 101 changes the visual appearance of the second scrolling region 704c and designates a respective region different from and adjacent to the second scrolling region 704c as responsive to gaze-only scrolling inputs in a manner similar to expanding and displaying the visual appearance of the second scrolling region 704c described above. FIG. 7L also illustrates the timer 724a indicative of the amount of time gaze 708 has been directed to the second scrolling region 704c. For example, the computer system 101 determines that the duration of the gaze 708 directed to the second scrolling region 704c is less than the first time threshold 724b and in response, the computer system 101 does not scroll the scrollable content. FIG. 7L also includes speed indicator 722 indicative of the speed at which the computer system 101 scrolls the scrollable content. In FIG. 7L, speed indicator 722 has a zero value (e.g., “S0”).

FIG. 7M illustrates the computer system 101 scrolling the scrollable content at a first speed (e.g., “S3”) as indicated by speed indicator 722 in response to determining that the gaze 708 is directed to text-based content. For example, the duration of the gaze 708 directed to the second scrolling region 704c exceeds the first time threshold 724b. As shown in FIG. 7M, the computer system 101 determines that the gaze 708 is directed to text-based content in the second scrolling region 704c, and in response, the computer system 101 scrolls the scrollable content at the first speed (e.g., “S3”) as indicated by speed indicator 722. In some embodiments, in response to detecting the location of the gaze 708 is a distance 752 from the edge of the second scrolling region 704c, the computer system 101 scrolls the scrollable content at the first speed (e.g., “S3”) as indicated by speed indicator 722. The first speed in FIG. 7M is greater than the respective speed in FIG. 7C in accordance with the determination that the distance 752 is greater than the distance 726, from the top edge of the second scrolling region 704c.

In some embodiments, while the computer system 101 scrolls the scrollable content at the first speed (e.g., “S3”) as indicated by speed indicator 722 in FIG. 7M, the respective location of gaze 708 is fixed (e.g., does not change or move). In some embodiments, scrolling changes the content displayed at a location corresponding to the respective location of the gaze. For example, the currently displayed portion of the scrollable content to which the gaze 708 of the user is directed changes from the text-based content in FIG. 7M to the image-based content in FIG. 7N, and in response, the computer system 101 optionally changes (e.g., increases) the scrolling speed from the first speed (e.g., “S3”) as indicated by speed indicator 722 in FIG. 7M to the second speed (e.g., “S5”) as indicated by speed indicator 722 in FIG. 7N.

In some embodiments, while the computer system 101 scrolls the scrollable content at the second speed (e.g., “S5”) as indicated by speed indicator 722 in FIG. 7N, the respective location of gaze 708 is fixed (e.g., does not change or move). In some embodiments, the currently displayed portion of the scrollable content to which the gaze 708 of the user is directed changes from the image-based content in FIG. 7N to the text-based content in FIG. 7O, and in response, the computer system 101 optionally changes (e.g., decreases) the scrolling speed from the second speed (e.g., “S5”) as indicated by speed indicator 722 in FIG. 7N to the first speed (e.g., “S3”) as indicated by speed indicator 722 in FIG. 7O.

In some embodiments, the scrolling speed increases as the duration of the gaze 708 of the user directed to the second scrollable region 704c increases (e.g., length of time the gaze of the user is directed to the second scrollable region 704c). For example the duration of gaze 708 directed to the second scrollable region 704c has increased from FIG. 7N to FIG. 7O, but still has not reached the second threshold 724c. From FIG. 7O to FIG. 7P, the duration of gaze 708 directed to the second scrollable region 704c has increased again, and has exceeded the second threshold 724c. In response the duration of gaze 708 exceeding the second threshold 724c, the computer system 101 changes (e.g., increases) the scrolling speed from the first speed (e.g., “S3”) as indicated by speed indicator 722 in FIG. 7O to a third speed (e.g., “S6”) as indicated by speed indicator 722 in FIG. 7P.

In some embodiments, while scrolling the scrollable content at a respective speed, the computer system determines that an end of the scrollable content is reached, and in response, the computer system decreases the speed at which the scrollable content is scrolled. For example, from FIG. 7P to FIG. 7Q, the duration of gaze 708 directed to the second scrollable region 704c has increased again, and in response the computer system 101 changes (e.g., increases) the scrolling speed from the third speed (e.g., “S6”) as indicated by speed indicator 722 in FIG. 7P to a fourth speed (e.g., “S8”) as indicated by speed indicator 722 in FIG. 7Q. In FIG. 7Q, while the computer system 101 scrolls the scrollable content at the fourth speed, the computer system determines that an end of the scrollable content is reached (e.g., when a boundary 704g or edge of the scrollable content is displayed), and in response, the computer system 101 changes (e.g., decreases) the scrolling speed from the fourth speed (e.g., “S8”) as indicated by speed indicator 722 in FIG. 7Q to a fifth speed (e.g., “S1”) as indicated by speed indicator 722 in FIG. 7R. In some embodiments, the computer system 101 slows the scrolling speed to a stop. From FIG. 7Q to FIG. 7R, the computer system 101 presents the scrollable content using a rubber band effect (e.g., as described with respect to method 800) at the edge of the internet browsing user interface element 704a when the boundary 704g of the scrollable content is reached.

In the example of FIG. 7R, the internet browsing user interface element 704a includes content 712c that is horizontally scrollable using gaze-based inputs. In some embodiments, the content 712c includes a collection of photos or other content. In some embodiments, while the computer system 101 scrolls the scrollable content in response to gaze 708 directed to the second scrollable region 704c as shown in FIG. 7R and described above, the computer system 101 detects the gaze 708 moving from being directed to the second scrolling region 704c in FIG. 7R to being directed to a right scrolling region 712b of content 712c, such as shown in FIG. 7S. In response, the computer system 101 optionally stops scrolling the scrollable content (e.g., the scrolling speed is zero, “S0” as shown by indicator 722).

As illustrated in FIG. 7S, in response to detecting that the gaze 708 of the user is directed to the right scrolling region 712b of content 712c, the computer system 101 expands and changes a visual appearance of the right scrolling region 712b in a manner similar to expanding and changing a visual appearance of the second scrolling region 704c described above. FIG. 7S also illustrates the timer 724a indicative of the amount of time gaze 708 has been directed to the right scrolling region 712b. For example, the computer system 101 determines that the duration of the gaze 708 directed to the right scrolling region 712b is less than the first time threshold 724b and in response, the computer system 101 does not scroll the content 712c.

FIG. 7T illustrates the computer system 101 scrolling the scrollable content in response to determining that the duration of the gaze 708 directed to the right scrolling region 712b exceeds the first time threshold 724b. In response to detecting the gaze 708 of the user directed to the right scrolling region 712b, the computer system 101 scrolls the content to the left at a first speed (e.g., “S3”) as shown by speed indicator 722 to reveal additional content on the right side of the content 712c. In some embodiments, the speed at which the computer system scrolls content 712c is based on a location of the gaze 708 within the right scrolling region 712b and/or duration of the gaze 708 directed to the right scrolling region 712b that is optionally analogous to scrolling the scrollable content in response to the location and/or duration of the gaze 708 directed the second scrolling region 704c as described above.

In some embodiments, the computer system 101 displays one or more user interface elements and/or virtual object visually overlaid on (or, optionally, in front of) the scrollable content including the scrollable regions. In some embodiments, when the computer system displays a user interface element overlaid on a scrollable region, the scrollable region is not responsive to scrolling inputs until the computer system 101 ceases to display the user interface element overlaid on the scrollable region. For example, in FIG. 7U, the computer system 101 detects a gesture that includes hand 738 performing a pinch gesture (e.g., similar to the gesture performed by hand 734 described above and in more detail with reference to method(s) 800 and/or 1000) while the gaze 708 of the user is directed to the side bar user interface button 706b (e.g., described above) and, in response, the computer system 101 expands internet browsing user interface element 704a to include a first menu user interface element 740 that includes a first list of options. For example, in FIG. 7V, the computer system 101 detects a gesture that includes a hand 738 performing a pinch gesture (e.g., similar to the gesture performed by hand 734 described above and in more detail with reference to method(s) 800 and/or 1000) while the gaze 708 of the user is directed to a second menu user interface element 742 of a first option of the list and, in response, the computer system 101 displays, via the display generation component 120, a second menu user interface element 742 overlaid on the internet browsing user interface element 704a. In some embodiments, the second menu user interface element 742 includes scrollable content (e.g., a scrollable list of options).

FIG. 7W illustrates that the computer system 101 does not scroll the scrollable content of the internet browsing user interface element 704a in response to determining that the duration of the gaze 708 directed to the second scrolling region 704c exceeds the first time threshold 724b of timer 724a because the second menu user interface element 742 is overlaid on the second scrolling region 704c.

FIG. 7X illustrates that while the gaze 708 is directed to the bottom region of the second menu user interface element 742, the computer system 101 detects a gesture that includes hand 738 performing a pinch gesture (e.g., as described in more detail with reference to method(s) 800 and/or 1000) and movement of the hand 738 upwards (e.g., from a first location to a second location of the hand 746) while the gaze 708 of the user is directed to the bottom region of the second menu user interface element 742 as shown in FIG. 7Y. In some embodiments, in response to detecting the gesture, the computer system 101 scrolls the scrollable content of the second menu user interface element 742 up to reveal additional content at the bottom region of the second menu user interface element 742 as shown in FIG. 7Y.

In some embodiments, although FIG. 7Y illustrates that a duration of the gaze 708 is directed to the bottom region of the second menu user interface element 742 for less than time threshold 728b as shown by time 728a, the computer system 101 scrolls the scrollable content of the second menu user interface element 742 in accordance with the movement of the hand 738. FIG. 7Z illustrates that the computer system 101 does not scroll content 712c in response to determining that the duration of the gaze 708 directed to the right scrolling region 712b of content 712c exceeds the first time threshold 724b of timer 724a because the second menu user interface element 742 is overlaid on the content 712c.

In some embodiments, the computer system 101 displays, via the display generation component 120, a user interface element that, when selected, causes the computer system 101 to set a user-defined scrolling speed. For example, in FIG. 7AA, the computer system 101 detects a gesture that includes a hand 738 performing a pinch gesture (e.g., as described in more detail with reference to method(s) 800 and/or 1000) while the gaze 708 of the user is directed to a settings user interface button 710 or virtual object optionally located above the internet browsing user interface element 704a within the three-dimensional environment 700. In some embodiments, in response to detecting the gesture, the computer system 101 displays, via the display generation component 120, a settings user interface element 748a as shown in FIG. 7BB. In some embodiments, the settings user interface element 748a includes a slider element 748b that, when selected, causes the computer system 101 to set a scrolling speed at which the computer system 101 scrolls the scrollable content as described in more detail with reference to method 800. For example, in FIG. 7BB, the computer system detects a gesture that includes hand 738 performing a pinch gesture followed by movement (e.g., as described in more detail with reference to method(s) 800 and/or 1000) while the gaze 708 of the user is directed to the slider element, and in response, the computer system sets the scrolling speed to correspond to the user-defined scrolling speed using the slider element 748b.

FIG. 8 is a flowchart illustrating a method in which a computer system scrolls scrollable content in response to gaze-based inputs, in accordance with some embodiments. In some embodiments, the method 800 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, a method 800 is performed at a computer system in communication with a display generation component and one or more input devices, such as computer system 101a in communication with display generation component 120 as shown in FIG. 7A. For example, a mobile device (e.g., a tablet, a smartphone, a media player, or a wearable device), or a computer or other electronic device. In some embodiments, the display generation component is a display integrated with the electronic device (or, optionally, a touch screen display), external display such as a monitor, projector, television, or a hardware component (or, optionally, integrated or external) for projecting a user interface or causing a user interface to be visible to one or more users, etc. In some embodiments, the one or more input devices include an electronic device or component capable of receiving a user input (e.g., capturing a user input, and/or detecting a user input.) and transmitting information associated with the user input to the computer system. Examples of input devices include a touch screen, mouse (e.g., external), trackpad (or, optionally, integrated or external), touchpad (or, optionally, integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor), microphone for capturing voice commands or other audio input, etc. In some embodiments, the computer system is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus.

In some embodiments, while displaying, via the display generation component, scrollable content including a first region of the scrollable content, such as region 704c in FIG. 7A, the computer system detects (802), via the one or more input devices, a gaze of a user of the computer system directed to the scrollable content, such as gaze 708 directed to region 704c in FIG. 7B. In some embodiments, the computer system displays the scrollable content in a three-dimensional environment (e.g., in a manner similar to displaying a virtual object in a three-dimensional environment as described with reference to the scene 105 in FIG. 1A). For example, the three-dimensional environment is optionally generated, displayed, or otherwise caused to be viewable by the computer system. In some embodiments, the three-dimensional environment is an extended reality (XR) environment such as a virtual reality (VR) environment, a mixed reality (MR) environment, or an augmented reality (AR) environment. In some embodiments, the scrollable content is a user interface element of an application, such as a web browser application or an application other than the web browser application, such as an electronic reading application, media content application, or a platform control application. For example, the user interface element is optionally a window or volume configured to present two-dimensional and/or three-dimensional content that is optionally bounded to the window. In some embodiments, the user interface element is the two-dimensional and/or three-dimensional content associated with the window. In some embodiments, the content corresponds to web content, a word processing document, a spreadsheet document, email content, presentation content, application content, or other displayed virtual objects. In some embodiments, the scrollable content includes visual and/or textual content (e.g., images and text) that is not all displayed on a respective content window (or, optionally, volume) at once (e.g., a portion of the visual and/or textual content are not visible on the respective content window at any given moment in time). Thus, in some embodiments, in response to detecting the gaze of the user directed to the first region of the scrollable content (e.g., described in further detail below), the computer system scrolls content that is displayed on the scrollable content such that portions of the content that were not previously visible on the scrollable content become visible, while portions of the content on the scrollable content that were previously visible are no longer visible. It is understood that although the embodiments described herein are directed to the first region of the scrollable content, such functions and/or characteristics, optionally apply to other scrolling regions as described below. For example, the scrollable content optionally includes the first region located at the bottom portion of the scrollable content. In some embodiments, in response to detecting that the gaze of the user is directed to the bottom region of the scrollable content, the computer system scrolls the content of the scrollable content up, such that portions of the content that are below the currently displayed content on the scrollable content become visible. In some embodiments, the computer system detects the gaze of the user directed to the first region of the scrollable content for a period of time greater than a time threshold (e.g., 0.02, 0.05, 0.1, 0.2, 0.25, 0.3, 0.5, 1, 2, 3, or 5 seconds). In some embodiments, the first region is located at the top portion of the scrollable content. In some embodiments, the scrollable content concurrently includes a second (e.g., scrolling) region located at the top portion of the scrollable content and the first region location at the bottom portion of the scrollable content. In some embodiments, in response to detecting that the gaze of the user is directed to the top region of the scrollable window, the computer system scrolls the content of the scrollable content down, such that portions of the content that are above the currently displayed content on the scrollable content become visible. In some embodiments, the first region of the scrollable content is located at the right (or, optionally, left) side portion of the scrollable content. In some embodiments, in response to detecting that the gaze of the user is directed to the right (or, optionally, left) side region of the scrollable window, the computer system scrolls the content of the scrollable content to the left (or, optionally, right, respectively), such that portions of the content that are to the right (or, optionally, the left) the currently displayed content on the scrollable content become visible. In some embodiments, the first region of the scrollable content is not delineated with any visual indicators or visual boundaries. Instead, the computer system optionally detects that the gaze of the user is beyond a threshold distance from the center of the scrollable content in order determine that the gaze of the user is within the first region of the scrollable content. For instance, if the first region is located at the bottom of the scrollable content, then the computer system optionally begins to scroll the scrollable content in response to detecting that the gaze of the user is beyond a threshold distance (e.g. 1, 5, 10, 15, 20, 30, 40, 50, or 100 cm and/or 1%, 5%, 10%, 20%, 30%, 40%, 60%, or 75% length and/or radial length) below the center of the scrollable content. In some embodiments the threshold distance is proportional to the size of the scrollable content. In some embodiments, the computer system detects that the gaze of the user is beyond a threshold distance in terms of degrees, for instance, in accordance with an angle (e.g., 0.5, 2.5, 5, 8, 10, 12, 15, 20, 40, or 50 degrees) defined by a line (e.g., measuring 0.1, 0.5, 1, 1.5, 2, 3, 5, or 10 m) between the user's viewpoint and the center of the scrollable content and a line defined by a line between the user's viewpoint and the gaze point of the user (e.g., measuring 1, 5, 10, 15, 20, 30, 40, 50, or 100 cm). In some embodiments, the computer system scrolls the scrollable content in response to detecting that the gaze of the user is directed to the first region of the scrollable content the without requiring additional user input (e.g., without a separate gesture input or without explicit interaction such as interacting with a scroll bar user interface object).

In some embodiments, in response to detecting the gaze of the user directed to the scrollable content (804), such as gaze 708 directed to region 704c, in accordance with a determination that the gaze is directed to a first type of content in the first region, the computer system scrolls the scrollable content at a first speed (806), such as text-based content in region 704c and scrolling at a speed as indicated by speed indicator 722 in FIG. 7O. In some embodiments, in response to detecting the gaze of the user directed to the scrollable content (804), in accordance with a determination that the gaze is directed to a second type of content in the first region, wherein the second type of content is different from the first type of content, such as image-based content 704e in FIG. 7A, the computer system scrolls the scrollable content at a second speed, different from the first speed, such as image-based content in region 704c and scrolling at a speed as indicated by speed indicator 722 in FIG. 7N. In some embodiments, the computer system changes the speed at which the content is scrolled within the scrollable content based on the type of content that is displayed in the first region of the scrollable content. For instance, if the computer system determines that the first region only includes text (e.g., does not include an image or other type of content), the computer system optionally causes the content in the scrollable content to be scrolled at a first speed (e.g., 0.1, 1, 5, 10, 15, 20, 30, 40 50, or 100 cm/s). In the event that the computer system determines that the first region of the scrollable content includes an image or a portion of an image (or, optionally, in addition to text), the computer system optionally causes the content in the scrollable content be scrolled at a second speed that is faster than the first speed so that the user can view the entirety of an image more quickly than if the content were scrolled at the first speed. In some embodiments, given the type of content, the computer system correlates the same location of the gaze in the first region with a different respective scrolling speed from multiple scrolling speeds including the first speed and the second speed as determined by the computer system and/or defined by the user of the computer system based on whether that location includes the first type of content or the second type of content. In some embodiments, in addition to text and/or images, the first type and second type of content include but are not limited to: video content, metadata content associated with the content being displayed on the scrollable content in the first region, or content having different visual characteristics (e.g., different brightness, color, opacity, and/or font size).

Scrolling content at different speeds based on the type of content being scrolled as well as based on the location of the gaze of the user minimizes input errors from the user associated with the user misinterpreting content due to the speed at which it is being scrolled and facilitates more efficient user interaction with the content (e.g., less overall time spent providing scrolling inputs) while avoiding errors in scrolling, thereby conserving computing resources associated with correcting erroneous input from the user and improving accessibility for users unable (e.g., users otherwise occupied or physically unable) to provide hand inputs or controller inputs.

In some embodiments, in response to detecting the gaze of the user directed to the scrollable content, in accordance with a determination that the gaze is directed to a second region of the scrollable content, such as region 704d in FIG. 7K, different from the first region, the computer system forgoes scrolling the scrollable content based on the gaze of the user directed to the scrollable content, such as indicated by speed indicator 722 in FIG. 7K. As described herein, the scrollable content is optionally a user interface element of an application, such as a window (or, optionally volume) of a web browser application or other application described above. In some embodiments, the scrollable content includes the first region (e.g., described herein) that, when the computer system detects the gaze of the user directed to the first region, the computer system scrolls content displayed in the first region. In some embodiments, the scrollable content includes a second region (e.g., adjacent to the first region) that, when the computer system detects the gaze of the user directed to the second region, the computer system does not scroll content displayed in the second region. In some embodiments, the second region of the scrollable content is optionally not responsive to gaze-only input (e.g., not including input from one or more portions of the user other than those portions providing the attention gaze input).

In some embodiments, the second region and the first region are part of a user interface element (e.g., a same user interface element such as a same window or same volume). In some embodiments, the second region and the first region occupy different portions of the user interface element. For example, a first portion of the user interface element that includes the first region optionally does not include the second region. In some embodiments, and as described in more detail with reference to method 1000, scrolling the scrollable content is performed by the computer system in response to the computer system detecting a respective input element providing an input to scroll as described in more detail with reference to method 1000. For example, the computer system optionally detects a non-gaze-based input directed to the second region, such as selection via a pinch air gesture in which the gaze of the user is optionally directed to the second region while one or more portions of the user (e.g., a hand, arm, and/or finger) of the user performs the pinch air gesture as described in more detail with reference to method 1000.

In some embodiments, while the computer system scrolls the scrollable content at the respective speed, the computer system detects that the gaze of the user is directed to the second region of the scrollable content (e.g., more than a threshold distance away from the first region of the scrollable content). In some embodiments, in response to detecting that the gaze of the user is directed to the second region of the scrollable content, the computer system stops scrolling the scrollable content at the respective speed. For example, after detecting that the gaze of the user is directed to the second region (and/or detecting that the gaze of the user is directed away from the first region), the computer system optionally scrolls the scrollable content at a reduced respective speed (e.g., the speed of scrolling the scrollable content is gradually reduced until scrolling stops). In another example, after detecting that the gaze of the user is directed to the second region (and/or detecting that the gaze of the user is directed away from the first region), the computer system optionally suddenly decreases the speed at which the scrollable content is scrolled (e.g., scrolling the scrollable content abruptly stops).

In some embodiments, while the gaze of the user is directed to the second region of the scrollable content, the computer system detects the respective input element providing an input to scroll as described in more detail with reference to method 1000, and in response to detecting the respective input element, the computer system scrolls the scrollable content despite the second region of the scrollable content being not responsive to gaze-only input to scroll. Forgoing scrolling content based on a determination that the gaze of the user is directed to a second region of the scrollable content reduces errors in the interaction between the user and the computer system (e.g., by avoiding unintentional scrolling of content), thereby conserving computing resources associated with correcting erroneous input from the user and improving accessibility for users unable (e.g., users otherwise occupied or physically unable) to provide hand inputs or controller inputs.

In some embodiments, the first type of content is text-based content, such as text-based content in region 704c in FIG. 7O, (e.g., alphanumeric characters and/or symbols), and in some embodiments, the second type of content is image-based content (e.g., photos, videos, two-dimensional virtual objects, and/or three-dimensional virtual objects), such as image-based content 704c as shown in FIG. 7J. Scrolling content at different speeds based on whether the content is text-based content or image-based content increases the readability of content displayed by the computer system and minimizes input errors from the user associated with the user misinterpreting content due to the speed at which it is being scrolled and facilitates more efficient user interaction with the content (e.g., less overall time spent providing scrolling inputs) while avoiding errors in scrolling, thereby conserving computing resources associated with correcting erroneous input from the user and improving accessibility for users unable (e.g., users otherwise occupied or physically unable) to provide hand inputs or controller inputs.

In some embodiments, scrolling the scrollable content at a respective speed includes, while the gaze of the user is directed to a respective location (e.g., a respective location in an environment that includes the scrollable content), in accordance with a determination that the respective location includes the first type of content, scrolling the scrollable content at the first speed (e.g., as described above) such as scrolling at speed indicated by speed indicator 722 as shown in FIG. 7N. For example, the computer system optionally determines that the gaze of the user is directed to a first location of the first region of the scrollable content. In some embodiments, the computer system detects that the respective location of the gaze (e.g., in the environment that includes the first region of the scrollable content) is fixed (e.g., does not change or move). In some embodiments, while the location of the gaze is fixed, the scrolling operation is ongoing, causing the scrollable content to scroll, such that portions of the scrollable content that were not previously visible become visible, while portions of the scrollable content that were previously visible are no longer visible. For example, scrolling optionally changes the content displayed at a location corresponding to the respective location of the gaze (e.g., changing and/or revealing a second type of content different from the previously displayed first type of content). In some embodiments, when a respective portion of the scrollable content that is visible corresponds to the respective location of the gaze includes a first type of content, the computer system scrolls the scrollable content at the first speed as described herein. In some embodiments, when the respective portion of the scrollable content that is visible corresponds to a second type of content, the computer system scrolls the scrollable content at the second speed as described herein.

In some embodiments, scrolling the scrollable content at a respective speed includes, while the gaze of the user is directed to a respective location (e.g., a respective location in an environment that includes the scrollable content), while scrolling the scrollable content at the first speed, in accordance with a determination that the content at the respective location changes from including the first type of content to including the second type of content, such as changing from image-based content in region 704c, as shown in FIG. 7N to text-based content in region 704c, as shown in FIG. 7O (e.g. due to the scrolling of the content causing different content to be displayed at the location to which the gaze of the user is directed), the computer system changes the respective speed from the first speed to the second speed (e.g., as described above with reference to scrolling the scrollable content at the second speed, different from the first speed and/or as shown in FIGS. 7M and 7N), such as the respective speed shown by indicator 722 in FIG. 7O. For example, the content to which the gaze of the user is directed is optionally the first type of content before scrolling. In some embodiments, the computer system scrolls the scrollable content at the first speed in response to the determination that the gaze of the user is directed to the first type of content. In some embodiments, scrolling the scrollable content in response to the gaze directed to the first region includes scrolling through a respective portion of the scrollable content and if the respective portion of the scrollable content includes the second type of content, the computer system scrolls the scrollable content at the second speed. In some embodiments, the gaze of the user is maintained at a location of the first region and the currently displayed portion of the scrollable content to which the gaze of the user is directed changes from the first type of content to the second type of content, and in response, the computer system optionally changes the scrolling speed from the first speed to the second speed. For example, the computer system optionally gradually changes the speed of scrolling from the first speed to the second speed. In another example, the computer system optionally suddenly changes the speed of scrolling from the speed to the second speed. Scrolling content and changing the speed at which the content is scrolled based on whether the content is a first type or a second type increases the readability of content displayed by the computer system and minimizes input errors from the user associated with the user misinterpreting content due to the speed at which it is being scrolled and facilitates more efficient user interaction with the content (e.g., less overall time spent providing scrolling inputs) while avoiding errors in scrolling, thereby conserving computing resources associated with correcting erroneous input from the user and improving accessibility for users unable (e.g., users otherwise occupied or physically unable) to provide hand inputs or controller inputs.

In some embodiments, scrolling the scrollable content at a respective speed includes, in accordance with a determination that a location of the gaze of the user directed to the first region is a first distance from an edge (e.g., top, bottom, left, or right) of the first region, scrolling the scrollable content at a third speed, such as distance 726 as shown in FIG. 7C. In some embodiments, the first region is substantially rectangular (or, optionally, square) having a top edge, a bottom edge (or, optionally, opposite the top edge), a left edge, and a right edge (or, optionally, opposite the left edge). In some embodiments, scrolling the scrollable content at the third speed is different (e.g., faster or slower) from scrolling the scrollable content at the first speed, the second speed, or other speed. In some embodiments, scrolling the scrollable content at the third speed is the same as scrolling the scrollable content at the first speed, the second speed, or other speed. In some embodiments, scrolling the scrollable content at the third speed includes applying an absolute modifier (e.g., increase or decrease the speed by 5, 7, 10, 15, 20, or 30 cm/s) or applying a relative modifier to the respective speed (e.g., the first speed, the second speed, or other speed plus or minus 5, 7, 10, 15, 20, or 30 cm/s). For example, while the computer system is scrolling the scrollable content at a first speed, and while the computer system detects the gaze of the user moving towards a respective location that is within a threshold distance (e.g., 0.1, 0.25, 0.5, 0.75, 0.9, 1, 1.5, 2, 3, 5, or 10 cm) from the edge of the first region, the computer system optionally scrolls the scrollable content at the third speed, wherein the third speed increases relative to the first speed as the computer system detects that the location of the gaze is directed to (and/or moving towards) the respective location that is within the threshold distance from the edge of the first region.

In some embodiments, scrolling the scrollable content at a respective speed includes, in accordance with a determination that the location of the gaze of the user directed to the first region is a second distance from an edge of the first region, different from the first distance, scrolling the scrollable content at a fourth speed, different from the third speed, such as distance 730 as shown in FIG. 7D. In some embodiments, the smaller the distance of the location of the gaze of the user from the edge of the first region, the greater the speed of scrolling the scrollable content (e.g., speed is increased). For example, the second distance is less than the first distance (e.g., closer to a bottom edge of the first region). In some embodiments, when the computer system determines that the location of the gaze of the user directed to the first region is the second distance from the edge of the first region (e.g., closer to the bottom edge of the first region), the computer system scrolls the scrollable content at the fourth speed which is greater than the third speed at which the computer system scrolls the scrollable content when the location of the gaze is the first distance from the edge. It is understood that although the embodiments described herein are directed to the bottom edge of the first region, such functions and/or characteristics, optionally apply to other edges, such as the top edge, left edge, and/or right edge. In some embodiments, such functions and/or characteristics optionally apply to only one edge (e.g., the bottom edge of the first region) and not the other edges (e.g., the top edge, the left edge, and/or the right edge). In some embodiments, the computer system determines that the gaze of the user is within a threshold distance (e.g., 0.1, 0.25, 0.5, 0.75, 0.9, 1, 1.5, 2, 3, 5, or 10 cm) from the edge of the first region, and in response to the determination that the gaze is within the threshold distance from the edge of the first region, the speed at which the computer system scrolls the scrollable content is increased. In some embodiments, the computer system determines that the location in the first region that the gaze is direct to is greater than the threshold distance, and in response, the speed at which the computer system scrolls the scrollable content is not increased and optionally remains at a respective speed.

Changing the speed at with the computer system scrolls the scrollable content in response to a location of the gaze of the user relative to the edge of the first region provides quick access to scrollable content and facilitates more efficient user interaction with the content (e.g., less overall time spent providing scrolling inputs) while avoiding errors in scrolling, thereby conserving computing resources associated with correcting erroneous input from the user and improving accessibility for users unable (e.g., users otherwise occupied or physically unable) to provide hand inputs or controller inputs.

In some embodiments, scrolling the scrollable content at a respective speed includes, in accordance with a determination that the gaze of the user is directed to the first region for a first period of time, scrolling the scrollable content at a third speed, such as the duration of gaze 708 directed to region 704c exceeding the first threshold 724b in FIG. 7O. In some embodiments, scrolling the scrollable content at the third speed is analogous to and/or has one or more of the characteristics of scrolling the scrollable content at the third speed as described above with reference to the determination that the location of the gaze of the user directed to the first region is the first distance from the edge. For example, while the computer system is scrolling the scrollable content at a first speed, and while the computer system detects the gaze of the user directed to the first region for the first period of time, the computer system optionally scrolls the scrollable content at the third speed, wherein the third speed increases relative to the first speed when the computer system detects that the period of time the gaze is detected as directed to the first region for longer than a first duration threshold as will be described herein.

For example, the computer system optionally detects that the gaze of the user is directed to the first region for the first period of time below a first duration threshold (e.g., 0.05, 0.1, 0.2, 0.25, 0.3, 0.5, 0.6, 0.7, 0.8, 0.9, 1, 1.2, 1.5, 2, 2.5, 3, 5, 10, or 30 seconds). In some embodiments, the first period of time starts at a moment when the computer system detects a direction of the user's gaze directed to the first region. In some embodiments, the first period of time starts once the gaze settles in the first region for a predetermined amount of time (e.g., 0.05, 0.1, 0.2, 0.25, 0.3, 0.5, 0.6, 0.7, 0.8, 0.9, 1, 1.2, 1.5, 2, 2.5, 3, 5, 10, or 30 seconds). In some embodiments, the computer system determines that the gaze of the user has moved from being directed to a first location within the first region to a second location within the first region, and in response, the computer system does not restart the first period of time. In some embodiments, the first period of time starts at a moment when the computer system detects the gaze of the user being directed to the first location within the first region. In some embodiments, the computer system restarts the first period of time when the computer system determines that the direction of the user's gaze is directed away from the first region.

In some embodiments, scrolling the scrollable content at a respective speed includes, in accordance with a determination that the gaze of the user is directed to the first region for a second period of time (e.g., longer than the first period of time), scrolling the scrollable content at a fourth speed, different from the third speed (e.g., faster than the third speed), such as the duration of gaze 708 directed to region 704c exceeding a second threshold in FIG. 7P. In some embodiments, scrolling the scrollable content at the fourth speed includes applying an absolute modifier (e.g., increase or decrease the speed by 5, 7, 10, 15, 20, or 30 cm/s) or applying a relative modifier to the respective speed (e.g., the first speed, the second speed, the third speed, or other speed plus or minus 5, 7, 10, 15, 20, or 30 cm/s). For example, while optionally scrolling the scrollable content at the third speed, and while the gaze of the user remains directed to the first region, and in accordance with a determination that the gaze of the user is directed to the first region for a second period of time (e.g. a duration of the gaze of the user has exceeded the first duration threshold described above), the computer system optionally scrolls the scrollable content at a fourth speed, different from the third speed.

In some embodiments, the computer system scrolls the scrollable content at a speed that optionally corresponds to the duration of gaze directed to the first region (e.g., increasing the speed at with the computer system scrolls the scrollable content). In some embodiments, when the computer system determines that the duration of the gaze of the user has exceeded the first duration threshold described herein, the computer system scrolls the scrollable content at the fourth speed which is greater than the third speed at which the computer system scrolls the scrollable content when the duration of the gaze is below the first duration threshold as described herein.

In some embodiments, scrolling the scrollable content at a respective speed that optionally corresponds to the duration of the gaze directed to the first region is irrespective of whether or not the location of the gaze changes including whether or not the distance of the location of the gaze from the edge of the first region changes as described above. Changing the speed at with the computer system scrolls the scrollable content in response to a duration of the gaze of the user directed to the first region provides quick access to scrollable content and facilitates more efficient user interaction with the content (e.g., less overall time spent providing scrolling inputs) while avoiding errors in scrolling, thereby conserving computing resources associated with correcting erroneous input from the user and improving accessibility for users unable (e.g., users otherwise occupied or physically unable) to provide hand inputs or controller inputs.

In some embodiments, while displaying the scrollable content including the first region, and while the gaze of the user is directed away from the first region of the scrollable content, the computer system detects the gaze of the user directed to the first region of the scrollable content, such as gaze 708 directed to region 704c in FIG. 7B. In some embodiments, the computer system determines that the gaze of the user is directed to a location in the three-dimensional environment that does not correspond to the first region of the scrollable content. For example, the location optionally corresponds to the second region of the scrollable content that is optionally not responsive to gaze-only input. In another example, the location optionally corresponds to a user interface element different from the scrollable content.

In some embodiments, in response to detecting that the gaze of the user is directed to the first region of the scrollable content, in accordance with a determination that the gaze of the user is directed to the first region of the scrollable content for less than a first duration threshold (e.g., 0.05, 0.1, 0.2, 0.25, 0.3, 0.5, 0.6, 0.7, 0.8, 0.9, 1, 1.2, 1.5, 2, 2.5, 3, 5, 10, or 30 seconds), the computer system forgoes scrolling the scrollable content, such as the duration of gaze 708 directed to region 704c below a first threshold 724b in FIG. 7B.

In some embodiments, in response to detecting that the gaze of the user is directed to the first region of the scrollable content, in accordance with a determination that the gaze of the user is directed to the first region of the scrollable content for longer than the first duration threshold, the computer system scrolls the scrollable content (as described above with reference to scrolling the scrollable content at a respective speed in accordance with the determination that the gaze of the user is directed to the first region for a respective period of time longer than the first duration threshold, and/or as shown in FIGS. 7B and 7C), such as the duration of gaze 708 directed to region 704c exceeding the first threshold 724b in FIG. 7C.

For example, the computer system optionally detects the gaze of the user directed to the first region for a period of time greater than the first duration threshold. In some embodiments, the period of time starts at a moment when the computer system detects a direction of the user's gaze directed to the first region. In some embodiments, the period of time starts once the gaze settles in the first region for a predetermined amount of time (e.g., 0.05, 0.1, 0.2, 0.25, 0.3, 0.5, 0.6, 0.7, 0.8, 0.9, 1, 1.2, 1.5, 2, 2.5, 3, 5, 10, or 30 seconds).

For example, the computer system optionally scrolls the scrollable content at a respective speed that is based on a location of the gaze of the user relative to the edge of the first region and/or the type of content as described above. For example, the computer system determines that the user is reading and/or scanning the scrollable content based on detected gaze movement, and optionally scrolls the scrollable at a respective speed as described above. In some embodiments, the computer system determines lack of movement of the gaze of the user (e.g., the computer system no longer detects movement of the gaze directed to the first region), and in response, the computer system ceases scrolling the scrollable content.

Scrolling the scrollable content in response to gaze directed to the first region and doing so when the gaze is directed to the first region for longer than the first duration threshold provides confirmation that the user intends to scroll the scrollable content, thereby reducing errors in the interaction between the user and the computer system (e.g., avoiding unintentional scrolling due to unintentional gaze) and reducing inputs needed to correct such errors and conserving computing resources associated with correcting erroneous input from the user and improving accessibility for users unable (e.g., users otherwise occupied or physically unable) to provide hand inputs or controller inputs.

In some embodiments, while scrolling the scrollable content in accordance with the determination that the gaze of the user is directed to the first region, in accordance with a determination that the gaze of the user is directed to a second region, different from and adjacent to the first region, the computer system continues scrolling the scrollable content, such as region 704h in FIG. 7B. In some embodiments, while scrolling the scrollable content in accordance with the determination that the gaze of the user is directed to the first region, in accordance with a determination that the gaze of the user is directed to a third region, different from the first region and the second region, the computer system ceases scrolling the scrollable content, such as region 704d in FIG. 7K.

In some embodiments, the first region of the scrollable content is a region designated by the computer system as responsive to both gaze-only input scrolling (e.g., not including input from one or more portions of the user other than those portions providing the gaze input to scroll) and non-gaze-based scrolling, such as via a respective input element providing an input to scroll while the gaze of the user is optionally directed to the first region as described in more detail with reference to method 1000. In some embodiments, while scrolling the scrollable content in accordance with the determination that the gaze of the user is directed to the first region, the computer system detects that the gaze of the user has moved from being directed to the first region to being directed to a second region, different from and adjacent to the first region, and in response to detecting that the gaze of the user has moved from being directed to the first region to being directed to the second region, the computer system continues scrolling the scrollable region. Thus, in some embodiments, while scrolling the scrollable content in accordance with the determination that the gaze of the user is directed to the first region, the computer system implements the second region as a scrolling region (e.g., responsive to gaze-only scrolling input) that would otherwise not be implemented as a scrolling region if the computer system was not scrolling the scrollable content in accordance with the gaze directed to the first region. For example, the computer system optionally expands the scrolling region to include the first region and the second region of the scrollable content in response to (and/or while scrolling the scrollable content in accordance with the gaze directed to the first region).

In some embodiments, the first region encompasses a first portion/area of the scrollable content, and the second region encompasses a second portion/area of the scrollable content, different from the first portion/area of the scrollable content and adjacent to the first portion/area of the scrollable content. For example, the first region and the second region optionally share an invisible (or, optionally, joint) boundary. In some embodiments, the computer system does not display a visual representation of the boundaries of the first region and/or the second region. In some embodiments, the computer system displays a visual indication that the particular portion of the scrollable content (e.g., the first region) is scrollable via gaze-only input as described herein.

In some embodiments, when the computer system detects that the gaze is directed to a third region, outside of the first region and the second region (e.g., beyond the joint boundary of the first region and the second region), the computer system stops scrolling the scrollable content. Expanding a respective scrolling region of the scrollable content in response to gaze directed to the first region enables scrolling via gaze (e.g., expands the first region to receive scrolling inputs), thereby reducing errors in the interaction between the user and the computer system and facilitating more efficient user interaction with the content (e.g., less overall time spent providing scrolling inputs), thereby conserving computing resources associated with correcting erroneous input from the user and improving accessibility for users unable (e.g., users otherwise occupied or physically unable) to provide hand inputs or controller inputs.

In some embodiments, while displaying the scrollable content, and while the gaze of user is directed to the first region, such as gaze directed to region 704b, the computer system detects the gaze of the user moving from the first region to a second region, different from and adjacent to the first region, such as the region to which the gaze 708 is directed to in FIG. 7J. In some embodiments, the second region is analogous to and/or includes one or more characteristics of the second region that is different from and adjacent to the first region described above. In some embodiments, in response to (and/or while) detecting the gaze of the user moving from the first region to the second region, in accordance with a determination that the scrollable content was scrolling prior to detecting the gaze of the user moving from the first region to the second region, the computer system continues scrolling the scrollable content, such as shown in FIG. 7I where the computer system was scrolling the scrollable content.

In some embodiments, the second region is responsive to gaze-only input(s) to scroll when the computer system was scrolling the scrollable content in accordance with the gaze directed to the first region. In some embodiments, the computer system continues to scroll the scrollable content as long as the detected movement of the gaze of the user is directed to the first region or the second region (e.g., has not moved to the third region that is different from the first region and the second region as described above).

In some embodiments, in response to (and/or while) detecting the gaze of the user moving from the first region to the second region, in accordance with a determination that the scrollable content was not scrolling prior to detecting the gaze of the user moving from the first region to the second region, the computer system forgoes scrolling the scrollable content, such as the region to which the gaze 708 is directed to in FIG. 7K.

In some embodiments, the computer system did not scroll the scrollable content in accordance with the detected gaze of the user directed to the first region before detecting the gaze of the user moving from the first region to the second region. In some embodiments, when the computer system determines that the duration of the gaze directed to the first region is below a respective duration threshold (e.g., described above and with reference to method 1000), the computer system does not scroll the scrollable content. Thus, in some embodiments, the computer system does not designate the second region as responsive to gaze-only input(s) to scroll the scrollable content. For example, the computer system optionally does not expand the first scrolling region to include the second region. Thus, in some embodiments, the computer system does not scroll the scrollable content in response to detecting the gaze of the user moving from the first region to the second region that would otherwise be implemented as responsive to gaze-only input(s) to scroll the scrollable content if the computer system was scrolling the scrollable content in accordance with the gaze directed to the first region.

Continuing or forgoing scrolling the scrollable content in response to detecting the gaze of the user moving to a respective region adjacent to a scrolling region and in accordance with a determination that the scrollable content was scrolling prior to detecting the gaze moving to the respective region prevents unintentional scrolling, thereby reducing errors in the interaction between the user and the computer system (e.g., avoiding unintentional scrolling due to unintentional gaze) and reducing inputs needed to correct such errors and conserving computing resources associated with correcting erroneous input from the user and improving accessibility for users unable (e.g., users otherwise occupied or physically unable) to provide hand inputs or controller inputs.

In some embodiments, while scrolling the scrollable content in accordance with the determination that the gaze of the user is directed to a respective region: in accordance with a determination that the gaze of the user is directed to a second region, different from and adjacent to the respective region, the computer system continues scrolling the scrollable content, such as the region to which the gaze 708 is directed to in FIG. 7C. In some embodiments, continuing scrolling the scrollable content in accordance with a determination that the gaze of the user is directed to a second region, different from and adjacent to the respective region is analogous to and/or includes one or more characteristics of continuing scrolling the scrollable content in accordance with the determination that the gaze of the user is directed to a second region, different from and adjacent to the first region as described above.

In some embodiments, in accordance with a determination that the gaze of the gaze of the user is directed to a third region, different from the respective region and the second region, and adjacent to the respective region, the computer system continues scrolling the scrollable content, wherein a size of the second region is different from a size of the third region, such as the region to which gaze 708 is directed to in FIG. 7J. In some embodiments, continuing scrolling the scrollable content in accordance with a determination that the gaze of the user is directed to a third region, different from the respective region and the second region, and adjacent to the respective region is analogous to and/or includes one or more characteristics of continuing scrolling the scrollable content in accordance with the determination that the gaze of the user is directed to a second region, different from and adjacent to the first region as described above.

In some embodiments, the respective region is located at a top portion of the scrollable content or at the bottom portion of the scrollable content. In some embodiments, the second region that is adjacent to the respective region is located at the top portion of the scrollable content. For example, the respective region and the second region optionally share an invisible (or, optionally, joint) boundary. In some embodiments, the third region that is adjacent to the respective region is located at the bottom portion of the scrollable content. In some embodiments, the third region and the respective region optionally share an invisible (or, optionally, joint) boundary.

In some embodiments, the second region is a first size, and the third region is a second size larger than the first size. In some embodiments, the second size is smaller than the first size. Thus, in some embodiments, the respective region and the second region located at the top portion of the scrollable content occupies a larger portion of the scrollable content than a respective portion associated with the respective region and third region located at the bottom portion of the scrollable content. For example, if the computer system detects that the gaze of the user is directed toward the top portion (e.g., respective region) of the scrollable content, the computer system optionally scrolls the scrollable content in a downwards direction to reveal content from the top of the scrollable content that were not previously displayed before scrolling, and continues to do so while the gaze of the user moves to the second region. In another example, if the computer system detects that the gaze of the user is directed toward the bottom region (e.g., respective region) of the scrollable content, the computer system optionally scrolls the scrollable content in an upwards direction to reveal content from the bottom of the scrollable content that were not previously displayed before scrolling, and continues to do so while the gaze of the user moves toward the third region.

Differently sized regions enables scrolling via gaze (e.g., a larger sized bottom region to receive scrolling inputs) as users typically scroll from top to bottom, thereby reducing errors in the interaction between the user and the computer system and facilitating more efficient user interaction with the content (e.g., less overall time spent providing scrolling inputs), thereby conserving computing resources associated with correcting erroneous input from the user and improving accessibility for users unable (e.g., users otherwise occupied or physically unable) to provide hand inputs or controller inputs. In some embodiments, while scrolling the scrollable content in accordance with the determination that the gaze of the user is directed to the respective region, and in accordance with a determination that the gaze of the user is directed to a fourth region, different from the respective region, the second region, the third region and adjacent to the respective region of the scrollable content, the computer system continues scrolling the scrollable content, such as the region to which gaze 708 is directed to in FIG. 7J. In some embodiments, continuing scrolling the scrollable content in accordance with a determination that the gaze of the user is directed to a fourth region, different from the respective region, the second region, the third region, and adjacent to the respective region is analogous to and/or includes one or more characteristics of continuing scrolling the scrollable content in accordance with the determination that the gaze of the user is directed to a second region, different from and adjacent to the first region as described above.

In some embodiments, while scrolling the scrollable content in accordance with the determination that the gaze of the user is directed to the respective region, and in accordance with a determination that the gaze of the user is directed to a fifth region, different from the respective region, the second region, the third region, and the fourth region and adjacent to the respective region of the scrollable content, the computer system continues scrolling the scrollable content, wherein a size of the fourth region is the same as a size of the fifth region, such as gaze 708 directed region 704h in FIG. 7B. In some embodiments, continuing scrolling the scrollable content in accordance with a determination that the gaze of the user is directed to a fifth region, different from the respective region, the second region, the third region, the fourth region, and adjacent to the respective region is analogous to and/or includes one or more characteristics of continuing scrolling the scrollable content in accordance with the determination that the gaze of the user is directed to a second region, different from and adjacent to the first region as described above.

In some embodiments, the respective region is located at a left portion of the scrollable content or at a right portion of the scrollable content. In some embodiments, the fourth region that is adjacent to the respective region is located at the left portion of the scrollable content. For example, the respective region and the fourth region optionally share an invisible (or, optionally, joint) boundary. In some embodiments, the fifth region that is adjacent to the respective region is located at the right portion of the scrollable content. In some embodiments, the fifth region and the respective region optionally share an invisible (or, optionally, joint) boundary.

In some embodiments, the fourth region and the fifth region have a same size. For example, if the computer system detects that the gaze of the user is directed toward the left region (e.g., respective region) of the scrollable content, the computer system optionally scrolls the scrollable content to the right to reveal content from the left of the scrollable content that were not previously displayed before scrolling, and continues to do so while the gaze of the user moves toward the fourth region. In another example, if the computer system detects that the gaze of the user is directed toward the right region (e.g., respective region) of the scrollable content, the computer system scrolls the scrollable content to the left to reveal content from the right of the scrollable content that were not previously displayed before scrolling, and continues to do so while the gaze of the user moves toward the fifth region.

Same sized regions enables scrolling via gaze (e.g., appropriately sized regions to receive scrolling inputs), thereby reducing errors in the interaction between the user and the computer system and facilitating more efficient user interaction with the content (e.g., less overall time spent providing scrolling inputs), thereby conserving computing resources associated with correcting erroneous input from the user and improving accessibility for users unable (e.g., users otherwise occupied or physically unable) to provide hand inputs or controller inputs.

In some embodiments, scrolling the scrollable content at a respective speed includes, in accordance with a user-defined speed setting being a first user-selected speed setting, changing the respective speed by a first modifier value, such as element 748b as shown in FIG. 7BB. In some embodiments, scrolling the scrollable content at a respective speed includes in accordance with the user-defined speed setting being a second user-selected speed setting, different from the first user-selected speed setting, changing the respective speed by a second modifier value, different from the first modifier value, such as element 748b in FIG. 7BB.

In some embodiments, changing the respective speed by a first modifier value, a second modifier value, or other modifier value includes applying an absolute modifier (e.g., increase or decrease the respective speed by the first user-selected speed setting, the second user-selected speed setting, or other user-selected speed setting) or applying a relative modifier to the respective speed (e.g., the respective speed plus or minus the first user-selected speed setting, the second user-selected speed setting, or other user-selected speed setting).

In some embodiments, the computer system changes the respective speed by the respective modifier value in response to user input corresponding to selection of the respective user-selected speed setting (e.g., increasing or decreasing the speed of a speed slider user interface element). For example, selection of the respective user-selected speed setting optionally includes changing a value of a slider element (or, optionally, control or thumb) of a horizontal (or vertical) track with or without tick marks identifying specific speed values between a minimum and maximum speed value. In some embodiments, the respective user-defined speed settings are set via a settings menu user interface for the computer system and/or a settings menu user interface for the application associated with the scrollable content.

Adjusting a respective value of the speed at which the scrollable content is scrolled based on a user-defined speed setting provides an efficient method for adjusting a respective scrolling speed, thereby reducing errors in the interaction between the user and the computer system and facilitating more efficient user interaction with the content (e.g., less overall time spent providing scrolling inputs), thereby conserving computing resources associated with correcting erroneous input from the user and improving accessibility for users unable (e.g., users otherwise occupied or physically unable) to provide hand inputs or controller inputs.

In some embodiments, while scrolling the scrollable content at a respective speed, the computer system detects that a scroll limit of the scrollable content has been reached (e.g., a beginning or an end of the scrollable content is reached), such as shown in user interface element 704a in FIG. 7Q. In some embodiments, in response to detecting that the scroll limit of the scrollable content has been reached, in accordance with a determination that a speed (e.g., magnitude and direction) associated with scrolling the scrollable content prior to (and/or at the moment of) detecting that the scrolling limit has been reached is a first speed, the computer system scrolls the scrollable content beyond the scrolling limit by a first amount of scrolling, such as shown in user interface element 704a in FIG. 7Q.

In some embodiments, in response to detecting that the scroll limit of the scrollable content has been reached, in accordance with a determination that a speed (e.g., magnitude and direction) associated with scrolling the scrollable content prior to (and/or at the moment of) detecting that the scrolling limit has been reached is a first speed, the computer system displays, via the display generation component, an animation of the scrollable content moving back from the first amount beyond the scrolling limit toward (or, optionally, to) a location that is within the scrolling limit, such shown in user interface element 704a in FIG. 7R.

For example, the speed associated with scrolling the scrollable content is based on a location of the gaze of the user as described above. In some embodiments, the computer system determines that the first speed at which the scrollable content is scrolled is below a first threshold (e.g., 0.5, 1, 3, 5, 7, 9, 10, 15, 20, 30, 40, 50, 100, or 200 cm/s), and prior to detecting that the scrolling limit has been reached, the computer system scrolls the scrollable content by a first amount corresponding to the first speed. For example, the first amount is optionally proportional to the first speed. In some embodiments, in response to detecting that the scroll limit of the scrollable content has been reached, in accordance with a determination that the speed associated with scrolling the scrollable content prior to (and/or at the moment of) detecting that the scrolling limit has been reached is a second speed that is different from the first speed, the computer system scrolls the scrollable content beyond the scrolling limit by a second amount of scrolling that is different from the first amount of scrolling, as shown by user interface element 704a in FIG. 7Q.

In some embodiments, in response to detecting that the scroll limit of the scrollable content has been reached, in accordance with a determination that the speed associated with scrolling the scrollable content prior to (and/or at the moment of) detecting that the scrolling limit has been reached is a second speed that is different from the first speed, the computer system displays, via the display generation component, an animation of the scrollable content moving back from the second amount beyond the scrolling limit toward (or, optionally, to) a location that is within the scrolling limit, as shown in user interface element 704a in FIG. 7R.

For example, during scrolling, a displayed portion of the scrollable content optionally appears to bounce (or, optionally, rubber band) off of a boundary of the scrollable content when the movement limit (or, optionally, a beginning or an end of the scrollable content) is reached. In some embodiments, the animation of the scrollable content moving back to within the movement limit includes an emulation of the physical behavior of a stretched rubber band or spring in that the greater the rubber band is pulled, the more resistance under stretching the rubber band. In some embodiments, the second speed at which the scrollable content is scrolled is above the first threshold described herein. In some embodiments, the second amount the scrollable content is scrolled is greater than the first amount.

In some embodiments, the speed at which the computer system scrolls the scrollable content is zero when the movement limit has been reached (e.g., when the boundary of the scrollable content is reached). In another example, a motion of the displayed scrollable content is damped when the movement limit is reached. Displaying an animation of the scrollable content moving back to within the movement limit in response to the speed associated with scrolling the scrollable content provides feedback that the a beginning or an end of the scrollable content is reached, which provides more efficient user interaction with the content (e.g., less overall time spent providing scrolling inputs), thereby conserving computing resources associated with correcting erroneous input from the user and improving accessibility for users unable (e.g., users otherwise occupied or physically unable) to provide hand inputs or controller inputs. In some embodiments, while scrolling the scrollable content in accordance with the determination that the gaze of the user is directed to the first region, the computer system detects that the gaze of the user has moved to being directed to a boundary portion of a user interface element in which the scrollable content is displayed, such as the region 704c to which gaze 708 is directed in FIG. 7R (or, optionally, the region to which gaze 908 is directed as will be described in more detail below with reference to FIG. 9W).

In some embodiments, while scrolling the scrollable content in accordance with the determination that the gaze of the user is directed to the first region, in response to detecting that the gaze of the user is directed to the boundary portion, the computer system ceases scrolling the scrollable content, such as shown by speed indicator 922 in FIG. 9W. In some embodiments, the user interface element is a window or volume of an application configured to present the scrollable content that is optionally bounded to the window. In some embodiments, the user interface element is a web browsing user interface element, a messaging user interface element, a word processing user interface element, an application user interface element or other user interface element configured to present content and/or virtual objects. In some embodiments, the boundary portion of the user interface element corresponds to an edge (e.g., top, bottom, right, or left) of the window or volume of the application, as opposed to an edge of the displayed scrollable content. In some embodiments, the boundary portion is within the user interface element. In some embodiments, the boundary portion is outside the user interface element. In some embodiments, the boundary portion straddles across a first area within the user interface element and a second area outside the user interface element. In some embodiments, the first region includes the boundary portion. For example, the boundary portion is optionally an edge of the first region. In some embodiments, the boundary portion is adjacent to a control element that, when selected performs an operation associated with the user interface element (e.g., move, resize, or close the user interface element) as described in more detail with reference to method 1000. In some embodiments, after ceasing scrolling the scrollable content in response to detecting that the gaze of the user is directed to the boundary portion, the computer system determines that the gaze of the user is directed away from the boundary portion of the user interface element, such as being directed to the first region of the scrollable content. In some embodiments, in response to the gaze directed to the first region of the scrollable content, the computer system scrolls the scrollable content at a respective speed as described herein. In some embodiments, while the gaze of the user is directed to the boundary portion, the computer system detects that the gaze of the user is moving to a location corresponding to a control element (e.g., described in method 1000), and in response, the computer system determines whether to suppress or continue scrolling the scrollable content as described in method 1000.

Ceasing scrolling the scrollable content in response to gaze directed to a boundary portion of a user interface element the scrollable content is displayed in provides feedback that the user's gaze is directed to a boundary portion of the user interface element which reduces errors in the interaction between the user and the computer system (e.g., by avoiding unintentional scrolling of content), thereby conserving computing resources associated with correcting erroneous input from the user and improving accessibility for users unable (e.g., users otherwise occupied or physically unable) to provide hand inputs or controller inputs.

In some embodiments, a size of the boundary portion of the user interface element in which the scrollable content is displayed changes over time, such as, for example, detecting an input (e.g., air gesture as described in more detail with reference to method(s) 800 and/or 1000) directed to control element 720, and in response, resizing the user interface element 704a including the size of the boundary portion of the user interface element 704a). In some embodiments, the size of the boundary portion of the user interface element changes over time, as when the computer system receives user input corresponding to a request to increase or decrease the size of the window (e.g., the user interface element). In some embodiments, the size of the boundary portion is based on the size of the window. For example, if the size of the window is smaller, then the size of the boundary portion is smaller, and if the size of the window is larger, then the size of the boundary portion is larger. In another example, a location of the boundary portion relative to the window changes over time. For example, if the window is moved from a first location within the three-dimensional environment to a second location within the three-dimensional environment, the boundary portion moves from the first location to the second location. In some embodiments, the size of the boundary portion is based on a hit volume of a control element location adjacent to the boundary portion as described above and with reference to method 1000. In some embodiments, the control element is configured to resize the user interface element and/or move the user interface element as described in more detail with reference to method 1000. Changing the size of the boundary portion of the user interface element in which the scrollable content is displayed over time ensures that the scrolling utility of the scrollable content is maintained for windows of different sizes which reduces errors in the interaction between the user and the computer system (e.g., by avoiding unintentional scrolling of content), thereby conserving computing resources associated with correcting erroneous input from the user and improving accessibility for users unable (e.g., users otherwise occupied or physically unable) to provide hand inputs or controller inputs.

In some embodiments, in accordance with a determination that the first region of the scrollable content includes the first type of content, the size and/or a position of the boundary portion is a first size and/or first position, such as, for example, in FIG. 7M where the user interface 704a includes text-based content. In some embodiments, in accordance with a determination that the first region of the scrollable content includes the second type of content, the size of the boundary portion is a second size and/or second position, different from the first size and/or second position, such as, for example, in FIG. 7N where the user interface 704a includes image-based content.

In some embodiments, the second size is larger than the first size. In some embodiments, the second size is smaller than the first size. In some embodiments, the size and/or position of the boundary portion of the user interface element in which the scrollable content is displayed is based on the type of content in the first region. For example, if the first region of the scrollable content includes text-based content, then the size of the boundary portion of the user interface element is smaller, and if the first region of the scrollable content includes image-based content, then the size of the boundary portion of the user interface element is larger. In another example, if the first region includes image-based content, then a position of the boundary portion of the user element optionally extends across a portion outside the user interface element. If the first region includes text-based content, then the position of the boundary portion of the user interface element is optionally contained within the user interface element.

Changing the size and/or position of the boundary portion of the user interface element the scrollable content is displayed in based on the type of content ensures that the scrolling utility of the scrollable content is maintained for different types of content which reduces errors in the interaction between the user and the computer system (e.g., by avoiding unintentional scrolling of content), thereby conserving computing resources associated with correcting erroneous input from the user and improving accessibility for users unable (e.g., users otherwise occupied or physically unable) to provide hand inputs or controller inputs.

In some embodiments, one or more parameters of the boundary portion of the user interface element in which the scrollable content is displayed are selected by an application associated with the scrollable content, such as application of user interface element 704a in FIG. 7A. In some embodiments, in accordance with a determination that the user interface element in which the scrollable content is displayed is a first application, the boundary portion is a first size and/or position relative to the user interface element (e.g., described above). In some embodiments, in accordance with a determination that the user interface element in which the scrollable content is displayed is a second application, different from the first application, the boundary portion is a second size and/or second position relative to the user interface element. In some embodiments, the second size and/or second position is different from the first size and/or first position. In some embodiments, the one or more parameters of the boundary portion of the user interface element include a size, position (e.g., top, bottom, left, or right portion of the user interface element), and/or enabled state. In some embodiments, the size, position, and whether the boundary portion is enabled or disabled are selected by the application associated with the scrollable content. For example, the computer system receives and/or captures a value indicative of an enabled state for the boundary portion of the user interface element such that when gaze is determined to be directed to the boundary portion of the user interface element, the computer system optionally does not scroll (or, optionally, ceases scrolling) the scrollable content. In another example, the computer system receives and/or captures a size value and/or position of the boundary portion of the user interface element optionally selected by the application associated with the scrollable content.

Using the one or more parameters of the boundary portion of the user interface element the scrollable content is displayed in as selected by the application associated with the scrollable content ensures that the scrolling utility of the scrolling content is maintained which reduces errors in the interaction between the user and the computer system (e.g., by avoiding unintentional scrolling of content), thereby conserving computing resources associated with correcting erroneous input from the user and improving accessibility for users unable (e.g., users otherwise occupied or physically unable) to provide hand inputs or controller inputs.

In some embodiments, the first region of the scrollable content has a first visual appearance while the gaze is not directed to the first region, such as shown by region 704c in FIG. 7A. In some embodiments, while the gaze of the user is not directed to the first region of the scrollable content, the computer system displaying the first region of the scrollable content with the first visual appearance, such as shown by region 704c in FIG. 7B. In some embodiments, while displaying the scrollable content including the first region the computer system detects, via the one or more input devices, the gaze of the user change from being directed to a location that is away from the first region to being directed to the first region, such as gaze being directed to region 704b, away from region 704c in FIG. 7H. In some embodiments, in response to detecting the gaze of the user being directed to the location that is away from the first region, the computer system displays the first region with the first visual appearance.

In some embodiments, in response to detecting the gaze of the user change from being directed to a location that is away from the first region to being directed to the first region, the computer system displays the first region with a second visual appearance, different from the first visual appearance, such as the visual appearance of region 704c in FIG. 7H. In some embodiments, the first visual appearance includes a first color, first pattern, first shading, first brightness, and/or first visual effect. In some embodiments, the second visual appearance includes a second color darker than the first color; a second pattern more distinct (or, optionally, more intense) than the first pattern; a second shading darker than the first shading, a second brightness more luminous than the first brightness; and/or a first visual effect more distinct (or, optionally, more intense) than the first visual effect. In some embodiments, after displaying the first region with the second visual appearance, the computer system detects that the gaze of the user is directed away from the first region, and in response, the computer system displays the first region with the first visual appearance. In some embodiments, the computer system initially displays the first region and any of the other regions described above including the second region with the first visual appearance. In some embodiments, the first region is not visually distinct from other regions of the scrollable content. In some embodiments, when the computer system detects that the gaze of the user is directed to the first region or any region responsive to gaze-only scrolling inputs as described above, the computer system displays the first region with the second visual appearance. In some embodiments, the first region having the second visual appearance is visually emphasized relative to other regions of the scrollable content irrespective of whether or not the other regions are responsive to gaze-only scrolling inputs as described above.

In some embodiments, the computer system displays the first region with the second visual appearance before the computer system starts scrolling the scrollable content. In some embodiments, the computer system displays the first region with the second visual appearance at the moment when the computer system starts scrolling the scrollable content. In some embodiments, the computer system displays the first region with the second visual appearance after the computer system starts scrolling the scrollable content.

Displaying the first region with a visual appearance that changes in response to gaze directed to the first region provides a quick way of indicating to the user scrollable regions, which enhances operability of the computer system and reduces power usage of the computer system, thereby reducing errors in the interaction between the user and the computer system, facilitating more efficient user interaction with the content, and conserving computing resources associated with correcting erroneous input from the user and improving accessibility for users unable (e.g., users otherwise occupied or physically unable) to provide hand inputs or controller inputs.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIGS. 9A-9KK illustrate methods of and systems for scrolling scrollable content in response to gaze-based inputs and/or input provided by a respective input element in accordance with some embodiments of the disclosure.

FIGS. 9A-9KK illustrate exemplary ways in which a computer system scrolls scrollable content in response to gaze-based inputs and/or input provided by a respective input element in accordance with some embodiments of the disclosure. The user interfaces in FIGS. 9A-9KK are used to illustrate the processes described below, including the processes in FIG. 10.

FIG. 9A illustrates a computer system 101 (e.g., an electronic device) displaying, via a display generation component 120 (e.g., display generation components 1-122a and 1-122b of FIG. 1), a three-dimensional environment 900 from a viewpoint of a user of the computer system 101. In FIG. 9A, the display generation component 120 is analogous to and/or includes one or more characteristics and/or one or more components (e.g., sensors 114a through 114c) as the display generation component 120 described with reference to FIG. 7A.

As shown in FIG. 9A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 900. For example, three-dimensional environment 900 includes representations of walls and a window 902 of the room in which the computer system 101 is located.

As discussed in more detail below, in FIG. 9A, display generation component 120 is illustrated as displaying one or more virtual objects in the three-dimensional environment 900. In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, computer system 101 detects input to computer system 101 are provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

In FIG. 9A, three-dimensional environment 900 includes a plurality of virtual objects, such as user interfaces and/or user interface elements 904a, 934, 910a, 912a, 906a, 916a, and 918a. In some embodiments, the virtual objects are optionally components of a user interface or window of an application containing scrollable content, such as a reading application, a media content application, a platform control application, or other application described with reference to method(s) 800, 1000, and/or 1200. In some embodiments, the term “scrollable content” refers to the user interface or window of the application. In some embodiments, the term “scrollable content” refers to content bounded to the user interface or window of the application. For example, in FIG. 9A, the computer system 101 displays internet browsing user interface element 904a (or, optionally, also referred to herein as a window or volume) of a web browser application containing website content, such as text, images, video, hyperlinks, and/or audio content, from the website. In some embodiments, the internet browsing user interface element 904a is analogous to and/or includes one or more characteristics of the internet browsing user interface element 704a in FIG. 7A.

In FIG. 9A, internet browsing user interface element 904a includes a navigation user interface element 934, control element 910a, and control element 912a. In some embodiments, the navigation user interface element 934 is analogous to and/or includes one or more characteristics of the navigation user interface element 706a in FIG. 7A. In some embodiments, control elements 910a and 912a are analogous to and/or include one or more characteristics of the control elements 718 and 720, respectively in FIG. 7A.

In FIG. 9A, internet browsing user interface element 904a includes scrollable content, such as an article that includes text-based content and/or image-based content. The internet browsing user interface element 904a includes a first scrolling region 904b and a second scrolling region 904c. As will be described in more detail below, in response to detecting the gaze of the user directed to the first scrolling region 904b or the second scrolling region 904c (e.g., without requiring additional user input as described below), the computer system 101 scrolls the scrollable content of the internet browsing user interface element 904a, respectively. In the example of FIG. 9A, the internet browsing user interface element 904a includes a third region 904d and in response to detecting the gaze of the user directed to the third region 904d, the computer system 101 does not scroll the scrollable content of the internet browsing user interface element 904a. In some embodiments, the third region 904d is not responsive to a gaze-only input (e.g., not including input from one or more portions of the user (e.g., hand, arm, and/or finger) of the computer system 101 other than those portions (e.g., eyes) providing the gaze input) as described with reference to method(s) 800 and/or 1000. In some embodiments, while the gaze of the user is directed to the third region 904d, the computer system 101 detects that a respective input element, such as hand 926a (e.g., as described in method 1000 and below) is providing an input to scroll the scrollable content, and in response, the computer system 101 scrolls the scrollable content in accordance with the respective input element as described in method 1000 and illustrated below. For illustrative purposes, as shown in FIG. 9A and the figures that follow, the first scrolling region 904b, the second region 904c, and the third region 904d are bounded by dashed lines, and it should be understood that the dashed lines of the respective regions are optionally not displayed via the display generation component 120.

In FIG. 9A, the computer system 101 displays music user interface element 906a (or, optionally, also referred to herein as a window or volume) of a music application containing music content, such as text, images, album art, music videos, and/or other user interface elements, such as control element 916a, and control element 918a. In some embodiments, control elements 916a and 918a are analogous to and/or include one or more characteristics of the control elements 718 and 720, respectively in FIG. 7A. In FIG. 9A, music user interface element 906a includes scrollable content, such as representations of music albums that, when selected, causes the computer system 101 to perform an action associated with the respective music album (e.g., display more information about the respective music album and/or play the respective music album). In some embodiments, the music user interface element 906a includes a first scrolling region 906b and a second scrolling region 906c.

In some embodiments, when the computer system 101 scrolls scrollable content vertically, the scrollable content includes scrolling regions at the top and bottom regions of the scrollable content. For example, in FIG. 9A, the first scrolling region 904b is at the top of the internet browsing user interface element 904a and the second scrolling region 904c is at the bottom of internet browsing user interface element 904a. In some embodiments, and as shown in FIG. 9A, the second scrolling region 904c is larger than the first scrolling region 904b. Optionally, the second scrolling region 904c is smaller than the first scrolling region 904b or the second scrolling region 904c is a same size as the first scrolling region 904b.

In some embodiments, when the scrollable content is scrolled horizontally, the scrollable content includes scrolling regions in the left and right regions of the scrollable content relative to the viewpoint of the user of the computer system. For example, in FIG. 9A, the first scrolling region 906b is located in a left region of the music user interface element 906a and the second scrolling region 906c is located in a right region of the music user interface element 906a relative to the viewpoint of the user (e.g., oriented towards the viewpoint of the user). In some embodiments, and as shown in FIG. 9A, the first scrolling region 906b is the same size as the second scrolling region 906c. Optionally, the first scrolling region 906b is larger than the second scrolling region 906c or the first scrolling region 906b is smaller than the second scrolling region 906c.

In some embodiments, in response to detecting that the gaze of the user is directed to a respective scrolling region (e.g., scrolling regions 904b, 904c, 906b, or 906c), the computer system 101 displays a visual indication that the respective scrolling region is gaze scrolling enabled (e.g., responsive to gaze-based inputs) as described below and in more detail with reference to method(s) 800 and/or 1000. For example, in FIG. 9A, in response to detecting gaze 908 directed to the second scrolling region 904c, the computer system 101 displays the second scrolling region 904c with a color or other visual appearance to emphasize the second scrolling region 904c relative to other regions (e.g., the first scrolling region 904b and the third region 904d) of the scrollable content (and/or the internet browsing user interface element 904a that includes the scrollable content). In some embodiments, displaying the second scrolling region 904c with the visual appearance is analogous to and/or includes one or more characteristics of displaying the second scrolling region 704c with the visual appearance in FIG. 7B.

In some embodiments, when the computer system 101 detects that gaze 908 is directed to the third region 904d, the computer system 101 does not display the third region 904d with the visual appearance because the third region 904d is not a gaze scrolling enabled region as described in more detail with reference to method(s) 800 and/or 1000.

In FIG. 9A, timer 936a indicates the amount of time gaze 908 has been directed to the second scrolling region 904c. In some embodiments, the time starts at a moment when the computer system 101 detects the gaze 908 is directed to the second scrolling region 904c. For example, the computer system 101 determines that the duration of the gaze 908 directed to the second scrolling region 904c is less than a first time threshold 936b and in response, the computer system 101 does not scroll the scrollable content of the internet browsing user interface element 904a. FIG. 9A also includes speed indicator 922 indicative of the speed at which the computer system 101 scrolls the scrollable content of the internet browsing user interface element 904a. In FIG. 9A, speed indicator 922 has a zero value (e.g. “S0”) which indicates that the scrollable content of the internet browsing user interface element 904a is not yet being scrolled in response to the gaze 908 of the user directed to the second scrolling region 904c.

In some embodiments, and as will be described below, the computer system 101 detects that a respective input element (e.g., as described in method 1000 and illustrated below) is providing an input to scroll the scrollable content. For example, in FIG. 9A, the respective input element optionally includes a portion of the user, such as a hand 926a, arm, and/or finger of the user of the computer system 101 as will be described in more detail below and with reference to method 1000. In some embodiments, in response to detecting that the respective input element is providing the input to scroll the scrollable content, the computer system scrolls the scrollable content in accordance with the respective input element, optionally at a speed as indicated by speed indicator 924 in FIG. 9A. In FIG. 9A, speed indicator 924 has a zero value (e.g. “S0”) which indicates that the scrollable content is not yet being scrolled in accordance with the respective input element. In FIG. 9A, the computer system determines that hand 926a is in a resting state (e.g., at the user's side, out of the user's field of view, on a lap while sitting, and/or not detected as providing input(s) to interact with the one or more virtual objects, such as providing the input to scroll the scrollable content).

FIG. 9B illustrates the computer system 101 scrolling the scrollable content in response to determining that the duration of the gaze 908 directed to the second scrolling region 904c exceeds the first time threshold 936b. As shown in FIG. 9B, in response to detecting the gaze 908 of the user directed to the second scrolling region 904c (e.g., the bottom region), the computer system 101 scrolls the scrollable content of the internet browsing user interface element 904a up to reveal additional scrollable content at the bottom of the internet browsing user interface element 904a. In some embodiments, and as a shown in FIG. 9B, after a predetermined amount of time has elapsed (e.g., as described in method 800), the computer system 101 does not display the second scrolling region 904c with the visual appearance as previously illustrated in FIG. 9A.

In some embodiments, the speed at which the computer system 101 scrolls the scrollable content is based on a location and/or duration of the gaze 908 directed to the second scrolling region 904c as described in more detail with reference to method 800 and as shown in FIGS. 7C, 7D, and 7L-7O. As shown in FIG. 9B, in response to detecting the location and/or duration of the gaze 908 directed to the second scrolling region 904c, the computer system 101 scrolls the scrollable content of the internet browsing user interface element 904a at a first speed (e.g., “S3”) as indicated by speed indicator 922.

In some embodiments, when the computer system 101 detects that a respective input element is providing an input to scroll the scrollable content, the computer system 101 forgoes scrolling the scrolling the scrollable content in accordance with the gaze of the user directed to the scrollable content as described in method 1000. For example, in FIG. 9C, the compute system 101 detects the hand 926b is performing a pinch gesture (e.g., two or more fingers of a user's hand 926b such as the thumb and index finger moving together and touching each other as described in more detail with reference to method(s) 800 and/or 1000) while gaze 908 is directed to the second scrolling region 904c of the internet browsing user interface element 904a. In some embodiments, in response to detecting the hand 926b performing the pinch gesture, the computer system stops scrolling the scrollable content of the internet browsing user interface element 904a as indicated by speed indicator 924 having a zero value (e.g. “S0”) which indicates that the computer system 101 has stopped scrolling the scrollable content of the internet browsing user interface element 904a.

In some embodiments, and as shown in FIG. 9D, the computer system 101 detects the hand 926b performing the pinch gesture followed by movement of the hand 926b from a first location 926b-1 to a second location 926b-2. In FIG. 9D, the computer system 101 scrolls the scrollable content with a magnitude and/or direction corresponding to the movement of the hand 926b from the first location 926b-1 to the second location 926b-2 (e.g., scrolls the scrollable content of the internet browsing user interface element 904a upward in accordance with the hand 926b moving upwards from the first location 926b-1 to the second location 926b-2). In FIG. 9D, speed indicator 924 has a first value (e.g. “S3”) which indicates that the computer system 101 is scrolling the scrollable content of the internet browsing user interface element 904a in accordance with the movement of the hand 926b from the first location 926b-1 to the second location 926b-2. In some embodiments, the respective input element includes an input other than the input provided by the hand 926b, such as for example, trackpad inputs, input device inputs (e.g., handheld input device) as described in more detail with reference to method 1000.

In some embodiments, the computer system 101 scrolls the scrollable content in accordance with the gaze of the user directed to a respective region while detecting that the respective input element is providing an input to respective content (or, optionally, of a same user interface or a different user interface of the respective user interface that contains the scrollable content) described in more detail in method 1000 and illustrated below. For example, in FIG. 9E, the computer system 101 detects that hand 926a is in a resting state (e.g., described above with reference to detecting hand 926a in the resting state in FIG. 9A). In FIG. 9E, speed indicator 924 has a zero value (e.g. “S0”) which indicates that the computer system 101 stopped scrolling the scrollable content of the internet browsing user interface element 904a in response to detecting that the hand 926a is in the resting state.

In some embodiments, the computer system 101 detects the gaze 908 moving from being directed to the second scrolling region 904c of the internet browsing user interface element 904a in FIG. 9D to being directed to the second scrolling region 906c of the music user interface element 906a. In some embodiments, and as described in more detail with reference to method 800, the computer system 101 contracts the second scrolling region 904c as show in FIG. 9E. In FIG. 9E, in response to detecting the gaze 908 of the user moving from the second scrolling region 904c to the second scrolling region 906c, the computer system 101 displays a visual indication that the second scrolling region 906c is gaze scrolling enabled (e.g., responsive to gaze-based inputs) and/or expands the second scrolling region 906c to include a region different from and adjacent to the second scrolling region 906c as shown in FIG. 9E and as described in more detail with reference to method 800. In FIG. 9E, in response to detecting gaze 908 directed to the second scrolling region 906c, the computer system 101 displays the second scrolling region 906c with a color or other visual appearance to emphasize the second scrolling region 906c relative to other regions (e.g., the first scrolling region 906b) of the scrollable content (and/or the music user interface element 906a that includes the scrollable content). In some embodiments, displaying the second scrolling region 906c with the visual appearance is analogous to and/or includes one or more characteristics of displaying the second scrolling region 904c with the visual appearance in FIG. 9A.

In FIG. 9E, timer 936a indicates the amount of time gaze 908 has been directed to the second scrolling region 906c. For example, the computer system 101 determines that the duration of the gaze 908 directed to the second scrolling region 906c is less than a first time threshold 936b and in response, the computer system 101 does not scroll the scrollable content of the music user interface element 906a. In FIG. 9F, the computer system 101 detects the hand 926f performing a pinch gesture (e.g., described above with reference to detecting hand 926b performing the pinch gesture in FIG. 9C) while gaze 908 is directed to the second scrolling region 906c of the music user interface element 906a. In FIG. 9G, the computer system 101 detects the hand 926f performing the pinch gesture followed by movement of the hand 926f from a first location 926f-1 to a second location 926f-2. In FIG. 9G, the computer system 101 scrolls the scrollable content of the music interface element 906a with a magnitude and/or direction corresponding to the movement of the hand 926f from the first location 926f-1 to the second location 926f-2 (e.g., scrolls the scrollable content of the music interface element 906a horizontally from right to left in accordance with the hand 926b moving horizontally from right to left from the first location 926f-1 to the second location 926f-2). In FIG. 9G, speed indicator 924 has a first value (e.g. “S3”) which indicates that the computer system 101 is scrolling the scrollable content of the music user interface element 906a in accordance with the movement of the hand 926f from the first location 926f-1 to the second location 926f-2. As shown in FIG. 9G, the speed indicator has a zero value indicating that the computer system 101 is not scrolling based on gaze because hand 926f is providing the scrolling input despite the duration of the gaze 908 directed to the second scrolling region 908c exceeding the first time threshold 936b.

In FIG. 9H, the computer system 101 detects continued movement of the hand 926f (or, optionally, while performing the pinch gesture described above) from the second location 926f-2 to a third location 926f-3. In FIG. 9H, the computer system 101 scrolls the scrollable content of the music interface element 906a with a magnitude and/or direction corresponding to the continued movement of the hand 926f from the second location 926f-2 to a third location 926f-3. While the computer system scrolls the scrollable content in accordance with the continued movement of the hand 926f from the second location 926f-2 to a third location 926f-3, the computer system 101 detects the gaze 908 moving from being directed to the second scrolling region 906c of the music user interface element 906a in FIG. 9G to being directed to the second scrolling region 904c of the internet browsing user interface element 904a in 9H.

In FIG. 9H, in response to detecting the gaze 908 of the user moving from the second scrolling region 906c to the second scrolling region 904c, the computer system 101 displays a visual indication that the second scrolling region 904c is gaze scrolling enabled (e.g., responsive to gaze-based inputs) and/or expands the second scrolling region 904c in a manner similar to the manner described above with reference to the second scrolling region 904c in FIG. 9A. In FIG. 9H, timer 936a indicates the amount of time gaze 908 has been directed to the second scrolling region 904c. For example, the computer system 101 determines that the duration of the gaze 908 directed to the second scrolling region 904c is less than a first time threshold 936b and in response, the computer system 101 does not scroll the scrollable content of the internet browsing user interface element 904a. FIG. 9H also includes speed indicator 922 indicative of the speed at which the computer system 101 scrolls the scrollable content of the internet browsing user interface element 904a. In FIG. 9H, speed indicator 922 has a zero value (e.g. “S0”) which indicates that the scrollable content of the internet browsing user interface element 904a is not yet being scrolled in response to the gaze 908 of the user directed to the second scrolling region 904c.

FIG. 9I illustrates that while the computer system detects continued movement of the hand 926f (or, optionally, while performing the pinch gesture described above) from the third location 926f-3 to a fourth location 926f-4 (e.g., the computer system 101 determines continued input is provided to scroll the scrollable content via the hand 926f while performing the pinch gesture), the computer system 101 scrolls the scrollable content of the music interface element 906a with a magnitude and/or direction corresponding to the continued movement of the hand 926f from the third location 926f-3 to the fourth location 926f-4, and the computer system 101 scrolls scrollable content other than the scrollable content of the music interface element 906a in accordance with gaze directed to a respective region of the scrollable content other than the scrollable content of the music interface element 906a as described in some embodiments and/or as shown in the figures that follow. For example, in FIG. 9I, while the computer system 101 scrolls the scrollable content of the music interface element 906a in accordance with the continued movement of the hand 926f from the third location 926f-3 to the fourth location 926f-4, the computer system 101 determines that the gaze 908 directed to the second scrolling region 904c of the internet browsing user interface element 904a satisfies the gaze-based criteria for scrolling the scrollable content of the internet browsing user interface element 904a (e.g., described in more detail with reference to method(s) 800 and/or 1000) including a criterion that is satisfied when the duration of the gaze 908 directed to the second scrolling region 904c exceeds the first time threshold 936b as shown by timer 936a in FIG. 9I.

FIG. 9I illustrates the computer system 101 scrolling the scrollable content of the internet browsing user interface element 904a in response to determining that the duration of the gaze 908 directed to the second scrolling region 904c exceeds the first time threshold 936b. In some embodiments, the computer system scrolls the scrollable content of the internet browsing user interface element 904a in a manner similar to the manner described above with reference to scrolling the scrollable content of the internet browsing user interface element 904a in FIG. 9B. In some embodiments, the speed at which the computer system 101 scrolls the scrollable content is based on a location and/or duration of the gaze 908 directed to the second scrolling region 904c. For example, as shown in FIG. 9I, the computer system 101 scrolls the scrollable content of the internet browsing user interface element 904a at a second speed (e.g., “S4”) as indicated by speed indicator 922 faster than the first speed (e.g., “S3”) at which the computer system scrolls the scrollable content of the internet browsing user interface element 904a in accordance with the respective location of the gaze directed to the second scrolling region 904c in FIG. 9B. The speed at which the computer system 101 scrolls scrollable content based on the location and/or duration of the gaze is described in more detail with reference to method 800 and/or as shown in FIGS. 7C, 7D, and 7L-7O.

In FIG. 9J, the computer system 101 detects that hand 926a is in a resting state (e.g., described above with reference to detecting hand 926a in the resting state in FIG. 9A). In some embodiments, in response to detecting the hand 926a in the resting state, the computer system 101 stops scrolling the scrollable content of the music interface element 906a as shown by speed indicator 924 having a zero value (e.g. “S0”).

In some embodiments, the scrolling speed increases as the duration of the gaze 908 directed to the second scrollable region 904c increases (e.g., length of time the gaze of the user is directed to the second scrollable region 904c). For example, the duration of gaze 908 directed to the second scrollable region 904c has increased from FIGS. 9I to 9J, but still has not reached the second threshold 936c. Thus, in some embodiments, the computer system continues to scroll the scrollable content of the internet browsing user interface element 904a at the same speed (e.g., S4) as the speed at which the computer system 101 scrolls the scrollable content when the duration of the gaze 908 directed to the second scrollable region 904c was the duration amount shown by timer 936a in FIG. 9I. In some embodiments, when the computer system determines that the duration of gaze 908 directed to the second scrollable region 904c has increased again, and has exceeded the second threshold 936c, the computer system 101 changes (e.g., increases) the scrolling speed in a manner similar to the manner in which the computer system changes the scrolling speed described in more detail in method 800 and/or as shown in FIGS. 7L-7O.

In FIG. 9K, the computer system 101 detects that the gaze 908 is directed away from the second scrollable region 904c to being directed to additional content 904c. In some embodiments, additional content element 904e is analogous to and/or includes one or more characteristics of additional content 716a in FIGS. 7A-7G. In some embodiments, in response to detecting that the gaze 908 is directed away from the second scrollable region 904c to being directed to additional content 904c, the computer system 101 stops scrolling the scrollable content (e.g., the scrolling speed is zero, “S0” as shown by indicator 922) in accordance with the determination that the gaze 908 is directed away from the second scrollable region 904c to being directed to additional content 904c. In FIG. 9K, while gaze 908 is directed to additional content element 904c, the computer system detects the hand 926k performing a pinch gesture (e.g., described above with reference to detecting hand 926b performing the pinch gesture in FIG. 9C).

In FIG. 9L, the computer system 101 detects the hand 926k performing the pinch gesture followed by movement of the hand 926k from a first location 926k-1 to a second location 926k-2. In FIG. 9L, the computer system 101 scrolls the scrollable content of the additional content element 904e with a magnitude and/or direction corresponding to the movement of the hand 926k from the first location 926k-1 to the second location 926k-2 (e.g., scrolls the scrollable content of the additional content element 904e upwards to reveal content from the bottom of the additional content element 904c in accordance with the hand 926k moving upwards from the first location 926k-1 to the second location 926k-2) in accordance with the gaze 908 being directed to additional content element 904c. In FIG. 9L, speed indicator 924 has a first value (e.g. “S2”) which indicates that the computer system 101 is scrolling the scrollable content of the additional content element 904e in accordance with the movement of the hand 926k from the first location 926k-1 to the second location 926k-2.

FIG. 9M illustrates that while the computer system detects continued movement of the hand 926k while performing the pinch gesture (or, optionally, albeit from a different direction) from the second location 926k-2 to a third location 926k-3 (e.g., the computer system 101 determines continued input is provided to scroll the scrollable content via the hand 926k while performing the pinch gesture), the computer system 101 scrolls the scrollable content of the internet browsing user interface element 904a with a magnitude and/or direction corresponding to the continued movement of the hand 926k from the second location 926k-2 to a third location 926k-3 (e.g., scrolls downwards to reveal content from the top of the additional content element 904c), and the computer system 101 scrolls scrollable content in the same user interface (e.g., the internet browsing user interface element 904a) in accordance with gaze directed to a respective scrolling region of the internet browsing user interface element 904a as described in some embodiments and/or as shown in the figures that follow. For example, in FIG. 9M, while the computer system 101 scrolls the scrollable content of the additional content element 904e included in the browsing user interface element 904a in accordance with the continued movement of the hand 926f the second location 926k-2 to the third location 926k-3, the computer system 101 detects the gaze 908 change from being directed to the additional content element 904e to being directed to the first scrolling region 904b of the internet browsing user interface element 904a.

In FIG. 9M, in response to detecting the gaze 908 of the user moving from being directed to the additional content element 904e to being directed to the first scrolling region 904b, the computer system 101 displays a visual indication that the first scrolling region 904b is gaze scrolling enabled (e.g., responsive to gaze-based inputs) and/or expands first scrolling region 904b in a manner similar to the manner described above with reference to the second scrolling region 904c in FIG. 9A. In FIG. 9M, timer 936a indicates the amount of time gaze 908 has been directed to the first scrolling region 904b (e.g., less than a first time threshold 936b). Thus, in some embodiments, the computer system 101 does not scroll the scrollable content of the internet browsing user interface element 904a. FIG. 9M also includes speed indicator 922 indicative of the speed at which the computer system 101 scrolls the scrollable content of the internet browsing user interface element 904a. In FIG. 9M, speed indicator 922 has a zero value (e.g. “S0”) which indicates that the scrollable content of the internet browsing user interface element 904a is not yet being scrolled in accordance with the determination that the gaze 908 of the user directed to the first scrolling region 904b does not satisfy the gaze-based criteria for scrolling the scrollable content of the internet browsing user interface element 904a (e.g., described in more detail with reference to method(s) 800 and/or 1000) including a criterion that is satisfied when the duration of the gaze 908 directed to the first scrolling region 904b exceeds the first time threshold 936b.

In FIG. 9N, while the computer system 101 scrolls the scrollable content of the additional content element 904e in accordance with the detected continued movement of the hand 926k from the third location 926k-3 to the fourth location 926k-4, the computer system 101 determines that the gaze 908 directed to the first scrolling region 904b of the internet browsing user interface element 904a satisfies the gaze-based criteria (e.g., the duration of gaze 908 exceeds threshold 936b), and in response, the computer system 101 scrolling the scrollable content of the internet browsing user interface element 904a in response to determining that the duration of the gaze 908 directed to the first scrolling region 904b exceeds the first time threshold 936b). FIG. 9N also indicates the speed at which the computer system 101 scrolls the scrollable content of the internet browsing user interface element 904a as shown by speed indicator 922 with a first speed value (e.g., “S2”).

FIG. 9O (or, optionally, other figures) illustrate multiple concurrent gaze inputs directed to internet browsing user interface element 904a, music user interface element 906a, control elements 910a, 912a, 916a, and/or 918a. It is understood that such gaze inputs are optionally alternative inputs, and not concurrent inputs. Additionally, in some embodiments, input to computer system 101 is provided via air gestures from hand 926a and/or gaze 908 of the user (e.g., as described in more detail with reference to method 800).

In some embodiments, the control elements 910a, 912a, 916a, and/or 918a are responsive to gaze-based inputs as described in more detail with reference to method(s) 800 and/or 1000 and/or as shown in the figures that follow. In some embodiments, the control elements 910a, 912a, 916a, and/or 918a are associated with respective hit volumes described in more detail with reference to method 1000 and/or as shown in FIG. 9CC. For example, a respective hit volume associated with a respective control element is an area of the three-dimensional environment responsive to gaze-based inputs. In some embodiments, the respective hit volume has a size based on whether a user interface element (e.g., internet browsing user interface element 904a, music user interface element 906a, or other user interface element described herein) including the one or more regions of the user interface element has gaze-based scrolling enabled as described in more detail with reference to method 1000. In some embodiments, the control elements 910a, 912a, 916a, and/or 918a include one or more characteristics described with reference to the exemplary set of control elements in FIG. 9CC.

Returning to FIG. 9O, in accordance with a determination that region 904c of the internet browsing user interface element 904a is responsive to gaze-only scrolling inputs, the respective hit volumes (e.g., hit volume 910b and 912b) associated with control elements 910a and 912a have a size analogous to hit volumes 916b and 912b associated control elements 910a and 912a, respectively in FIG. 9CC. In FIG. 9O, in accordance with a determination that region 906d of music user interface element 906a is not responsive to gaze-only scrolling inputs, the respective hit volumes (e.g., hit volume 916b and 918b) associated with control elements 916a and 918a have a size analogous to hit volumes 916b and 918b associated with control elements 910a and 912a, respectively in FIG. 9CC.

From FIG. 9O to FIG. 9P, the computer system 101 detects the gaze 908 moving from being directed to the third region 904d of the internet browsing user interface element 904a in FIG. 9O to being directed to the control element 912a (e.g., within the hit volume 912b) associated with the music user interface element 906a. In response to detecting the gaze 908 moving from being directed to the third region 904d to being directed to the control element 912a, the computer system 101 displays control elements 910a and 912a with a color or other visual appearance indicative of control elements 910a and 912a gaining system focus as shown in FIG. 9P.

In another example, the computer system 101 detects gaze 920 (or, optionally, analogous to and/or includes one or more characteristics of gaze 908) moving from being directed to a middle region of the music user interface element 906a in FIG. 9O to being directed to an overlapping region 918c (or, optionally, analogous to overlapping region 918c in FIG. 9CC) in FIG. 9P. In response to detecting the gaze 920 moving from being directed to the middle region of the music user interface element 906a to being directed to the overlapping region 918c, the computer system 101 displays control elements 910a and 912a with a color or other visual appearance indicative of control elements 910a and 912a gaining system focus as shown in FIG. 9P.

From FIG. 9P to FIG. 9Q, the computer system 101 detects gaze 908 and gaze 920 moving to respective locations away from control elements 912a and 918a, respectively. As shown in FIG. 9Q, in response to detecting that gaze 908 and gaze 920 moving to respective locations away from control elements 912a and 918a, the computer system 101 continues to display the control elements 912a and 918a with the visual appearance indicative of the control elements 912a and 918a having system focus because the computer system 101 determines that gaze 908 and gaze 920 are still directed to respective locations within the respective hit volumes of control elements 912a and 918a, respectively.

From FIG. 9Q to FIG. 9R, the computer system 101 detects gaze 908 moving to a location outside the hit volume 912b to a location within the second scrolling region 904c, such as, for example, to a location outside hit volume 912b and within region 932 adjacent to control elements 910a and 912a in FIG. 9CC. In some embodiments, in response to detecting the gaze 908 moving to a location outside the hit volume 912b to a location within the second scrolling region 904c, the computer system 101 moves the system focus from the control elements 910a and 912a to the second scrolling region 904c. In some embodiments, and as shown in FIG. 9R, in response to detecting the gaze 908 moving to a location outside the hit volume 912b to a location within the second scrolling region 904c, the computer system 101 ceases to display control elements 912a and 918a with the visual appearance indicative of the control elements 912a and 918a having system focus and displays the second scrolling region 904c with a visual appearance optionally analogous to and/or having one or more of the characteristics of displaying the second scrolling region 904c with the visual appearance as shown in FIG. 9A.

In FIG. 9Q, timer 936a indicates the amount of time gaze 908 has been directed to the second scrolling region 904c. For example, the computer system 101 determines that the duration of the gaze 908 directed to the second scrolling region 904c is less than a first time threshold 936b and in response, the computer system 101 does not scroll the scrollable content of the internet browsing user interface element 904a. From FIG. 9Q to FIG. 9R additionally illustrates computer system 101 detecting gaze 920 moving to a location outside the hit volume 918b to a location within hit volume 916b, such as, for example, to a location within hit volume 916b adjacent to hit volume 918b in FIG. 9CC. In some embodiments, in response to detecting the gaze 908 moving to a location outside the hit volume 912b to a location within the second scrolling region 904c, the computer system 101 moves the system focus from the control elements 910a and 912a to the second scrolling region 904c. In some embodiments, and as shown in FIG. 9R, in response to detecting the gaze 908 moving to a location outside the hit volume 918b to a location within hit volume 916b, the computer system 101 changes the visual appearance of control element 916a to visually convey a specific action (e.g., close and/or cease to display the music user interface element 906a) in response to gaining more targeted system focus. Thus, in some embodiments, the computer system 101 displays control element 916a in a manner that indicates that, in response to further user input (e.g., pinch gesture) directed to the control element 916a while the control element 916a has system focus, causes the computer system 101 to close and/or cease to display the music user interface element 906a associated with the control element 916a.

FIG. 9S illustrates the computer system 101 scrolling the scrollable content in response to determining that the duration of the gaze 908 directed to a location within the second scrolling region 904c exceeds the first time threshold 936b. Scrolling the scrollable content is optionally analogous to and/or includes one or more characteristics of scrolling scrollable content as shown in FIG. 9B. In some embodiments, and as a shown in FIG. 9S, after a predetermined amount of time has elapsed (e.g., as described in method 800), the computer system 101 does not display the second scrolling region 904c with the visual appearance as previously illustrated in FIG. 9R. In FIG. 9S, scrolls the scrollable content at a first speed (e.g., “S3”) as indicated by speed indicator 922. In some embodiments, the speed at which the computer system 101 scrolls the scrollable content is based on a location and/or duration of the gaze as described in more detail with reference to method 800.

From FIG. 9R to FIG. 9S, the computer system 101 detects gaze 920 moving from being directed to a location within hit volume 916b in FIG. 9R to being directed to a location within overlapping region 916c (or, optionally, analogous to overlapping region 916c in FIG. 9CC) in FIG. 9S. In response to detecting the gaze 920 moving from being directed to the location within hit volume 916b to the location within overlapping region 916c, the computer system 101 maintains system focus on control element 916a and continues to display control element 916a with a visual appearance indicative of control element 916a having system focus as shown in FIG. 9S.

From FIG. 9S to FIG. 9T, the computer system 101 detects gaze 908 moving from a first location within the second scrolling region 904c in FIG. 9S to a second location within the second scrolling region 904c in FIG. 9T. In some embodiments, the computer system 101 continues to scroll the scrollable content because the location of the gaze 908 is still within the second scrolling region 904c In FIG. 9T, the computer system 101 scrolls the scrollable content at a second speed (e.g., “S2”) as indicated by speed indicator 922. In some embodiments, the second speed is less than the first speed in FIG. 9S because of the detected respective locations of the gaze 908 within the second scrolling region 904c as described in more detail with reference to method 800.

From FIG. 9S to FIG. 9T, the computer system 101 detects gaze 920 moving from being directed to a location within overlapping region 916c in FIG. 9S to being directed to a location outside the hit volume 916b of control element 916a (e.g., a location in the music user interface element 906a). In response to detecting the gaze 920 moving from being directed to a location within overlapping region 916c in FIG. 9S to being directed to a location outside the hit volume 916b of control element 916a, the computer system 101 removes system focus on control element 916a and ceases to display control element 916a with the visual appearance indicative of control element 916a having system focus as shown in FIG. 9T.

From FIG. 9T to FIG. 9U, the computer system 101 detects gaze 908 moving from the second location within the second scrolling region 904c in FIG. 9T to a third location within the second scrolling region in FIG. 9U. In some embodiments, in response to detecting the gaze 908 moving from the second location within the second scrolling region 904c in FIG. 9T to the third location within the second scrolling region 904c in FIG. 9U, the computer system 101 scrolls the scrollable content at a third speed (e.g., “S3”) as indicated by speed indicator 922. In some embodiments, the third speed is greater than the second speed in FIG. 9T because of the detected respective locations of the gaze 908 within the second scrolling region 904c as described in more detail with reference to method 800.

From FIG. 9T to FIG. 9U, the computer system 101 detects gaze 920 moving from being directed to a location outside the hit volume 916b of control element 916a (e.g., a location in the music user interface element 906a) in FIG. 9T to being directed to a second location in the music user interface element 906a in FIG. 9U that is a greater distance away from the first location in the music user interface element 906a shown in FIG. 9T. In some embodiments, both locations are not gaze scrolling enabled (e.g., not responsive to gaze-based inputs) and thus, in some embodiments, the computer system 101 continues to display control element 916a without the visual appearance indicative of control element 916a having system focus as shown in FIG. 9U.

From FIG. 9U to FIG. 9V, the computer system 101 detects gaze 908 moving from the third location within the second scrolling region 904c in FIG. 9U to a fourth location within the second scrolling region 904c in FIG. 9V, and because the gaze 908 is directed to a location still within the second scrolling region, the computer system 101 continues scrolling the scrollable content at the third speed (e.g., “S3”).

From FIG. 9V to FIG. 9W, the computer system 101 detects gaze 908 moving from the fourth location within the second scrolling region 904c in FIG. 9V to a location within the hit volume 912b of control element 912a in FIG. 9W. In some embodiments, in response to detecting the gaze 908 moving from the fourth location within the second scrolling region 904c in FIG. 9V to a location within the hit volume 912b of control element 912a in FIG. 9W, the computer system 101 ceases scrolling the scrollable content as indicated by speed indicator 922 with a zero value (e.g. “S”) and moves system focus from the second scrolling region 904c to control element 912a. In some embodiments, the computer system 101 detects a selection input while a respective control element 912a has focus before the computer system 101 displays control element 912a with the visual appearance, and in response to detecting the selection input, the computer system 101 selects the respective control element for subsequent inputs despite displaying the control element 912a without the visual appearance as described in more detail with reference to method 1000. For example, in FIG. 9X, the computer system 101 detects the hand 926x performing a pinch gesture (e.g., described above with reference to detecting hand 926b performing the pinch gesture in FIG. 9C) while the control element 912a has system focus and gaze 908 is directed to the control element.

In some embodiments, and as shown in FIG. 9Y, the computer system 101 detects the hand 926x performing the pinch gesture followed by movement of the hand 926x from a first location 926x-1 to a second location 926x-2, and in response, the computer system 101 moves the internet browsing user interface element 904a with a magnitude and/or direction corresponding to the movement of the hand 926x from the first location 926x-1 to the second location 926x-2 (e.g., moves the internet browsing user interface element 904a upward in accordance with the hand 926x moving upwards from the first location 926x-1 to the second location 926x-2).

In FIG. 9Z, the computer system 101 detects continued movement of the hand 926x (or, optionally, while performing the pinch gesture described above) from the second location 926X-2 to a third location 926x-3, and in response, the computer system 101 moves the internet browsing user interface element 904a down in accordance with the hand 926x moving downwards from the second location 926x-2 to a third location 926x-3. In some embodiments, the computer system 101 displays control elements 910a and 912a with the visual appearance indicative of the control elements 910a and 912a having system focus.

In some embodiments, the computer system 101 scrolls the scrollable content in accordance with the gaze of the user directed to a respective region while detecting that the hand 926x is not providing an input. For example, in FIG. 9AA, the computer system 101 detects that hand 926a is in a resting state (e.g., described above with reference to detecting hand 926a in the resting state in FIG. 9A). In FIG. 9BB, while the hand 926a is in a resting state, the computer system 101 determines that the gaze 908 directed to the second scrolling region 904c of the internet browsing user interface element 904a satisfies the gaze-based criteria for scrolling the scrollable content of the internet browsing user interface element 904a (e.g., described in more detail with reference to method(s) 800 and/or 1000) including a criterion that is satisfied when the duration of the gaze 908 directed to the second scrolling region 904c exceeds the first time threshold 936b as shown by timer 936a in FIG. 9BB. In some embodiments, in accordance with the determination that the gaze 908 directed to the second scrolling region 904c of the internet browsing user interface element 904a satisfies the gaze-based criteria for scrolling, the computer system scrolls the scrollable content as shown in FIG. 9BB.

For example, in FIG. 9CC exemplary control elements 916a, 918a, 910a, and 912a are magnified to illustrate their hit volumes, 916b, 918b, 910b, and 912b, respectively. In FIG. 9CC, control elements 910a and 912a are associated with user interface element 940. In some embodiments, in accordance with a determination that the user interface element 940 is responsive to gaze-based inputs (e.g., a region 932 adjacent to control elements 910a and 912a is responsive to gaze-only scrolling inputs), the hit volumes 910b and 912b associated with control elements 910a and 912a, respectively have a first size. In FIG. 9CC, user interface element 938 is not responsive to gaze-based inputs (e.g., a region 930 adjacent to control elements 916a and 918a is not responsive to gaze-only scrolling inputs), the hit volumes 916b and 918b associated with control elements 916a and 918a, respectively have a second size, larger than the first size as shown in FIG. 9CC. In some embodiments, the hit volumes 916b and 918b and the region 930 overlap at overlapping regions 916c and 918c, respectively.

In some embodiments, the hit volumes 916b, 918b, 910b, and 912b are utilized by the computer system 101 as part of adding or removing system focus to respective control elements. For example, and as described in more detail with reference to method 1000, when a respective control element has system focus (or, optionally, input focus) (e.g., selected by gaze, selected by a gesture, and/or selected by any of the other user inputs described in method(s) 800 and/or 1000), and the computer system 101 detects a subsequent input (e.g., gesture input), the computer system 101 directs the subsequent input to the respective control element because the system focus is on the respective control element. For example, when the computer system 101 detects the location of the gaze within hit volume 910b, the control element 910a has system focus. In another example, when the computer system 101 detects the location of the gaze within overlapping region 918c and/or hit volume 918b, the control element 918a has system focus.

In some embodiments, the computer system 101 detects a selection input while a respective control element has focus, and in response to detecting the selection input, the computer system 101 selects the respective control element for subsequent inputs as described in more detail with reference to method 1000. For example, from FIG. 9DD to FIG. 9EE, the computer system 101 detects gaze 908 moving from a fifth location within the second scrolling region 904c in FIG. 9DD to a corner location of the internet browsing user interface element 904a in FIG. 9EE. In some embodiments, in response to detecting the gaze 908 moving from the fifth location within the second scrolling region 904c in FIG. 9DD to a corner location of the internet browsing user interface element 904a in FIG. 9EE, the computer system 101 displays, via the one or more display generation components, a resize control element 914a that, when selected, causes the computer system 101 to resize the internet browsing user interface element 904a as will be described below. In some embodiments, and as shown in FIG. 9EE, the resize control element 914a includes a hit volume 914b analogous to and/or includes one or more characteristics of a hit volume described herein. In some embodiments, resize control element 914a is an irregularly shaped virtual object and the computer system 101 optionally applies an appropriately shaped hit volume, such the hit volume 914b that is a rectangular, cuboidal shape.

In some embodiments, and as shown in FIG. 9EE, the computer system 101 displays the resize control element 914a with a visual appearance indicative of the resize control element 914a having system focus as shown in FIG. 9EE. In some embodiments, displaying the resize control element 914a with the visual appearance is analogous to and/or includes one or more characteristics of displaying control elements 910a and 912a with a visual appearance described in FIG. 9AA. In FIG. 9FF, the computer system 101 detects the hand 926ff performing a pinch gesture (e.g., as described above with reference to detecting hand 926b performing the pinch gesture in FIG. 9C) while the resize control element 914a has system focus and gaze 908 is directed to the resize control element 914a. In some embodiments, and as shown in FIG. 9GG, the computer system 101 detects the hand 926ff performing the pinch gesture followed by movement of the hand 926ff from a first location 926ff-1 to a second location 926ff-2, and in response, the computer system 101 resizes the internet browsing user interface element 904a with a magnitude and/or direction corresponding to the movement of the hand 926ff from the first location 926ff-1 to the second location 926ff-2.

In FIG. 9HH, the computer system 101 detects that hand 926a is in a resting state, and in response to detecting the hand 926a in the resting state, the computer system 101 stops resizing the internet browsing user interface element 904a. In FIG. 9HH, the gaze 908 has moved from the corner location of the internet browsing user interface element 904a, as shown in FIG. 9GG to a location within the third region 904d of the internet browsing user interface element 904a. In some embodiments, and as shown in FIG. 9HH, the computer system 101 determines that gaze-based scrolling did not occur recently as described in more detail with reference to method 1000, and in some embodiments, the respective hit volumes 912b and 910b have a size larger than their respective size when gaze-based scrolling occurred recently as shown in FIG. 9S-9V.

In FIG. 9II, the computer system 101 detects gaze 908 directed to a location within the hit volume 912b of control element 912a, and in response to detecting the gaze 908 directed to a location within the hit volume 912b of control element 912a, the control element 912a gains system focus. In FIG. 9II, the computer system 101 changes the visual appearance of control element 912a to visually convey the action to close and/or cease to internet browsing user interface element 904a in response to further user input (e.g., pinch gesture) directed to the control element 912a while the control element 912a has system focus.

In FIG. 9JJ, the computer system 101 detects the hand 926jj performing a pinch gesture (e.g., described above with reference to detecting hand 926b performing the pinch gesture in FIG. 9C) while the control element 912a has system focus and gaze 908 is directed to the control element 912a. In some embodiments, in response to detecting the hand 926jj performing the pinch gesture while the control element 912a has system focus, the computer system 101 ceases to display the internet browsing user interface element 904a as shown in FIG. 9KK.

FIG. 10 is a flowchart illustrating a method in which a computer system scrolls scrollable content in response to gaze-based inputs and/or input provided by a respective input element, in accordance with some embodiments. In some embodiments, the method 1000 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, a method 1000 is performed at a computer system in communication with a display generation component and one or more input devices. In some embodiments, the computer system has one or more of the characteristics of the computer system of method 800. For example, a mobile device (e.g., a tablet, a smartphone, a media player, or a wearable device), or a computer or other electronic device. In some embodiments, the display generation component has one or more characteristics of the display generation component in method 800. In some embodiments, the one or more input devices have one or more characteristics of the one or more input devices in method 800. In some embodiments, the computer system is in communication with one or more cameras (e.g., such as the one or more cameras in method 800).

In some embodiments, while displaying, via the display generation component, scrollable content, the computer system detects (1002), via the one or more input devices, a gaze of a user of the computer system directed to the scrollable content, such as gaze 908 directed to region 904c in FIG. 9A. In some embodiments, the computer system displays the scrollable content in a three-dimensional environment as described with reference to method 800. In some embodiments, a portion of the user (e.g., hand, arm, and/or finger) of the computer system is positioned within or outside of a viewport of the user into the three-dimensional environment when the gaze of the user is directed to the scrollable content. In some embodiments, the portion of the user is within a field of view of the one or more input devices (e.g., the one or more image sensors 314 as described with reference to FIG. 3). In some embodiments, the portion of the user or a representation of the portion of the user is visible via the display generation component. In some embodiments, and as described with reference to method 800, while the gaze of the user is directed to the scrollable content (e.g., the first region of the scrollable content), the computer system scrolls the scrollable content in accordance with the gaze of the user directed to the scrollable content (e.g., the gaze of the user is optionally directed to a part of the scrollable content that causes the computer system to scroll the content based on gaze-only input, such as described with reference to method 800). In some embodiments, while the portion of the user is visible in the three-dimensional environment, the computer system scrolls the scrollable content in accordance with the gaze of the user directed to the scrollable content. In some embodiments, and as will be described herein, while the computer system scrolls the scrollable content in accordance with the gaze of the user directed to the scrollable content (and/or, optionally, while the portion of the user is visible in the three-dimensional environment), the computer system determines that the portion of the user is providing an input to scroll the scrollable content; and in response to determining that the portion of the user is providing an input to scroll the scrollable content, the computer system ceases scrolling in accordance with the gaze of the user directed to the scrollable content. In some embodiments, in response to determining that the portion of the user is providing an input to scroll the scrollable content, the computer system scrolls the scrollable content in accordance with the input to scroll the scrollable content as provided by the portion of the user. In some embodiments, the scrollable content has one or more characteristics of the scrollable content of method 800. In some embodiments, detecting the gaze of the user of the computer system directed to the scrollable content shares one or more characteristics with the detection of the gaze of the user directed to the scrollable content of method 800.

In some embodiments, while displaying, via the display generation component, scrollable content, in response to detecting the gaze of the user directed to the scrollable content (1004), in accordance with a determination that gaze-based criteria for scrolling the scrollable content is met while a respective input element is not providing an input to scroll the scrollable content, the computer system scrolls (1006) the scrollable content in accordance with the gaze of the user directed to the scrollable content, such as shown in FIG. 9B where the scrollable content is scroll in accordance with the gaze 908 directed to region 904c. In some embodiments, the gaze-based criteria for scrolling the scrollable content is based on gaze tracking information as described in further detail below. In some embodiments, the respective input element includes the portion of the user as described herein. In some embodiments, the respective input element is communicatively coupled with a controller to scroll the scrollable content as will be described in further detail below.

In some embodiments, while displaying, via the display generation component, scrollable content, in accordance with a determination that the gaze-based criteria for scrolling the scrollable content is met while the respective input element is providing an input to scroll the scrollable content, the computer system forgoes (1006) scrolling the scrollable content in accordance with the gaze of the user directed to the scrollable content (and, or, optionally, scrolling the scrollable content in accordance with the input of the respective input element, optionally at a different speed, with a different magnitude and/or in a different direction than the scrolling of the scrollable content in accordance with the gaze of the user), such as shown in FIG. 9C with scrolling stopped in response to detecting hand 926 providing an input to scroll in FIG. 9C.

In some embodiments, the computer system scrolling the scrollable content in response to detecting the gaze of the user directed to the scrollable content shares one or more characteristics with the computer system scrolling the scrollable content in response to detecting the gaze of the user described with respect to method 800. For example, the gaze is directed to a portion of the scrollable content (e.g., the first region of the scrollable content as described with reference to method 800) that is responsive to scrolling inputs, including gaze-only based scrolling inputs (e.g., not requiring input from one or more portions of the user other than those portions providing the gaze input). In some embodiments, the computer system ignores detected gaze inputs to scroll the scrollable content when the computer system also detects that a respective input element is providing an input to scroll the scrollable content. For example, the respective input element optionally includes a portion of the user, such as the hand arm, and/or finger of the user, and the detected input from the portion of the user for scrolling the content includes the user performing an air gesture (e.g., an air pinch gesture, such as two or more fingers of a user's hand such as the thumb and index finger moving together and touching each other) followed by motion of the hand in the direction of the desired scroll direction. In some embodiments, the computer system ignores gaze inputs for scrolling the scrollable content so long as the computer system detects an input to scroll the scrollable window from another portion of body of the user (e.g., the hands of the user), but ceases to ignore the gaze input upon detecting that the input from the other portion of the user being used to scroll the scrollable content has terminated (e.g., the user releases the air pinch gesture (e.g., opens their two or more fingers so they are no longer touching)). For example, the computer system optionally starts scrolling the scrollable content in accordance with the detected gaze-only based scrolling input (e.g., irrespective of the portion of the user being visible in the three-dimensional environment). In some embodiments, the computer system, in response to detecting the gaze of the user being directed to the scrollable content, scrolls the scrollable content in accordance with the detected gaze of the user, but ceases to scroll the scrollable content in accordance with the detected gaze when the computer system detects that the other portion of the user (e.g., the hand of the user) is being used to scroll the scrollable content instead. For example, the computer system optionally starts scrolling the scrollable content in accordance with the detected input to scroll the scrollable content provided by the portion of the user. In some embodiments, scrolling the scrollable content in accordance with the gaze of the user directed to the scrollable content includes scrolling the scrollable content at a first speed or second speed as described with reference to method 800. In some embodiments, forgoing scrolling the scrollable content in accordance with the gaze of the user directed to the scrollable content, and scrolling, instead, in accordance with the portion of the user providing the input to scroll the scrollable content (e.g., movement of the portion of the user) includes scrolling at the first speed, the second speed as described with reference to method 800 or a third speed, different from the first speed and the second speed. In some embodiments, the third speed is faster (or, optionally, slower) than the first speed (and, or, optionally, the second speed).

Scrolling content in scrollable content in response to detecting the gaze of the user only if the computer system detects that the user is not providing an alternative input to scroll the scrollable content minimizes input errors from the user, such as due to the scrollable content being scrolled in response to multiple commands simultaneously and/or unpredictably, thereby conserving computing resources associated with correcting erroneous input from the user.

In some embodiments, the gaze-based criteria include a criterion that is met when one or more of location-based criteria or duration-based criteria are met, such as shown by the location of the gaze 908 within region 904c and the gaze duration exceeding the first threshold 936b in FIG. 9B. In some embodiments, the location-based criteria include a criterion that is met when the computer system detects the gaze of the user directed to a location (or, optionally, region) of the scrollable content that corresponds to the first region of the scrollable content as described in more detail with reference to method 800. In some embodiments, the duration-based criteria include a criterion that is met when a duration of the gaze of the user is directed to the first region for longer than a first duration threshold as described in more detail with reference to method 800. In some embodiments, the computer system determines whether the gaze of the user satisfies a combination of some or all of the criteria including the location-based criteria and/or the duration-based criteria as described in method 800.

For example, in accordance with a determination that gaze direction is directed to a location of a user interface element that is responsive to gaze-only input scrolling (e.g., not including input from one or more portions of the user other than those portions providing the gaze input to scroll) and a duration of the gaze is below a respective duration threshold (e.g., described with reference to method 800) to initiate scrolling, the computer system optionally does not initiate scrolling. In some embodiments, the computer system does initiate scrolling.

In another example, in accordance with a determination that gaze direction is directed to a location of the user interface element that is not responsive to gaze-only input scrolling, the computer system optionally does not initiate scrolling. In some embodiments, in accordance with a determination that gaze direction is directed to the location of the user interface element that is responsive to gaze-only input scrolling and a duration of the gaze meets or is above the respective duration threshold to initiate scrolling, the computer system initiates scrolling. Scrolling the scrollable content in response to gaze and doing so when the location and/or duration of the gaze is directed to the first region for longer than the first duration threshold provides confirmation that the user intends to scroll the scrollable content, thereby reducing errors in the interaction between the user and the computer system (e.g., avoiding unintentional scrolling due to unintentional gaze) and reducing inputs needed to correct such errors and conserving computing resources associated with correcting erroneous input from the user.

In some embodiments, the gaze-based criteria for scrolling the scrollable content includes a criterion that is met while the gaze of the user is directed to a first region of the scrollable content, such as shown with gaze 908 directed to region 904c in FIG. 9I. For example, the first region of the scrollable content as described above and/or with reference to method 800 is responsive to scrolling inputs, including gaze-only based scrolling inputs (e.g., not requiring input from one or more portions of the user other than those portions providing the gaze input).

In some embodiments, in accordance with a determination that the gaze-based criteria for scrolling the scrollable content is not met because the gaze of the user is determined to not be directed to the first region of the scrollable content, forgoing scrolling the scrollable content, such as gaze 908 directed to region 904d in FIG. 9O. In some embodiments, the gaze-based criteria for scrolling the scrollable content is not met when the gaze of the user is directed to a second region of the scrollable content, wherein the second region of the scrollable content is not responsive to gaze-only based scrolling inputs as described in more detail with reference to method 800. In another example, the gaze-based criteria for scrolling the scrollable content is optionally not met when the gaze of the user is directed to a location outside the first region of the scrollable content. For example, the location optionally corresponds to the user interface element or window that contains the scrollable content. In another example, the location optionally corresponds to a control element associated with the scrollable content as will be described in more detail below. In another example, the location optionally corresponds to a location in the three-dimensional environment or another user interface element of an application different from the application associated with the scrollable content as will be described in more detail below. Forgoing scrolling content based on a determination that the gaze-based criteria for scrolling the scrollable content is not met reduces errors in the interaction between the user and the computer system (e.g., by avoiding unintentional scrolling of content), thereby conserving computing resources associated with correcting erroneous input from the user.

In some embodiments, detecting the input to scroll the scrollable content provided by the respective input element includes detecting, via the one or more input devices, movement of a portion of the user of the computer system (e.g., hand, arm, and/or finger), such as hand 926k moving from a first location 926k-1 to a second location 926k-2 in FIG. 9L. For example, the computer system optionally detects the hand of the user performing an air pinch gesture (e.g., two or more fingers of a user's hand such as the thumb and index finger moving together and touching each other) to form a pinch hand shape while the gaze of the user is directed to the first region of the scrollable content, followed by movement of the hand in the pinch hand shape upward (or, optionally, downward or to the left or to the right). In some embodiments, the computer system detects a gesture other than an air pinch gesture, such as a forward pointing gesture (e.g., a forward movement of a user's hand while one or more fingers of the user's hand are extended towards the first region of the scrollable content) or a tap gesture with a finger of the user's hand (e.g., a forward movement by a finger of the user's hand such that the finger touches the first region of the scrollable content or approaches within a threshold distance (e.g., 0.01, 0.1, 0.5, 1, 2, 3, 4, 5, or 10 centimeters) of the first region of the scrollable content), followed by movement (e.g., upward, downward, left, or right) of the hand in the pointing gesture. In another example, the computer system optionally detects a pinch and drag gesture that is an air gesture including the pinch gesture performed in conjunction with (e.g., followed by) a drag input that changes a position of the user's hand from a first position (e.g., a start position of the drag) to a second position (e.g., an end position of the drag). In some embodiments, the computer system detects the pinch hand shape while performing the drag input, and a release of the pinch gesture (e.g., opens their two or more fingers) to end the drag gesture (e.g., at the second position). In some embodiments, the computer system detects that the pinch input and the drag input are performed by the same hand (e.g., the user pinches two or more fingers to make contact with one another and moves the same hand to the second position in the air with the drag gesture). In some embodiments, the computer system detects that the pinch input is performed by a first hand of the user and the drag input is performed by the second hand of the user (e.g., the user's second hand moves from the first position to the second position in the air while the user continues the pinch input with the user's first hand). In some embodiments, the computer system optionally scrolls the scrollable content with a magnitude and/or direction corresponding to the movement of the hand of the user (e.g., scrolls the scrollable content upward if the hand moves upward, and scrolls the scrollable content downward if the hand moves downward).

In some embodiments, the computer system determines that the respective input element providing the input to scroll the scrollable content includes other types of inputs (e.g., processed by input controllers of the computer system), such as trackpad inputs (e.g., finger touching a trackpad and moving in a direction and/or with a magnitude) or an input device input (e.g., movement of a hand held input device that detects direction and/or magnitude of movement of the input device while it is being held in the hand of the user and/or rotating a physical click wheel or moving a point of contact with the click wheel or a rotatable input device, such as rotation of a digital crown). In some embodiments, the computer system determines that the respective input element providing the input to scroll the scrollable content is optionally processed by an input controller of the computer system to which the computer system optionally scrolls the scrollable content based on interaction with a controller, such as a trackpad and/or other input device as described herein. In some embodiments, the computer system displays a virtual controller, such as a scroll bar user interface element indicating a location of the portion of the scrollable content displayed relative to the entire scrollable content. For example, the computer system detects the respective input element providing the input to scroll the scrollable content as described herein (e.g., input corresponding to a request to move the scroll bar from a first position to a second position, different from the first position), and in response, the computer system scrolls the scrollable content to display a different portion of the scrollable content and moves the scroll bar to a corresponding position relative to the portion of scrollable content displayed. In another example, the computer system determines that the input to scroll the scrollable content provided by the respective input element includes movement of a physical input device (e.g., movement of a hand held input device, such as a controller, mouse, stylus, or other motion tracking device that detects direction and/or magnitude of movement of the physical input device while it is being held in the hand of the user).

In some embodiments, if the computer system no longer detects movement of the hand and/or an input corresponding to a request to stop scrolling the scrollable region (e.g., a voice input to stop scrolling), the computer system ceases scrolling the scrollable region. Scrolling the scrollable content in response to the input to scroll the scrollable content controlled by movement of a portion of the user of the computer system provides quick access to scroll content without requiring the user to provide further inputs, thereby reducing the number of inputs and providing more efficient interactions between the user and the computer system. In some embodiments, the scrollable content includes a first region (e.g., as described above and/or with reference to method 800), such as region 904c as shown in FIG. 9I.

In some embodiments, in response to detecting the gaze of the user directed to the first region of the scrollable content, in accordance with a determination that the gaze-based criteria for scrolling the scrollable content is met while the respective input element is providing an input to respective content, the computer system scrolls the scrollable content in accordance with the gaze of the user directed to the first region, such as scrolling scrollable content of user interface element 904 according to gaze 908 while hand 926f is providing an input to scroll scrollable content of user interface 906a in FIG. 9I.

In some embodiments, determining whether the gaze-based criteria for scrolling the scrollable content is met is analogous to and/or has one or more of the characteristics of the computer system determining that the gaze-based criteria for scrolling the scrollable content is met described above. In some embodiments, the computer system detects or receives simultaneous inputs from different input devices (e.g., the one or more input devices described above and/or with reference to method 800), and in response, performs actions based on the simultaneous inputs. For example, the computer system optionally displays, via the display generation component, the scrollable content and content that is optionally not in the first region of the scrollable content. In some embodiments, the scrollable content is a user interface element, such as a window or volume as described with reference to method 800. In some embodiments, the content that is optionally not in the first region of the scrollable content is content in the user interface element as described in more detail below. In some embodiments, the content that is optionally not in the first region of the scrollable content is content in a second user interface element (e.g., second window or volume), different from the user interface element including the first region of scrollable content as described in more detail below.

In some embodiments, while the respective input element (e.g., as described above) is providing an input to respective content, the computer system scrolls the scrollable content in accordance with detecting that the gaze of the user is directed to the first region (and, or, optionally, in accordance with a determination that gaze-based criteria for scrolling the scrollable content is met). For example, the computer system optionally receives an input (or, optionally, provided by the respective input element) to perform an action associated with the respective content, such as scroll, move, resize, or close the respective content as will be described in more detail below. In some embodiments, while the computer system performs the action associated with the respective content, the computer system scrolls the scrollable content in accordance with the gaze of the user directed to the first region as described herein. In some embodiments, the input to respective content optionally corresponds to an input to interact with the respective content (e.g., scroll the respective content, select the respective content, manipulate (e.g., resize, move, or close) the respective content, and/or perform an action associated with the respective content) as will be described in more detail below.

In some embodiments, while the computer is scrolling the scrollable content in accordance with the gaze of the user directed to the first region as described herein, the computer system receives and/or detects input provided by the respective input element directed to the first region (e.g., input to perform an operation, such as select content, scroll, or other interaction operation described in more detail below). In some embodiments, in response to receiving the input provided by the respective input element directed to the first region, the computer system stops scrolling the scrollable in accordance with the gaze of the user directed to the first region.

In some embodiments, in accordance with a determination that the gaze-based criteria for scrolling the scrollable content is met while the respective input element is not providing an input to scroll the scrollable content, scrolling the scrollable content in accordance with the gaze of the user directed to the first region. In some embodiments, the computer system scrolling the scrollable content in accordance with the gaze of the user directed to the first region shares one or more characteristics with the computer system scrolling the scrollable content in response to detecting the gaze of the user described with respect to method 800. Scrolling the scrollable content while providing an input to respective content that is not in the first region allows the user to interact with different content at the same time, thus reducing user input required to multitask, and thereby provides quick access to scroll content which reduces the number of inputs and provides more efficient interactions between the user and the computer system.

In some embodiments, the scrollable content is part of a first user interface element, such as user interface element 904a. In some embodiments, the input to the respective content provided by the respective input element is an input to scroll the respective content, wherein the respective content is also part of the first user interface element, such as element 904c in FIG. 9N. In some embodiments, the computer system determines that the respective input element is providing an input to scroll the respective content when the computer system detects that the hand of the user is performing an air gesture followed by motion of the hand in the direction of the desired scroll direction. In another example, the computer system determines that the respective input element is providing an input to scroll the respective content when the computer system detects trackpad inputs, movement of a handheld input device, rotating a physical click wheel, analog stick or a rotatable input device, and/or user interaction with other input device(s) processed by input controllers of the computer system.

In some embodiments, the first user interface element is optionally a window or volume as described with reference to method 800 configured to present two-dimensional and/or three-dimensional content including the scrollable content and the respective content, different from the scrollable content. In some embodiments, the respective content is adjacent to the scrollable content of the first user interface element. In some embodiments, the respective content has one or more of the characteristics of the first region of scrollable content as described above and/or with reference to method 800.

As mentioned above, the computer system detects or receives simultaneous inputs from different input devices, and in response, performs actions based on the simultaneous inputs. In some embodiments, the inputs are directed to different content of within a same user interface element (e.g., the first user interface element). For example, while the respective input element (e.g., as described above with reference to the computer system detecting the respective input element is providing an input to scroll) is providing an input directed to the respective content to optionally scroll the respective content, the computer system scrolls the scrollable content in accordance with the gaze of the user directed to the first region (and, or, optionally, in accordance with a determination that gaze-based criteria for scrolling the scrollable content is met) as described herein and above. In some embodiments, the speed and/or direction at which the computer system scrolls the respective content corresponds to the speed and/or direction of the movement of the respective input element (e.g., hand of the user during the input to scroll as described above).

In some embodiments, the computer system optionally receives and/or detects two substantially simultaneous inputs. For example, the computer system optionally displays a user interface element or window that includes the scrollable content and the respective content, different from the scrollable content, such as a music application window that includes a first region with a scrollable list of albums (e.g., scrollable content) and a second region with a scrollable list of music videos (e.g., the respective content). In some embodiments, the computer receives a first input and a second input. The first input includes scrolling the first region (or, optionally, of the scrollable content) in accordance with the gaze of the user directed to the first region and the second input includes scrolling the respective content in accordance with the input to scroll provided by the respective input element as described above. In response to receiving the first input and the second input, the computer system optionally scrolls the scrollable content and the respective content at the same time.

Scrolling the scrollable content while providing an input directed to the respective content allows the user to interact with different content of a same user interface element at the same time, thus reducing user input required to multitask, and thereby provides quick access to scroll content which reduces the number of inputs and provides more efficient interactions between the user and the computer system. In some embodiments, the scrollable content is part of a first user interface element, such as user interface element 904a in FIG. 9I. In some embodiments, the input to the respective content provided by the respective input element is an input to scroll the respective content, wherein the respective content is part of a second user interface element, different form the first user interface element, such as user interface element 906a in FIG. 9I. In some embodiments, the input to scroll the respective content provided by the respective input element includes a gaze of the user, a contact on a touch-sensitive surface, actuation of a physical input device of the computer system, and air gesture, a voice input from the user, and/or other input device determined by the computer system to correspond to a request to scroll the respective content as described above with reference to the respective input element providing an input to scroll respective content.

For example, the first user interface element and the second user interface element optionally correspond to a respective first window (or, optionally, volume) and second window as described with reference to method 800. In some embodiments, the first user interface element includes the scrollable content and the second user interface element includes the respective content. In some embodiments, the first user interface element and the second user interface element are concurrently displayed within the three-dimensional environment. For example, the first user interface element is optionally a window or volume of a web browser application including web content (e.g., web article) and the second user interface element is optionally a window or volume of a music application including music application content (e.g., list of music albums).

In some embodiments, the computer system optionally detects or receives simultaneous inputs directed to different content associated with different user interface elements (e.g., the first user interface element and the second user interface element), and in response, the computer system performs actions based on the simultaneous inputs directed to respective content of the first user interface element and the second user interface element. For example, while the computer system determines that the respective input element (e.g., as described above) is providing an input directed to the respective content associated with the second user interface element, the computer system optionally scrolls the respective content associated with the second user interface and the computer system optionally scrolls the scrollable content in the first user interface element in accordance with the gaze of the user directed to the scrollable content of the first user interface element, different from second user interface element. In some embodiments, the speed and/or direction at which the computer system scrolls the respective content of the second user interface element corresponds to the speed and/or direction of the movement of the respective input element (e.g., hand of the user during the input to scroll as described above). Thus, in some embodiments, both the first user interface element and the second user interface element are simultaneously and independently scrolling in response to two separate inputs (e.g., gaze-based input and input provided by the input element) that are being applied simultaneously. Scrolling the scrollable content of a first region associated with a first user interface element while providing an input directed to respective content associated with a second user interface element, different from the first user interface element allows the user to interact with different content of different user interface elements at the same time, thus reducing user input required to multitask, and thereby provides quick access to scroll content which reduces the number of inputs and provides more efficient interactions between the user and the computer system. In some embodiments, while displaying the scrollable content, and while displaying virtual content, different from the scrollable content, the computer system detects the gaze of the user directed to the first region of the scrollable content.

For example, the virtual content and the first region of the scrollable content are part of a same user interface element (e.g., the first user interface element as described above). In some embodiments, the virtual content is associated with a second user interface element and the scrollable content is associated with the first user interface elements as described above. In some embodiments, the virtual content is adjacent to the first region of scrollable content. In some embodiments, the virtual content is displayed concurrently with the first region of the scrollable content.

In some embodiments, in response to detecting the gaze of the user directed to the first region of the scrollable content, in accordance with a determination that gaze-based criteria for scrolling the scrollable content is met (e.g., as described above with reference to a location-based criteria and/or a duration-based criteria), and while the respective input element is providing an input to move the virtual content from a first location to a second location, different from the first location, the computer system scrolls the scrollable content in accordance with the gaze of the user directed to the first region (or, optionally, while moving the virtual content from the first location to the second location in accordance with the input from the respective input element), such as moving user interface element 904a in FIG. 9Y.

In some embodiments, the computer system optionally detects or receives simultaneous inputs directed to different content (e.g., the first region of the scrollable content and the virtual content optionally associated with different user interface elements), wherein the respective inputs correspond to different actions: to scroll the scrollable content and to move the virtual content from a first location to a second location, different from the first location. In some embodiments, in response to receiving the simultaneous inputs, the computer system performs the respective actions to scroll the scrollable content and to move the virtual content from a first location to a second location, different from the first location at the same time. In some embodiments, the magnitude, speed, acceleration and/or direction at which the computer system moves the virtual content from the first location to the second location corresponds to the magnitude, speed, acceleration and/or direction of the movement of the respective input element (e.g., hand of the user during the input to move the virtual content from the first location to the second location as described above). In some embodiments, while the computer system scrolls the scrollable content and moves the virtual content at the same time, the computer system receives an input corresponding to a request to stop scrolling (e.g., the computer system detects that the gaze of the user is directed away from the first region), and in response, the computer system ceases scrolling the scrollable content and continues to move the virtual content in accordance with the respective input. In some embodiments, while the computer system scrolls the scrollable content and moves the virtual content at the same time, the computer system receives an input corresponding to a request to stop moving the virtual content (e.g., the computer system detects that the hand of the user has stopped), and in response, the computer system stops moving the virtual content and continues to scroll the scrollable content in accordance with the gaze of the user.

In some embodiments, the computer system determines that the gaze-based criteria for scrolling the scrollable content is not met when the gaze of the user is not directed to the first region (e.g., the gaze of the user is directed to a region outside of the first region that is not adjacent to the first region). In some embodiments, in response to the determination that the gaze of the user is not directed to the first region, the computer system ceases scrolling the scrollable content optionally while moving the virtual content from the first location to the second location in accordance with the input from the respective input element.

Scrolling the scrollable content of a first region while providing an input to move a virtual content from a first location to a second location, wherein the virtual content is different from the scrollable content allows the user to interact with different content at the same time, thus reducing user input required to multitask, and thereby provides quick access to scroll content which reduces the number of inputs and provides more efficient interactions between the user and the computer system. In some embodiments, while displaying the scrollable content, and while displaying virtual content, different from the scrollable content, the computer system detects, via the one or more input devices, the gaze of the user directed to the first region of the scrollable content, such as gaze 908 directed to control element 914a in FIG. 9GG. In some embodiments, the virtual content has one or more of the characteristics of the virtual content described above.

In some embodiments, in response to detecting the gaze of the user directed to the first region of the scrollable content in accordance with a determination that gaze-based criteria for scrolling the scrollable content is met (e.g., as described above with reference to a location-based criteria and/or a duration-based criteria) while the respective input element is providing an input to change a size of the virtual content, the computer system scrolls the scrollable content in accordance with the gaze of the user directed to the first region while changing the size of the virtual content in accordance with the input from the respective input element, such as changing the size of user interface element 904a in FIG. 9GG.

In some embodiments, the computer system optionally detects or receives simultaneous inputs directed to different content (e.g., the first region of the scrollable content and the virtual content optionally associated with different user interface elements), wherein the respective inputs correspond to different actions: to scroll the scrollable content and to change a size of the virtual content. In some embodiments, in response to receiving the simultaneous inputs, the computer system performs the respective actions to scroll the scrollable content and to change the size of the virtual content. In some embodiments, the magnitude, speed, acceleration and/or direction at which the computer system changes the size of the virtual content corresponds to the magnitude, speed, acceleration and/or direction of the movement of the respective input element (e.g., hand of the user during the input to change the size of the virtual content as described above).

In some embodiments, the computer system determines that the gaze-based criteria for scrolling the scrollable content is not met when the gaze of the user is not directed to the first region (e.g., the gaze of the user is directed to a region outside of the first region that is not adjacent to the first region). In some embodiments, in response to the determination that the gaze of the user is not directed to the first region, the computer system ceases scrolling the scrollable content optionally while changing the size of the virtual content in accordance with the input from the respective input element. Scrolling the scrollable content of a first region while providing an input to resize a virtual content from a first size to a second size, wherein the virtual content is different from the scrollable content allows the user to interact with different content at the same time, thus reducing user input required to multitask, and thereby provides quick access to scroll content which reduces the number of inputs and provides more efficient interactions between the user and the computer system.

In some embodiments, in response to detecting the gaze of the user directed to the scrollable content, in accordance with a determination that the gaze-based criteria for scrolling the scrollable content is met (e.g., as described above with reference to a location-based criteria and/or a duration-based criteria) while the respective input element is not engaged (and/or not providing input to the scrollable content and/or the computer system), the computer system scrolls the scrollable content in accordance with the gaze of the user directed to the scrollable content, such as scrolling scrollable content of 904a according to gaze in FIG. 9B.

In some embodiments, if the computer system detects that the respective input element is not engaged (e.g., due to a release of the pinch gesture, such as opening two or more fingers to end the respective gesture), the computer system no longer ignores gaze inputs for scrolling the scrollable content, and as such, when the computer system detects that the gaze-based criteria for scrolling the scrollable content is met, the computer system scrolls the scrollable content. In some embodiments, the computer system optionally starts scrolling the scrollable content irrespective of the portion of the user (e.g., hands, arms, and/or fingers) being visible in the three-dimensional environment as long as the respective input element is not engaged (e.g., the computer system continues to detect an un-pinch gesture based on movement of the two or more fingers away from each other).

In another example, the computer system optionally determines that the respective input element is not engaged when input is not being applied to a physical input device such as a controller. For example, the computer system optionally does not detect movement of the physical input device while it is being held in the hand of the user and/or the computer system does not detect inputs to the physical input device (e.g., buttons, knobs, toggles, digital crowns, dials, switches, sliders, joysticks, click wheels, and/or the like optionally after a predetermined amount of time (e.g., 2, 5, 15, 30, 40, 50 60, 70, 80, 120, or 300 seconds).

In some embodiments, while the computer is scrolling the scrollable content using gaze-only input(s), the computer system detects that the physical input device is engaged (e.g., movement of a controller while it is being held in the hand of the user and/or actuation of a physical button), and in response to detecting that the physical input device is engaged, the computer system ceases scrolling the scrollable content in accordance with the gaze of the user directed to the scrollable content.

In some embodiments, the computer system determines that the gaze-based criteria for scrolling the scrollable content is not met when the gaze of the user is not directed to the first region (e.g., the gaze of the user is directed to a region outside of the first region that is not adjacent to the first region) optionally while the respective input element is not engaged. In some embodiments, in response to the determination that the gaze of the user is not directed to the first region, the computer system ceases scrolling the scrollable content optionally while the respective input element is not engaged. Scrolling the scrollable content while the user is not providing an alternative input to scroll the scrollable content minimizes input errors from the user, such as due to the scrollable content being scrolled in response to multiple commands simultaneously and/or unpredictably, thereby conserving computing resources associated with correcting erroneous input from the user.

In some embodiments, scrolling the scrollable content in accordance with the gaze of the user directed to the scrollable content includes, in accordance with a determination that a location of the gaze of the user directed to the scrollable content is a first location of the scrollable content, scrolling the scrollable content with a first speed, such as shown by speed indicator 922 in FIG. 9T. For example, when the computer system determines that a location of the gaze of the user corresponds to a location that is a first distance from the edge of a gaze enabled scrolling region (e.g., the first region), the computer system optionally scrolls the scrollable content at a third speed as described in method 800. In another example, the computer system determines that the gaze directed to the first location of the scrollable content corresponds to a bottom portion of the scrollable content (or, optionally, near the bottom edge of the scrollable content), and in response, the computer system scrolls the scrollable content at a speed faster than when the gaze location corresponds to a middle portion of the scrollable content.

In some embodiments, in accordance with a determination that the location of the gaze of the user directed to the scrollable content is a second location of the scrollable content, different from the first location, scrolling the scrollable content with a second speed, different from the first speed, such as shown by speed indicator 922 in FIG. 9U. For example, when the computer system determines that a location of the gaze of the user corresponds to a location that is a second distance from the edge of a gaze enabled scrolling region (e.g., the first region), the computer system optionally scrolls the scrollable content at a fourth speed as described in method 800. In some embodiments, scrolling the scrollable content at the fourth speed includes applying an absolute modifier or a relative modifier to a respective speed (e.g., the first speed, the second speed, the third speed, or other speed) as described in method 800. In another example, the computer system determines that the gaze directed to the second location of the scrollable content corresponds to a middle portion of the scrollable content, and in response, the computer system scrolls the scrollable content at a speed slower than when the gaze location corresponds to a top portion of the scrollable content (or, optionally, near the top edge of the scrollable content). In some embodiments, the computer system determines that the middle portion of the scrollable content is not responsive to gaze-only based scrolling input(s), and in response, the computer system ceases to scroll the scrollable content or does not initiate scrolling the scrollable content.

Scrolling content at different speeds based the location of the gaze of the user minimizes input errors from the user associated with the user misinterpreting content due to the speed at which it is being scrolled and minimizes erroneous shifts in system control based on temporary movements of gaze (e.g., less overall time spent providing scrolling inputs) while avoiding errors in scrolling, thereby conserving computing resources associated with correcting erroneous input from the user.

In some embodiments, the computer system displays, via the display generation component, a control element associated with the scrollable content outside an area of the scrollable content with a first visual appearance (e.g., a first color, first pattern, first shading, first brightness, and/or first visual effect), such as control elements 912a and 910a in FIG. 9II. In some embodiments, the scrollable content is a user interface element, such as a window or volume of an application (e.g., a browser window of a web browser application). In some embodiments, the scrollable content is the content in the window (e.g., a news article). In some embodiments, the control element is a component or virtual object associated with (e.g., paired with) the window. As will be described in more detail, the control element is selectable to perform one or more actions associated with the window, action to move, resize, close the window, or other action associated with the window. In some embodiments, the control element is adjacent to and/or a part of the window. In some embodiments, the control element is displayed as separated from the window. For example, the window optionally occupies a first area or portion of the three-dimensional environment and the control element occupies a second area or portion of the three-dimensional environment, different from the first area or portion. In some embodiments, the computer system receives and/or detects user input (e.g., a gaze of a user of the computer system, a contact on a touch-sensitive surface, actuation of a physical input device, a predefined gesture (e.g., pinch gesture or air tap gesture) and/or a voice input from the user), and/or a combination of some or all of the above corresponding to a request to move the window, close the window, or resize the window using the control element as will be described in more detail below. For example, manipulating (e.g., inputs directed to) the control element optionally cause a respective action associated with the window (or, optionally, including the control element) to be performed as will be described in more detail below.

In some embodiments, while the computer system displays the control element with the first visual appearance, the control element does not have system focus (or, optionally, input focus) for subsequent user inputs as will be described in more detail below. For example, the control element with the first visual appearance is optionally not a target for input(s) detected from the respective input element described above (e.g., input(s) from the respective input element will optionally not be targeted (or, optionally, directed) at the control element). In some embodiments, and as will be described herein and below, the computer system displays the control element with a second visual appearance, different from the first visual appearance, to give the control element an appearance of having focus (e.g., confirmation that the control element is the target for input(s) from the respective input element). In some embodiments, while displaying the control element, the computer system detects, via the one or more input devices, the gaze of the user of the computer system directed to the control element, such as gaze 908 directed to control element 912a in FIG. 9II.

In some embodiments, in response to detecting the gaze of the user directed to the control element in accordance with a determination that the gaze-based criteria (e.g., described above) for scrolling the scrollable content was met within a first time threshold (e.g., 0.5, 1, 5, 10, 20, 30, 40, 50, 60, 100, 200, 300, 500, or 1000 seconds) before detecting the gaze of the user of the computer system directed to the control element, the computer system displays, via the display generation component, the control element with a second visual appearance, different from the first visual appearance, within a second time threshold (e.g., 0.03, 0.05, 0.07, 0.1, 0.2, 0.3, 0.5, 1, 3, 5, 10, 15, 20, or 30 seconds), such as control element 912a as shown in FIG. 9II. For example, in accordance with a determination that a prior user interaction with the scrollable content (e.g., before detecting the gaze of the user of the computer system directed to the control element) included a gaze-only based scrolling input thus resulting in scrolling the scrollable content, and that the gaze-only based criteria for scrolling the scrollable content occurred recently (e.g., within the first time threshold described herein), the computer system optionally displays the control element with the second visual appearance in response to detecting the gaze of the user directed to the control element. As described above, when the computer system determines that the gaze-based criteria for scrolling the scrollable content is met, the computer system optionally initiates a scrolling event (e.g., scrolling the scrollable content). In some embodiments, the computer system sets the first time threshold to start from the time when the computer system started scrolling the scrollable content. In some embodiments, the computer system sets the first time threshold to start from the time when the computer system determines that the gaze-based criteria for scrolling the scrollable content is met. In some embodiments, the computer system displays the control element with the second visual appearance within the second time threshold described herein. In some embodiments, the computer system sets the second time threshold to start from the time when the computer system detected the gaze of the user directed to the scrollable content.

In some embodiments, displaying the control element with the second visual appearance provides as visual indication or confirmation of the control element gaining system focus (or, optionally, input focus) for subsequent user inputs as will be described in more detail below. For example, the control element with the second visual appearance is optionally a target for input(s) detected from the respective input element described above (e.g., input(s) from the respective input element will optionally be targeted (or, optionally, directed) at the control element). In some embodiments, the second visual appearance includes a second color darker or lighter than the first color; a second pattern more distinct (or more intense) than the first pattern; a second shading darker or lighter than the first shading, a second brightness more or less luminous than the first brightness; and/or a first visual effect more distinct (or more intense) than the first visual effect. In some embodiments, the second visual appearance is displayed for a predetermined amount of time (e.g., the second time threshold 0.1, 0.2, 0.3, 0.5, 1, 3, 5, 10, 15, 20, or 30 seconds) before returning to being displayed with the first visual appearance. In some embodiments, after displaying the control element with the second visual appearance, the computer system detects that the gaze of the user is directed away from the control element, and in response, the computer system displays the control element with the first visual appearance. In some embodiments, the computer system initially displays the control element with the first visual appearance. For example, upon opening or displaying the scrollable content for a first time within the three-dimensional environment, the computer system displays the control element with the first visual appearance.

In some embodiments, in response to detecting the gaze of the user directed to the control element, in accordance with a determination that the gaze-based criteria for scrolling the scrollable content was not met within the first time threshold before detecting the gaze of the user of the computer system directed to the control element, the computer system forgoes displaying the control element with the second visual appearance for a third time threshold (e.g., 0.03, 0.05, 0.07, 0.1, 0.2, 0.3, 0.5, 1, 3, 5, 10, 15, 20, or 30 seconds), such as control element 912a as shown in FIG. 9S.

For example, in accordance with a determination that the gaze-based criteria for scrolling the scrollable content was not met, thus, there was optionally no prior user interaction (e.g., gaze-only scrolling input) with the scrollable content within the first time threshold before detecting the gaze of the user of the computer system directed to the control element, the computer system optionally does not display the control element with the second visual appearance in response to detecting the gaze of the user directed to the control element. In some embodiments, the computer system does not display the control element with the second visual appearance for a third time threshold as described herein. For example, the computer system optionally delays displaying the control element with a second visual appearance for the third time threshold to allow the gaze of the user to settle on the control element before displaying the control element with the second visual appearance. In some embodiments, the computer system sets the third time threshold to start from the time when the computer system detected the gaze of the user directed to the scrollable content. In some embodiments, and as will be described in more detail below, as long as the computer system detects continued gaze of the user directed to the control element for a period of time greater than a third time threshold (e.g., 0.1, 0.2, 0.3, 0.5, 1, 3, 5, 10, 15, 20, 30, 40, or 50 seconds), the computer system displays the control element with the second visual appearance.

Displaying the control element with a second visual appearance in response to determining that the gaze of the user is directed to the scrollable content and in an instance when the gaze-based criteria for scrolling the scrollable content was met within a first time threshold before detecting the gaze of the user of the computer system directed to the control element minimizes erroneous shifts in system control based on temporary movements of gaze (e.g., the computer system provides confirmation that the user intends to interact with the control element), thereby providing more efficient interactions between the user and the computer system.

In some embodiments, in response to detecting the gaze of the user directed to the control element, in accordance with a determination that the gaze-based criteria for scrolling the scrollable content was not met within the first time threshold before detecting the gaze of the user of the computer system directed to the control element, the computer system displays, via the display generation component, the control element with the second visual appearance after a fourth time threshold (e.g., 0.1, 0.2, 0.3, 0.5, 1, 3, 5, 10, 15, 20, 30, 40, or 50 seconds), different from the third time threshold, such as control element 916a in FIG. 9S. In some embodiments, in accordance with a determination that the gaze-based criteria for scrolling the scrollable content was not met, thus, there were no recent prior user interaction (e.g., gaze-only scrolling input) with the scrollable content within the first time threshold before detecting the gaze of the user of the computer system directed to the control element, the computer system displays the control element with the second visual appearance after a fourth time threshold as described herein. In some embodiments, the computer system sets the third time threshold to start from the time when the computer system detected the gaze of the user was directed to the scrollable content. In some embodiments, the computer system does not display the control element with the second visual appearance when the computer system detects that the gaze of the user of computer system is directed away from the control element before the third time threshold has passed.

In some embodiments, while the computer system displays the control element with the second visual appearance (e.g., highlighted or other visual characteristic described above), the computer system detects an input corresponding to a request to perform an action, such as move and/or resize the window (e.g., scrollable content) associated with the control element, and in response, the computer system optionally changes the display of the control element from the second visual appearance to the first visual appearance (e.g., ceases to display the control element as highlighted or having any of the other visual characteristics described above). In some embodiments, the computer system does not change the visual appearance of the control element and continues to display the control element with the second visual appearance until the completion of the action corresponding to the request.

Displaying the control element with a second visual appearance after a fourth time threshold and in response to determining that the gaze-based criteria for scrolling the scrollable content was not met within a first time threshold before detecting the gaze of the user of the computer system directed to the control element minimizes erroneous shifts in system control based on temporary movements of gaze (e.g., the computer system provides confirmation that the user intends to interact with the control element), thereby providing more efficient interactions between the user and the computer system.

In some embodiments, while displaying, via the display generation component, a user interface element and a control element associated with the user interface element, while a gaze of the user of the computer system is directed to the control element and while a system focus is on the control element, the computer system detects, via the one or more input devices, movement of the gaze of the user to (or towards but not yet to) the user interface element, such as gaze 908 and gaze 920 in FIG. 9S. In some embodiments, the user interface element is a window or volume as described with reference to method 800. In some embodiments, the user interface element includes scrollable content as described above. For example, the control element is optionally analogous to and/or has one or more of the characteristics of the control element described herein and above. For example, the control element is optionally a target for input(s) detected from the respective input element (e.g., input(s) from the respective input element will optionally be targeted (directed) at the control element) described above.

In some embodiments, when the control element has system focus (or input focus) (e.g., selected by gaze, selected by a gesture, and/or selected by any of the other user inputs described above), and the computer system detects and/or receives a subsequent input (e.g., gesture input), the computer system directs the subsequent input to the control element because the system focus is on the control element. For example, while a gaze of the user of the computer system is directed to the control element and while a system focus is on the control element, the computer system optionally detects an air pinch gesture. In some embodiments, in response to detecting the air pinch gesture while the system focus is on the control element, the computer system performs an operation associated with the control element and the air pinch gesture as described in more detail herein. In some embodiments, in response to detecting the air pinch gesture, the computer system performs an operation associated with the control element because the control element has system focus. In some embodiments, and as described herein, the computer system detects movement of the gaze of the user from the control element to the user interface element, and in response, the computer system moves the system focus from the control element to the user interface element based on one or more factors/conditions described herein.

In some embodiments, when the computer system determines that the control element has system focus, the computer system displays the control element with a visual appearance that includes a larger size, different color, increased brightness, more distinct contrast (or other visual property) and/or a visual effect that is more intense than when the control element does not have focus. In some embodiments, displaying the control element with the visual appearance visually emphasizes the control element relative to other objects in the environment.

In some embodiments, while displaying, via the display generation component, the user interface element and the control element associated with the user interface element, in response to detecting the movement of the gaze of the user to (or towards but not yet to) the user interface element, such as control elements 912a and 916a in FIG. 9S, in accordance with a determination that the user interface element has gaze-based scrolling enabled, and in accordance with a determination that the movement of the gaze of the user is greater than a first threshold distance (e.g., 0.01, 0.1, 0.5, 1, 2, 3, 4, 5, or 10 centimeters) away from the control element (e.g., the first threshold distance is based on a respective hit volume associated with the control element and the respective hit volume is based on whether or not the user interface element has gaze-based scrolling enabled; the respective hit volume is described in more detail herein below), the computer system moves the system focus from the control element to the user interface element, such as shown in FIG. 9S with control element 916a with system focus. For example, in accordance with a determination that the user interface element has gaze-based scrolling enabled (e.g., the user interface element including predetermined regions of the user interface element are responsive to scrolling inputs, including gaze-only based scrolling inputs as described above and/or with reference to method 800), the computer system moves the system focus from the control element to the user interface element in response to detecting movement of the gaze of the user from the control element to the user interface element as long as the detected movement of the gaze of the user is greater than the first threshold distance away from the control element as described herein. In some embodiments, in accordance with a determination that the gaze directed to the user interface element satisfies the gaze-based criteria for scrolling respective scrollable content (e.g., described above), the computer system scrolls the respective scrollable content in the user interface element.

In some embodiments, the first threshold distance is based on a respective hit volume or region associated with the control element. In some embodiments, the respective hit volume or region associated with the control element is based on one or more dimensions of the control element (e.g., minimum and/or maximum height, width, and depth dimensions). In some embodiments, the respective hit volume is a square, rectangle, cube, rectangular prism, or other shape that matches the shape of the control element. In some embodiments, when the user interface element has gaze-based scrolling enabled, the respective hit volume associated with the control element has a first size and/or first shape based on the one or more dimensions of the control element. In some embodiments, and as will be described in more detail herein, when the user interface element does not have gaze-based scrolling enabled, the respective hit volume associated with the control element has a second size and/or second shape, different from the first size and/or shape, and based on one or more dimensions of the control element. For example, the second size and/or second shape is larger than the first size and/or shape in one or more dimensions. In some embodiments, when the respective hit volume associated with control element has the second size and/or shape, the respective hit volume overlaps with the user interface element as will be described in more detail herein.

In some embodiments, when the user interface element has gaze-based scrolling enabled and the control element associated with the user interface element has the first size, the computer system detects movement of the gaze of the user away from the control element to the user interface element. In some embodiments, the computer system determines whether the location of the gaze is greater than the first threshold distance away from the control element, and in response to determining that the location of the gaze is greater than the first threshold distance away from the control element (e.g., beyond the respective hit volume), and within the threshold distance of the user interface element, the computer system moves the system focus from the control element to the user interface element. In some embodiments, when the computer system moves the system focus from the control element to the user interface element, the computer system displays the control element with the first visual appearance as described above. In some embodiments, displaying the control element with the first visual appearance serves as visual indication or confirmation of the control element no longer having the system focus for subsequent user inputs.

In some embodiments, in accordance with a determination that the user interface element has gaze-based scrolling enabled, and in accordance with a determination that the movement of the gaze of the user is less than the first threshold distance away from the control element to the user interface element, the computer system does not move the system focus from the control element to the user interface element.

In some embodiments, while displaying, via the display generation component, the user interface element and the control element associated with the user interface element, in accordance with a determination that the user interface element does not have gaze-based scrolling enabled, and in accordance with a determination that the movement of the gaze of the user is greater than a second threshold distance (e.g., 0.1, 0.5, 1, 2, 3, 4, 5, 10, 15, or 20 centimeters), wherein the second threshold distance is greater than the first threshold distance, away from the control element to the user interface element, the computer system moves the system focus from the control element to the user interface element, such as shown with control element 912a and user interface element 904a in FIG. 9S.

As described herein, when the user interface element does not have gaze-based scrolling enabled, the respective hit volume associated with the control element has a second size and/or shape larger than the first size and/or shape of the respective hit volume associated with the control element when the user interface element does have gaze-based scrolling enabled. In some embodiments, the respective hit volume with the second size and/or shape overlaps with the user interface element. For example, when the computer system determines that the location of the gaze of the user is directed to the overlapping hit region (e.g., the region where the respective hit volume partially overlaps the user interface element), the computer system does not move the system focus from the control element to the user interface element. In some embodiments, moving the system focus from the control element to the user interface element optionally requires a greater amount of movement of the gaze of the user (e.g., greater than a second threshold distance) when the user interface element does not have gaze-based scrolling enabled compared to the amount of movement required of the gaze of the user (e.g., greater than the first threshold distance) when the user interface element has gaze-based scrolling enabled. In some embodiments, in accordance with a determination that the movement of the gaze of the user is greater than the first threshold distance away from the control element and less than the second threshold distance away from the control element, the computer system maintains system focus on the control element.

The lower (e.g., first) threshold distance required before moving the system focus from the control element to the user interface element when the user interface element does have gaze-based scrolling; and the higher (e.g., second) threshold distance required before moving the system the system focus from the control element to the user interface element when the user interface element does not have gaze-based scrolling enabled minimizes erroneous shifts in system control based on temporary movements of gaze (e.g., by adjusting a size and/or shape of the of the respective hit volume associated with the control element), thereby reducing errors in the interaction between the user and the computer system and reducing inputs needed to correct such errors.

In some embodiments, while displaying, via the display generation component, a control element associated with the scrollable content outside an area of the scrollable content with a first visual appearance (e.g., as described above), in accordance with a determination that the gaze of the user is directed to the control element, and prior to changing a visual appearance of the control element from the first visual appearance to a second visual appearance (e.g., as described above) based on the gaze of the user being directed to the control element, the computer system detects, via the one or more input devices, a first input from the respective input element directed to the control element, such as shown by hand 926x and control element 912a in FIG. 9X. For example, the first input optionally includes a gaze of a user of the computer system, a contact on a touch-sensitive surface, actuation of a physical input device, a predefined gesture (e.g., pinch gesture or air tap gesture) and/or a voice input from the user), and/or a combination of some or all of the above corresponding to a request to select the control element.

For example, changing the visual appearance of the control element from the first visual appearance to the second visual appearance optionally includes displaying the control element with a greater degree of highlighting and/or other visual characteristic emphasizing the control element (or providing a visual indication that the gaze is directed to control element). In some embodiments, providing the visual indication that the gaze of the user is directed to the control element by changing the visual appearance of the control element from the first visual appearance to the second visual appearance does not preclude selection of the control element or initiation of an action to be performed. For example, while the control element is displayed with the first visual appearance, an input corresponding to a request to select the control element is initiated given the input satisfies one or more criteria including a criterion that is satisfied when the input corresponds to a an activation input, such as gaze directed to the control element (e.g., described herein), air pinch gesture (e.g., described above), a tap gesture (e.g., described above), or one of or a combination of the above, or other gesture corresponding to a request to select the control element.

In some embodiments, in response to detecting the first input, the computer system selects the control element, such as hand 926x selecting element 192a as shown in FIG. 9X. For example, the computer system selects the control element in response to detecting the first input irrespective of whether or not the computer system displays the control element with the second visual appearance indicative of the control element gaining system focus (or input focus) for subsequent user inputs as will be described in more detail below. In some embodiments, when the computer system selects the control element in response to detecting the first input as described herein, the control element gains system focus (or, optionally, input focus) for subsequent user inputs as will be described in more detail below. For example, while (and/or after) selecting the control element, the computer system optionally moves, resizes, or closes the scrollable content (e.g., window associated with the control element) including optionally moving, resizing, or closing the control element in response to the first input and/or a sequence of one or more inputs following the first input, such as gaze and pinch gesture, gaze and pinch gesture including movement of the hand of the user, or other input as described above and/or below.

Selecting the control element in response to detecting a first input directed to the control element prior to changing the visual appearance of the control element from the first visual appearance to the second visual appearance provides immediate confirmation of user intent to select the control element based on the first input directed to the control element, and thereby provides quick selection of the control element which reduces the number of inputs and provides more efficient interactions between the user and the computer system.

In some embodiments, the computer system displays, via the display generation component, a control element associated with the scrollable content outside an area of the scrollable content (e.g., as described above), such as control elements 912a and 916a in FIG. 9R. In some embodiments, while displaying the control element and while a system focus is on the scrollable content (described above), the computer system detects, via the one or more input devices, the gaze of the user of the computer system moving to the control element, such as control element 912a in FIGS. 9Q and 916a in FIG. 9R.

In some embodiments, when the scrollable content has system focus (or, optionally, input focus), the scrollable content has one or more of the characteristics of the control element with system focus as described herein. For example, while a gaze of the user of the computer system is directed to the scrollable content and while a system focus is on the scrollable content, the computer system optionally detects a gaze-based scrolling input as described above. In some embodiments, in response to detecting the gaze-based scrolling input while the system focus is on the scrollable content, the computer system scrolls the scrollable content as described with reference to method 800.

In some embodiments, the computer system displays a visual indication of system focus on the scrollable content. For example, the computer system optionally displays the scrollable content with a second visual appearance optionally analogous to and/or including one or more of the characteristics of displaying the control element with the second visual appearance as described above. In some embodiments, the computer system does not display the visual indication of system focus on the scrollable content. In some embodiments, the computer system detects movement of the gaze of the user from the scrollable content to the control element, and in response, the computer system moves the system focus from the scrollable content to the control element as will be described herein.

In some embodiments, in response to detecting the gaze of the user moving to the location of the control element (e.g., a location within the respective hit volume of the control element as described above), the computer system changes the system focus to the control element (e.g., such as described previously), such as control element 916a in FIG. 9R. In some embodiments, while the system focus is directed to the control element, the computer system detects that the gaze of the user has moved away from the location of the control element, such as control element 912a in FIG. 9R.

In some embodiments, in response to detecting that the gaze of the user has moved away from the location of the control element, in accordance with a determination that the gaze of the user has moved away from the location of the control element by a first amount and in accordance with a determination that gaze-based scrolling (or, optionally, of the scrollable content associated with the control element) occurred within a first time threshold (e.g., 0.5, 1, 5, 10, 20, 30, 40, 50, 60, 100, 200, 300, 500, or 1000 seconds) of when the gaze of the user moved to the location of the control element, the computer system removes the system focus from the control element, such as control element 912a in FIG. 9R. For example, in accordance with a determination that gaze-based scrolling (e.g., scrolling the scrollable content in accordance with gaze-only based scrolling inputs as described above and/or with reference to method 800) occurred within the first time threshold from when the gaze of the user moving to the location of the control element (e.g., a location within the respective hit volume of the control element as described above) was detected, the computer system removes the system focus from the control element as long as the detected movement of the gaze of the user has moved away from the location of the control element by a first amount (e.g., an amount greater than the first threshold distance away from the control element as described above). In some embodiments, if the movement of the gaze of the user has moved away from the location of the control element by a second amount less than the first threshold distance away from the control element, the computer system maintains the system focus on the control element.

In some embodiments, in response to detecting that the gaze of the user has moved away from the location of the control element, in accordance with the determination that the gaze of the user has moved away from the location of the control element by the first amount and in accordance with a determination that gaze-based scrolling (or, optionally, of the scrollable content associated with the control element) did not occur within the first time threshold of when the gaze of the user moved to the location of the control element, the computer system forgoes removing the system focus on the control element (e.g., maintaining the system focus on the control element), such as control element 916a in FIG. 9S.

For example, in accordance with a determination that gaze-based scrolling did not occur within the first time threshold from when the gaze of the user moving to the location of the control element was detected, the computer system optionally does not remove the system focus from the control element in response to the determination that movement of the gaze of the user has moved away from the location of the control element by the first amount (e.g., an amount greater than the first threshold distance away from the control element as described above). In some embodiments, if the movement of the gaze of the user has moved away from the location of the control element by a second amount greater than the second threshold distance away from the control element as described above, the computer system removes the system focus on the control element.

Removing system focus on a control element in response to detecting that the gaze of the user has moved away from the location of the control element by a first amount and based on whether or not gaze-based scrolling occurred within the first time threshold from when the gaze of the user moving to the location of the control element was detected minimizes erroneous shifts in system control based on temporary movements of gaze (e.g., the computer considers whether or not gaze-based scrolling occurred recently before removing the system focus on the control element), thereby providing more efficient interactions between the user and the computer system.

In some embodiments, in response to detecting that the gaze of the user has moved away from the location of the control element, in accordance with the determination that the gaze of the user has moved away from the location of the control element by a second amount, greater than the first amount (e.g., 0.01, 0.1, 0.5, 1, 2, 3, 4, 5, or 10 centimeters), the computer system removes the system focus from the control element (or, optionally, independently of whether gaze-based scrolling occurred within the first time threshold of when the gaze of the user moved to the location of the control element), such as control element 916a in FIG. 9T. In some embodiments, the gaze-based scrolling includes scrolling the scrollable content associated with the control element.

In some embodiments, in accordance with a determination that gaze-based scrolling did not occur within the first time threshold from when the gaze of the user moving to the location of the control element was detected, the computer system optionally removes the system focus from the control element in response to the determination that movement of the gaze of the user has moved away from the location of the control element by a second amount (e.g., an amount greater than the second threshold distance away from the control element as described above).

Removing system focus on a control element in response to detecting that the gaze of the user has moved away from the location of the control element by a second amount and based on whether or not gaze-based scrolling occurred within the first time threshold from when the gaze of the user moving to the location of the control element was detected minimizes erroneous shifts in system control based on temporary movements of gaze (e.g., the computer system provides confirmation that the user no longer intends to interact with the control element), thereby providing more efficient interactions between the user and the computer system.

In some embodiments, while the system focus is directed to the control element, the control element is configured to receive one or more inputs from a portion of the user of the computer system (e.g., from the respective input element), such as hand 926ff in FIG. 9FF. In some embodiments, the portion of the user includes a hand, arm, and/or finger of the user of the computer system positioned within or outside of a viewport of the user into the three-dimensional environment when the system focus (e.g., selected by gaze) is directed to the control element. In some embodiments, the portion of the user of the computer system optionally corresponds to the portion of the user of the computer system content as described in method(s) 800 and 1000 and is optionally analogous to and/or has one or more of the characteristics of receiving one or more inputs from the portion of the user of the computer system. In some embodiments, when the control element has system focus (or input focus), the control element has one or more of the characteristics of the control element with system focus as described above. For example, while the system focus is on the control element, the computer system selects the control element for further input(s) to perform an action, such as move, resize, or close a user interface element associated with the control element as will be described in more detail below. In some embodiments, when the system focus is not on the control element, the control element is not a target for the further input(s) to move, resize, or close the user interface element.

The fact that the control element has system focus is used to determine user intent from user input that is ambiguous (e.g., move, resize, or close) such that ambiguous user input(s) are directed to the control element having system focus which provides immediate confirmation of user intent to interact with the control element, and thereby provides quick selection of the control element which reduces the number of inputs and provides more efficient interactions between the user and the computer system.

In some embodiments, while displaying the control element and while the system focus is on the control element, the computer system detects, via the one or more input devices, the portion of the user (e.g., hand, arm, and/or finger of the user as described above) providing an input directed to the control element, such as hand 926ff directed to control element 914a in 9FF. In some embodiments, in response to detecting the portion of the user providing the input directed to the control element, the computer system performs an action associated with the control element in accordance with the input directed to the control element provided by the portion of the user, such as resizing user interface element 904a in FIG. 9GG in accordance with hand 926ff in FIG. 9GG.

As described above and herein, the control element is associated with a user interface element including the scrollable content (e.g., window or volume of an application) and when the computer system receives and/or detects an input directed to the control element, the computer system performs an action associated with the user interface element including the control element. Exemplary actions are described in more detail below. In some embodiments, the input directed to the control element includes a gaze of a user of the computer system, a contact on a touch-sensitive surface, actuation of a physical input device, a predefined gesture (e.g., pinch gesture or air tap gesture), a voice input from the user, and/or a combination of some or all of the above corresponding to a request to perform an action associated with the control element.

In some embodiments, the computer system detects the portion of the user providing one or more second inputs(s), directed to the control element (or other selectable element configured to perform an action associated with a respective user interface element). In some embodiments, in response to detecting the portion of the user providing the one or more second input(s), the computer system determines whether the control element has system focus. In accordance with a determination that the control element has focus, the computer system optionally performs the action associated with the control element in accordance with the one or more second input(s) directed to the control element provided by the portion of the user. In some embodiments, in accordance with a determination that the control element does not have system focus, the computer system does not initiate the action associated with the control element.

Performing an action associated with the control element in accordance with an input directed to the control element enables the user to quickly perform the action, thereby reducing errors in interacting with the control element, which provides a more efficient user-computer system interface, reduces power consumption (e.g., the computer system readily recognizes the input is directed to the control element), and conserves computing resources associated with correcting erroneous input from the user.

In some embodiments, the control element is a movement affordance that is selectable to move the scrollable content (and/or the user interface element that includes the scrollable content), such as control element 912a in FIG. 9Y. As described above and herein, the scrollable content is a user interface element, such as a window or volume of an application (e.g., a music application). In some embodiments, the scrollable content is the content in the window (e.g., a listing of music albums). In some embodiments, the movement affordance is optionally analogous to and/or has one or more of the characteristics of the control element described above. In some embodiments, the computer system receives and/or detects user input (e.g., a gaze of a user of the computer system, a contact on a touch-sensitive surface, actuation of a physical input device, a predefined gesture (e.g., pinch gesture or air tap gesture) and/or a voice input from the user), and/or a combination of some or all of the above directed to the movement affordance. In some embodiments, in response to receiving the user input directed to the movement affordance, the computer system moves the scrollable content to another location within the three-dimensional environment in accordance with the user input. For example, moving the scrollable content and optionally the control element in the three-dimensional environment is based optionally on a movement of the portion of the user (e.g., hand, arm, and/or finger). For example, the scrollable content is moved in a direction (e.g., left, right, upwards, downwards, forward, and/or backward) to a location in the three-dimensional environment. In some embodiments, the magnitude, speed, acceleration and/or direction of the movement of the scrollable content corresponds to the magnitude, speed, acceleration and/or direction of the movement of the portion of the user during the user input.

Moving the scrollable content in response to an input directed to the control element enables a user to quickly position the scrollable content which provides a more efficient user-computer system interface, reduces power consumption, and improves battery life of the computer system. In some embodiments, the control element is a resize affordance that is selectable to resize the scrollable content (and/or resize the user interface element that includes the scrollable content, which optionally also resizes the scrollable content), such as control element 914a in FIG. 9FF. In some embodiments, the resize affordance is optionally analogous to and/or has one or more of the characteristics of the control element described above. In some embodiments, the computer system receives and/or detects user input (e.g., a gaze of a user of the computer system, a contact on a touch-sensitive surface, actuation of a physical input device, a predefined gesture (e.g., pinch gesture or air tap gesture) and/or a voice input from the user), and/or a combination of some or all of the above directed to the resize affordance. In some embodiments, the user input includes a direction of resizing (e.g., corresponding to increasing or decreasing a size of the scrollable content) and an amount of resizing. In some embodiments, the user input includes movement and an amount (e.g., magnitude, speed, acceleration, and/or distance) of the movement corresponding to an amount of resizing. For example, when the computer system detects greater movement, the computer system presents a greater change in size; and when the computer system detects less movement, the computer system presents a smaller change in size. In some embodiments, when the computer system reduces a size of the scrollable content (e.g., window), the computer system reduces a size of the content displayed in the scrollable content. In some embodiments, when the computer system increases a size of the scrollable content, the computer system increases a size of the content displayed in the scrollable content.

Resizing the scrollable content in response to an input directed to the control element enables a user to quickly resize the scrollable content which provides a more efficient user-computer system interface, reduces power consumption, and improves battery life of the computer system.

In some embodiments, the control element is a close affordance that is selectable to close (e.g., cease displaying) the scrollable content (and/or the user interface element that includes the scrollable content), such as control element 912a in FIG. 9II. In some embodiments, the close affordance is optionally analogous to and/or has one or more of the characteristics of the control element described above. In some embodiments, the computer system receives and/or detects user input (e.g., a gaze of a user of the computer system, a contact on a touch-sensitive surface, actuation of a physical input device, a predefined gesture (e.g., pinch gesture or air tap gesture) and/or a voice input from the user), and/or a combination of some or all of the above directed to the close affordance. In some embodiments, in response to receiving and/or detecting the user input directed to the close affordance, the computer system closes (e.g., ceases to display) the scrollable content.

Closing the scrollable content in response to an input directed to the control element enables a user to quickly close the scrollable content which provides a more efficient user-computer system interface, reduces power consumption, and improves battery life of the computer system. In some embodiments, the computer system displays, via the display generation component, a control element associated with the scrollable content, and while the system focus is directed to the control element (e.g., as described above), the computer system detects, via the one or more input devices, the gaze of the user of the computer system has moved away from the control element, such as gaze 908 in FIG. 9R.

In some embodiments, in response to detecting the gaze of the user has moved away from the control element in accordance with a determination that the gaze of the user has moved away from the location of the control element by a first amount, the computer system removes the system focus from the control element irrespective of whether gaze-based scrolling (or, optionally, of the scrollable content associated with the control element) occurred prior to the system focus moving to the control element, such as control element 912a in FIG. 9R. For example, the control element having the system focus is optionally analogous to and/or includes one or more of the characteristics of the control element having the system focus as described above. In some embodiments, the control system gains system focus based on a determination whether movement of the gaze of the user satisfies a combination of some or all of the criteria including time threshold(s) and/or threshold distance(s) described above. In some embodiments, and as described herein, the computer system detects movement of the gaze of the user away from the control element, and in response, the computer system removes the system focus from the control element based on one or more factors/conditions described herein.

For example, in accordance with a determination that the gaze of the user moved away from the location of the control element by a first amount (e.g., 0.01, 0.1, 0.5, 1, 2, 3, 4, 5, or 10 centimeters), the computer system removes the system focus from the control element as long as the detected movement of the gaze of the user has moved away from the location of the control element by an amount greater than the first threshold distance away from the control element as described above. Thus, the computer system optionally removes the system focus from the control element even if the computer system scrolled the scrollable content associated with the control element prior to the system focus moving to the control element which is described in detail above. In some embodiments, if the movement of the gaze of the user has moved away from the control element by a second amount less than the first threshold distance away from the control element, the computer system maintains the system focus on the control element.

In some embodiments, if the movement of the gaze of the user has moved away from the control element by a second amount greater than the second threshold distance away from the control element as described above, the computer system removes the system focus on the control element.

Removing system focus on a control element in response to detecting that the gaze of the user has moved away from the location of the control element by a first amount irrespective of whether gaze-based scrolling occurred prior to the system focus moving to the control element minimizes erroneous shifts in system control based on temporary movements of gaze (e.g., the computer considers whether or not user portion-based scrolling occurred recently before removing the system focus on the control element), thereby providing more efficient interactions between the user and the computer system.

It should be understood that the particular order in which the operations in method 1000 have been described is merely exemplary and is not intended to indicate that the described order is the only order in which the operations could be performed. One of ordinary skill in the art would recognize various ways to reorder the operations described herein. In some embodiments, aspects/operations of method 1000 may be interchanged, substituted, and/or added between these methods. For example, various object manipulation techniques and/or object movement techniques of method 1000 is optionally interchanged, substituted, and/or added between these methods. For brevity, these details are not repeated here.

FIGS. 11A-11V illustrate examples of a computer system displaying a plurality of virtual objects in a three-dimensional environment that change in appearance based on the duration of a gaze input directed to a selectable virtual object from the plurality of the virtual objects displayed in the three-dimensional environment in accordance with some embodiments.

FIG. 11A illustrates a computer system 101 (e.g., a computer system) displaying, via a display generation component (e.g., display generation component 120 of FIGS. 1 and 3), a three-dimensional environment 1100 from a viewpoint of a user. In some embodiments, computer system 101 includes a display generation component 120. In FIG. 11A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 11A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1100 and/or the physical environment of the computer system 101 is visible via display generation component 120 (e.g., via passive passthrough). For example, as shown in FIG. 11A, the three-dimensional environment 1100 includes a representation of a window 1131, which is optionally a representation of a physical window in the physical environment.

As discussed in more detail below, in FIG. 11A, display generation component 120 is illustrated as displaying content in the three-dimensional environment 1100. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 11A-11V.

As discussed herein, the user optionally provides gaze or attention inputs (e.g., gaze 1111) and/or performs one or more air gestures and/or movements to provide one or more inputs to computer system 101 to provide one or more corresponding inputs directed to content displayed by computer system 101. In the figures, gaze is optionally used to more broadly indicate or correspond to attention of the user. Such depiction is intended to be exemplary rather than limiting; the user optionally provides user inputs using different air gestures and/or using other forms of input.

In the example of FIG. 11A, the user's gaze 1111 is directed at the three-dimensional environment 1100 within the viewport of display generation component 120. As mentioned above, the computer system 101 is configured to display content in the three-dimensional environment 1100 using the display generation component 120. In FIG. 11A, the three-dimensional environment 1100 also includes virtual objects. In some embodiments, the virtual object 1103 is optionally a user interface of an application including content (e.g., a plurality of selectable options, images, text, and/or video), three-dimensional objects (e.g., virtual clocks, virtual balls, or virtual cars) and/or any other element displayed by computer system 101 that is not included in the physical environment of display generation component 120. For example, in FIG. 11A, the virtual object 1103 is a user interface of a content browser containing photo, video, and/or audio content, and the user interface optionally includes selectable objects. As an example, in FIG. 11A, the virtual object 1103 includes a first selectable virtual object 1101, a second selectable virtual object 1105, a third selectable virtual object 1106, a fourth selectable virtual object 1107, a fifth selectable virtual object 1108, and a sixth selectable virtual object 1109 (as illustrated in FIG. 11A, only portions of selectable virtual objects 1106 and 1108 are visible within virtual object 1103).

In some embodiments, the user's gaze 1111 is directed at the virtual object 1103 without being directed to any of the aforementioned selectable virtual objects (e.g., gaze 1111 is not directed to objects 1101, and 1105-1109). In some embodiments, the detecting selection of the selectable virtual object 1101 includes detecting gaze 1111 being directed at any region(s) associated with the displayed shape or representation of the selectable virtual object 1101, and/or detecting an air gesture (e.g., an air pinch including contact between fingers of a hand of a user of computer system 101, an air pointing of one or more of the fingers, and/or an air curling of one or more of the fingers) while gaze 1111 is directed at the selectable virtual object, as discussed in greater detail below with respect to FIG. 11G.

In some embodiments, the user interface of virtual object 1103 is scrollable (e.g., upward and/or downward) in the three-dimensional environment 1100. For example, in response to detecting inputs requesting scrolling of content included in virtual object 1103 (e.g., the virtual objects 1101, 1105, 1107, and/or the like), computer system 101 optionally changes which virtual content is be displayed in the user interface of the virtual object 1103. It is be understood that the virtual content such as virtual objects described above are merely exemplary and that, in some embodiments, additional and/or alternative virtual content and/or user interfaces are displayed in the three-dimensional environment 1100, such as the content described above with reference to methods 800 and/or 1000.

In some embodiments, as shown in FIG. 11A, the virtual object 1103 is displayed with one or more control user interface elements. For example, virtual object 1103 in FIG. 11A is displayed with an exit option 1135 and grabber bar 1120. In some embodiments, the exit option 1135 is selectable to initiate a process to cease displaying the virtual object 1103 in the three-dimensional environment 1100. In some embodiments, the grabber bar 1120 is selectable to initiate a process to move the virtual object 1103 within the three-dimensional environment 1100. It is understood that as described herein, virtual content being “selectable” to perform operations includes computer system 101 detecting one or more inputs described with reference to method 1200 directed to the virtual content, and in response to detecting the one or more inputs, initiating a related operation. For example, computer system 101 optionally detects an air pinch gesture and/or gaze 1111 directed to grabber bar 1120, and in response, optionally initiates movement of virtual object 1103 relative to three-dimensional environment 1100.

In some embodiments, the user's attention (e.g., gaze) is directed at a physical object, visible through a transparent display. In some embodiments, the user's attention (e.g., gaze) is directed at a representation of a physical object within the viewport of the display generation component 120. In some embodiments, the computer system 101 detects and/or tracks the duration of the gaze 1111 directed at a physical object, a visual representation of a physical object, and/or a virtual object (e.g., the selectable virtual objects 1101, and 1105-1109).

In some embodiments, computer system 101 manages a timer (as reflected by the timer bar 1121) associated with an amount of time that a duration of gaze 1111 is directed at a given selectable virtual object. In FIG. 11A, the timer corresponding to timer bar 1121 does not initiate because the gaze 1111 has not yet been directed at a selectable virtual object. For example, the gaze 1111 is not directed at any of the selectable virtual objects 1101 and 1105-1109, as illustrated in FIG. 11A. Therefore, timer bar 1121 does not initiate the tracking of a duration of gaze. In some embodiments, the computer system 101 detects the user's gaze 1111 shift and/or move from a physical object or a representation of a physical object to a virtual object, such as shown in FIG. 11B.

As illustrated in FIG. 11B, the gaze 1111 is directed at the selectable virtual object 1101. In some embodiments, the gaze 1111 is continuously directed at a selectable virtual object from FIG. 11A to FIG. 11B, and in response to the computer system 101 detecting the gaze being directed at the given selectable virtual object, the computer system 101 initiates a timer (e.g., as reflected by the timer bar 1121) for tracking the duration of the gaze 1111 being directed to the given selectable virtual object. In some embodiments, the gaze 1111 of the user moves to a selectable virtual object (e.g., selectable virtual object 1101) from not being directed at a selectable object, and in doing so, the computer system detects the movement of the gaze and initiates a timer bar associated with the corresponding selectable virtual object in response. In some embodiments, the computer system 101 resets the timer bar 1121 in response to the gaze 1111 diverting away from any regions associated with the given selectable virtual object. In some embodiments, the time thresholds 1123 and 1125 are associated with the timer bar 1121, which are discussed in more detail below. For example, in the example of FIG. 11B, the computer system 101 has detected the gaze 1111 being directed at the selectable virtual objects 1101, and in response, the timer bar 1121 initiates a duration/count. In this example, the timer bar 1121 has been initiated while gaze 1111 has been directed at the selectable virtual object 1101 for a period of time shown by duration 1127. As illustrated in FIG. 11B, the appearance of the selectable virtual object 1101 has not undergone any visual changes in response to the computer system detecting the gaze 1111 of the user directed to selectable virtual object 1101 since the time as reflected by timer bar 1121 is below threshold 1123. In some embodiments, for changes in appearance for any of the selectable virtual objects 1101 to occur, a criterion must be satisfied that requires that the duration 1127 exceeds a time threshold (e.g., the time threshold 1123 and/or 1125). In these examples, in the event that the computer system detects gaze 1111 diverting away from the selectable virtual object 1101, the computer system optionally resets the timer bar 1121 that was previously initiated for tracking the duration of gaze 1111 being directed at the selectable virtual object 1101.

As illustrated in the example of FIG. 11C, the gaze 1111 moved away from being directed at the selectable virtual object 1101 and is instead directed at the selectable virtual object 1107 (e.g., while still being directed at a region within the virtual object 1103). In response to detecting the gaze 1111 diverting away from the selectable virtual object 1101, the computer system 101 resets the duration 1127 of the timer bar 1121 to 0 seconds. In some embodiments, the timer bar 1121 progresses only if the gaze 1111 is continuously directed at a selectable virtual object. For example, in accordance with a determination that gaze 1111 strays away from a selectable virtual object, computer system 101 resets the timer corresponding to timer bar 1121. For example, in the example of FIG. 11C, in the event that the gaze 1111 is continuously directed at the selectable virtual object 1107, the computer system initiates a duration for timer bar 1121 (e.g., after being reset to 0 as the previous duration was associated with continuous gaze at the selectable object 1101), and the duration of the timer bar is associated with the selectable virtual object 1107.

From FIG. 11C to FIG. 11D, gaze 1111 is returned to the selectable object 1101. In some embodiments, the computer system tracks gaze 1111 of the user in the three-dimensional environment 1100 and highlights/adds glow to a region of the three-dimensional environment centered at gaze 1111. In some embodiments, in response to the user's gaze being directed at the virtual object 1103 or any of the plurality of the selectable virtual objects (e.g., object 1101) included in the virtual object 1103, the computer system 101 optionally displays a gaze glow centered at the gaze point (e.g., with a radius of 1, 1.5, or 2 inches). In some embodiments, the gaze glow 1113 has an oval or circular shape that is visible within the three-dimensional environment 1100. That is, the user optionally sees, in the three-dimensional environment 1100, a confirmation of their gaze within the viewport of display generation component 120. In some embodiments, the gaze glow 1113 is displayed with a different brightness from the representations of the physical object and/or other virtual objects. For example, a region corresponding to gaze glow 1113 is displayed with a brightness from (e.g., greater than) the brightness of other displayed content.

In some embodiments, as shown in the example of FIG. 11D, when computer system 101 detects that gaze 1111 is directed at the selectable virtual object 1101 for a period of time greater than the first time threshold 1123, computer system 101 changes the visual appearance of the selectable virtual object 1101 (e.g., changing from a first visual appearance to a second visual appearance). In some embodiments, the gaze glow 1113, as described herein, is displayed after the time corresponding to timer bar 1121 passes the first time threshold 1123.

In some embodiments, a change in the visual appearance of a selectable objects includes change(s) in size of the selectable virtual object and/or includes changing the manner in which the selectable objects are displayed to simulate a change depth. For example, as shown in FIG. 11D, the computer system changes the visual appearance of the selectable virtual object 1101 by enlarging the size of the selectable virtual object 1101 (e.g., a height and/or width of selectable virtual object 1101) and/or moves selectable virtual object to a distance and/or depth with respect to the viewpoint of the user that is closer than its distance and/or depth before changing the visual appearance. In some embodiments, computer system 101 displays a virtual shadow based upon the spatial relationship between a viewpoint of a user of the computer system 101 and the virtual object 1103. For example, as shown in FIG. 11D, the particular portions of virtual object 1103 upon which the virtual shadow is virtually cast is optionally based upon the viewpoint of the user and/or the direction of the gaze relative to virtual object 1101 (e.g., cast as though one or more virtual light sources were directed upwards relative to a floor of the three-dimensional environment, pointed toward a front-facing surface of virtual object 1103, and/or leftward relative to the viewpoint of the user). In some embodiments, in the event that the duration of the timer bar 1121, proceeds beyond the first time threshold 1123, and the computer system detects gaze 1111 redirecting/diverting away from the respective selectable virtual object, the computer system resets the timer bar 1121 to 0 as illustrated in the example of FIG. 11E.

From FIG. 11D to FIG. 11E, gaze 1111 is redirected and/or diverted away from selectable virtual object 1101 to a region within the virtual object 1103. In some embodiments, because gaze 1111 is no longer directed at the selectable virtual object 1101, computer system 101 ceases display of the virtual shadow. Additionally or alternatively, in response to detecting gaze 1111 divert away from the selectable virtual object 1101, computer system 101 optionally resets the timer corresponding to timer bar 1121 (e.g., indicated by the lack of fill overlaying timer bar 1121 in FIG. 11E).

From FIG. 11D to FIG. 11F, computer system 101 detects that gaze 1111 continues to be directed to selectable object 1101 (e.g., as an additional or alternative example in which gaze 1111 is not diverted away from selectable option 1101, as described with reference to FIG. 11E). In some embodiments, as shown in FIG. 11F, computer system 101 detects gaze 1111 remain directed to selectable object 1101 for a period of time greater than second time threshold 1125, as indicated by timer bar 1121. In some embodiments, in response to detecting the gaze 1111 remain directed at the selectable virtual object 1101 beyond the second time threshold 1125, computer system 101 changes the visual appearance of the selectable virtual object 1101 (e.g., from a second visual appearance to a third visual appearance). In FIG. 11F, the computer system changes the visual appearance of the selectable virtual object 1101 by enlarging the size of the selectable virtual object 1101 (e.g., to a size greater than a size included in the second visual appearance described above). Thus, from FIG. 11C FIG. 11D, computer system 101 increases the size of selectable virtual object 1101 from a first size to a second size, and from FIG. 11D to FIG. 11F, computer system 101 increases the size of selectable virtual object 1101 from the second size to a third size. Additionally or alternatively, the changes in visual appearance illustrated in FIG. 11F includes displaying virtual object 1101 as though virtual object 1101 moves closer to the viewpoint of the user, such as in a depth dimension relative to the viewpoint of the user. Additionally, the computer system transitions to displaying additional text for the content item associated with the selectable virtual object 1101 and/or displaying the selectable affordances 1144 and 1132 overlaid on the visual appearance of the selectable object 1101.

In some embodiments, when gaze 1111 is directed to selectable virtual object for an amount of time greater than second time threshold 1125, computer system 101 initiates display of controls associated with selectable virtual object 1101. For example, the selectable affordance 1144 is optionally a first control that is selectable to play a content item associated with the selectable virtual object 1101. For example, the content item optionally corresponds to animated content, video, automatically-generated visual content such as images and/or videos, and/or some combination thereof, and computer system 101 optionally initiates playback of an animation and/or of video in response to detecting input directed to selectable affordance 1144. In some embodiments, the selectable affordance 1132—corresponding to a second control—is selectable to display additional information associated with the aforementioned content item.

In FIG. 11F, computer system 101 optionally displays an animation sequence that corresponds to moving visual content such as the rocket revolving around the planet within the selectable virtual object 1101. In some embodiments, in the event that the virtual shadow is already displayed, the computer system tracks the depth and size changes of the selectable virtual object 1101 and increases the size of the virtual shadow or adjust the regions covered by the virtual shadow in accordance with the latest changes to the selectable virtual object 1101. In some embodiments, in the event that the duration of the timer bar 1121, proceeds beyond the second time threshold 1125, and the computer system detects gaze 1111 redirecting/diverting away from the respective selectable virtual object, the computer system resets the timer bar 1121 and/or reverts the visual appearance of the respective selectable object to a prior visual appearance (e.g., a visual appearance before detecting gaze 1111 being directed to the respective selectable object). Additionally or alternatively, computer system 101 optionally ceases playback of content included in the selectable virtual object 1101, such as ceasing playback of the rocket orbit animation in response to detecting gaze 1111 move away from selectable virtual object 1101.

In some embodiments, in the event that the animation sequence that is displayed within a selectable virtual object ends while the gaze remains directed to selectable virtual object 1101, the animation sequence repeats. For example, as shown from FIG. 11F to FIG. 11G, the gaze 1111 of the user is directed at the selectable object 1101 for an amount of timer greater than second time threshold 1125. In response to detecting the gaze 1111 dwell for the amount of time greater than the second time threshold 1125, computer system 101 displays an animation sequence (e.g., of a rocket ship passing the planet) and optionally repeats the animation sequence while the computer system 101 detects that the user maintains gaze the selectable virtual object 1101. In some embodiments, while the instant of the gaze 1111 remains directed at the selectable virtual object 1101, the computer system detects selection inputs selecting any of the selectable affordances (e.g., selectable affordance 1144 and/or exit option 1135) as illustrated in FIG. 11G.

In the example of FIG. 11G, computer system 101 detects that the hand of the user performing an air pinch input 1151 while the gaze 1111 of the user is directed at the selectable affordance 1144 (e.g., that is included in virtual object 1101). In response to detecting the air pinch input 1151, computer system 101 initiates a process to perform an operation associated with the selectable affordance 1144. In the example of FIG. 11G, the selectable affordance 1144 is a play button for a content item associated with the selectable virtual object 1101, and in response to detecting air pinch input 1151, computer system 101 initiates a play operation as illustrated in FIG. 11H. In the example of FIG. 11H, computer system 101, in response to detecting the pinch input 1151 of FIG. 11F, displays the content or media item associated with selectable virtual object 1101.

In an alternative example to FIG. 11G, as shown in the example of FIG. 11I, computer system 101 detects that the user performs an air pinch input 1152 while gaze 1111 is directed at the selectable virtual object 1101, instead of selectable affordance 1144. In response to detecting the air pinch input 1152, computer system 101 initiates a process to perform an operation associated with the selectable virtual object 1101 as illustrated in FIG. 11J (e.g., to display an enlarged view of the corresponding content and/or a media player user interface for the content). In the example of FIG. 11J, in response to detecting the air pinch input 1152 of FIG. 11I, computer system 101 displays additional information for the content or media item associated with selectable virtual object 1101. For example, in FIG. 11J, computer system 101 displays a media player user interface, optionally including media similar to or the same as represented in the selectable affordance 1144. In some embodiments, the media player user interface included in virtual object 1103 in FIG. 11J includes a plurality of selectable options, which when selected, causes computer system 101 to initiate operations associated with the media content depicted in the virtual object 1103. For example, computer system 101 in FIG. 11J displays a selectable option that is selectable to initiate playback of the content item, a selectable option that is selectable to initiate presentation of a media snippet (e.g., a trailer for a movie, a snippet from a song, and/or an interview of an individual that created the content item), and/or a selectable option that is selectable to display additional or alternative information related to the content (e.g., a cast, a crew, metadata, and/or some combination of such information relating to the content item).

FIGS. 11K-11Q illustrate embodiments in which computer system 101 optionally detects attention (e.g., gaze 1111) directed to selectable virtual object 1109, and in accordance with a determination that a dwell time of attention exceeds one or more thresholds, computer system 101 optionally changes the visual appearance and/or optionally initiates presentation of content, such as animations and/or playback of content. In FIG. 11K, similar to the example of FIG. 11A, computer system 101 detects that the gaze 1111 of the user move away from virtual content, toward the three-dimensional environment 1100 (e.g., the user is no longer gazing at any region(s) associated with the selectable virtual object 1103 (e.g., including the selectable virtual objects 1101, and 1105-1109)). Accordingly, computer system 101 resets and/or does not advance the timer corresponding to timer bar 1121.

From FIG. 11K to FIG. 11L, computer system 101 detects gaze 1111 directed at selectable virtual object 1109. As indicated by timer bar 1121, the duration of time (e.g., the dwell time) that gaze 1111 has been directed to selectable virtual object 1109 is non-zero, but is less than the first time threshold 1123. Accordingly, in FIG. 11L, the appearance of the selectable virtual object 1109 has not undergone any visual changes (e.g., is a first visual appearance).

As illustrated in the example of FIG. 11M, computer system 101 detects that the gaze 1111 remains directed at the selectable object 1109 beyond first time threshold 1123, and in response, computer system 101 modifies the visual appearance of the selectable virtual object 1109. For example, as shown in FIG. 11M, the computer system changes the visual appearance of the selectable virtual object 1109 by enlarging the size of the selectable virtual object 1109 and optionally displays virtual object 1109 as though moved closer toward the viewpoint of the user (e.g., seeming to extrude away from virtual object 1103). Thus, from FIG. 11L to FIG. 11M, computer system 101 displays selectable virtual object 1109 with a second visual appearance, different from the first visual appearance. Also as shown in FIG. 11M, computer system 101 to displays a virtual shadow 1160 covering a region directly behind the selectable virtual object 1109 (e.g., yet still overlaid on the virtual object 1103 or selectable virtual objects 1101, 1105-1108), such as if virtually cast by virtual object 1109. In some embodiments, computer system 101 scales the dimensions of virtual shadow 1160 in accordance with a change in dimensions of the related virtual object. For example, as computer system 101 progressively increases the size of selectable virtual object 1109, computer system 101 optionally increases the size of virtual shadow 1160, as described with reference to method 1200.

From FIG. 11M to FIG. 11N, computer system 101 detects gaze 1111 has remained directed to selectable virtual object 1109. In particular, in FIG. 11N, the dwell time of gaze 1111 exceeds second time threshold 1125. In response to detecting dwell time (e.g., the timer corresponding to timer bar 1121) exceed second time threshold 1125, computer system 101 modifies the visual appearance of the selectable virtual object 1109 (e.g., changing from a second visual appearance to a third visual appearance). For example, as shown in FIG. 11N, the computer system changes the visual appearance of the selectable virtual object 1109 by enlarging the size of the selectable virtual object 1109 to a size greater than as shown in FIG. 11M, and/or decreases the simulated depth at which virtual object 1109 is displayed (e.g., extruding further toward the viewpoint of the user than as shown in FIG. 11M).

In some embodiments, in a manner similar to or the same as described above, computer system 101 displays information and/or one or more selectable options associated with selectable virtual object 1109 when the dwell time of gaze 1111 exceeds the second time threshold 1125. For example in FIG. 11N, computer system 101 displays additional text (e.g., captions, titles, lyrics, and/or the like) associated the content item that is included in virtual object 1109. Additionally, computer system 101 in FIG. 11N displays selectable affordances 1133 and 1134 overlaid on the selectable object 1109. In some embodiments, the selectable affordance 1133 is selectable to initiate playback of the content item associated with the selectable virtual object 1109. In some embodiments, the selectable affordance 1134 is selectable to display additional information associated with the aforementioned content item. In some embodiments, as the dwell time exceeds second time threshold 1125 the computer system displays an animation effect overlaying and/or applied to virtual content included in the selectable virtual object 1109. In FIG. 11N, for example, computer system 101 displays an animation sequence that corresponds to moving visual content such as a wind blowing through musical notes within the selectable virtual object 1109, and/or displays the musical notes moving over time. In some embodiments, the animation is displayed occurring over a first period of time. In some embodiments, in accordance with a determination that the animation concludes, and that gaze 1111 remains directed to selectable option 1109, computer system 101 repeats display of the animation (e.g., computer system 101 displays the animation a second time in accordance with a determination that gaze 1111 remains directed to selectable virtual object 1109 for a period of time greater than the first period of time).

From FIG. 11N to FIG. 11O, computer system 101 detects that gaze 1111 shifts within selectable virtual object 1109, and that gaze 1111 targets selectable affordance 1133. In FIG. 11O, the animation effect progress relative to as illustrated in FIG. 11O, and computer system 101 detects air pinch input 1152 while gaze 1111 is directed at the selectable affordance 1133. In response to detecting the air pinch input 1152, computer system 101 performs an operation associated with the selectable affordance 1133.

In the example of FIG. 11P, computer system 101 initiates playback of the content item associated with selectable virtual object 1109. Additionally, computer system 101 scales the content up (e.g., increases the size) of the content item, such that the content item occupies the dimensions of virtual object 1103 concurrently while initiates the playback. In FIG. 11P, the computer system 101 displays playback controls 1142, 1140 and 1143 for controlling playback of the content or media item. For example, control 1142 is optionally selectable to skip backward in the content or media item, control 1140 is optionally selectable to pause playback of the content or media item, and control 1143 is optionally selectable to skip forward in the content or media item. In FIG. 11P, computer system 101 detects selection of control 1140 (e.g., via an air pinch while gaze 1111 is directed to control 1140), and in response, as illustrated by the example of FIG. 11Q, the computer system pauses the playback of the item.

FIGS. 11R-11V illustrate embodiments in which computer system 101 scrolls virtual content in accordance with attention (e.g., gaze) of a user. In some embodiments, computer system 101 detects attention directed to a region of a user interface and/or of a virtual object associated with scrolling currently displayed virtual content (e.g., text, virtual objects, graphics, media content, and/or the like), and in response, scrolls through the virtual content.

In FIG. 11R, three-dimensional environment 1100 includes a plurality of virtual objects, such as user interfaces and/or user interface elements 1101, 1103, 1118, and 1105-1109. In some embodiments, the virtual objects are components of a user interface or window of an application containing scrollable content, such as a reading application, a media content application, a platform control application, or other application described with reference to method(s) 800, 1000, and/or 1200. For example, in FIG. 11R, the computer system 101 displays a virtual object 1103 (or, optionally, also referred to herein as a window or volume) containing content, such as text, images, video, hyperlinks, and/or audio content. In some embodiments, the media browsing user interface is displayed with a navigation user interface including a side bar user interface button that, when selected, causes the computer system 101 to expand media browsing user interface element to include additional content.

In FIG. 11R, virtual object 1103 includes scrollable content, such as all or a portion of a media library (e.g., the lower bar/region that includes virtual objects 1101, 1105-1108) that includes virtual objects 1101 and 1105-1109 that are associated with content. The virtual object 1103 includes a first scrolling region 1116a and a second scrolling region 1116b. As will be described in more detail below, in response to detecting the gaze of the user directed to the first scrolling region 1116a or the second scrolling region 1116b (e.g., without requiring additional user input as described below), the computer system 101 scrolls the scrollable content including the media library and image-based virtual objects 1101 and 1105-1108 respectively. It should be understood that the dashed lines that define first region 1116a and/or second region 1116 are optionally not displayed.

In some embodiments, computer system 101 facilitates horizontal scrolling of the selectable objects associated with virtual object 1103. For example, computer system 101 optionally determines a first scrolling region 1116a, and/or optionally determines a second scrolling region 1116b, each scrolling region optionally associated with scrolling the objects 1101 and 1105-1108 in a first or in a second direction (e.g., leftward or rightward, or vice-versa). In some embodiments, the relative size of a scrolling region is changed from a default size in accordance with a determination that attention (e.g., gaze 1111) is directed to the scrolling region. For example, in FIG. 11R, the second scrolling region 1116b is larger than the first scrolling region 1116a due to gaze 1111 being directed to a location within the bounds of second scrolling region 1116b.

In some embodiments, the scrollable content includes additional content such as virtual object 1108 that is not fully displayed in FIG. 11R. In some embodiments, the virtual object 1108 is associated with embedded content and/or selectable links to other content. In some embodiments, in response to detecting that the gaze of the user is directed to the first scrolling region 1116a, the computer system 101 displays a visual indication that the first scrolling region 1116a is gaze scrolling enabled (e.g., responsive to gaze-based inputs) as described in more detail with reference to method(s) 800 and/or 1000. As illustrated in FIG. 11R, in response to detecting gaze 1111 directed to the second scrolling region 1116b, the computer system 101 optionally displays the second scrolling region 1116b with a color or other visual appearance to emphasize the second scrolling region 1116b relative to other regions (e.g., the first scrolling region 1116a) of the scrollable content (and/or the virtual object 1103 that includes the scrollable content).

In some embodiments, in response to detecting that the gaze of the user is directed to the first scrolling region 1116a or the second scrolling region 1116b, the computer system 101 changes a size of the respective region to which the gaze 1111 is directed to. For example, the second scrolling region 1116b has a first size before the computer system 101 detected gaze directed to the second scrolling region 1116b. In FIG. 11R, in response to detecting gaze 1111 directed to the second scrolling region 1116b, the computer system 101 displays the second scrolling region 1116b with a second size, larger than the first size of scrolling region 1116b. In some embodiments, the computer system 101 displays the second scrolling region 1116b with the second size as long as gaze 1111 is directed to the second scrolling region 1116b. In some embodiments, as described herein with respect to methods 800 and/or 1000, in the event that the gaze 1111 had been directed to the first scrolling region 1116a, the computer system 101 expands the first scrolling region 1116a (e.g., increase the size of the first scrolling region 1116a).

FIG. 11S illustrates the computer system 101 scrolling the scrollable content in response to determining that gaze 1111 is directed to the second scrolling region 1116b. As shown in FIG. 11S, in response to detecting the gaze 1111 of the user directed to the second scrolling region 1116b (e.g., the right region), the computer system 101 scrolls the scrollable content left to reveal additional scrollable content at the right side of the virtual object 1103. In some embodiments, as described above with respect to the methods 800 and/or 1000, in the event that the gaze 1111 had been directed to the first scrolling region 1116a (e.g., the left region), the computer system 101 would scroll the scrollable content left to reveal additional scrollable content at the left side of the virtual object 1103.

As illustrated in FIG. 11S, the gaze 1111 is directed at the selectable virtual object 1108. In some embodiments, the gaze 1111 of the user moves to the selectable virtual object 1108 while the selectable virtual object 1108 was previously partially displayed in a scrollable region, and in doing so, the computer system detects the gaze being directed to the selectable virtual object 1108 and initiates the timer bar 1121 to track the duration of gaze 1111 being directed at selectable virtual object 1108. In some embodiments, the computer system 101 resets the timer bar 1121 in response to the gaze 1111 diverting away from any regions associated with the selectable virtual object 1108. For example, in the example of FIG. 11S, the computer system 101 has detected the gaze 1111 being directed at the selectable virtual objects 1108, and in response, the timer bar 1121 initiates a duration/count. As illustrated in FIG. 11S, the appearance of the selectable virtual object 1108 has not undergone any visual changes in response to the computer system detecting the gaze 1111 of the user directed to selectable virtual object 1108 since the time as reflected by timer bar 1121 is below threshold 1123.

As illustrated in the example of FIG. 11T, the gaze 1111 remains directed at the selectable object 1108 beyond threshold 1123. In some embodiments, in response to the user's gaze being directed at the virtual object 1108, the computer system 101 optionally displays a gaze glow centered at the gaze point (e.g., with a radius of 1, 1.5, or 2 inches). As shown in the example of FIG. 11T, the computer system detects gaze 1111 remaining continuously directed at the selectable virtual object 1108 for a duration beyond the first time threshold 1123. In response to detecting the gaze 1111 directed at the selectable virtual object 1108 for a duration beyond the first time threshold 1123, the computer system changes the visual appearance of the selectable virtual object 1108 (e.g., changing into a second visual appearance from a first visual appearance). For example, as shown in FIG. 11T, the computer system changes the visual appearance of the selectable virtual object 1108 by enlarging the size of the selectable virtual object 1108 and/or transitions to displaying it at a closer distance and/or depth with respect to the viewpoint of the user. As shown in FIG. 11T, depending on the viewport of the one or more cameras in communication with the computer system 101, the viewpoint of the user, and the direction of the gaze, the computer system transitions to displaying a virtual shadow covering a region directly behind the selectable virtual object 1108 (e.g., yet still overlaid on the virtual object 1103 or selectable virtual objects 1101, 1105-1107, 1109), as if being virtually cast by object 1108.

In FIG. 11U, three-dimensional environment 1100 includes a plurality of virtual objects 1101, 1103, 1118, and 1105-1109 (e.g., objects including and/or corresponding to user interfaces and/or user interface elements). For example, in FIG. 11U, the computer system 101 displays a virtual object 1103 (or, optionally, also referred to herein as a window or volume) containing content, such as text, images, video, hyperlinks, and/or audio content. In FIG. 11U, virtual object 1103 includes scrollable content, such as all or a portion of a media library that includes virtual objects 1101 and 1105-1109, each of which being associated with content. The virtual object 1103 includes a third scrolling region 1116c and a fourth scrolling region 1116d. As will be described in more detail below, in response to detecting the gaze of the user directed to the third scrolling region 1116c or the second scrolling region 1116d (e.g., without requiring additional user input as described below), the computer system 101 scrolls the scrollable content including the media library and image-based virtual objects 1101 and 1105-1109 respectively. It should be understood that the dashed lines that defined the third region 1116c and the fourth region 1116d are optionally not displayed by computer system 101. FIG. In some embodiments, similarly to as described with reference to scrolling regions 1116a and 1116b, computer system 101 changes the size of third region 1116c and/or fourth region 1116d in accordance with a determination that attention (e.g., gaze 1111) is directed to the corresponding region. For example, as shown in FIG. 11S, computer system 101 determines fourth region 1116d corresponds to a relatively greater size than third region 1116c, due to gaze 1111 being directed to a location corresponding to a default size of fourth region 1116d.

As mentioned above, the scrollable content includes additional content that is not displayed in FIG. 11U, such as virtual object 1162 as shown in FIG. 11V. In some embodiments, the virtual object 1162 is associated with embedded content and/or selectable links to other content. In some embodiments, in response to detecting that the gaze of the user is directed to the third scrolling region 1116c or the fourth scrolling region 1116d in FIG. 11U, the computer system 101 displays a visual indication that a respective scrolling region is gaze scrolling enabled (e.g., responsive to gaze-based inputs) as described in more detail with reference to method(s) 800 and/or 1000. In the example of FIG. 11V, in response to detecting gaze 1111 directed to the fourth scrolling region 1116d, the computer system 101 optionally displays the fourth scrolling region 1116d with a color or other visual appearance to emphasize the fourth scrolling region 1116d relative to other regions (e.g., the first scrolling region 1116c) of the scrollable content (and/or the virtual object 1103 that includes the scrollable content In some embodiments, the computer system 101 displays the fourth scrolling region 1116d with the visual appearance as long as gaze 1111 is directed to the fourth scrolling region 1116d. In some embodiments, as described above with respect to methods 800 and/or 1000, in the event that the gaze 1111 had been directed to the third scrolling region 1116c, the computer system 101 would display the third scrolling region 1116c with the visual appearance optionally analogous to and/or having one or more of the characteristics of displaying the fourth scrolling region 1116d with the visual appearance.

In some embodiments, in response to detecting that the gaze of the user is directed to the third scrolling region 1116c or the fourth scrolling region 1116d, the computer system 101 changes a size of the respective region to which the gaze 1111 is directed to. For example, the fourth scrolling region 1116d has a first size before the computer system 101 detected gaze directed to the fourth scrolling region 1116d. In FIG. 11U, in response to detecting gaze 1111 directed to the fourth scrolling region 1116d, the computer system 101 displays the fourth scrolling region 1116d with a second size, larger than the first size of scrolling region 1116d. In some embodiments, the computer system 101 displays the fourth scrolling region 1116d with the second size as long as gaze 1111 is directed to the fourth scrolling region 1116d. In some embodiments, when the computer system 101 no longer detects that gaze 1111 is directed to the fourth scrolling region 1116d, the size of the fourth scrolling region 1116d reverses to the first size. In some embodiments, as described herein with respect to methods 800 and/or 1000, in the event that the gaze 1111 had been directed to the third scrolling region 1116c, the computer system 101 expands the third scrolling region 1116c (e.g., increase the size of the third scrolling region 1116c).

FIG. 11V illustrates the computer system 101 scrolling the scrollable content in response to determining that gaze 1111 is directed to the fourth scrolling region 1116d. As shown in FIG. 11V, in response to detecting the gaze 1111 of the user directed to the fourth scrolling region 1116d (e.g., the bottom region), the computer system 101 scrolls the scrollable content up (e.g., vertically) to reveal additional scrollable content (e.g., selectable virtual object 1162) at the bottom side of the virtual object 1103.

FIG. 12 is a flowchart illustrating a method of updating a visual appearance of a virtual object based upon a duration of attention directed to the virtual object, in accordance with some embodiments. In some embodiments, the method 1200 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, a method 1200 is performed at a computer system in communication with a display generation component and one or more input devices, such as computer system 101 in communication with display generation component 120 as shown in FIG. 11A. In some embodiments, the computer system has one or more of the characteristics of the computer system of methods 800 and 1000. For example, a mobile device (e.g., a tablet, a smartphone, a media player, or a wearable device), or a computer or other electronic device. In some embodiments, the display generation component has one or more characteristics of the display generation component in methods 800 and 1000. In some embodiments, the one or more input devices have one or more characteristics of the one or more input devices in methods 800 and 1000. In some embodiments, the computer system is in communication with one or more cameras (e.g., such as the one or more cameras in methods 800 and 1000).

In some embodiments, while displaying, via the display generation component, a plurality of virtual objects (e.g., a plurality of selectable virtual objects), such as virtual objects 1101, 1106, and/or 1107 as shown in FIG. 11A, the computer system detects (1202), via the one or more input devices, a gaze of a user directed to a first virtual object of the plurality of virtual objects, such as gaze 1111 as shown in FIG. 11A, wherein the first virtual object is displayed with a first visual appearance of the first virtual object, such as virtual object 1101 as shown in FIG. 11A.

In some embodiments, the computer system displays one or more virtual objects in a three-dimensional environment, such as the environments of the methods 800 and/or 1000, that are optionally selectable (e.g., in a manner similar to displaying a virtual object in a three-dimensional environment described in relation to methods 800 and/or 1000). In some embodiments, the one or more virtual objects are displayed with a first visual appearance. In some embodiments, a visual appearance of a virtual object encompasses various attributes including size, color, shape, pattern, brightness, opacity, and/or transparency, and is optionally associated with a content that is displayed on or in the first virtual object. In some embodiments, the first visual appearance of a first virtual object reflects a first state of the first virtual object (e.g., with a first visual appearance) prior to user inputs directed to (and/or while no user input is directed to) the one or more virtual objects. In some embodiments, the gaze of the user was not yet directed at the first virtual object when the computer system subsequently detected that it was. In some embodiments, the first virtual object is/was displayed with the first visual appearance prior to the gaze of the user being directed at the first virtual object. In some embodiments, the user provides the gaze input directed to the first object without providing additional input(s) from a (or any) different portion of the user (e.g., one or more hands). In some embodiments, the first visual appearance of the first virtual object is predetermined via system settings. In some embodiments, the first visual appearance of the first virtual object is user-controlled and/or user-defined (e.g., adjustable based on user inputs). In some embodiments, the one or more virtual objects are concurrently displayed with and/or within a user interface of an application, such as an electronic reading application, a media content application, a settings application, or a platform control application. In some embodiments, the one or more virtual objects are displayed only partially (e.g., a portion of the visual and/or textual content associated with the one or more virtual object is not visible on the display). In some embodiments, the one or more objects are concurrently displayed with and/or within scrollable content, as defined in relation to methods 800 and/or 1000. In some embodiments, the user directs a gaze at a partially displayed or partially visible first virtual object to cause the first virtual object to scroll and to fully display the first virtual object prior to the first virtual object reaching the first state. In some embodiments, the computer system detects the gaze of the user directed to a region of the user interface and/or the virtual objects for a period of time (e.g., 0.02, 0.05, 0.1, 0.2, 0.25, 0.3, 0.5, 1, 2, 3, or 5 seconds) before changing the visual appearance of the first object as described below.

In some embodiments, in response to (and/or while) detecting the gaze of the user directed to the first virtual object, in accordance with a determination that a duration for which the gaze of the user has been directed to the first virtual object exceeds a first time threshold (e.g., 0.02, 0.05, 0.1, 0.2, 0.25, 0.3, 0.5, 1, 2 or 5 seconds), such as first time threshold 1123 as shown in FIG. 11D, the computer system changes (1204) a visual appearance of the first virtual object from the first visual appearance of the first virtual object to a second visual appearance of the first virtual object, different from the first visual appearance of the first virtual object, such as from the first visual appearance as shown in FIG. 11B of virtual object 1101 to a second visual appearance as shown in FIG. 11D.

In some embodiments, while the first virtual object is displayed with the second visual appearance of the first virtual object, in accordance with a determination that the duration for which the gaze of the user has been directed to the first virtual object exceeds a second time threshold (e.g., 0.05, 0.1, 0.2, 0.25, 0.3, 0.5, 1, 2, or 6 seconds), longer than the first time threshold, such as second time threshold 1125 as shown in FIG. 11F, the computer system changes (1206) the visual appearance of the first virtual object from the second visual appearance of the first virtual object to a third visual appearance of the first virtual object, different from the first visual appearance of the first virtual object and the second visual appearance of the first virtual object, such as to the visual appearance of virtual object 1101 as shown in FIG. 11F, wherein the third visual appearance includes visual content displayed in the first virtual object that is not included in the first virtual object having the first visual appearance of the first virtual object and second visual appearance of the first virtual object, such as selectable affordance 1144 as shown in FIG. 11F.

In some embodiments, the transition of the first virtual object from the first visual appearance of the first virtual object to the second visual appearance of the first virtual object includes displaying an animation from displaying the first virtual object with the first visual appearance of the first virtual object to the second visual appearance of the first virtual object. For example, the first visual appearance of the first virtual object optionally includes the first virtual object being displayed with a given brightness, and in response to detecting the gaze persisting beyond the first time threshold, the first visual appearance transitions to the second visual appearance including the first virtual object being displayed at a higher brightness. Alternatively, this transition from the first visual appearance of the first virtual object to the second visual appearance of the first virtual object occurs without an (or any) intermediary states (e.g., without gradually increasing the brightness to the higher brightness) or without an animation. In some embodiments, while the first virtual object is being displayed with the second visual appearance of the first virtual object, in response to the computer system detecting the gaze of the user continues to be continuously directed at the first virtual object beyond the first time threshold and a second time threshold, longer than the first time threshold, the computer system optionally transitions from displaying the first virtual object with the second visual appearance of the first virtual object to displaying the first virtual object with a third visual appearance of the first virtual object, different from both the first visual appearance of the first virtual object and the second visual appearance of the first virtual object. In some embodiments, this second transition of the first virtual object from the second visual appearance of the first virtual object to the third visual appearance of the first virtual object includes an animation from displaying the first virtual object with the second visual appearance of the first virtual object to the third visual appearance of the first virtual object. For example, the first visual appearance of the first virtual object and second visual appearance of the first virtual object optionally include the first virtual object being displayed with a given distance and/or depth from the viewpoint of the user, and in response to detecting the gaze of the user persisting on the first virtual object for longer than the second time threshold, the first virtual object transitions from being displayed with the second visual appearance of the first virtual object to the third visual appearance of the first virtual object that includes being displayed at a closer distance and/or depth from the viewpoint of the user. This second transition optionally occurs with an animation moving the first virtual object closer to the viewpoint of the user, thereby changing the second visual appearance of the first virtual object to the third visual appearance with which the first virtual object is displayed at a closer distance to the viewpoint of the user. Alternatively, this transition from the second visual appearance of the first virtual object to the third visual appearance of the first virtual object occurs without an (or any) intermediary states (e.g., without gradually shortening the distance to the viewpoint of the user) or without an animation. In some embodiments, the third visual appearance of the first virtual object includes features and/or visual content that are not included in or absent from both the initial and the second visual appearances of the first virtual object. For example, in the event that the first virtual object is associated with a first content item, the third visual appearance of the first virtual object includes additional text reflecting information associated with the first content item, where that text was not included in the first visual appearance of the first virtual object or the second visual appearance of the first virtual object.

Changing the visual appearance of a virtual object to different visual appearances in response to detecting that the gaze of the user has been directed to the virtual object beyond one or more threshold durations of time minimizes input errors from the user associated with the user misinterpreting which virtual object of one or more virtual objects are being controlled by the gaze of the user and avoids transition of the virtual object to being displayed with an unprompted visual appearance and/or being unintentionally engaged, thereby conserving computing resources associated with correcting erroneous input from the user.

In some embodiments, while displaying, via the display generation component, the first virtual object with the second visual appearance (or the third visual appearance), the computer system detects, via the one or more input devices, that the gaze of the user is not directed to the first virtual object, such as gaze 1111 shifting away from virtual object 1101 from as shown in FIG. 11D to as shown in FIG. 11E.

As described herein, in some embodiments, the computer system displays one or more virtual objects, including the first virtual object, in a three-dimensional environment, such as the environments of the methods 800 and/or 1000, and the first virtual object is optionally displayed (e.g., after detecting that the gaze of the user is continuously directed at the first virtual object for the first time threshold) with its second visual appearance (e.g., reflecting a second state of the first virtual object). In some embodiments, as the computer system is displaying the first virtual object with its second visual appearance, the computer system detects that the gaze of the user moves onto a different object and/or location within the three-dimensional environment and/or stops being directed at the first virtual object. For example, the computer systems detects that the gaze of the user has moved from the first virtual object onto a second virtual object, different from the first virtual object, from the displayed one or more virtual objects or to a visual representation of one or more physical object within the user's viewpoint. In some embodiments, while displaying the first virtual object with the second visual appearance of the first virtual object, the computer system detects that the attention (e.g., based on gaze) of the user has moved away from the first virtual object to the second virtual object or the visual representation of the one or more physical object within the user's viewpoint. In some embodiments, the computer system detects that the gaze of the user is no longer directed at the first virtual object or ceases (e.g., the user closing their eyes) being directed at the first virtual object (e.g., or any of the other displayed virtual object or one or more visual representation of the one or more physical objects).

In some embodiments, in response to (and/or while) detecting the gaze of the user is not directed to the first virtual object, the computer system changes the visual appearance of the first virtual object from the second visual appearance (or the third visual appearance) of the first virtual object to the first visual appearance of the first virtual object, such as the visual appearance of virtual object 1101 from as shown in FIG. 11D to as shown in FIG. 11E.

In some embodiments, in response to detecting that the gaze of the user is no longer directed at the first virtual object (e.g., in response to detecting that the gaze of the user ceases being directed at the first virtual object or moves onto a different virtual object or a visual representation of a physical object, while the first virtual object is displayed with the second visual appearance), the computer system changes the visual appearance of the first virtual object from the second visual appearance of the first virtual object to the first visual appearance of the first virtual object. For example, in response to the computer system detecting any changes to the gaze of the user that the gaze of the user is no longer being directed at the first virtual object, while the first virtual object is displayed with the second visual appearance, the computer system reverts the visual appearance of the first virtual object from the second visual appearance of the first virtual object back to the first visual appearance of the first virtual object (e.g., corresponding to reversing the second state of the first virtual object back to the first state of the first virtual object). In some embodiments, the first visual appearance of the first virtual object is equivalent to the visual appearance of the first virtual object prior to the computer detecting the gaze of the user being directed at the first virtual object. In some embodiments, in response to detecting that the gaze of the user is no longer directed at the first virtual object, the computer system reverses previous changes to the visual appearance of the first virtual object by changing the visual appearance of the first virtual object to the first visual appearance of the first virtual object. Changing (e.g., or undoing) the visual appearance of a virtual object based on a determination that the gaze of the user is no longer directed at the virtual object (e.g., or directed at a different object or is not directed at any objects within the user's viewpoint) reduces errors in the interaction between the user and the computer system (e.g., by avoiding unintentional changing to the visual appearance of the virtual object), thereby conserving computing resources associated with correcting erroneous input from the user.

In some embodiments, while the duration for which the gaze of the user has been directed to the first virtual object exceeds the first time threshold (e.g., 0.02, 0.05, 0.1, 0.2, 0.25, 0.3, 0.5, 1, 2 or 5 seconds) but not the second time threshold (e.g., 0.05, 0.1, 0.2, 0.25, 0.3, 0.5, 1, 2, or 6 seconds), such as the amount of time indicated in the timer bar 1121 as shown in FIG. 11D, and while displaying the first virtual object with the second visual appearance of the first virtual object, the computer system detects, via the one or more input devices, that the gaze of the user is no longer directed to the first virtual object, such as gaze 1111 shifting from as shown in FIG. 11D to as shown in FIG. 11E. In some embodiments, the computer system detects that the gaze of the user continues to be directed at the first virtual object for a duration exceeding the first time threshold, as described herein. In some embodiments, while the duration for which the gaze of the user is directed at the first virtual object exceeds the first time threshold and before it reaches the second time threshold (e.g., that is longer than the first time threshold), the computer system detects that the gaze of the user moves to a different object within the three-dimensional environment and/or stops being directed to the first virtual object. In some embodiments, the visual appearance of the first virtual object is changed from the first visual appearance of the first virtual object to the second visual appearance of the first virtual object (or, optionally, in response to the gaze of the user being detected as exceeding the duration of the first time threshold).

In some embodiments, in response to (and/or while) detecting that the gaze of the user is no longer directed to the first virtual object, such as gaze 1111 as shown in FIG. 11E that is not directed to virtual object 1101, the computer system changes the visual appearance of the first virtual object from the second visual appearance of the first virtual object to the first visual appearance of the first virtual object without displaying the first virtual object with the third visual appearance of the first virtual object, such as the change in visual appearance of virtual object 1101 from as shown in FIG. 11D to as shown in FIG. 11E.

In some embodiments, in response to detecting that the gaze of the user is no longer directed at the first virtual object (e.g., in response to detecting that the gaze of the user ceases being directed at the first virtual object or moves onto a different virtual object or a visual representation of a physical object, while the first virtual object is displayed with the second visual appearance), the computer system forgoes changing the visual appearance of the first virtual object from the second visual appearance of the first virtual object to the third visual appearance of the first virtual object and changes (or reverts) the visual appearance of the first virtual object (e.g., without displaying the first virtual object with the third visual appearance of the first virtual object) to the first appearance (e.g., the appearance prior to the gaze of the user being detected as exceeding the first time threshold). For example, in response to the computer system detecting any changes to the gaze of the user, while the duration for which the gaze of the user is directed at the first virtual object exceeds the first time threshold and before it reaches the second time threshold, the computer system does not change the visual appearance of the first virtual object from the second visual appearance of the first virtual object to the third visual appearance of the first virtual object (e.g., corresponding to transitioning to a third visual appearance of the first virtual object). In some embodiments, in response to the computer system detecting any changes to the gaze of the user that results in the gaze being no longer being directed at the first virtual object, while the duration for which the gaze of the user is directed at the first virtual object exceeds the first time threshold and before it reaches the second time threshold, the computer system forgoes changing the visual appearance of the first virtual object from the second visual appearance of the first virtual object to the third visual appearance of the first virtual object (e.g., does not display the first virtual object with the third visual appearance of the first virtual object). In some embodiments, in response to detecting that the gaze of the user is no longer directed at the first virtual object, the computer system reverses previous changes to the visual appearance of the first virtual object by changing the visual appearance of the first virtual object to the first visual appearance of the first virtual object as well as forgoing changing the changing the visual appearance of the first virtual object from the second visual appearance of the first virtual object to the third visual appearance of the first virtual object (e.g., without displaying the first virtual object with the third visual appearance of the first virtual object). Foregoing changes to the visual appearance of a virtual object based on a determination that the gaze of the user is no longer directed at the virtual object (e.g., or directed at a different object or is not directed at any objects within the user's viewpoint) reduces errors in the interaction between the user and the computer system (e.g., by avoiding unintentional changing to the visual appearance of the virtual object), thereby conserving computing resources associated with correcting erroneous input from the user.

In some embodiments, the plurality of the virtual objects includes a second virtual object. In some embodiments, the computer system detects, via the one or more input devices, the gaze of a user being directed to the second virtual object, wherein the second virtual object is displayed with a first visual appearance of the second virtual object, such as virtual object 1109 as shown in FIG. 11L that is different from virtual object 1101. In some embodiments, the computer system displays one or more virtual objects, including a second virtual object, in a three-dimensional environment, such as the environments of the methods 800 and/or 1000, and the second virtual object is optionally displayed with its first visual appearance. In some embodiments, the first visual appearance of the second virtual object reflects a first state of the second virtual object (e.g., with a first visual appearance) prior to user inputs directed to (and/or while no user input is directed to) the one or more virtual objects. In some embodiments, the gaze of the user was not yet directed at the second virtual object when the computer system subsequently detected that it was. In some embodiments, the second virtual object is/was displayed with the first visual appearance prior to the gaze of the user being directed at the second virtual object. In some embodiments, the user provides the gaze input directed to the first object without providing additional input(s) from a (or any) different portion of the user (e.g., one or more hands). In some embodiments, the first visual appearance of the second virtual object is predetermined via system settings. In some embodiments, the first visual appearance of the second virtual object is user-controlled and/or user-defined (e.g., adjustable based on user inputs). In some embodiments, the user directs a gaze at a partially displayed or partially visible second virtual object to cause the second virtual object to scroll and to fully display the second virtual object prior to the second virtual object reaching the first state. In some embodiments, the computer system detects the gaze of the user directed to a region of the user interface and/or the virtual objects for a period of time (e.g., 0.02, 0.05, 0.1, 0.2, 0.25, 0.3, 0.5, 1, 2, 3, or 5 seconds) before changing the visual appearance of the second virtual object as described below.

In some embodiments, in response to (and/or while) detecting the gaze of the user directed to the second virtual object, in accordance with a determination that a duration for which the gaze of the user has been directed to the second virtual object exceeds the first time threshold (e.g., 0.02, 0.05, 0.1, 0.2, 0.25, 0.3, 0.5, 1, 2 or 5 seconds), such as indicated in timer bar 1121 as shown in FIG. 11M, the computer system changes a visual appearance of the second virtual object from the first visual appearance of the second virtual object to a second visual appearance of the second virtual object, different from the first visual appearance of the second virtual object, such as the visual appearance of virtual object 1109 as shown in FIG. 11M.

In some embodiments, while the second virtual object is displayed with the second visual appearance of the second virtual object, in accordance with a determination that the duration for which the gaze of the user has been directed to the second virtual object exceeds the second time threshold (e.g., 0.05, 0.1, 0.2, 0.25, 0.3, 0.5, 1, 2, or 6 seconds), longer than the first time threshold, such as indicated by timer bar 1121 as shown in FIG. 11N, the computer system changes the visual appearance of the second virtual object from the second visual appearance of the second virtual object to a third visual appearance of the second virtual object, different from the first visual appearance of the second virtual object and the second visual appearance of the second virtual object, wherein the third visual appearance includes visual content displayed in the second virtual object that is not included in the second virtual object having the first visual appearance of the second virtual object and second visual appearance of the second virtual object, such as the visual appearance of virtual object 1109 as shown in FIG. 11N.

In some embodiments, the transition of the second virtual object from the first visual appearance of the second virtual object, optionally different from the first visual appearance of the first virtual object, to the second visual appearance of the second virtual object, optionally different from the second visual appearance of the first virtual object, includes displaying an animation from displaying the second virtual object with the first visual appearance of the second virtual object to the second visual appearance of the second virtual object. For example, the first visual appearance of the second virtual object optionally includes the second virtual object being displayed with a given brightness, and in response to detecting the gaze persisting beyond the first time threshold, the first visual appearance transitions to the second visual appearance including the second virtual object being displayed at a higher brightness. Alternatively, this transition from the first visual appearance of the second virtual object to the second visual appearance of the second virtual object occurs without an (or any) intermediary states (e.g., without gradually increasing the brightness to the higher brightness) or without an animation. In some embodiments, while the second virtual object is being displayed with the second visual appearance of the second virtual object, in response to the computer system detecting the gaze of the user continues to be continuously directed at the second virtual object beyond the first time threshold and a second time threshold, longer than the first time threshold, the computer system optionally transitions from displaying the second virtual object with the second visual appearance of the second virtual object to displaying the second virtual object with a third visual appearance of the second virtual object, different from the first visual appearance of the second virtual object, the second visual appearance of the second virtual object, and/or the third visual appearance of the first virtual object. In some embodiments, this second transition of the second virtual object from the second visual appearance of the second virtual object to the third visual appearance of the second virtual object includes an animation from displaying the second virtual object with the second visual appearance of the second virtual object to the third visual appearance of the second virtual object. For example, the first visual appearance of the second virtual object and second visual appearance of the second virtual object optionally include the second virtual object being displayed with a given distance and/or depth from the viewpoint of the user, and in response to detecting the gaze of the user persisting on the second virtual object for longer than the second time threshold, the second virtual object transitions from being displayed with the second visual appearance of the second virtual object to the third visual appearance of the second virtual object that includes being displayed at a closer distance and/or depth from the viewpoint of the user. This second transition optionally occurs with an animation moving the second virtual object closer to the viewpoint of the user, thereby changing the second visual appearance of the second virtual object to the third visual appearance with which the second virtual object is displayed at a closer distance to the viewpoint of the user. Alternatively, this transition from the second visual appearance of the second virtual object to the third visual appearance of the second virtual object occurs without an (or any) intermediary states (e.g., without gradually shortening the distance to the viewpoint of the user) or without an animation. In some embodiments, the third visual appearance of the second virtual object includes features and/or visual content that are not included in or absent from both the initial and the second visual appearances of the second virtual object. For example, in the event that the second virtual object is associated with a second content item, the third visual appearance of the second virtual object includes additional text reflecting information associated with the second content item, where that text was not included in the first visual appearance of the second virtual object or the second visual appearance of the second virtual object. Changing the visual appearance of a virtual object to different visual appearances in response to detecting that the gaze of the user has been directed to the virtual object beyond one or more threshold durations of time minimizes input errors from the user associated with the user misinterpreting which virtual object of one or more virtual objects are being controlled by the gaze of the user and avoids transition of the virtual object to being displayed with an unprompted visual appearance and/or being unintentionally engaged, thereby conserving computing resources associated with correcting erroneous input from the user.

In some embodiments, while displaying, via the display generation component, the second virtual object with the second visual appearance (or, optionally, the third visual appearance), the computer system detects, via the one or more input devices, that the gaze of the user is not directed to the second virtual object, such as gaze 1111 directed to region 1116b as shown in FIG. 11R. As described herein, in some embodiments, the computer system displays one or more virtual objects, including the second virtual object, in a three-dimensional environment, such as the environments of the methods 800 and/or 1000, and the second virtual object is optionally displayed (e.g., after detecting that the gaze of the user is continuously directed at the first virtual object for the first time threshold) with its second visual appearance (e.g., reflecting a second state of the second virtual object). In some embodiments, as the computer system is displaying the second virtual object with its second visual appearance, the computer system detects that the gaze of the user moves onto a different object and/or location within the three-dimensional environment and/or stops being directed at the first virtual object. For example, the computer system detects that the gaze of the user has moved from the first virtual object onto a third virtual object, different from the second virtual object, from the displayed one or more virtual objects or to a visual representation of one or more physical object within the user's viewpoint. In some embodiments, while displaying the second virtual object with the second visual appearance of the first virtual object, the computer system detects that the attention (e.g., based on gaze) of the user has moved away from the second virtual object to the third virtual object or the visual representation of the one or more physical object within the user's viewpoint. In some embodiments, the computer system detects that the gaze of the user is no longer directed at the second virtual object or ceases (e.g., the user closing their eyes) being directed at the second virtual object (e.g., or any of the other displayed virtual object or one or more visual representation of the one or more physical objects).

In some embodiments, in response to detecting the gaze of the user is not directed to the second virtual object, the computer system changes the visual appearance of the second virtual object from the second visual appearance (or, optionally, the third visual appearance) of the second virtual object to the first visual appearance of the second virtual object, such as to the visual appearance of virtual object 1109 as shown in FIG. 11R. In some embodiments, in response to detecting that the gaze of the user is no longer directed at the second virtual object (e.g., in response to detecting that the gaze of the user ceases being directed at the second virtual object or moves onto a different virtual object or a visual representation of a physical object, while the second virtual object is displayed with the second visual appearance), the computer system changes the visual appearance of the second virtual object from the second visual appearance of the second virtual object to the first visual appearance of the second virtual object. For example, in response to the computer system detecting one or more changes to the gaze of the user that results in the gaze being no longer being directed at the first virtual object, while the second virtual object is displayed with the second visual appearance, the computer system reverts the visual appearance of the second virtual object from the second visual appearance of the second virtual object back to the first visual appearance of the second virtual object (e.g., corresponding to reversing the second state of the second virtual object back to the first state of the second virtual object). In some embodiments, the first visual appearance of the first virtual object is equivalent to the visual appearance of the first virtual object prior to the computer detecting the gaze of the user being directed at the first virtual object. In some embodiments, in response to detecting that the gaze of the user is no longer directed at the second virtual object, the computer system reverses previous changes to the visual appearance of the second virtual object by changing the visual appearance of the second virtual object to the first visual appearance of the second virtual object. Changing (e.g., or undoing) the visual appearance of a virtual object based on a determination that the gaze of the user is no longer directed at the virtual object (e.g., or directed at a different object or is not directed at any objects within the user's viewpoint) reduces errors in the interaction between the user and the computer system (e.g., by avoiding unintentional changing to the visual appearance of the virtual object), thereby conserving computing resources associated with correcting erroneous input from the user.

In some embodiments, while the duration for which the gaze of the user has been directed to the second virtual object exceeds the first time threshold but not the second time threshold, such as indicated by timer bar 1121 as shown in FIG. 11M, and while displaying the second virtual object with the second visual appearance of the second virtual object, the computer system detects, via the one or more input devices, that the gaze of the user is no longer directed to the second virtual object, such as detecting gaze 1111 shift from as shown in FIG. 11M to as shown in FIG. 11K. In some embodiments, the computer system detects that gaze of the user continues to be directed at the second virtual object for a duration exceeding the first time threshold, as described herein. In some embodiments, while the duration for which the gaze of the user is directed at the second virtual object exceeds the first time threshold and before it reaches the second time threshold (e.g., that is longer than the first time threshold), the computer system detects that the gaze of the user moves to a different object within the three-dimensional environment and/or stops being directed to the second virtual object. In some embodiments, the visual appearance of the second virtual object is changed from the first visual appearance of the second virtual object to the second visual appearance of the second virtual object (e.g., in response to the gaze of the user being detected as exceeding the duration of the first time threshold).

In some embodiments, in response to (and/or while) detecting that the gaze of the user is no longer directed to the second virtual object, the computer system changes the visual appearance of the second virtual object from the second visual appearance of the second virtual object to the first visual appearance of the second virtual object without displaying the second virtual object with the third visual appearance of the second virtual object, such as the change in visual appearance of virtual object 1109 from as shown in FIG. 11M to as shown in FIG. 11K. In some embodiments, in response to detecting that the gaze of the user is no longer directed at the second virtual object (e.g., in response to detecting that the gaze of the user ceases being directed at the second virtual object or moves onto a different virtual object or a visual representation of a physical object, while the second virtual object is displayed with the second visual appearance), the computer system forgoes changing the visual appearance of the second virtual object from the second visual appearance of the second virtual object to the third visual appearance of the second virtual object and changes (or, optionally, reverts) the visual appearance of the first virtual object (e.g., without displaying the second virtual object with the third visual appearance of the second virtual object) to the first appearance (e.g., the appearance prior to the gaze of the user being detected as exceeding the first time threshold). For example, in response to the computer system detecting any changes to the gaze of the user, while the duration for which the gaze of the user is directed at the second virtual object exceeds the first time threshold and before it reaches the second time threshold, the computer system does not change the visual appearance of the second virtual object from the second visual appearance of the second virtual object to the third visual appearance of the second virtual object (e.g., corresponding to transitioning to a third visual appearance of the second virtual object). In some embodiments, in response to the computer system detecting any changes to the gaze of the user that results in the gaze being no longer being directed at the first virtual object, while the duration for which the gaze of the user is directed at the second virtual object exceeds the first time threshold and before it reaches the second time threshold the computer system forgoes changing the visual appearance of the second virtual object from the second visual appearance of the second virtual object to the third visual appearance of the second virtual object (e.g., does not display the second virtual object with the third visual appearance of the second virtual object). In some embodiments, in response to detecting that the gaze of the user is no longer directed at the second virtual object, the computer system reverses previous changes to the visual appearance of the second virtual object by changing the visual appearance of the second virtual object to the first visual appearance of the second virtual object as well as forgoing changing the changing the visual appearance of the second virtual object from the second visual appearance of the second virtual object to the third visual appearance of the second virtual object (e.g., without displaying the second virtual object with the third visual appearance of the second virtual object). Foregoing changes to the visual appearance of a virtual object based on a determination that the gaze of the user is no longer directed at the virtual object (e.g., or directed at a different object or is not directed at any objects within the user's viewpoint) reduces errors in the interaction between the user and the computer system (e.g., by avoiding unintentional changing to the visual appearance of the virtual object), thereby conserving computing resources associated with correcting erroneous input from the user.

In some embodiments, displaying the first virtual object with the second visual appearance of the first virtual object includes displaying the first virtual object with a first size, such as virtual object 1101 as shown in FIG. 11B. In some embodiments, displaying the first virtual object with the first visual appearance of the first virtual object includes displaying the first virtual object with a second size, such as virtual object 1101 as shown in FIG. 11D. In some embodiments, the second size is different from the first size, such as the difference in size between virtual object 1101 as shown in FIG. 11B compared to as shown in FIG. 11D. In some embodiments, in accordance with a determination that the gaze of the user is directed to the first virtual object for less than a first duration threshold (e.g., as described herein), the first virtual object has a first size. In some embodiments, the one or more virtual objects have a rectangular or circular shape and are displayed at a predetermined and/or user-defined size. In some embodiments, in accordance with a determination that the gaze of the user is directed away from or is no longer directed at the first virtual object (e.g., directed at the second virtual object or a visual representation of a physical object within the user's viewpoint or ceases being directed at the first virtual object) (e.g., and the first virtual object is fully displayed), the first virtual object has the first size. In some embodiments, in response to detecting the gaze of user directed at the first virtual object (and, optionally, for longer than the first duration threshold), the computer system changes (e.g., expands) the size of the first virtual object from the first size to a second size (e.g., as the computer system changes the visual appearance of the first virtual object from the first visual appearance of the first virtual object to the second visual appearance of the first virtual object), greater than the first size. In some embodiments, changing the size of the first virtual object represents a subset of changes from the changes to the visual appearance of the first virtual object from the first visual appearance of the first virtual object to the second visual appearance of the first virtual object (e.g., the changes to the visual appearance of the first virtual object are not limited to changes in the size for the first virtual object). In some embodiments, the computer system does not display a visual indication of the size of the first virtual object via the display generation component. Increasing the size of a virtual object in response to gaze being directed at the virtual object enables a progressive confirmation and/or selection of the virtual object via gaze (e.g., expands the virtual object to receive selection inputs), thereby reducing errors in the interaction between the user and the computer system and facilitating more efficient user interaction with the content (e.g., less overall time spent providing selection inputs), thereby conserving computing resources associated with correcting erroneous input from the user.

In some embodiments, the first visual appearance of the first virtual object includes displaying the first virtual object at a first depth with respect to a viewpoint of the user, such as a depth of virtual object 1101 as shown in FIG. 11B. In some embodiments, the second visual appearance includes displaying the first virtual object at a second depth, different from the first depth, with respect to the viewpoint of the user, such as virtual object 1101 as shown in FIG. 11D. In some embodiments, the computer system displays one or more virtual objects (e.g., or a plurality of virtual objects), including the first virtual object and the second virtual object, and/or the visual representation of the one or more physical objects within the three-dimensional environment, such as the environments of the methods 800 and/or 1000, at a depth with respect to the viewpoint of the user and in accordance with the duration for which the gaze of the user is directed to the first virtual object. For example, the aforementioned three-dimensional environment, such as the environments of the methods 800 and/or 1000, can be defined by X, Y, and Z axes as perceived from the user's viewpoint. In some embodiments, the Z axis of the three-dimensional environment extends perpendicular to the display. In some embodiments, the Z-axis represents the dimension of distance perpendicular to the display, and the depth associated with a virtual object with respect to user's viewpoint represents such distance. In some embodiments, in accordance with a determination that the gaze of the user is directed to the first virtual object for less than a first time threshold (e.g., associated with changing the visual appearance of the first virtual object from the first visual appearance of the first virtual object to the second visual appearance of the first virtual object, described above), the first virtual object is displayed with a first depth with respect to the user's viewpoint. In some embodiments, in accordance with a determination that the gaze of the user is directed away from or is no longer directed at the first virtual object (e.g., directed at the second virtual object or a visual representation of a physical object within the user's viewpoint or ceases being directed at the first virtual object and the first virtual object is fully displayed) or is directed at the first virtual object for a duration of less than the first time threshold, the first virtual object is displayed with the first depth with respect to user's viewpoint. In some embodiments, in response to detecting the gaze of user directed at the first virtual object (and, optionally, for longer than the first duration threshold), the computer system changes (e.g., moves the first virtual object with respect to the user's viewpoint) the depth of the first virtual object from the first depth to a second depth (e.g., as the computer system changes the visual appearance of the first virtual object from the first visual appearance of the first virtual object to the second visual appearance of the first virtual object). In some embodiments, the first depth of the first virtual object (e.g., corresponding to the depth of the first state of the first virtual object) with respect to user's viewpoint appears closer to the user's viewpoint than the second depth of the first virtual object (e.g., corresponding to the depth of the second state of the first virtual object). Changing the depth of a virtual object in response to gaze being directed at the virtual object enables a progressive confirmation and/or selection of the virtual object via gaze (e.g., moves the virtual object closer to receive selection inputs), thereby reducing errors in the interaction between the user and the computer system and facilitating more efficient user interaction with the content (e.g., less overall time spent providing selection inputs), thereby conserving computing resources associated with correcting erroneous input from the user.

In some embodiments, changing the visual appearance from the first visual appearance of the first virtual object to the second visual appearance of the first virtual object includes applying a gaze glow to the first virtual object, such as a gaze glow 1113 overlaying and/or applied to virtual object 1101 as shown in FIG. 11D. In some embodiments, the gaze glow indicates a location on the first virtual object to which attention (e.g., based on gaze) of the user is directed, such as centered on the location indicated by gaze glow 1113 that overlaps with virtual object 1101 as shown in FIG. 11D. In some embodiments, in accordance with a determination that the gaze of the user is directed to the first virtual object for less than a first duration threshold (e.g., as described above), the computer system does not display the first virtual object with a gaze glow (e.g., or a gaze glow is not applied to the visual appearance of the first virtual object). In some embodiments, the gaze glow associated with the first virtual object corresponds to a soft, luminous aura surrounding the first virtual object (e.g., a virtual lighting effect displayed on the first object). In some embodiments, applying the gaze glow to the first virtual object includes applying a semi-transparent overlay with a bright color that creates the appearance of light emitting from the first virtual object. In some embodiments, displaying the first virtual object with a gaze glow includes modifying one or more visual characteristics of the first virtual object including but not limited to the color, brightness, tint, and/or transparency of the first virtual object. In some embodiments, in accordance with a determination that the gaze of the user is directed away from or is no longer directed at the first virtual object (e.g., directed at the second virtual object or a visual representation of a physical object within the user's viewpoint or ceases being directed at the first virtual object and the first virtual object is fully displayed), the first visual appearance of the first virtual object does not include applying the gaze glow to the first virtual object. In some embodiments, in response to detecting the gaze of user directed at the first virtual object for longer than the first duration threshold, the computer system applies a gaze glow to the visual appearance of the first virtual object (e.g., as the computer system changes the visual appearance of the first virtual object from the first visual appearance of the first virtual object to the second visual appearance of the first virtual object). In some embodiments, the gaze glow marks (or indicates) a first location on the first virtual object to which the attention of the user is directed, and in response to detecting the gaze of the user migrating (or moving) to a second location on the first virtual object, different from the first location on the first virtual object, the gaze glow moves to the second location to mark (or indicate) the second location on the first virtual object to which attention of the user is directed. Applying a gaze glow to a virtual object in response to gaze being directed at the virtual object enables a progressive confirmation and/or selection of the virtual object via gaze (e.g., glows the virtual object to receive selection inputs), thereby reducing errors in the interaction between the user and the computer system and facilitating more efficient user interaction with the content (e.g., less overall time spent providing selection inputs), thereby conserving computing resources associated with correcting erroneous input from the user.

In some embodiments, changing the visual appearance from the first visual appearance of the first virtual object to the second visual appearance of the first virtual object includes changing a brightness (and/or visual emphasis relative to the three-dimensional environment) of the first virtual object, such as changing of a brightness of some or all of virtual object 1101 from as shown in FIG. 11B to as shown in FIG. 11D. In some embodiments, the computer system displays one or more virtual objects (e.g., or a plurality of virtual objects), including the first virtual object and the second virtual object, and/or the visual representation of the one or more physical objects within the three-dimensional environment, such as the environments of the methods 800 and/or 1000, with a visual appearance at a brightness in accordance with the duration for which the gaze of the user is directed at any of the virtual objects or the visual representation of the one or more physical objects. In some embodiments, the brightness associated with the visual appearance of the one or more virtual objects corresponds to the overall luminance, color vibrancy, and/or intensity of the displayed visual appearance. In some embodiments, changing the brightness of the first virtual object represents a subset of changes from the changes to the visual appearance of the first virtual object from the first visual appearance of the first virtual object to the second visual appearance of the first virtual object (e.g., the changes to the visual appearance of the first virtual object are not limited to changes in the brightness of the first virtual object). In some embodiments, in accordance with a determination that the gaze of the user is directed to the first virtual object for less than a first duration threshold (e.g., as described herein), the computer system displays the first virtual object with a visual appearance that has a first brightness (e.g., 100, 120, 150, or 200 nits). In some embodiments, in accordance with a determination that the gaze of the user is directed away from or is no longer directed at the first virtual object (e.g., directed at the second virtual object or a visual representation of a physical object within the user's viewpoint or ceases being directed at the first virtual object and the first virtual object is fully displayed), the first virtual object is displayed with the visual appearance associated with the first brightness. In some embodiments, in response to detecting the gaze of user directed at the first virtual object for longer than the first duration threshold, the computer system changes the brightness of the visual appearance of the first virtual object from the first brightness to a second brightness (e.g., 150, 200, 250, and/or 300 nits), as the computer system changes the visual appearance of the first virtual object from the first visual appearance of the first virtual object to the second visual appearance of the first virtual object. In some embodiments, the first brightness associated with the first visual appearance of the first virtual object (e.g., corresponding to the brightness of the first state of the first virtual object) is displayed brighter to the user's viewpoint than the second brightness associated with the second visual appearance of the first virtual object (e.g., corresponding to the brightness of the second state of the first virtual object). Changing the brightness of a visual appearance of a virtual object in response to gaze being directed at the virtual object longer than a threshold duration enables a progressive confirmation and/or selection of the virtual object via gaze (e.g., increases the brightness associated with the visual appearance of the virtual object to receive selection inputs), thereby reducing errors in the interaction between the user and the computer system and facilitating more efficient user interaction with the content (e.g., less overall time spent providing selection inputs), thereby conserving computing resources associated with correcting erroneous input from the user.

In some embodiments, changing the visual appearance from the first visual appearance of the first virtual object to the second visual appearance of the first virtual object includes displaying one or more affordances overlaid on the first virtual object from a viewpoint of the user, such as selectable affordance 1144 as shown in FIG. 11F. In some embodiments, the computer system changes the visual appearance of the one or more virtual objects (e.g., or a plurality of virtual objects), including the first virtual object and the second virtual object, and/or the visual representation of the one or more physical objects within the three-dimensional environment, such as the environments of the methods 800 and/or 1000, by adding additional content to the appearance of the virtual object (e.g., overlaying the additional content on the visual appearance of the one or more virtual objects) of the one or more visual objects. In some embodiments, the additional content associated with changing the visual appearance of the one or more virtual objects includes one or more affordance that are optionally selectable. In some embodiments, in accordance with a determination that the gaze of the user is directed to the first virtual object for less than a first duration threshold (e.g., as described above), the computer system displays the first virtual object with a visual appearance without displaying the one or more affordances. In some embodiments, in accordance with a determination that the gaze of the user is directed away from or is no longer directed at the first virtual object (e.g., directed at the second virtual object or a visual representation of a physical object within the user's viewpoint or ceases being directed at the first virtual object and the first virtual object is fully displayed), the computer system displays the first virtual object with a visual appearance without displaying the one or more affordances.

In some embodiments, in response to detecting the gaze of user directed at the first virtual object (and optionally for longer than the first duration threshold), the computer system changes the visual appearance of the first virtual object by displaying one or more affordances overlaid on the visual appearance of the first virtual object (e.g., as the computer system changes the visual appearance of the first virtual object from the first visual appearance of the first virtual object to the second visual appearance of the first virtual object). For example, the computer system optionally displays a visual representation of a media application, and the visual representation of the media application includes a content item (e.g., corresponding to the first virtual object) that is displayed with its third visual appearance. Overlaid on the third visual appearance for such content item is optionally one or more affordances, such as media controls and/or a selectable play action button. In some embodiments, overlaying one or more affordances on the visual appearance of the first virtual object represents a subset of changes from the changes to the visual appearance of the first virtual object from the first visual appearance of the first virtual object to the second visual appearance of the first virtual object (e.g., the changes to the visual appearance of the first virtual object is not limited to overlaying one or more affordances on the visual appearance of the first virtual object). In some embodiments, in response to the computer system detecting a user input directed at a first affordance (or other affordance) from the one or more affordances (e.g., selection of the first affordance), the computer system performs an operation (or action) associated with the first affordance (or the other affordance). Changing a visual appearance of a virtual object by displaying one or more affordances overlaid on the visual appearance of the virtual object in response to gaze being directed at the virtual object enables a progressive confirmation and/or selection of the virtual object via gaze (e.g., overlaying an affordance associated with the virtual object to receive selection inputs) and enables a transition to additional menus for selection associated with the virtual object, thereby reducing errors in the interaction between the user and the computer system and facilitating more efficient user interaction with the content (e.g., less overall time spent providing selection inputs), thereby conserving computing resources associated with correcting erroneous input from the user.

In some embodiments, the visual content associated with the third visual appearance of the first virtual object includes text overlaid on the first virtual object, such as text included in virtual object 1101 as shown in FIG. 11F. In some embodiments, the additional content, as described above, associated with changing the visual appearance of the one or more virtual objects includes additional text. In some embodiments, in accordance with a determination that the gaze of the user is directed to the first virtual object for less than a first time threshold (e.g., associated with changing the visual appearance of the first virtual object from the first visual appearance of the first virtual object to the second visual appearance of the first virtual object, described above), the first virtual object is displayed with a visual appearance without displaying the additional text. In some embodiments, in accordance with a determination that the gaze of the user is directed away from or is no longer directed at the first virtual object (e.g., directed at the second virtual object or a visual representation of a physical object within the user's viewpoint or ceases being directed at the first virtual object and the first virtual object is fully displayed), the first virtual object is displayed with a visual appearance without displaying the additional text. In some embodiments, in response to detecting the gaze of user directed at the first virtual object (and optionally for longer than the first duration threshold), the computer system changes the visual appearance of the first virtual object by displaying additional text overlaid on the visual appearance of the first virtual object (e.g., as the computer system changes the visual appearance of the first virtual object from the second visual appearance of the first virtual object to the third visual appearance of the first virtual object). For example, overlaid on the third visual appearance for a content item is optionally additional texts associated with the content item, such as date of release and/or cast information. In some embodiments, changing the size of the first virtual object represents a subset of changes from the changes to the visual appearance of the first virtual object from the second visual appearance of the first virtual object to the third visual appearance of the first virtual object (e.g., the changes to the visual appearance of the first virtual object are not limited to changes in the size for the first virtual object). In some embodiments, overlaying additional text on the visual appearance of the first virtual object represents a subset of changes from the changes to the visual appearance of the first virtual object from the second visual appearance of the first virtual object to the third visual appearance of the first virtual object (e.g., the changes to the visual appearance of the first virtual object is not limited to overlaying one or more affordances on the visual appearance of the first virtual object). Changing a visual appearance of a virtual object by displaying text overlaid on the visual appearance of the virtual object in response to gaze being directed at the virtual object enables a progressive confirmation and/or selection of the virtual object via gaze (e.g., overlaying text associated with the virtual object to receive selection inputs) and enables additional information and feedback that may be useful for interaction between the user and the computer system, thereby reducing errors in the interaction between the user and the computer system, providing visual feedback as a result of such interaction, and facilitating more efficient user interaction with the content (e.g., less overall time spent providing selection inputs), thereby conserving computing resources associated with correcting erroneous input from the user.

In some embodiments, the changing of the visual appearance of the first virtual object from the second visual appearance of the first virtual object to the third visual appearance of the first virtual object includes displaying a first animation in the first virtual object, such as displaying the animation (e.g., the rocket orbiting a planet) in virtual object 1101 as shown in FIG. 11F. In some embodiments, as the gaze of the user directed at the first virtual object persists beyond the second time threshold (e.g., the time threshold associated with changing the visual appearance of the first virtual object from the second visual appearance of the first virtual object to the third visual appearance of the first virtual object as described above), and in response to the computer system detecting that the gaze of the user has been directed at the first virtual object beyond the second time threshold, the computer system changes the visual appearance of the first virtual object from the second visual appearance of the first virtual object to the third visual appearance of the first virtual object and the third visual appearance includes displaying a first animation on the first virtual object. For example, the second visual appearance of the first virtual object optionally includes one or more visual contents (e.g., a first visual content) that is also common to the third visual appearance of the first virtual object. The first animation associated with changing the visual appearance of the first virtual object from the second visual appearance of the first virtual object to the third visual appearance of the first visual appearance optionally includes animating the first visual content that was displayed as being static during the first and second visual appearances. In some embodiments, the first animation (e.g., on the first virtual object) is not limited to movements of the one or more visual contents that were displayed during the first and/or second visual appearances within the displayed region occupied by the first virtual object. In some embodiments, the first animation corresponds to fading, flipping, and/or color shifting (e.g., within the displayed region occupied by the first virtual object) of the one or more visual contents (e.g., common to the second visual appearance of the first virtual object and the third visual appearance of the first virtual object). Changing a visual appearance of a virtual object by displaying an animation on the virtual object in response to detecting a persistence of the gaze being directed at the virtual object enables a progressive confirmation and/or selection of the virtual object via gaze, thereby reducing errors in the interaction between the user and the computer system, providing visual feedback as a result of such interaction, and facilitating more efficient user interaction with the content (e.g., less overall time spent providing selection inputs), thereby conserving computing resources associated with correcting erroneous input from the user.

In some embodiments, the first animation includes a first animation sequence, wherein displaying the first animation comprises, while the gaze of the user is directed to the first virtual object, repeating the first animation sequence when an end of the first animation sequence is reached, such as repeating the animation included in virtual object 1101 as shown in FIG. 11F. In some embodiments, the first animation, as described above, on the first virtual object includes a sequence of changes (e.g., a first animation sequence such as unique movement steps) to the one or more visual content (e.g., the first visual content common to the second visual appearance of the first virtual object and the third visual appearance of the first virtual object) as the computer system detects that the gaze of the user directed at the first virtual object is persisting beyond the second time threshold, as described herein.

In some embodiments, the start of the first animation sequence (e.g., unique movement steps of the first visual content common to the second visual appearance of the first virtual object and the third visual appearance of the first virtual object) corresponds to a start of the computer system detecting that the gaze of the user directed at the first virtual object persists beyond the second time threshold (e.g., associated with changing the visual appearance of the first virtual object from the second visual appearance of the first virtual object to the third visual appearance of the first virtual object, described above). In some embodiments, the end of first animation sequence corresponds to a completion of changes associated with the first animation on the first virtual object. In some embodiments, the computer system detects that the gaze of the user is directed to the first virtual object persists beyond the second time threshold such that the first animation sequence (e.g., unique movement steps of the first visual content common to the second visual appearance of the first virtual object and the third visual appearance of the first virtual object) occurs at least once. In some embodiments, the end of the first animation sequence, while the gaze of the user has not changed its direction from being directed at the first virtual object, triggers a repeat of the first animation sequence.

In some embodiments, the first animation includes a first animation sequence, wherein displaying the first animation comprises, in accordance with a determination that the gaze of the user is no longer directed to the first virtual object, ceasing display of the first animation in the first virtual object, such as ceasing of the animation of content included in virtual object from as shown in FIG. 11I to as shown in FIG. 11K. In some embodiments, in response to detecting that the gaze of the user is no longer directed at the first virtual object (e.g., in response to detecting that the gaze of the user ceases being directed at the first virtual object or moves onto a different virtual object or a visual representation of a physical object, while the first virtual object is displayed with the second visual appearance), the computer system changes the visual appearance of the first virtual object from the third visual appearance of the first virtual object to the first visual appearance of the first virtual object. In some embodiments, in response to detecting that the gaze of the user is no longer directed at the first virtual object, the computer system ceases (e.g., or terminates) display of the first animation on the first virtual object (e.g., including the first animation sequence and optionally the second animation sequence). Displaying an animation including repeating the animation sequence on a virtual object while the gaze of the user is directed at the virtual object enables a progressive confirmation and/or selection reduces errors in the interaction between the user and the computer system providing visual feedback as a result of such interaction, and facilitating more efficient user interaction with the content (e.g., less overall time spent providing selection inputs), thereby conserving computing resources associated with correcting erroneous input from the user.

In some embodiments, the computer system detects, via the one or more input devices (e.g., using one or more acoustic/optical/capacitive sensors), a selection input, such as an air pinch 1151 as shown in FIG. 11G. In some embodiments, examples of detecting the first input include but are not limited to detecting a touch on the touch screen, detecting an air pinch using one or more cameras of the electronic device, detecting a voice command using one or more audio input devices, and/or any combination of the aforementioned input types. In some embodiments, the air pinch corresponds to two or more fingers of a user's hand such as the thumb and index finger moving together and touching each other.

In some embodiments, in response to detecting the selection input, in accordance with a determination that the gaze of the user is directed to the first virtual object at a time corresponding to a time when the selection input was detected, the computer system performs a first operation associated with the first virtual object, such as display of the content item consuming the dimensions of virtual object 1103 as shown in FIG. 11J, and/or playback of the content item included in virtual object 1103 as shown in FIG. 11P. In some embodiments, while the computer system detects that the gaze of the user is directed at the one or more virtual objects (e.g., first virtual object), the computer system optionally also detects that a respective input element is providing a selection input directed at the first virtual object. For instance, the respective input element optionally includes a portion of the user, such as the hand arm, and/or finger of the user, and the detected selection input from the portion of the user for selecting the first virtual object includes the user performing an air gesture (e.g., an air pinch gesture, such as two or more fingers of a user's hand such as the thumb and index finger moving together and touching each other). In some embodiments, the computer system, in response to detecting the selection input directed to the first virtual object, and in accordance with the determination that the gaze of the user is maintained at the first virtual object, performs a first operation (e.g., or a first action) associated with the first virtual object. In some embodiments, as the first virtual object is optionally associated with a content item or media, performing the first operation associated with the first virtual object corresponds to displaying or triggering to display a visual representation of the content item or media (e.g., playing the content). In some embodiments, in response to detecting the selection input, in accordance with a determination that the gaze of the user is not directed to the first virtual object at a time corresponding to a time when the selection input was detected, the computer system forgoes performing the first operation associated with the first virtual object. In some embodiments, the determination that the gaze of the user is directed to the first visual object occurs when the selection input was detected within a threshold temporal gap (e.g., a time threshold of 0.5, 1, 2, 3, or 5 milliseconds) from the time when the selection was detected. In some embodiments, regardless of whether the first virtual object is with the first visual appearance of the first virtual object, the second visual appearance of the first virtual object, or the third visual appearance of the first virtual object at the time of detecting the selection input, in response to the computer system detecting the selection input and that the gaze of the user is directed at the first virtual object, the computer system performs the first operation (e.g., or the first action) associated with the first virtual object. Performing an operation in response to detecting a selection input directed to a virtual object while the gaze of the user is also directed at the virtual object minimizes input errors from the user, thereby conserving computing resources associated with correcting erroneous input from the user.

In some embodiments, in response to detecting the first selection input, in accordance with a determination that the gaze of the user is directed to a second virtual object of the plurality of virtual objects at a time corresponding to a time when the selection input was detected, different from the first virtual object, the computer system performs a second operation associated with the second virtual object, such as an operation associated with selectable affordance 1133 in response to detecting air pinch input 1152 as shown in FIG. 11O. For instance, the respective input element optionally includes a portion of the user, such as the hand arm, and/or finger of the user, and the detected selection input from the portion of the user for selecting the second virtual object includes the user performing an air gesture (e.g., an air pinch gesture, such as two or more fingers of a user's hand such as the thumb and index finger moving together and touching each other). In some embodiments, the computer system, in response to detecting the selection input directed to the second virtual object, and in accordance with the determination that the gaze of the user is maintained at the second virtual object, performs a second operation (e.g., or a first action) associated with the second virtual object, optionally different from the first operation associated with the first virtual object. In some embodiments, as the second virtual object is optionally associated with a second content item or media, performing the second operation associated with the second virtual object corresponds to displaying or triggering to display a visual representation of the second content item or media (e.g., playing the second content). In some embodiments, in response to detecting the selection input, in accordance with a determination that the gaze of the user is not directed to the second virtual object at a time corresponding to a time when the selection input was detected, the computer system forgoes performing the second operation associated with the second virtual object. In some embodiments, the determination that the gaze of the user is directed to the first visual object occurs when the selection input was detected within a threshold temporal gap (e.g., a time threshold of 0.5, 1, 2, 3, or 5 milliseconds) from the time when the selection was detected. In some embodiments, regardless of whether the second virtual object is displayed with the first visual appearance of the second virtual object, the second visual appearance of the second virtual object, or the third visual appearance of the second virtual object when the selection input is detected, in response to computer system detecting the selection input and that the gaze of the user is directed at the second virtual object, the computer system performs the second operation (e.g., or the second action) associated with the second virtual object. Performing an operation in response to detecting a selection input directed to a virtual object while the gaze of the user is also directed at the virtual object minimizes input errors from the user, thereby conserving computing resources associated with correcting erroneous input from the user.

In some embodiments, changing the visual appearance of the first virtual object from the first visual appearance of the first virtual object to the second visual appearance of the first virtual object includes displaying a first transition sequence from the first visual appearance of the first virtual object to the second visual appearance of the first virtual object, such as a transition in visual appearance of virtual object 1101 from as shown in FIG. 11B to as shown in FIG. 11D. In some embodiments, the first transition sequence is displayed according to a non-linear transition curve relative to a duration of the gaze (and, optionally, wherein the transition sequence is optionally an animation of the transition of the visual appearance of the first virtual object), such as a non-linear curve that defines and/or is defined by a relationship between an amount of change of size of virtual object 1101 as a function of an amount of time that gaze 1111 is directed to virtual object 1101 during the transition in visual appearance from shown in FIG. 11B to as shown in FIG. 11D (e.g., a logarithmic, exponential, piecewise, and/or some other composite curve including one or more of such types of curves).

In some embodiments, as the gaze of the user directed at the first virtual object persists beyond the first time threshold (e.g., as described above), and in response to the computer system detecting that the gaze of the user has been directed at the first virtual object beyond the first time threshold, changing the visual appearance of the first virtual object from the first visual appearance of the first virtual object to the second visual appearance of the first virtual object is includes displaying a first transition sequence on the first virtual object. For example, the first visual appearance of the first virtual object optionally includes one or more visual contents that is also common to the second visual appearance of the first virtual object. The first transition sequence associated with changing the visual appearance of the first virtual object from the first visual appearance of the first virtual object to the second visual appearance of the first visual appearance optionally includes movement of the one or more visual contents within the displayed region occupied by the first virtual object (e.g., the third visual appearance of the first virtual object appears to display a shifting of visual contents within the displayed region occupied by the first virtual object). In some embodiments, the first transition sequence is not limited to an array of unique movements of the one or more visual contents within the displayed region occupied by the first virtual object. In some embodiments, the first transition sequence corresponds to set of changes characterized by fading, flipping, and/or color shifting (e.g., within the displayed region occupied by the first virtual object) of the one or more visual contents (e.g., common to the first visual appearance of the first virtual object and the second visual appearance of the first virtual object). In some embodiments, the rate of transition for the changes to the visual appearance of the first virtual object, from the first visual appearance of the first virtual object to the second visual appearance of the first virtual object, under the first transition sequence is not constant (e.g., is varied or variable). In some embodiments, as the duration for which the gaze of the user is directed at the first virtual object increases, the changes to the visual appearance of the first virtual object, from the first visual appearance of the first virtual object to the second visual appearance of the first virtual object, occur at a non-linear rate and/or according to a non-linear transition curve relative to the duration of the gaze. For example, the non-linear transition curve refers to the behavior of the changes to the visual appearance determined based on the relationship of time (e.g., X-axis) vs changes (e.g., or frame rate of the transition) for the visual appearance (e.g., Y-axis). In some embodiments, the non-linear transition curve represents an uneven spread of the changes to the visual appearance of the first virtual object over the duration of the transition sequence. In some embodiments, the movements of the one or more visual contents within the displayed region occupied by the first virtual object (e.g., changes to the visual appearance of the first virtual object) is concentrated at the beginning of the transition sequence while the end of the transition sequence includes minimal movements of the one or more visual contents within the displayed region occupied by the first virtual object. Changing a visual appearance of a virtual object at variable rates enables a progressive confirmation and/or selection of the virtual object via gaze, thereby reducing errors in the interaction between the user and the computer system, providing visual feedback as a result of such interaction, and facilitating more efficient user interaction with the content (e.g., less overall time spent providing selection inputs), thereby conserving computing resources associated with correcting erroneous input from the user.

In some embodiments, changing the visual appearance of the first virtual object from the first visual appearance of the first virtual object to the second visual object comprises, in accordance with a determination that a size of the first virtual object is a first size, displaying the first transition sequence according to a first rate of transition over time, such as the size of virtual object 1101 and the corresponding rate of transition of virtual object 1101 from as shown in FIG. 11B to as shown in FIG. 11D. In some embodiments, changing the visual appearance of the first virtual object from the first visual appearance of the first virtual object to the second visual object comprises, in accordance with a determination that the size of the first virtual object is a second size, different from the first size, displaying the first transition sequence according to a second rate of transition over time, different from the first rate of transition over time, such as the size of virtual object 1109 and the corresponding rate of transition of virtual object 1109 from as shown in FIG. 11L to as shown in FIG. 11M. In some embodiments, the rate of transition (e.g., or the rate of transition over time) refers to the change to the visual appearance (measured in number of displayed frames changes such as 10 or 30 frames or a given amount of progression-such as 1, 3, 5, 20, 30 or 50 percent of the total frame changes) of the first virtual object (e.g., or the second virtual object) over a unit of time (e.g., 1 second). As described herein, in some embodiments, the rate of transition over time for the changes to the visual appearance of the first virtual object (e.g., or frame rate of the first transition sequence), from the first visual appearance of the first virtual object to the second visual appearance of the first virtual object, under the first transition sequence is not constant (e.g., is varied or variable, ranging between 10 fps to 30 fps, or a given amount of progression-such as 1, 3, 5, 20, 30 or 50 percent-through the transition sequence for a unit of time). In some embodiments, the instantaneous rate of transition over time for the changes to the visual appearance of the first virtual object (e.g., or frame rate of the first transition sequence), from the first visual appearance of the first virtual object to the second visual appearance of the first virtual object, while the gaze of the user is directed at the first virtual object, is a function of size. For example, as the duration for which the gaze of the user is directed at the first virtual object increases and the size of the visual appearance of the first virtual object increases, the changes to the visual appearance of the first virtual object occur (e.g., or frame rate of the first transition sequence), from the first visual appearance of the first virtual object to the second visual appearance of the first virtual object, at an increasing rate of transition. Changing a visual appearance of a virtual object at variable rates in accordance with a size of the virtual object enables a progressive confirmation and/or selection of the virtual object via gaze, thereby reducing errors in the interaction between the user and the computer system, providing visual feedback as a result of such interaction, and facilitating more efficient user interaction with the content (e.g., less overall time spent providing selection inputs), thereby conserving computing resources associated with correcting erroneous input from the user.

In some embodiments, the changing of the visual appearance of the first virtual object from the second visual appearance of the first virtual object to the third visual appearance of the first virtual object includes displaying a first transition sequence from the second visual appearance of the first virtual object to the third visual appearance of the first virtual object, such as the transition between display virtual object 1101 from as shown in FIG. 11D to as shown in FIG. 11F. In some embodiments, the first transition sequence is displayed according to a non-linear transition of animation progress relative to a duration of gaze (and, optionally, wherein the transition sequence is optionally an animation of the transition of the visual appearance of the first virtual object), such as a non-linear curve that defines and/or is defined by a relationship between an amount of change of size of virtual object 1101 as a function of time that gaze 1111 of virtual object 1101 from shown in FIG. 11D to as shown in FIG. 11F. In some embodiments, as the gaze of the user directed at the first virtual object persists beyond the second time threshold (e.g., associated with changing the visual appearance of the first virtual object from the second visual appearance of the first virtual object to the third visual appearance of the first virtual object), and in response to the computer system detecting that the gaze of the user has been directed at the first virtual object beyond the second time threshold, changing the visual appearance of the first virtual object from the second visual appearance of the first virtual object to the third visual appearance of the first virtual object is includes displaying a first transition sequence. In some embodiments, the rate of transition for the changes to the visual appearance of the first virtual object, from the second visual appearance of the first virtual objects to the third visual appearance of the first virtual objects, under the first transition sequence is not constant (e.g., is varied or variable). In some embodiments, as the duration for which the gaze of the user is directed at the first virtual object increases, the changes to the visual appearance of the first virtual object occur at a non-linear rate and/or according to a non-linear transition curve of animation progress relative to the duration of the gaze. For example, the non-linear transition curve of animation progress refers to the behavior of the changes to the visual appearance determined based on the relationship of time (e.g., X-axis) vs changes (e.g., or frame rate of the transition) to the visual appearance (e.g., Y-axis). In some embodiments, within a first period of time (e.g., 0.02, 0.05, 0.1, 0.2, 0.25, 0.3, 0.5, 1, 2 or 5 seconds) following the starting moment of the visual appearance of the first virtual object changing, the associated animation progresses at a first rate of transition. In some embodiments, within a second period of time (e.g., 0.02, 0.05, 0.1, 0.2, 0.25, 0.3, 0.5, 1, 2 or 5 seconds) following the starting moment of the visual appearance of the first virtual object changing, different from the first period of time, but having the same length as the first period of time, the associated animation progresses at a second rate of transition, greater than the first rate of transition. Changing a visual appearance of a virtual object at variable rates enables a progressive confirmation and/or selection of the virtual object via gaze, thereby reducing errors in the interaction between the user and the computer system, providing visual feedback as a result of such interaction, and facilitating more efficient user interaction with the content (e.g., less overall time spent providing selection inputs), thereby conserving computing resources associated with correcting erroneous input from the user.

In some embodiments, changing the visual appearance of the first virtual object from the first visual appearance of the first virtual object to the second visual appearance of the first object comprises, in accordance with a determination that a size of the first virtual object is a first size, displaying the first transition sequence according to a first rate of transition over time, such as the rate of transition in visual appearance of virtual object 1101 from as shown in FIG. 11D to as shown in FIG. 11F. In some embodiments, changing the visual appearance of the first virtual object from the first visual appearance of the first virtual object to the second visual appearance of the first object comprises, in accordance with a determination that the size of the first virtual object is a second size, different from the first size, displaying the first transition sequence according to a second rate of transition over time, different from the first rate of transition over time, such as the rate of transition in visual appearance of virtual object 1109 from as shown in FIG. 11M to as shown in FIG. 11N. In some embodiments, the rate of transition (e.g., or the rate of transition over time) refers to the change to the visual appearance (e.g., measured in number of displayed frames changes such as 10 or 30 frames or a given amount of progression-such as 1, 3, 5, 20, 30 or 50 percent of the total frame changes) of the first virtual object (e.g., or the second virtual object) over a unit of time (e.g., 1 second), and the rate of transition over time for the changes to the visual appearance of the first virtual object (e.g., or frame rate of the first transition sequence), from the second visual appearance of the first virtual objects to the third visual appearance of the first virtual objects, under the first transition sequence is not constant (e.g., is varied or variable, ranging between 10 fps to 30 fps, or a given amount of progression-such as 1, 3, 5, 20, 30 or 50 percent-through the transition sequence for a unit of time). In some embodiments, the instantaneous rate of transition over time for the changes to the visual appearance of the first virtual object (e.g., or instantaneous frame rate of the first transition sequence), from the second visual appearance of the first virtual objects to the third visual appearance of the first virtual objects, while the gaze of the user is directed at the first virtual object, is a function of size. For example, as the duration for which the gaze of the user is directed at the first virtual object increases and the size of the visual appearance of the first virtual object increases (e.g., or frame rate of the first transition sequence), the changes to the visual appearance of the first virtual object, from the second visual appearance of the first virtual objects to the third visual appearance of the first virtual objects, occur at an increasing rate of transition. Changing a visual appearance of a virtual object at variable rates in accordance with a size of the virtual object enables a progressive confirmation and/or selection of the virtual object via gaze, thereby reducing errors in the interaction between the user and the computer system, providing visual feedback as a result of such interaction, and facilitating more efficient user interaction with the content (e.g., less overall time spent providing selection inputs), thereby conserving computing resources associated with correcting erroneous input from the user.

In some embodiments, the first virtual object is displayed in a scrollable user interface region, such as virtual object 1108 as shown in FIG. 11S. In some embodiments, in response to (and/or while) detecting the gaze of the user directed to the first virtual object, in accordance with a determination that the first virtual object is partially displayed while being displayed in the scrollable user interface region, such as virtual object 1108 as shown in FIG. 11S, the computer system scrolls the user interface region, such as the scrolling of virtual object including virtual object 1108 from as shown in FIG. 11S to as shown in FIG. 11T, wherein the user interface region is scrolled prior to changing the visual appearance of the first virtual object from the first visual appearance of the first visual object to the second visual appearance of the first visual object, such as the change in visual appearance of virtual object 1108 from as shown in FIG. 11S to as shown in FIG. 11T. In some embodiments, as described herein, such as in relation to methods 800 and 1000, the computer system displays one or more virtual objects within the three-dimensional environment, such as the environments of the methods 800 and/or 1000, in a user interface region that is scrollable (e.g., the scrollable interface region includes multiple virtual objects some of which are fully displayed, some of which are partially displayed, and some of which are not displayed and are not displayed until the user interface region is scrolled). In some embodiments, the first virtual object is only partially displayed (e.g., in the scrollable user interface region). In some embodiments, the computer system optionally detects the gaze of the user directed at the first virtual object that is partially displayed (e.g., to the portion of the first virtual object that is visible to the user) the scrollable user interface region. In some embodiments, the computer system scrolls the user interface region so that the first virtual object is optionally fully displayed (e.g., fully visible to the user) before transitioning to display the first virtual object in any of the first, second, or third visual appearance, as described herein. In some embodiments, the computer system scrolls the user interface region so that the first virtual object is optionally more visible but is still partially displayed before transitioning to display the first virtual object in any of the first, second, or third visual appearance, as described herein. In some embodiments, while the first virtual object is partially displayed, in response to detecting that the gaze of the user directed at the first virtual object, the computer system scrolls the scrollable user interface region (e.g., to fully display the first virtual object or increase visibility of the first virtual object while still being partially displayed) at a respective speed that is based on a location of the gaze of the user relative to the edge of the scrollable user interface region and/or the type of content associated with the first virtual object, as described herein. In some embodiments, the computer system determines that the user is reading and/or scanning the first virtual object based on the gaze of the user and its related movement(s), and optionally scrolls the scrollable user interface region (e.g., to fully display the first virtual object or increase visibility of the first virtual object while still being partially displayed) at a respective speed, as described herein. In some embodiments, the computer system determines lack of movement of the gaze of the user (e.g., the computer system no longer detects movement of the gaze directed to the scrollable user interface region), and in response, the computer system ceases scrolling the scrollable user interface region. Scrolling a scrollable user interface region in response to a gaze of a user being directed at the virtual object that is partially displayed in the scrollable user interface region provides confirmation that the user intends to fully view the first virtual object, thereby reducing errors in the interaction between the user and the computer system (e.g., avoiding unintentional scrolling due to unintentional gaze) and reducing inputs needed to correct such errors and conserving computing resources associated with correcting erroneous input from the user.

In some embodiments, the first visual appearance of the first virtual object, the second visual appearance of the first virtual object, and/or the third visual appearance of the first virtual object are customizable (e.g., based on user input or based on one or more settings or options selected by an application or application developer when creating the application), such as the visual appearance of virtual object 1109 that is defined in accordance with one or more settings and/or options, which optionally define the size with which virtual object 1109 is displayed as shown in FIG. 11L through FIG. 11N. In some embodiments, the manner (e.g., the first visual appearance, the second visual appearance, and/or the third visual appearance) in which the computer system displays one or more virtual objects, including the first virtual object (e.g., and/or the second virtual object), within the three-dimensional environment, such as the environments of the methods 800 and/or 1000, is customizable. In some embodiments, the size and/or shape of the first virtual object (e.g., and/or the second virtual object), displayed according to their corresponding visual appearance, are customizable. In some embodiment, the visual appearance of the first virtual object (e.g., and/or the second virtual object) is predetermined according to system settings In some embodiments, the computer system settings (e.g., the settings app) include one or more options (e.g., or menus) for customization of any of the aforementioned elements (e.g., the device settings have one or more menus dedicated for the visual appearance of virtual objects its associated animation sequence). In some embodiments, the computer system receives the customizations through an initial user profile setup prior to first user or after resetting the system settings. In some embodiments, the first visual appearance of the first virtual object, the second visual appearance of the first virtual object, and the third visual appearance of the first virtual object (e.g., associated with an application) are defined by the corresponding application developer. In some embodiments, in the event that the first virtual object is associated with a first application, the first visual appearance of the first virtual object, the second visual appearance of the first virtual object, and the third visual appearance of the first virtual object correspond to a first set of visual appearances defined by the first application. Alternatively, in the event that the first virtual object is associated with a second application, different from the first application, the first visual appearance of the first virtual object, the second visual appearance of the first virtual object, and the third visual appearance of the first virtual object correspond to a second set of visual appearances, different from the first visual appearances, defined by the second application.

Customizing a visual appearance of a virtual object according to user inputs or application settings (e.g., or predetermining the visual appearance of the virtual object according to system settings) provides an efficient user experience, thereby facilitating more efficient user interaction with the content (e.g., less overall time spent interacting with the user interface).

It should be understood that the particular order in which the operations in method 1200 have been described is merely exemplary and is not intended to indicate that the described order is the only order in which the operations could be performed. One of ordinary skill in the art would recognize various ways to reorder the operations described herein. In some embodiments, aspects/operations of method 1200 may be interchanged, substituted, and/or added between these methods. For example, various object manipulation techniques and/or object movement techniques of method 1200 is optionally interchanged, substituted, and/or added between these methods. For brevity, these details are not repeated here.

FIGS. 13A-13HH illustrate exemplary ways in which a computer system displays animations in accordance with animation curves. The user interfaces in FIGS. 13A-13HH are used to illustrate the processes described below, including the processes in FIG. 14.

FIG. 13A illustrates a computer system 101 (e.g., an electronic device) displaying, via a display generation component 120 (e.g., display generation components 1-122a and 1-122b of FIG. 1), a three-dimensional environment 1300 from a viewpoint of a user of the computer system 101. In FIG. 13A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 13A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1300. For example, three-dimensional environment 1300 includes representations of the rear and side walls of the room in which the computer system 101 is located.

As discussed in further detail below, in FIG. 13A, display generation component 120 is illustrated as displaying one or more virtual objects in the three-dimensional environment 1300. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 13A-13HH.

Display generation component 120 has a field of view (e.g., a field of view captured by external image sensors 114b and 114c and/or visible to the user via display generation component 120) that corresponds to the virtual objects shown in FIG. 13A. Because display generation component 120 is optionally a head-mounted device, the field of view of display generation component 120 is optionally the same as or similar to the field of view of the user.

In some embodiments, a user interface illustrated and described below is also implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method 1400), or via a trackpad from hand 406, and inputs described herein are optionally received via the trackpad or via air gestures/attention.

In FIG. 13A, three-dimensional environment 1300 includes a plurality of virtual objects, such as user interfaces and/or user interface elements. For example, in FIG. 13A, virtual objects 1304 and 1306, selectable option 1316, and visual indication 1318 are displayed in three-dimensional environment 1300. In some embodiments, the virtual objects are optionally components of a user interface or window of an application such as a reading application, a media content application, a platform control application, or other application described with reference to method(s) 800, 1000, 1200, 1400, and/or 1600. For example, virtual object 1306 optionally is a user interface for a software application such as a media content browsing and/or playback application. In FIG. 13A, virtual object 1306 includes artwork, animations, and/or media corresponding to applications that available for launching at computer system 101 and/or a carousel element indicating that a user of computer system 101 is able to scroll (e.g., horizontally or vertically) to browse for available content.

Virtual object 1306 in FIG. 13A include a plurality of virtual objects, such as virtual object 1314a, virtual object 1341b, and virtual object 1314c. In some embodiments, the plurality of virtual objects are or include one or more images, pieces of text, graphics, animations, instances of media (e.g., prerecorded, live, and/or artificially intelligently generated media), and/or additional or alternative visual effects such as a blurring effect of content included in a virtual object and/or a light effect including increasing of a brightness and/or contrast of some or all of the virtual object, and/or some combination of such content and/or visual effects. In FIG. 13A, virtual objects 1314a through 1314c are displayed with respective “initial appearance states” as described with reference to method 1400. For example, in FIG. 13A, virtual object 1314a includes respective first text (e.g., “Arctic”), virtual object 1314b includes respective first text (e.g., “Cooking Show”), and virtual object 1314c includes respective first text (e.g., “Robo Hero”). In some embodiments, virtual objects 1314a through 1314c correspond to representations of applications and/or immersive experiences available for launching at computer system 101. In some embodiments, in response to detecting selection of a virtual object such as one or more of the inputs described with reference to method 1400 and/or FIG. 13V, computer system 101 displays a user interface for initiating playback of media such as a landing page for an immersive content series that correspond to the selected virtual object, initiates display of a virtual object corresponding to a selected application, initiates display of a user interface to purchase the selected application, and/or performs an additional or alternative function.

In some embodiments, computer system 101 displays one or more control interfaces that are selectable to initiate performance of operations related to a function of virtual object 1306 and/or a function of computer system 101. For example, selectable option 1316 is optionally a “grabber” as described with reference to method 1400 as shown in FIG. 13A. In some embodiments, in response to detecting selection input such as described with reference to FIG. 13V (e.g., contacting of a plurality of fingers included in an air pinch gesture while attention of the user is directed to selectable option 1316), computer system 101 initiates movement of virtual object 1306 in three-dimensional environment 1300 based on movement of an input element, such as the input element used to perform the air gesture including the plurality of fingers in contact, movement of a finger or object across a trackpad, and/or movement of a joystick.

In some embodiments, visual indication 1318 is displayed concurrently with virtual object 1306 and selectable option 1316, such as shown in FIG. 13A. In some embodiments, visual indication 1318 is at least temporarily not displayed and/or is displayed with a level of visual prominence that is reduced relative to baseline level of visual prominence while attention of the user is not directed to selectable option 1316 and/or is not directed to a region surrounding selectable option 1316, such as within a threshold distance of selectable option 1316 (e.g., 0, 0.05, 0.1, 0.25, 0.5, 0.75, or 1 m). Visual indication 1318 optionally is selectable to display a plurality of selectable options that are individually selectable to perform additional or alternative operations and/or to cease display of virtual object 1306.

It is understood that a virtual object being “selectable” optionally corresponds to one or more operations performed by computer system 101 relating to the virtual object. For example, while the virtual object is displayed, computer system 101 optionally detects attention of the user is directed to the virtual object and/or user input (e.g., an air gesture is detected, contacting of a trackpad, pressing of a button, and/or an air gesture moves to within a threshold distance of the virtual object as described with reference to method 1400). In response to detecting the attention and/or user input, computer system 101 optionally performs one or more operations corresponding to the virtual object. For example, user interface element 1312a in FIG. 13A optionally is selectable to search for content which computer system 101 is able to play back and/or applications that computer system 101 is able to purchase and/or launch. Additionally or alternatively, in FIG. 13A, virtual object 1320b is optionally selectable to display a home screen of the user interface illustrated in virtual object 1306. Additionally or alternatively, in FIG. 13A, user interface element 1320c is optionally selectable to display a representation of a plurality of content browsing instances such as different browsing windows corresponding to a same software application (e.g., an application store application, a media browsing application, and/or a web browsing application). Additionally or alternatively, in FIG. 13A, user interface element 1320d is optionally selectable to display content that corresponds to a category, such as a sports live streaming category, content produced by a company that has constructed computer system 101, and/or content that is available for purchase, in virtual object 1306.

FIG. 13A further illustrates computer system 101 displaying virtual object 1304 concurrently with virtual object 1306. As described further below, virtual object 1304 optionally has one or more characteristics that are the same as one or more characteristics described with reference to virtual object 1306. Additionally or alternatively, virtual object 1304 optionally has characteristics that differ from those described with reference to virtual object 1306. For example, virtual object 1304 in FIG. 13A optionally corresponds to a media browsing user interface, whereas virtual object 1306 optionally corresponds to an application browsing and/or purchasing user interface and/or a user interface for a gallery of third-party immersive environments. Virtual object 1304 in FIG. 13A includes a selectable option 1308, which is optionally selectable to initiate a search for content to play back at computer system 101. Additionally or alternatively, selectable option 1310 is optionally a visual indication of a user profile that is logged in to computer system 101 and/or an application represented in virtual object 1304, such as a user profile for consuming subscription media content.

In some embodiments, computer system 101 displays one or more animations in accordance with an animation curve in response to detecting attention is directed to a virtual object, such as described with reference to method 1400. In FIG. 13A, attention of the user is directed to a location in three-dimensional environment 1300 that is not illustrated, and/or does not overlap with nor correspond to a respective virtual object. Animation curve 1320 in FIG. 13A is representative of an exemplary animation curve for displaying the one or more animations, including a time axis corresponding to an independent axis and an axis associated with one or more visual properties of the virtual object, corresponding to a dependent axis. Progression of the animation curve, represented along the dependent axis, optionally represents the amount of change of one or more visual characteristics and/or visual properties of content included in a given virtual object, as described with reference to method 1400. In some embodiments, the dependent axis corresponds to a normalized value of progress of the animation relative to a final visual appearance state. For example, when the animation is not ongoing, the value of the dependent axis is optionally 0. When the animation is complete and computer system 101 is displaying the virtual object with a final visual appearance state, the value of the dependent axis is optionally 1. When the animation is ongoing and the visual properties of the virtual object have not yet reached the final visual appearance state, the value along the animation curve is optionally less than 1. When the animation is ongoing and the visual properties exceed the final visual appearance state (e.g., the virtual object is bigger and/or displayed with a brightness that exceeds a brightness included in the visual state), the value along the animation curve is optionally greater than 1.

The progression, for example, optionally corresponds to a progress of changes in values of one or more visual properties (e.g., height, width, brightness, change along a saturation curve, change along a brightness curve, and/or a percentage of the virtual object that is consumed by text). As described in greater detail below, as computer system 101 detects attention of the user remain directed to a virtual object, computer system 101 optionally displays an animation, which optionally includes advancing the progress indicator 1322 along animation curve 1320 through a first portion 1324a, a first transition 1326a, a second portion 1324b, a second transition 1326b, and/or a final appearance corresponding to third portion 1324c. In FIG. 13A, because attention of the user is not directed to a particular user interface that is responsive to attention, progress indicator 1322 is aligned with at first value of the animation curve 1320 (e.g., at the origin of the axes).

FIG. 13B illustrates attention 1328 of a user of computer system 101 directed to virtual object 1314a. From FIG. 13A to FIG. 13B, a first portion of the animation is ongoing (e.g., the animation initiated when the computer system 101 detected the attention of the user move to virtual object 1314a), which optionally includes changing a size of virtual object 1314a. In FIG. 13B, attention 1328 has been directed to virtual object 1314a for a period of time indicated by the offset of progress indicator 1322 on the time axis relative to the origin of the axes of animation curve 1320 as (e.g., the position of progress indicator 1322 as shown in FIG. 13A). Accordingly, computer system 101 in FIG. 13B displays virtual object 1314a with a size that is greater than the size of virtual object 1314a as shown in FIG. 13A. In this way, the appearance of virtual object 1314a in FIG. 13B is optionally different from the initial appearance of virtual object 1314a (e.g., as shown in FIG. 13A).

It is understood that in general, computer system 101 optionally maintains the appearance state of a virtual object (e.g., forgoes changing the appearance of the virtual object) in accordance with a determination is detected to another virtual object. In FIG. 13B, computer system 101 forgoes display of animation corresponding to virtual objects 1314b and 1314c in accordance with a determination that attention 1328 is not directed to virtual objects 1314b and 1314c (e.g., computer system 101 maintains display of the initial appearance states of virtual objects 1314b and 1314c). In certain embodiments, however, computer system 101 changes the appearance of a plurality of virtual objects concurrently and/or based on a same animation curve in accordance with a determination that the virtual objects belong to a same group and attention targeted a virtual object included in the group, such as a detecting attention directed to an icon included in a cluster of application icons that are included in a group of icons that are being targeted by attention 1328.

In FIG. 13C, computer system 101 displays virtual object 1314a with a size greater than as shown in FIG. 13B. For example, because attention 1328 remains directed to virtual object 1314a, computer system 101 optionally continues to animate a gradual increase in size of virtual object 1314a from FIG. 13A to FIG. 13B, and from FIG. 13B to FIG. 13C, as indicated by the movement of progress indicator 1322 along first portion 1324a of animation curve 1320. For example, the height and/or width of virtual object 1314a optionally increases at an amount over time that corresponds to a constant rate per unit of time corresponding to the slope of first portion 1324a. It is understood that additionally or alternatively, computer system 101 optionally displays visual effects in accordance with the first portion 1324a, such as a gradual increasing in opacity of one or more colors displayed around a border of virtual object 1314a and/or within virtual object 1314a.

In FIGS. 13A through 13C, computer system 101 optionally determines the appearance, and/or displays virtual object 1314a with an appearance, based on an initial appearance state and an intermediate appearance state. For example, as described in greater detail with reference to method 1400, a process associated with a virtual object, such as a process performed by an application running at computer system 101 optionally communicates the initial appearance state of virtual object 1314a (e.g., “Arctic” at a first size immediately before the animation is initiated) and/or a first intermediate appearance state (e.g., “Arctic” at a second size, greater than the first size at a time corresponding to first transition 1326a) to computer system 101. In some embodiments, computer system 101 determines the amount of change to one or more visual properties, such as a change in height, width, brightness, and/or contrast of virtual object 1314a, required to interpolate between the appearance states and/or displays the animation based on the results of the interpolation.

In some embodiments, while displaying the animation (e.g., as shown in FIGS. 13B, 13C, and/or in additional or alternatives Figures described further below), the computer system detects attention of the user move away from a virtual object that is being animated, such as virtual object 1314a in FIGS. 13B and 13C. In some embodiments, in response to detecting the attention move away from the virtual object, computer system 101 ceases display of the animation and reverts the appearance of the virtual object to correspond to an initial appearance state (e.g., the appearance of virtual object 1314a as shown in FIG. 13A).

In FIG. 13D, computer system 101 displays virtual object 1314a with a size greater than as shown in FIG. 13C and with different content than as shown in FIG. 13C. From FIG. 13C to FIG. 13D, progress indicator 1322 has transitioned from first portion 1324a of animation curve 1320 to second portion 1324b of animation curve 1320. In some embodiments, second portion 1324b of animation curve 1320 includes one or more non-linear portions. Accordingly, the rate of change of virtual object 1314a changes by one or more amounts per unit of time that are relatively greater in the second portion 1324b of the animation than in the first portion 1324a of the animation. For example, the height and/or width of virtual object 1314a optionally is increasing at a first rate from first transition 1326a to the time shown in FIG. 13D. The first rate is optionally greater than a rate of increase of height and/or width of virtual object 1314a from as shown in FIG. 13B to as shown in FIG. 13C.

In FIG. 13D, the animation based on animation curve 1320 also includes display of information 1320f, corresponding to an animation, prerecorded media, and/or live media generated by a process associated with a developer of the application corresponding to virtual object 1314a as described in greater detail with reference to method 1400. Additionally, in FIG. 13D, computer system 101 displays information at a rate over time that is relatively greater than during the first portion 1324a of the animation. For example, as shown in FIG. 13D, computer system 101 displays text (e.g., “Explore the Arctic with Guy”) more quickly over the period of time from the first transition 1326a to as shown in FIG. 13D, as compared to the rate of new information displayed from FIG. 13B to FIG. 13C (e.g., if computer system 101 animated virtual object 1314a to include text during such a transition (e.g., “Explore”)).

As described above, second portion 1324b of animation curve 1320 includes one or more non-linear portions. For example, as shown in FIG. 13D, second portion 1324b includes an inflection point at which concavity (e.g., a derivative of a function representing second portion 1324b) changes from a positive value to a negative value. It is understood that the non-linearities can vertical discontinuities, changing in concavity one or more times, changes in a mathematical function (e.g., from a linear to a cubic function), and/or some combination of additional or alternative changes in animation curve 1320 as described with reference to method 1400.

From FIG. 13D to FIG. 13E, computer system 101 continues to display the animation of virtual object 1314a while attention 1328 remains directed to virtual object 1314a. As shown in FIG. 13E, the progress of animation curve 1320 peaks, or is nearly at a peak. Accordingly, virtual object 1314a optionally includes an amount of information greater than any other amount of information displayed in accordance with any other portion of the animation (e.g., including information 1320f). For example, virtual object 1314a in FIG. 13E is optionally bigger than any other size that will be or was assumed during display of the animation (e.g., before FIG. 13E or after FIG. 13E).

From FIG. 13E to FIG. 13F, computer system 101 continues to display continues to display the animation of virtual object 1314a while attention 1328 remains directed to virtual object 1314a. As shown in FIG. 13F, progress indicator 1322 moves along the time axis of animation curve 1320, and the changes in visual appearance that were introduced when animating along the first portion of animation curve 1320 through as shown in FIG. 13E begin to transition toward a final visual appearance state. For example, computer system 101 displays virtual object 1314a in FIG. 13F with a size that is less than as shown in FIG. 13E.

From FIG. 13F to FIG. 13G, computer system 101 displays virtual object 1314a with a final visual appearance state. As described in further detail with reference to method 1400, computer system 101 optionally displays user interface elements and/or virtual objects with visual appearance that differs from the initial appearance state at a conclusion of the animation. In some embodiments, the visual appearance at the appearance state of the virtual object is at least temporarily maintained after the animation concludes.

As described with reference to first transition 1326a and/or method 1400, second transition 1326b optionally corresponds to an intermediate or final appearance state of virtual object 1314a. Third portion 1324c optionally corresponds to a steady state and final visual appearance of virtual object 1314a after the animation has concluded, which is based on the final appearance state of virtual object 1314a. In some embodiments, the appearance state of virtual object 1314a at the conclusion of the animation is defined by a process associated with a developer of an application corresponding to virtual object 1314a. Virtual object 1314a, for example, is displayed with a size in FIG. 13G that is different from as shown in FIG. 13A, and/or is different from (e.g., less than, or greater than) as shown in FIG. 13F, because animation progress as indicated by progress indicator 1322 has moved beyond the second transition 1326b, into the third portion 1324c of animation curve 1320.

In some embodiments, while attention remains directed to virtual object 1314a, and/or before attention has moved away from virtual object 1314a for a period of time greater than threshold 1334 as shown in the off-target time 1332, computer system 101 optionally maintains display of virtual object 1314a as shown in FIG. 13G. In some embodiments, computer system 101 continues to display an animation and/or live video, such as indicated by information 1320f (e.g., video of a bear moving across an arctic tundra) while displaying virtual object 1314a with the final visual appearance state. Additionally or alternatively, at the conclusion of the animation, some or all of the information displayed during the animation, such as text included in virtual object 1314a remains displayed in virtual object 1314a, as shown in FIG. 13G.

From FIGS. 13G to 13H, computer system 101 detects attention 1328 of the user move away from virtual object 1314a and displays virtual object 1314a with an initial state appearance in accordance with a determination that the amount of time that attention has remained away from virtual object 1314a is greater than threshold 1334. For example, from FIG. 13G to FIG. 13H, attention 1328 is not directed to virtual object 1314a for some period of time, indicated by off-target time 1332 less than threshold 1334. From FIG. 13H to FIG. 13I, attention 1328 is not directed to virtual object 1314a for some period of time, indicated by off-target time 1332, greater than threshold 1334. Because off-target time 1332 is greater than threshold 1334, computer system 101 displays virtual object 1314a with the initial appearance state, as described with reference to method 1400. In other embodiments, computer system 101 displays virtual object 1314a with the initial appearance state immediately in response to detecting attention 1328 move away from virtual object 1314a.

FIGS. 13J through 13M illustrates computer system 101 detecting attention 1328 directed to virtual object 1314b, and in response, displaying an animation that visually differs from the animation of virtual object 1314a using a same animation curve used to display the animation of virtual object 1314a. In some embodiments, computer system 101 uses a same animation curve to display animations of different virtual objects, as described in greater detail with reference to method 1400. In some embodiments, the virtual objects are similar, such as virtual object 1314a being included in a same user interface as virtual object 1314b. Additionally or alternatively, the virtual objects are different, such as virtual object 1314a being animated with an animation curve that is shared between different types of virtual objects as described with reference to FIG. 13HH. For example, virtual object 1314a optionally changes in visual appearance that are the same as rates of change of a search icon, a messaging notification, a current status of a user of a different computer system than computer system 101, and/or additional or alternative content. It is understood that the animation illustrated and described with reference to FIGS. 13J through 13M optionally applies to such types of virtual objects.

FIG. 13J illustrates computer system 101 displaying virtual object 1314b with an appearance that differs from an initial appearance state of virtual object 1314b, such as the initial appearance state of virtual object 1314b as shown in FIG. 13A. FIG. 13J illustrates attention 1328 of the user of computer system 101 directed to virtual object 1314b. From FIG. 13I to FIG. 13J, the first portion of the animation is ongoing based on first portion 1324a of animation curve 1320, which optionally includes changing a size of virtual object 1314b. In FIG. 13J, attention 1328 has been directed to virtual object 1314b for the period of time indicated by the offset of progress indicator 1322 on the time axis relative to the position of progress indicator 1322 as shown in FIG. 13I. Accordingly, computer system 101 in FIG. 13J displays virtual object 1314b with a size that is greater than the size of virtual object 1314b as shown in FIG. 13I. In this way, the appearance of virtual object 1314a in FIG. 13J is optionally different from the initial appearance state of virtual object 1314a (e.g., as shown in FIGS. 131 and/or 13A). In FIG. 13J, computer system 101 forgoes display of animation corresponding to virtual objects 1314a and 1314c in accordance with a determination that attention 1328 is not directed to virtual objects 1314a and 1314c (e.g., computer system 101 maintains display of the initial appearance states of virtual objects 1314a and 1314c).

In FIG. 13K, computer system 101 displays virtual object 1314b with a size greater than as shown in FIG. 13J. For example, computer system 101 optionally continues to animate a gradual increase in size of virtual object 1314b from FIG. 13I to FIG. 13J, and from FIG. 13J to FIG. 13K, as indicated by the linear movement of progress indicator 1322 along first portion 1324a of animation curve 1320. In some embodiments, the rate of progress is the same as the first portion 1324a described with reference to FIGS. 13A through 13C. In FIG. 13I through FIG. 13K, computer system 101 optionally determines the appearance and/or displays virtual object 1314b with an appearance based on an interpolation between the initial appearance state of virtual object 1314b and/or an intermediate appearance state. For example, as described in greater detail with reference to method 1400, a developer of the application that corresponds to virtual object 1314b optionally communicates the initial appearance state (e.g., “Cooking Show” at a first size) and/or a first intermediate appearance state (e.g., “Cooking Show” at a second size, greater than the first size) to computer system 101. Computer system 101 optionally receives the indication(s), determines a manner to interpolate between the initial appearance state and the first intermediate appearance state, and/or displays the animation between the initial appearance state and the first intermediate appearance state, as illustrated by the interpolated user appearance of virtual object 1314b in FIG. 13J and FIG. 13K.

In FIG. 13K, computer system 101 displays virtual object 1314b with a size greater than as shown in FIG. 13J and with different content than as shown in FIG. 13J. From FIG. 13J to FIG. 13K, progress indicator 1322 has transitioned from first portion 1324a of animation curve 1320 to second portion 1324b of animation curve 1320. In FIG. 13K, computer system 101 displays information at a rate over time that is relatively greater than during the first portion 1324a of the animation. For example, as shown in FIG. 13K, computer system 101 displays text (e.g., “Cook with Julia”) at a first rate over a period of time from the first transition 1326a to the time corresponding to the position of progress indicator 1322 as shown in FIG. 13L. The first rate is optionally greater than a second rate of display of new information, corresponding to the rate at which new information is displayed from FIG. 13I to FIG. 13J (e.g., if computer system 101 animated virtual object 1314b to include text during such a transition (e.g., “Cook”)).

From FIG. 13K to FIG. 13L, computer system 101 continues to display the animation of virtual object 1314b while attention 1328 remains directed to virtual object 1314b. As shown in FIG. 13L, the progress of animation curve 1320 peaks, or is nearly at a peak. Accordingly, virtual object 1314b optionally includes an amount of information greater than any other amount of information displayed in accordance with any other portion of the animation. For example, virtual object 1314b in FIG. 13L is optionally bigger than any other size that will be or was assumed during display of the animation (e.g., before FIG. 13L or after FIG. 13L). From FIG. 13L to FIG. 13M, computer system 101 advances the animation based on animation curve 1320, displaying virtual object 1314b with a final appearance state in accordance with the determination that progress of the animation reaches the third portion 1324c of animation curve 1320.

From FIG. 13M to FIG. 13N, attention 1328 is not directed to virtual object 1314b for some period of time, indicated by off-target time 1332 less than threshold 1334. Accordingly, computer system 101 maintains display of virtual object 1314b with the final appearance state corresponding to the third portion 1324c of animation curve 1320, in a manner similar to or the same as described with reference to virtual object 1314a.

FIGS. 13O through 13U illustrate computer system 101 changing characteristics of animation curve 1320 to display animations based on inputs directed to virtual objects. For example, computer system 101 optionally uses a time-compressed version of animation curve 1320 to display animations in response to detecting input such as an object contacting a trackpad and/or a portion of a body of the user move within a threshold distance of a virtual object, as described in greater detail with reference to method 1400. In this way, type(s) of input that add precision as to a target of attention of the user optionally results in display of an animation that is based on an accelerated version of the animation curve described with reference to FIGS. 13A through 13N.

In some embodiments, animation curve 1338 is similar to, but different from animation curve 1320. For example, animation curve 1338 in FIG. 13O includes a first portion 1340a (e.g., corresponding to first portion 1324a), a first transition 1326c (e.g., corresponding to first transition 1326a), a second portion 1340b (e.g., corresponding to second portion 1324b), a second transition 1326d (e.g., corresponding to second transition 1326b), and a third portion 1340c (e.g., corresponding to third portion 1324c). Additionally or alternatively, animation curve 1338 includes linear and non-linear portions, similar to those described with reference to animation curve 1320. Additionally or alternatively, animation curve 1338 is based on one or more intermediate appearance states associated with a process that corresponds to a virtual object that is being animated, such as a developer of an application represented by the virtual object.

In FIG. 13O, computer system 101 detects a direct type of input, such as hand 1344 directed to trackpad 1342. In some embodiments, it is understood that additional or direct types of inputs described with reference to method 1400 optionally apply to the description of animation curve 1338 described further below. In FIG. 13O, computer system 101 detects the contact of hand 1344 with trackpad 1342. In response to detecting the contact, computer system 101 optionally displays cursor 1346, as shown in FIG. 13P. In FIG. 13P, computer system 101 has not initiated display of an animation because cursor 1346 does not correspond to the position of a user interface element, such as overlapping with virtual object 1314c.

In FIG. 13Q, computer system 101 has detected input from hand 1344 across trackpad 1342 moving cursor 1346 to correspond to virtual object 1314c (e.g., from FIG. 13P to FIG. 13Q), and in response, optionally initiates display of an animation using animation curve 1338. For example, in FIG. 13Q and in FIG. 13R, progress indicator 1322 moves along first portion 1340a of animation curve 1338, which is a linear portion of animation curve 1338. Based on the animation curve 1338, computer system 101 increases the size of virtual object 1314c from FIG. 13P to FIG. 13Q, and from FIG. 13Q to FIG. 13R.

In some embodiments, if attention of the user was directed to virtual object 1314c, computer system 101 displays the same animation as displayed based on input from hand 1344 directed to trackpad 1342 but based on one or more different rates due to attention-based animations being slower than direct input-based animations. For example, irrespective of the manner of input, computer system 101 optionally displays an animation based on the same appearance states, including the same changes in size and/or other visual characteristics, and/or including display of the same information. The rate of such operations over time and/or the total amount of time required to perform such operations is optionally based on whether attention is directed to virtual object 1314c or a direct type of input is directed to virtual object 1314c.

In FIG. 13S, computer system 101 ceases display of the animation of virtual object 1314c in response to detecting hand 1344 provide input to trackpad 1342 that moves cursor 1346 away from virtual object 1314c. For example, similar to as described with reference to attention above, computer system 101 ceases display of an animation in accordance with a determination input is not directed to a virtual object (e.g., as described with reference to FIGS. 13B and/or 13C). It is understood that when cursor 1346 remains directed to virtual object 1314c, computer system 101 optionally displays the animation using the accelerated animation curve 1338.

FIGS. 13T and 13U illustrates examples of computer system 101 detecting a direct type of input including movement of a portion of a body of the user of computer system 101 and display of an animation using the animation curve described above. In some embodiments, computer system 101 detects direct types of input such as a portion (e.g., a finger) of a user move within a threshold distance 1348 of a virtual object, such as virtual object 1306 and/or virtual object 1314c. In some embodiments, in response to detecting the movement within the threshold distance 1348, computer system 101 performs the operations to initiate, progress, and/or cease an animation using an animation curve that are the same as described with reference to detecting different instances and/or types of the direct input above. For example, in FIG. 13T, computer system 101 detects hand 1344 move to a distance that is beyond threshold 1348 relative to virtual object 1306 and/or virtual object 1314c, and in response, optionally forgoes display of the animation using animation curve 1338 (e.g., does not display) and/or optionally does not display an animation of virtual object 1314c (e.g., as described with reference to hand 1344 and trackpad 1342).

In FIG. 13U, computer system 101 has detected a finger and/or other portions of hand 1344 move within threshold distance 1348 of virtual object 1306 and/or of virtual object 1314c (e.g., from as shown in FIG. 13T to as shown in FIG. 13U). In response, computer system 101 displays the animation using animation curve 1338, in a manner that is the same as described with reference to at least FIG. 13Q but is based on the direct input including the movement of hand 1344 toward virtual object 1314c. For example, in FIG. 13U, virtual object 1314c includes virtual content 1356 (e.g., including a robot model) in accordance with the transition from first portion 1340a to 1340b as the progress indicator 1322 reaches the first transition 1326c of animation curve 1338.

FIG. 13V illustrates a selection input directed toward virtual object 1304 detected by computer system 101 and FIG. 13W illustrates the corresponding changes in level of visual prominence of some or all of virtual object 1304 and/or 1306. In FIG. 13V, computer system 101 detects selection input including attention 1328 directed to virtual object 1304 and an air pinch gesture including contact between fingers of hand 1344. In response to detecting the selection input, computer system 101 changes the level of visual prominence of virtual object 1304 and/or virtual object 1306. For example, in FIG. 13W, computer system 101 has decreased the level of visual prominence of some of virtual object 1306 that was previously virtually obscuring virtual object 1304, and/or increased the level of visual prominence of some of virtual object 1304 that was previously obscured by virtual object 1306 in response to detecting the selection input as shown in FIG. 13V (e.g., increased and/or decreased opacity of the portions of virtual object 1304 and virtual object 1306).

FIGS. 13W through 13AA illustrates the manner by which a process, such as a process run by and/or based on information from an application or media source customizes an animation curve. For example, in FIG. 13W, animation curve 1388 is similar to, but different from the animation curve 1320 (e.g., illustrated with a dashed line linear, quadratic, and steady state portions). In FIG. 13W, animation curve 1388 includes a first portion 1386a (e.g., corresponding to first portion 1324a), a first transition 1326e (e.g., corresponding to first transition 1326a), a second portion 1386b (e.g., corresponding to second portion 1324b), a second transition 1326f (e.g., corresponding to second transition 1326b), and a third portion 1386c (e.g., corresponding to third portion 1324c). First portion 1386a is linear, first portion 1386b is non-linear (e.g., has a change in concavity), and third portion 1386c corresponds to a final visual appearance state. As described in greater detail with reference to method 1400, a process corresponding to “Media 2” optionally defines the duration and/or one or more intermediate states that define animation curve 1388. For example, in FIG. 13W, computer system 101 displays virtual object 1306b, which optionally represents content (e.g., prerecorded, live, and/or generated media content) available for playback at computer system 101. In FIG. 13W, virtual object 1306b is displayed with an initial appearance state that is defined by a content provider (e.g., a broadcast or streaming network and/or a corresponding application for the network).

Virtual objects 1360a and 1360c in FIG. 13W are optionally also displayed with respective initial appearance states, similar to or the same as described with reference to other initial appearance states above. For example, virtual objects 1360a and 1360c optionally correspond to different content providers than the content provider that corresponds to virtual object 1360b.

From FIG. 13W to FIG. 13X, computer system 101 detects attention 1328 remain directed to virtual object 1360b and displays an animation in accordance with animation curve 1388. It is understood that the first portion 1386a optionally has one or more characteristics of other “first portion(s)” of animations and/or animation curves described above. Due to the display of the first portion of the animation, computer system 101 displays virtual object 1360b with a size in FIG. 13X that is bigger than as shown in FIG. 13W.

In FIG. 13Y, computer system 101 detects attention 1328 remain directed to virtual object 1360b, and in response, continues to present the animation in accordance with the progress indicator 1322 (e.g., from FIG. 13X to FIG. 13Y). For example, in FIG. 13Y, computer system 101 is presenting the animation based on an interpolation between an intermediate state corresponding to the first transition 1326e and second transition 1326f, as defined by the content provider for virtual object 1360b, which includes additional text (e.g. #1 Music Game”) and graphics (e.g., musical notes) representative of media that computer system 101 is able to stream in response to detecting selection of virtual object 1360b. In FIG. 13Y, virtual object 1360b is displayed with a size that is bigger than as shown in FIG. 13X in accordance with the appearance based on the intermediate states.

From FIG. 13Y to FIG. 13Z, computer system 101 continues to display the animation of virtual object 1360b, including decreasing the size of virtual object 1360b from as shown in FIG. 13Y to as shown in FIG. 13Z while maintaining display of some of the text and/or icons displayed in earlier portions of the animation. Similarly, from FIG. 13Z to FIG. 13AA, computer system 101 continues to display the animation of virtual object 1360b, including decreasing the size of virtual object 1360b.

In FIG. 13AA, computer system 101 detects input from hand 1358 directed to a button included in computer system 101. It is understood that such input is representative of one or more inputs including and/or different from the selection of the button, such as a voice command, one or more direct or indirect inputs (e.g., as described with reference to method 1400) selecting one or more selectable options from one or more user interfaces, launching of applications, and/or some combination of inputs thereof.

Regardless of the specific manner of input, computer system 101 is optionally capable of displaying a user interface for contacting and/or checking status of a plurality of contacts associated with computer system 101 in response to detecting one or more inputs. For example, in FIG. 13BB, (e.g., in response to detecting input from hand 1358 at the button), computer system 101 displays a user interface 1362 including a plurality of representations of users 1364a, 1364b, 1364c, 1364d, 1364e, and 1364f (e.g., in response to detecting the input shown in FIG. 13AA). In some embodiments, the representations of users 1364a through 1364f correspond to contacts stored in a collection of contacts in memory at computer system 101.

In FIG. 13BB, representations of users 1364a through 1364f include pictures, video, live video, icons, generated graphics, and/or some combination thereof and text including names and/or contact information such as e-mail address corresponding to profiles of each user (e.g., “Mom,” “Lina,” “Adam”, “Jake,” “Alice,” and “Debbie”). In FIG. 13BB, computer system 101 does not display (e.g., forgoes display of) an animation including display of information associated with a particular representation of a user because attention 1328 is not directed to a representation of a user. In FIG. 13CC, computer system 101 detects attention 1328 directed to representation 1346f of a user (e.g., “Debbie”). In response to detecting attention 1328 as shown in FIG. 13CC, computer system 101 displays an animation, such as an animation including display of the information 1366 as shown in FIG. 13DD.

In this way, computer system 101 is capable of displaying an animation to present a status associated with the user that corresponds to representation 1364f. The status, as described with reference to method 1400, optionally includes a status indicative of when the user last used a device owned by the user, such as a device that is similar (e.g., is a headset, mobile phone, and/or laptop) to computer system 101. In some embodiments, as described in greater detail with reference to method 1400, computer system 101 displays an animation of representation 1364f and/or information 1366 based on the same animation curve as described with reference to other virtual objects above. For example, the height and/or width of representation 1364f optionally changes at rates that are the same as virtual object 1314b in response to detecting attention 1328 directed to representation 1364f. It is understood that the same animation curve is optionally used when animating virtual objects such as the content described with reference to FIGS. 13EE through 13GG.

In FIG. 13DD, computer system 101 displays a notification 1368 in response to receiving communication from an electronic device in communication with computer system 101. For example, notification 1368 is displayed in response to receiving a text or electronic message such as an e-mail. In some embodiments, notification 1368 is animated in response to detecting attention 1328 directed to notification 1368 as shown in FIG. 13DD, until displayed with a final appearance state, such as illustrated by notification 1370 (e.g., corresponding to notification 1368) as shown in FIG. 13EE.

In FIG. 13FF, computer system 101 displays a music and/or media consumption user interface included in virtual object 1371 for browsing for and playing back music and/or visual media. In some embodiments, computer system 101 detects attention to a virtual object associated with performing a search function. For example, in FIG. 13FF, computer system 101 detects attention 1328 directed to selectable option 1372 (e.g., corresponding to a search icon). In some embodiments, in response to detecting attention 1328 directed to the virtual object associated with performing the search function, computer system 101 displays an animation including display of suggested search queries that are selectable to initiate performance of one or more searches. For example, from FIG. 13FF to FIG. 13GG, computer system 101 expands the selectable option 1372 in three-dimensional environment 1300 to include a collection of suggested queries 1373 (e.g., “Song 1” and “Artist 1”). In some embodiments, the animation is based on the same animation curve as described with reference to FIG. 13DD and 13EE.

FIG. 13HH illustrates exemplary animation curves that are the same for different types of virtual objects. For example, animation curves 1374a, 1374b, 1374c, and 1374d optionally share a same independent axis (e.g., a time axis) and a same dependent axis (e.g., an animation axis indicative for changes of one or more visual properties of a corresponding virtual object over time). In some embodiments, some or all of the characteristics of animation curves 1374a, 1374b, 1374c, and 1374d are the same as some or all of the characteristics of the animation curves described above, such as animation curve 1320, 1338, and/or 1388. It is understood that computer system 101, as described above, optionally displays animation based on the animation curves described with reference to FIG. 13HH. In FIG. 13HH, a plurality of appearances and/or appearance states are illustrated for each type of virtual object that is depicted. For example, animation curve 1374a illustrates an application icon that progressively changes in size and/or includes a greater or lesser amount of information over the course of the animation. In particular, the icon is displayed with a first size at state 1367a, a second size at state 1378a, a third size and including new information (e.g., text) at state 1380a, a fourth, largest size at state 1382a with more information that shown in state 1380, and/or with a final visual appearance state 1384a. In FIG. 13HH, animation curve 1374b illustrates a notification badge that progressively changes in size and/or includes a greater or lesser amount of information over the course of the animation. In particular, the badge is displayed with a first size at state 1367b, a second size at state 1378b, a third size and including new information (e.g., text indicating a name of a user profile that sent the message such as “John”) at state 1380b, a fourth, largest size at state 1382b with more information that shown in state 1380. While the notification badge is displayed as shown with state 1382b, the badge includes a preview of the message from the user profile (e.g., “Hey, you busy?”). Further, the final visual appearance state 1384b includes the information displayed during earlier states of the animation in which the notification badge is smaller than as shown in state 1382b.

Additionally, animation curve 1374c illustrates a search icon and/or field that progressively changes in size and/or includes a greater or lesser amount of information over the course of the animation. In particular, the icon is displayed with a first size at state 1367c and with a first visual indication (e.g., a magnifying glass), a second size at state 1378c, a third size and including new information (e.g., text such as “Search”) at state 1380c, a fourth, largest size at state 1382c with more information that shown in state 1380c (e.g., “Suggestion 1” and “Suggestion 2”), and/or with a final visual appearance state 1384c which includes the information from the prior states 1380c and 1382c.

Additionally, animation curve 1374d illustrates a representation of a user profile that progressively changes in size and/or includes a greater or lesser amount of information over the course of the animation. In particular, the icon is displayed with a first size at state 1367d including a first visual indication (e.g., a picture or graphic representative of person that is registered to the user profile), a second size at state 1378d, a third size and including new information (e.g., text such as “Jake”) at state 1380d, a fourth, largest size at state 1382d with more information that shown in state 1380d (e.g., including a user status (e.g., “Online,” offline, last called on a date, and/or some combination of information thereof), and/or with a final visual appearance state 1384d which includes the information from the prior states 1380d and 1382d.

Despite the animations corresponding to animation curves 1374a, 1374b, 1374c, and 1374d relating to different virtual objects, there are similarities as to the manner by which a computer system (e.g., computer system 101) displays the animation. For example, new information is displayed at same appearance states corresponding to same times relative to the start of the animation states (e.g., the display of “M” in state 1380a, “John” in state 1380b, “Search” in 1380c, and “Jake” in 1380d). Additionally or alternatively, the rate of scaling of content included in each virtual object is optionally the same, such as a same rate of growth in a length and/or height dimension of some or all of the virtual objects shown in FIG. 13HH. In these and other ways described in greater detail with reference to method 1400, a computer system is able to display animations for different types of virtual objects based on a shared animation curve.

FIG. 14 illustrates a flow diagram illustrating a method in which a computer system animates virtual objects based on animation curves in accordance with some embodiments of the disclosure. In some embodiments, the method 1400 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed a computer system in communication with one or more input devices and one or more display generation components, such as computer system 101 in communication with internal image sensors 114a and external image sensors 114b and 114c. For example, the computer system is optionally a mobile device (e.g., a tablet, a smartphone, a media player, or a wearable device), or a computer or other electronic device. In some embodiments, the computer system has one or more characteristics of computer systems in methods 800, 1000 and/or 1200. In some embodiments, the display generation component has one or more characteristics of the display generation component in methods 800, 1000 and/or 1200. In some embodiments, the one or more input devices have one or more characteristics of the one or more input devices in methods 800, 1000 and/or 1200.

In some embodiments, while displaying, via the one or more display generation components, a respective virtual object (optionally within a three-dimensional environment), such as virtual object 1314a through virtual object 1314c as shown in FIG. 13C, the computer system detects (1402), via the one or more input devices, attention (e.g., based on gaze or pointing) of a user of the computer system directed to the respective virtual object, such as attention 1328 as shown in FIG. 13C. In some embodiments, the respective virtual object has one or more characteristics of one or more of the virtual objects described with reference to methods 800, 1000 and/or 1200. In some embodiments, the three-dimensional environment has one or more characteristics of the three-dimensional environments described with reference to methods 800, 1000 and/or 1200. In some embodiments, the attention (e.g., gaze and/or pointing) of the user has one or more characteristics of the attention described with reference to methods 800, 1000 and/or 1200. For example, a display generation component optionally corresponds to a projected or illuminated display included in a head-mounted device capable of displaying, via the display generation component, content at a level of immersion relative to the three-dimensional environment greater than an immersion threshold. Additionally or alternatively, the display generation component optionally corresponds to a planar display such as a laptop, tablet, or mobile phone display that is optionally not capable of displaying the content at the level of immersion relative to the three-dimensional environment.

In some embodiments, in response to detecting the attention of the user directed to the respective virtual object (e.g., optionally without detecting additional or alternative input, such as a pressing of a button, an air gesture including contacting of fingers of a body of a user, and/or a voice command) (1404), and in accordance with a determination that the respective virtual object is a first virtual object, the computer system displays (1406), via the one or more display generation components, a first animation that follows a respective animation curve, such as in accordance with a determination that the virtual object is virtual object 1314a as shown in FIG. 13C using animation curve 1320 in FIG. 13C.

In some embodiments, an appearance of the respective virtual object during the first animation is based on an interpolation between two or more appearance states for the first virtual object (e.g., between a start appearance state of the first virtual object, zero or more intermediate appearance states of the first virtual object, and an end appearance state of the first virtual object) (1408), such as an interpolation between one or more appearance state of virtual object 1314a. For example, the interpolation optionally includes changing the virtual object 1314a from as shown in FIG. 13A through as shown in FIG. 13G.

In some embodiments, the first animation progresses along the respective animation curve based on a duration of the attention being directed toward the first virtual object (1410), such as attention 1328 remaining directed to virtual object 1314a from as shown in FIG. 13B through as shown in FIG. 13G. In some embodiments, the respective virtual object is associated with a characteristic such as a setting and/or a flag indicating that the computer system is able to display an animation of the respective virtual object in response to detecting and/or after detecting attention (e.g., gaze or pointing) of the user directed to the respective virtual object. In some embodiments, the setting and/or flag is configured by an application developer of a software application stored at or accessed by the computer system to display the respective virtual object. For example, the respective virtual object is optionally a button, a piece of text, an image, media, and/or a user interface for the software application displayed by the computer system. In some embodiments, the application developer designates that the respective virtual object is associated with an animation (e.g., the application developer configures metadata, sets a property, and/or assigns the respective virtual object to a type of software component that indicates to the computer system that the respective virtual object is capable of animation). In some embodiments, the respective virtual object includes one or more of such user interface elements that are displayed within a user interface element associated with an operating system of the computer system, such as a notification that is displayed while a user interface corresponding to the software application is not displayed. For example, the notification is optionally indicative of a message or a change in status of a software application while the computer system is not displaying (e.g., is forgoing display of) a user interface for the software application. Additionally or alternatively, the respective virtual object optionally includes a button, image, text, and/or graphic that is included in a system user interface, such as an icon displayed independently of whether virtual objects corresponding to user interfaces are displayed. For example, the respective virtual object is optionally a system icon that is displayed in response to detecting pressing of a button that initiates display of a system user interface including a plurality of selectable options that are respectively selectable to initiate display of software applications stored at the computer system (e.g., a software application picker user interface that overlays virtual content displayed prior to detecting the pressing of the button). In these and other ways described herein, the computer system optionally displays animations of virtual content such as virtual objects in response to detecting attention (e.g., gaze or pointing) directed toward the virtual content.

In some embodiments, the computer system displays an animation that progresses in accordance with an animation curve in response to detecting attention (e.g., gaze or pointing) of the user target the respective virtual object, such as attention 1328 being directed to virtual object 1314a as shown in FIGS. 13B through 13G. For example, an application developer of virtual content included in a virtual object (e.g., a developer of a software application represented by a visual icon displayed by the computer system) optionally designates at least a visual start and end state of the virtual object, and the computer system optionally displays an animation that visually transitions from the visual start state to the visual end state. In some embodiments, the application developer specifies some or all of the intermediate states of the respective virtual object that the computer system displays while displaying the animation of the respective virtual object. In some embodiments, the animation of a respective virtual object follows an “animation curve” as described further herein. The animation curve optionally defines a relationship between time elapsed from the initiation of the animation and the visual progression of the respective virtual object as it changes from the start state to the end state of the respective virtual object that are optionally different from one another. For instance, the animation curve optionally dictates how the respective virtual object is animated over time (e.g., how the visual appearance of the respective virtual object changes over time). As described further herein, the animation curve optionally dictates the changes to visual properties of the respective virtual object such as the height, width, opacity, and/or position of the respective virtual object relative to the three-dimensional environment over time. Additionally or alternatively, the animation curve optionally dictates the time(s) at which the computer system initiates display of virtual content included in the respective virtual object (e.g., text, color, portion(s) of a border, an animated graphic, and/or some combination thereof), and/or optionally dictates the time(s) at which the computer system forgoes display of virtual content included in the respective virtual object. In some embodiments, display of the animation includes displaying one or more intermediate visual states

As described further herein, some virtual objects that optionally share similar properties are animated in accordance with a common animation curve, such as animation curve 1320 as shown in FIGS. 13A through 13G. For example, in response to detecting that the attention (e.g., gaze or pointing) of the user is directed to the respective virtual object, the computer system optionally expands one or more portions of the respective virtual object by displaying an animation that begins with the respective virtual object in a collapsed state and ends with the respective virtual object in an expanded state. For example, in the context of the respective virtual object being a photo album including a text-based title, such an animation includes gradually displaying the entirety of the title of a photo album (e.g., the title is initially truncated, and the computer system expands the title in response to detecting the attention (e.g., gaze or pointing) of the user directed to the respective virtual object). In some embodiments, the rate at which the respective virtual object is expanded is optionally the same between different titles (e.g., different instances of virtual objects) due to both titles expanding according to the same animation curve. Additionally or alternatively, the computer system optionally displays an animation of a first icon representing a first software application increasing in one or more dimensions relative to the three-dimensional environment in response to detecting attention (e.g., gaze or pointing) of the user target the icon. In such embodiments, the rate at which one or more of the dimensions of the icon change during the animation is the same as when the attention (e.g., gaze or pointing) of the user targets a second icon representing a second software application, different from the first icon and the first software application due to both icons being animated according to the same animation curve. It is understood that the above-described embodiments are merely exemplary, and that additional or alternative aspects of animation are described further herein.

In some embodiments, virtual objects associated with animations (e.g., that are optionally animated by the computer system) are displayed in accordance with a start state and/or an end state, such as the appearance state and/or appearance of virtual object 1314a in FIG. 13A corresponding to an initial state as shown in FIG. 13M and/or the end appearance state of virtual object 1314a as shown in FIG. 13G. For example, in response to detecting attention (e.g., gaze or pointing) of the user directed to the first virtual object, the computer system optionally initiates display of the animation from the start state (e.g., how the first virtual object is displayed (e.g., its visual appearance) before detecting the attention (e.g., gaze or pointing) target the first virtual object), progressing toward and concluding with display of the first virtual object with the end state (e.g., the visual appearance of the first virtual object at the end of the animation). In some embodiments, the computer system continues to display the animation while attention is directed to the first virtual object and ceases display of the animation in response to detecting attention move away from the first virtual object. In some embodiments, the computer system continues to display the animation for at least a period of time in response to detecting the attention of the user move away from the first virtual object while the animation is being displayed. In some embodiments, the start state corresponds to a visual state of the respective virtual object before attention (e.g., gaze or pointing) is directed to the respective virtual object and/or after the computer system ceases display of the respective virtual object end state. In some embodiments, the end state corresponds to the visual state of the respective virtual object at the conclusion of the animation, and/or before the computer system reverts the display of the respective virtual object to the start state (e.g., after attention (e.g., gaze or pointing) of the user strays away from the respective virtual object for a period of time greater than a threshold period of time (e.g., 1, 1.5, 3, 5, 7, 10, 15 or 30 seconds) as described further herein). In some embodiments, the computer system displays the animation in accordance with a respective animation curve (e.g., including one or more characteristics of the animation curve described above). For example, the computer system optionally displays the animation starting from the start state, changes the visual properties and/or the content included in the respective virtual object in accordance with the animation curve, and/or ceases the animation by displaying the first virtual object with the end state. Thus, the animation curve optionally represents an amount of change of one or more visual properties of a respective virtual object such as the first virtual object from a start state to an end state over time. In some embodiments, the animation curve includes one or more portions corresponding to one or more mathematical functions, such as a linear, quadratic, exponential, logarithmic, and/or piecewise function. In some embodiments, the animation curve corresponds to or includes the rate of change of one or more of the visual properties over time, such as an opacity, size in one or more dimensions, brightness, and/or size of a border surrounding the respective virtual object.

In some embodiments, the first animation is based on an interpolation between appearance states, such as interpolating between the appearance state of virtual object 1314a from as shown in FIG. 13B through as shown in FIG. 13G. The appearance states, for example, optionally include the start state and end state described above. As an example, an appearance state optionally includes the text, graphics, frame of an animation, the inclusion or exclusion of a visual element, and/or some combination of visual elements. In some embodiments, an application developer, different from the computer system (e.g., a developer of an application represented by a virtual icon displayed by the computer system), provides one or more of the appearance states. For example, the developer optionally provides a first state in which a title for a software application is displayed that is intermediate to a start and end state of an icon for the application. Additionally or alternatively, the developer optionally provides a second state in which the tile grows in size and/or includes media corresponding to a recently aired application. In some embodiments, in response to detecting and/or while attention is (or was recently) directed to the icon, the computer system displays the animation transitioning from the start state, to the first state, to the second state, and/or to the end state. In some embodiments, the animation includes display of live media corresponding to currently airing or streaming media content. During display of the animation, the computer system optionally interpolates the size, position, visual effects, and/or the time that such visual elements are displayed, not displayed, or change. As an example, the computer system optionally displays a first animation of an icon representing a media player application. In some embodiments, the start state includes displaying the icon with a first size and including a title of the media player application. In some embodiments, during the animation, the computer system gradually increases the size of the icon relative to the three-dimensional environment, initiating display of additional text in the icon, displaying animated graphical content in the icon, displaying a simulated glow surrounding the icon (e.g., a simulation of light extending away from the border and surrounding the icon), and/or changing the position and/or rotating the icon relative to the three-dimensional environment. During the animation, some or all of the aforementioned visual effects in any combination optionally change (e.g., increasing and/or decreasing the size, displaying and/or ceasing display of graphical content, initiating, intensifying, decreasing intensity of, and/or ceasing display of the simulated glow, and/or moving the icon away from and/or back to a position included in the start state). In some embodiments, the rate at which the visual properties such as size and/or position, and/or the time at which content such as the simulated glowing effect and/or the animated graphical content are displayed follows the rate(s) and/or time(s) dictated by the animation curve. At the conclusion of the animation, the computer system optionally displays the icon with the end state, which optionally includes displaying the icon (e.g., the first virtual object) with a size, position, with text and/or graphics, with a recurrent graphical animation of content in the icon, and/or with a recurrent positional oscillation that are optionally not included in the start state of the icon. Thus, the computer system optionally differentiates the start state from the end state, drawing attention of the user toward the first virtual object and potentially enriching the information presented to the user that is associated with the first virtual object.

In some embodiments, in response to detecting the attention of the user directed to the respective virtual object (e.g., optionally without detecting additional or alternative input, such as a pressing of a button, an air gesture including contacting of fingers of a body of a user, and/or a voice command) (1404), in accordance with a determination that the respective virtual object is a second virtual object, different from the first virtual object, the computer system displays (1412), via the one or more display generation components, a second animation that follows the respective animation curve, such as attention 1328 being directed to virtual object 1314b as shown in FIG. 13K and/or if attention 1328 was directed to virtual object 1360a in FIG. 13W.

In some embodiments, the appearance of the respective virtual object during the second animation is based on an interpolation between two or more appearance states for the second virtual object (e.g., between a start appearance state of the second virtual object, zero or more intermediate appearance states of the second virtual object, and an end appearance state of the second virtual object) (1414).

In some embodiments, the second animation progresses along the respective animation curve based on a duration of the attention being directed toward the second virtual object (1416), such as an interpolation between the appearance states of virtual object 1314f from FIG. 13J to FIG. 13M. For example, the second virtual object optionally has one or more characteristics that are similar to, or the same as one or more characteristics of the first virtual object. In some embodiments, the start state of the second virtual object is at least partially different from, and/or is at least partially the same as the start state of the respective virtual object. For example, the computer system optionally displays a first icon including first text indicating a title of associated media content, a first image, and displayed at a first size. Concurrently, the computer system optionally displays a second icon including a second title, different from the first title, with a second image, different from the first image, and optionally displays the second icon with the first size relative to the three-dimensional environment. In response to detecting attention (e.g., gaze or pointing) directed to the first icon, the computer system optionally increases the size of the first icon over a first period of time concurrently while animating the first image with a preview of the corresponding media, and optionally decreases the size of the first icon over a second period of time while continuing to display the preview of the corresponding media. At a conclusion of the animation, the computer system optionally displays the first icon with a size larger than the size of the first icon at its start state. Similarly, in response to detecting attention (e.g., gaze or pointing) directed to the second icon, the computer system optionally increases the size of the second icon over the first period of time concurrently while animating the second image with a preview of the corresponding media, and optionally decreases the size of the second icon over the second period of time while continuing to display the preview of the corresponding media. At a conclusion of the animation, the computer system optionally displays the second icon with a size larger than the size of the second icon at its start state, which is optionally the same size of the first icon at its end state. The first and second icon at their respective end states, however, optionally include different images and/or text, and are thus visually differentiated at respective end states from each other.

In some embodiments, the second animation has one or more characteristics that are similar to, the same as, or correspond to one or more characteristics of the first animation, such as an animation of virtual object 1314b in FIGS. 13K and 13L. Similarly, the start, intermediate, and/or end appearance state(s) and/or interpolation between such state(s) have one or more characteristics that are similar to, the same as, or correspond to one or more characteristics of the interpolation described with reference to the first animation. Similarly, the manner by which the computer system optionally progresses the transitions along the animation curve when displaying the second animation are optionally similar to, the same as, or correspond to one or more characteristics of the manner by which the computer system progresses the first animation.

In some embodiments, the respective animation curve is shared between different virtual objects. For example, two different virtual objects of different sizes optionally are animated to change in similar manners over time, even when the start state of each virtual object is different. For example, while displayed with respective start states, the virtual objects are optionally displayed with different lengths, widths, levels of opacity, with different font sizes of text in the virtual objects, and/or some combination thereof. While the computer system animates the virtual objects, the computer system optionally changes the visual properties of each virtual object at a same rate (e.g., each object changes length, width, level of opacity, and/or font size at a same rate relative to time). Additionally or alternatively, initiating and/or ceasing display of virtual content in each virtual object optionally occurs at a same time relative to the progression of each animation of each virtual object. For example, the computer system optionally initiates or ceases display of text, animated graphics, playback of live or prerecorded media, and/or application or removal of a visual effect (e.g., blurring, particle effects, and/or simulated lighting effects) at a same time relative to the initiation of an animation for the first virtual object and the second virtual object or at different times dictated by the placement of the start state relative to the respective animation curve. As an example, the computer system optionally initiates display of a recording of a polar bear five seconds after initiating an animation of a tile representative of a gaming application, and optionally initiates display of a recording or live playback of a news segment five seconds after initiating an animation of a tile representative of a news media application. Additionally or alternatively, the computer system optionally animating of a text title of the gaming application five seconds after detecting attention target the gaming tile, and/or optionally initiates animating of a text title of the news media application three seconds after detecting gaze target the news media tile. In some embodiments, the rate of change of visual properties changes over attention of virtual objects during an animation is shared between animations of the virtual objects, analogously to the acceleration of a change in a value of a visual property rather than a speed of change in the value of the visual property over time. For example, the rate of change that a speed with which opacity, size, position, and/or additional or alternative visual properties of the virtual object changes over time is optionally the same for the first and/or the second virtual object. In these and other ways described herein, the computer system optionally displays animations that share an animation curve, despite differences in start and end state of similar virtual objects. Displaying animations in accordance with a similar or same animation curve based on different start and end states lends visual consistency between the animations of respective virtual objects while conveying object-specific information, increasing the likelihood that user is apprised of the progression of the animation irrespective of the specific virtual object that is targeted, thus reducing the likelihood the user erroneously interrupts an animation or otherwise erroneously interacts with the virtual objects and allowing for consistency in the manner that respective virtual objects are displayed in accordance with attention as specified by software developers associated with the respective virtual objects, and thereby reducing input and corresponding processing required to replay the animation.

In some embodiments, the respective animation curve includes a first portion, such as first portion 1324a as shown in FIG. 13A that progresses in accordance with a first average rate over time, and includes a second portion that progresses in accordance with a second average rate over time, different than the first average rate over time, such as second portion 1324b as shown in FIG. 13A. For example, one or more sections of the first portion of the respective animation curve optionally progress at an average rate over time that is greater than, equal, to, and/or less than an average rate over time of one or more sections of the second portion of the respective animation curve. In some embodiments, the first portion of the respective animation curve and the second portion of the respective animation curve correspond to different periods of time. For example, the first portion is optionally before the second portion of the respective animation curve in time. In some embodiments, the average rate is expressed in a percentage of completion of the animation over time, such as 2, 5, 10, 15, 20, 25, 40, 50, 60, or 75% of the animation. In some embodiments, the respective animation curve is based on a time axis (e.g., an independent axis for the curve). For instance, an exemplary animation curve when presented on a graph optionally has time represented on the x-axis and progression represented on the y-axis. In some embodiments, progression on the y-axis is expressed as a percentage of completion of the animation. In some embodiments, the animation curve begins at time 0 seconds and 0% completion and concludes when the progression reaches 100%. In some embodiments, a derivative of the respective animation curve corresponds to a rate over time at which the animation progresses. In some embodiments, a respective first portion of the derivative curve temporally corresponds to the first portion of the respective animation curve. Additionally or alternatively, a respective second portion of the derivative curve optionally temporally corresponds to the second portion of the respective animation curve. In some embodiments, the value of the dependent variable in the respective first portion of the derivative curve is different from the value of the dependent variable in the respective second portion of the derivative curve. Configuring different portions of the respective animation curve to progress with different rates over time, which optionally increases the likelihood that user is apprised of the progression of the animation irrespective of the specific virtual object that is targeted, thus reducing the likelihood the user erroneously interrupts an animation or otherwise erroneously interacts with the virtual objects and allowing for consistency in the manner that respective virtual object are displayed in accordance with attention as specified by developers associated with the respective virtual objects, and thereby reducing input and corresponding processing required to replay the animation.

In some embodiments, the second average rate is greater than the first average rate, such as first portion 1324a as shown in FIG. 13B and second portion 1324b as shown in FIG. 13B. In some embodiments, the animation progress changes more quickly while displaying a second portion of an animation than while during a first portion of the animation. For example, the first average rate is optionally an average change of 0.1, 1, 2.5, 5, 10, 15, or 20% of completion of the animation per unit time and the second average rate is optionally 1, 2.5, 5, 7.5, 10, 12.5, 15, 20, 25, or 30% of completion of the animation per unit time. For example, a derivative of the respective animation curve (e.g., corresponding to a rate of change of the animation progress as a function of time that attention is directed to the first virtual object) optionally corresponds to a rate of change of progress of the respective animation curve over time. It is understood that some embodiments referencing the first, second, third, and/or additional or alternative portions of the respective animation curve optionally correspond to first, second, third, and/or additional or alternative portions of a related animation (e.g., the first portion of the animation is displayed in accordance with the first portion of the respective animation curve). In some embodiments, a value of the derivative is greater while displaying an animation in accordance with the second portion of the respective animation curve than while displaying in accordance with the first portion of the respective animation curve. Configuring the second portion of the animation curve to progress more quickly than the first portion of the animation curve optionally reduces the amount of time spent displaying the second portion of the animation, thus indicating a transition between portions of the animation, thereby reducing the likelihood user input erroneously interrupts the animation before the computer system concludes display of the animation, thereby reducing the power consumption required to correct for the erroneous interruption and reducing the amount of time required to display the second portion of the animation.

In some embodiments, the first portion of the respective animation curve is non-linear or (optionally and) the second portion of the respective animation curve is non-linear, such as second portion 1324b as shown in FIG. 13B. For example, the first portion and/or the second portion of the animation curve respectively and optionally comprise one or more linear and/or non-linear functions. In some embodiments, the functions include one or more of a quadratic, exponential, logarithmic, piece-wise, cubic, and/or additional or alternative functions. Configuring the first and/or second portion of the respective animation curve with partial or complete non-linear segments optionally offers a wider array of possibilities for displaying a corresponding animation, thus optionally reducing the need to display of additional or alternative animated effects to indicate visual feedback, thereby reducing power consumption required for the display of the additional or alternative animated effects.

In some embodiments, the first portion of the respective animation curve includes a first peak value, such as a peak value of in first portion 1324a as shown in FIG. 13C. For example, the maximum value in the first portion of the respective curve is optionally a first value. In some embodiments, a value of the respective animation curve corresponds to the y-value of the respective animation curve, whereas the x-axis represents time. In some embodiments, the value corresponds to a visual property of the respective virtual object such as the height, width, opacity, brightness, saturation, scale, rotation, and/or position of the respective virtual object and/or one or more portions of content displayed (or capable of being displayed) in the respective virtual object. In some embodiments, the value corresponds to an amount of progression of the related animation (e.g., the first animation and/or the second animation) towards a final appearance state of the object.

In some embodiments, the second portion of the respective animation curve includes a second peak value, such as a peak of second portion 1324b as shown in FIG. 13E. For example, the maximum value in the second portion of the respective curve is optionally a second value, optionally different from the first value.

In some embodiments, a value of the respective animation curve when the respective virtual object is displayed with a final appearance state is a third value, less than the first peak value or less than the second peak value, such as the value of animation curve 1320 as shown in FIG. 13G indicated by progress indicator 1322. In some embodiments, the third value is less than the first peak value and less than the second peak value. For example, the maximum value in the third portion of the respective animation curve is optionally a third value, less than the first and/or the second values when displayed with the final appearance state at a conclusion of a corresponding animation. In this way, a peak of the respective animation curve in the first and/or second portion of the animation curve optionally is greater than a peak of the respective animation curve in the third portion. As an example, displaying the first and/or the second portion of the animation includes displaying a virtual object with a peak size, brightness, level of opacity, and/or with a size of a matte underlaying text with one or more first values. Further, displaying the third portion of the animation optionally includes displaying the virtual object with a size, brightness, level of opacity, and/or size of the matte with one or more second values, respectively less than some or all of the one or more first values. Configuring the respective animation curve with a peak value for the first and/or portion of the respective animation curve that is greater than a peak value for the third portion of the respective animation curve visually draws visual attention toward the corresponding animation, thus reducing the likelihood is unaware the animation is ongoing and indicating that the animation has progressed toward a steady state, thereby reducing power consumption required to correct for erroneous interruptions to the animation.

In some embodiments, the respective animation curve includes a transition portion for transitioning from the first portion to the second portion of the animation curve, such as first transition 1326a as shown in FIG. 13C. For example, the transition portion optionally includes one or more points between an end of the first portion and a beginning of the second portion of the respective animation curve. In some embodiments, the first and second portions are continuous functions with respect to an independent axis, such as a time axis. In such embodiments, the transition portion corresponds to a single time value where the first and second portions meet, or nearly meet. In some embodiments, the first and second portions of the curve are non-continuous. In such embodiments, the transition portion corresponds to a range of times and corresponding time values intermediate to the first and second portions of the respective animation curve. In some embodiments, the transition portion includes at least some of the first portion and/or the second portion of the respective animation curve.

In some embodiments, at least a portion of a derivative of the transition portion of the respective animation curve is non-continuous, such as a derivative of animation curve 1320 at first transition 1326a as shown in FIG. 13C. For example, when the transition portion only corresponds to a point along the animation curve, a derivative at the point is optionally indefinite (e.g., because the transition portion corresponds to an impulse function). Additionally or alternatively, for values of a whole number “n” (e.g., 1, 2, 3, and/or 4), an nth order derivative of the first portion of the respective animation curve is optionally continuous. In some embodiments, an nth order derivative of the second portion of the respective animation curve is optionally continuous. In some embodiments, an nth order derivative of the transition portion is not continuous. For example, the first portion of the respective animation curve optionally is defined by a first mathematical function such as a straight-line function with a constant slope. In such an example, the second portion of the respective animation curve optionally is defined by second, different mathematical function, such as a quadratic and/or logarithmic function. In this way, the transition from the first to the second portion of a corresponding animation optionally is distinct and/or abrupt (e.g., an impulse function), thereby more clearly indicating a transition between the first and second portions of the respective animation curve. Configuring the respective animation curve to include a discontinuity in a derivative at a transition between the first and second portions of the respective animation curve visually indicates the transition, thus providing potentially rapid changes in the progression of the animation and visually differentiating between portions of the animation, thereby reducing power consumption required to detect input erroneously interrupting the animation.

In some embodiments, the first virtual object is associated with a first intermediate appearance state that is displayed when the computer system is displaying the first animation during the transition portion of the respective animation curve, such as an appearance state of virtual object 1314a corresponding to first transition 1326a as shown in FIG. 13C. In some embodiments, the computer system receives an indication of intermediate appearance state(s) that define one or more appearances of a virtual object while the computer system transitions between the first and the second portions of the respective animation curve (e.g., from a developer corresponding to the virtual object and/or determined by the computer system). In some embodiments, a respective intermediate appearance state defines a y-value for the respective animation curve. For example, the first virtual object is associated with one or more first intermediate appearance states, such as the first intermediate appearance state (e.g., defined by a developer of a software application represented by the first virtual object, defined by an operating system of the computer system, and/or defined by a user setting configurable by the user of the computer system). In some embodiments, one or more of the intermediate appearance states define (e.g., correspond to) different values for one or more visual characteristics of the respective virtual object. In some embodiments, the respective intermediate states, such as those included in the one or more first intermediate appearance states, are independent of each other and/or are different from one another. In some embodiments, the respective intermediate appearance corresponds to an appearance state of the first virtual object during the transition portion of the respective animation curve, as described above. In some embodiments, the intermediate appearance states define visual characteristics, such as the size of some or all of the virtual object, the display of text, the playback time of a piece of media, the display or ceasing of display of graphics, the progression of display of a visual effect like a simulated light glowing from the virtual object, and/or some combination thereof. In some embodiments, different intermediate appearance states include different combinations and/or values of visual characteristics (e.g., displaying a first portion of text and/or with 10% opacity or displaying the first and a second portion of the text with 50% opacity).

In some embodiments, the second virtual object is associated with a second intermediate appearance state that is displayed when the computer system is displaying the second animation during the transition portion of the respective animation curve, such as an appearance state corresponding to first transition 1326a as shown in FIG. 13J to FIG. 13K for virtual object 1314b. For example, the second intermediate state has one or more characteristics similar to, the same as, or that correspond to the first intermediate state. In some embodiments, the second intermediate appearance state is based on a different (or a same) software application and/or define different visual content for animations of the second virtual object. For example, second intermediate appearance state optionally includes different graphics, timing, text, visual effects, level(s) of visual characteristic(s), that are different from similar visual properties included in the first intermediate appearance state. In this way, the first intermediate appearance state and/or the second intermediate appearance state optionally define different values of the respective animation curve. Displaying animations using intermediate appearance states and a respective animation curve reduces the processing required for the computer system to independently generate appearance states and/or visually interpolate between appearance states without guidance from the intermediate appearance states.

In some embodiments, a rate of change of the respective animation curve gradually increases during the first portion over time, and a rate of change of the respective animation curve gradually decreases during the second portion over time, for example, the rate of change of animation curve 1320 in FIG. 13B changes from a positive value to a negative value in second portion 1324b, such as after transition indicator 1322 moves from before FIG. 13D to after FIG. 13E. In some embodiments, the rate of change of the respective animation curve increases during the first portion of the animation curve (e.g., 0.1, 1, 2.5, 5, 7.5, 10, 12.5, or 15% completion of the animation per second). For example, the first portion of the respective animation curve optionally bears similarities to a first portion of a cubic function, in which the respective animation curve gradually increases as a function of time. Further, the second portion of the respective animation curve optionally bears similarities to a second portion of the cubic function, in which the respective animation curve gradually decreases as a function of the time. Additionally or alternatively, the first portion optionally corresponds to an exponentially increasing function, and the second portion optionally corresponds to a logarithmic decaying function. Configuring the respective animation curve with a gradually increasing portion and a gradually decreasing portion presents an indication that the animation is progressing (e.g., speeding up and then slowing down, or vice versa), allowing for rapid display and/or ceasing display of information included in the animation, thus reducing user input required to manually accelerate or deaccelerate progression of the animation or otherwise required to preview the information, thereby reducing processing required to perform operations based on the user input.

In some embodiments displaying the first animation includes, while the first animation progresses along the first portion of the respective animation curve, displaying text associated with the first virtual object, such as displaying text in virtual object 1314a from as shown in FIG. 13C to as shown in FIG. 13D. For example, the computer system optionally displays some or all of a piece of text. The text, for example, optionally includes a title of media, description of a notification, a body of a message, a subject line for an e-mail, a description of a status of a user, a description of a currently displayed image, a director's note about a portion of a scene, a name and/or identifier of an individual, location, or product displayed in the respective virtual object, and/or some combination of text thereof. In some embodiments, the text is associated with the first virtual object. For example, the text corresponds to a notification for a messaging application (e.g., including text and/or content from a particular message) represented by a user interface included in the respective virtual object, a status displayed in a user interface for a video calling application user interface included in the respective virtual object, and/or a description of an annotation inserted into a virtual scene represented in a virtual scene editing user interface included in the first virtual object. In some embodiments, some or all of the text is not displayed prior to displaying the first animation and/or prior to reaching the first portion of the respective animation curve during display of the first animation of the first virtual object. In some embodiments, some or all of the text is displayed during the first portion and/or the second portion of the animation. In some embodiments, the second animation progress includes display of similar text and/or different text that is associated with content included in the second virtual object and/or associated with the second virtual object. Displaying text in the first animation reduces the need to display the text prior to detecting attention of the user directed to a virtual object, thereby reducing computation and power consumption.

In some embodiments, displaying the text during display of the first animation further comprises, while the first animation progresses along the first portion of the respective animation curve, displaying, via the one or more display generation components, a first portion of the text, such as text indicated by state 1380a of an application icon as shown in FIG. 13HH.

In some embodiments, displaying the text during display of the first animation further comprises, while the first animation progresses along the second portion of the respective animation curve, displaying, via the one or more display generation components, the first portion of the text and a second portion of the text, different from the first portion of the text (e.g., a second portion of the text that was not displayed while the first animation was progressing along the second portion of the respective animation curve), such as indicated by state 1382a of an application icon as shown in FIG. 13HH. For example, the computer system optionally displays text that is not displayed before initiating the first animation. In some embodiments, the computer system displays text that is at least partially truncated, such as a preview of a message and/or a preview of a description of an application during the first portion of the respective animation curve. In some embodiments, the first animation begins with the text partially displayed (e.g., truncated, corresponding to the first portion of the text), and as the animation continues, the text is more completely or completely displayed but is still truncated when the first portion of the respective animation curve concludes (e.g., corresponding to the second portion of the text). In some embodiments, displaying the second animation includes displaying text that is at least partially truncated and/or is truncated prior to the displaying the second animation. In some embodiments, the first portion of the text includes a greater or fewer number of characters than the second portion of the text. In some embodiments, the computer system displays the first and the second portions of the text concurrently while progressing along the second portion of the respective animation curve. Displaying text that is truncated and/or displaying the entirety of previously truncated text optionally reduces power consumption required to display the text prior to detecting attention of the user directed to a virtual object.

In some embodiments, the text associated with the respective virtual object was not displayed prior to displaying the first animation, such as text indicated by state 1382a (e.g., “Music”) of an application icon as shown in FIG. 13HH. For example, as described with reference to text that is at least partially truncated, the computer system optionally displays text that is not displayed prior to initiating display of the first animation (e.g., before attention targets the respective virtual object). Additionally or alternatively, the computer system optionally displays text during the second animation that is not displayed prior to displaying the second animation. Displaying text that is not displayed prior to detecting attention directed to a virtual object optionally reduces power consumption required to display the text prior to detecting attention of the user directed to a virtual object.

In some embodiments, a duration of time during which the computer system displays the first animation in accordance with the first portion of the respective animation curve is greater than a duration of time during which the computer system displays the first animation in accordance with the second portion of the respective animation curve, such as the time required for progress indicator 1322 to reach the second transition 1326b corresponding to a final appearance state associated with animation curve 1320 as compared to the time required for progress indicator 1322 to reach the second transition 1326d corresponding to a final appearance state associated with animation curve 1338. For example, the time required to display the first portion of the first animation is optionally greater than the time required to display the second portion of the first animation (or vice-versa). In some embodiments, the amount of time (e.g., a duration of time) required to display the first portion of the second animation is greater than the amount of time required to display the second portion of the second animation (or vice-versa). For example, the computer system optionally displays the first portion of the animation over a 0.05, 0.1, 0.5, 1, 1.5, 2, 3, 5, or 10 second period of time and optionally displays the second portion of the animation over a 0.01, 0.05, 0.1, 0.5, 1, 1.5, 2, 3, or 5 second period of time. Varying the amount of time required to display different portions of the animation corresponding to different portions of the respective animation curve allows the computer system to present information in different manners, thus reducing time required to display animations that are restricted by less flexible schemes and timing restrictions enforced when displaying animations in accordance with animation curves.

In some embodiments, displaying the first animation in accordance with the first portion of the respective animation curve includes displaying, via the one or more display generation components, a first amount of information (that was optionally not displayed when the first portion of the respective animation curve was initiated), such as the increase in information of an application icon from as state 1378a to state 1380a as shown in FIG. 13HH. For example, the computer system optionally displays a first amount of information while displaying the first portion of the animation (e.g., corresponding to the first portion of the animation curve) that is not displayed prior to initiating the first portion of the animation. In some embodiments, the first information includes a first number of characters, a first width of text, and/or a first percentage of one or more images and/or video. In some embodiments, the computer system displays the first amount of information overlaying the respective virtual object. In some embodiments, overlaying the first information on the respective virtual object includes displaying the text so that the entirety of the text is displayed at a location that corresponds to the respective virtual object. Additionally or alternatively, overlaying the first information on the virtual object includes displaying the text so that some portion of the text is displayed adjacent to the respective virtual object.

In some embodiments, displaying the first animation in accordance with the second portion of the respective animation curve includes displaying, via the one or more display generation components, a second amount of information (that was optionally not displayed when the second portion of the respective animation curve was initiated), greater than the first amount of information, such as the increase in information of an application icon from as state 1380a to state 1382a as shown in FIG. 13HH. In some embodiments, the second portion of the animation includes one or more characteristics described with reference to the first portion of the animation (e.g., but corresponding to the second portion of the animation curve instead of the first portion of the animation curve). For example, the computer system optionally displays the second amount of information while displaying the second portion of the animation (e.g., corresponding to the second portion of the animation curve) that is not displayed prior to initiating the second portion of the animation.

In some embodiments, the rate at which information is displayed is different for respective portions of an animation, such as different portions of the animation curves 1374a through 1374d as shown in FIG. 13HH. For example, the first amount of information optionally quantifies an increase in information displayed over a period of time beginning with an initiation of the first portion of the animation and concluding with a conclusion of the first portion of the animation (e.g., corresponding to the first portion of the respective animation curve). Additionally or alternatively, the second amount of information optionally quantifies an increase in information newly displayed over a period of time beginning with an initiation of the second portion of the animation to a conclusion of the second portion of the animation (e.g., corresponding to the second portion of the respective animation curve). Thus, in some embodiments, the amount of information newly revealed during the first animation is a first amount of information, and the amount of information newly revealed during the second animation (e.g., that was not previously revealed prior to or during the first animation) is a second amount of information that is greater than the first amount of information. In some embodiments, the second amount of information includes less or more information than the first amount of information. In some embodiments, the first and second amounts of information include same or different types of information, such as both including text, both including video, one including just a graphic while the other includes an animation and/or text, and the like. In some embodiments, the computer system displays the second amount of information overlaying the virtual object, included in the virtual object, and/or adjacent to the virtual object. It is understood that description of the first animation optionally applies to description of the second animation. For example, the second animation optionally includes display of different amounts of information during different portions of the second animation. Displaying different amounts of information optionally reduces power consumption required to prematurely display excessive information at a particular playback position of the animation and/or improves efficiency of interaction by more-quickly presenting information while displaying an animation that presents information at a constant rate, thus reducing power consumption required to display an animation if the first portion of the animation presents a sufficient amount of information to satisfy interests of the user.

In some embodiments, displaying the first animation includes (e.g., and/or displaying the second animation includes), during the first portion of the respective animation curve, changing a size of the respective virtual object along a first dimension relative to a three-dimensional environment of the user and not along a second dimension relative to the three-dimensional environment, such as increasing a size of notification 1368 along a first dimension as shown from FIG. 13DD to FIG. 13EE. For example, the computer system optionally increases and/or decreases a size of the virtual object relative to the three-dimensional environment during the first portion of the animation (e.g., the first and/or second virtual objects). In some embodiments, the changes in size are restricted to a first dimension of the virtual object during the first portion of the animation that corresponds to the first portion of the respective animation curve. The computer system, for example, optionally displays an increasing (or decreasing) of a height, width, or depth while forgoing increasing (and/or decreasing) of the height, width, and/or depth. In some embodiments, a dimension of the three-dimensional environment corresponds to an axis along a Cartesian coordinate system. In some embodiments, the dimension corresponds to an axis along an additional or alternative coordinate system, such as a spherical coordinate system.

In some embodiments, displaying the first animation includes (e.g., and/or displaying the second animation includes), during the second portion of the respective animation curve, changing the size of the respective virtual object along a plurality of dimensions, including the first dimension and the second dimension relative to the three-dimensional environment, such as increasing a size of notification 1368 along a first dimension and a second dimension as possible from as shown in FIG. 13DD to as shown in FIG. 13EE. For example, the computer system optionally concurrently changes size of the virtual object with respect to a plurality of dimensions during a second portion of the animation (e.g., an X, Y, and/or Z dimension). In some embodiments, the plurality of dimensions includes (or does not include) the first dimension of the virtual object that is changed during the first portion of the animation. For example, the computer system optionally increases a length of the virtual object during the first portion of the animation and increases both the length and height (e.g., concurrently and/or in succession) during the second portion of the animation. In some embodiments, the rates by which the dimension(s) of the virtual object are changed during the first and/or the second portions of the animation are different from each other. For example, the change in length during the first portion of the animation is optionally less than the change in length during the second portion of the animation. In some embodiments, the rates of change and/or the specific dimensions that are changed during animation of a virtual object are the same between different objects (e.g., objects corresponding to a same or different types of content, such as both corresponding to application icons and/or to media previews). In some embodiments, the rates of change and/or specific dimensions that are changed during an animation of a virtual object are different between different objects (e.g., an application icon grows in length during a first portion, whereas a picture grows in height during the first portion). Changing the size of the virtual object along a single dimension followed by a plurality of dimensions reduces power consumption required to change the virtual object in a plurality of dimensions during the first portion of an animation.

In some embodiments, the two or more appearance states for the first virtual object include respective start and end appearance states defined by a first process (e.g., associated with and/or defined by a first application), such as a process that corresponds to virtual object 1360b as shown in FIG. 13W.

In some embodiments, the two or more appearance states for the second virtual object include respective start and end appearance states defined by a second process, different from the first process (e.g., associated with and/or defined by a second software application, different from the first software application), such as a process that corresponds to virtual object 1360a as shown in FIG. 13W. For example, the computer system optionally determines and/or receives an indication of visual start and end appearance states for a given animation (e.g., first animation and/or second animation). In some embodiments, the first process is a process that is associated with a first application. In some embodiments, the second process is a process that is associated with a second application that is different from the first application. In some embodiments, the first process includes a process for displaying the first virtual object. Similarly, in some embodiments, the second process includes a process for displaying the second virtual object. In some embodiments, the first process and the second process include definitions of the two or more appearance states of the first virtual object and the second virtual object, the first process and the second process both utilize the same animation curve to transition between the two more appearance states. In some embodiments, the first process is associated with a first virtual object, because the first virtual object is a user interface for the first application, and the second process is associated with the second virtual object because the second virtual object is a user interface for the second application. In some embodiments, the process is performed by the computer system and/or by a software application that indicates results of the process to the computer system. For example, the first virtual object is optionally a user interface for a first application that defines and/or specifies parameters for the first process, and the second virtual object is optionally a user interface for a second application, different from the first application, that defines and/or specifies parameters for the second process. In some embodiments, in response to detecting selection input as described further above that is directed to a respective virtual object (e.g., the first virtual object and/or the second virtual object), the computer system launches a respective application and/or displays a user interface for the respective application (e.g., launches and/or displays a user interface for the first application and/or the second application, respectively). In some embodiments, in response to detecting selection input as described further above directed to a respective virtual object (e.g., the first virtual object and/or the second virtual object), the computer system displays content (e.g., text, prerecorded or live video, pictures, graphics, and/or animations) corresponding to a respective application (e.g., the first application and/or the second application). In some embodiments, the computer system visually interpolates between the start appearance state and/or the end appearance states while the first and/or second animation is being displayed. Visual interpolation optionally includes determining the translation of visual elements, the initiating of display of such elements, the ceasing of display of such elements, the display or ceasing of display animated effects, the changing of size of such elements, and/or some combination thereof based on the time dictated by the respective animation curve in view of the time of that the start appearance state is defined and the time that the end appearance state is defined relative to the curve.

In some embodiments, a software developer and/or software application provides an indication of an appearance state, such as a developer or application corresponding to virtual objects 1314a through 1314c and/or virtual object 1360a through 1360c. For example, a software application optionally includes one or more files such as pictures, vector files, frames from media, text, and/or a proposed arrangement of such media to display to the user of the computer system. The appearance states are thus optionally specified by the developer and/or the software application, at least with respect to how the virtual object is to be displayed by the computer system when the animation is initiated and/or concludes. For example, a start appearance state optionally includes a title and a graphic displayed with a first size and at a first position. An end appearance state optionally includes the title displayed with a relatively larger size than specified by the start appearance state, the graphic displayed with an increased size and at a second position, different from the first position. In some embodiments, a first process determines a first start state and a first end state for the first animation. In some embodiments, a second process determines a second start state, different from the first start state, and determines a second end state, different from the first end state. In some embodiments, the computer system uses the respective animation curve when displaying the first animation based on the first start and end states specified by respective process, and when displaying the second animation based on the second start and end states (e.g., when interpolating between the start and end states). Appearance states of the virtual object optionally specify the appearance of the virtual object, thus reducing computation otherwise required by the computer system to determine the appearance of the virtual object absent such appearance states.

In some embodiments, the first virtual object is associated with a first application and the second virtual object is associated with a second application, different from the first application, such as an application corresponding to virtual objects 1314a through 1314c. In some embodiments, the first application and/or the second application have one or more characteristics similar to, the same as, and/or that correspond to the first process, the second process, the first application, and/or the second application described further above. For example, the first application and the second application optionally applies to similar or different types of application. In some embodiments, the first application is a media player application, and the second application is a gaming application. Additionally or alternatively, the applications optionally are associated with an operating system of the computer system, such as applications that are installed when the computer system is manufactured. For example, the applications optionally correspond to a native browser, messaging, media browser, audio, video, and/or spatial-based calling applications, and/or some combination thereof. In this way, the first virtual object is optionally associated with a first process as described above, and the second virtual object is optionally associated with a second virtual object as described above. Using different applications to correspond to different virtual objects optionally allows the computer system to present animations tailored to information that is relevant to each application, thus reducing processing required to detect input and perform presentation-related operations to preview the information otherwise unavailable if the animations are not application-specific.

In some embodiments, while displaying the first animation, the computer system detects the attention of the user move away from the respective virtual object (e.g., and/or while displaying the second animation), such as attention 1328 moving away from virtual object 1314c, similar to (e.g., or the same as) cursor 1346 move away from virtual object 1314c. For example, the computer system optionally detects attention move away from where the first virtual object exists in the three-dimensional environment and/or away from where visual effects and/or media included in the first animation are displayed. In some embodiments, the computer system ceases display of the animation in accordance with a determination that that the first virtual object is not yet displayed with an end appearance state (as described further herein) and in response to detecting the attention move away from a respective virtual object. In some embodiments, the computer system maintains display of the virtual object with an end appearance state in response to detecting the attention of the user move away from the virtual object (e.g., when the first and/or second animation is no longer being displayed, but the result of the animation is being displayed).

In some embodiments, in response to detecting the attention of the user move away from the respective virtual object, the computer system ceases display of the first animation (and/or ceasing to display the second animation), such as the ceasing of animation of virtual object 1314c as indicated by the progress indicator 1322 in FIG. 13S. In some embodiments, ceasing to display the first animation includes stopping the first animation, reversing at least a portion of the first animation, and/or removing any user interface elements that were displayed as part of the first animation. In some embodiments, ceasing to display the second animation includes stopping the second animation, reversing at least a portion of the second animation, and/or removing any user interface elements that were displayed as part of the second animation. For example, the computer system optionally immediately ceases progression of display of the first animation. In some embodiments, the computer system forgoes display (e.g., ceases display) of visual effects and/or media included in the first animation. In some embodiments, the computer system, in response to detecting the attention move away from the respective virtual object, changes the visual characteristic(s) of the virtual object to reflect the values of the visual characteristic(s) immediately prior to initiating of the animation. For example, the computer system optionally displays the respective virtual object with visual characteristics that are the same as visual characteristics of an “initial” appearance state of the respective virtual object in response to detecting attention of the user move away from the respective virtual object. In some embodiments, the initial appearance state is a visual appearance state of the respective virtual object that is displayed when the attention of the user initially targets the respective virtual object to initiate display of an animation. Ceasing display of the animation based on attention moving away from a virtual object reduces power consumption otherwise required to display the entirety of the animation.

In some embodiments, displaying the first animation includes changing one or more of a scale relative to a three-dimensional environment, an opacity, or a shape of the respective virtual object, such as an opacity, scale, and/or shape of the virtual object depicted in FIG. 13HH corresponding to appearance states 1367a through 1384d. For example, the computer system optionally displays the first and/or second virtual object with one or more first values for one or more visual characteristics prior to displaying the first and/or second animation. When displaying the animation, the computer system optionally changes the values of the one or more visual characteristics (e.g., to one or more second, third, fourth, and/or additional or alternative values). In some embodiments, the visual characteristic(s) include a scale relative to the three-dimensional environment along one or more dimensions. In some embodiments, the visual characteristic(s) include a level of opacity. In some embodiments, the visual characteristic(s) include a shape and/or spatial profile of a visual mask (e.g., a “clipping” shape). In some embodiments, the visual mask defines regions of the virtual object that are not displayed with underlying virtual content, thus masking off portions of the virtual content (and forgoing display of the virtual content at the portions of the virtual object). Thus, in some embodiments, the shape of the respective virtual object includes a clipping shape associated with the virtual object. Changing one or more visual characteristics of a virtual object while displaying an animation increases visual emphasis of the virtual object, thus drawing focus of the user toward the virtual object and reducing the likelihood that the user erroneously interacts with the virtual object or other portions of the three-dimensional environment, thereby reducing processing required to perform operations in accordance with the erroneous input.

In some embodiments, while displaying the respective virtual object, the computer system detects, via the one or more input devices, input directed toward the respective virtual object (e.g., an air gesture, input directed to a controller, voice input, attention of the user, and/or some combination thereof), such as input from hand 1344 as shown in FIG. 13B and/or FIG. 13U.

In some embodiments, in response to detecting the input, the computer system displays, via the one or more display generation components, the first animation that follows the respective animation curve (e.g., as described above), wherein in accordance with a determination that the input corresponds to a direct input type, the respective animation curve corresponds to a first animation curve, such as using animation curve 1338 as shown in FIG. 13U in response to detecting hand 1344 move within threshold 1348. In some embodiments, the animation curve is based on a type of input directed toward a virtual object. For example, the direct input type optionally includes a scenario in which a portion of a body of a user (e.g., a finger, a hand, and/or an elbow) is moved to a position that is within a threshold distance (e.g., 0, 0.005, 0.01, 0.05, 0.1, 0.2, 0.3) of the virtual content (e.g., the first and/or second virtual object and/or a selectable option included in a virtual object). In response to detecting a direct input directed toward the virtual object, the computer system optionally displays the first and/or the second animation in accordance with a first animation curve.

In some embodiments, in response to detecting the input, and in accordance with a determination that the input corresponds to an indirect input type, the respective animation curve corresponds to a second animation curve, different from the first animation curve, such as using animation curve 1320 as shown in FIG. 13B in response to detecting attention 1328 target virtual object 1314a, and/or in response to detecting one or more air gestures outside of a threshold distance from virtual object 1314 such as threshold 1348. In some embodiments, the computer system uses a different animation curve to display the first and/or second animation in accordance with a determination that that input directed toward the first and/or second virtual object corresponds to the indirect input type. In some embodiments, indirect inputs include attention of the user directed toward a virtual object concurrently while a selection input is detected, such as an input different from the movement of the portion of the body of the user within the threshold distance. For example, the indirect input optionally includes a pinching air gesture including contact between a plurality of portions of the user's hands, such as touching of two fingers. Additionally or alternatively, the indirect input optionally includes tapping of one or more portions of the housing of the computer system, one or more inputs directed to an input device such as a touchpad or a button on a controller, and/or a blinking immediately after attention is directed toward the virtual object. In some embodiments, the first animation curve and the second animation curve are similar with respect to one or more appearance states. For example, the first animation curve and/or the second animation curve optionally are based upon a same initial appearance state and/or a same end appearance state, and/or some or all intermediate states. Additionally or alternatively, in some embodiments, the second animation curve is different from the first animation curve with respect to a duration of the respective animation curves. Additionally or alternatively, the curves are optionally different with respect to the duration of one or more portions of the respective animation curves. In some embodiments, the shapes of animation curves are similar. For example, the first and second animation curves optionally both include quadratic functions at same relative portions of the curves, but are optionally defined by different scalar multipliers. Using different animation curves for different types of inputs optionally reduces the likelihood that a user erroneously interrupts an animation, thus reducing the time and power consumed with correcting erroneous inputs associated with erroneously interrupting the animation requesting display of an erroneously interrupted animation.

In some embodiments, the first animation curve corresponds to a first duration of time, and wherein the second animation curve corresponds to a second duration of time that is longer than the first duration of time, such as the duration of animation curve 1320 as shown in FIG. 13B and/or the duration of animation curve 1338 as shown in FIG. 13O. For example, the animation curve for direct types of inputs optionally is a time-compressed version of the animation curve for indirect types of inputs (e.g., or vice-versa). In some embodiments, the second duration of time is 5, 10, 15, 20, 25, 40, 50, 60, 75, or 90% greater than the first duration of time. In some embodiments, displaying an animation in response to detecting direct types of input directed to a virtual object includes displaying a same set of appearance states as when the computer system is displaying an animation in response to detecting indirect types of input. For example, the computer system optionally displays the same start appearance state, intermediate appearance state(s), and/or end appearance state when displaying animations based on direct and based on indirect inputs. In some embodiments, a duration of display of an animation is one of many possible differentiating aspects between animations based on the direct and indirect types of input. For example, animations displayed in response to detecting direct input types optionally are performed over one or more first periods of time (e.g., configured by a process associated with the virtual object, such as 1, 2, 3, 4, 5, 6, 7, 10, 15, or 20 seconds), and animations displayed in response to detecting indirect types of input directed to a respective virtual object optionally are performed over one or more second periods of time, optionally greater than or less than the one or more first periods of time (e.g., configured by the process associated with the virtual object, such as 0.5, 1, 2, 3, 4, 5, 6, 7, 10, 15, 20, or 30 seconds). Using an accelerated animation curve for direct types of inputs reduces power consumption otherwise required to display a prolonged version of the same animation and indicates to the user a greater degree of confidence that the direct inputs are directed to virtual content subject to animation by the computer system.

In some embodiments, in response to detecting the input, and in accordance with a determination that the input includes direct input directed to a hardware input device, the respective animation curve is the first animation curve, input directed to such as hand 1344 contacting trackpad 1342 as shown in FIG. 13O. For example, the input directed to the hardware input device optionally includes an input (e.g., selecting a button, a voice command, touching of a trackpad or non-touch sensitive surface, turning of a button, and/or squeezing of a housing of the hardware input device) directed to a hardware input device such as a controller, a button on the controller, a wearable device, a trackpad, a mouse and/or some combination thereof.

In some embodiments, in response to detecting the input, and in accordance with a determination that the input includes direct input that includes an air gesture, the respective curve is the first animation curve, such as hand 1344 moving within threshold 1348 of virtual object 1306 as shown in FIG. 13T. In some embodiments, the computer system uses the same animation curve in response to detecting a direct input including an air gesture (e.g., without detecting attention of the user directed to the respective virtual object) as described above, and in response to detecting input directed to the hardware input device. In some embodiments, in accordance with a determination that the input does not include input directed to the hardware input device, the computer system displays the animation based on the logic described above with reference to direct and/or indirect types of input. Using a same animation curve for direct inputs and inputs directed to hardware input devices lends visual consistency across different input interactions, thus indicating that virtual content with which the user is directly interacting with direct input and/or by specifying via the hardware input device is the target of the interaction, thus reducing the likelihood the animation is erroneously canceled while interacting with the virtual object and reducing processing required to correct for the erroneous cancellation of the animation.

In some embodiments, the respective animation curve spans a respective amount of time, and the respective amount of time is determined by a process (e.g., associated with and/or defined by an application as described further herein) associated with the respective virtual object, such as an amount of time corresponding to animation of virtual object 1360b based on animation curve 1388 as shown in FIG. 13Y. In some embodiments, a process that is associated with a virtual object indicates the duration of an animation for the virtual object. For example, in accordance with a determination that a developer of an application that defines the process indicates the first animation be displayed over the course of a first amount of time, the respective amount of time is optionally the first amount of time. In accordance with a determination that the developer indicates the first animation is displayed over the course of a second amount of time, different from (e.g., greater or less than) the first period of time, the respective amount of time is optionally the second amount of time. In some embodiments, the respective amount of time is defined by a developer of an application. Additionally or alternatively, the first software application and the second software application optionally define a same amount of time. For example, the respective amount of time is optionally a first amount of time when the first software application and/or when the second software application indicate to the computer system that a same amount of time should be used for the respective animation curve. In some embodiments, the respective amount of time is based on a user setting configured in menu for settings defining animation times for various applications. Additionally and/or alternatively, the respective amount of time is based on a setting configured by a developer of the various applications. Customizing the amount of time of an animation based on a corresponding software application optionally reduces the power consumption required to needlessly prolong the animation and/or displays information for a relatively more prolonged period of time to reduce the likelihood the user is not able to view the information, thereby reducing power consumption required to again-display the animation.

In some embodiments, displaying the first virtual object includes displaying a representation of a search field. In some embodiments, displaying the first animation (e.g., and/or displaying the second animation) includes increasing a size of the representation of the search field relative to a three-dimensional environment and displaying one or more search suggestions that are selectable to initiate corresponding searches, such as selectable option 1372 being animated from as shown in FIG. 13FF to as shown in FIG. 13FF including queries 1373 in FIG. 13FF. For example, in response to detecting the attention of the user directed to the first and/or second virtual object, and in accordance with a determination that that the virtual object includes a search field, the computer system optionally expands the search field and/or displays suggestions for the search. Additionally or alternatively, the computer system optionally initiates display and/or enlarges a visual container upon which representations of the search suggestions are displayed. For example, the visual container optionally corresponds to a region in which one or more colors and/or a border are displayed that include representations of suggested searches. In some embodiments, the representation of the search field and/or the visual container increases in one or more dimensions during the animation. In some embodiments, the search suggestions include one or more search proposals which, when selected, cause the computer system to initiate searches using the selected search proposal as a query. For example, the search suggestions for a music player search field optionally includes a plurality of artists and/or songs that the user expressed interest in during previous music playing sessions. Additionally or alternatively, the search suggestions for a mapping application search field optionally include a plurality of recent points of interest viewed while previously using the mapping application. In some embodiments, the representations of suggested searches are displayed within and/or overlaying the search field. In some embodiments, the representations of searches include media such as text, live video, pictures, and/or graphics. Displaying a plurality of content suggestions based on attention directed to the virtual object reduces user input required to specify queries and the processing required to detect the user input.

In some embodiments, displaying the first virtual object includes displaying, via the one or more display generation components, a representation of a respective user of a computer system, different from the computer system, such as representation 1364f as shown in FIG. 13BB.

In some embodiments, displaying the first animation includes displaying, via the one or more display generation components, a current status of the respective user of the respective computer system, such as the display of the information 1366 as shown in FIG. 13DD. In some embodiments, the computer system displays a status of a user associated with another computer system (e.g., separate from the computer system that is displaying the first animation). For example, the status optionally indicates that the user is offline, online, in a call, recently completed a call, and/or is away from their device. In some embodiments, the virtual object corresponds to a representation of the user, such as a picture, a name, a video, and/or a graphic representation of the user displayed concurrently with additional or alternative representations of other users of other devices. In some embodiments, the computer system concurrently displays a plurality of representations of a plurality of users of other devices concurrently, and in response to detecting attention directed to a respective representation of the plurality of representations, displays the current status of a corresponding user. It is understood that description with respect to the first virtual object and/or the first animation optionally applies to the second virtual object and/or the second animation. Including status information in the animation reduces user input otherwise required to locate and display the status information, thus reducing user input required to display the status information and processing required to perform operations in accordance with the user input.

In some embodiments, displaying the first virtual object includes displaying, via the one or more display generation components, respective text prior to detecting the attention of the user directed to the first virtual object. In some embodiments, displaying the first animation includes displaying, via the one or more display generation components, the respective text, such as displaying text included in virtual object 1314a as shown in FIG. 13A and/or as shown in FIG. 13D. For example, displaying an animation of a virtual object optionally includes displaying text (e.g., the respective text) that is partially or entirely not displayed before detecting attention of the user target the virtual object. For example, the text optionally includes some or all of a message, an e-mail, a notification body, a name assigned to a contact saved at the computer system, and/or some combination thereof. In some embodiments, the computer system displays some or all of the text during the first animation. In some embodiments, displaying the second animation includes one or more of the operations described with reference to display of text during the first animation. Displaying text during display of an animation provides information that relates to the virtual object that does not necessarily need to be displayed prior to displaying the animation, thus reducing power consumption of the computer system.

In some embodiments, the respective text displayed while displaying the first animation is a portion of text, such as a portion of text included in the queries illustrated in state 1382c of a search icon and/or field as shown in FIG. 13HH. In some embodiments, the portion of the text is not displayed prior to detecting the attention of the user directed to the first virtual object. In some embodiments, in response to detecting attention of the user directed to the virtual object, the computer system displays a portion of text that is not displayed prior to detecting attention directed to the virtual object (e.g., the respective text). In some embodiments, the truncated text (e.g., the portion of text that is displayed prior to detecting attention directed to the virtual object) is displayed as part of the first animation. In some embodiments, the computer system maintains display of the portion of the text at least until additional or alternative input is detected. For example, while displaying the portion of the text (e.g., a truncated version of the text), the computer system optionally detects an air gesture such as an air pinch and/or detects attention directed to the portion of the text. In response to detecting the air gesture, the computer system optionally displays the remaining portion of the text (e.g., the text is displayed in its entirety). Displaying truncated text optionally reduces the power consumption required to display text in its entirety thus preserving battery and computing resources associated with displaying the text in its entirety.

In some embodiments, the respective text displayed while displaying the first animation corresponds to a message received at the computer system such as a messaged received by computer system 101 as shown in FIG. 13DD.

In some embodiments, the message received at the computer system is not displayed prior to detecting the attention of the user directed to the first virtual object, such as the lack of display of notification 1368 from FIG. 13DD as shown in FIG. 13CC. For example, as described with reference to the display of text that is not displayed prior to the first animation, the computer system optionally partially or entirely does not display a body of a message. In response to detecting attention directed to a notification icon indicative of activity from a related messaging application, the computer system optionally displays an animation including display of some or all of the message body (e.g., the respective text). In some embodiments, additional or alternative notifications or indications are displayed corresponding to different applications than the messaging applications. In some embodiments, the different applications each include messaging functionality. In some embodiments, in response to detecting attention directed to the notifications or indications corresponding to the different applications, the computer system displays text using an animation that is similar to, or the same as described with reference to the messaging application. Thus, the computer system optionally presents previews and/or full messages with a similar or same animation, optionally independently of the specific application that communicated the message. Displaying text corresponding to a message in response to detecting attention allows the computer system to optionally conserve power otherwise required to display the message absent the attention.

In some embodiments, before the attention of the user is directed to the respective virtual object, the respective virtual object is displayed with a first appearance, such as the appearance of virtual objects 1314a through 1314c as shown in FIG. 13A. For example, the computer system displays a virtual object (e.g., the first virtual object and/or the second virtual object) with an appearance before displaying an animation associated with the virtual object based on the respective animation curve.

In some embodiments, while displaying the respective virtual object with a second appearance, wherein the second appearance corresponds to an appearance of the respective virtual object after displaying (optionally at least a portion or all of) the first animation, the computer system detects, via the one or more input devices, the attention (e.g., based on gaze) of the user move away from the respective virtual object, such as attention 1328 move away from virtual object 1314a, such as away from the direction of attention 1328 as shown in FIG. 13D. For example, the computer system optionally displays, via the one or more display generation components, the respective virtual object with a second appearance, different from the first appearance, in response to detecting the attention of the user target the virtual object. For example, the second appearance optionally corresponds to an appearance state that is displayed while displaying an animation of the virtual object, such as an intermediate appearance state or an end appearance state of the virtual object. In some embodiments, the computer system detects attention of the user move to a location in the three-dimensional environment that does not include a portion of the respective virtual object (e.g., attention of the user moves away from the respective virtual object). In some embodiments, displaying the respective virtual object with the second appearance includes some or all of the operations described above with reference to initiating display of text, suggested searches, messages, status of users, and/or additional or alternative displayed content based on attention of the user triggering display of an animation.

In some embodiments, in response to detecting the attention of the user move away from the respective virtual object, the computer system updates display of the respective virtual object from the second appearance to the first appearance, such as displaying virtual object 1314b with the appearance of virtual object 1314b as shown in FIG. 13I. For example, in response to detecting the attention of the user move away from the first virtual object or the second virtual object, the computer system optionally changes appearance of the corresponding virtual object. For example, the computer system optionally displays an expanded version of an application icon with graphics and/or an expanded size while displaying the first animation, and in response to detecting attention of the user move away and while the animation is ongoing, the computer system optionally ceases display of the application icon with the graphics and/or scales down the application icon to assume be a size that was displayed prior to detecting the attention of the user. Additionally or alternatively, the computer system optionally ceases display of content suggestions when attention moves away from a search bar (e.g., displayed during an animation described herein), and/or ceases presenting of audio played concurrently while displaying the animation. Updating display of virtual objects in response to detecting attention move away from the virtual objects optionally reduces power consumption otherwise required to display the animation when the animation is not canceled and indicates that the respective virtual object is no longer a target of the user, thus reducing the likelihood the user erroneously interacts with the respective virtual object, thereby reducing power consumption of the computer system.

In some embodiments, updating display of the respective virtual object from the second appearance to the first appearance is initiated in accordance with a determination that the attention (e.g., based on gaze) of the user has moved away from the respective virtual object for a period of time longer than a time threshold (e.g., 0.005, 0.01, 0.05, 0.1, 0.2, 0.3, 0.5, 1, 1.5, 3, or 5 seconds), such as attention 1328 being directed away from virtual object 1314a as shown in FIG. 13I for off-target time 1332 greater than threshold 1334. For example, in response to detecting the attention of the user move away from the first virtual object and/or the second virtual object, the computer system optionally maintains display of the respective virtual object with the second appearance until the period of time greater than the threshold period of time has elapsed (e.g., after the computer system detects the attention of the user move away from the respective virtual object). Delaying the display of the virtual object with the first appearance after detecting attention move away from the virtual object reduces ceasing of display of the second appearance due to erroneous movement of attention away from the respective virtual object, thereby reducing power consumption required to display the respective virtual object with the second appearance an additional instance.

In some embodiments, in accordance with (and optionally after) a determination that the first animation has concluded in accordance with the respective animation curve, the computer system displays, via the one or more display generation components, the respective virtual object with an end appearance state while one or more criteria are satisfied, wherein the one or more criteria include a criterion that is satisfied while the attention of the user remains directed to the respective virtual object, such as the appearance of virtual object 1314a as shown in FIG. 13G while attention 1328 remains directed to virtual object 1314a. For example, the computer system optionally maintains display (e.g., forgoes changing) of the respective virtual object after displaying the respective virtual object with the end appearance state (e.g., as described further herein) based on the computer system concluding display of the first and/or the second animation. As an example, the computer system optionally displays the first animation, which concludes with display of an application icon with text and a graphic that were not displayed prior to initiating the first animation. In some embodiments, the computer system maintains display of the end appearance state until the one or more criteria are not satisfied. For example, the one or more criteria are optionally not satisfied when attention of the user has been directed away from the respective virtual object for the period of time greater than the threshold period of time, as described above. In some embodiments, the computer system displays the respective virtual object with an initial appearance state in accordance with a determination that the one or more criteria are no longer satisfied. It is understood that description of the first animation and/or the first virtual object optionally apply to additional or alternative animations and/or virtual objects, such as the second animation and/or the second virtual object. Displaying the respective virtual object with the end appearance state preserves display of information potentially relevant to the user, thus reducing user input requesting re-display or expressly requesting maintain display of the information, thereby reducing processing required to perform operations based on the user input.

In some embodiments, while displaying the respective virtual object with the end appearance state, the computer system detects, via the one or more input devices, attention of the user move away from the respective virtual object, such as attention 1328 moving away from virtual object 1314a from as shown in FIG. 13G to as shown in FIG. 13H and/or FIG. 13I. For example, the computer system optionally detects attention (e.g., gaze and/or a cursor) optionally move away from the first and/or second virtual object while displaying the first and/or second virtual object with a respective end appearance state.

In some embodiments, in response to detecting the attention of the user move away from the respective virtual object, initially maintaining display of the respective virtual object with the end appearance state, such as maintaining the appearance state of virtual object 1314a as shown in FIG. 13H. For example, the computer system optionally, at least temporarily, maintains display of the respective virtual object as described herein with reference to the one or more criteria and maintaining of the end appearance state. The computer system optionally maintains the display of the respective object with the end appearance state until the one or more criteria are not satisfied. Preserving the end appearance state after attention moves away from the virtual object preserves display of information potentially relevant to the user while allowing attention to shift within the three-dimensional environment, thus reducing user input requesting re-display or expressly requesting maintain display of the information, thereby reducing processing required to perform operations based on the user input.

In some embodiments, the respective virtual object is displayed with an initial appearance state before detecting attention of the user being directed to the respective virtual object, such as the appearance state of virtual object 1314a as shown in FIG. 13A. For example, the computer system optionally displays the respective virtual object with an appearance that is different from the end appearance state. As an example, the first and/or second virtual objects are optionally displayed with a first size, first content, and/or at first positions prior to displaying corresponding attention-based animations (e.g., the first and/or second animations).

In some embodiments, after initially maintaining the display of the respective virtual object with the end appearance state, in accordance with a determination that the attention of the user has been directed away from the respective virtual object for a period of time greater than a threshold period of time (e.g., 0.005, 0.01, 0.05, 0.075, 0.1, 0.25, 0.3, 0.5, 0.75, 1, or 2 seconds), the computer system displays, via the one or more display generation components, the respective virtual object with the initial appearance state, such as the virtual object 1314a being displayed with the appearance state as shown in FIG. 13I. For example, the computer system optionally changes the appearance of a virtual object after attention has not been directed to a virtual object for the period of time that exceeds the threshold period of time. In some embodiments, in accordance with a determination that the period of time elapsed since attention moves away from the virtual object is greater than the threshold period of time, the computer system displays the virtual object with the initial appearance state. In some embodiments, the transition from displaying the respective virtual object with the end appearance state to displaying the respective virtual object with the initial appearance state is abrupt, or is gradual. For example, the computer system optionally ceases display of the respective virtual object with the end appearance state and/or initiates display of the respective virtual object with the initial appearance state without displaying an animation between the two appearance states and/or without relying upon the respective animation curve. In some embodiments, the computer system gradually transitions between the end and the initial appearance state, such as animating in a direction along the respective animation curve that opposes the transition from display of the initial appearance state to display of the end appearance state. In this way, the computer system optionally reverts display of a virtual object to correspond to an appearance that precedes the display of the attention-based animation. Displaying virtual objects with an appearance after attention remains away from the virtual objects for greater than a threshold amount of time reduces power consumption required to display excess visual content that is less relevant to a current interest of the user.

In some embodiments, the respective animation curve defines a value of a first characteristic of the respective virtual object over time while attention is directed to the respective virtual object, such as a height, opacity, width, and/or brightness of virtual object 1314a based on animation curve 1320 as shown in FIGS. 13A and 13B. For example, the first characteristic includes one or more of the visual characteristics described herein such as scale, opacity, position, brightness, and/or an application of a visual effect and/or a level of the visual effect. In some embodiments, the computer system maintains different animation curve(s) for different set(s) of visual characteristics. For example, the respective animation curve optionally defines the value of the scale, opacity, position (e.g., in a coordinate system corresponding to locations in the three-dimensional environment), brightness, and/or the activation and/or the deactivation of the visual effect over time during the animation. In some embodiments, as attention remains directed to the respective virtual object, the computer system changes the value of the one or more visual characteristics based on the value for the respective animation curve for a given instant of time along the respective animation curve.

In some embodiments, the first animation further follows an additional animation curve, different from the respective animation curve, such as based on animation curve 1338 as shown in FIG. 13O. In some embodiments, the additional animation curve defines a value of a second characteristic of the respective virtual object, different from the first characteristic, over time while attention is directed to the respective virtual object, such as an amount of a blurring effect, a depth, and/or a width of virtual object 1314a that varies based on animation curve 1338 that is shown in FIG. 13O. For example, the additional animation curve optionally has one or more characteristics that are optionally similar to, the same as, different from, and/or correspond to one or more characteristics described with reference to the respective animation curve. In some embodiments, the animation curves (e.g., the respective and “additional” animation curve) comprise different functions, durations, values, and/or some combination of characteristics thereof. For example, a curve defining how opacity changes over time during an animation is optionally different from a curve defining how length changes over time during the same animation. In some embodiments, the computer system maintains a plurality of animation curve for a corresponding plurality of different visual characteristics. In some embodiments, the computer system shares animation curves for some or all of the visual characteristics. In some embodiments, different animation curves reach end appearance states for corresponding one or more visual characteristics at different times.

In some embodiments, different animations curves have different and/or independent initial, intermediate and/or end appearance states, such as if animation curve 1320 as shown in FIG. 13A was based on different appearance states than animation curve 1338 as shown in FIG. 13O. For example, the depth of the respective virtual object is optionally a first value for the initial appearance state at a first time, a second value, different from the first value, for some intermediate appearance state at a second time, and/or a third value, different from the first value and/or the second value, for the end appearance state of the respective virtual object at a third time along the respective animation curve. Additionally or alternatively, the opacity and/or brightness of the respective virtual object is optionally a fourth value for the initial appearance state at a first time (e.g., different from the first value corresponding to depth of the respective virtual object), a fifth value, different from the second and the fourth value, for some intermediate appearance state at the second time, and/or a sixth value, different from the third value, the fourth value, and/or the fifth value, at the end appearance state of the respective virtual object for the third time along the respective animation curve. It is understood that description of the respective and “additional” animation curve optionally applies to some or all embodiments described with reference to the first and/or the second animation, and/or to additional or alternative animations of virtual objects other than the first and the second virtual objects. Maintaining different animation curves for different characteristic(s) of a virtual object improves the granularity by which an animation can visually progress, thus reducing the likelihood that the characteristic(s) change in a manner that would render interaction with the virtual object difficult, thereby reducing cognitive load required to view and interact with the virtual object.

It should be understood that the particular order in which the operations in method 1400 have been described is merely exemplary and is not intended to indicate that the described order is the only order in which the operations could be performed. One of ordinary skill in the art would recognize various ways to reorder the operations described herein. In some embodiments, aspects/operations of method 1400 may be interchanged, substituted, and/or added between these methods. For example, various object manipulation techniques and/or object movement techniques of method 1400 is optionally interchanged, substituted, and/or added between these methods. For brevity, these details are not repeated here.

FIGS. 15A-15U illustrate exemplary ways in which a computer system transitions between media content windows in response to gaze-based inputs in accordance with some embodiments of the disclosure. The user interfaces in FIGS. 15A-15U are used to illustrate the processes described below, including the processes in FIG. 16

FIG. 15A illustrates a computer system 101 (e.g., an electronic device) displaying, via a display generation component 120 (e.g., display generation components 1-122a and 1-122b of FIG. 1), a three-dimensional environment 1500 from a viewpoint of a user of the computer system 101. In FIG. 15A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 15A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1500. For example, three-dimensional environment 1500 includes representations of the rear and side walls of the room in which the computer system 101 is located. As discussed in more detail below, in FIG. 15A, display generation component 120 is illustrated as displaying one or more virtual objects in the three-dimensional environment 1500. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 15A-15U. Display generation component 120 has a field of view (e.g., a field of view captured by external image sensors 114b and 114c and/or visible to the user via display generation component 120) that corresponds to the virtual objects shown in FIG. 15A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

In some embodiments, and as illustrated in FIG. 15A, three-dimensional environment 1500 includes a plurality of virtual windows, such as media user interface 1502 and media user interface 1504. In some embodiments, media user interface 1502 and media user interface 1504 as associated respectively with a first media application and a second media application that is different from the first media application. In some embodiments, both media user interface 1502 and media user interface 1504 both include control interfaces 1506 and 1508 respectively for controlling the user interface (e.g., a close affordance to close the interfaces and a grabber bar for moving the interfaces within the three-dimensional environment). In some embodiments, the first media application and the second media applications are applications that play video content with accompanying audio. In some embodiments, and as described herein, media user interface 1502 and media user interface 1504 play video content with accompanying audio based on the detection attention of the user (e.g., based on gaze).

Media user interface 1502 includes a plurality of video content elements 1502a-d. In some embodiments, each of video content elements 1502a-d represent a video content window that plays a video content item (e.g., a video) when active. As illustrated in the example of FIG. 15A, computer system 101 is playing video content in video content element 1502a, while also presenting audio 1510a (e.g., the audio that accompanies the video content of video content element 1502a). In some embodiments, audio 1510a is presented at a volume as indicated by the glyph associated with audio 1510a. As illustrated in FIG. 15A, the computer system detects the gaze 1501 of the user of computer system is directed to video content element 1502a (e.g., because the user is watching the video content of video content element 1502a). In some embodiments, computer system 101 detects that the gaze 1501 of the user has been directed to video content element 1502a for a duration of time 1514. In some embodiments, computer system 101 transitions between video content elements and/or video content applications based on detecting that the gaze of the user has moved to another video content element/video content application, as illustrated in FIGS. 15B-15E.

As illustrated in FIG. 15B, computer system 101 detects that the gaze 1501 of the user has moved from video content element 1502a to video content element 1502b. In response to detecting the gaze 1501 of the user move to video content element 1502b, computer system 101 resets the time 1514. In the example of FIG. 15B, even though computer system 101 detects that the gaze 1501 of the user is directed to video content element 1502b, the computer system does not play the video content of video content element 1502b nor present the audio 1510b associated with video content element 1502b because the time (e.g., duration) 1514 that the gaze 1501 of the user has been directed to video content element 1502b has not exceed time threshold 1518. However, as illustrated in the example of FIG. 15C-15E, once computer system 101 detects that the time 1514 has exceeded time threshold 1518, the computer system initiates a process to transition playing of video content from video content element 1502a to video content element 1502b.

In the example of FIG. 15C, computer system 101 detects that the time 1514 that gaze 1501 of the user has been directed to video content element 1502b has exceeded time threshold 1518 and in response transitions play of video content from video content element 1502a to video content element 1502b. In some embodiments, and as illustrated in FIG. 15C, the process to transition includes playing the video content of video content element 1502a and video content element 1502b simultaneously (for a period of time), while gradually fading audio 1510a (associated with video content element 1502a) and gradually increasing audio 1510b (associated with video content element 1502b). For instance, as illustrated in FIG. 15C, in some embodiments, computer system begins to play the video content of video content element 1502b without ceasing to play the video content video content of video content element 1502a in response to detecting that time 1514 has exceeded threshold 1518. Optionally, and as illustrated in FIG. 15C, computer system 101 visually deemphasizes video content element 1502a to indicate that playing of video transitioning away from video content element 1502a.

In some embodiments, while playing both the video content of video content element 1502a and video content element 1502b, computer system 101 gradually decreases audio 1510a and gradually increases audio 1510b. Thus, as illustrated in FIG. 15C, the volume of audio 1510a has decreased (as compared to the levels shown in FIGS. 15A-15B), while the volume of audio 1510b has increased. In the example of FIG. 15C, the volume of audio 1510b is less than the audio 1510a, since the transition process has just been initiated, however as illustrated in FIG. 15D, eventually the volume of audio 1510b surpasses the volume of audio 1510a (with audio 1510a) eventually going to zero (e.g., no volume). In some embodiments, and as illustrated in FIG. 15D, and as part of the transition process, computer system 101 ceases playing the video content of video content element 1502a, even while still presenting audio 1510a. In some embodiments, and as part of the transition process, computer system 101 ceases playing video content of video content element 1502a prior to ceasing presenting audio 1510a associated with the video content, but eventually also ceases to present audio 1510a as illustrated in FIG. 15E.

FIG. 15E illustrates the termination of the process of transitioning playing content from video content element 1502a to playing content (both audio and video) from video content element 1502b. As illustrated in FIG. 15E, the process of transitioning play of the video content of video content element 1502a to video content element 1502b terminates with computer system 101 terminating the playing of the video content of video content element 1502a and terminating presenting audio 1510a while continuing to play the video content of video content element 1502b and playing audio 1510b. Thus, as illustrated collectively by FIGS. 15C-15E, in response to detecting the gaze 1501 of the user being directed to video content element 1502b, computer system 101 transitions to video content element 1502b by playing both video content of video content element 1502a and 1502b, while gradually increasing the volume of audio 1510b, gradually decreasing audio 1510a, and eventually terminates playing both video content of video content element 1502a and audio 1510a.

In some embodiments, the process described with respect to FIGS. 15C-15E can be repeated for other video content elements that are associated with the same application, as illustrated in the examples of FIGS. 15F-15H. As illustrated in FIG. 15F, while video content element 1502b is playing video content (in response to the gaze 1501 of the user moving to video content element 1502b as described above), computer system 101 detects gaze 1501 of the user move from video content element 1502b to 1502d. In the example of FIG. 15F, computer system 101 does not yet begin the transition process from video content element 1502b to video content element 1502d because the time 1514 (e.g., which was restarted when computer system 101 detected the gaze 1501 moving to video content element 1502d) has not yet crossed threshold 1518. However, as illustrated in FIG. 15G, once computer system 101 detects that time 1514 has crossed threshold 1518, computer system 101 initiates the transition process from video content element 1502b to playing video content element 1502b. Similar to the example process described with respect to FIGS. 15C-15E, at FIG. 15G, the process is initiated by playing video content of video content 1502d simultaneously with the video content of video content element 1502b. Simultaneously, computer system 101 begins to gradually reduce the volume of audio 1510b, while gradually increasing the volume of audio 1510d.

FIG. 15H illustrates the completion of the process of transitioning from playing video content of video content element 1502b to playing video content of video content 1502d. As illustrated in FIG. 15H, the process is completed when video content from video content element 1502d is playing while video from video content element 1502e has ceased playing, and when audio 1510d is being presented, and audio 1502b is no longer being presented. The example of FIGS. 15A-15H illustrate the process of switching between video content elements within the same application (e.g., different video content elements 1052a-d within the same application), however, the process described with respect to FIGS. 15A-15H can also be applied to transition between playing content items from different applications as illustrated with respect to FIGS. 15-15J.

Turning to the example of FIG. 15I, computer system 101 detects gaze 1501 of the user move from video content element 1502d (e.g., associated with a first application) to media user interface 1504. In some embodiments, media user interface 1504 is associated with a media application that plays video content and is a different application than the application associated with media user interface 1502. As illustrated in FIG. 15I, and similar to the examples of FIGS. 15B, and 15F, even though computer system 101 has detected that the gaze 1501 of the user has moved from video content element 1502d to media user interface 1504, the computer system 101 has not initiated the process for transitioning to paying the video content of media user interface 1504, because gaze 101 has not been detected as being directed to media user interface 1504 for a time 1516 that exceeds threshold 1520. As illustrated in FIG. 15I, the time 1516 starts as soon as computer system 101 detects the gaze 1501 of the user is directed to media user interface 1504.

In some embodiments, the process of transitioning from play video content at video content element 1502a to playing the video content of media user interface 1504 is similar to the process described with respect to FIGS. 15A-15H (e.g., the video content of both interfaces is played simultaneously for a period of time, while the volume of audio 1512 of media user interface 1504 is gradually increased, while volume of audio 1510d is gradually reduced). Eventually, the process terminates as illustrated in FIG. 15J, with video content of media user interface 1504 playing and audio 1512 being presented, while both the video content of video content element 1502d and corresponding audio 1510d are stopped. In some embodiments, the audio of the content item that being transitioned to is increased gradually over time in a non-linear manner as illustrated in FIG. 15K. FIG. 15K illustrates an exemplary time verses volume relationship for a media content item that is being transitioned to. Graph 1522 illustrates two exemplary curves 1524 and 1526 for transitioning audio. Both curves 1524 and 1526 illustrate that the audio of an item is increased non-linearly, with both curves approaching a maximum over time.

In the examples of FIGS. 15A-15J, computer system 101 terminates the playing of a video content item in response to detecting that the attention of the user (e.g., based on gaze) is directed to another video content item. However, as illustrated in the examples of FIGS. 15L-15M, computer system 101 optionally does not transition away from playing a video content item in response to detecting that the gaze of the user 1501 has moved to non-video content items. For instance, in the example of FIG. 15L, a virtual window 1528 is displayed in three-dimensional environment 1500 by computer system 101. In some embodiments, virtual window 1528 is a text-based content window (e.g., such as a web browser) that does not include any video content. In some embodiments, while playing the video content of media user interface 1504, computer system detects gaze 1501 of the user move from the media user interface 1504 (e.g., as was illustrated in FIG. 15J) and move to virtual window 1528. In some embodiments, computer system 101 does not initiate or perform a process to transition away from playing video content of media user interface 1504 even though the computer system has detected that the gaze 1501 of the user has been directed to the virtual window 1528 for a time 1530 that is longer than threshold 1518. Thus, in some embodiments, even though the attention of the user (e.g., based on gaze) is directed to something other than media user interface 1504, computer system 101 does not stop playing the video content of media user interface 1504 (and, optionally, presenting audio 1512) since the attention of the user is not detected as being directed to another video content item.

In some embodiments, in response to detecting the gaze 1501 of the user being directed to virtual window 1528 (and, optionally, in response to an input of the user being directed to virtual window 1528), computer system 101 visually deemphasizes media user interfaces 1504 as illustrated in FIG. 15L, but restores the visual emphasis to virtual window 1528 in response to detecting the gaze 1501 of the user return to media user interface 1504 as illustrated in FIG. 15M. In some embodiments, computer system 101 does not visually deemphasize media user interface 1504 unless the gaze 1501 of the user is directed to an alternative object in three-dimensional environment 1500. For instance, as illustrated in FIG. 15M, in response to detecting the gaze 1501 of the user directed to an empty space 1532 in three-dimensional environment 1500 (e.g., a space that does not contain a virtual content item and/or window), computer system 101 maintains the visual appearance of media user interface 1504 as when the gaze 1501 of the user was directed at the media user interface 1504.

In some embodiments, various notifications and controls can be displayed by computer system 101 without causing an interruption to the playing of video content as illustrated in the examples of FIGS. 15N-15U. For instance, as illustrated in FIG. 15N, in response to detecting attention of the user (e.g., gaze 1501) directed to a lower portion of media user interface 1504, and in response to detecting an air pinch performed by hand 1536, computer system 101 displays a control user interface 1534 that is associated with media user interface 1504. In some embodiments, control user interface 1534 includes one or more user-selectable affordances for controlling playback of the video content of media user interface 1504 (e.g., play, pause, fast forward, and/or rewind). In some embodiments, control user interface 1534 is an “auto-hide” control user interface that automatically ceases to be terminated after it has been displayed for a time 1538 that exceeds a threshold 1540. However, as illustrated in FIG. 15N, computer system 101 continues to display control user interface 1534 even though time 1538 has exceeded threshold 1540 in response to detecting that gaze 1501 of the user continues to be directed to control user interface 1534. In some embodiments, computer system 101 continues to display control user interface 1534 so long as the gaze 1501 is detected as being directed to control user interface 1534. However, in some embodiments, once time 1538 has exceeded threshold 1540, in response to detecting gaze 1501 of the user move away from control user interface 1534, computer system ceases display of control user interface 1534 as illustrated in FIG. 15O. In the example of FIG. 15O, computer system detects that gaze 1501 of the user moves back to a central portion of media user interface 1504 (e.g., away from the bottom portion) and in response ceases display of control user interface 1534. In some embodiments, and as illustrated in both FIGS. 15N-150, the video content of media user interface 1504 continues to play uninterrupted.

In some embodiments, video content continues to play even in the presence of other auto-hide user interfaces. For instance as illustrated in FIGS. 15P-15U, the video content of media user interface 1504 continues to play even when a system notification 1542 is displayed by computer system 101. In the example of FIG. 15P, computer system 101 displays system notification 1542 in response to receiving a text message (or, optionally, another type of message). In some embodiments, computer system 101 displays system notification 1542 to alert the user of the computer system that they have received a message. In some embodiments, system notification 1542 is an auto-hide notification that the computer system ceases to display once the notification has been displayed for a duration that exceeds a time threshold. For example, in response to displaying system notification 1542, computer system 101 begins tracking the time 1544 as illustrated in FIG. 15Q.

In some embodiments, and as illustrated in FIG. 15Q, time 1544 increases but is still shorter than threshold 1546. Thus, computer system 101 continues to display system notification 1542. However, once time 1544 exceeds threshold 1546, computer system 101 ceases to display system notification 1542 as illustrated in FIG. 15R. As illustrated in FIGS. 15P-15R, computer system 101 displays system notification 1542 and auto-hides the system notification, all while continuing to play the video content of media user interface 1504 uninterrupted. In some embodiments, computer system 101 will forgo terminating display of system notification 1542 even when time 1544 has exceeded threshold 1546, in response to determining that the attention of the user (e.g., based on gaze) is directed to the system notification as illustrated in FIG. 15S-T. In the example of FIG. 15S, computer system 101 detects gaze 1501 of the user is directed to system notification 1542. Computer system 101 continues to display system notification 1542 since time 1544 has not crossed threshold 1546 (e.g., the system notification 1542 will not auto-hide because the duration that it has been displayed as not exceeded the threshold amount of time). However, in response to detecting that gaze 1501 of the user continues to be directed to system notification 1542, computer system 101 continues to display system notification 1542 (e.g., forgoes auto-hiding the notification) even though time 1544 exceeds threshold 1546 as illustrated in FIG. 15T.

In the example of FIG. 15T, computer system continues to display system notification 1542 even though time 1544 has exceeded threshold 1546. In some embodiments, computer system 101 continues to play the video content of media user interface 1504 even though computer system 101 has detected that the gaze 1501 of the user has moved away from media user interface 1504 and is instead directed to system notification 1542 as system notification 1542 is not another video content item (e.g., similar to the examples described above). In some embodiments, computer system 101 ceases to display system notification 1542, in response to detecting that both the time 1544 has exceeded threshold 1546, and in response to detecting that gaze 1501 of the user has moved away from system notification 1542 as illustrated in FIG. 15U.

FIG. 16 illustrates a flow diagram illustrating a method 1600 in which an electronic device transitions between playing content items based on a detected attention of the user in accordance with some embodiments of the disclosure. In some embodiments, the method 1600 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, a method 1600 is performed at a computer system in communication with one or more input devices, one or more audio output devices, and one or more display generation components. For example, the computer system is optionally a mobile device (e.g., a tablet, a smartphone, a media player, or a wearable device), or a computer or other electronic device. In some embodiments, the computer system has one or more characteristics of computer systems in methods 800, 1000, 1200, and/or 1400. In some embodiments, the one or more display generation components have one or more characteristics of the display generation components in methods 800, 1000, 1200, and/or 1400. In some embodiments, the one or more input devices have one or more characteristics of the one or more input devices in methods 800, 1000, 1200, and/or 1400.

In some embodiments, while concurrently displaying, via the one or more display generation components, a first content item that is playing and a second content item, different from the first content item, that is playing, and while presenting a first audio associated with the first content item via the one or more audio output devices, the computer system detects (1602) attention (e.g., based on gaze or pointing) of a user of the computer system move to the second content item (e.g., from the first content item), such as computer system 101 detecting that the gaze 1501 of the user moves from video content element 1502a to video content element 1502b while video content element 1502a is playing video content. In some examples, the first content item and/or the second content item share one or more characteristics with the content items described with respect to methods 800, 1000, 1200, and/or 1400. In some embodiments, the one or more content items include video and/or audio. In some embodiments, both the first content item and the second content item are played concurrently. For instance, in an example where both the first content item and the second content item are videos, the computer system plays both videos concurrently. However, optionally, the computer system presents the first audio associated with the first content item, and forgoes presenting audio associated with the second content item. In some embodiments, the computer system displays the first content item and the second content item in a three-dimensional environment (e.g., in a manner similar to displaying a virtual object in a three-dimensional environment as described with reference to the scene 105 in FIG. 1A). For example, the three-dimensional environment is optionally generated, displayed, or otherwise caused to be viewable by the computer system. In some embodiments, the three-dimensional environment is an extended reality (XR) environment, such as a virtual reality (VR) environment, a mixed reality (MR) environment, or an augmented reality (AR) environment. In some embodiments, the first content item and/or the second content item is a user interface element of an application, such as a web browser application or an application other than the web browser application, such as an electronic reading application, media content application, or a platform control application. For example, the first and/or second content items is optionally a window or volume configured to present two-dimensional and/or three-dimensional content that is optionally bounded to the window. In some embodiments, presenting audio refers to playing audio (e.g., making the audio audible) such that the user of the computer system is able to hear the audio while viewing the three-dimensional environment. In some embodiments, the audio is presented by the computer system using one or more audio output devices (e.g., one or more speakers that are part of and/or communicatively coupled to the computer system). In some embodiments the presented audio is associated with a content item. For instance, the first audio is associated with the first content item, and specifically is associated with visual content (e.g., images and/or video) that is being displayed as part of the first content item. As an example, when the first content item is a video, the first audio that is presented by the computer system is audio that corresponds to the displayed video. In some embodiments, the computer system presents the first audio and/or the second audio according to one or more audio characteristics. For instance, the audio characteristics include one or more of a magnitude (e.g., a volume), bass level, treble level, tone, and/or stereo. In some embodiments, the attention of the user (e.g., gaze of the user) shares one or more characteristics of the attention of the user described with respect to methods 800, 1000, 1200, and/or 1400. In some embodiments, the first audio is presented by the computer system in response to detecting that the gaze of the user is directed to the first content item. Thus, in some embodiments, prior to detecting that the gaze of the user is directed to the first content item, the computer system forgoes presenting the first audio, and only begins playing the first audio in response to detecting that the gaze of the user is directed to the first content item.

In some embodiments, in response to detecting the attention of the user of the computer system move to the second content item, the computer system gradually reduces (1604), over time, a value of an audio parameter (e.g., reducing a volume, frequency, or tone) of the first audio being output via the one or more audio output devices such as the audio 1510a associated with video content element 1502a reducing over time in FIGS. 15C-15E. In some embodiments, the computer system detects that the attention of the user (e.g., based on gaze) of the user has moved to the second item upon detecting that the attention of the user has changed from being directed to the first content item to instead being directed to the second content item. Additionally or alternatively, the computer system detects that the attention of the user of the computer system moves from being directed to any location within the three-dimensional environment to being directed to the second content item. In some embodiments, the computer system, in response to detecting that the attention of the user (e.g., based on gaze) is directed to the second content item, initiates a process to cease presenting the first audio associated with the first content item. In some embodiments, the process to cease presenting the first audio includes gradually reducing a value of an audio parameter (e.g., volume and/or tone) associated with an audio of the first content item. In some embodiments, the presentation of an audio (e.g., first audio) includes one or more of magnitude, frequency, tone, and/or other audio quantities. In the example of magnitude, the computer system gradually decreases a magnitude (e.g., volume level) at which the first audio is presented gradually (e.g., over time). For instance, the computer system decreases the magnitude such that it ceases to be presented over a predefined time period (e.g., 0.1, 0.5. 1, 2, 5, or 10 seconds). In some embodiments, while the computer system detects that the gaze of the user is directed to the first content item, the computer system presents the first audio at a first magnitude. In some embodiments, upon or in response to detecting that the gaze of the user is directed to the second content item, the computer system begins to gradually decrease the magnitude of the first audio from the first magnitude until the first audio has ceased to be presented (e.g., the magnitude is 0). In one or more examples, the rate at which the magnitude is decreased (e.g., 0.1 dB/sec, 0.5 dB/sec, 1 dB/sec, 5 dB/sec, 10 dB/sec) is based on an application associated with the first content item and/or a type of content item associated with the first content item. Gradually decreasing the presentation of audio associated with a first content item when the attention of the user moves to a second content item minimizes user perception error associated with listening to audio from a content item that is not the same content item that the user is focused on, thus minimizing input errors from the user associated with the user misinterpreting content due to audio associated with first content item playing while the gaze of the user is directed to the second content item and minimizing the need for manual inputs from the user, thereby conserving computing resources associated with correcting erroneous input from the user and/or manual inputs from the user. Gradually decreasing the presentation of audio as described above also gives the user feedback, and the ability to change course, that the computer system will be switching away from presenting the first audio, thus further reducing errors in interaction with the system.

In some embodiments, in response to detecting the attention of the user of the computer system move to the second content item, the computer system gradually increases, over time, a value of an audio parameter of a second audio being output via the one or more audio output devices, wherein the second audio is associated with the second content item different from the first audio, such as in audio 1510b increasing gradually over time in FIGS. 15C-15E in response to computer system 101 detecting attention of the user directed to video content element 1502b from video content element 1502a. In some embodiments, in addition to gradually reducing the value of an audio parameter associated with the first audio, in response to detecting the attention of the user of the computer system move to the second content, the computer system additionally gradually increases (e.g., over a period of time of 0.1, 0.5, 1, 3, or 5 seconds) a value of an audio parameter of audio that is associated with the second content item (e.g., second audio). Thus, in some embodiments, the computer system simultaneously decreases the audio parameter associated with the first content item while also increasing an audio parameter associated with second content item. In some embodiments, the audio parameter associated with the first content item is the same parameter associated with the second content item. For instance, the computer system decreases a volume (e.g., the audio parameter) associated with the first content item and simultaneously increases the volume associated with the second content item in response to detecting the attention of the user of the computer system move the second content item from the first content item. In some embodiments, the audio parameter associated with the first content item is different (e.g., different type) from the audio parameter associated with the content item. For examples, the computer system gradually decreases the volume of the first content item while simultaneously increasing a bass content of the second content item. Gradually increasing the presentation of audio associated with a second content item when the attention of the user moves to a second content item minimizes user perception error associated with listening to audio from a content item that is not the same content item that the user is focused on, thus minimizing input errors from the user associated with the user misinterpreting content due to audio associated with first content item playing while the gaze of the user is directed to the second content item, thereby conserving computing resources associated with correcting erroneous input from the user. Gradually increasing the presentation of audio as described above also gives the user feedback, and the ability to change course, that the computer system will be switching away from presenting the first audio to presenting the second audio, thus further reducing errors in interaction with the system.

In some embodiments, while concurrently displaying, via the one or more display generation components, the first content item, the second content item, and a third content item, and while the attention of the user is directed to the first content item, in accordance with detecting the attention of the user of the computer system move from the first content item to the second content item, the computer system maintains a value of an audio parameter of the third content item while increasing the value of the audio parameter of the second content item, such as the audio 1510b associated with video content element 1502b increasing over time while audio 1510d associated maintaining a constant value in response to computer system 101 detecting gaze 1501 directed to video content 1502b in FIGS. 15C-15E.

In some embodiments, in accordance with detecting the attention of the user of the computer system move from the first content item to the third content item, the computer system maintains the value of the audio parameter of the second content item while increasing a value of an audio parameter of the third content item, such as if audio 1510d increased over time in FIGS. 15F-15H in response to the computer system 101 detecting the gaze 1501 moving from video content element 1502a to video content element 1502d. In some embodiments, the computer system increases the audio parameter of a content item based on which content item the attention (e.g., based on gaze) of the user is detected as being directed to. As an example, in a scenario in which three content items (e.g., a first content item, a second content item, and a third content item) are displayed in the three-dimensional environment, when the computer system detects that the attention of the user moves from the first content item to the second content item, the computer system decreases the audio parameter of the first content item while increasing the audio parameter of the second content item, and also while maintaining the audio parameter of the third content item at a value that the audio parameter had prior to the computer system detecting the attention of the user moving from the first content item to the second content item. In some embodiments, the value of the third content item is zero (e.g., no audio associated with the third content item is being played). Alternatively, if the computer system detects that attention of the user moves from the first content item to the third content item, the computer system optionally decreases the audio parameter of the first content item while increasing the audio parameter of the third content item, and also while maintaining the audio parameter of the second content item at a value that the audio parameter had prior to the computer system detecting the attention of the user moving from the first content item to the third content item. In some embodiments, in response to detecting the attention of the user from one content item to another, the computer system decreases the audio parameter associated with the content item from where the attention moved from and increases the audio parameter associated with the content item from where the attention moved to. Thus, as an example, in response to detecting the attention of the user moving from the second content item to the third content item, the computer system decreases the audio parameter of the second content item, increases the audio parameter of the third content item, while maintaining the value of the audio parameter associated with the first content item. Gradually increasing the presentation of audio associated with a content item based on where the attention of the user is detected as moving to minimizes user perception error associated with listening to audio from a content item that is not the same content item that the user is focused on, thus minimizing input errors from the user associated with the user misinterpreting content due to audio associated with first content item playing while the gaze of the user is directed to the second content item, thereby conserving computing resources associated with correcting erroneous input from the user. Gradually increasing the presentation of audio as described above also gives the user feedback, and the ability to change course, that the computer system will be switching away from presenting the first audio to presenting the second or third audio, thus further reducing errors in interaction with the system.

In some embodiments, in response to detecting the attention of the user of the computer system move to the second content item, while gradually reducing, over time, the value of the audio parameter of the first audio being output via the one or more audio output devices, the computer system at least partially presents audio of the second content item, such as audio 1510a associated with video content element 1502a playing concurrently with audio 1510 associated with video content element 1502b in FIGS. 15C-15D. In some embodiments, the computer simultaneously reduces the value of the audio parameter of the first audio while simultaneously presenting audio of the second content item such that at least for a duration of time the computer system concurrently presents audio associated with the first content item and audio associated with the second content item. In some embodiments, and in an example where the computer system displays a first content item, a second content item, and a third content item concurrently, in response to detecting the attention of the user of the computer system move to the second content item from the first content item, the computer system gradually reduces the value of the audio parameter associated the first content item while concurrently presenting audio from both the second content item and the third content item. Gradually decreasing the audio parameter associated with the first content item, while concurrently presenting audio of other content items minimizes user perception error associated with listening to audio from a content item that is not the same content item that the user is focused on, thus minimizing input errors from the user associated with the user misinterpreting content due to audio associated with first content item playing while the gaze of the user is directed to the second content item, thereby conserving computing resources associated with correcting erroneous input from the user. Gradually increasing the presentation of audio as described above also gives the user feedback, and the ability to change course, that the computer system will be switching away from presenting the first audio to presenting the second or third audio, thus further reducing errors in interaction with the system.

In some embodiments, gradually increasing the value of the audio parameter of the second audio over time includes increasing, in a non-linear manner, the value of the audio parameter of the second audio being output via the one or more audio output devices, such as the manner depicted by curves 1524 and 1526 in FIG. 15K. In some embodiments, a non-linear manner refers to the relationship between the value of the audio parameter of the second audio and time. Thus, in one or more examples, the audio parameter of the second audio increases non-linearly as time progresses. In some embodiments, the non-linear manner includes but is not limited to: exponential, cubic, quadratic, and/or logarithmic increases in the audio parameter of the second audio over time. Increasing the audio parameter associated with the second content item in a non-linear manner minimizes user perception error associated with listening to audio from a content item that is not the same content item that the user is focused on, thus minimizing input errors from the user associated with the user misinterpreting content due to audio associated with first content item playing while the gaze of the user is directed to the second content item, thereby conserving computing resources associated with correcting erroneous input from the user. Gradually increasing the presentation of audio as described above also gives the user feedback, and the ability to change course, that the computer system will be switching away from presenting the first audio to presenting the second or third audio, thus further reducing errors in interaction with the system.

In some embodiments, gradually increasing the audio parameter of the second audio includes gradually increasing the audio parameter of the second audio in accordance with a determination that (or in response to detecting that) the attention of the user of the computer system has been directed to the second content item for longer than a pre-determined time threshold such as the increase in audio 1510b not commencing until time 1514 is beyond threshold 1518 in FIG. 15C. In some embodiments, the gradual increase of the audio parameter is delayed by the computer system until the computer system determines that the attention of the user (e.g., based on gaze) has been directed to the second content item for longer than the pre-determined time threshold (e.g., 0.01, 0.02, 0.05, 0.1, 0.5, 1, 2, or 5 seconds). In some embodiments, the computer system also delays decreasing the audio parameter of the first audio until the attention of the user has been directed to the second content item for longer than the pre-determined time threshold. In some embodiments, in response to detecting that the attention of the user (e.g., based on gaze) moves away from the second content item before the time threshold has been exceeded, the computer system forgoes increasing the audio parameter of the second audio. Additionally, the computer system optionally forgoes decreasing the audio parameter of the first audio in response to determining that the attention of the user has moved away from the second content item for less than the pre-determined time threshold. Delaying increasing the audio parameter associated with the second content item until the attention of the user has been directed to the second content item for longer than a pre-determined threshold of time minimizes errors associated with unintentional and/or momentary shifts of attention to other content items, thus minimizing input errors from the user associated with the user momentarily directing attention to the second content without intending to listen to the audio associated with the second content item, thereby conserving computing resources associated with correcting erroneous input from the user. Gradually increasing the presentation of audio as described above also gives the user feedback, and the ability to change course, that the computer system will be switching away from presenting the first audio to presenting the second or third audio, thus further reducing errors in interaction with the system.

In some embodiments, the first content item is associated with a respective application, such as content item 1502a that is displayed on media user interface 1502 that is associated with a first application in FIG. 15D, and the second content item is also associated with the respective application, such as content item 1502b that is displayed on media user interface 1502 that is associated with the same application as content item 1502a in FIG. 15D. In some embodiments, the first content item and the second content items are generated by and/or displayed by a common software application (e.g., the respective application). As an example, the first content item and the second content are both generated by a common media application that plays media content items. Thus, in the same example, the first content item is a media content item, and the second content item is a media content item that are both associated with the same media application. In some embodiments, the first content item and the second content item are displayed in the same application window and/or user interface. Additionally or alternatively, the first content item and the second content item are displayed in separate application windows and/or user interfaces. Presenting audio from multiple content items associated with the same application based on where the attention of the user is directed, allows for the user to switch between multiple content items from a common application while minimizing perception errors associated with the user misperceiving that audio from a first content item is associated with the second content item and vice versa, thereby conserving computing resources associated with correcting erroneous input from the user.

In some embodiments, the first content item is associated with a first application, and the second content item is associated with a second application, different from the first application, such as media user interface 1502 being associated with a first application, and media user interface 1504 being associated with a different second application in FIG. 15J. In some embodiments, the first content item and the second content items are generated by and/or displayed by different software applications (e.g., the first application and the second application). As an example, the first content item is associated with a media application while the second content item is associated with a photo application. Thus, in the same example, the first content item is a media content item, such as a movie or television show, and the second content item is a video content item that are each associated with different applications. Presenting audio from multiple content items associated with different software applications based on where the attention of the user is directed, allows for the user to switch between multiple content items from a different applications while minimizing perception errors associated with the user misperceiving that audio from a first content item is associated with the second content item and vice versa, thereby conserving computing resources associated with correcting erroneous input from the user.

In some embodiments, the first content item is a video content item, and the second content item is also a video content item, such as the video content items being played at video content element 1502a and video content element 1502b in FIG. 15C. In some embodiments, the first content item and the second content items are associated with applications that manage video content. For instance, in one example, the application is a movie application and the first content item, and the second content item are different movies that are both managed by the movie application. As an additional example, the first content item and the second content items are associated with a photo application that includes video content, and the first and second content items are both videos that are managed by the photo application. In some embodiments, the first content item and second content item are different types of video content items including but not limited to movies, television shows, video recorded by the computer system, and/or videos created in a video editing application. Presenting audio from multiple video content items based on where the attention of the user is directed, allows for the user to switch between multiple content items from different applications while minimizing perception errors associated with the user misperceiving that audio from a first video content item is associated with the second video content item and vice versa, thereby conserving computing resources associated with correcting erroneous input from the user.

In some embodiments, displaying the first content item includes playing video content of the first content item. In some embodiments, in response to detecting the attention of the user of the computer system move to the second content item from the first content item, the computer system ceases playing of the video content of the first content item, such as the video content of video content element 1502a ceasing to be played in FIG. 15D. In some embodiments, in addition to gradually reducing the value of the audio parameter of the first audio over time, the computer system also pauses the video content (e.g., pauses playback of the video content) of the first content item. In some embodiments, the audio of the first content item is presented even though the video content of the first item is paused. Alternatively, in some embodiments, the video content is paused only after the computer system completes the process of gradually reducing the value of the audio parameter of the first audio over time. In some embodiments, while the video content of the first content item is playing, video content associated with the second content item is paused. In some embodiments, when the computer system pauses the video content of the first content item (e.g., in response to detecting the attention of the user of the computer system move to the second content item), the computer concurrently un-pauses (e.g., plays) the video content of the second content item. Pausing video content of the first content item in response to detecting the attention of the user moving to the second content item, minimizes perception errors associated with the user misperceiving that audio from a first video content item is associated with the second video content item and vice versa, thereby conserving computing resources associated with correcting erroneous input from the user.

In some embodiments, gradually reducing the value of the audio parameter of the first audio over time includes ceasing presentation of the first audio (optionally with the first audio parameter) via the one or more audio output devices, and the ceasing playing of the video content occurs prior to the ceasing presentation of the first audio (optionally with the first audio parameter), such as the video content of video content element 1502a stopping while the associated audio 1510a is still playing in FIG. 15D. In some embodiments, the computer system pauses the video content of the first content item concurrently with initiating reducing the value of the audio parameter of the first audio over time, such that the video content is paused while the first is audio is still being presented and before the first audio has ceased being presented as part of the process of gradually reducing the value of the audio parameter of the first audio over time. Alternatively, in some embodiments, the video content is paused during the process of gradually reducing the audio parameter of the first audio over time but is not paused when the process of gradually reducing the value of the audio parameters is initiated. Pausing video content of the first content item before ceasing presentation of the first audio in response to detecting the attention of the user moving to the second content item, minimizes perception errors associated with the user misperceiving that audio from a first video content item is associated with the second video content item and vice versa, thereby conserving computing resources associated with correcting erroneous input from the user.

In some embodiments, in response to detecting the attention of the user of the computer system move to the second content item, the computer system initiates playing, via the one or more display generation components, of video content of the second content item, such as the video content of video content element 1502b being played in response to computer system 101 detecting gaze 1501 of the user move to video content element 1502b in FIG. 15C. In some embodiments, initiating playback (e.g., playing) of video content includes un-pausing paused video content of the second content item. Additionally or alternatively, initiating playback of video content of the second content item includes starting the video content from a beginning point (e.g., the start of the video content) in response to detecting the attention of the user (e.g., based on gaze) of the computer system move to the second content item. In some embodiments, the video content of the second content item plays concurrently with the audio and/or video content of the first content item. Playing video content of second content item in response to detecting the attention of the user moving to the second content item, minimizes perception errors associated with the user misperceiving that audio from a first video content item is associated with the second video content item and vice versa, thereby conserving computing resources associated with correcting erroneous input from the user.

In some embodiments, in response to detecting the attention of the user of the computer system move to the second content item, the computer system gradually increases, over time, a value of an audio parameter of a second audio being output via the one or more audio output devices. In some embodiments, the second audio is associated with the second content item, different from the first audio, and gradually increasing the value of the audio parameter begins prior to initiating playing of the video content of the second content item, such as if in FIG. 15C audio 1510 began increasing prior to the video content of video content element 1502b being played in response to the computer system detecting gaze 1501 of the user moving to video content element 1502b. In some embodiments, initiating display of video content of the second content item occurs after a threshold of time after the second audio associated with the second content item begins gradually increasing (e.g., 0.1, 0.5, 1, or 5 seconds). In some embodiments, if the second audio ceases to be played prior to the threshold of time expiring, for instance if the attention of the user (e.g., based on gaze) moves to another content item other than the second content item, then the computer system forgoes initiating playing of the video content of the second item. Playing video content of second content item after the audio of the second item begins playing, minimizes perception errors associated with the user misperceiving that audio from a first video content item is associated with the second video content item and vice versa, thereby conserving computing resources associated with correcting erroneous input from the user.

In some embodiments, initiating display of the video content of the second content item begins prior to the audio parameter of the second audio reaching a target (optionally a maximum) value, such as the video content of video content element 1502b being played in FIG. 15C prior to audio 1510b reaching full volume in FIG. 15E. In some embodiments, the video content of the second content begins playing during the process of gradually increasing the audio parameter of the second audio such that the video content of the second content item starts playing prior to the audio parameter of the second audio reaching a target value, such as a maximum value of the audio parameter. Using volume as an example of the audio parameter, in some embodiments, the video content of the second content item begins playing after the second audio begins playing and while the volume of the second audio is gradually increasing. In some embodiments, the video content of the second content item begins playing before the volume of the second audio has reached a maximum level. In some embodiments, the computer system continues to play the video content of the second content item even after the audio parameter of the second audio reaches the maximum value. In some embodiments, the target value refers to a threshold value (e.g., 10%, 20%, 50%, 75%, and/or 100% of the maximum value of the audio parameter). Playing video content of second content item after the audio of the second item begins playing but before the audio parameter of the second audio reaches a maximum value, minimizes perception errors associated with the user misperceiving that audio from a first video content item is associated with the second video content item and vice versa, thereby conserving computing resources associated with correcting erroneous input from the user.

In some embodiments, the first content item and the second content item correspond to an immersive experience, such as is if media user interface 1502 was associated with an immersive experience in FIG. 15A. In some embodiments, an immersive experience refers to a user interface and/or an application that when executed by the computer system displays a three-dimensional environment associated with the application at full immersion (e.g., as described herein) or that occupies more than a threshold amount of immersion (e.g., greater than 30%, 40%, 50%, 75%, 90%). In some embodiments, an immersive experience included one or more visual elements that are places a plurality of spatial locations within the three-dimensional environment. In some embodiments, the immersive experience shares one or more characteristics with the immersive application described with respect to method 1200. In some embodiments, the computer system displays the first content item and the second content item in an immersive viewing environment, such as in a cinematic environment that the computer system simulates and displays via the display generation component. In some embodiments, the first content item and the second content item are immersive media content items and/or three-dimensional media content items, such that the computer displays the media content items in a manner that allows a user of the computer system to observe the media content items from different perspectives (e.g., different viewpoints and depths). Gradually decreasing the presentation of audio associated with a first content item when the attention of the user moves to a second content item when the first content item and the second content item correspond to an immersive experience minimizes user perception error associated with listening to audio from a content item that is not the same content item that the user is focused on, thus minimizing input errors from the user associated with the user misinterpreting content due to audio associated with first content item playing while the gaze of the user is directed to the second content item, thereby conserving computing resources associated with correcting erroneous input from the user. Gradually decreasing the presentation of audio as described above also gives the user feedback, and the ability to change course, that the computer system will be switching away from presenting the first audio, thus further reducing errors in interaction with the system.

In some embodiments, in response to detecting the attention of the user of the computer system move to the second content item, the computer system increases, via the one or more display generation components, a visual prominence of the second content item relative to the first content item, such as the visual prominence of visual prominence of video content element 1502b relative to the visual prominence of video content element 1502a in FIG. 15C. In some embodiments, increasing a visual prominence of the second content item relative to the first content item includes increasing one or more visual characteristics associated with the second content item relative to the first content item including, but not limited to brightness, opacity, tone, and/or color saturation. In some embodiments, increasing the visual prominence of the second content item relative to the first content item includes increasing the one or more visual characteristics of the second content item while simultaneously decreasing the same and/or different visual characteristic(s) of the first content item. In some embodiments, increasing the visual prominence of the second content item relative to the first content item includes decreasing one or more visual characteristics of the first content item. In some embodiments, the one or more visual characteristics include the visual characteristics described with respect to increasing the visual prominence of the second content described herein. Increasing the visual prominence of the second content item relative to the first content when the attention of the user is directed to the second content item, decreases the likelihood of the user misperceiving which content item is playing, thus minimizing input errors from the user associated with the user misinterpreting content due to audio associated with first content item playing while the gaze of the user is directed to the second content item, thereby conserving computing resources associated with correcting erroneous input from the user.

In some embodiments, gradually reducing the value of the audio parameter of the first audio over time occurs in response to detecting the attention of the user move to the second content, and a determination that the attention of the user is directed to the second content item for longer than a threshold amount of time, such as audio 1510b associated with video content element 1502b gradually increasing and audio 1510a associated with video content element 1502a gradually decreasing in response to the computer system 101 detecting that the gaze 1501 of the user has been directed to video content element 1502b for a time 1514 that is longer than time threshold 1518. In some embodiments, the computer system forgoes initiating the process of gradually reducing the value of the audio parameter of the first audio until the computer system detects that the attention of the user (e.g., based on gaze) is directed to the second content item for longer than a threshold amount of time (e.g., 0.1, 0.2, 0.5, 1, or 5 seconds). In some embodiments, if the computer system detects that the attention of the user ceases to be directed to the second content item before the threshold amount of time is exceeded, the computer system forgoes gradually reducing the value of the audio parameter of the first audio and maintains the value of the audio parameter to the value that it had prior to the computer system determining that the attention of the user was directed to the second content item. Delaying reduction of the audio parameter of the first audio until detecting the attention of the user has been directed to the second content item for longer than a threshold of time decreases the likelihood of the user misperceiving which content item is playing, thus minimizing input errors from the user associated with the user misinterpreting content due to audio associated with first content item playing while the gaze of the user is directed to the second content item, thereby conserving computing resources associated with correcting erroneous input from the user.

In some embodiments, the first content item and the second item play concurrently while the gradual reduction, over time, of the value of the audio parameter of the first audio occurs, such as the video content of video content element 1502a and the video content of video content element 1502b playing concurrently in FIG. 15C. In some embodiments, in response to detecting that the attention of the user (e.g., based on gaze) moves from the first content item to the second content item, the computer system gradually reduces the value of the audio parameter while playing both the second content item and first content item concurrently. In some embodiments, the computer system begins playing the second content item in response to detecting that the attention of the user (e.g., based on gaze) is directed to the second content item. Concurrently, the computer system optionally continues playing the first content item while also gradually reducing the value of the audio parameter of the first audio, such that three things optionally occur concurrently: (1) the first content item is playing, (2) the second content item is playing, and (3) the audio parameter of the first audio is reducing. In some embodiments, the computer system ceases playing the first content item when the audio parameter of the first audio falls below a threshold (e.g., 1, 0.5, 0.25, 0.1, or 0.01 dB) and/or falls to 0 (e.g., the volume of the first audio goes to 0 dB). Concurrently playing the first content item and the second content item while the audio parameter of the first audio decreases, decreases the likelihood of the user misperceiving which content item is playing and/or which audio pertains to a particular content item, thus minimizing input errors from the user associated with the user misinterpreting content due to audio associated with first content item playing while the gaze of the user is directed to the second content item, thereby conserving computing resources associated with correcting erroneous input from the user.

In some embodiments, while concurrently displaying the first content item, the second content item, and a user interface element, in accordance with a determination that the user interface has been displayed for longer than a threshold amount of time and that the attention of the user is directed to the user interface element, the computer system maintains display of the user interface element, such as computer system 101 maintaining display of control user interface 1534 due to detecting gaze 1501 being directed to control user interface 1534 even though time 1538 has exceeded threshold 1540 in FIG. 15N.

In some embodiments, while concurrently displaying the first content item, the second content item, and a user interface element, in accordance with a determination that the user interface has been displayed for longer than a threshold amount of time and that the attention of the user is not directed to the user interface element, the computer system ceases display of the user interface element, such as computer system 101 ceasing display of control user interface 1534 in FIG. 15O. In some embodiments, the user interface element is an “autohide” user interface that the computer ceases displaying in response to detecting that the attention of the user is no longer directed to the user interface after the user interface element has been displayed for longer than a threshold amount of time (e.g., 0.1, 0.5, 1, 3, or 5 seconds). In some embodiments, the user interface element is overlaid on either the first content item or the second content item. Additionally and/or alternatively, the user interface element is a stand-alone user interface (e.g., the user interface is displayed independently from the first content item and/or the second content item. Autohiding user interface elements in response to detecting that the attention of the user has moved away from the user interface element after the user interface element has been displayed longer than a threshold amount of time, decreases visual clutter when interacting with a content item and thus reduces the likelihood of the user misperceiving or erroneously interacting with a content item, thereby conserving computing resources associated with correcting erroneous input from the user.

In some embodiments, the user interface element includes a control interface overlaid on the second content item, such as control user interface 1534 overlaid on media user interface 1504 in FIG. 15N. In some embodiments, the control interface being overlaid on the second content item refers to the control interface being displayed at a location in the three-dimensional environment that corresponds to a location where at least a portion of the second content item is displayed. In some embodiments, the control interface obscures at least a portion of the second content item when displayed. In some embodiments, examples of the control interface include but are not limited to media player controls (e.g., controls to play, pause, fast forward, and/or rewind media content) associated with a media application. In some embodiments, the control interface includes one or more selectable affordances. Using the media control interface example, the control interface includes a plurality of selectable affordances to control the media being played on the second content item (e.g., fast forward, rewind, and/or stop). In response to detecting that a selectable affordance has been selected by the user (e.g., detecting the attention of the user directed to the selectable affordance while performing an air pinch), the computer system performs the operation associated with the selectable affordance. Additionally and/or alternatively, the control interface includes communication session controls (e.g., controls to initiate a communication session, stop a communication session, and/or change one or more settings with respect to the communication session). Autohiding control interfaces of a content item in response to detecting the attention of the user move away from the control interface, decreases visual clutter when interacting with a content item and thus reduces the likelihood of the user misperceiving or erroneously interacting with a content item, thereby conserving computing resources associated with correcting erroneous input from the user.

In some embodiments, the user interface element includes a notification user interface, such as system notification 1542 in FIG. 15P. In some embodiments, the notification user interface includes textual and/or visual information associated with a status or condition of the computer system and/or one or more application that are being executed by the computer system. For instance, the notification optionally includes information about a message received at the computer system (e.g., a text message or other communication message). In some embodiments, the notification user interface includes notification information pertaining to a status of the computer system. Autohiding a notification user interface in response to detecting the attention of the user move away from the notification or after a threshold amount of time has been exceeded, decreases visual clutter when interacting with the computer system and thus reduces the likelihood of the user misperceiving or erroneously interacting with a content item, thereby conserving computing resources associated with correcting erroneous input from the user.

In some embodiments, while displaying the second content item that is playing, and while presenting a second audio associated with the second content item, the computer system detects, via the one or more input devices, the attention of the user of the computer system move to a first location within a three-dimensional environment, wherein the first location does not correspond to a content item, such as computer system 101 detecting gaze 1501 move to empty space 1532 in FIG. 15M. In some embodiments, the first location is a location within the three-dimensional environment that is not associated content being displayed from an application of the computer system. For instance, in one example, the first location is a space (e.g., empty space in the three-dimensional environment) between the second content item and a third content item. In some embodiments, the first location pertains to a portion of the three-dimensional environment where a non-content item is being displayed (e.g., a settings menu, a text document, and/or a system notification).

In some embodiments, in response to detecting the attention of the user of the computer system move to the first location, the computer system forgoes reducing a value of an audio parameter of the second audio over time such shown in FIG. 15M by computer system 101 maintaining the volume of audio 1512 in response to detecting gaze 1501 move to empty space 1532 in FIG. 15M. In some embodiments, the second content item continues to play with a constant value of the audio parameter (e.g. volume) of second audio until the computer system detects that the attention of the user has moved to another content item that is being displayed. In some embodiments, in response to detecting that the attention of the user has moved to another content item, the computer system gradually reduces the value of the audio parameter of the second audio and subsequently ceases reducing the value in response to detecting that the attention of the user has moved to a portion of the three-dimensional environment not associated with a content item. Thus, in some embodiments, the process of reducing the audio parameter of the second audio is interrupted and terminated if the computer system determines that the attention of the user has moved to a non-content item. Continuing to play audio from a content item even when the computer system detects attention of the user move to a non-content item, decreases errors associated with ceasing and/or interrupting the playing of content items when the user inadvertently looks away from a content item and thus reduces the likelihood of the user misperceiving or erroneously interacting with a content item, thereby conserving computing resources associated with correcting erroneous input from the user.

It should be understood that the particular order in which the operations in method 1600 have been described is merely exemplary and is not intended to indicate that the described order is the only order in which the operations could be performed. One of ordinary skill in the art would recognize various ways to reorder the operations described herein. In some embodiments, aspects/operations of method 1600 may be interchanged, substituted, and/or added between these methods. For example, various object manipulation techniques and/or object movement techniques of method 1600 is optionally interchanged, substituted, and/or added between these methods. For brevity, these details are not repeated here.

FIGS. 17A-17F illustrate exemplary ways in which a computer system adjusts characteristics of gaze scrolling regions of content based on characteristics of the content. The user interfaces in FIGS. 17A-17F are used to illustrate the processes described below, including the processes in FIG. 18.

FIG. 17A illustrates a computer system 101 (e.g., an electronic device) displaying, via a display generation component 120 (e.g., display generation components 1-122a and 1-122b of FIG. 1), a three-dimensional environment 700 from a viewpoint of a user of the computer system 101. In FIG. 17A, the computer system 101 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Computer system 101 also includes external image sensors 314b and 314c facing outwards from the user to detect and/or capture the physical environment and/or movements of the user's hands.

As shown in FIG. 17A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 700. For example, three-dimensional environment 700 includes representations of the rear and side walls of the room in which the computer system 101 is located.

As discussed in further detail below, in FIG. 17A, display generation component 120 is illustrated as displaying one or more virtual objects in the three-dimensional environment 700. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 17A-17F.

In FIG. 17A, three-dimensional environment 700 includes virtual object 704a. Three-dimensional environment 700 and virtual object 704a optionally have one or more of the characteristics of three-dimensional environment 700 and virtual object 704a in FIGS. 7A-7BB. In FIG. 17A, virtual object 704a is an internet browsing user interface element (e.g., also referred to as a window or volume) of a web browser application containing website content, such as text, images, video, hyperlinks, and/or audio content, from the website.

Virtual object 704a in FIG. 17A includes content, some of which is scrollable content, and some of which is not scrollable content. Scrollable content and non-scrollable content are described in more detail with reference to methods 800, 1000 and/or 1800. In FIG. 17A, all of the content included in virtual object 704a is scrollable except for content 704a′, which is optionally not scrollable. Content 704a′ is optionally content such as a navigation pane for the website, a side bar for the website, or other portion of the content displayed in virtual object 704a that does not scroll even when the remainder of the content is scrolled (e.g., in response to user input). For example, in response to detecting attention of the user directed to the content inside virtual object 704a and an air pinch and drag gesture from a hand of the user, the computer system 101 scrolls the content inside virtual object 704a in accordance with the direction and/or magnitude of the movement of the hand, without scrolling content 704a′. Additional details about scrolling content based on air gesture inputs are described with reference to methods 800, 1000 and/or 1800.

As described with reference to methods 800, 1000 and/or 1800, computer system 101 optionally facilitates gaze-based scrolling of scrollable content. To facilitate such scrolling, computer system 101 optionally establishes one or more regions of the content within virtual object 704a as gaze-enabled scrolling regions, where gaze of the user directed to those regions will cause computer system 101 to scroll the content within virtual object 704a, except for content 704a′, as described in more detail with reference to methods 800, 1000 and/or 1800. In some embodiments, computer system 101 determines spatial characteristics (e.g., size, shape and/or placement) of these gaze-enabled scrolling regions based on characteristics of the content included in virtual object 704a; and specifically, based on characteristics of the non-scrollable content 704a′ included in virtual object 704a, as will be described in greater detail below.

The bottom portion of FIG. 17A illustrates a schematic 701 representation of virtual object 704a and various regions related to gaze scrolling that will now be described. In some embodiments, in the absence of determining gaze scrolling regions based on characteristics of the underlying content in virtual object 704a, computer system 101 optionally establishes default baseline gaze scrolling regions 704b and 704c at one or more locations relative to virtual object 704a based on the direction of scrolling of the content within virtual object 704a. For example, in FIG. 17A, the content in virtual object 704a is vertically scrollable. Therefore, computer system 101 would optionally establish baseline region 704b at the top edge of virtual object 704a for scrolling the content in an upward direction in response to detecting gaze of the user directed to baseline region 704b, and baseline region 704c at the bottom edge of virtual object 704a for scrolling the content in a downward direction in response to detecting gaze of the user directed to baseline region 704c. However, because the content in virtual object 704a includes non-scrollable content 704a′, computer system 101 optionally establishes an exclusion region 704q (corresponding to the size, shape and/or placement of non-scrollable content 704a′). The computer system 101 optionally automatically (e.g., without user input) determines the size, shape and/or placement of exclusion region 704q based on the size, shape and/or placement of non-scrollable content 704a′ and/or other characteristics of the content included in virtual object 704a, as described in more detail with reference to method 1800. Because of the size, shape and/or placement of non-scrollable content 704a′, computer system 101 establishes exclusion region 704q within the boundaries of baseline region 704b. In response to detecting gaze of the user directed to exclusion region 704q, the computer system 101 optionally does not scroll the content in virtual object 704a, even though exclusion region 704q is otherwise included within the boundaries of baseline region 704b.

Because of the placement of exclusion region 704q, the area available for gaze scrolling in virtual object 704a is reduced, as shown in schematic 701. Therefore, computer system 101 optionally modifies the shape and/or area of gaze-enabled regions of virtual object 704a to increase the area available for gaze scrolling in virtual object 704a, as shown in schematic 701′. In particular, because exclusion region 704q (corresponding to non-scrollable content 704a′) is contained completely within baseline region 704b, computer system 101 expands the gaze scrolling region at the top edge of virtual object 704a by extended region 704b′. Extended region 704b′ has an area equal to the area of exclusion region 704q. Further, extended region 704b′ is adjacent to and contiguous with baseline region 704b, as shown in schematic 701′. Further, extended region 704b′ spans the width of virtual object 704a, as does baseline region 704b. Therefore, the total area available for gaze scrolling at the top edge of virtual object 704a (e.g., corresponding to baseline region 704b surrounding exclusion region 704q, and extended region 704b′) is optionally the same as the total area of baseline region 704b if exclusion region 704q were not included within and/or overlapping with baseline region 704b. Computer system 101 optionally does not modify baseline region 704c, because no exclusion region is included within and/or overlaps with baseline region 704c. In FIGS. 17A-17F, and in method 1800, the gaze scrolling regions and the modified gaze scrolling regions are described and illustrated in terms of baseline regions and extended regions, to facilitate description of the various examples; however, it is understood that one or more baseline regions and one or more extended regions that are adjacent to each other or overlapping are optionally a single contiguous region, and together can be considered to be single, modified (e.g., expanded or otherwise modified in size, shape and/or placement) gaze scrolling regions associated with virtual object 704a.

Returning to the view of three-dimensional environment 700 visible via display generation component 120 in FIG. 17A, computer system 101 responds in the following ways to gaze 708 directed to the content in virtual object 704a based on the modified gaze scrolling regions illustrated in schematic 701′. In particular, computer system 101: scrolls the content (other than non-scrolling content 704a′) in an upward direction in response to detecting gaze 708 directed to baseline region 704b or directed to extended region 704b′; scrolls the content (other than non-scrolling content 704a′) in a downward direction in response to detecting gaze 708 directed to baseline region 704c; and does not scroll the content in response to detecting gaze 708 directed to content 704a′ (corresponding to exclusion region 704q) or directed to the content between extended region 704b′ and baseline region 704c.

FIG. 17B illustrates another example with different content within virtual object 704a, and the resulting gaze scrolling regions defined by computer system 101. Three-dimensional environment 700 and virtual object 704a in FIG. 17B optionally have the same characteristics as three-dimensional environment 700 and virtual object 704a in FIG. 17A, except as otherwise noted below. In FIG. 17B, the content within virtual object 704a includes non-scrollable content 704a′.

The bottom portion of FIG. 17B illustrates a schematic 703 representation of virtual object 704a and various regions related to gaze scrolling that will now be described. In some embodiments, in the absence of determining gaze scrolling regions based on characteristics of the underlying content in virtual object 704a, computer system 101 optionally establishes baseline region 704b at the top edge of virtual object 704a for scrolling the content in an upward direction in response to detecting gaze of the user directed to baseline region 704b, and baseline region 704c at the bottom edge of virtual object 704a for scrolling the content in a downward direction in response to detecting gaze of the user directed to baseline region 704c. However, because the content in virtual object 704a includes non-scrollable content 704a′, computer system 101 optionally establishes an exclusion region 704r (corresponding to the size, shape and/or placement of non-scrollable content 704a′). The computer system 101 optionally automatically (e.g., without user input) determines the size, shape and/or placement of exclusion region 704r based on the size, shape and/or placement of non-scrollable content 704a′ and/or other characteristics of the content included in virtual object 704a, as described in more detail with reference to method 1800. Computer system 101 establishes exclusion region 704r with a size, shape and/or placement within virtual object 704a corresponding to the size, shape and/or placement of non-scrollable content 704a′, which results in exclusion region 704r overlapping with baseline region 704b. In response to detecting gaze of the user directed to exclusion region 704r, the computer system 101 optionally does not scroll the content in virtual object 704a.

Because of the placement of exclusion region 704r, the area available for gaze scrolling in virtual object 704a is reduced, as shown in schematic 703. Therefore, computer system 101 optionally modifies the shape and/or area of gaze-enabled regions of virtual object 704a to increase the area available for gaze scrolling in virtual object 704a, as shown in schematic 703′. In particular, because exclusion region 704r (corresponding to non-scrollable content 704a′) overlaps with baseline region 704b, extends across a horizontal midpoint of the content in virtual object 704a, extends beyond baseline region 704b, and/or extends across a certain vertical proportion of the content in virtual object 704a (e.g., less than 5%, 10%, 25%, 33%, 50% or 66% of the vertical dimension of the content), computer system 101 expands the gaze scrolling region at the top edge of virtual object 704a by extended region 704b′. Extended region 704b′ has an area equal to the area of exclusion region 704r. Further, extended region 704b′ is adjacent to and contiguous with baseline region 704b, as shown in schematic 703′. Further, extended region 704b′ spans the width of virtual object 704a. Therefore, the total area available for gaze scrolling at the top edge of virtual object 704a is optionally the portion of baseline region 704b to the left of exclusion region 704r, the portion of baseline region 704b to the right of exclusion region 704r, and extended region 704b′ surrounding exclusion region 704r. Computer system 101 optionally does not modify baseline region 704c, because no exclusion region is included within and/or overlaps with baseline region 704c. As previously described, the portion of baseline region 704b to the left of exclusion region 704r, the portion of baseline region 704b to the right of exclusion region 704r, and extended region 704b′ surrounding exclusion region 704r optionally form a single, contiguous gaze scrolling region associated with virtual object 704a.

Returning to the view of three-dimensional environment 700 visible via display generation component 120 in FIG. 17B, computer system 101 responds in the following ways to gaze 708 directed to the content in virtual object 704a based on the modified gaze scrolling regions illustrated in schematic 703′. In particular, computer system 101: scrolls the content (other than non-scrolling content 704a′) in an upward direction in response to detecting gaze 708 directed to the left or right portions of baseline region 704b, or directed to extended region 704b′; scrolls the content (other than non-scrolling content 704a′) in a downward direction in response to detecting gaze 708 directed to baseline region 704c; and does not scroll the content in response to detecting gaze 708 directed to content 704a′ (corresponding to exclusion region 704r) or directed to the content between extended region 704b′ and baseline region 704c.

FIG. 17C illustrates another example with different content within virtual object 704a, and the resulting gaze scrolling regions defined by computer system 101. Three-dimensional environment 700 and virtual object 704a in FIG. 17C optionally have the same characteristics as three-dimensional environment 700 and virtual object 704a in FIG. 17A, except as otherwise noted below. In FIG. 17C, the content within virtual object 704a includes non-scrollable content 704a′.

The bottom portion of FIG. 17B illustrates a schematic 705 representation of virtual object 704a and various regions related to gaze scrolling that will now be described. In some embodiments, in the absence of determining gaze scrolling regions based on characteristics of the underlying content in virtual object 704a, computer system 101 optionally establishes baseline region 704b at the top edge of virtual object 704a for scrolling the content in an upward direction in response to detecting gaze of the user directed to baseline region 704b, and baseline region 704c at the bottom edge of virtual object 704a for scrolling the content in a downward direction in response to detecting gaze of the user directed to baseline region 704c. However, because the content in virtual object 704a includes non-scrollable content 704a′, computer system 101 optionally establishes an exclusion region 704s (corresponding to the size, shape and/or placement of non-scrollable content 704a′). The computer system 101 optionally automatically (e.g., without user input) determines the size, shape and/or placement of exclusion region 704s based on the size, shape and/or placement of non-scrollable content 704a′ and/or other characteristics of the content included in virtual object 704a, as described in more detail with reference to method 1800. Computer system 101 establishes exclusion region 704s with a size, shape and/or placement within virtual object 704a corresponding to the size, shape and/or placement of non-scrollable content 704a′, which results in exclusion region 704s overlapping with baseline region 704b. In response to detecting gaze of the user directed to exclusion region 704s, the computer system 101 optionally does not scroll the content in virtual object 704a.

Because of the placement of exclusion region 704s, computer system 101 optionally modifies the shape and/or area of gaze-enabled regions of virtual object 704a, as shown in schematic 705′. In particular, because exclusion region 704s (corresponding to non-scrollable content 704a′) overlaps with baseline region 704b, extends across a horizontal midpoint of the content in virtual object 704a, extends beyond baseline region 704b, and/or extends across a certain vertical proportion of the content in virtual object 704a (e.g., greater than 5%, 10%, 25%, 33%, 50% or 66% of the vertical dimension of the content, but less than 25%, 33%, 50%, 66%, 75% or 100% of the vertical dimension of the content), computer system 101 removes gaze scrolling regions at the top edge of virtual object 704a (e.g., baseline region 704b, including the portions of baseline region 704b to the left and right of exclusion region 704s), as shown in schematic 705′. Therefore, no area is available for gaze scrolling at the top edge of virtual object 704a. Computer system 101 optionally does not modify baseline region 704c, because no exclusion region is included within and/or overlaps with baseline region 704c.

Returning to the view of three-dimensional environment 700 visible via display generation component 120 in FIG. 17C, computer system 101 responds in the following ways to gaze 708 directed to the content in virtual object 704a based on the modified gaze scrolling regions illustrated in schematic 705′. In particular, computer system 101: scrolls the content (other than non-scrolling content 704a′) in a downward direction in response to detecting gaze 708 directed to baseline region 704c; and does not scroll the content in response to detecting gaze 708 directed to content 704a′ (corresponding to exclusion region 704s) or directed to the portions of the content above baseline region 704c and outside of non-scrolling content 704a′.

FIG. 17D illustrates another example with different content within virtual object 704a, and the resulting gaze scrolling regions defined by computer system 101. Three-dimensional environment 700 and virtual object 704a in FIG. 17D optionally have the same characteristics as three-dimensional environment 700 and virtual object 704a in FIG. 17A, except as otherwise noted below. In FIG. 17D, the content within virtual object 704a includes non-scrollable content 704a′.

The bottom portion of FIG. 17D illustrates a schematic 707 representation of virtual object 704a and various regions related to gaze scrolling that will now be described. In some embodiments, in the absence of determining gaze scrolling regions based on characteristics of the underlying content in virtual object 704a, computer system 101 optionally establishes baseline region 704b at the top edge of virtual object 704a for scrolling the content in an upward direction in response to detecting gaze of the user directed to baseline region 704b, and baseline region 704c at the bottom edge of virtual object 704a for scrolling the content in a downward direction in response to detecting gaze of the user directed to baseline region 704c. However, because the content in virtual object 704a includes non-scrollable content 704a′, computer system 101 optionally establishes an exclusion region 704t (corresponding to the size, shape and/or placement of non-scrollable content 704a′). The computer system 101 optionally automatically (e.g., without user input) determines the size, shape and/or placement of exclusion region 704t based on the size, shape and/or placement of non-scrollable content 704a′ and/or other characteristics of the content included in virtual object 704a, as described in more detail with reference to method 1800. Computer system 101 establishes exclusion region 704t with a size, shape and/or placement within virtual object 704a corresponding to the size, shape and/or placement of non-scrollable content 704a′, which results in exclusion region 704t overlapping with baseline region 704b (e.g., in region 704t′). In response to detecting gaze of the user directed to exclusion region 704t, the computer system 101 optionally does not scroll the content in virtual object 704a.

Because of the placement of exclusion region 704t, the area available for gaze scrolling in virtual object 704a is reduced, as shown in schematic 707. Therefore, computer system 101 optionally modifies the shape and/or area of gaze-enabled regions of virtual object 704a to increase the area available for gaze scrolling in virtual object 704a, as shown in schematic 707′. In particular, because exclusion region 704t (corresponding to non-scrollable content 704a′) overlaps with baseline region 704b, does not extend across a horizontal midpoint of the content in virtual object 704a, and/or extends beyond baseline region 704b, computer system 101 expands the gaze scrolling region at the top edge of virtual object 704a by extended region 704b′. Extended region 704b′ has an area equal to the area of the overlap between exclusion region 704t and baseline region 704b (e.g., has an area equal to the area of region 704t′). Further, extended region 704b′ is adjacent to and contiguous with baseline region 704b, as shown in schematic 707′. Further, extended region 704b′ spans the width of virtual object 704a from the right edge of exclusion region 704t to the right edge of virtual object 704a. Therefore, the total area available for gaze scrolling at the top edge of virtual object 704a is optionally the portion of baseline region 704b to the right of exclusion region 704t, and extended region 704b′ to the right of exclusion region 704t. Computer system 101 optionally does not modify baseline region 704c, because no exclusion region is included within and/or overlaps with baseline region 704c. As previously described, the portion of baseline region 704b to the right of exclusion region 704t, and extended region 704b′ to the right of exclusion region 704t optionally form a single, contiguous gaze scrolling region associated with virtual object 704a.

Returning to the view of three-dimensional environment 700 visible via display generation component 120 in FIG. 17D, computer system 101 responds in the following ways to gaze 708 directed to the content in virtual object 704a based on the modified gaze scrolling regions illustrated in schematic 707′. In particular, computer system 101: scrolls the content (other than non-scrolling content 704a′) in an upward direction in response to detecting gaze 708 directed to the right portion of baseline region 704b, or directed to extended region 704b′; scrolls the content (other than non-scrolling content 704a′) in a downward direction in response to detecting gaze 708 directed to baseline region 704c; and does not scroll the content in response to detecting gaze 708 directed to content 704a′ (corresponding to exclusion region 704t, including portions of content 704a′ inside overlap region 704t′ and outside overlap region 704t′) or directed to the content between extended region 704b′ and baseline region 704c.

FIG. 17E illustrates another example with different content within virtual object 704a, and the resulting gaze scrolling regions defined by computer system 101. Three-dimensional environment 700 and virtual object 704a in FIG. 17E optionally have the same characteristics as three-dimensional environment 700 and virtual object 704a in FIG. 17A, except as otherwise noted below. In FIG. 17E, the content within virtual object 704a includes non-scrollable content 704a′.

The bottom portion of FIG. 17E illustrates a schematic 709 representation of virtual object 704a and various regions related to gaze scrolling that will now be described. In some embodiments, in the absence of determining gaze scrolling regions based on characteristics of the underlying content in virtual object 704a, computer system 101 optionally establishes baseline region 704b at the top edge of virtual object 704a for scrolling the content in an upward direction in response to detecting gaze of the user directed to baseline region 704b, and baseline region 704c at the bottom edge of virtual object 704a for scrolling the content in a downward direction in response to detecting gaze of the user directed to baseline region 704c. However, because the content in virtual object 704a includes non-scrollable content 704a′, computer system 101 optionally establishes an exclusion region 704u (corresponding to the size, shape and/or placement of non-scrollable content 704a′). The computer system 101 optionally automatically (e.g., without user input) determines the size, shape and/or placement of exclusion region 704u based on the size, shape and/or placement of non-scrollable content 704a′ and/or other characteristics of the content included in virtual object 704a, as described in more detail with reference to method 1800. Computer system 101 establishes exclusion region 704u with a size, shape and/or placement within virtual object 704a corresponding to the size, shape and/or placement of non-scrollable content 704a′, which results in exclusion region 704u overlapping with baseline region 704b (e.g., in region 704u′) and with baseline region 704c (e.g., in region 704u″). In response to detecting gaze of the user directed to exclusion region 704u, the computer system 101 optionally does not scroll the content in virtual object 704a.

Because of the placement of exclusion region 704u, the area available for gaze scrolling in virtual object 704a is reduced, as shown in schematic 709. Therefore, computer system 101 optionally modifies the shape and/or area of gaze-enabled regions of virtual object 704a to increase the area available for gaze scrolling in virtual object 704a, as shown in schematic 709′. In particular, because exclusion region 704u (corresponding to non-scrollable content 704a′) overlaps with baseline region 704b and baseline region 704c, does not extend across a horizontal midpoint of the content in virtual object 704a, and/or extends beyond baseline region 704b and baseline region 704c, computer system 101 expands the gaze scrolling region at the top edge of virtual object 704a by extended region 704b′, and expands the gaze scrolling region at the bottom edge of virtual object 704a by extended region 704c′. Extended region 704b′ has an area equal to the area of the overlap between exclusion region 704u and baseline region 704b (e.g., has an area equal to the area of region 704u′), and extended region 704c′ has an area equal to the area of the overlap between exclusion region 704u and baseline region 704c (e.g., has an area equal to the area of region 704u″). Further, extended region 704b′ is adjacent to and contiguous with baseline region 704b, and extended region 704c′ is adjacent to and contiguous with baseline region 704c, as shown in schematic 709′. Further, extended region 704b′ and extended region 704c′ span the width of virtual object 704a from the right edge of exclusion region 704u to the right edge of virtual object 704a. Therefore, the total area available for gaze scrolling at the top edge of virtual object 704a is optionally the portion of baseline region 704b to the right of exclusion region 704u, and extended region 704b′ to the right of exclusion region 704u; and, the total area available for gaze scrolling at the bottom edge of virtual object 704a is optionally the portion of baseline region 704c to the right of exclusion region 704u, and extended region 704c′ to the right of exclusion region 704u. As previously described, the portion of baseline region 704b to the right of exclusion region 704u, and extended region 704b′ to the right of exclusion region 704u optionally form a single, contiguous gaze scrolling region associated with virtual object 704a, and the portion of baseline region 704c to the right of exclusion region 704u, and extended region 704c′ to the right of exclusion region 704u optionally form a single, contiguous gaze scrolling region associated with virtual object 704a.

Returning to the view of three-dimensional environment 700 visible via display generation component 120 in FIG. 17E, computer system 101 responds in the following ways to gaze 708 directed to the content in virtual object 704a based on the modified gaze scrolling regions illustrated in schematic 709′. In particular, computer system 101: scrolls the content (other than non-scrolling content 704a′) in an upward direction in response to detecting gaze 708 directed to the right portion of baseline region 704b, or directed to extended region 704b′; scrolls the content (other than non-scrolling content 704a′) in a downward direction in response to detecting gaze 708 directed to right portion of baseline region 704c or directed to extended region 704c′; and does not scroll the content in response to detecting gaze 708 directed to content 704a′ (corresponding to exclusion region 704u, including portions of content 704a′ inside overlap regions 704u′ and 704u″, and outside overlap regions 704u′ and 704u″) or directed to the content between extended region 704b′ and baseline region 704c.

FIG. 17F illustrates another example with different content within virtual object 704a, and the resulting gaze scrolling regions defined by computer system 101. Three-dimensional environment 700 and virtual object 704a in FIG. 17F optionally have the same characteristics as three-dimensional environment 700 and virtual object 704a in FIG. 17A, except as otherwise noted below. In FIG. 17F, the content within virtual object 704a includes non-scrollable content 704a′.

The bottom portion of FIG. 17F illustrates a schematic 711 representation of virtual object 704a and various regions related to gaze scrolling that will now be described. In some embodiments, in the absence of determining gaze scrolling regions based on characteristics of the underlying content in virtual object 704a, computer system 101 optionally establishes baseline region 704b at the top edge of virtual object 704a for scrolling the content in an upward direction in response to detecting gaze of the user directed to baseline region 704b, and baseline region 704c at the bottom edge of virtual object 704a for scrolling the content in a downward direction in response to detecting gaze of the user directed to baseline region 704c. However, because the content in virtual object 704a includes non-scrollable content 704a′, computer system 101 optionally establishes an exclusion region 704v (corresponding to the size, shape and/or placement of non-scrollable content 704a′). The computer system 101 optionally automatically (e.g., without user input) determines the size, shape and/or placement of exclusion region 704v based on the size, shape and/or placement of non-scrollable content 704a′ and/or other characteristics of the content included in virtual object 704a, as described in more detail with reference to method 1800. Computer system 101 establishes exclusion region 704v with a size, shape and/or placement within virtual object 704a corresponding to the size, shape and/or placement of non-scrollable content 704a′, which results in exclusion region 704v overlapping with baseline region 704b and baseline region 704c. In response to detecting gaze of the user directed to exclusion region 704v, the computer system 101 optionally does not scroll the content in virtual object 704a.

Because of the placement of exclusion region 704v, computer system 101 optionally modifies the shape and/or area of gaze-enabled regions of virtual object 704a, as shown in schematic 711′. In particular, because exclusion region 704v (corresponding to non-scrollable content 704a′) overlaps with baseline region 704b and 704c, extends across a horizontal midpoint of the content in virtual object 704a, extends beyond baseline region 704b and baseline region 704c, and/or extends across a certain vertical proportion of the content in virtual object 704a (e.g., greater than 33%, 50%, 66%, 75%, 90%, 95% or 99% of the vertical dimension of the content, or 100% of the vertical dimension of the content), computer system 101 treats the portions of exclusion region 704v that overlap with baseline region 704b and baseline region 704c as gaze scrollable regions (e.g., treats those portions as having the behavior of baseline region 704b and baseline region 704c, rather than having the behavior of exclusion region 704v), as shown in schematic 711′. Therefore, the total area available for gaze scrolling at the top edge of virtual object 704a is baseline region 704b, and the total area available for gaze scrolling at the top edge of virtual object 704a is baseline region 704c. Thus, computer system 101 optionally does not modify baseline region 704b nor baseline region 704c based on exclusion region 704v, and optionally does not add any extended regions as gaze scrolling regions associated with virtual object 704a.

Returning to the view of three-dimensional environment 700 visible via display generation component 120 in FIG. 17F, computer system 101 responds in the following ways to gaze 708 directed to the content in virtual object 704a based on the modified gaze scrolling regions illustrated in schematic 711′. In particular, computer system 101: scrolls the content (other than non-scrolling content 704a′) in an upward direction in response to detecting gaze 708 directed to the right portion of baseline region 704b, directed to the left portion of baseline region 704b, or directed to the portion of baseline region 704b that overlaps with non-scrolling content 704a′; scrolls the content (other than non-scrolling content 704a′) in a downward direction in response to detecting gaze 708 directed to the right portion of baseline region 704c, directed to the left portion of baseline region 704c, or directed to the portion of baseline region 704c that overlaps with non-scrolling content 704a′; and does not scroll the content in response to detecting gaze 708 directed to content 704a′ between baseline region 704b and baseline region 704c, or directed to the content between baseline region 704b and baseline region 704c.

FIG. 18 illustrates a flow diagram illustrating a method 1800 in which a computer system modifies gaze scrolling regions in accordance with some embodiments of the disclosure. In some embodiments, the method 1800 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

The devices, methods, and/or computer-readable storage mediums described below enhance the operability of the device and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Reducing the number of inputs needed to perform an operation (such as by scrolling scrollable content based on gaze) enhances the operability of the device by improving accessibility to the scrolling of content for users who might be unable to provide scrolling inputs via other types of input, such as hand-based scrolling inputs, and reducing the number of inputs and time required to perform a particular operation, reducing energy usage by the device. Performing an operation when a set of conditions has been met without requiring further user input (such as by controlling spatial characteristics of a gaze-based scrolling region based on characteristics of content including scrollable content) enhances the operability of the device by reducing unnecessary inputs and/or steps to navigate through different user interfaces or sets of controls, reducing the rate of accidental scrolling of the scrollable content based on gaze, and reducing the difficulty of and/or number of interactions needed to locate and/or interact with the gaze-based scrolling region, reducing energy usage by the device.

In some embodiments, method 1800 is performed at a computer system in communication with one or more display generation components and one or more input devices. In some embodiments, the computer system, the one or more display generation components, and/or the one or more input devices have one or more of the characteristics of the computer system(s), the one or more display generation components, and/or the one or more input devices of methods 800, 1000, 1200, 1400 and/or 1600.

In some embodiments, while displaying, via the one or more display generation components, respective content that includes scrollable content (e.g., scrollable content, as described with reference to methods 800 and/or 1000), such as the content included in virtual object 704a in FIGS. 17A-17F, the computer system detects (1802), via the one or more input devices, a gaze (and/or attention) of a user of the computer system directed to the respective content, such as gaze 708 in any of FIGS. 17A-17F. For example, detecting the gaze of the user directed to the scrollable content, as described with reference to methods 800 and/or 1000. In some embodiments, the computer system displays the respective content in a three-dimensional environment (e.g., in a manner similar to displaying a virtual object in a three-dimensional environment as described with reference to the scene 105 in FIG. 1A), such as described with reference to methods 800, 1000, 1200, 1400 and/or 1600. In some embodiments, the respective content is a user interface of an application, such as a web browser application or an application other than the web browser application, such as an electronic reading application, media content application, or a platform control application. In some embodiments, the respective content includes media and/or textual content (e.g., images, videos and/or text) that is not all displayed in the user interface at once (e.g., a portion of the content is not visible in the respective content at any given moment in time). Thus, display of other portions of the content optionally requires that the content be scrolled to reveal and/or display those other portions of content, as described with reference to methods 800 and/or 1000.

In some embodiments, in response to detecting the gaze of the user directed to the respective content (1806), in accordance with a determination that the gaze of the user is directed to a first region of the respective content that is associated with gaze-based scrolling (e.g., a region that causes the computer system to scroll the respective content based on gaze being directed to that region, without additional input being detected from the user, such as described with reference to methods 800 and/or 1000), such as regions 704b, 704b′, 704c or 704c′ in FIGS. 17A-17F, the computer system scrolls (1808) the scrollable content (e.g., by an amount or at a rate that is based on a location of the gaze within the first region and/or a duration of the gaze within the first region), wherein one or more spatial characteristics of the first region (e.g., the size, shape and/or placement of the first region relative to the respective content, relative to the scrollable content, and/or relative to a user interface in which the respective content is displayed), such as the characteristics of regions 704b, 704b′, 704c or 704c′ in FIGS. 17A-17F, are based on one or more characteristics of the respective content, such as based on characteristics of content 704a′ in FIGS. 17A-17F. In some embodiments, scrolling the scrollable content based on gaze has one or more of the characteristics of scrolling the scrollable content based on gaze described with reference to methods 800 and/or 1000. In some embodiments, the direction in which the computer system scrolls the scrollable content is based on in which region the computer system detects the gaze of the user, as described in more detail with reference to methods 800 and/or 1000 (e.g., different regions cause different directions of scrolling). In some embodiments, the spatial characteristics of the first region are based on the characteristics of the respective content within and/or overlapping with the first region (and optionally not based on the characteristics of the respective content within and/or overlapping with a different gaze-based scrolling region). In some embodiments, the spatial characteristics of a different gaze-based scrolling region (e.g., for scrolling the scrollable content in a different direction) are based on the characteristics of the respective content within and/or overlapping with the different region (and optionally not based on the characteristics of the respective content within and/or overlapping with the first gaze-based scrolling region). In some embodiments, visual indications of the first and/or second regions are, or are not, displayed by the computer system as described in more detail with reference to methods 800 and/or 1000. The relationship between the spatial characteristics of the first region and the characteristics of the respective content is described in more detail below.

In some embodiments, in response to detecting the gaze of the user directed to the respective content (1806), in accordance with a determination that the gaze of the user is directed to a second region of the respective content that is not associated with gaze-based scrolling (e.g., the gaze is directed to a portion of the respective content that is not enabled for gazed-based scrolling, as described with reference to methods 800 and/or 1000), such as regions 704q, 704r, 704s, 704t, 704u or 704v in FIGS. 17A-17F, the computer system forgoes scrolling (1810) the scrollable content. In some embodiments, if the gaze of the user is directed to the second region of the respective content, and the computer system also detects additional input from the user (e.g., an air pinch and drag input from a hand of the user, or a touch and drag input from a hand of the user on a touchpad), the computer system optionally scrolls the respective content in accordance with the additional input from the user, as described in more detail with reference to methods 800 and/or 1000.

In some embodiments, the one or more spatial characteristics of the first region (e.g., the size, shape and/or placement of the first region relative to the respective content and/or relative to a user interface in which the respective content is displayed) are based on one or more spatial characteristics of one or more exclusion regions (e.g., the size, shape and/or placement of the exclusion regions relative to the respective content and/or relative to a user interface in which the respective content is displayed) for which gaze-based scrolling of the scrollable content is disabled, such as exclusion regions 704q, 704r, 704s, 704t, 704u or 704v in FIGS. 17A-17F. In some embodiments, the exclusion regions are regions defined by the computer system as being regions in which gaze-based scrolling is disabled. Thus, in some embodiments, in response to detecting the gaze of the user directed to an exclusion region, the computer system does not scroll the scrollable content, even if the gaze is directed to a portion of the respective content that otherwise would trigger scrolling of the scrollable content if the exclusion region were not positioned there. The one or more exclusion regions optionally have one or more of the characteristics of similar exclusion regions described with reference to methods 800 and/or 1000.

In some embodiments, in accordance with a determination that the one or more exclusion regions have a first set of one or more spatial characteristics of the one or more exclusion regions (e.g., first sizes, first shapes, and/or first placements of the one or more exclusion regions), such as the spatial characteristics of exclusion region 704t in FIG. 17D, the first region has a first set of one or more spatial characteristics of the first region (e.g., a first size, a first shape, and/or a first placement of the first region), such as the spatial characteristics of regions 704b and 704b′ in FIG. 17D, and in some embodiments, in accordance with a determination that the one or more exclusion regions have second set of one or more spatial characteristics of the one or more exclusion regions, different from the first set of one or more spatial characteristics of the one or more exclusion regions (e.g., second sizes, second shapes, and/or second placements of the one or more exclusion regions), such as the spatial characteristics of exclusion region 704r in FIG. 17B, the first region has a set of one or more second spatial characteristics of the first region, different from the first set of one or more spatial characteristics of the first region (e.g., a second size, a second shape, and/or a second placement of the first region), such as the spatial characteristics of regions 704b and 704b′ in FIG. 17B.

In some embodiments, the one or more exclusion regions are determined by the computer system automatically based on evaluation of the respective content, such as exclusion regions 704q, 704r, 704s, 704t, 704u or 704v in FIGS. 17A-17F being determined automatically based on the evaluation of the content in virtual object 704a in those figures. For example, the computer system uses deterministic and/or non-deterministic processes (e.g., rules-based and/or machine learning (ML)-based processes) to analyze the respective content. In some embodiments, the computer system analyzes the respective content without user input. In some embodiments, the computer system determines whether or not an exclusion region (or multiple exclusion regions) exists automatically, and without user input indicating whether or not the exclusion region (or multiple exclusion regions) exists. In some embodiments, the computer system determines the spatial properties of an exclusion region (or multiple exclusion regions) automatically, and without user input indicating the spatial properties of the exclusion region (or multiple exclusion regions).

In some embodiments, in accordance with a determination that the one or more characteristics of the respective content are first content characteristics (e.g., first types of content, first structure of content, first positioning of content, first sizes of content, and/or first placements of content), such as the characteristics of content 704a′ in FIG. 17B, the computer system identifies a first set of one or more regions of the respective content as the one or more exclusion regions, such as exclusion region 704r in FIG. 17B. In some embodiments, the first ser of one or more regions correspond to areas of the respective content that are defined by the first content characteristics. For example, the content characteristics of a first portion of the respective content optionally define and/or correspond to an exclusion region (if the computer system determines that one exists) located at the position of the first portion of the respective content. For example, the size and/or position of the exclusion region located at a first portion of the respective content corresponds to the size and/or position of the first portion of the respective content. In some embodiments, the exclusion region positions and/or boundaries correspond to the positions and/or boundaries of underlying content structures defined in the source code of the content itself (e.g., in the case where the respective content is web content). For example, if the computer system determines to place an exclusion region coincident with an HTML structure in the content (e.g., a table, a layer, or any other HTML structure), the size and/or position of the exclusion region optionally correspond (e.g., are based on and/or are the same as) the size and/or position of the HTML structure.

In some embodiments, in accordance with a determination that the one or more characteristics of the respective content are second content characteristics, different from the first content characteristics (e.g., second types of content, second structure of content, second positioning of content, second sizes of content, and/or second placements of content), such as the characteristics of content 704a′ in FIG. 17C, the computer system identifies a second set of one or more second regions of the respective content, different from the first set of one or more first regions of the respective content, as the one or more exclusion regions (e.g., in one or more of the ways described above with respect to identifying the first set of one or more regions as the one or more exclusion regions), such as exclusion region 704r in FIG. 17C.

In some embodiments, in accordance with a determination that a respective region that includes content of a respective type of content in the respective content (e.g., content 704a′ in FIG. 17B) is in (e.g., includes content that is displayed in) a baseline region that is associated with gaze-based scrolling (in some embodiments, the size, area and/or placement of the respective region is defined by, based on and/or the same as the size, area and/or placement of the content of the respective type), such as content 704a′ being in baseline region 704b in FIG. 17B, the computer system defines the first region of the respective content to include the baseline region and an extended region that is adjacent to the first region, such as baseline region 704b and extended region 704b′ in FIG. 17B. In some embodiments, the baseline region is a region defined by the computer system in which gaze-based scrolling is enabled and/or would be enabled independent of characteristics of the respective content. For example, the baseline region is a default region in which gaze-based scrolling is enabled (e.g., having default positioning and/or size relative to the respective content, relative to the scrollable content, and/or the user interface in which the respective content is displayed). For example, for vertically scrollable content, the baseline regions are optionally at the top and bottom edges of the scrollable content, and for horizontally scrollable content, the baseline regions are optionally at the left and right edges of the scrollable content. The baseline regions optionally have one or more of the characteristics of the gaze-enabled scrolling regions of methods 800 and/or 1000.

Content of the respective type is optionally content that is non-scrolling content (e.g., content that cannot be scrolled, whether based on gaze or otherwise, such as based on hand air gesture input), such as content 704a′ in FIGS. 17A-17F. The non-scrolling content optionally has one or more of the characteristics of non-scrolling content described with reference to methods 800 and/or 1000. Thus, in some embodiments, the respective content includes content within it that cannot be scrolled, though the remainder of the respective content can be scrolled.

In some embodiments, if the content of the respective type overlaps with the baseline region (e.g., at the respective region), such as shown with content 704a′ overlapping with baseline region 704b in FIG. 17B, the computer system expands the region in which gaze-based scrolling is enabled to be the baseline region plus an extended region that is attached to, adjacent to and/or contiguous with the baseline region. Thus, in some embodiments, the computer system expands one or more dimensions of the baseline region by an amount or region corresponding to the extended region, thus resulting in the gaze-enabled region being a combination of the baseline region and the extended region.

In some embodiments, in accordance with a determination that the respective region is not in the baseline region that is associated with gaze-based scrolling, such as content 704a′ in FIG. 17B not being in baseline region 704c in FIG. 17B, the computer system defines the first region of the respective content to include the baseline region without including the extended region that is adjacent to the first region (and, optionally, without including any extended region that is adjacent to the first and/or baseline region), such as including baseline region 704c without including extended regions in FIG. 17B. Thus, the computer system optionally does not expand one or more dimensions of the baseline region, resulting in the gaze-enabled region being the original, default baseline region. The computer system optionally independently expands or does not expand different baseline regions associated with the respective content based on whether and/or in what manner those baseline regions overlap with one or more exclusion regions and/or content of the respective type.

In some embodiments, defining the first region of the scrollable content to include the baseline region and the extended region that is adjacent to the first region includes, in accordance with a determination that the respective region (e.g., including content of the respective type) of content is entirely included in the baseline region (e.g., the baseline region fully encompasses the content of the respective type, such that the content of the respective type is contained entirely within the region of the baseline region), such as with content 704a′ being entirely included in baseline region 704b in FIG. 17A, defining a size of (e.g., the dimensions and/or area of) the extended region to correspond to an amount of overlap between the respective region and the baseline region, such as the size of extended region 704b′ in FIG. 17A corresponding to the amount of overlap between content 704a′ and baseline region 704b in FIG. 17A. In some embodiments, the total area of the extended region is based on, corresponds to and/or is the same as the total area of the overlap between the respective region and/or the content of the respective type, and the baseline region. In some embodiments, this size of the extended region (e.g., total area of the extended region) is based on, corresponds to and/or is the same as the size (e.g., area) of the respective region and/or the content of the respective type. Thus, in some embodiments, the greater the overlap between the content of the respective type and the baseline region, the larger the extended region, and the less the overlap, the smaller the extended region.

In some embodiments, defining the first region of the scrollable content to include the baseline region and the extended region that is adjacent to the first region includes, in accordance with a determination that the respective region extends outside of the baseline region (e.g., the respective region is partially located within the baseline region, and is partially located outside of the baseline region; for example, a first portion of the respective region is located within the baseline region, and a second portion of the respective region is located outside of the baseline region), such as content 704a′ extending outside of baseline region 704b in FIG. 17B, defining a size of (e.g., the dimensions and/or area of) the extended region to correspond to a size of (e.g., the dimensions and/or area of) the respective region (optionally including a size of the respective region that extends outside of the baseline region and/or optionally independent of, or different from, the amount of the overlap between the baseline region and the respective region), such as the size of extended region 704b′ corresponding to the size of content 704a′ in FIG. 17B. Thus, in some embodiments, in accordance with a determination that the amount of the overlap between the baseline region and the respective region is a first amount of overlap, the computer system defines the size of the extended region to be the size of the respective region, and in accordance with a determination that the amount of the overlap between the baseline region and the respective region is a second amount of overlap, different from the first amount of overlap, the computer system defines the size of the extended region to be the size of the respective region (e.g., the same size as if the overlap amount were different). In some embodiments, the total area of the extended region is based on, corresponds to and/or is the same as the total area of the respective region of the respective type. Thus, in some embodiments, the greater the size (e.g., area) of the respective region, the larger the extended region, and the less the size of the respective region, the smaller the extended region.

In some embodiments, the first region corresponds to a first edge of the respective content (e.g., the first region is located on and/or is located adjacent the first edge of the respective content and/or the user interface in which the respective content is displayed, such as the top edge, bottom edge, right edge or left edge), such as the top edge of virtual object 704a in FIG. 17C.

In some embodiments, in accordance with a determination that a respective region that includes content of a respective type of content (e.g., a respective region and/or content of the respective type, such as described herein) in the respective content (e.g., content 704a′ in FIG. 17C) is at the first edge of the respective content (e.g., at least a part of the content of the respective type overlaps or intersects with the first region, and/or at least part of the content of the respective type is displayed within the first region), such as content 704a′ in FIG. 17C being displayed at the top edge of virtual object 704a, and that a proportion of a dimension (e.g., height, width, or other dimension) of the respective region to a corresponding dimension of the respective content (and/or the user interface in which the scrollable is displayed) is within a first range of proportions (e.g., within a range of 33% to 90%), such as content 704a′ extending within the first range of proportions of the vertical dimension of the content in virtual object 704a in FIG. 17C, the computer system disables gaze-based scrolling in the first region of the respective content, such as disabling gaze-based scrolling at the top edge of virtual object 704a in FIG. 17C. For example, the comparison is between the width of the content of the respective type and the width of the respective content and/or the user interface in which the respective content is displayed, or the comparison is between the height of the content of the respective type and the height of the respective content and/or the user interface in which the respective content is displayed. In some embodiments, disabling gaze-based scrolling in the first region means that, in response to detecting the gaze of the user directed to the first region of the respective content, the computer system does not initiate scrolling of the scrollable content.

In some embodiments, in accordance with a determination that the respective region in the respective content is at the first edge of the respective content, such as content 704a′ in FIG. 17B being displayed at the top edge of virtual object 704a, and that the proportion of the dimension of the respective region to the corresponding dimension of the respective content is below the first range of proportions (e.g., less than 33%), such as content 704a′ extending below the first range of proportions of the vertical dimension of the content in virtual object 704a in FIG. 17B, the computer system enables (and/or maintaining) gaze-based scrolling in the first region of the respective content, such as enabling or maintaining gaze-based scrolling at the top edge of virtual object 704a in FIG. 17B. In some embodiments, enabling gaze-based scrolling in the first region means that, in response to detecting the gaze of the user directed to the first region of the respective content, the computer system does scroll the scrollable content (e.g., in ways described herein and/or with reference to methods 800 and/or 1000).

In some embodiments, in accordance with the determination that the respective region is at (e.g., includes content that is displayed at) the first edge of the respective content (e.g., as described herein), and that the proportion of the dimension of the respective region to the corresponding dimension of the respective content is below the first range of proportions (e.g., as described herein), such as shown with content 704a′ in FIG. 17D, the first region of the respective content includes, a baseline region (e.g., as described herein) that corresponds to the first edge of the respective content (e.g., is located at or adjacent to the first edge of the respective content and/or the user interface in which the respective content is displayed, as described herein) and is associated with gaze-based scrolling (e.g., is enabled for gaze-based scrolling, such that in response to detecting the gaze of the user directed to the baseline region, the computer system scrolls the scrollable content, as described herein), such as baseline region 704b in FIG. 17D, and an extended region (e.g., as described herein) that is adjacent to the first region (e.g., as described in more detail herein with respect to one or more extended regions that are adjacent to a baseline region) and is associated with gaze-based scrolling (e.g., is enabled for gaze-based scrolling, such that in response to detecting the gaze of the user directed to the extended region, the computer system scrolls the scrollable content, as described herein, in the same or similar way that scrolling would proceed if the gaze were directed to the baseline region), such as extended region 704b′ in FIG. 17D, wherein a size of (e.g., the dimensions and/or area of) the extended region corresponds to (e.g., is based on) an amount of overlap between the respective region and the baseline region, such as the size of extended region 704b′ corresponding to the amount of overlap in region 704t′ between content 704a′ and baseline region 704b in FIG. 17D. In some embodiments, the size of the extended region (e.g., total area of the extended region) is based on, corresponds to and/or is the same as the size (e.g., area) of the overlap between the respective region and the baseline region. Thus, in some embodiments, the greater the overlap, the larger the extended region, and the less the overlap, the smaller the extended region.

In some embodiments, in accordance with a determination that the respective region is at (e.g., includes content that is displayed at) the first edge of the respective content (e.g., as described herein), and that the proportion of the dimension of the respective region to the corresponding dimension of the respective content (e.g., as described herein) is above the first range of proportions (e.g., above 90%), such as shown with content 704a′ in FIG. 17F, the computer system enables gaze-based scrolling in the first region of the respective content (e.g., as described herein), such as in baseline region 704b in FIG. 17F. In some embodiments, the first region of the respective content includes a baseline region that corresponds to the first edge of the respective content and is associated with gaze-based scrolling (e.g., as described herein), without including an extended region (e.g., as described herein) based on the respective region, such as baseline region 704b in FIG. 17F not including an extended region. Thus, the first region is optionally only the default, baseline region, without being extended or expanded by the computer system.

In some embodiments, the first region includes an area where the baseline region and the respective region overlap, such as the portion of baseline region 704b that overlaps with content 704a′ in FIG. 17F. Thus, in some embodiments, in response to detecting the gaze of the user directed to the area of the respective region where the respective region and the baseline region overlap, the computer system scrolls the scrollable content (e.g., gaze-based scrolling is enabled in this overlap region), as described herein. In some embodiments, in response to detecting the gaze of the user directed to the area of the respective region where the respective region and the baseline region overlap, the computer system does not initiate scrolling of the scrollable content (e.g., gaze-based scrolling is disabled in this overlap region).

In some embodiments, in accordance with a determination that a respective region that includes content of a respective type of content in the respective content (e.g., a respective region and/or content of the respective type, such as described herein) is in (e.g., includes content that is displayed in) a central region of the respective content, such as shown with content 704a′ in FIG. 17C (e.g., the respective region spans, covers, extends across and/or occupies at least the middle or center of the respective content, such as occupying a middle fifth, fourth, third or half of the respective content, though in some embodiments, the respective region is considered to be in the central region of the respective content even if the respective region is not centered in the respective content but spans, covers, extends across and/or occupies at least the middle or center of the respective content), the computer system modifies the first region of the respective content in a first manner, such as modifying baseline region 704b in FIG. 17C. Modifying the first region optionally has one or more characteristics of modifying the first region described herein, such as extending a baseline region with one or more different extended regions, not extending a baseline region with an extended region, enabling gaze-based scrolling in the first region, or disabling gaze-based scrolling in the first region.

In some embodiments, in accordance with a determination that the respective region is not in the central region of the respective content (e.g., the respective region does not at least span, cover, extend across and/or occupy the middle or center of the respective content, such as occupying a left or right fifth, fourth or third of the respective content), such as shown with content 704a′ in FIG. 17D, the computer system modifies the first region of the respective content in a second manner, different from the first manner, such as adding extended region 704b′ to baseline region 704b in FIG. 17D. Modifying the first region optionally has one or more characteristics of modifying the first region described herein, such as extending a baseline region with one or more different extended regions, not extending a baseline region with an extended region, enabling gaze-based scrolling in the first region, or disabling gaze-based scrolling in the first region. Modifying the first region in the first manner optionally differs in at least one way from modifying the first region in the second manner.

In some embodiments, modifying the first region of the respective content in the first manner includes disabling gaze-based scrolling in the first region (e.g., as described herein), such as disabling gaze-based scrolling at the top edge of virtual object 704a in FIG. 17C. Thus, in some embodiments, in response to detecting the gaze of the user directed to the first region, the computer system does not scroll the scrollable content, even if the gaze is directed to a portion of the scrollable content. In some embodiments, modifying the first region of the respective content in the second manner includes maintaining gaze-based scrolling in the first region (e.g., as described herein), such as maintaining gaze-based scrolling at the top edge of virtual object 704a in FIG. 17D. Thus, in some embodiments, in response to detecting the gaze of the user directed to the first region, the computer system does scroll the scrollable content, even if the gaze is directed to a portion of the scrollable content.

In some embodiments, modifying the first region of the respective content in the second manner includes expanding the first region of the respective content (e.g., as described herein), such as adding extended region 704b′ to baseline region 704b in FIG. 17D. For example, the computer system expands one or more boundaries of a baseline region (e.g., as described herein) to add one or more extended regions (e.g., as described herein) to the first region, thus increasing the size (e.g., area) of the first region that will cause scrolling of the scrollable content in response to the computer system detecting the gaze of the user directed to it. The computer system optionally expands the first region in any of the ways described herein, such as expanding it based on the amount of overlap between the respective type of content and the baseline region and/or based on the size (e.g., area) of the respective type of content.

In some embodiments, scrolling the scrollable content in accordance with the determination that the gaze of the user is directed to the first region of the respective content that is associated with gaze-based scrolling includes scrolling the scrollable content in a first manner, such as baseline region 704b and extended region 704b′ in FIG. 17D being for scrolling the content in virtual object 704a in an upward direction. For example, the first region is or includes a first baseline region (e.g., as described herein) for scrolling the scrollable content in a first direction based on gaze. For example, the first region is a region at the top edge of the respective content and/or the user interface in which the respective content is displayed (e.g., as described herein), and in response to detecting the gaze of the user directed to the first region, the computer system scrolls the scrollable content upward (e.g., as described with reference to methods 800 and/or 1000). The first region is optionally alternatively at the left edge of the respective content and/or the user interface in which the respective content is displayed (e.g., as described herein), and in response to detecting the gaze of the user directed to the first region, the computer system scrolls the scrollable content leftward (e.g., as described with reference to methods 800 and/or 1000).

In some embodiments, in response to detecting the gaze of the user directed to the respective content and in accordance with a determination that the gaze of the user is directed to a second region of the respective content that is associated with gaze-based scrolling (e.g., the second region has one or more characteristics of the first region, described herein), wherein the second region is different from the first region, such as baseline region 704c in FIG. 17D, the computer system scrolls the scrollable content in a second manner, different from the first manner, such as scrolling the content in virtual object 704a in a downward direction in FIG. 17D. In some embodiments, the second region has some or all of the behaviors described herein with respect to the first region. For example, the second region is or includes a second baseline region (e.g., as described herein) for scrolling the scrollable content in a second direction, different from the first direction, based on gaze. For example, the second region is a region at the bottom edge of the respective content and/or the user interface in which the respective content is displayed (e.g., as described herein), and in response to detecting the gaze of the user directed to the second region, the computer system scrolls the scrollable content downward (e.g., as described with reference to methods 800 and/or 1000). The second region is optionally alternatively at the right edge of the respective content and/or the user interface in which the respective content is displayed (e.g., as described herein), and in response to detecting the gaze of the user directed to the second region, the computer system scrolls the scrollable content rightward (e.g., as described with reference to methods 800 and/or 1000).

In some embodiments, in accordance with a determination that the scrollable content is scrollable in a first direction but not scrollable in a second direction, different from the first direction (e.g., the scrollable content is vertically scrollable, but not horizontally scrollable), such as being vertically scrollable such as shown in FIG. 17D, the first region of the respective content (e.g., a baseline region or a region that includes the baseline region) is located at a first location relative to the respective content, wherein the first location corresponds to the first direction of scrolling, such as regions 704b and 704b′ being located at the top edge of virtual object 704a, and region 704c being located at the bottom edge of virtual object 704a in FIG. 17D. For example, when the scrollable content is vertically scrollable, the first region is located at the top edge or bottom edge of the respective content, at a top edge or bottom edge of the scrollable content, and/or the user interface in which the respective content is displayed (e.g., as described herein). When the scrollable content is vertically scrollable, the respective content is optionally associated with two gaze-based scrolling regions: one at the top edge of the respective content, at the top edge of the scrollable content, and/or the user interface in which the respective content is displayed, and for scrolling through the scrollable content in one direction (e.g., upward); and one at the bottom edge of the respective content, at the bottom edge of the scrollable content, and/or the user interface in which the respective content is displayed, and for scrolling through the scrollable content in a different direction (e.g., downward). Characteristics of gaze-based scrolling regions for scrollable content that is scrollable in a first direction (e.g., vertically) are described in more detail with reference to methods 800, 1000 and/or 1800.

In some embodiments, in accordance with a determination that the scrollable content is scrollable in the second direction but not scrollable in the first direction (e.g., the scrollable content is horizontally scrollable, but not vertically scrollable), such as if the content in virtual object 704a in FIG. 17D were horizontally scrollable, the first region of the respective content (e.g., a baseline region or a region that includes the baseline region) is located at a second location relative to the respective content, different from the first location relative to the respective content, wherein the second location corresponds to the second direction of scrolling, such as if regions 704b and 704c in FIG. 17D were instead positioned on the left and right edges of virtual object 704a. For example, when the scrollable content is horizontally scrollable, the first region is located at the left edge or right edge of the respective content, at the left edge or right edge of the scrollable content, and/or the user interface in which the respective content is displayed (e.g., as described herein). When the scrollable content is horizontally scrollable, the respective content is optionally associated with two gaze-based scrolling regions: one at the left edge of the respective content and/or the user interface in which the respective content is displayed, and for scrolling through the scrollable content in one direction (e.g., leftward); and one at the right edge of the respective content and/or the user interface in which the respective content is displayed, and for scrolling through the scrollable content in a different direction (e.g., rightward). Characteristics of gaze-based scrolling regions for scrollable content that is scrollable in a second direction (e.g., horizontally) are described in more detail with reference to methods 800, 1000 and/or 1800. In some embodiments, if scrollable content is scrollable in two directions (e.g., vertically and horizontally scrollable), the respective content is optionally associated with four gaze-based scrolling regions: one at the left edge of the respective content and/or the user interface in which the respective content is displayed, and for scrolling through the scrollable content in one direction (e.g., leftward); one at the right edge of the respective content and/or the user interface in which the respective content is displayed, and for scrolling through the scrollable content in a different direction (e.g., rightward); one at the top edge of the respective content and/or the user interface in which the respective content is displayed, and for scrolling through the scrollable content in a different direction (e.g., upward); and one at the bottom edge of the respective content and/or the user interface in which the respective content is displayed, and for scrolling through the scrollable content in a different direction (e.g., downward).

In some embodiments, the direction of scrolling of the scrollable content controls the direction in which extended region(s) (e.g., as described herein) that are added to baseline region(s) (e.g., as described herein) extend into the respective content. For example, for a baseline region that is located on the left side of the respective content (e.g., for leftward gaze-based scrolling), the computer system optionally adds (e.g., as described herein) an extended region to the right of the baseline region that extends rightward into the respective content from the baseline region. Similarly, for a baseline region that is located on the right side of the respective content (e.g., for rightward gaze-based scrolling), the computer system optionally adds (e.g., as described herein) an extended region to the left of the baseline region that extends leftward into the respective content from the baseline region. Similarly, for a baseline region that is located on the bottom side of the respective content (e.g., for downward gaze-based scrolling), such as baseline region 704c in FIG. 17E, the computer system optionally adds (e.g., as described herein) an extended region above the baseline region that extends upward into the respective content from the baseline region, such as extended region 704c′ in FIG. 17E. Finally, for a baseline region that is located on the top side of the respective content (e.g., for upward gaze-based scrolling), such as baseline region 704b in FIG. 17E, the computer system optionally adds (e.g., as described herein) an extended region below the baseline region that extends downward into the respective content from the baseline region, such as extended region 704b′ in FIG. 17E.

In some embodiments, aspects/operations of methods 800, 1000, 1200, 1400, 1600 and/or 1800 may be interchanged, substituted, and/or added between these methods. For example, the virtual objects and/or content of methods 800, 1000, 1200, 1400, 1600 and/or 1800, the three-dimensional environments of methods 800, 1000, 1200, 1400, 1600 and/or 1800, the scrolling (e.g., gaze-based or otherwise) of scrollable content of methods 800, 1000, 1200 and/or 1800, the gaze scrolling regions of methods 800, 1000, 1200 and/or 1800, the moving of system focus to a control element or a user interface element of method 1000, the transition between video content items of method 1600, the animations and/or animations curves of method 1400, and/or the changing of the visual appearance of a virtual object of methods 1200 and/or 1400, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-20. (canceled)

21. A method comprising:
at a computer system in communication with a display generation component and one or more input devices:
while displaying, via the display generation component, scrollable content, detecting, via the one or more input devices, a gaze of a user of the computer system directed to the scrollable content; and
in response to detecting the gaze of the user directed to the scrollable content:
in accordance with a determination that gaze-based criteria for scrolling the scrollable content is met while a respective input element is not providing an input to scroll the scrollable content, scrolling the scrollable content in accordance with the gaze of the user directed to the scrollable content; and
in accordance with a determination that the gaze-based criteria for scrolling the scrollable content is met while the respective input element is providing an input to scroll the scrollable content, forgoing scrolling the scrollable content in accordance with the gaze of the user directed to the scrollable content.

22. The method of claim 21, wherein the gaze-based criteria include a criterion that is met when one or more of location-based criteria or duration-based criteria are met.

23. The method of claim 21, wherein the gaze-based criteria for scrolling the scrollable content includes a criterion that is met while the gaze of the user is directed to a first region of the scrollable content, the method further comprising:
in accordance with a determination that the gaze-based criteria for scrolling the scrollable content is not met because the gaze of the user is determined to not be directed to the first region of the scrollable content, forgoing scrolling the scrollable content.

24. The method of claim 21, wherein detecting the input to scroll the scrollable content provided by the respective input element includes detecting, via the one or more input devices, movement of a portion of the user of the computer system.

25. The method of claim 21, wherein the scrollable content includes a first region, the method further comprising:
in response to detecting the gaze of the user directed to the first region of the scrollable content:
in accordance with a determination that the gaze-based criteria for scrolling the scrollable content is met while the respective input element is providing an input to respective content, scrolling the scrollable content in accordance with the gaze of the user directed to the first region.

26. The method of claim 25, wherein:
the scrollable content is part of a first user interface element; and
the input to the respective content provided by the respective input element is an input to scroll the respective content, wherein the respective content is also part of the first user interface element.

27. The method of claim 25, wherein:
the scrollable content is part of a first user interface element; and
the input to the respective content provided by the respective input element is an input to scroll the respective content, wherein the respective content is part of a second user interface element, different form the first user interface element.

28. The method of claim 25, further comprising:
while displaying the scrollable content, and while displaying virtual content, different from the scrollable content, detecting the gaze of the user directed to the first region of the scrollable content; and
in response to detecting the gaze of the user directed to the first region of the scrollable content:
in accordance with a determination that gaze-based criteria for scrolling the scrollable content is met, and while the respective input element is providing an input to move the virtual content from a first location to a second location, different from the first location, scrolling the scrollable content in accordance with the gaze of the user directed to the first region.

29. The method of claim 25, further comprising:
while displaying the scrollable content, and while displaying virtual content, different from the scrollable content, detecting, via the one or more input devices, the gaze of the user directed to the first region of the scrollable content; and
in response to detecting the gaze of the user directed to the first region of the scrollable content:
in accordance with a determination that gaze-based criteria for scrolling the scrollable content is met while the respective input element is providing an input to change a size of the virtual content, scrolling the scrollable content in accordance with the gaze of the user directed to the first region while changing the size of the virtual content in accordance with the input from the respective input element.

30. The method of claim 21, further comprising:
in response to detecting the gaze of the user directed to the scrollable content:
in accordance with a determination that the gaze-based criteria for scrolling the scrollable content is met while the respective input element is not engaged, scrolling the scrollable content in accordance with the gaze of the user directed to the scrollable content.

31. The method of claim 21, wherein scrolling the scrollable content in accordance with the gaze of the user directed to the scrollable content includes:
in accordance with a determination that a location of the gaze of the user directed to the scrollable content is a first location of the scrollable content, scrolling the scrollable content with a first speed; and
in accordance with a determination that the location of the gaze of the user directed to the scrollable content is a second location of the scrollable content, different from the first location, scrolling the scrollable content with a second speed, different from the first speed.

32. The method of claim 21, further comprising:
displaying, via the display generation component, a control element associated with the scrollable content outside an area of the scrollable content with a first visual appearance;
while displaying the control element, detecting, via the one or more input devices, the gaze of the user of the computer system directed to the control element; and
in response to detecting the gaze of the user directed to the control element:
in accordance with a determination that the gaze-based criteria for scrolling the scrollable content was met within a first time threshold before detecting the gaze of the user of the computer system directed to the control element, displaying, via the display generation component, the control element with a second visual appearance, different from the first visual appearance, within a second time threshold; and
in accordance with a determination that the gaze-based criteria for scrolling the scrollable content was not met within the first time threshold before detecting the gaze of the user of the computer system directed to the control element, forgoing displaying the control element with the second visual appearance for a third time threshold.

33. The method of claim 32, further comprising:
in response to detecting the gaze of the user directed to the control element:
in accordance with a determination that the gaze-based criteria for scrolling the scrollable content was not met within the first time threshold before detecting the gaze of the user of the computer system directed to the control element, displaying, via the display generation component, the control element with the second visual appearance after a fourth time threshold, different from the third time threshold.

34. The method of claim 21, further comprising:
while displaying, via the display generation component, a user interface element and a control element associated with the user interface element:
while a gaze of the user of the computer system is directed to the control element and while a system focus is on the control element, detecting, via the one or more input devices, movement of the gaze of the user to the user interface element; and
in response to detecting the movement of the gaze of the user to the user interface element:
in accordance with a determination that the user interface element has gaze-based scrolling enabled, and in accordance with a determination that the movement of the gaze of the user is greater than a first threshold distance away from the control element, moving the system focus from the control element to the user interface element; and
in accordance with a determination that the user interface element does not have gaze-based scrolling enabled, and in accordance with a determination that the movement of the gaze of the user is greater than a second threshold distance, wherein the second threshold distance is greater than the first threshold distance, away from the control element to the user interface element, moving the system focus from the control element to the user interface element.

35. The method of claim 21, further comprising:
while displaying, via the display generation component, a control element associated with the scrollable content outside an area of the scrollable content with a first visual appearance:
in accordance with a determination that the gaze of the user is directed to the control element, and prior to changing a visual appearance of the control element from the first visual appearance to a second visual appearance based on the gaze of the user being directed to the control element, detecting, via the one or more input devices, a first input from the respective input element directed to the control element; and
in response to detecting the first input, selecting the control element.

36. The method of claim 21, further comprising:
displaying, via the display generation component, a control element associated with the scrollable content outside an area of the scrollable content;
while displaying the control element and while a system focus is on the scrollable content, detecting, via the one or more input devices, the gaze of the user of the computer system moving to the control element;
in response to detecting the gaze of the user moving to a location of the control element, changing the system focus to the control element;
while the system focus is directed to the control element, detecting that the gaze of the user has moved away from the location of the control element; and
in response to detecting that the gaze of the user has moved away from the location of the control element:
in accordance with a determination that the gaze of the user has moved away from the location of the control element by a first amount and in accordance with a determination that gaze-based scrolling occurred within a first time threshold of when the gaze of the user moved to the location of the control element, removing the system focus from the control element; and
in accordance with the determination that the gaze of the user has moved away from the location of the control element by the first amount and in accordance with a determination that gaze-based scrolling did not occur within the first time threshold of when the gaze of the user moved to the location of the control element, forgoing removing the system focus on the control element.

37. The method of claim 36, further comprising:
in response to detecting that the gaze of the user has moved away from the location of the control element:
in accordance with the determination that the gaze of the user has moved away from the location of the control element by a second amount, greater than the first amount, removing the system focus from the control element.

38. The method of claim 36, wherein while the system focus is directed to the control element, the control element is configured to receive one or more inputs from a portion of the user of the computer system.

39. The method of claim 38, further comprising:
while displaying the control element and while the system focus is on the control element, detecting, via the one or more input devices, the portion of the user providing an input directed to the control element; and
in response to detecting the portion of the user providing the input directed to the control element, performing an action associated with the control element in accordance with the input directed to the control element provided by the portion of the user.

40. The method of claim 36, wherein the control element is a movement affordance that is selectable to move the scrollable content.

41. The method of claim 36, wherein the control element is a resize affordance that is selectable to resize the scrollable content.

42. The method of claim 36, wherein the control element is a close affordance that is selectable to close the scrollable content.

43. The method of claim 36, further comprising:
displaying, via the display generation component, a control element associated with the scrollable content, and while the system focus is directed to the control element, detecting, via the one or more input devices, the gaze of the user of the computer system has moved away from the control element; and
in response to detecting the gaze of the user has moved away from the control element: in accordance with a determination that the gaze of the user has moved away from the location of the control element by a first amount, removing the system focus from the control element irrespective of whether gaze-based scrolling occurred prior to the system focus moving to the control element.

44. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the display generation component, scrollable content, detecting, via the one or more input devices, a gaze of a user of the computer system directed to the scrollable content; and
in response to detecting the gaze of the user directed to the scrollable content:
in accordance with a determination that gaze-based criteria for scrolling the scrollable content is met while a respective input element is not providing an input to scroll the scrollable content, scrolling the scrollable content in accordance with the gaze of the user directed to the scrollable content; and
in accordance with a determination that the gaze-based criteria for scrolling the scrollable content is met while the respective input element is providing an input to scroll the scrollable content, forgoing scrolling the scrollable content in accordance with the gaze of the user directed to the scrollable content.

45. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the display generation component, scrollable content, detecting, via the one or more input devices, a gaze of a user of the computer system directed to the scrollable content; and
in response to detecting the gaze of the user directed to the scrollable content:
in accordance with a determination that gaze-based criteria for scrolling the scrollable content is met while a respective input element is not providing an input to scroll the scrollable content, scrolling the scrollable content in accordance with the gaze of the user directed to the scrollable content; and
in accordance with a determination that the gaze-based criteria for scrolling the scrollable content is met while the respective input element is providing an input to scroll the scrollable content, forgoing scrolling the scrollable content in accordance with the gaze of the user directed to the scrollable content.

46-145. (canceled)
